(19) United States
(12) Patent Application Publication
(10) Pub. No.: US 2026/0066813 A1
(43) Pub. Date: Mar. 5, 2026

(54) MULTI-LAYERED SWITCH WITH COOLING BUS BARS

(71) Applicant: Marel Power Solutions, Inc., Plymouth, MI (US)

(72) Inventors: Ian Byers, Northville, MI (US); Gary Miller, Caseville, MI (US); Antonella Grimaldi, Novi, MI (US); Martin Baker, Ann Arbor, MI (US); Leonardo Olan Valdivieso, Westland, MI (US); Michael Marczi, Genoa, NV (US); Evan West, Farmington Hills, MI (US); Stuart Wooters, Franklin, MI (US)

(73) Assignee: Marel Power Solutions, Inc., Plymouth, MI (US)

(21) Appl. No.: 19/313,328

(22) Filed: Aug. 28, 2025

Related U.S. Application Data
(60) Provisional application No. 63/688,778, filed on Aug. 29, 2024.
(60) Provisional application No. 63/701,687, filed on Oct. 1, 2024.
(60) Provisional application No. 63/796,844, filed on Apr. 29, 2025.
(60) Provisional application No. 63/836,746, filed on Jul. 1, 2025.
(60) Provisional application No. 63/846,244, filed on Jul. 18, 2025.

(51) Int. Cl. H02M 7/5387; H02M 7/00

(52) U.S. Cl. CPC H02M 7/53871; H02M 7/003

(57) ABSTRACT

A switch includes first and second transistors electrically connected in series between the switch's first and second terminals. Each of the first and second transistors includes first and second transistor terminals between which electrical current can flow. A first metal bus bar includes a first channel through which fluid can flow. A second metal bus bar includes a second channel through which fluid can flow. The first transistor terminals of the first and second transistors are electrically connected to the first and second metal bus bars, respectively. A first driver circuit controls the first transistor. A second driver circuit controls the second transistor. A control unit can generate a first signal. A first distribution network can transmit the first signal to the first and second drivers at the same time.

### RELATED APPLICATIONS

This application claims priority to U.S. patent application 63/688,778, filed Aug. 29, 2024, U.S. patent application 63/701,687, filed Oct. 1, 2024, U.S. patent application 63/796,844, filed Apr. 29, 2025, U.S. patent application 63/836,746 filed Jul. 1, 2025, and U.S. patent application 63/846,244 filed Jul. 18, 2025, all of which are incorporated herein by reference in their entirety.

### BACKGROUND

Power conversion is a process of converting electrical energy from one form to another. Power converters vary in design and operation. An “inverter” is one type of power converter. Inverters convert direct current (DC) electrical power (hereinafter DC power) into alternating current (AC) electrical power (hereinafter AC power). A “rectifier” is another type of power converter. Rectifiers convert AC power into DC power. DC/DC converters (e.g., buck, boost, or buck/boost converters) convert DC power of one voltage level into DC power of another voltage level. AC/AC converters convert AC power of one form into AC power in another form. For example, an AC/AC converter can convert AC power of one frequency into AC power of another frequency. Power converters can be a combination of sub power converters. For example, a rectifier, a DC/DC converter, and an inverter can be combined to create a solid-state transformer in which the rectifier can supply DC power of one voltage level to the DC/DC converter, which supplies DC power of another voltage level to the inverter.

Power converters use power transistors and power diodes. Power transistors and power diodes can transmit substantial current (i.e., one ampere (A) or more). Power transistors and power diodes can run hot in power converters. If not properly cooled, power transistors and power diodes, and the power converters in which they are used, can function poorly or fail.

### BRIEF DESCRIPTION OF THE DRAWINGS

The present technology may be better understood, and its numerous objects, features, and advantages made apparent to those skilled in the art by referencing the accompanying drawings.

FIG. 1A illustrates relevant components of an example three-phase inverter.

FIG. 1B is a timing diagram that shows example gate control signals.

FIG. 1C illustrates relevant components of an example three-phase rectifier.

FIGS. 2A-1, 2A-2, and 2A-3 are top, bottom, and side views, respectively, of an example packaged switch.

FIGS. 2B-1, 2B-2, and 2B-3 are top, bottom, and side views, respectively, of an example packaged switch.

FIGS. 2C-1, 2C-2, and 2C-3 are top, bottom, and side views, respectively, of an example packaged switch.

FIGS. 2C-4, 2C-5, and 2C-6 are top, bottom, and side views, respectively, of an example packaged switch.

FIGS. 2C-7, 2C-8, and 2C-9 are top, bottom, and side views, respectively, of an example packaged switch.

FIGS. 2C-10, 2C-11, and 2C-12 are top, bottom, and side views, respectively, of an example packaged switch.

FIGS. 2D-1, 2D-2, and 2D-3 are top, bottom, and side views, respectively, of an example packaged switch.

FIGS. 2D-4, 2D-5, and 2D-6 are top, bottom, and side views, respectively, of an example packaged switch.

FIGS. 2D-7, 2D-8, and 2D-9 are top, bottom, and side views, respectively, of an example packaged switch.

FIGS. 2D-10, 2D-11, and 2D-12 are top, bottom, and side views, respectively, of an example packaged switch.

FIGS. 2D-13, 2D-14, and 2D-15 are top, bottom, and side views, respectively, of an example packaged switch.

FIG. 2D-16 is a front view of an example half bridge.

FIG. 2D-17 is a front view of an example half bridge.

FIG. 2D-18 is a front view of an example half bridge.

FIG. 2D-19 is a front view of an example half bridge.

FIG. 2D-20 is a front view of an example half bridge.

FIG. 2D-21 is a front view of an example half bridge.

FIGS. 2D-22, 2D-23, and 2D-24 are top, bottom, and side views, respectively, of an example packaged switch

FIGS. 2E-1, 2E-2, and 2E-3 are top, bottom, and side views, respectively, of an example packaged diode.

FIG. 2F is a top view showing an example transistor.

FIG. 2G is a side-view showing a portion of an example transistor.

FIG. 2H is a side-view showing a portion of an example layered sheet.

FIG. 2I is a side-view showing a portion of an example layered sheet.

FIG. 2J-1 is a side-view showing a portion of an example layered sheet.

FIG. 2J-2 is a side-view showing an example control-terminal post.

FIG. 2J-3 is a side-view showing an example control-terminal post.

FIG. 2K-1 is a side-view showing a portion of an example layered sheet.

FIG. 2K-2 is a side-view showing an example control-terminal post.

FIG. 2K-3 is a side-view showing an example control-terminal post.

FIG. 2L is a side-view showing an example control-terminal post.

FIG. 3A shows an example packaged switch.

FIG. 3B shows an example packaged switch.

FIG. 3C shows an example packaged switch.

FIG. 3D shows an example packaged switch.

FIG. 3E shows an example packaged switch.

FIG. 3F shows an example packaged switch.

FIG. 3G shows an example packaged switch.

FIG. 3H shows an example packaged switch.

FIG. 3I shows an example packaged switch.

FIG. 3J shows an example packaged switch.

FIG. 3K shows an example packaged switch.

FIG. 3L shows an example packaged switch.

FIG. 3M shows an example packaged diode.

FIG. 3N shows an example packaged diode.

FIG. 3O shows an example packaged switch.

FIG. 3P shows an example packaged switch.

FIG. 4A-1 shows top and side views of an example die substrate.

FIG. 4A-2-1 shows top and side views of an example die substrate with example transistors.

FIG. 4A-2-2 shows top and side views of an example die substrate with example transistors.

FIG. 4A-2-3 shows top and side views of an example die substrate with example transistors.

FIG. 4A-3 shows top and side views of an example die substrate with example transistors and pedestals.

FIG. 4A-4-1 shows top and side views of an example die clip.

FIG. 4A-4-2 shows top and side views of an example die clip.

FIG. 4A-4-3 shows top and side views of an example die clip.

FIG. 4A-4-4 shows top and side views of an example die clip.

FIG. 4A-5 shows top and side views of an example switch module.

FIG. 4A-6 shows top and side views of an example die substrate with example transistors and pedestals.

FIG. 4A-7 shows top and side views of an example switch module.

FIG. 4A-8 shows top and side views of an example die substrate with example transistors and pedestals.

FIG. 4A-9 shows top and side views of an example switch module.

FIG. 4B-1 shows top and side views of an example die substrate with example transistors.

FIG. 4B-2 shows top and side views of an example die substrate with example transistors and pedestals.

FIG. 4B-3 shows top and side views of an example switch module.

FIG. 4B-4 shows top and side views of an example die substrate with example transistors and pedestals.

FIG. 4B-5 shows top and side views of an example switch module.

FIG. 4C-1 shows top and side views of an example die clip with example transistors.

FIG. 4C-2 shows top and side views of an example switch module.

FIG. 4D-1 shows top and side views of an example die clip with example transistors and pedestals.

FIG. 4D-2 shows top and side views of an example paddle.

FIG. 4D-3 shows top and side views of an example switch module.

FIG. 4E-1 shows top and side views of an example die substrate with example transistors.

FIG. 4E-2 shows top and side views of an example die clip with example transistors.

FIG. 4E-3 shows top and side views of an example switch module.

FIG. 4F-1 shows top and side views of an example die substrate with example transistors.

FIG. 4F-2 shows top and side views of an example die substrate with example transistors and pedestals.

FIG. 4F-3 shows top and side views of an example switch module.

FIG. 4G-1 shows top and side views of an example transistor.

FIG. 4G-2 shows top and side views of an example transistor with example signal frames.

FIG. 4G-3 shows top and side views of an example transistor with example signal frames and pedestals.

FIG. 4G-4 is a side view of the structure shown in FIG. 4G-3.

FIG. 4G-5 is a cross-sectional view of the structure shown in FIG. 4G-3.

FIG. 4G-6 shows top and side views of an example die substrate with an example transistor.

FIG. 4G-7 shows top and side views of an example switch module.

FIG. 4G-8 is a top view of example transistors with example signal frames and pedestals.

FIG. 4G-9 is a top view of an example die substrate with example transistors.

FIG. 4G-10 is a side view of an example die substrate with example transistors.

FIG. 4G-11 is a side view of an example switch module.

FIG. 4G-12 is a top view of an example switch module.

FIG. 4G-13 is a top view of an example transistor with example control-terminal posts and example pedestals.

FIG. 4G-14 is a cross-sectional view of the structure shown in FIG. 4G-13.

FIG. 4G-15 is a side view of the structure shown in FIG. 4G-13.

FIG. 4G-16 shows the structure of FIG. 4G-13 with added straps.

FIG. 4G-17 is a cross-sectional view of the structure shown in FIG. 4G-16.

FIG. 4G-18 is a side view of the structure shown in FIG. 4G-16.

FIG. 4G-19 shows top and side views of an example die substrate with an example transistor.

FIG. 4G-20 shows top and side views of an example switch module.

FIG. 4G-21 is a top view of example transistors with example control-terminal posts and example pedestals.

FIG. 4G-22 shows the structure of FIG. 4G-21 with added straps.

FIG. 4G-23 is a top view of an example die substrate with example transistors.

FIG. 4G-24 is a top view of an example switch module.

FIG. 4G-25 is a side view of the structure shown in FIG. 4G-22.

FIG. 4G-26 is a side view of the structure shown in FIG. 4G-23.

FIG. 4G-27 is a side view of the structure shown in FIG. 4G-24.

FIG. 4H shows top and side views of an example diode module.

FIG. 5A-1 is a front view of an example converter.

FIG. 5A-2S is a side view of an example converter.

FIG. 5A-2T is a top view of an example converter.

FIG. 5A-3 shows cross-sectional or end views of example tubes.

FIG. 5A-4 shows cross-sectional or end views of example tubes.

FIG. 5A-5 shows cross-sectional or end views of example tubes.

FIG. 5A-6 shows cross-sectional or end views of example tubes.

FIG. 5A-7 shows cross-sectional or end views of example tubes.

FIG. 5A-8 is a side view of an example.

FIG. 5A-9 is a side view of an example.

FIG. 5A-10 is a side view of an example.

FIG. 5A-11 is a side view of an example tube.

FIG. 5A-12 is a side view of an example tube.

FIG. 5A-13 is a side view of an example tube.

FIG. 5A-14 is a side view of an example tube.

FIG. 5A-15-1 is a view of an example bus bar formed around tubes.

FIG. 5A-15-2 is a view of an example bus bar formed around tubes.

FIG. 5A-16-1 is a view of example bus bar portions.

FIG. 5A-16-2 is a view of example bus bar portions.

FIG. 5A-16-3 is a view of an example bus.

FIG. 5A-17-1 is a front view of example bus bar portions and tubes.

FIG. 5A-17-2 is a side view of example bus bar portions and tubes.

FIG. 5A-17-3 is a side view of example bus bar portions and tubes.

FIG. 5A-17-4 is a side view of an example bus bar with tubes.

FIG. 5A-17-5 is a front view of an example bus bar with tubes.

FIG. 5A-17-6 is a front view of example phase bus bar portions and tubes.

FIG. 5A-17-7 is a side view of example phase bus bar portions and tubes.

FIG. 5A-17-8 is a side view of example phase bus bar portions and tubes.

FIG. 5A-17-9 is a side view of example phase bus bars with tubes.

FIG. 5A-17-10 is a front view of example phase bus bars with tubes.

FIG. 5A-17-11 is a front view of example phase bus bar portions and tubes.

FIG. 5A-17-12 is a side view of example phase bus bar portions and tubes.

FIG. 5A-17-13 is a side view of example phase bus bar portions and tubes.

FIG. 5A-17-14 is a side view of example phase bus bars with tubes.

FIG. 5A-17-15 is a front view of example phase bus bars with tubes.

FIG. 5A-18-1 is a side view of an example bus bar.

FIG. 5A-18-2 is a side view of an example punch.

FIG. 5A-18-3 is a side view of an example punch.

FIG. 5A-19-1 is a side view of a rectangular cuboid made of metal.

FIG. 5A-19-2 is a side view of an example bus bar.

FIG. 5A-19-3 is a side view of an example bus bar with tubes.

FIG. 5A-19-4 is a side view of an example bus bar with tubes.

FIG. 5A-19-5 is a front view of an example bus bar formed around tubes.

FIG. 5A-20 is a side view of an example converter.

FIG. 5A-21 is a side view of an example converter.

FIG. 5A-22 is a side view of an example converter.

FIG. 5A-23 is a side view of an example converter.

FIG. 5A-24 is a side view of an example converter.

FIGS. 5A-25B and 5A-25F show front and back views of an example PCB with capacitors.

FIG. 5A-26 is a side view of an example converter.

FIGS. 5A-27B and 5A-27F show front and back views of an example PCB with capacitors and other devices.

FIG. 5A-28 is a front view of an example converter.

FIGS. 5A-29B and 5A-29F show front and back views of an PCB.

FIG. 5A-30 is a side view of an example converter.

FIG. 5A-31 is a side view of an example converter.

FIG. 5A-32 is a view of an example converter.

FIGS. 5A-33F and 5A-33B show front and back views of an example PCB.

FIG. 5A-34 is a view of an example converter.

FIG. 5A-35 is a view of an example converter.

FIG. 5A-36 is a view of an example converter.

FIG. 5A-37 is a view of an example converter.

FIG. 5A-38 is a view of an example converter.

FIG. 5A-39 is a view of an example converter.

FIGS. 5A-40 and 5A-41 show top and side views of example converter components.

FIGS. 5A-42 and 5A-43 show top and side views of example converter components.

FIGS. 5A-44 and 5A-45 show top and side views of example converter components.

FIG. 5A-46 is a front view of an example converter.

FIG. 5A-47 is a front view of an example converter.

FIG. 5A-48 is a side view of an example converter.

FIG. 5B-1 is a front view of an example converter.

FIG. 5B-2 is a side view of an example converter.

FIG. 5C is a front view of an example converter.

FIG. 5D-1 is a front view of an example converter.

FIG. 5D-2 is a back view of an example converter.

FIG. 5D-3 is a side view of an example converter.

FIG. 5D-4 is a top view of an example converter.

FIG. 5E-1 is a front view of an example converter.

FIG. 5E-2 is a side view of an example converter.

FIG. 5E-3 is a side view of an example converter.

FIG. 5F-1 is a front view of an example converter.

FIG. 5F-2 is a side view of an example converter.

FIG. 5F-3 is a side view of an example converter.

FIG. 5G-1 is a front view of an example converter.

FIG. 5G-2 is a side view of an example converter.

FIG. 5G-3 is a front view of an example converter.

FIG. 5H is a front view of an example converter.

FIG. 5I-1 is a front view of an example converter.

FIG. 5I-2 is a back view of an example converter.

FIG. 5I-3 is a side view of an example converter.

FIG. 5I-4 is a top view of an example converter.

FIG. 5I-5 is a top view of an example converter.

FIG. 5I-6A illustrates examples of winding connections in stators.

FIGS. 5I-6F and 5I-6B illustrate back and front views of an example driver PCB.

FIG. 5I-7 illustrates an example driver PCB.

FIG. 5I-8 illustrates an example driver PCB.

FIG. 5J is a front view of an example converter.

FIG. 5K-1 is a front view of an example converter.

FIG. 5K-2 is a side view of an example converter.

FIG. 5K-3 is a side view of an example converter.

FIGS. 5K-4B and 5K-4F illustrate back and front views of an example driver PCB.

FIG. 5L is a front view of an example converter.

FIG. 5M-1 is a front view of an example solid-state circuit switch.

FIG. 5M-2 is a side view of an example solid-state circuit switch.

FIGS. 5M-3a-5M-3i illustrate example voltage suppression circuits.

FIG. 5M-4 is a front view of an example solid-state circuit switch.

FIGS. 5M-5 and 5M-6 show side views of an example solid-state circuit switch.

FIG. 5M-7 is a front view of an example solid-state circuit switch.

FIGS. 5M-8 and 5M-9 are side views of an example solid-state circuit switch.

FIG. 5M-10 is a front view of an example solid-state circuit switch.

FIGS. 5M-11 and 5M-12 are side views of an example solid-state circuit switch.

FIG. 5N-1 is a front view of an example solid-state circuit switch.

FIG. 5N-2 is a side view of an example solid-state circuit switch.

FIG. 5N-3 is a front view of an example solid-state circuit switch.

FIGS. 5N-4 and 5N-5 are side views of an example solid-state circuit switch.

FIG. 5O-1 is a front view of an example converter.

FIG. 5O-2 is a side view of an example converter.

FIG. 5O-3 is a side view of an example converter.

FIG. 5P-1 is a front view of an example converter.

FIG. 5P-2 is a side view of an example converter.

FIG. 5P-3 is a front view of example connected bus bars.

FIG. 5P-4 is a side view of an example coupling and bus bar.

FIG. 5P-5 is a front view of an example bus.

FIG. 5P-6 is a side view of an example bus bar.

FIG. 5P-7 is a side view of example coupling and bus bar.

FIG. 5Q-1 is a front view of an example converter.

FIG. 5Q-2 is a back view of an example converter.

FIG. 5Q-3 is a side view of an example converter.

FIG. 5Q-4 is a side view of an example converter.

FIG. 5Q-5 is a top view of an example converter.

FIG. 5Q-6 is a top view of an example converter.

FIG. 5R-1 is a front view of an example converter.

FIG. 5R-2 is a side view of an example converter.

FIG. 5R-3 is a side view of an example converter.

FIG. 5R-4 is a front view of an example converter.

FIG. 5R-5 is a side view of an example converter.

FIG. 5R-6 is a side view of an example converter.

FIG. 5R-7 is a front view of an example converter.

FIG. 5R-8 is a side view of an example converter.

FIG. 5R-9 is a side view of an example converter.

FIG. 5R-10 is a front view of an example converter.

FIG. 5R-11 is a side view of an example converter.

FIG. 5R-12 is a side view of an example converter.

FIG. 5S-1 is a front view of an example converter.

FIG. 5S-2 is a back view of an example converter.

FIG. 5S-3 is a side view of an example converter.

FIG. 5S-4 is a front view of an example converter.

FIG. 5S-5 is a back view of an example converter.

FIG. 5S-6 is a side view of an example converter.

FIG. 5T-1 is a front view of an example converter.

FIG. 5T-2 is a back view of an example converter.

FIG. 5T-3 is a side view of an example converter.

FIG. 5T-4 is a side view of an example converter.

FIG. 5U-1 is a front view of an example converter.

FIG. 5U-2 is a back view of an example converter.

FIG. 5U-3 is a side view of an example converter.

FIG. 5U-4 is a side view of example connected packaged switches.

FIG. 5U-5 is a front view of the structure in FIG. 5U-4.

FIG. 5V is a front view of an example converter.

FIG. 5W-1 is a front view of an example converter.

FIG. 5W-2 is a back view of an example converter.

FIG. 5W-3 is a side view of an example converter.

FIG. 5W-4 is a side view of an example converter.

FIG. 5W-5 is a side view of example packaged switches.

FIG. 5X-1 is a front view of an example converter.

FIG. 5X-2 is a side view of an example converter.

FIG. 6A-1 is a front view of an example module stack.

FIGS. 6A-2 and 6A-3 are side views of an example module stack.

FIG. 6A-4 is a front view of an example module stack.

FIGS. 6A-5 and 6A-6 are side views of an example module stack.

FIG. 6B-1 is a front view of an example module stack.

FIG. 6B-2 is a side view of an example module stack.

FIG. 6B-3 is a front view of an example module stack.

FIG. 6B-4 is a side view of an example module stack.

FIG. 6C-1 is a front view of an example stacked switch.

FIGS. 6C-2 and 6C-3 are side views of an example stacked switch.

FIG. 6D-1 is a front view of an example stacked switch.

FIGS. 6D-2 and 6D-3 are side views of an example stacked switch.

FIG. 6E-1 is a front view of an example stacked switch.

FIGS. 6E-2 and 6E-3 are side views of an example stacked switch.

FIG. 6F-1 is a front view of an example stacked switch.

FIGS. 6F-2 and 6F-3 are side views of an example stacked switch.

FIG. 7C-1 is a top view of an example converter.

FIG. 7C-2 is a cross-sectional view of the example converter of FIG. 7C-1.

FIG. 7C-3 is a cross-sectional view of the example converter of FIG. 7C-1.

FIG. 7D-1 is a top view of an example converter.

FIG. 7D-2 is a cross-sectional view of the example converter of FIG. 7D-1.

FIG. 7D-3 is a cross-sectional view of the example converter of FIG. 7D-1.

FIG. 7E-1 is a front view of an example converter.

FIG. 7E-2 is a back view of an example converter.

FIG. 7E-3 illustrates an example PCB.

FIGS. 7E-4 and 7E-5 are side views of an example inverter.

FIG. 7E-6 is a back view of an example converter.

FIG. 7E-7 illustrates an example PCB.

FIG. 7E-8 is a side view of an example inverter.

FIG. 7F-1 is a front view of an example converter.

FIG. 7F-2 is a back view of an example converter.

FIG. 7F-3 is a side view of an example converter.

FIG. 7F-4 is a top view of an example converter.

FIG. 7F-5 is a bottom view of an example converter.

FIG. 7F-6 is a front view of an example converter.

FIG. 7F-7 is a back view of an example converter.

FIG. 7F-8 is a side view of an example converter.

FIG. 7F-9 is a front view of an example converter.

FIG. 7F-10 is a back view of an example converter.

FIG. 7F-11 is a side view of an example converter.

FIG. 7F-12 is a front view of an example converter.

FIG. 7F-13 is a back view of an example converter.

FIGS. 7F-14 and 7F-15 are side views of an example converter.

FIG. 8A-1 is a front view of an example converter.

FIG. 8A-2 is a bottom view of an example converter.

FIGS. 8A-3 and 8A-4 are side views of an example converter.

FIG. 9A-1 is a front view of an example converter.

FIG. 9A-2 is a side view of an example converter.

FIG. 9A-3 shows cross-sectional or end views of example tubes.

FIG. 9A-4 shows cross-sectional or end views of example tubes.

FIG. 9A-5 is a side view of an example tube.

FIG. 9A-6-1 is a side view of an example tube.

FIG. 9A-6-2 is a side view of an example tube.

FIG. 9A-7 shows cross-sectional or end views of example tubes.

FIG. 9A-8 is a side view of an example tube.

FIG. 9A-9 is a side view of an example tube.

FIG. 9A-10 is a front view of example bus bar portions and tubes.

FIG. 9A-11 is a side view of example bus bar portions and tubes.

FIG. 9A-12 is a side view of example bus bar portions and tubes.

FIG. 9A-13 is a side view of an example bus bar with tubes.

FIG. 9A-14 is a front view of an example bus bars with tubes.

FIG. 9A-15 is a front view of example phase bus bar portions and tubes.

FIG. 9A-16 is a side view of example phase bus bar portions and tubes.

FIG. 9A-17 is a side view of example phase bus bar portions and tubes.

FIG. 9A-18 is a side view of example phase bus bars with tubes.

FIG. 9A-19 is a front view of example phase bus bars with tubes.

FIG. 9A-20 is a front view of example bus bar portions and tubes.

FIG. 9A-21 is a side view of example bus bar portions and tubes.

FIG. 9A-22 is a side view of example bus bar portions and tubes.

FIG. 9A-23 is a side view of an example bus bar with tubes.

FIG. 9A-24 is a front view of an example bus bars with tubes.

FIG. 9A-25 is a front view of example phase bus bar portions and tubes.

FIG. 9A-26 is a side view of example phase bus bar portions and tubes.

FIG. 9A-27 is a side view of example phase bus bar portions and tubes.

FIG. 9A-28 is a side view of example phase bus bars with tubes.

FIG. 9A-29 is a front view of example phase bus bars with tubes.

FIG. 9A-30 is a side view of example bus bar portions and tubes.

FIG. 9A-31 is a side view of example slats and tubes.

FIG. 9A-32 is a side view of an example bus bar.

FIG. 9A-33 is a top view of an example bus bar.

FIG. 9A-34 is a side view of example slats and tubes.

FIG. 9A-35 is a top view of example slats and tubes.

FIG. 9A-36 is a side view of example phase bus bars.

FIG. 9A-37 is a top view of example phase bus bars.

FIG. 10A-1 is a front view of an example converter.

FIGS. 10A-2 and 10A-3 are side views of an example converter.

FIG. 10A-4 is a front view of an example converter.

The use of the same reference symbols in different figures indicates identical items. The description of an element identified by reference symbol without a letter and/or number after it, applies to elements bearing that reference symbol. For example, a description of element “204” applies to elements 204L, 204H, 204L-1, etc., and a description of element “204L” applies to elements 204L-1, 204-2.

### DETAILED DESCRIPTION

Power converters are disclosed. Power converters include inverters, rectifiers, DC/DC converters, AC/AC converters, chargers (e.g., on-board chargers (OBCs), DC fast chargers, etc.), matrix converters, solid-state transformers (SSTs), etc. Solid-state circuit breakers, solid-state contactors and other devices for opening or closing an electrical circuit are also disclosed. Power converters, solid-state circuit breakers, and solid-state contactors are examples of “power apparatuses.”

Power converters may be unidirectional or bidirectional. For example, bidirectional rectifiers can convert AC power into DC power when operating in the forward direction and DC power into AC power when operating in the reverse direction. When operating in the forward direction, bidirectional chargers may convert AC power (e.g., AC power provided by a power grid, which may also be referred to as an “electric grid”) into DC power for charging a battery or other purpose, and when operating in the reverse direction, the bidirectional charger may convert DC power from the battery or other DC power source into AC power.

Power converters vary in design. For example, power converters of this disclosure may have one, two, three or more legs. Each leg may include at least one “high-side switch” electrically connected to at least one “low-side switch.”

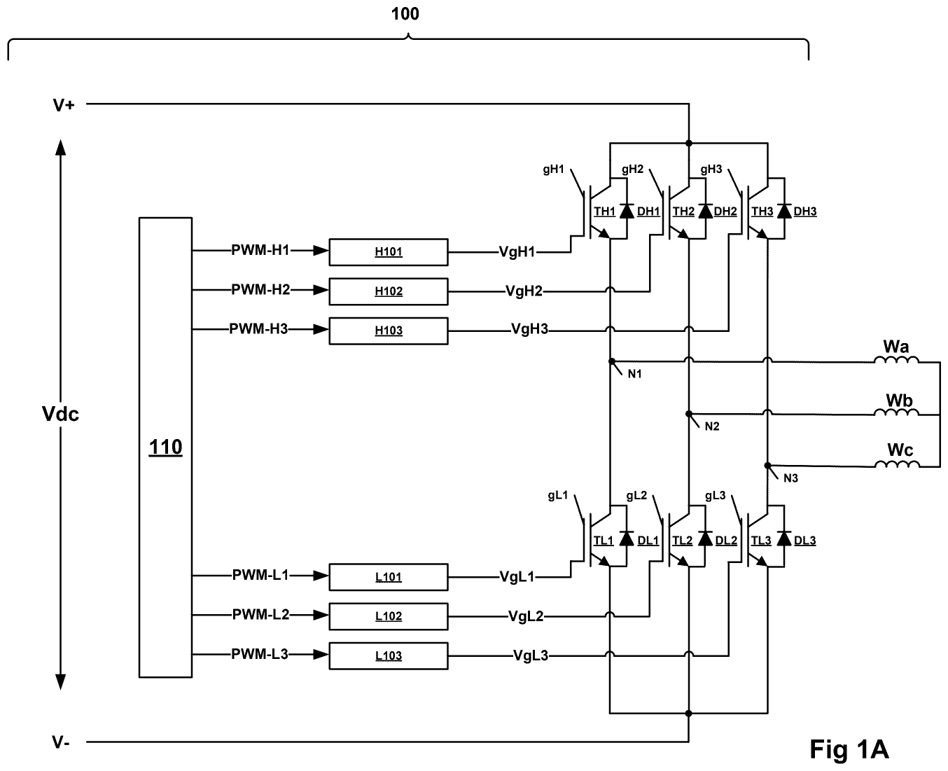

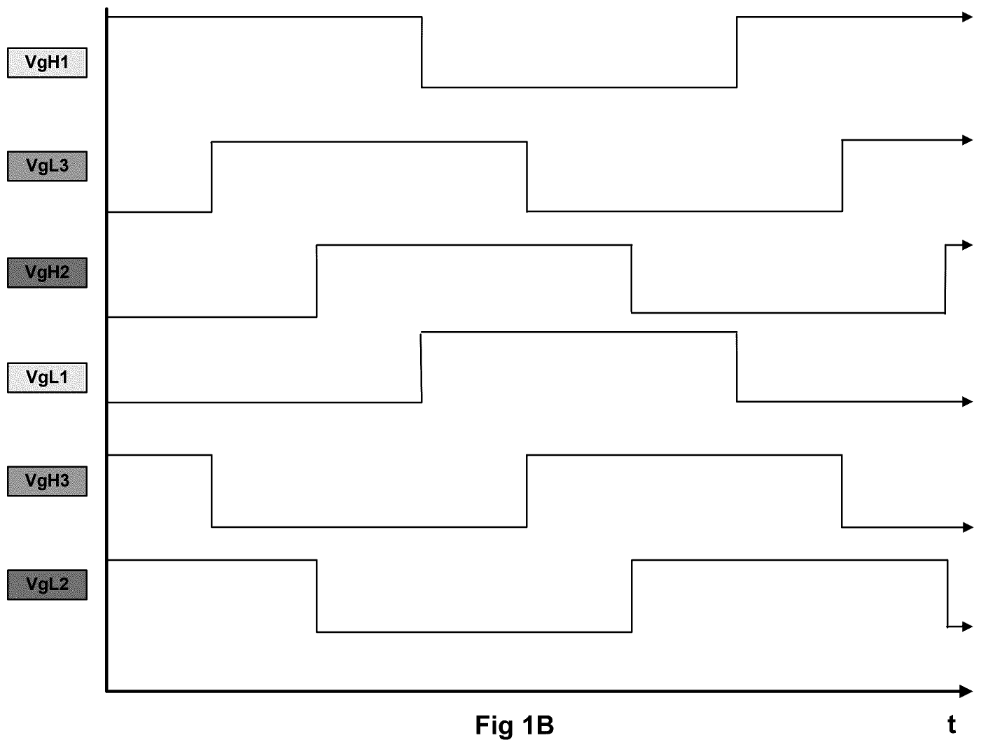

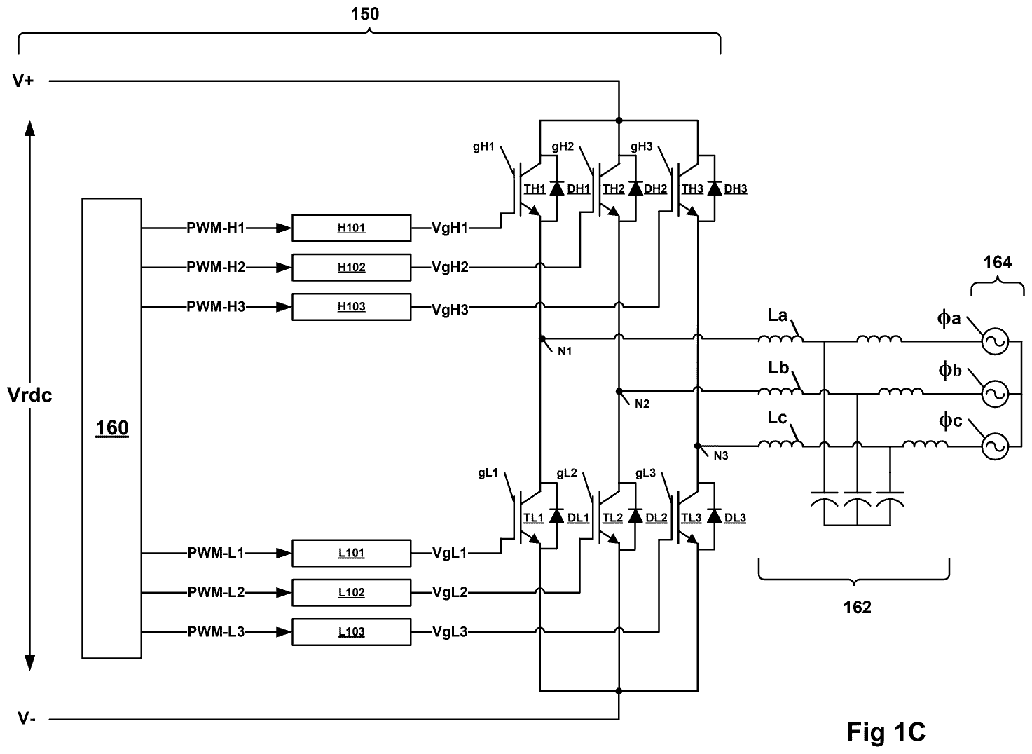

FIG. 1A is a schematic drawing that illustrates relevant components of an example three-phase inverter 100 for converting DC power into three-phase AC power. Inverter 100 includes three legs, each of which includes a high-side switch electrically connected to a low-side switch. Each high-side switch includes a high-side transistor TH electrically connected to a high-side diode DH, and each low-side switch includes a low side transistor TL electrically connected to a low-side diode DL as shown. In FIG. 1A, each transistor TH and TL is an insulated gate bipolar transistor (IGBT).

High-side transistors TH1-TH3 may be electrically connected in series with low-side transistors TL1-TL3, respectively, via nodes N1-N3, respectively, which in turn are electrically connected to respective terminals of inductive elements (e.g., inductors) Wa-Wc as shown. Inductive elements Wa-Wc may be stator windings of an electric motor.

The collector terminals of TH1-TH3 and the cathode terminals of DH1-DH3 may be electrically connected to each other and to a V+ terminal, while the emitter terminals of TL1-TL3 and the anode terminals of diodes DL1-DL3 may be electrically connected to each other and to a V-terminal as shown.

A DC voltage may be provided between V+ and V-terminals of this disclosure by a battery or other voltage source (e.g., DC/DC converter). V+ and V-terminals may be directly or indirectly connected to a battery or other voltage source. For example, a V+ terminal may be indirectly connected to a battery through a filter or filter component such as an inductor. FIG. 1A and other figures of this disclosure symbolically show V+ and V-terminals.

Control unit 110 may control high-side transistors TH1-TH3 and low-side transistors TL1-TL3 through gate drivers H101-H103 and L101-L103, respectively. A driver, such as gate driver H101 or L101, is an electronic device that includes an input that can accept a low-power driver control signal from another device (e.g., an electronic control unit) and produce a corresponding high-power control signal at its output for controlling, for example, a transistor.

Control of the transistors is relatively simple. High-side gate drivers H101-H103 and low-side gate drivers L101-L103 receive driver control signals (e.g., pulse width modulation signals PWM-H1-PWM-H3 and PWM-L1-PWM-L3) from control unit 110. High-side gate drivers H101-H103 activate high-side transistors TH1-TH3, respectively, by asserting high-power, transistor control signals (e.g., gate control signals) VgH1-VgH3, respectively, when PWM-H1-PWM-H3 signals, respectively, are asserted. Low-side gate drivers L101-L103 activate low-side transistors TL1-TL3, respectively, by asserting high-power, gate control signals VgL1-VgL3, respectively, when PWM-L1-PWM-L3 signals, respectively, are asserted. Each of the transistors TH1-TH3 and TL1-TL3 may conduct current when activated.

Through coordinated activation of transistors TH1-TH3 and TL1-TL3, electrical current flow in windings Wa-Wc can be controlled. FIG. 1B illustrates example gate control signals VgH1-VgH3 and VgL1-VgL3. FIG. 1B is provided only to facilitate a basic understanding of inverter control. In practice, more complicated control signals are typically used.

Control unit 110 controls high-side transistors TH1-TH3 and low-side transistors TL1-TL3 via PWM-H1-PWM-H3 and PWM-L1-PWM-L3 signals, respectively. A control unit may include a microcontroller unit (MCU,) electronic control unit (ECU), field-programmable gate array (FPGA), etc. A control unit may include a central processing unit (CPU), memory that stores instructions executable by the CPU, and peripherals such as timers, input/output (I/O) ports, etc. Control unit 110 can generate PWM-H1-PWM-H3 and PWM-L1-PWM-L3 signals based on executable instructions stored in memory. Gate drivers H101-H103 can generate the VgH1-VgH3 signals based on the PWM-H1-PWM-H3 signals, and gate drivers L101-L103 can generate the VgL1-VgL3 signals based on the PWM-L1-PWM-L3 signals. Control unit 110 can adjust the timing, duty cycle, and frequency of the PWM signals in accordance with the instructions stored in memory.

FIG. 1C is a schematic drawing that illustrates relevant components of an example three-phase rectifier 150 that can convert three-phase AC power into DC power. Inverter 100 and rectifier 150 share similar components. Like inverter 100, each leg of rectifier 150 includes a high-side switch connected to a low-side switch. Each high-side switch includes transistor TH connected to diode DH, and each low-side switch includes transistor TL connected to diode DL. High-side transistors TH1-TH3 may be connected in series with low-side transistors TL1-TL3, respectively, via nodes N1-N3, respectively, which in turn may be connected to respective terminals of inductive elements La-Lc, respectively. Inductive elements La-Lc may be inductors of an LCL filter 162, which may be coupled to a three-phase AC power source 164.

The collector terminals of TH1-TH3 and the cathode terminals of DH1-DH3 may be connected to each other, and to a V+ output terminal, while the emitter terminals of TL1-TL3 and the anode terminals of diodes DL1-DL3 may be connected to each other, and to a V-output terminal.

High-side transistors TH1-TH3 and low-side transistors TL1-TL3 may be controlled by control unit 160 via gate drivers H101-H103 and L101-L103, respectively. Through coordinated activation of high-side and low-side IGBTs, rectifier 150 can provide a controlled DC voltage Vrdc at output terminals V+ and V−, which in turn may be connected to an isolated DC/DC converter or other device. A filter may be connected between the output terminals (e.g., V+ and V−) of a rectifier to smooth the output voltage (e.g., Vrdc) before it is provided to another device such as an isolated DC/DC converter or battery.

While inverter 100 and rectifier 150 appear similar, differences may exist. Rectifier 150 includes control unit 160, which may include a CPU and memory that stores executable instructions that are different from the executable instructions stored in memory of control unit 110 of inverter 100. Like control unit 110, control unit 160 generates PWM-H1-PWM-H3 and PWM-L1-PWM-L3 signals. Gate drivers H101-H103 can generate the VgH1-VgH3 signals based on the PWM-H1-PWM-H3 signals, and gate drivers L101-L103 can generate the VgL1-VgL3 signals based on the PWM-L1-PWM-L3 signals. Control unit 160 can adjust the duty cycle, timing, frequency or other features of the PWM signals.

EVs, industrial machines (e.g., pumps, fans, compressors, etc.), electric vertical take-off and landing (eVTOL) aircraft, data centers, battery energy storage systems, etc., employ power converters that may be large and heavy. A long-felt need exists for smaller and lighter power converters with high power density (i.e., power divided by volume). For example, the October 2017 “Electrical and Electronics Technical Team (EETT) Roadmap” published in part by the US Department of Energy, sets 100 kW/L as the 2025 power density target for EV inverters. The 2017 EETT Roadmap states, “To meet the 2025 EETT R&D target, the power density must be increased by more than 800 percent compared to 2015 EETT R&D technical targets, and 450 percent compared to current on-road technology.”

“Power modules” are disclosed. Power modules include “switch modules” and “diode modules.”

A switch module may include a “power stack” that may include a “switch” sandwiched between a “die substrate” and a “die clip.” The switch may be electrically and thermally connected (e.g., sintered, soldered, etc.) to the die substrate and to the die clip. A switch may include one, two or more power transistors (hereinafter “transistors”). Transistors in a switch may be electrically connected in series, in parallel, in anti-parallel, or back-to-back. A switch may also include one or more power diodes (hereinafter “diodes”). A diode may be electrically connected in parallel, anti-parallel, or in series with one or more transistors in a switch. A switch may transmit 1, 5, 10, 20, 50, 100, 200, 400, 600, 800 amperes (A) or more. A range for a value, like switch current, may be expressed with a starting value. For example the range for a value may may be expressed as 1, 5, 10 A or more, which means the value can be 1 A or more, 5 A or more, or 10 A or more, or the range of a value may be expressed as 50, 20, 15 A or less, which means the value can be 50 A or less, 20 A or less, or 15 A or less.

Switch modules may include one or more additional components such as control-terminal drivers (hereinafter “drivers” such as gate drivers), resistors, capacitors, current sensors, temperature sensors, voltage sensors, voltage regulators, power management integrated circuits (PMICs), etc. PMICs may be electronic devices that can provide supply voltages needed by respective drivers to control their respective transistors. PMICs may provide supply voltages to other components.

A diode module may include a power stack that may include one or more diodes sandwiched between a die substrate and a die clip. The one or more didoes may be electrically and thermally connected (e.g., sintered, soldered, etc.) to the die substrate and to the die clip. A diode module may include multiple diodes electrically connected in parallel or in series. A diode module may transmit 1, 5, 10, 20, 50, 100, 200, 400, 600, 800 amperes (A) or more. Diode modules may also include one or more additional components such as resistors, capacitors, current sensors, temperature sensors, voltage sensors, etc.

Die substrates and die clips are electrically and thermally conductive elements or structures. Die substrates and die clips may be formed from metal. Die substrates and die clips may be platelike in shape. Die substrates and die clips may have substantially flat die substrate terminals and die clip terminals, respectively. Die substrate and die clip terminals may be referred to as die substrate and die clip electrodes, or as die substrate and die clip pads.

The die substrate terminal and die clip terminal of a power stack can be electrically and thermally connected to substantially flat surfaces of first and second bus bars, respectively. Electrical current can flow along a path between the first and second bus bars through a power stack consisting of the die clip, the die substrate, and the switch sandwiched between the die clip and the die substrate. The path may be essentially linear between the first and second bus bars. Heat can flow along the path concurrently with the electrical current. Thus, heat generated by a switch in a power stack connected between the first and second bus bars, can flow up to the first bus bar along an essentially linear path through the die substrate, and flow down to the second bus bar along an essentially linear path through the die clip. In this manner, switches of power stacks can be “double-side cooled.”

“Packaged power modules” are disclosed. Packaged power modules may include packaged switch modules and packaged diode modules. Packaged power modules may include a case as more fully described below.

Packaged switch modules may contain more than one switch module. A packaged switch module with just one switch module is called a “packaged switch.” A packaged switch module with two switch modules is called a “packaged half bridge.” Switches may or may not be electrically connected inside a packaged half bridge.

Packaged diode modules (hereinafter also referred to as packaged diodes) may contain more than one diode module.

Metal bus bars are disclosed. Transistors, diodes, capacitors, and/or other devices can be electrically and thermally connected to metal bus bars (hereinafter bus bars) of this disclosure as noted above. A bus bar may be rigid.

Metal heat sinks are disclosed. Transistors, diodes, capacitors, and/or other devices can be thermally connected to metal heat sinks (hereinafter heat sinks) of this disclosure. Transistors, diodes, capacitors, and/or other devices may or may not be electrically connected to metal heat sinks (hereinafter heat sinks) of this disclosure. A heat sink may be rigid.

A bus bar or heat sink of this disclosure may include one or more internal channels or hollow sections through which fluid may flow. Bus bar or heat sink channels may be circular, oval, square, rectangular, etc., from one of the bus bar or heat sink to the other end of the bus bar or heat sink. A fluid flowing through a bus bar or heat sink channel may be thermally connected to transistors, diodes and/or other devices through the bus bar or heat sink.

A bus bar may be formed (e.g., cast, sintered, soldered, welded, etc.) around one or more tubes through which fluid may flow. A tube may be configured to electrically isolate fluid flowing through it from a bus bar in which the tube is contained. The fluid flowing through a tube may be thermally connected to transistors, diodes and/or other devices that are electrically and thermally connected to the bus bar in which the tube is contained.

A heat sink may be formed (e.g., cast, sintered, soldered, welded, etc.) around one or more tubes through which fluid may flow. The fluid flowing through a tube may be thermally connected to transistors, diodes and/or other devices that are thermally connected to the heat sink in which the tube is contained.

Tubes may extend linearly from end to end. A tube may be circular, oval, square, rectangular, etc., in shape from end to end. A tube may have a circular, oval, square, rectangular, etc., shaped outer surface. A Tube may include one or more channels or hollow portions through which fluid may flow through the tube. A tube channel may be circular, oval, square, rectangular, etc., from end to end.

Tubes may be received in respective channels of a bus bar or heat sink. A channel of a bus bar or heat sink, or a tube within the channel, may be a part of a fluid circuit through which fluid may flow. A fluid circuit may also include a pump, radiator, manifold, or other components.

Power converters (hereinafter also referred to as converters), solid-state circuit breakers, solid-state contactors, and other power apparatuses of this disclosure may employ the packaged switches, packaged diodes, heat sinks, and/or bus bars of this disclosure. Packaged switches, packaged diodes, heat sinks, and/or bus bars of this disclosure may be used in other power apparatuses.

The disclosed power converters, solid-state circuit breakers, solid-state contactors, packaged switches, packaged diodes, etc., provide one or more advantages. For example, the power density of one or more of the disclosed inverters can meet or exceed the power density target of 100 kW/L as set forth in the 2017 EETT Roadmap mentioned above. A power converter such as an inverter of the present disclosure may use fewer transistors than prior art inverters with similar power ratings. Packaged switches of this disclosure may have reduced parasitic inductance, which can lower voltage spikes across transistors during switching.

In general, packaged switches and packaged diodes may be rectangular cuboids in shape with six sides: top, bottom, front, back, left, and right. A packaged switch or packaged diode may include one or more “connector-leads” or “pins” extending from one or more sides.

FIGS. 2A-1-2E-3 illustrate example packaged switches 247 with connector-leads 288dc and 288ds and example packaged diodes 245 with connector-leads 288dc and 288ds. Packaged switches 247 may also include one or more connector-leads 288g as shown. In alternative embodiments, each of the packaged switches 247 and packaged diode 245 may lack a connector-lead 288dc, a connector-lead 288ds, or both.

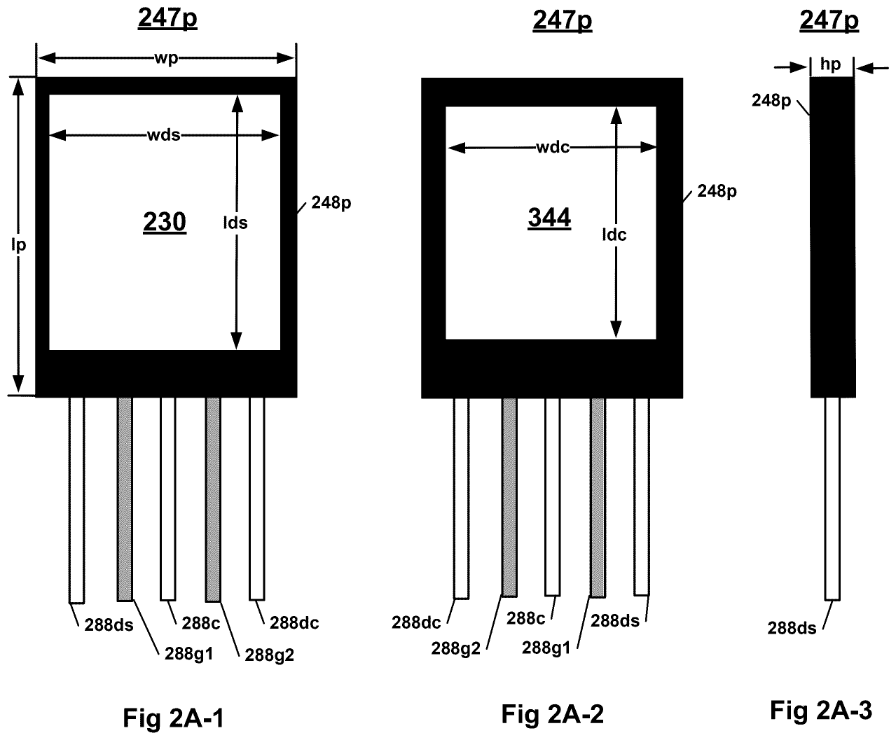

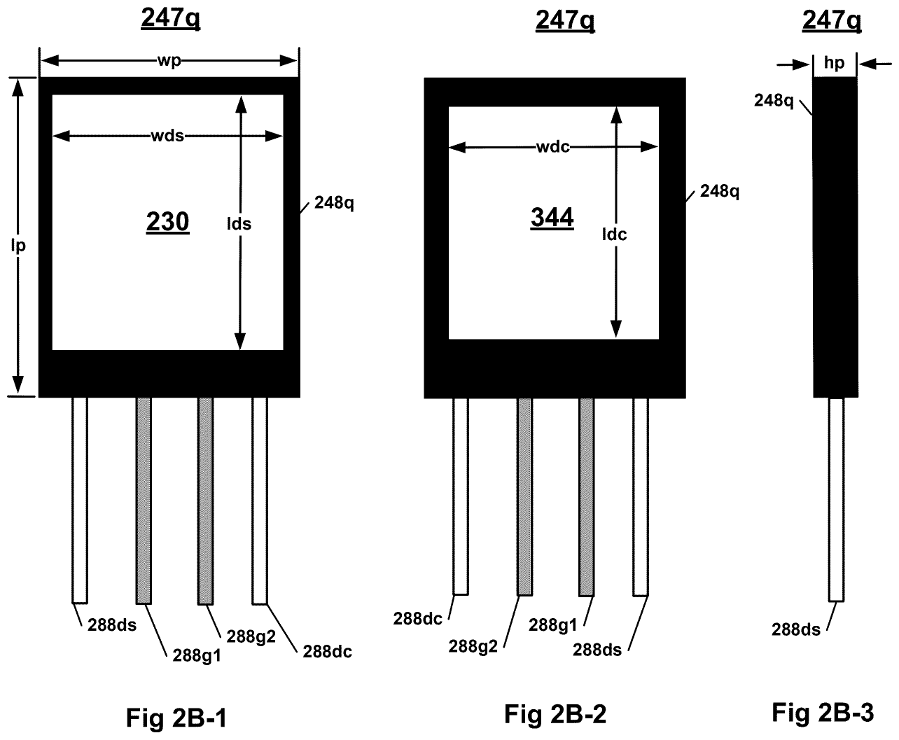

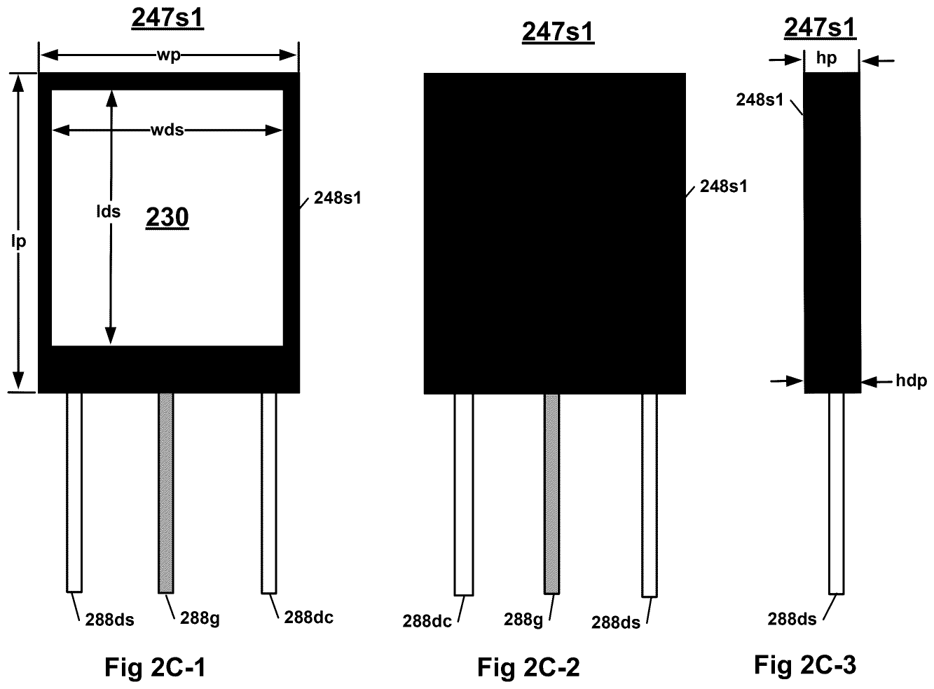

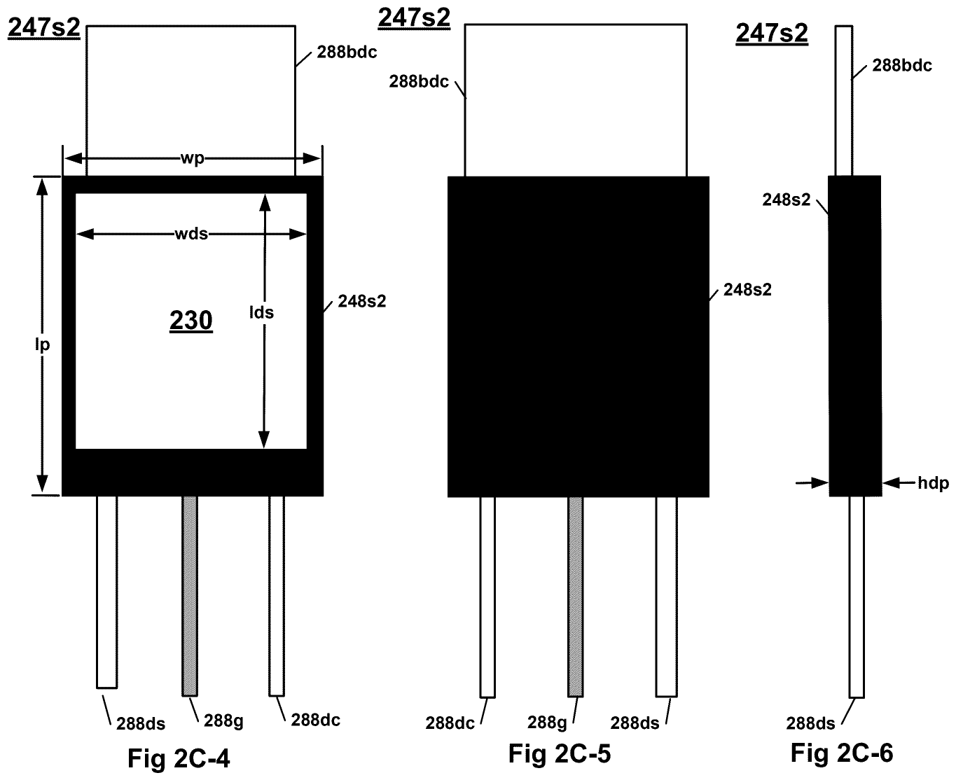

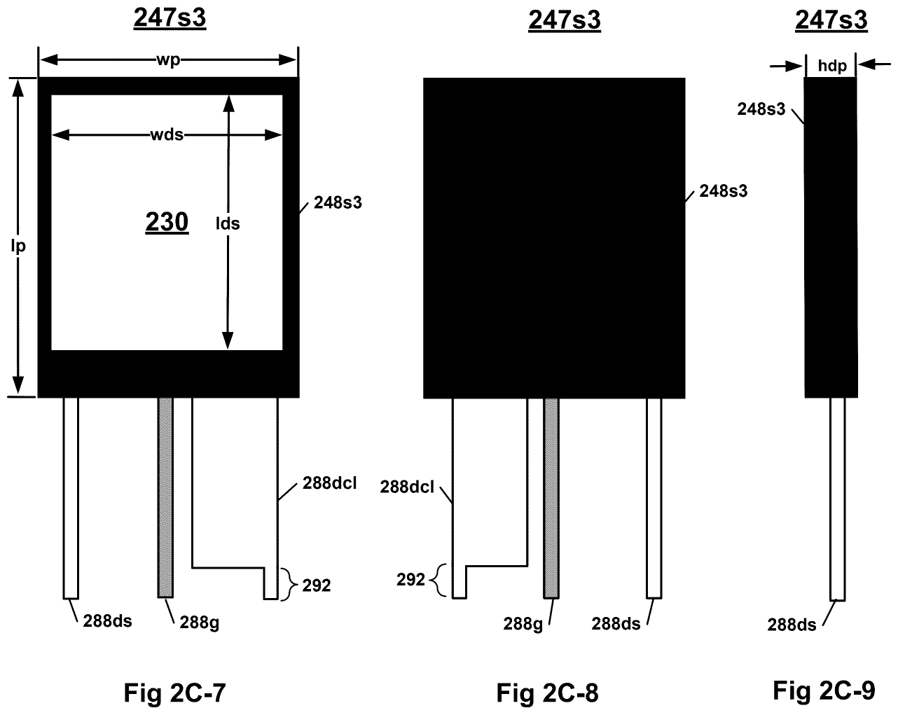

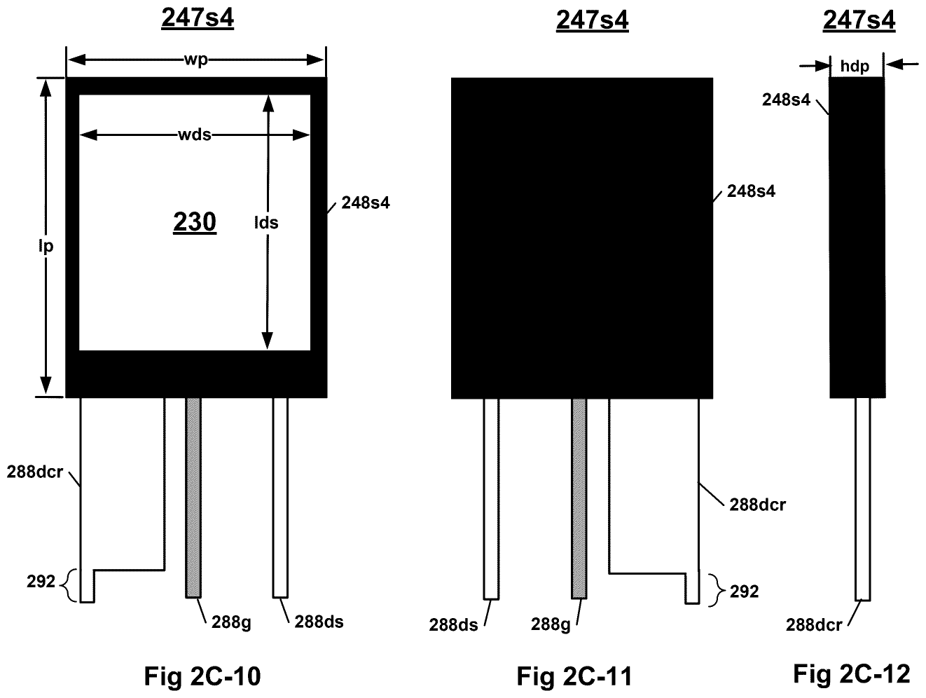

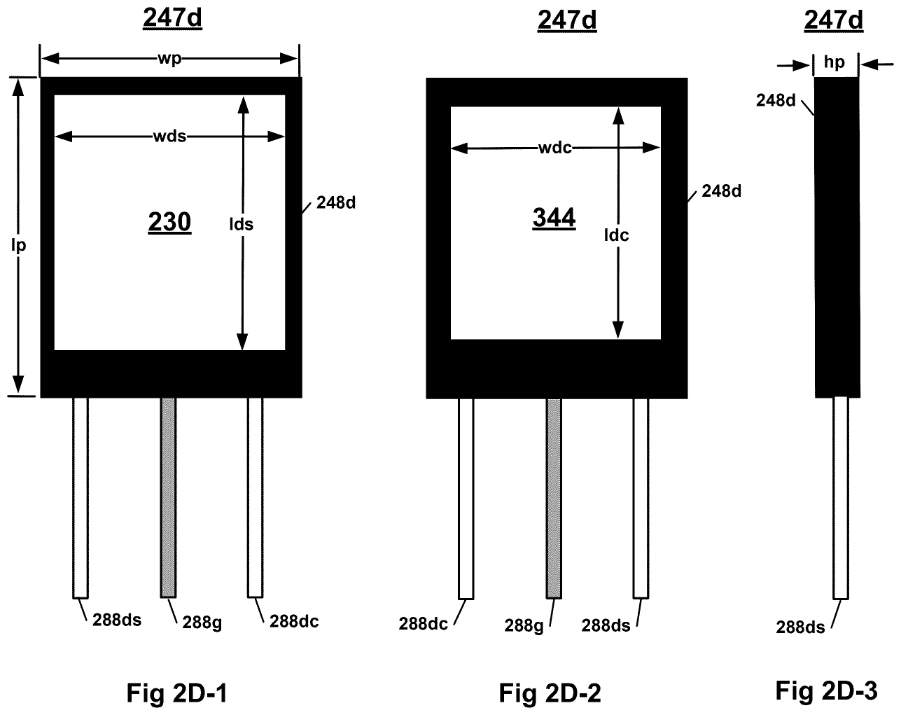

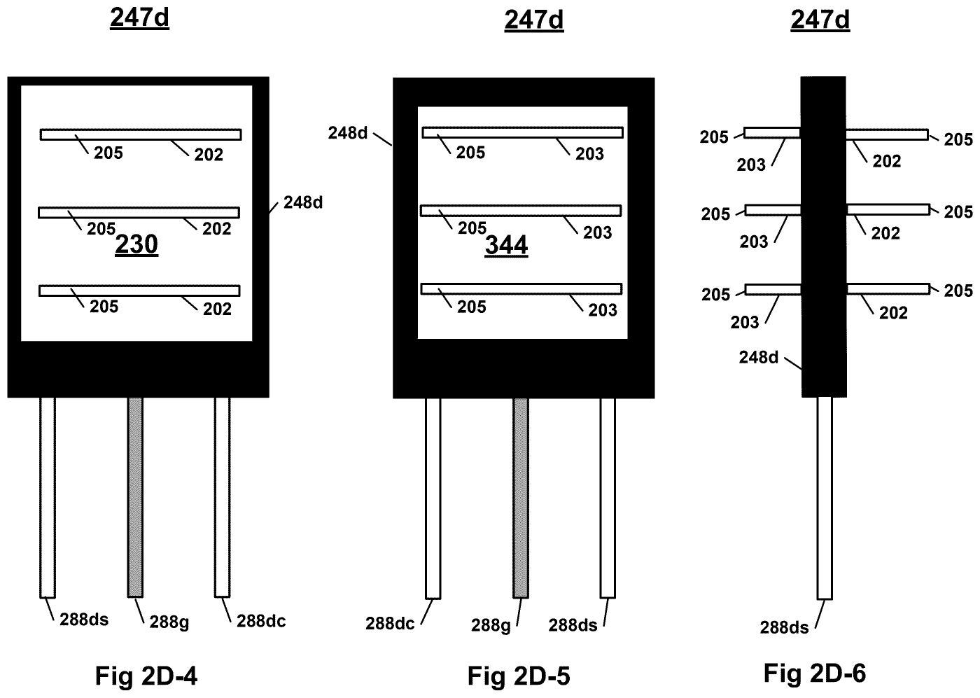

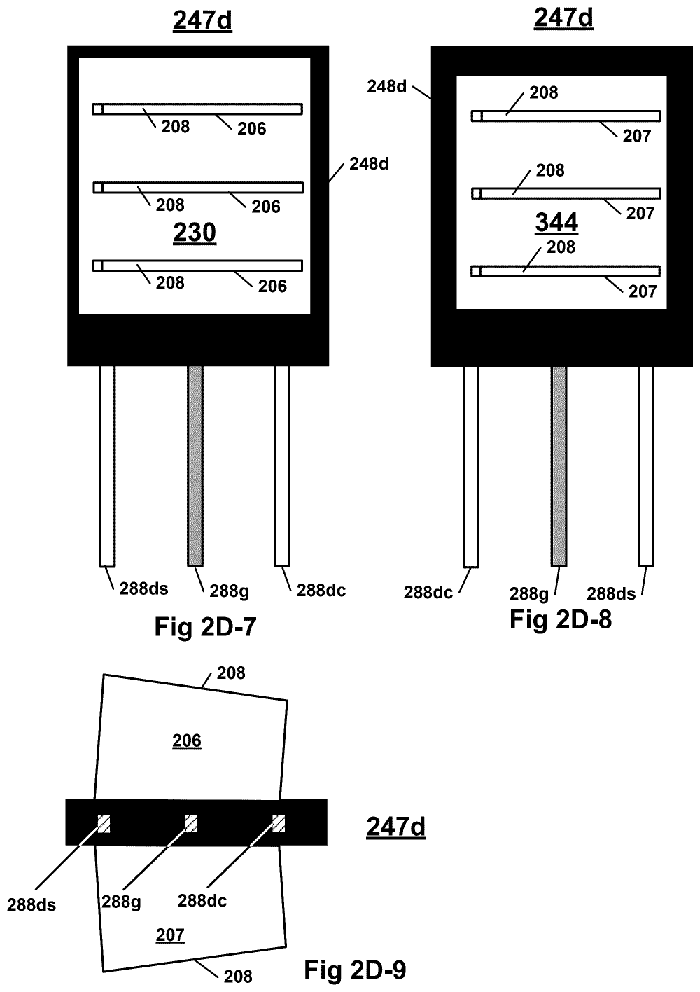

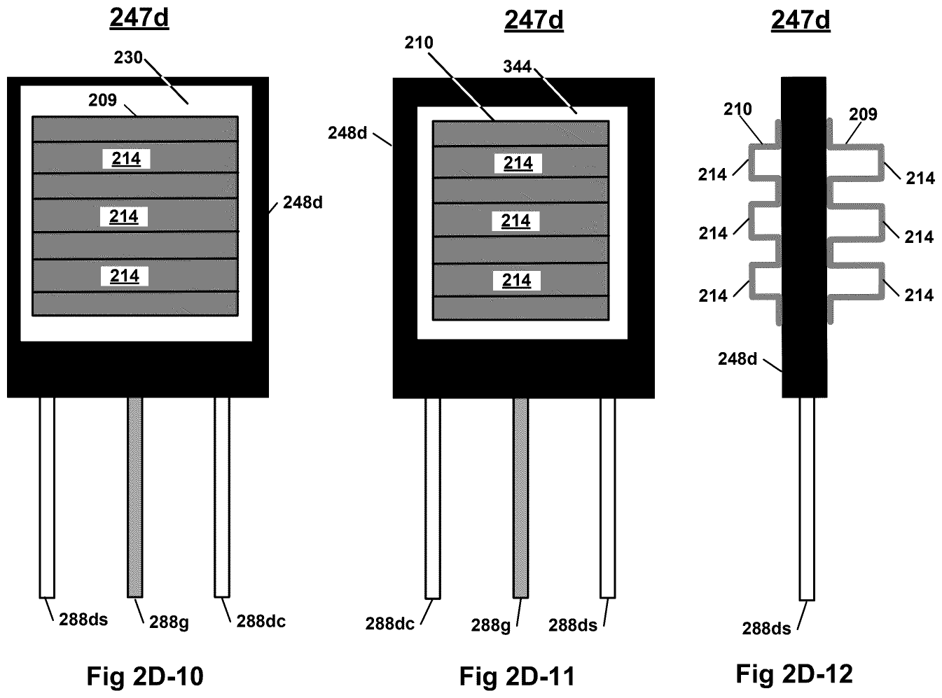

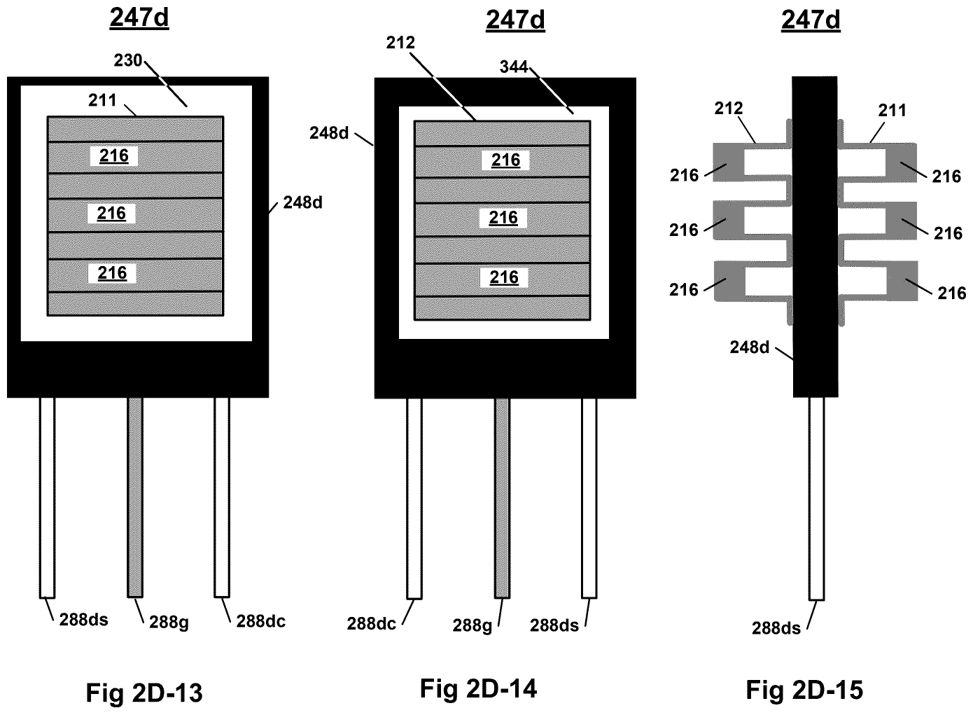

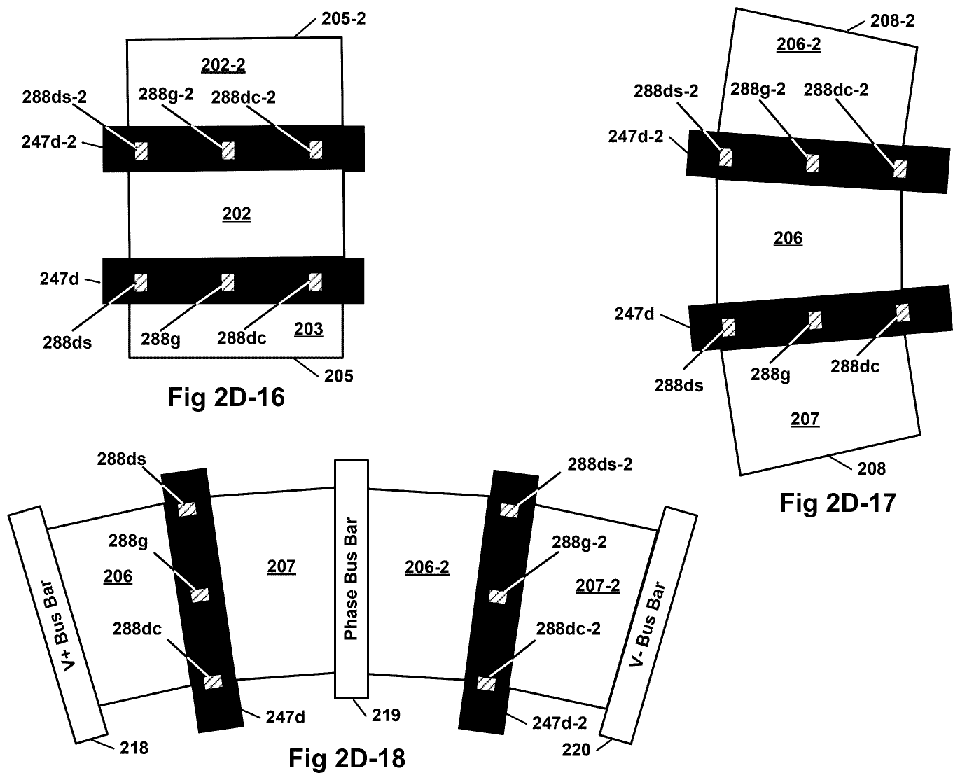

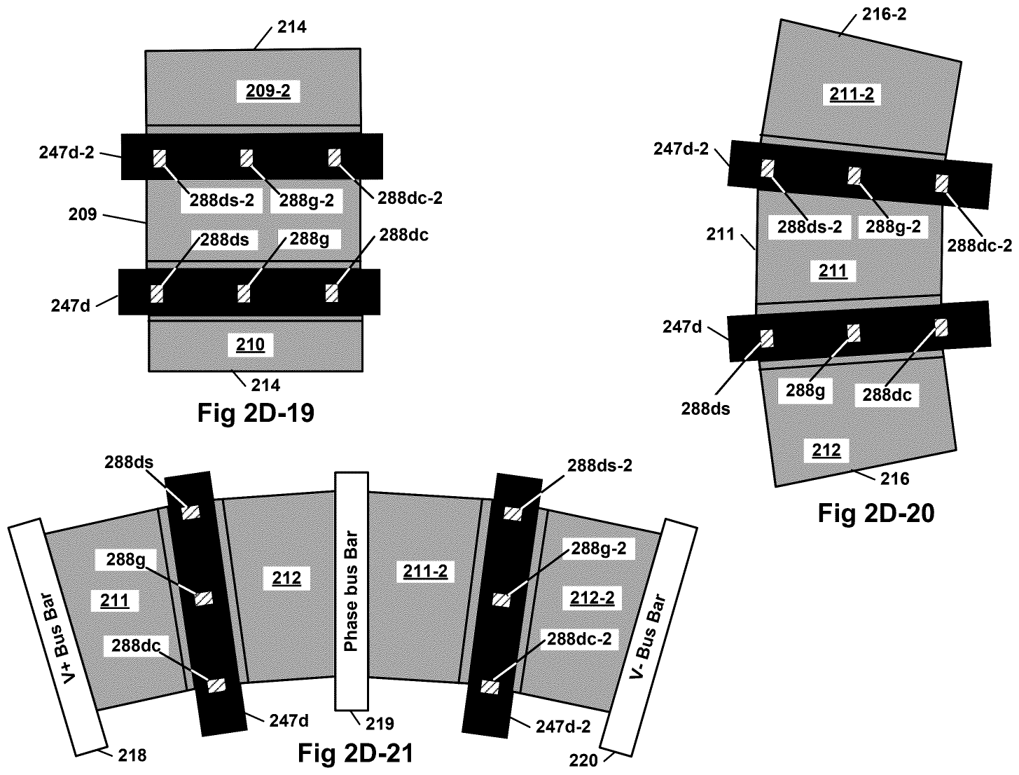

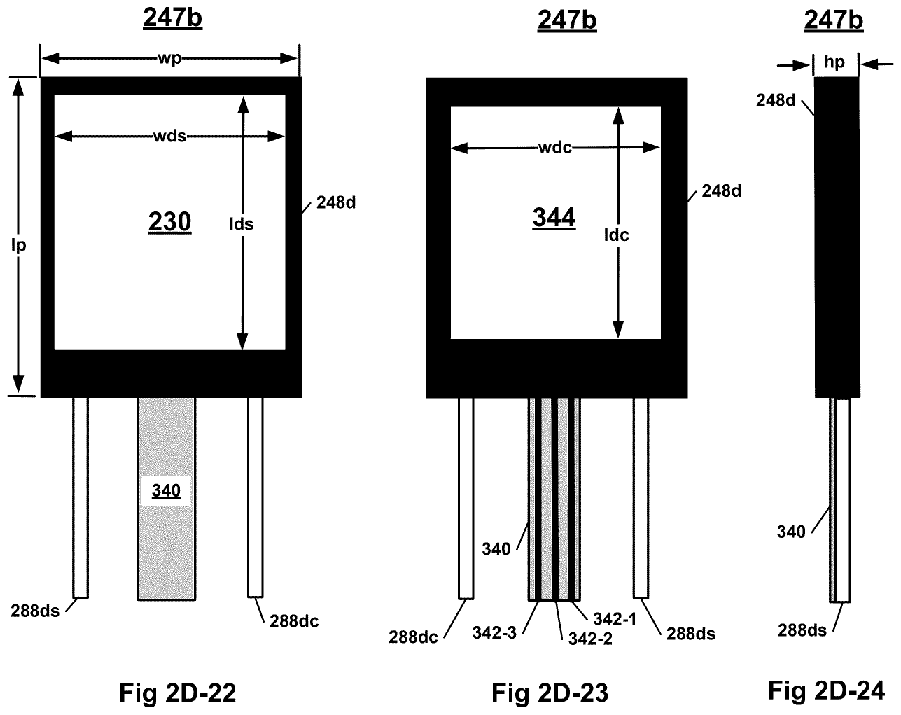

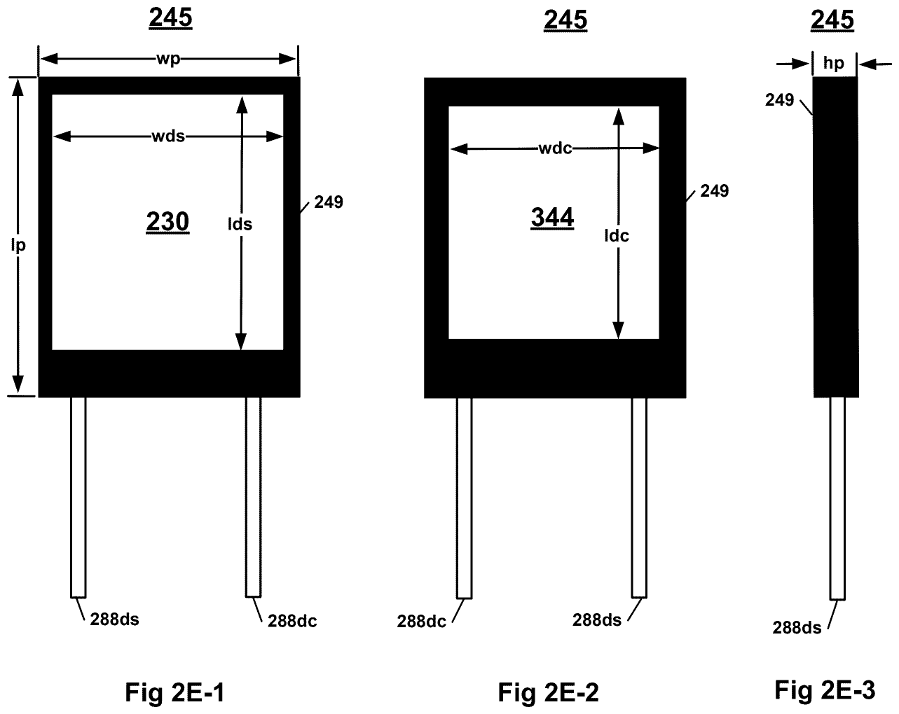

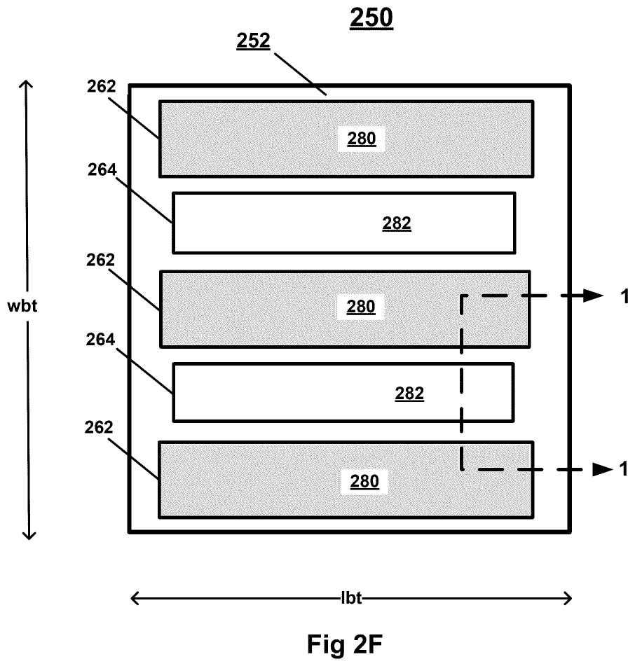

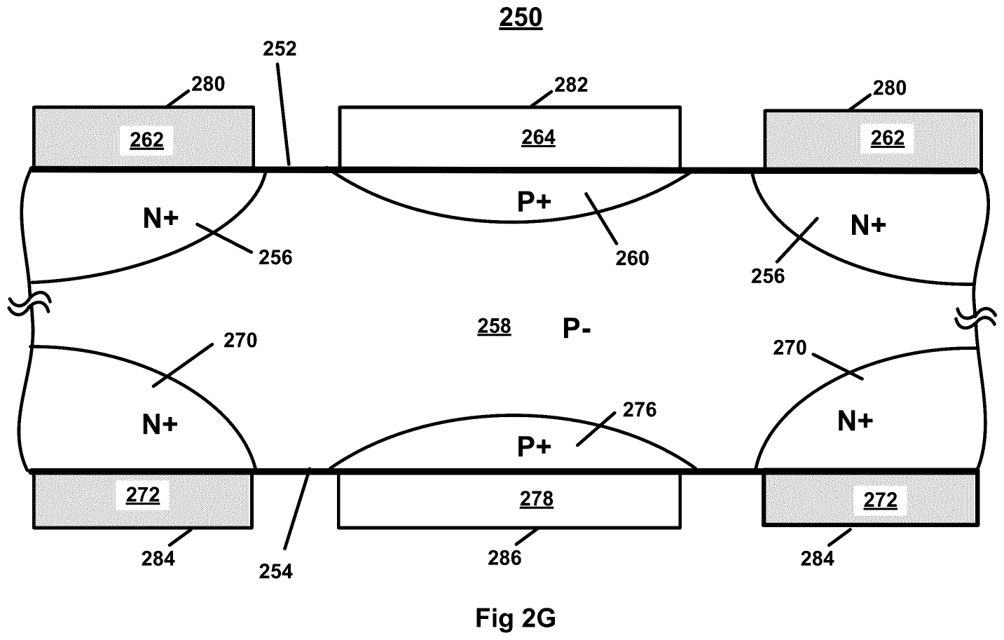

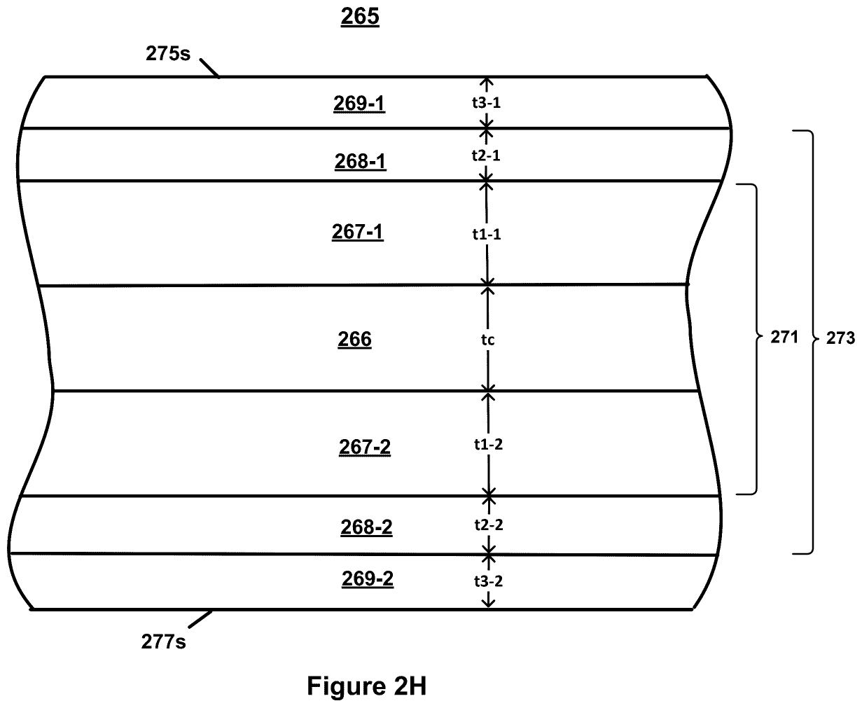

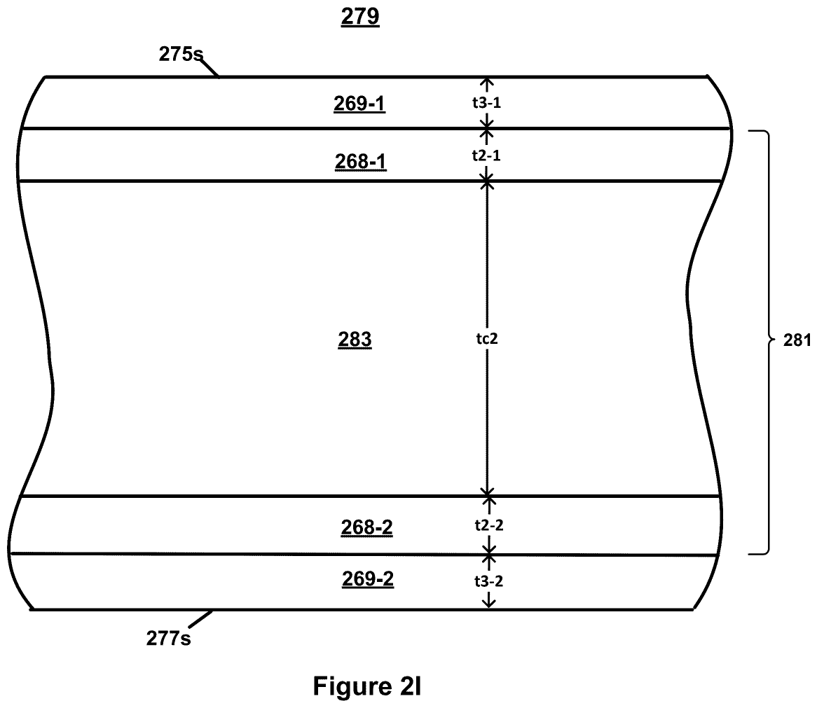

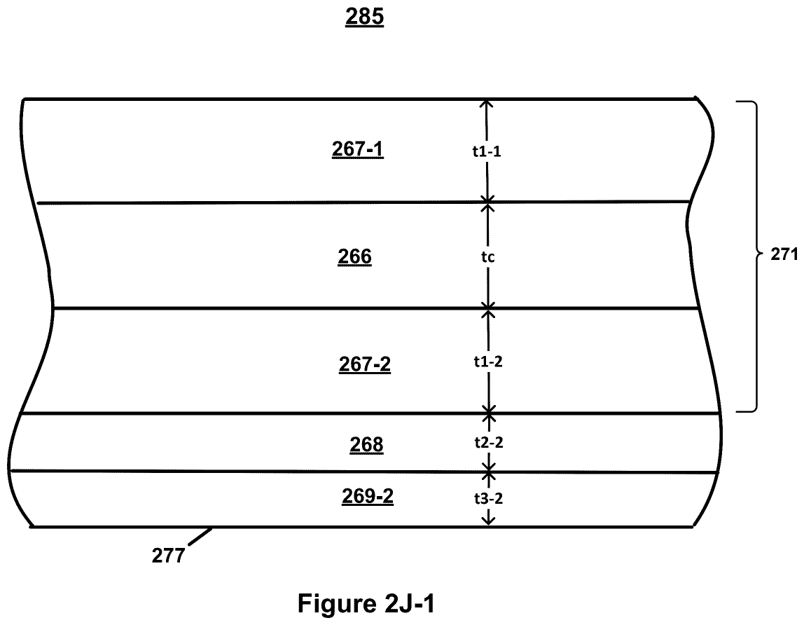

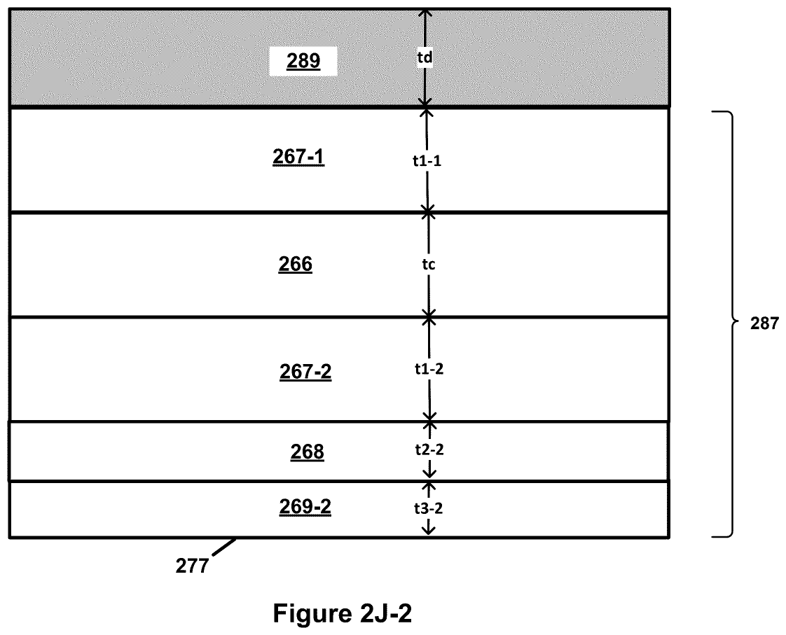

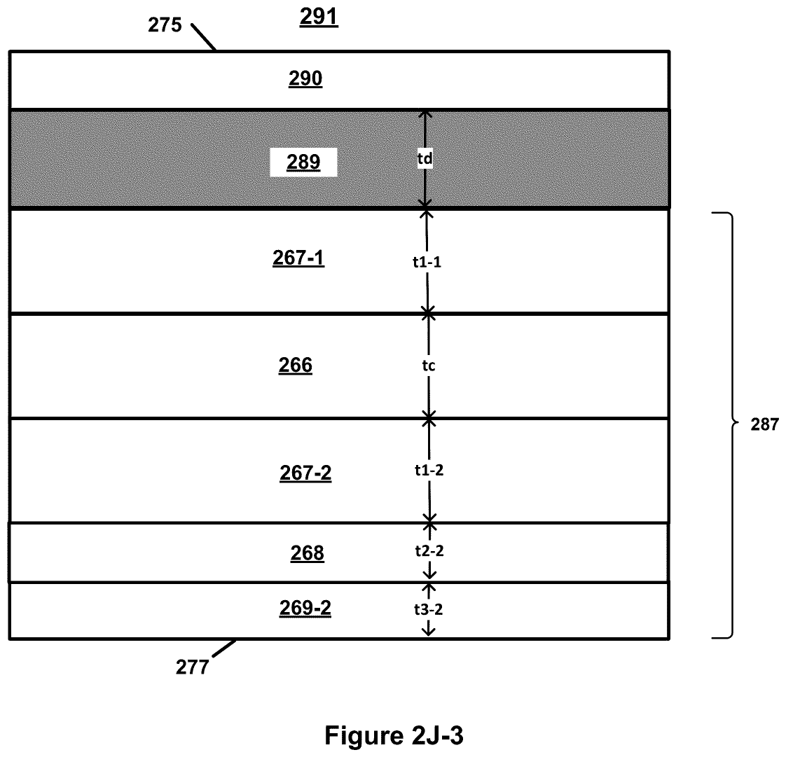

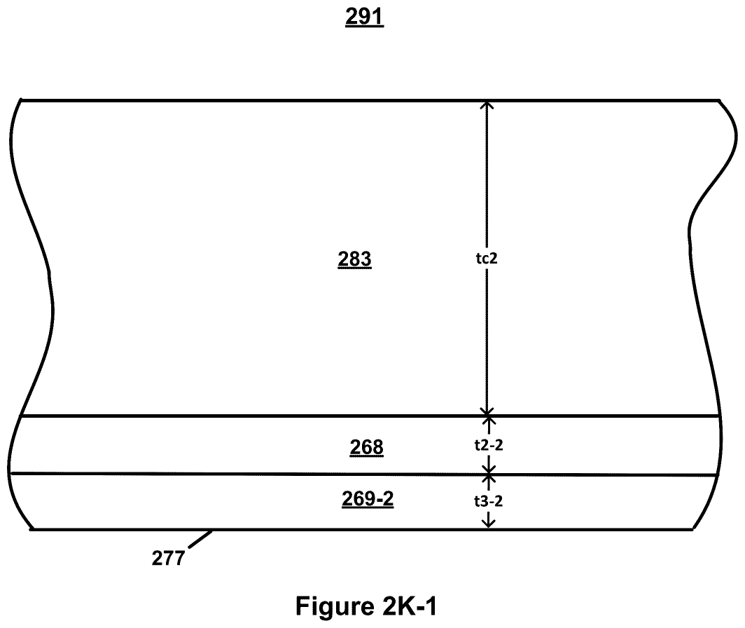

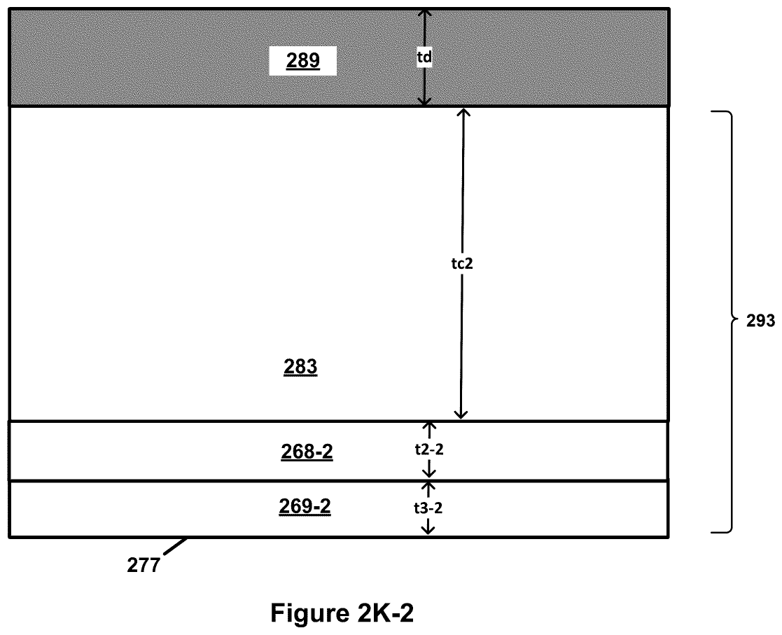

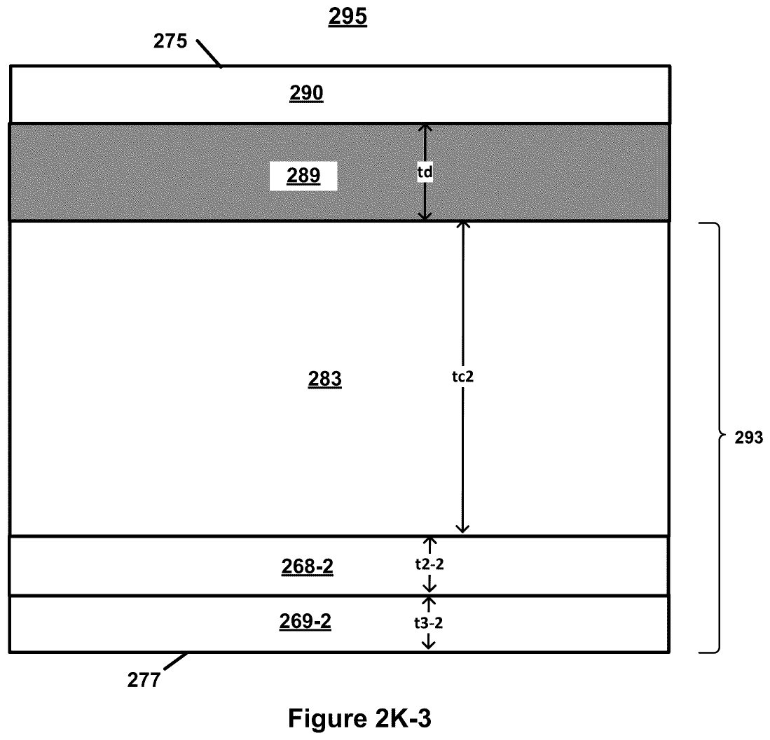

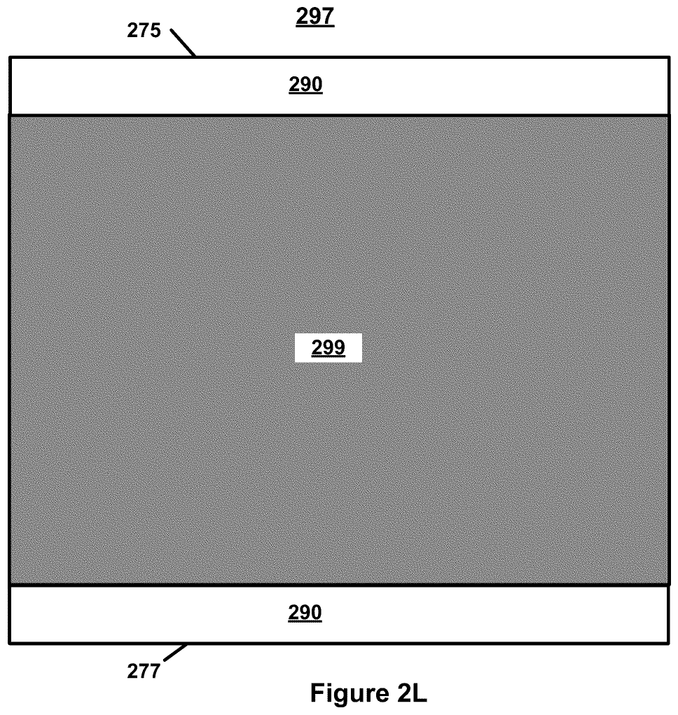

FIGS. 2A-1, 2A-2, and 2A-3 are top, bottom, and side views, respectively, of an example packaged switch 247p. FIGS. 2B-1, 2B-2 and 2B-3 are top, bottom, and side views, respectively, of an example packaged switch 247q. FIGS. 2C-1, 2C-2 and 2C-3 are top, bottom, and side views, respectively, of an example packaged switch 247s1. FIGS. 2C-4, 2C-5 and 2C-6 are top, bottom, and side views, respectively, of an example packaged switch 247s2. FIGS. 2C-7, 2C-8 and 2C-9 are top, bottom, and side views, respectively, of an example packaged switch 247s3. FIGS. 2C-10, 2C-11 and 2C-12 are top, bottom, and side views, respectively, of an example packaged switch 247s4. FIGS. 2D-1, 2D-2 and 2D-3 are top, bottom, and side views, respectively, of an example packaged switch 247d. FIGS. 2D-4, 2D-5, and 2D-6 are top, bottom, and side views, respectively, of packaged switch 247d with metal cooling-fins. FIGS. 2D-7, 2D-8, and 2D-9 are top, bottom, and side views, respectively, of packaged switch 247d with metal cooling-fins. FIGS. 2D-10, 2D-11, and 2D-12 are top, bottom, and side views, respectively, of packaged switch 247d with metal cooling-fins. FIGS. 2D-13, 2D-14, and 2D-15 are top, bottom, and side views, respectively, of packaged switch 247d with metal cooling-fins. FIGS. 2D-22, 2D-23 and 2D-24 are top, bottom, and side views, respectively, of an example packaged switch 247b. FIGS. 2E-1, 2E-2, and 2E-3 are top, bottom, and side views, respectively, of an example packaged diode 245.

Packed switches 247, including packaged switch 247d, and packaged diodes 245 may have oppositely facing, substantially flat-surfaced die substrate and die clip terminals. Stated differently, substantially flat-surfaced die substrate and die clip terminals can be contained in planes that are substantially parallel to each other and located on opposite sides of a packaged switch or packaged diode. Packed switches 247 and packaged diode 245 of FIGS. 2A1-2E3 are shown with example, substantially flat-surfaced die substrate terminals 230 and substantially flat-surfaced die clip terminals 344, which are contained in substantially parallel planes on opposite sides. As will be more fully described below, connector-lead 288ds and connector-lead 288dc may be electrically connected to die substrate terminal 230 and die clip terminal 344, respectively.

Several packaged switches 247d are shown in FIGS. 2D-4-2D-15 with metal cooling-fins that are electrically and thermally attached to die substrate terminals 230 and die clip terminals 344. Alternatively, metal cooling-fins may be electrically and thermally attached to the die substrate terminal 230, or die clip terminal 344, but not both. Fluid can flow over surfaces of a metal cooling-fin. Metal cooling-fins may take many different forms. Cooling-fins may have opposite facing surfaces that are substantially flat. Cooling-fins may have non-planar surfaces each with one or more protrusions, depressions, or channels to promote turbulent fluid flow.

FIGS. 2D-4, 2D-5, and 2D-6 are top, bottom, and side views, respectively, of a packaged switch 247d with rectangular-shaped metal cooling-fins 202 and 203 having narrow flat end surfaces (not shown), which are electrically and thermally attached (e.g., welded, soldered, sintered, etc.) to the die substrate terminal 230 and die clip terminal 344, respectively. Cooling-fins can be attached to a die substrate terminal 230 or a die clip terminal 344 before or after the die clip or die substrate is incorporated into a packaged switch 247. Cooling-fins could be clamped or press-fitted against die substrate terminals 230 or die clip terminals 344. Fins, such as fins 202 or 203, could be integrally formed with a die clip or a die substrate. For example, a die substrate or die clip with fins could be extruded or cast from metal to create a unitary device. Cooling-fins 202 and 203 may have equal height, width, and/or length. Cooling-fins 202 and 203 may be parallel to each other. Cooling-fins may be attached to a die substrate terminal 230 or die clip terminal 344 at an angle that is different from that shown in the figures. For example, cooling-fins, such as cooling-fins 202 and 203, may be rotated 90 degrees so that they are parallel with connector-leads 288, such as connector-leads 288dc, 288ds, and 288g. Or cooling-fins, such as cooling-fins 202 and 203, may be rotated less than 90 degrees to form a non-zero angle with connector-leads 288, such as connector-leads 288dc, 288ds, and 288g. Cooling-fins 202 and 203 are shown in FIGS. 2D-4-2D-6 with equal width (e.g., 5.0, 2.5, 1.0, 0.5 mm or less). In FIGS. 2D-4-2D-6, the height of cooling-fins 203 is less than the height of cooling-fins 202, and the length of cooling-fins 202 is equal to the length of cooling-fins 203. FIGS. 2D-4-2D-6 show an equal number (i.e. three) of cooling-fins 202 and 203, it being understood that more than three cooling-fins can be attached to die substrate terminal 230, die clip terminal 344, or both. The number of cooling-fins 202 may exceed the number of cooling-fins 203. Flat-surface outer edges 205 of cooling-fins 202 may be contained in a first plane so that they can be electrically and thermally attached (e.g., welded, solder, sintered, press-fitted, etc.) to a flat surface of: a first bus bar, or; a die substrate terminal 230 or die clip terminal 344 of either a first packaged switch 247 or a packaged diode 245. Flat-surfaced outer edges 205 of cooling-fins 203 may be contained in a second plane so that they may be electrically and thermally attached (e.g., welded, solder, sintered, press-fitted, etc.) to a flat surface of: a second bus bar, or; a die substrate terminal 230 or die clip terminal 344 of either a second packaged switch 247 or a packaged diode 245. The first and second planes can be parallel to each other. Cooling-fins, such as cooling-fins 202, can be replaced with a row of metal pins (e.g., cylindrical pins) of equal or unequal length, each of which extends between first and second ends, where a flat surfaced first end is electrically and thermally attached (e.g., soldered, welded, sintered, etc.) to the die substrate terminal 230. Each of cooling-fins 203 can be replaced with a row of metal pins (e.g., cylindrical pins) of equal or unequal length, each of which extends between first and second ends, where the flat end surface of each first end is electrically and thermally attached (e.g., soldered, welded, sintered, etc.) to the die clip terminal 344. Cooling-fins 202 and 203 can be attached to die substrate and die clip terminals 230 and 344, respectively, of packaged switches 247p or 247q. Cooling-fins 202 can be attached to die substrate terminals 230 of packaged switches 247s. Cooling-fins 202 and 203 can be attached to die substrate and die clip terminals 230 and 344, respectively, or diode packages 245.

FIGS. 2D-7, 2D-8, and 2D-9 are top, bottom, and front views, respectively, of a packaged switch 247d with trapezoidal shaped metal cooling-fins 206 and 207 with narrow flat end surfaces (not shown) that are electrically and thermally attached (e.g., welded, soldered, sintered, etc.) to the die substrate terminal 230 and die clip terminal 344, respectively. Alternatively, cooling-fins 206 or 207 can be integrally formed with die substrates or die clips. Cooling-fins 206 and 207 may have the same dimensions and shape. Flat surfaced, narrow ends of cooling-fins 206 and 207 attached to die substrate terminal 230 and die clip terminal 344, respectively, may be parallel to each other as shown. Cooling-fins 206 and 207 are shown in FIGS. 2D-7-2D-9 with equal width (e.g., 5.0, 2.5, 1.0, 0.5 mm or less). FIGS. 2D-7-2D-9 show an equal number (i.e. three) of cooling-fins 206 and 207, it being understood that more than three cooling-fins can be attached to die substrate terminal 230, die clip terminal 344 or both. The number of cooling-fins 206 may exceed the number of cooling-fins 207. Flat-surfaced outer edges 208 of cooling-fins 206 may be contained in a first plane so that they can be electrically and thermally attached (e.g., welded, solder, sintered, press-fitted, etc.) to a flat surface of: a first bus bar, or; a die substrate terminal 230 or die clip terminal 344 of either a first packaged switch 247 or a packaged diode 245. Flat-surfaced outer edges 208 of cooling-fins 207 may be contained in a second plane so that they may be electrically and thermally attached (e.g., welded, solder, sintered, press-fitted, etc.) to a flat surface of: a second bus bar, or; a die substrate terminal 230 or die clip terminal 344 of either a second packaged switch 247 or a packaged diode 245. The first and second planes may be at an angle to each other. Cooling-fins 206 and 207 may be rotated by 90 degrees so that they are parallel with connector-leads 288. Or cooling-fins 206 and 207 may be rotated less than 90 degrees to form a non-zero angle with connector-leads 288. Cooling-fins 206 and 207 can be attached to die substrate and die clip terminals 230 and 344, respectively, of packaged switches 247p or 247q. Cooling-fins 206 can be attached to die substrate terminals 230 of packaged switches 247s. Cooling-fins 206 and 207 can be attached to die substrate and die clip terminals 230 and 344, respectively, or diode packages 245.

FIGS. 2D-10, 2D-11, and 2D-12 are top, bottom, and side views, respectively, of packaged switch 247d with folded metal cooling-fins 209 and 210 having flat surfaces (not shown) that are electrically and thermally attached (e.g., welded, soldered, sintered, etc.) to the die substrate terminal 230 and die clip terminal 344, respectively. Alternatively, cooling-fins 209 or 210 can be integrally formed with die substrates or die clips. Cooling-fins 209 and 210 may have equal size and shape. As seen in FIG. 2D-12, the height of cooling-fins 210 is less than the height of cooling-fins 209. Cooling-fins 209 and 210 may be parallel to each other as shown. Cooling-fins 209 and 210 may be rotated by 90 degrees so that they are parallel with connector-leads 288. Or cooling-fins 209 and 210 may be rotated less than 90 degrees to form a non-zero angle with connector-leads 288. Cooling-fins 209 and 210 are shown in FIGS. 2D-10-2D-12 with equal width (e.g., 5.0, 2.5, 1.0, 0.5 mm or less). FIGS. 2D-10-2D-12 show an equal number (i.e. twelve) of approximately 90-degree folds, it being understood that more than twelve folds are contemplated at the same 90-degree angle or at different angles. Flat-surfaced outer edges 214 of cooling-fins 209 may be contained in a first plane so that they can be electrically and thermally attached (e.g., welded, solder, sintered, press-fitted, etc.) to a flat surface of: a first bus bar, or; a die substrate terminal 230 or die clip terminal 344 of either a first packaged switch 247 or a packaged diode 245. Flat-surfaced outer edges 214 of cooling-fins 210 may be contained in a second plane so that they may be electrically and thermally attached (e.g., welded, solder, sintered, press-fitted, etc.) to a flat surface of: a second bus bar, or; a die substrate terminal 230 or die clip terminal 344 of either a second packaged switch 247 or a packaged diode 245. The first and second planes may be parallel to each other. Cooling-fins 209 and 210 can be attached to die substrate and die clip terminals 230 and 344, respectively, of packaged switches 247p or 247q. Cooling-fins 209 can be attached to die substrate terminals 230 of packaged switches 247s. Cooling-fins 209 and 210 can be attached to die substrate and die clip terminals 230 and 344, respectively, or diode packages 245.

FIGS. 2D-13, 2D-14, and 2D-15 are top, bottom, and side views, respectively, of packaged switch 247d with folded metal cooling-fins 211 and 212 having substantially flat surfaces (not shown) that are electrically and thermally attached (e.g., welded, soldered, sintered, etc.) to the die substrate terminal 230 and die clip terminal 344, respectively. Alternatively, cooling-fins 211 or 212 can be integrally formed with die substrates or die clips. Cooling-fins 211 and 212 may have the same dimensions and shape. Cooling-fins 211 and 212 are shown in FIGS. 2D-13-2D-15 with equal width (e.g., 5.0, 2.5, 1.0, 0.5 mm or less). FIGS. 2D-13-2D-15 show an equal number (i.e. twelve) of approximately 90-degree folds, it being understood that more than twelve 90-degree folds it being understood that more than twelve folds are contemplated at the same 90-degree angle or at different angles. Flat-surfaced outer edges 216 of cooling-fins 211 may be contained in a first plane so that they can be electrically and thermally attached (e.g., welded, solder, sintered, press-fitted, etc.) to a flat surface of: a first bus bar, or; a die substrate terminal 230 or die clip terminal 344 of either a first packaged switch 247 or packaged diode 245. Flat-surfaced outer edges 216 of cooling-fins 212 may be contained in a second plane so that they may be electrically and thermally attached (e.g., welded, solder, sintered, press-fitted, etc.) to a flat surface of: a second bus bar, or; a die substrate terminal 230 or die clip terminal 344 of either a second packaged switch 247 or packaged diode 245. The first and second planes may be at an angle to each other. Cooling-fins 211 and 212 may be rotated by 90 degrees so that they are parallel with connector-leads 288. Or cooling-fins 211 and 212 may be rotated less than 90 degrees to form a non-zero angle with connector-leads 288. Cooling-fins 211 and 212 can be attached to die substrate and die clip terminals 230 and 344, respectively, of packaged switches 247p or 247q. Cooling-fins 211 can be attached to die substrate terminals 230 of packaged switches 247s. Cooling-fins 211 and 212 can be attached to die substrate and die clip terminals 230 and 344, respectively, or diode packages 245.

FIGS. 2D-4-2D-15 show fins attached to die substrate terminals 230 and die clip terminals 344 of packaged switches 247d with cases 248d. Fins, such as fins 202 and 203, can be attached to die substrate terminals 230 and die clip terminals 344 of packaged switches 247 that lack cases 248d.

FIG. 2D-16 illustrates a front view of the finned packaged switch 247d shown in FIGS. 2D-4, 2D-5, and 2D-6 with edge surfaces 205 (not shown) of fins 202 electrically and thermally attached (e.g., welded, soldered, sintered, press-fitted, etc.) to a die clip terminal of a second instance of packaged switch 247d (i.e., 247d-2). FIG. 2D-16 also shows one fin of a set (e.g., two, three or more) of metal fins 202-2 with end surfaces (not shown) electrically and thermally attached (e.g., welded, soldered, sintered, etc.) to a die substrate terminal of packaged switch 247d-2. The fins may be positioned at a different angle. For example, fins 202 and 203 in FIG. 2D-16 could be rotated by 90 degrees so that they are parallel with connector-leads 288. Or the fins may be rotated less than 90 degrees to form a non-zero angle with connector-leads 288. Although not shown, connector lead 288ds-2 may be electrically connected directly or indirectly to a V+ terminal of a DC voltage source, connector lead 288dc-2 may be electrically connected to connector lead 288ds, and connector lead 288dc may be electrically connected directly or indirectly to a V-terminal of the voltage source.

FIG. 2D-17 illustrates a front view of the finned packaged switch 247d shown in FIGS. 2D-7, 2D-8, and 2D-9 with edge surfaces 208 (not shown) of fins 206 electrically and thermally attached (e.g., welded, soldered, sintered, etc.) to a die clip terminal of a second instance of packaged switch 247d (i.e., 247d-2). FIG. 2D-17 also shows one fin of a set (e.g., two, three or more) of metal fins 206-2 with end surfaces (not shown) electrically and thermally attached (e.g., welded, soldered, sintered, etc.) to a die substrate terminal of packaged switch 247d-2. The cooling-fins may be rotated by 90 degrees so that they are parallel with connector-leads 288. Or the fins may be rotated less than 90 degrees to form a non-zero angle with connector-leads 288. Although not shown, connector lead 288ds-2 may be electrically connected directly or indirectly to a V+ terminal of a DC voltage source, connector lead 288dc-2 may be electrically connected to connector lead 288ds, and connector lead 288dc may be electrically connected directly or indirectly to a V-terminal of the voltage source.

FIG. 2D-18 illustrates a front view of finned packaged switch 247d shown in FIGS. 2D-7, 2D-8, and 2D-9 with edge surfaces 208 (not shown) of fins 206 and 207 electrically and thermally attached (e.g., welded, soldered, sintered, press-fitted, etc.) to respective flat surfaces of solid metal bus bars 218 and 219, and another instance of finned packaged switch 247d (i.e., 247d-2) shown in FIGS. 2D-7, 2D-8, and 2D-9 with edge surfaces 208 (not shown) of fins 206-2 and 207-2 electrically and thermally attached (e.g., welded, soldered, sintered, press-fitted, etc.) to respective flat surfaces of metal bus bars 219 and 220. Alternatively, the cooling-fins may be rotated in position. For example, the cooling-fins could be rotated by 90 degrees so that they are parallel with connector-leads 288. Or the fins may be rotated less than 90 degrees to form a non-zero angle with connector-leads 288. Although not shown, V+ bus bar 218 may be electrically connected to a V+ terminal of a DC voltage source through a filter or filter component, phase bus bar 219 may be electrically connected to, for example, a terminal of a stator winding in an electric motor, and V-bus bar 220 may be electrically connected directly or indirectly to a V-terminal of the voltage source. Bus bars 218, 219, and 220 may be rectangularly shaped in cross section. Phase bus bars may also be referred to as AC bus bars.

FIG. 2D-19 illustrates a front view of the finned packaged switch 247d shown in FIGS. 2D-10, 2D-11, and 2D-12 with edge surfaces 214 (not shown) of fin 209 electrically and thermally attached (e.g., welded, soldered, sintered, press-fitted, etc.) to a die clip terminal of a second instance of packaged switch 247d (i.e., 247d-2). FIG. 2D-16 also shows metal fin 209-2 with end surfaces (not shown) electrically and thermally attached (e.g., welded, soldered, sintered, press-fitted, etc.) to a die substrate terminal of packaged switch 247d-2. Cooling-fins may be rotated by an angle up to 90 degrees. Although not shown, connector lead 288ds-2 may be electrically connected to a V+ terminal of a DC voltage source through a filter or filter component, connector lead 288dc-2 may be electrically connected to connector lead 288ds, and connector lead 288dc may be electrically connected to a V-terminal of the voltage source through a filter or filter component.

FIG. 2D-20 illustrates a front view of the finned packaged switch 247d shown in FIGS. 2D-13, 2D-14, and 2D-15 with edge surfaces 216 (not shown) of fin 211 electrically and thermally attached (e.g., welded, soldered, sintered, press-fitted, etc.) to a die clip terminal of a second instance of packaged switch 247d (i.e., 247d-2). FIG. 2D-20 also shows metal fin 211-2 with end surfaces (not shown) electrically and thermally attached (e.g., welded, soldered, sintered, press-fitted, etc.) to a die substrate terminal of packaged switch 247d-2. The cooling-fins may be rotated by 90 degrees so that they are parallel with connector-leads 288. Or the cooling-fins may be rotated less than 90 degrees to form a non-zero angle with connector-leads 288. Although not shown, connector lead 288ds-2 may be electrically connected to a V+ terminal of a DC voltage source through a filter or filter component, connector lead 288dc-2 may be electrically connected to connector lead 288ds, and connector lead 288dc may be electrically connected to a V-terminal of the voltage source through a filter or filter component.

FIG. 2D-21 illustrates a front view of finned packaged switch 247d shown in FIGS. 2D-13, 2D-14, and 2D-15 with edge surfaces 216 (not shown) of fins 211 and 212 electrically and thermally attached (e.g., welded, soldered, sintered, etc.) to respective flat surfaces of metal bus bars 218 and 219, and another instance of finned packaged switch 247d (i.e., 247d-2) shown in FIGS. 2D-13, 2D-14, and 2D-15 with edge surfaces 216 (not shown) of fins 211-2 and 212-2 electrically and thermally attached (e.g., welded, soldered, sintered, etc.) to respective flat surfaces of metal bus bars 219 and 220. Cooling-fins 211 and 212 could be rotated by 90 degrees so that they are parallel with connector-leads 288. Or cooling-fins 211 and 212 may be rotated less than 90 degrees to form a non-zero angle with connector-leads 288, such as connector-leads 288dc, 288ds, and 288g. Although not shown, V+ bus bar 218 may be electrically connected to a V+ terminal of a DC voltage source through a filter or filter component, phase bus bar 219 may be electrically connected to, for example, a terminal of a stator winding in an electric motor, and V-bus bar 220 may be electrically connected to a V-terminal of the voltage source through a filter or filter component.

Packaged switches and packaged diodes may have cases. FIGS. 2A-1-2A-3 show example case 248p. FIGS. 2B-1-2B-3 show example case 248q. FIGS. 2C-1-2C-3 show example case 248s1. FIGS. 2C-4-2C-6 show example case 248s2. FIGS. 2C-7-2C-9 show example case 248s3. FIGS. 2C-10-2C-12 show example case 248s4. FIGS. 2D-1-2D-3 show example case 248d. FIGS. 2E-1-2E-3 show example case 249. Packaged switches 247 may lack cases 249, and packaged diodes 245 may lack cases 249.

The surfaces of die substrate terminals 230 and die clip terminals 344 may be entirely flat and substantially parallel to each other. In addition to being entirely flat and substantially parallel to each other, the surfaces of die substrate terminals 230 and die clip terminals 344 may be substantially flush with respective flat surfaces of cases 248. Or the surfaces of die substrate terminals 230 and die clip terminals 344 may be entirely flat, substantially parallel to each other, and recessed below or protruding beyond the outer surfaces of cases 248. Although not clearly shown in the figures, die substrate terminals 230 and die clip terminals 344 are presumed to be entirely flat, substantially parallel to each other and protruding beyond the outer surfaces of cases 248, including case 248d so that they can connect with flat surfaces or bus bars or heat sinks. When a die substrate terminal 230 and a die clip terminal 344 are connected (e.g., sintered, soldered, etc.) to flat surfaces of respective bus bars, gaps may exist between the bus bars and the case of the packaged switch when the die substate 230 and die clip terminal 344 are flat, parallel to each other and protruding beyond the packaged switch case surfaces. The gaps may be fully filled with thermally conductive material, such as epoxy described below, to provide a heat transfer path between the case surface and a bus bar or heat sink.

Cases can isolate, protect and/or support switch module components or diode module components such as power stacks. Cases may add further protection against electrical shorts or dendrite growth between switch module components such as die substrates and die clips. Cases may be made of glass, plastic, ceramic, or other dielectric material. For explanation only, cases may be presumed to be made of plastic such as a mold compound like epoxy resin. Modern mold compounds have evolved into complex formulations that contain as many as 20 distinct raw materials. Fillers such as alumina may be added to increase a mold compound's thermal conductivity, which may help to transfer heat away from switch module components or diode module components including transistors and diodes. Cases may be formed around switch modules and diode modules using any one of many different types of packaging techniques including transfer molding.

Packaged switches 247 and packaged diodes 245 can be small. For example, the length lp, width wp, and height hp of packaged diode 245, packaged switch 247q, packaged switch 247s, and/or packaged switch 247d, may measure around 21 mm, 16 mm, and 5 mm, respectively, it being understood the size (e.g., 21 mm×16 mm×5 mm) and shape (e.g., rectangular cuboid) of packaged switches and packaged diodes may vary and should not be limited to that shown or described in this disclosure. The length lp, width wp, and height hp of packaged switch 247p may measure around 21 mm, 16 mm, and 12 mm, respectively, it being understood the size (e.g., 21 mm×16 mm×12 mm) and shape (e.g., rectangular cuboid) of packaged switch 247p may vary and should not be limited to that shown or described in this disclosure. Each of the example lengths, widths and/or heights of packaged switch 247p, 247q, 247s1-247s4, or 247d above could increase or decrease depending on, for example, the type, arrangement, and/or number of the components contained therein.

The size and shape of a packaged switch 247 may depend on one or more factors such as the number transistors in the packaged switch, the types of transistors in the packaged switch, the way the transistors are electrically connected in the packaged switch, the way the transistors are arranged or oriented in the packaged switch, etc. For example, a packaged switch 247d with six metal-oxide semiconductor field-effect transistors (MOSFETs) electrically connected in parallel may be longer and/or wider than a packaged switch 247d with four MOSFETs electrically connected in parallel, which in turn may be longer and/or wider than a packaged switch 247d with two MOSFETs electrically connected in parallel. Or a packaged switch 247d with two MOSFETs electrically connected in parallel may be thinner than a packaged switch 247p with two MOSFETs electrically connected back-to-back. Some types of transistors may be wider and/or longer than other transistors. For example, IGBTs may be wider and/or longer than MOSFETs, or MOSFETs from one manufacturer may be wider and/or longer than MOSFETs provided by another manufacturer. A packaged switch 247d with four IGBTs electrically connected in parallel may be longer and/or wider than a packaged switch 247d with four MOSFETs electrically connected in parallel. A packaged switch 247d with four parallel connected IGBTs, the combination of which is connected in parallel with one or more discrete diodes (e.g., Schottky diodes (e.g., Schottky barrier diodes SBDs), TVS diodes, etc.) may be longer and/or wider than a packaged switch 247d with only four IGBTs electrically connected in parallel.

External surfaces of the cases, bus bars, die substrate terminals, die clip terminals, current terminal pads, etc., may be substantially flat. “Substantially” may be used to describe a feature such as flatness. The term “substantially” means the feature has a variation that is within an acceptable manufacturing tolerance. For example, a substantially flat surface means a surface with a variation in flatness that is within an acceptable manufacturing tolerance such as 10.0 μm.

Switch modules and diode modules may include traces, bond-wires, straps, leads, pins, tabs, signal frames, pedestals, control-terminal posts, etc., or other electrically conductive connecting elements (hereinafter connecting elements). Connecting elements may transmit signals, electrical power, or both. Signals may include voltage signals and current signals. Connecting elements may also transfer heat.

Traces may have flat surfaces and may be formed of metal on outer surfaces of rigid printed circuit boards (PCBs), flexible PCBs, direct bond copper (DBC) substrates, etc. Traces may also be formed in middle layers of rigid PCBs. Traces on different layers of PCBs may be electrically connected through metal vias.

Bond-wires may have a small diameter (e.g., 10 μm or less, and up to several hundred micrometers).

Straps, leads, tabs, pins, and signal frames may be formed (e.g., stamped) from thin sheets of metal. Straps, leads, tabs, pins, and signal frames may be thicker than traces and bond-wires and rated to conduct substantially more electrical current.

Pedestals, which are more fully described below, may be connected (e.g., sintered, soldered, etc.) to transistor or diode current terminals.

Control-terminal posts, which are more fully described below, may be connected (e.g., sintered, soldered, etc.) to and between transistor control terminals and die clips or die substates. In addition to transmitting a signal to a transistor control terminal, a control-terminal post can transmit heat to a die clip or die substrate to which it may be connected. A control-terminal post connected between a transistor control terminal and a die clip or die substrate should have a dielectric layer that electrically isolates the control terminal from the die clip or die substrate.

Control-terminal posts can be dielectric based, or metal based. A dielectric based control-terminal post may be built on a base of dielectric material (e.g., a ceramic such as aluminum oxide (AO), silicon nitride, boron nitride, aluminum nitride, beryllium oxide, etc.) that extends laterally between oppositely facing, substantially flat surfaces. One or more layers of metal may be formed on each of the opposite facing, substantially flat surfaces of the dielectric base. The outer surfaces of metal layers formed on the dielectric base should be substantially flat and oppositely facing. A layer of sintering enhancement material (e.g., copper, silver, silver alloy, or silver metal mixtures such as silver/palladium, silver platinum, etc.) can be added to the outer surfaces of metal layers formed on the dielectric base. The added sintering enhancement layers may have oppositely faced and substantially flat surfaces.

A metal-based control-terminal post may be built on a base of metal or a base of layered metals, which extends between oppositely facing, substantially flat surfaces. A metal-based control-terminal post may include a base of one type of conductive metal between layer(s) of another type of metal or composite. This type of metal-based control terminal post may have a coefficient-of-thermal expansion (CTE) that is better suited for use with SiC and GaN transistors. For example, the base of a post better suited for SiC or GaN may take form in a layer of molybdenum, tungsten, diamond, copper/molybdenum alloy, copper/tungsten, copper/diamond, which is sandwiched between layers of copper. A layer of dielectric material (e.g., a ceramic such as aluminum oxide, silicon nitride, boron nitride, aluminum nitride or beryllium oxide) can be added to one of the oppositely facing, substantially flat surfaces of the metal base or metal base with added layered metals. One or more layers of metal can be formed on a substantially flat outer surface of the added dielectric layer. The outer surface of the one or more layers of metal formed on the dielectric layer should be substantially flat. A layer of sintering enhancement material (e.g., copper, silver, silver alloy, silver metal mixtures such as silver/palladium, silver platinum, etc.) can be added to each of the opposite-facing flat surfaces after the dielectric layer is added. The added sintering enhancement layers may have oppositely facing, substantially flat surfaces.

Straps, leads, pins, bond-wires, signal frames, traces, etc., may be attached, joined, connected, bonded, etc., together or to die clips, die substrates, paddles, current terminal pads, control terminal pads, etc. PCBs or DBC substrates (hereinafter also referred to as DBCs) may be attached, joined, connected, bonded, etc., to die clips, die substrates, paddles, etc. Components may be attached, joined, connected, bonded, etc., through an electrically conductive attachment, bond, connection, or joint using an electrically conductive material such as solder paste or preform, sintering paste or preform (e.g., silver sintering paste or silver sintering preform), silver thermal paste, a combination of solder paste and wire mesh, etc. Components may be attached, joined, connected, bonded, etc., through a dielectric or electrically insulating attachment, connection, bond, or joint made of a dielectric material. When a strap, lead or other connecting element is attached, joined, connected, bonded, etc., to a device (e.g., a die substrate) through a dielectric material, the device is electrically insulated from the strap, lead, or other connecting element. The terms connect, attach, join, or bond may be used interchangeably. The terms connection, attachment, joint, or bond may be used interchangeably. The terms connecting, attaching, joining, or bonding may be used interchangeably.

Leads or pins can have a square or rectangle shaped cross-section. For purposes of explanation only, straps, signal frames, pins, tabs, pins, and leads have square or rectangular cross-sections. Straps, tabs, signal frames, and leads may be formed (e.g., cut, sawed, diced, stamped, etc.) from thin sheets of electrically conductive material such as metal (e.g., copper, aluminum, etc.).

Switch modules or diode modules may include PCB (printed circuit board), DBC (direct bond copper), or AMB (active metal brazed) substrates. A DBC substrate may be composed of a ceramic tile (e.g., aluminum oxide, silicon nitride, beryllium oxide, etc.) with a sheet of copper bonded to each side by a high-temperature oxidation process (the copper and substrate may be heated to a carefully controlled temperature in an atmosphere of nitrogen containing about 30 ppm of oxygen; under these conditions, a copper-oxygen eutectic forms that bonds successfully both to copper and the oxides used as substrates). The top copper layer may be pre-formed prior to firing or chemically etched using PCB technology to form traces, while the bottom copper layer, which may be flat and attached to a flat surface of a die substrate or die clip using an electrically conductive or dielectric material, is usually kept plain.

AMB substrates provide high thermal conductivity and mechanical stability. AMB substrates may be formed by joining ceramic substrates to metal layers using a specialized brazing process. The brazing process may involve applying a thin layer of active metal alloy to the ceramic substrate surface, which is then heated to a high temperature in the presence of a reducing gas atmosphere. This causes the active metal to react with the ceramic and form a strong chemical bond, allowing the metal layer to be joined to the ceramic substrate.

AMB substrates can be used in high-power electronic applications, such as in power modules for electric vehicles and renewable energy systems, where the ability to dissipate heat quickly is important for device performance and reliability. The use of AMB substrates allows for the creation of high-performance power modules with improved thermal management and reduced size, weight, and cost compared to traditional wire-bonded packages.

AMB is a promising thick film. In AMB ceramic substrate technology a solution to the discrepancy between thermal expansion coefficients of copper and ceramic substrate was found by introducing a buffer layer between conductor and ceramic substrate. This buffer layer can release strain between the layers during thermal cycling and serve as an adhesion layer. The buffer layer can be deposited by CVD or PVD technology as well as with special solder pastes. The main thickness of copper may be grown by a galvanic method. A weak point of ABM technology may be thermal conductivity of buffer layer that reduces the thermal conductivity of conducting layer, and therefore aluminum nitride (AlN) substrates may be more suitable for use in this technology. AMB ceramic PCBs may be a good choice for high-temperature H2 soldering. The PCBs may have extreme thermal and energy cycle resistivity (e.g., more than 15000 energy cycles on/off at 100 C and more than 5000 cycles in 200 C.).

One or more packaged or unpackaged discrete components and/or integrated circuits can be mounted on a top side of a DBC substrate and connected to traces. For example, an unpackaged control terminal driver (e.g., gate driver) can be mounted on top side of a DBC substrate with terminals (e.g., gate driver terminals) electrically connected to respective traces on the DBC substrate. Other devices such as temperature sensors, diodes or resistors can also be connected to DBC substrate traces. The flat surface of the copper layer on the bottom side of the DBC can be connected (e.g., soldered, sintered, brazed, etc.) to a flat surface of a die substrate in a power stack. A first current terminal pad (e.g., drain pad) of a transistor can also be connected (e.g., soldered, sintered, brazed, etc.) to the flat surface of the die substrate. The opposite side of the die substrate can be connected (e.g., soldered, sintered, brazed, etc.) to a flat surface of a bus bar that may also act as a heat sink. A second current terminal pad (e.g., source pad) of the transistor may be electrically and thermally connected to a pedestal as will be more fully described below. Unless otherwise stated in this disclosure, a flat surface area of a pedestal may contact a substantial portion, most (i.e., 51%-99%) or all the outwardly facing surface area of a current terminal through a bond. A first terminal of the control terminal driver can be electrically connected to the control terminal of the transistor via a first electrical path that may include a first trace of the DBC and a first bond-wire with ends directly connected to the first trace and the control terminal pad. This first electrical path may be 10, 5, 3, 1, 0.5 mm or less in length. Parasitic inductance, capacitance, and/or resistance can be reduced by reducing the length of the first electrical path. A second terminal of the control terminal driver can be electrically connected to the second current terminal pad via a second electrical path that may include a second trace of the DBC substrate and a second bond-wire with one end directly connected to the second trace and another end directly or indirectly connected to the second current terminal pad. This second electrical path may be 10, 5, 3, 1, 0.5 mm or less in length.

PCBs have flat conductive traces that may be etched from one or more thin sheet layers of metal laminated onto and/or between sheet layers of a non-conductive substrate. Metal vias extending through non-conductive substrate layers can electrically connect traces at different levels. One or more packaged or unpackaged integrated circuits and/or discrete devices can be mounted on a top side of a PCB. For example, an unpackaged control terminal driver (e.g., gate driver) can be mounted on top side of a PCB with terminals (e.g., gate driver terminals) electrically connected to respective traces on the PCB. Other devices such as temperature sensors, diodes or resistors can be connected to PCB traces. The flat bottom side of the PCB can be connected (e.g., glued with a thermal adhesive) to a flat surface of a die substrate of a power stack. A first current terminal pad (e.g., drain pad) of a transistor can also be connected (e.g., sintered, soldered, etc.) to the flat surface of the die substrate. The opposite side of the die substrate can be connected (e.g., sintered, soldered, etc.) to a flat surface of a bus bar that may also act as a heat sink. A second current terminal pad (e.g., source pad) of the transistor may be electrically and thermally connected to a pedestal. A first terminal of the control terminal driver can be electrically connected to the control terminal of the transistor via a first electrical path that may include a first trace of the PCB and a first bond-wire with ends connected to the first trace and the control terminal pad. This first electrical path may be 10, 5, 3, 1, 0.5 mm or less in length. A second terminal of the control terminal driver can be electrically connected to the second current terminal pad via a second electrical path that may include a second trace of the PCB and a second bond-wire with one end directly connected to the second trace and another end directly or indirectly connected to the second current terminal pad. This second electrical path may be 10, 5, 3, 1, 0.5 mm or less in length.

Connecting elements (e.g., traces, bond-wires, bond-ribbon, fiber optic cables, signal frames, leads, etc.) may transmit signals (e.g., transistor control signals, driver control signals, temperature sensor signals, etc.) and/or electrical power. A connecting element may carry a signal and/or electrical power between a device (e.g., transistor, driver, temperature sensor, etc.) internal to a packaged switch or packaged diode and a lead of the packaged switch or packaged diode. A connecting element may carry a signal and/or electrical power between two devices internal to a packaged switch or packaged diode. A bond-wire may carry a signal between a transistor control terminal and a trace of a PCB or DBC substrate in a packaged switch. A bond-wire may carry a signal between a transistor control terminal and a strap in a packaged switch. Traces of PCBs or DCB substrates can carry signals (e.g., transistor control signals, driver control signals, temperature sensor signals, etc.) and/or electrical power. A trace of a PCB or DCB substrate may carry signals and/or power in an electrical path between devices (e.g., a temperature sensor) internal to a switch module or diode module, and a device (e.g., an ECU) external to the switch or diode module. Traces of flexible PCBs may be used in converters to transmit signals between a data processing device such as an ECU and other components such as drivers, voltage sensors, current sensors, etc., as will be more fully described below.

Packaged diodes or packaged switches may include one or more connector-leads or pins. Ends of some connector-leads may be electrically connected to die substrates, paddles, die clips, etc., which in turn may be electrically connected to current terminals of transistors, diodes, etc.

Packaged diodes or packaged switches may include one or more components such as bond-wires, straps, signal frames, PCBs, DBCs, drivers, temperature sensors, etc. Ends of some connector-leads may be electrically connected to traces, straps, signal frames, etc., which in turn may be electrically connected to transistor control terminals, driver terminals, temperature sensor terminals, etc.

A packaged switch or packaged diode may include a connector-lead with an end that is electrically connected to a strap, DBC trace, PCB trace, etc., directly or indirectly through another connecting element such as a bond-wire. The strap, DBC, PCB, etc., may be attached to a flat surface of die clip, paddle, or die substrate. A strap may be attached to a die clip, paddle, or die substrate through a material that electrically insulates the strap from the die clip, paddle or die substrate. A DBC, PCB, etc., may be attached to a die clip, paddle, or die substrate through a material that may or may not be dielectric.

A packaged switch or packaged diode may include a PCB or DBC and connector-leads with ends that are electrically connected to a driver, temperature sensor, voltage sensor, etc., mounted on the PCB or DBC via respective traces formed thereon, and these connector-leads may extend from the packaged switch. Example packaged diode 245, packaged switch 247p, packaged switch 247q, packaged switch 247s, and packaged switch 247d do not include a PCB or DBC.

Connector-leads can extend laterally from cases of a packaged switch or packaged diode. The connector-leads of a packaged switch or packaged diode can mate with a “connector,” which may be mounted on a driver PCB, which is more fully described below. Or the connector-leads may extend through apertures of driver PCB and electrically connected (e.g., soldered) to respective traces thereon. Other components may be mounted on the driver PCB such as drivers (e.g., gate drivers), PMICs, current sensors, capacitors, diodes, transformers, etc. The connector-leads may be electrically connected to respective traces of the driver PCB, and the traces may be electrically connected to components mounted on the driver PCB as gate drivers, PMICs, current sensors, voltage sensors, capacitors, diodes, transformers, etc. Connector-leads may carry signals between a packaged switch or packaged diode, and components mounted on a driver PCB.

FIG. 2A shows connector-leads 288g1, 288g2, 288c, 288dc, and 288ds. FIG. 2B shows connector-leads 288g1, 288g2, 288dc, and 288ds. FIGS. 2C-1-2C-5 and 2D show connector-leads 288g, 288dc, and 288ds, except for FIGS. 2D-22-2D-24, which show packaged switch 247b, which may be packaged switch 247d of FIGS. 2D-1-2D-3 with connector-lead 288g replaced by PCB 340 as will be more fully described below. FIGS. 2C-3-2C-5 show an additional connector-lead 288bdc. FIGS. 2C-7-2C-12 show connector-leads 288g, 288dcl, 288dcr, and 288ds. FIG. 2E show connector-leads 288ds and 288dc. In an alternative embodiment, the packaged diode of FIG. 2E may lack one or both connector-leads 288ds and 288dc. The ends of connector-leads 288, other than connector-lead 288bdc, of a packaged switch 247 or a packaged diode 245 can be received in respective slots of a connector or other devices, which can be mounted on a PCB as more fully described below. Connector-leads 288dcl and 288dcr may be wider than connector-leads 228dc, but include narrowed extensions 292 as shown with a width and height equal to the width and height of connector-leads 288g and 288ds so that the extensions 292 can be received by PCB mounted connectors or other devices.

Although not shown in FIGS. 2A-1 and 2B-1 connector-lead 288g1 may be electrically connected to one or more first control terminals (e.g., gate terminals) of one or more first transistors in packaged switches 247p or 247q, and connector-lead 288g2 may be electrically connected to one or more second control terminals (e.g., gate terminals) of one or more second transistors in packaged switches 247p or 247q. In some instances, connector-leads 288g1 and 288g2 may be connected to respective control terminals of one transistor (e.g., a bidirectional bipolar junction transistor) in packaged switch 247q. Although not shown in FIGS. 2C-1, 2C-4, 2C-7, 2C-10 and 2D-1 connector-lead 288g may be electrically connected to one or more control terminals (e.g., gate terminals) of one or more transistors in packaged switches 247s and 247d. Connector-leads 228ds and 228dc may be electrically connected to a die substrate and die clip, respectively. Connector-lead 288dcr or 288dcl may be electrically connected to a die clip. Connector-lead 288bdc may be electrically connected to a die clip. Connector-lead 288c may be electrically connected to a paddle, which is more fully described below.

A power stack may include a switch or diode(s), which may be electrically and thermally connected to a die substrate and a die clip, and positioned between the die substrate and the die clip. Elements in a power stack, including pedestals more fully described below, may be thermally and electrically connected to each other through bonding layers. A bonding layer may also be referred to as joint, connection, attachment, or bond. Die substrates and die clips may be platelike structures that are formed from an electrically and thermally conductive material (e.g., metal or layers of metal) as will be more fully described below. Die substrates and die clips may have substantially flat top and bottom surfaces that are parallel to each other. The flat top and bottom surfaces of a die substrate and a die clip in a power stack may be parallel to each other.

Die substrates and die clips may include die substrate terminals and die clip terminals, respectively. Packaged switches and packaged diodes of FIGS. 2A-1-2E-3 show example die substrate terminals 230 and die clip terminals 344.

Die substrate terminal 230 may be substantially flat with a width wds around 13.5 mm, and a length lds around 16.5 mm. Die clip terminal 344 may be substantially flat with a width wdc around 13.0 mm, and a length ldc around 16.0 mm. Die substrate terminal 230 and die clip terminal 344 are oppositely facing. Die substrate terminal 230 and die clip terminal 344 may be substantially parallel to each other but contained in different planes. The length, width, and/or height of a die substrate terminal 230 and a die clip terminal 344 may depend on several factors including the configuration, number and/or type of transistors in the switch positioned between them. For example, a packaged switch 247q with six metal-oxide semiconductor field-effect transistors (MOSFETs) electrically connected in parallel may have die substrate and die clip terminals 230 and 344, respectively, that may be wider and/or longer than die clip terminals 230 and 344, respectively, in a packaged switch 247q with only four MOSFETs electrically connected in parallel. A packaged switch 247d with two IGBTs electrically connected in parallel may have die clip terminals 230 and 344, respectively, that may be wider and/or longer than die clip terminals 230 and 344, respectively, in a packaged switch 247d with only two MOSFETs electrically connected in parallel. A packaged switch 247d with two IGBTs electrically connected in parallel, the combination of which is electrically connected in parallel with two parallel connected diodes, may have die clip terminals 230 and 344, respectively, that may be wider and/or longer than die clip terminals 230 and 344, respectively, in a packaged switch 247d with only two IGBTs electrically connected in parallel and no diodes. A first packaged switch 247 employing a first type of switch (e.g., an IGBT) may have a die clip and/or die substrate that is different in height than the die clip and/or die substrate of a second packaged switch 247 employing a second type of switch (e.g., a MOSFET) so that the heights of the first and second packaged switches 247 between their respective terminals 230 and 344, are substantially equal.

The length, width, and/or height of a die substrate terminal 230 and/or a die clip terminal 344 in diode package 245 may depend on several factors such as the number and/or type of diodes between them. A packaged diode 245 with four diodes electrically connected in parallel may have die clip terminals 230 and 344, respectively, that may be wider and/or longer than die clip terminals 230 and 344, respectively, in a packaged diode 245 with only two diodes electrically connected in parallel. Packaged diodes 245 may or may not include pedestals. If a packaged diode does not include pedestals, the current terminals (i.e., collector and anode) may be directly connected (e.g., sintered) to flat surfaces of a die substrate and die clip, respectively. A packaged diode 245 with or without pedestals may have a die clip and/or die substrate that is different in height than the height of the die clip and/or die substrate in a packaged switch 247 so that the heights of the packaged diode 245 and packaged switch 247 between terminals 230 and 344, are substantially equal.

Connector-leads 288ds and 288dc in the figures are electrically connected to die substrate terminal 230 and die clip terminal 344, respectively. Connector-leads 288dcl or 288dcr are electrically connected to a die clip in FIGS. 2C-7-2C-12. FIGS. 2C-4-2C-6 show connector-lead 288bdc, which is electrically connected to connector-lead 288dc. Connector-leads 288ds, 288bdc, 288dcl, 288dcr, and 288dc can carry substantial current (e.g., 1, 5, 10, 25, 50, 100 amperes (A) or more). For ease of illustration connector-leads 288, except for connector-lead 288bdc, in FIGS. 2A-1-2E-3 are shown as being contained in a common plane. Connector-leads 288 need not be contained in a common plane.

Switch modules may include power stacks, each of which may include a switch that is thermally and electrically connected to and sandwiched between a die substrate and a die clip. The die substrate may be directly connected (e.g., sintered, soldered, etc.) to the switch, or indirectly connected to the switch through one or more electrically and thermally conductive components such as pedestals (more fully described below). Additionally, the die substrate may be indirectly connected to the switch through one or more control-terminal posts (more fully described below). The die clip may be directly connected (e.g., sintered, soldered, etc.) to the switch, or indirectly connected to the switch through one or more electrically and thermally conductive components such as pedestals. Additionally, the die clip may be indirectly connected to the switch through one or more control-terminal posts. Pedestals can conduct heat (e.g., 1, 2, 5, 10, 20, 40, 100, 200, 400, 800, 1200, 1400 Watts or more) and electrical current (e.g., 1, 5, 10, 50, 100, 200, 400 A or more) between a switch and a die substrate or die clip. Because of its dielectric layer described above, a control-terminal post can conduct only heat (e.g., 1, 2, 5, 10, 20, 40, 100, 200, 400, 800, 1200, 1400 Watts or more) between a switch and a die substrate or die clip.

Two items can be directly or indirectly connected. Two items (e.g., a transistor and a die substrate, or a bus bar and a die substrate terminal) that are thermally and electrically connected, either directly or indirectly, can concurrently conduct substantial electrical current (e.g., 1, 5, 10, 50, 100, 200, 400 A or more) and substantial heat (e.g., 1, 2, 5, 10, 20, 40, 80, 100, 200, 400, 800, 1200, 1400 Watts or more) between them. Two items thermally and electrically connected can concurrently conduct substantial electrical current and substantial heat between them through a direct connection such as a sintered or soldered connection, a sintered or soldered attachment, a sintered or soldered bond, or a sintered or soldered joint, etc. Two items thermally and electrically connected indirectly together can concurrently conduct substantial electrical current and substantial heat between them through one or more intervening items such as a pedestal. Two items (e.g., a die substrate and a control-terminal post, or a die clip and a control-terminal post) thermally connected indirectly together, but electrically isolated from each other, can conduct substantial heat (e.g., 1, 2, 5, 10, 20, 40, 80, 100, 200, 400, 800, 1200, 1400 Watts or more) between them. Respective surface areas of two items can be directly connected by pressing the surface areas together using a mechanical structure such as a clamp, bolt, screw, etc.

A thermal and/or electrical connection may be more than just a point-to-point connection. Two items that are thermally and/or electrically connected may have respective surface areas (e.g., 1, 5, 10, 20, 50, 100, 200, 400 mm² or more) that may be directly connected through a layer of connection material. Two items that are thermally and/or electrically connected may have respective flat surface areas (e.g., 1, 5, 10, 20, 50, 100, 200, 400 mm² or more) that may be directly connected through a layer of connection material. A thermal and/or electrical connection directly connecting two items may substantially fill all the space directly between their surface areas that face each other. Flat-surface to flat-surface connections may conduct more heat and/or electrical current between items than point-to-point connections.

Diode modules may include power stacks, each of which may include at least one diode electrically and thermally connected to and positioned between a die substrate and a die clip. A diode may be directly connected (e.g., sintered, soldered, etc.) to a die substrate, or indirectly connected to the die substrate through one or more as pedestals. A diode may be directly connected (e.g., sintered, soldered, etc.) to a die clip, or indirectly connected to the die clip through one or more pedestals.

Sintering may be a process of forming a connection by the application of heat and/or pressure between items using sintering material without melting the sintering material to the point of liquefaction. Before a pair of items such as a die substrate and a transistor are sintered together, a thin layer of sintering material (e.g., a sinter paste or sinter preform containing silver, silver alloy, etc.) may be applied to the surface(s) of one or both items. Heat can then be applied to the sintering material and the items to be sintered together. Intense light energy can be used to heat the sintering material and the items. Pressure may be applied to the items and the sintering material between them as they are heated. The pressure may squeeze the items together. During the sintering process the atoms in the sintering material diffuse across boundaries of the items to be sintered, fusing them together and effectively creating one solid item, which may have increased strength, durability and improved material properties. The sintering temperature need not reach the melting point of the sintering material, nor does the sintering process need to reach the melting point of the items (e.g., a die substrate and transistor) to be sintered together. The sintering temperature should be below the temperature at which transistors or diodes can be damaged. Sintering, when compared to soldering, may reduce the occurrence of bubbles or other voids in the joint or bond between the items, which can adversely affect thermal and electrical conductivity between the items. While other methods of attaching items can be employed, sintering may be preferred since it may create a mechanically stronger bond, especially when compared to soldering. A strong joint or bond may be particularly important when it is subjected to stress (e.g., thermal and/or mechanical stress) of extreme environments. For example, a joint or bond can be subjected to severe mechanical stress caused by road vibrations of a moving vehicle, and a joint or bond can be subjected to severe thermal stress caused by temperature cycling. Moreover, since the melting point of the sintering material may be higher than the temperature used in soldering, brazing, epoxy bonding, sintering, or other processes used in the construction of a packaged switch, diode, or converter, those processes should not disturb the sintered joint or bond

The die clip and die substrate of a power stack may be substantially identical, or they may be substantially different in size, shape and/or composition. Die substrates can vary in size, shape, and composition between different versions of power stacks. Likewise, die clips can vary in size, shape, and/or composition between different versions of power stacks.

A switch may include one or more semi-controllable and/or fully controllable transistors (e.g., insulated-gate bipolar transistor (IGBT), reverse-blocking IGBT (RB-IGBT), reverse blocking integrated gate commutated thyristor (RB-IGCT), non-punch through IGBT (NPT-IGBT), metal-oxide field effect transistor (MOSFET), silicon-controlled rectifier (SCR), thyristor, gate turn off thyristor (GTO thyristor), bidirectional thyristor (BT), bidirectional triode thyristor or TRIAC, bidirectional control thyristor (BCT), bipolar junction transistor (BJT), bidirectional BJT (BBJT (aka BTran)), etc.). A switch may also include one or more diodes (e.g., normal diode, Zener diode, Schottky diode, transient voltage suppression (TVS) diode, etc.) connected in series, parallel, or anti-parallel with one or more transistors. Transistors and/or diodes may be made from any one of many different types of semiconductor materials such as Si, SiC, GaN, GaO, cubic boron arsenide, etc.

A transistor may have two current terminals (e.g., collector and emitter terminals in an IGBT or BJT, source and drain terminals in a MOSFET, cathode and anode terminals in a thyristor, collector/emitter terminals in a BBJT, cathode/anode terminals in a BT, etc.) between which current can flow. A diode may have two current terminals (e.g., a cathode terminal and an anode terminal) between which current can flow. A current terminal may include one or more pads, each of which may have a substantially flat and outwardly facing surface. A transistor pad can be electrically and thermally conductive. The first current terminal(s) (e.g., drain terminal(s), collector(s), cathode(s), etc.) of a switch may be electrically and thermally connected to a die substrate terminal, such as die substrate terminal 230 shown in FIGS. 1A-2E, through the body of the die substrate. The second current terminal(s) (e.g., source(s), emitter(s), anode(s), etc.) may be electrically and thermally connected to a die clip terminal, such as die clip terminal 344 shown in FIGS. 1A-2E, through the body of the die clip. A current terminal may also be referred to as a current electrode.

Transistors may include control terminals (e.g., gate terminal in a MOSFET or IGBT, base terminal in a BJT or BBJT, etc.). A control terminal may also be referred to as a control electrode. Transistors may be controlled (activated or deactivated) by signals received at their control terminals. Transistors may be purely unidirectional or capable of controlling electrical current flow from the first terminal to the second current terminal when activated, and capable of blocking current in the reverse direction (i.e., from the second current terminal to the first current terminal) when deactivated. Switches may be purely unidirectional. Transistors (e.g., MOSFETs) may be quasi-unidirectional or capable of controlling electrical current flow from the first terminal to the second current terminal when activated but incapable of controlling electrical current flow in the reverse direction when deactivated. Switches may be quasi-unidirectional. An IGBT connected anti-parallel with a diode (i.e., diode cathode and IGBT collector electrically connected, and diode anode and IGBT emitter electrically connected) is an example of a switch that is quasi-unidirectional. Transistors (e.g., BBJTs) may be bidirectional or capable of controlling electrical current flow in both directions between their first and second current terminals when activated, and capable of blocking current flow in both directions between their first and second current terminals when deactivated. Switches may be bidirectional or capable of controlling electrical current flow in the forward and reverse directions. Bidirectional transistors and switches may also be known as four-quadrant devices or devices capable of controlling current flow in both directions (positive and negative) and blocking voltage of either polarity.

As noted, a current terminal may include one or more pads, each of which may have a substantially flat, outwardly facing surface. A “low resistance path” may exist between a current terminal pad and a die clip terminal in a power stack. A “low resistance path” is presumed to be a path that has low electrical resistance (16, 12, 10, 8, 6, 5, 4, 3, 1, 0.1, 0.01, 0.001 ohms or less) and low thermal resistance (0.5, 0.3, 0.2, 0.1, 0.05, 0.03, 0.02° C./Watt or less) unless otherwise noted. A low resistance path may exist between a current terminal pad and a die substrate terminal or die clip terminal in a power stack. No dielectric should exist in a low resistance path between a current terminal pad and a die substrate terminal or die clip terminal. A low resistance path may include one or more connections (e.g., one or more sintered connections, one or more soldered connections, etc.) between a current terminal pad and a die substrate or a die clip. A low resistance path may include a pedestal or other metallic component between a current terminal pad and a die substrate or a die clip. A low resistance path may include a pedestal or multiple pedestals between a current terminal and a die substrate or a die clip. A low resistance path may include multiple pedestals between multiple current terminals, and a die substrate or a die clip. A low resistance path may mean the cross-sectional area of the path, which cross-sectional area is parallel to the surface of a current terminal pad, does not decrease from the current terminal pad to a die substrate terminal or a die clip terminal. The cross-sectional area of a low resistance path, which cross-sectional area may be parallel to the surface of a current terminal pad, may increase from the current terminal pad to a die substrate terminal or a die clip terminal, which may enable better heat spreading from the current terminal pad to the die substrate terminal or the die clip terminal. Substantial heat (e.g., 1, 2, 5, 10, 20, 50, 100, 200, 300, 750 Watts or more) and current (e.g., 1, 5, 10, 50, 100, 200, 400 A or more) can concurrently flow through a low resistance path. For example, substantial heat (e.g., 1, 2, 5, 10, 20, 50, 100, 200, 300, 750 Watts or more) and current (e.g., 1, 5, 10, 50, 100, 200, 400 A or more) can concurrently flow from a current terminal pad to a die substrate terminal 230 or a die clip terminal 344 through a low resistance path. Ideally, a cross-sectional area of a low resistance path between a current terminal pad and a die substrate terminal or die clip terminal should not decrease as electrical current and heat conducts from the current terminal pad to the die substrate terminal or die clip terminal. Ideally, a low resistance path between a current terminal pad and a die substrate terminal or die clip terminal should have a cross-sectional area that is not less than the surface area of the current terminal pad. A low resistance path may have low parasitic inductance. A low resistance path between a current terminal pad and a die substrate terminal in this disclosure may have 10, 5, 1, 0.1, 0.01 nF or less parasitic inductance. A low resistance path between a current terminal pad and a die clip terminal in this disclosure may have 10, 5, 1, 0.1, 0.01 nF or less parasitic inductance. Like pedestals, current-terminal posts may have low thermal resistance and the ability to transmit substantial heat (e.g., 1, 2, 5, 10, 20, 50, 100, 200, 300, 750 Watts or more) between a control-terminal pad and a die clip or a die substrate. However, current-terminal posts should have high electrical resistance between oppositely facing flat end surfaces of the posts. A dielectric layer(s) should be included in a control-terminal post to prevent an electrical connection between a control-terminal pad and a die clip or die substrate when the current-terminal post is connected (e.g., sintered, soldered, etc.) therebetween.

Transistors in a switch may be connected in parallel (i.e., first current terminals of the transistors are electrically connected, and second current terminals of the transistors are electrically connected). Transistors in a switch may be connected in series (e.g., the second current terminal of a first transistor is electrically connected to the first current terminal of a second transistor). Transistors in a switch may be connected back-to-back (e.g., two transistors connected in series but with their first current terminals electrically connected or their second current terminals electrically connected). Transistors in a switch may be connected in anti-parallel (e.g., two transistors connected in parallel but with the first and second current terminals of the first transistor electrically connected to the second and first current terminals, respectively, of the second transistor). Switches may be bidirectional or capable of controlling the flow of current in both directions and/or capable of blocking voltage in both directions. A switch may be bidirectional if it contains quasi unidirectional transistors such as MOSFETs, which are connected back-to-back. A switch may be bidirectional if it contains transistors, including NPT-IGBTs, RB-IGCTs, or RB-IGBTs, which are connected in anti-parallel. A switch may be bidirectional if it contains only one bidirectional transistor such as BBJT or several bidirectional transistors connected in parallel. A bidirectional switch can function properly with its first current terminal electrically connected to a first bus bar (e.g., a V+ bus bar) and its second current terminal electrically connected to a second bus bar (e.g., a phase bus bar), or its first current terminal electrically connected to the second bus bar (e.g., the phase bus bar) and its second current terminal electrically connected to first bus bar (e.g., the V+ bus bar).

A switch may be a hybrid or a mix of different types of transistors connected in parallel, series, anti-parallel, or back-to-back. For example, a hybrid switch may include one or more MOSFETs and one or more IGBTs connected in parallel (i.e., drains and collectors may be electrically connected, and sources and emitters may be electrically connected). Other hybrid switches are contemplated.

Different types of drivers may be needed to control different types of transistors. Some gate drivers that can activate and deactivate an IGBT cannot activate and deactivate a MOSFET, and vice versa. However, other drivers may be capable of concurrently controlling different types of transistors. For example, some drivers can independently generate separate signals for controlling the gates of a MOSFET and an IGBT, or the gate of a MOSFET and a base of a BBJT. Independently controlled signals can be turned on at different times. For example, independently controlled signals (e.g., gate signals) for respective transistors can be asserted at different times.

Multiple transistors in a switch may be connected in parallel and controlled by a common signal received at their control terminals. Parallel connected transistors in a switch may be controlled by respective, independently generated transistor control signals received at their control terminals. Groups of parallel connected transistors in a switch may be controlled by respective, independently generated transistor control signals. All or fewer than all (e.g., one, two, or more, but less than all) parallel connected transistors in the switch may be activated at the same time when controlled by respective, independently generated transistor control signals.

A pair of transistors in a switch may be connected in anti-parallel, or two groups of parallel connected transistors in a switch may be connected in anti-parallel. The pair of anti-parallel transistors may be controlled by respective, independently generated transistor control signals, or the two groups of parallel connected transistors that are anti-parallel connected may be controlled by respective, independently generated transistor control signals. Only one of the pair of anti-parallel connected transistors should be activated at a time, and only one the two groups of parallel connected transistors, which groups are connected in anti-parallel, should be activated at a time.

A pair of transistors in a switch may be connected back-to-back, or two groups of parallel connected transistors in a switch may be connected back-to-back. The pair of back-to-back connected transistors may be controlled by respective, independently generated signals, or the two groups of parallel connected transistors that may be connected back-to-back may be controlled by respective, independently generated transistor control signals. Only one of in the pair of back-to-back connected transistors in a switch should be activated at a time, and only one of two groups of parallel connected transistors that may be connected back-to-back should be activated at a time.

Transistors or diodes may be vertically structured semiconductors or dies. A vertically structured transistor may have a trench-like structure with a first current terminal (e.g., a drain terminal, collector terminal, collector/emitter terminal, etc.) on or near a first surface (e.g., bottom surface) of the die, and a second current terminal (e.g., a source terminal, emitter terminal, collector/emitter terminal, etc.) on or near an oppositely facing second surface (e.g., top surface) of the die. Stated differently, the first and second current terminals can be on opposite sides of a vertically structured transistor. A vertically structured transistor may also have a control terminal (e.g., base terminal or gate terminal) on or near the top surface of the die. Some transistors such as BBJTs or BCTs may have a second control terminal on or near the bottom surface of its die. The cathode terminal and the anode terminal of vertically structured diode may be on or near oppositely facing top and bottom surfaces, respectively. Stated differently, the cathode and anode terminals can be on opposite sides of a vertically structured diode. Transistors and diodes of this disclosure are presumed vertically structured, as opposed to planar or laterally structured, unless otherwise specified.

A current terminal may include one or more electrically and thermally conductive (e.g., metallic) contact pads (hereinafter pads), each of which may be in electrical or ohmic contact with an underlying doped semiconductor region (e.g., a source, a drain, an emitter, a collector, an emitter/collector, an anode, a cathode, etc.). A control terminal may include one or more pads. A control terminal pad may or may not be in ohmic contact with an underlying doped semiconductor region (e.g., a gate, a base, etc.). In IGBTs and MOSFETs a dielectric layer may electrically isolate a gate terminal pad from an underlying gate. A BJT or BBJT base terminal pad may be in electrical or ohmic contact with an underlying base.

Current terminal and control terminal pads may be formed on the same side or surface of a transistor. The current terminal pad(s) in a transistor may have outwardly facing flat surface areas that may be larger than those of the transistor's control terminal pad(s). Current terminals pads may have flat surfaces that may be exposed and configured for connection (e.g., sintered connection) directly to corresponding flat surfaces of die clips, die substrates, paddles, pedestals, etc. Current terminal pads may have a surface area with a size that enables substantial heat transfer when electrically and thermally connected to die clips, paddles, pedestals, etc., and the larger the surface area connection the more heat can be transferred. First current terminal pad surfaces (e.g., drain and collector terminal pad surfaces of MOSFETs and IGBTs (or BJTs), respectively) may have a flat surface area of 1, 2, 3, 4, 5, 6, 8, 10, 15, 20, 40 mm² or more. Second current terminal pad surfaces (e.g., source and emitter terminal pad surfaces of MOSFETs and IGBTs (or BJTs), respectively) may have a flat surface area of 1, 2, 3, 4, 6, 8, 10, 15, 20, 40 mm² or more. Exposed flat surfaces of current terminal pads on a side of a transistor may be contained in a common plane.

Exposed flat surfaces of control terminal pads in a transistor (e.g., a BBJT more fully described below) may be contained in a common plane. Control terminal pads may also have flat surfaces that may be connected (e.g., wire bonded, soldered, sintered, etc.) to bond-wires, signal frames, control-terminal posts, etc. Unless otherwise stated in this disclosure, a flat end surface area of a control-terminal post contacts most (i.e., 51%-100%) of the outwardly facing surface area of a control terminal pad through a connection such as a sintered connection, soldered connection, etc.

Outwardly facing flat surfaces of control terminal and current terminal pads in a transistor may be in the same plane. Outwardly facing flat surfaces of current terminal pad(s) in a transistor may be contained in a plane that may be elevated from and parallel to a plane that contains the outwardly facing flat surfaces of control terminal pad(s). The current terminal pad(s) in a transistor may be manufactured with a height that may be greater than the height of the control terminal pad(s) so that a flat surface of a die substrate or die clip may be directly connected (e.g., sintered, soldered, etc.) to flat surfaces of the current terminal pad(s) while avoiding contact with the control terminal pad(s). An etched layer of photoresist may be formed on a wafer that exposes current terminal (e.g., source terminals) pad(s) while covering control terminal (gate terminal) pad(s). Metal could then be deposited to increase the height of the current terminal pad(s). Thereafter the photoresist layer may be removed to leave exposed surface(s) of the current terminal pad(s) contained in a common plane that may be higher than the common plane that contains the surface(s) of the control terminal pad(s). The added height given to the current terminal pad(s) may be viewed as “pedestals.”

Outwardly facing flat surfaces of terminal pads on top and bottom sides of a transistor or a diode may face opposite directions. In general, an outward pointing vector normal to the average elevation of first surface of a pair of oppositely facing surfaces, may point an opposite direction with respect to an outward pointing vector normal to the average elevation of the second surface of the pair of oppositely facing surfaces.

FIG. 2F shows a top or overhead-view of an example, vertically structured BBJT 250 with example current terminal pads and control terminal pads. FIG. 2G shows a partial cross-sectional view of BBJT 250 taken along line 1-1 in FIG. 2F. General principles of several transistor features, such as control and current terminal pads, are described with reference to BBJT 250, it being understood transistor features should not be limited to that shown in FIGS. 2F and 2G.

Example current and control terminal pads are shown in FIGS. 2G and 2F. With respect to FIG. 2F, BBJT may include a first (e.g., top) substantially flat surface 252 and an opposite facing second (e.g., bottom) and substantially flat surface 254. Control terminal pads and current terminal pads may have substantially flat, outwardly facing surfaces. The control terminal pads, and current terminal pads may be substantially flat entirely across their outwardly facing surfaces.

FIG. 2G shows collector/emitter regions 256 on one side that may form a junction with a drift or bulk substrate 258, and collector/emitter terminal pads 262 that may be electrically connected to respective collector/emitters regions 256. Collector/emitter terminal pads 262 define exposed and substantially flat surfaces 280. FIG. 2G shows base region 260 disposed between the collector/emitter regions 256, and a base terminal pad 264 that may be electrically connected to base region 260. Base terminal pad 264 defines an exposed and substantially flat surface 282. Surfaces 280 and 282 may be contained in a common plane, it being understood surfaces 280 may be contained in a plane that is higher or lower than the plane that contains surface 282. FIG. 2G shows collector/emitter regions 270 on the opposite side that may form a junction with bulk substrate 258, and collector/emitter terminal pads 272 that electrically couple to respective collector/emitter regions 270. Collector/emitter terminal pads 272 define exposed and substantially flat surfaces 284. Unlike many transistors, BBJT 250 has control terminals (i.e., base terminals) on both sides. FIG. 2G shows base region 276, and a base terminal pad 278 that are electrically coupled to the base region 276. Base terminal pad 278 defines an exposed and substantially flat surface 286. Surfaces 284 and 286 are contained in a common plane, it being understood surfaces 284 may be contained in a plane that is higher or lower than the plane that contains surface 286. Although not shown in FIG. 2G, BBJTs may include several collector/emitter regions and several base regions on both sides. In FIG. 2G, only two collector/emitter terminal pads are shown, and only one base terminal pad is shown on each side; however, two or more collector/emitter terminal pads may be implemented BBJTs on each side, and two or more base terminal pads may be implemented in BBJTs on each side. Terminal pads may be formed by depositing a metallic material through windows in an insulation material (not shown) covering a side of a transistor such as a BBJT.

The width wbt of BBJT 250 may be between 6 and 14 mm, and the length lbt may be between 6 and 14 mm. The width of surface areas 280 and 284 may be between 0.5 and 3 mm, and the length of surface areas 280 and 284 may be between 5 and 13 mm. The width of surface areas 282 and 286 may be between 0.5 and 3 mm, and the length of surface areas 282 and 286 may be between 5 and 13 mm. Pedestals may be attached (e.g., sintered, soldered, etc.) to current terminal pads such as collector/emitter pads 262 and 272. Pedestals may have flat end surface areas with widths and lengths substantially equal to, slightly smaller than, or slightly larger than the widths and lengths of surface areas 280 or 284 to which the pedestals may be attached (e.g., sintered, soldered, etc.). Pedestals may have a consistent cross-sectional area along the axial length between flat end surfaces. Control-terminal posts may be attached (e.g., sintered, soldered, etc.) to control terminal pads such as base terminal pads 264 and 268. Control-terminal posts may have flat end surface areas with widths and lengths substantially equal to the widths and lengths of surface areas 282 or 286 to which the posts may be attached (e.g., sintered, soldered, etc.). Alternatively, control-terminal posts may have flat end surface areas with widths substantially equal to the widths of control terminal pads to which the posts may be attached (e.g., sintered, soldered, etc.), and lengths that may be substantially longer than the lengths of the control terminal pads. Control-terminal posts may have a consistent cross-sectional area along the axial length between flat end surfaces. Pedestals and control-terminal posts attached to collector/emitter terminal pad surfaces 280 and base terminal pad surfaces 282, respectively, should be sized so that collector/emitter terminal pads 262 and base terminal pads 264 are electrically isolated from each other. Likewise, pedestals attached to collector/emitter terminal pad surfaces 284 and control-terminal posts attached to base terminal pad surfaces 286 should be sized so that collector/emitter terminal pads 272 and base terminal pads 278 are electrically isolated from each other.

The example BBJT 250 is an NPN structure, which means the collector/emitter regions 256 and 270 may be N-type, the bases regions 260 and 276 may be P-type, and the bulk substrate 258 is P-type. PNP-type BBJTs may be also contemplated; however, to not unduly lengthen this disclosure, a PNP-type BBJT is not specifically shown.

A switch can transmit high levels of current (e.g., 1, 5, 10, 50, 100, 200, 400 A or more) between a die clip and a die substrate without failure depending on the size (e.g., current terminal width and length), type (e.g., MOSFET), semiconductor material (e.g., SiC, GaN, etc.), and number of transistors connected in parallel. A transistor can transmit high levels of current (e.g., 1, 5, 10, 50, 100, 200, 400 A or more) between its current terminals at high switching speeds (e.g., up to 100 kHz or more for Si IGBTs, up to 500 kHz or more for SiC MOSFETs, up to 1.0 GHz or more for GaN MOSFETs, etc.). When thermally connected to and cooled by heat sinks or bus bars that also act as heat sinks, transistors in a switch may be able to transmit more current at higher switching speeds without breaking, delaminating, or degrading. Likewise, when thermally connected to and cooled by heat sinks or bus bars that also act as heat sinks, diodes may be able to transmit more current (e.g., 1, 5, 10, 50, 100, 200, 400 A or more) without breaking, delaminating, or degrading.

Switches may be electrically and thermally connected to and sandwiched between die substrates and die clips. The first current terminal (e.g., collector terminal, drain terminal, top collector/emitter terminal, etc.) pad(s) and the second current terminal (e.g., emitter terminal, source terminal, bottom collector/emitter terminal, etc.) pad(s) of a transistor in a switch may be directly or indirectly connected electrically and thermally to a die substrate and a die clip, respectively, or vice versa. The flat surface(s) of the first current terminal pad(s) and the flat surface(s) of the second current terminal pad(s) of a transistor in a switch may be indirectly connected electrically and thermally to flat surfaces of a die substrate and a die clip, respectively, or vice versa. The flat surface(s) of the first current terminal pad(s) of a transistor in a switch may be directly connected electrically and thermally to a flat surface of a die substrate while the flat surface(s) of the second current terminal pad(s) may be indirectly connected electrically and thermally to a flat surface of a die clip, or vice versa. The flat surface(s) of the first current terminal pad(s) of a transistor in a switch may be directly connected electrically and thermally to a flat surface of a die clip and the flat surface(s) of the second current terminal pad(s) may be directly connected electrically and thermally to a flat surface of a die substrate, or vice versa. A direct connection may include only sintering material or other type of bonding material, such as solder, between a current terminal pad surface and a surface of a die substrate or a die clip. A current terminal pad can be indirectly connected electrically and thermally to a die clip or die substrate through an electrically and thermally conductive pedestal or bridge with a flat end surface that may be sintered to a flat surface of the current terminal pad. A flat end surface area of a pedestal or bridge may directly connect to most (i.e., 51%-100%) of the outwardly facing surface area of a current terminal pad through a connection such as a sintered connection, soldered connection, etc.

Control-terminal pads of a transistor in a switch should not be electrically connected to a die substrate or die clip. Control-terminal pads of a transistor in a switch may or may not be thermally connected to a die substrate or die clip through, for example, control-terminal posts.

A switch may include multiple transistors, each of which may be electrically and thermally connected to and sandwiched between the die clip and the die substrate. Flat surfaces of first current terminal pads and flat surfaces of second current terminal pads of parallel connected transistors in a switch may be directly or indirectly connected electrically and thermally to the flat surfaces of a die substrate and a die clip, respectively, or vice versa. The flat surface(s) of the first current terminal (e.g., collector) pad(s) of a first transistor (e.g., a first RB-IGBT, RB-IGCT, etc.) in a switch and the flat surface(s) of the second current terminal (e.g., emitter) pad(s) of a second transistor (e.g., a second RB-IGBT, RB-IGCT, etc.) in the switch may be directly or indirectly connected electrically and thermally to a flat surface of a die substrate, while the flat surface(s) of the second current terminal (e.g., emitter) pad(s) of the first transistor and the flat surface(s) of the first current terminal (e.g., collector) pad(s) of the second transistor may be directly or indirectly connected electrically and thermally to a flat surface of a die clip, or vice versa. Flat surfaces of first current terminal (e.g., drain) pads of first and second transistors in a switch may be directly or indirectly connected electrically and thermally to flat surfaces of a die substrate and a die clip, respectively, while second current terminal (e.g., source) pads of the first and second transistors may be indirectly connected electrically and thermally to each other.

The control terminal(s) (e.g., gate terminal, base terminal, etc.) of one or more transistors in a switch may be controlled by a voltage signal or a current signal from a driver, or control terminals of respective transistors or respective groups of transistors in a switch may be controlled by respective voltage signals or current signals from respective drivers. Different types of transistors may need different types of drivers for effective control. A driver may be configured to separately control different types of transistors. Control terminals of a BBJT may be controlled by the separate signals from a driver, or by separate transistor control signals from respective drivers.

Control terminal (e.g., gates) pad(s) may be positioned on only one side of some transistors (e.g., MOSFETs and IGBTs), or control terminal pads may be positioned on opposite sides of other transistors (e.g., BBJTs). The control terminal pad(s) may be positioned adjacent to current terminal (e.g., source terminal or emitter terminal) pad(s) in some transistors (e.g., MOSFETs or IGBTs), or control terminal pads may be positioned between current terminal (e.g., collector/emitter terminal) pads in other transistors (e.g., BBJTs).

A transistor control signal may be carried from a driver to a control terminal pad in an electrical path that may include a lead, trace, strap, bond-wire, signal frame, control-terminal post, etc., or a serially connected combination of two or more thereof. A bond-wire may be wire-bonded to a control terminal pad in some switch modules. A signal frame may be connected (e.g., soldered) to one or more control terminal pads in some switch modules. A control-terminal post may be connected (e.g., soldered or sintered) to a control terminal pad in some switch modules.

One or more pedestals may be electrically and thermally connected to and positioned between a transistor and a die clip, paddle, bridge or die substrate. The pedestals can provide space beneath the die clip, paddle or die substrate for bond-wires, signal frames, straps, PCBs, temperature sensors, etc. In some power stacks, one or more pedestals may be electrically and thermally connected to and positioned between a transistor and a die clip, and/or one or more pedestals may be electrically and thermally connected between the transistor and a paddle or die substrate. Pedestals can be sized so that liquid mold compound (e.g., liquid resin) can flow around them and/or between them during transfer mold packaging of switch modules or diode modules to create packages in which the mold compound (e.g., resin) fills spaces between and electrically isolates exposed surfaces of die clips and die substrate that face each other. The mold compound may also cover some or all exposed surfaces of bond-wires, straps, signal frames, current terminal pads, control terminal pads, drivers, etc. One or more control-terminal posts may be thermally connected to and positioned between a transistor and a die clip, paddle, or die substrate. In some embodiments, a power stack is not packaged in plastic so that a dielectric fluid can flow over exposed surfaces of the power stack's die substrate, die clip, pedestals, control-terminal posts, transistors, etc. One or more control-terminal posts may be thermally connected to and positioned between a transistor and a die clip, and/or one or more control-terminal posts may be electrically and thermally connected between the transistor and a paddle or die substrate. Control-terminal posts and pedestals connected to control terminals and current terminals, respectively, on the same side of a transistor may have substantially the same height so that their end surfaces to be attached (e.g., sintered, soldered, etc.) to a die clip or die substrate, are contained in the same plane. Control-terminal posts may be positioned between pedestals.

One or more diodes may be electrically and thermally connected to and sandwiched between die substrates and die clips. The flat surface of a first current terminal (e.g., anode terminal) pad(s) and the flat surface of a second current terminal (e.g., cathode terminal) pad(s) of a diode may be directly or indirectly connected electrically and thermally to a die substrate and a die clip, respectively, or vice versa. Like switches, a diode current terminal pad can be indirectly connected to a die substrate or die clip through a pedestal or bridge that is sintered to the pad. A direct connection between a diode current terminal pad and a die clip or die substrate may include only sintering or other type of bonding material, such as solder. A first current terminal pad and a second current terminal pad of a diode may be directly connected (e.g., sintered, soldered, etc.) to respective flat surfaces of a die clip and a die substrate.

A die clip can transmit substantial current into or out of a packaged switch or packaged diode through its die clip terminal while concurrently transmitting substantial heat out of the packaged switch or packaged diode through its die clip terminal. A die substrate can transmit substantial current into or out of a packaged switch or packaged diode through its die substrate terminal while concurrently transmitting substantial heat out of the packaged switch or packaged diode through its die substrate terminals.

A pedestal can transmit substantial current into or out of a current terminal pad to which it may be attached (e.g., sintered, soldered, etc.) while concurrently transmitting substantial heat out of the current terminal pad to which it may be attached. A flat end surface of a pedestal can be connected (e.g., sintered, soldered, etc.) directly to a flat surface of only one current terminal pad, or a flat end surface of a pedestal can be connected (e.g., sintered, soldered, etc.) directly to surfaces of multiple current terminal pads in a transistor or diode. Pedestals in a switch module or diode module may be identical in composition and/or structure. Some switch modules may not employ pedestals; opposite facing current terminal pad surfaces in a transistor or diode may be directly connected (e.g., sintered, soldered, etc.) to respective flat surfaces of a die clip and die substrate. Likewise, some packaged diodes may not employ pedestals; opposite facing current terminal pad surfaces may be directly connected (e.g., sintered, soldered, etc.) to respective flat surfaces of a die clip and die substrate. A control-terminal post can transmit substantial heat out of a control terminal pad to which it may be attached (e.g., sintered, soldered, etc.). A flat end surface of a control-terminal post can be connected (e.g., sintered, soldered, etc.) directly to a flat surface of only one control terminal pad, or a flat end surface of a control-terminal post can be connected (e.g., sintered, soldered, etc.) directly to surfaces of multiple control terminal pads in a transistor. Control-terminal posts in a switch module may be identical in composition and/or structure. Some switch modules may not employ control-terminal posts.

Power stacks may include electrically and thermally conductive components such as bridges and paddles more fully described below. Pedestals and other components (e.g., bridges) may provide a low resistive path (e.g., electrical resistance (e.g., 1, 0.5, 0.1, 0.01, 0.001 ohms or lower) and thermal resistance (e.g., 1, 0.5, 0.1, 0.01, 0.001 C/W or lower)) path between current terminal pads and die clips or die substrates. The flat end surfaces of pedestals or bridges may be directly attached (e.g., sintered, soldered, etc.) to flat surfaces of current terminal pads, while the opposite facing flat end surfaces of the pedestals or bridges may be directly attached (e.g., sintered, soldered, etc.) to the flat surface(s) of a die clip, paddle or die substrate. The oppositely facing end surfaces of a pedestal may be directly attached to respective current terminal (e.g., source) pads of a pair of transistors that may be connected back-to-back. Control-terminal posts may provide a path of low thermal resistance (e.g., 5, 1, 0.5, 0.1, 0.01 C/W or lower) between control terminal pads and die clips, paddles, or die substrates. However, the control-terminal posts should electrically isolate the control terminals from the die clips, paddles, or die substrates. The flat end surfaces of control-terminal posts may be directly attached (e.g., sintered, soldered, etc.) to flat surfaces of control terminal pads, while the opposite facing flat end surfaces of the control-terminal posts may be directly attached (e.g., sintered, soldered, etc.) to the flat surface(s) of a die clip, paddle or die substrate.

Die substrates, die clips, and paddles in a power stack may have different shapes, sizes, and/or compositions, or they may be substantially identical in size, shape, and/or composition. Die substrates, die clips, pedestals, paddles, metal bases for control-terminal posts, and bridges may be formed using the same or different methods. Die substrates, die clips, pedestals, paddles, metal bases for control-terminal posts, and bridges may be 3-D printed. Die substrates, die clips, paddles, pedestals, metal bases for control-terminal posts, and bridges may be extruded. Die substrates, die clips, paddles, pedestals, metal bases for control-terminal posts, and bridges may be formed through a sintering process in which a solid mass may be formed by applying pressure and heat to a sintering powder in a mold without melting it to the point of liquefaction. Die substrates, die clips, pedestals, paddles, metal bases for control-terminal posts, and bridges may be formed from a thin sheet of thermally and electrically conductive material such as metal, alloy, metal composite (e.g. copper-graphite), etc. Die substrates, die clips, paddles, pedestals, control-terminal posts, bridges, etc. may include a thin layer of sintering enhancement material (e.g., silver, silver alloy, etc.) on some or all their exposed surfaces, or between some or all their metal layers. Barrel plating may be used to form the thin layer of sintering enhancement material. A barrel plating process involves placing the items (e.g., sheets from which pedestals, die substrates, die clips, metal bases of control-posts, etc., may be formed, or pedestals, die substrates, etc., after they are formed from sheets that lack a sintering enhancement layer) in a barrel-shaped cage that may be manufactured from nonconductive material. The cage may be then submerged into a tank containing the appropriate chemical solution, while a slow tumbling action may be used to commence the plating action. Die substrates, pedestals, die clips, bridges, paddles, etc., should lack a dielectric element. Control-terminal posts should include a dielectric element to electrically isolate a control-terminal pad from a die substrate, paddle, or die clip.

Die clips, die substrates, paddles, pedestals, bridges, metal bases for control-terminal posts, etc., may be formed (e.g., machined, cut, stamped, sawed, diced, etc.) from a thin (e.g., 10.0, 5.0, 2.5, 1.0, 0.5, 0.1 mm or less) sheet of metal. The term metal includes pure metal (e.g., copper, iron, nickel, aluminum, gold, silver, molybdenum, etc.), metal alloys, or metal composites. Or die clips, die substrates, paddles, pedestals, bridges, metal bases for control-terminal posts, etc., may be formed (e.g., machined, cut, stamped, sawed, diced, etc.) from a thin (e.g., 10.0, 5.0, 2.5, 1.0, 0.5, 0.1 mm or less) sheet with multiple layers of metal. One or more of the layers of a layered sheet may be formed of a sintering enhancement material.

A thin (e.g., 10.0, 5.0, 2.5, 1.0, 0.5, 0.1 mm or less) sheet from which die substrates, die clips, paddles, pedestals, metal bases for control-terminal posts, or bridges may be formed (e.g., machined, cut, stamped, sawed, diced, etc.), may be layered. Two or more layers in a layered sheet may be substantially uniform in thickness. Each layer in a layered sheet may be a metal. One or more layers in a layered sheet may be a first type of metal, while one or more layers in the layered sheet may be a second type of metal. A layered sheet may have three or more layers of different types of metals.

FIG. 2H shows a side view of a portion of layered sheet 265 from which pedestals, paddles, bridges, die clips, die substrates or other components can be formed. Layered sheet 265 may be 0.5-1.5 mm between first and second oppositely facing flat surfaces 275s and 277s. Section 271 consists of a central layer 266 of electrically conductive material (e.g., copper, aluminum, molybdenum, copper/diamond, copper/molybdenum, copper/tungsten, etc.) between layers 267 of metal (e.g., copper). A die substrate, die clip, paddle, pedestal, or bridge that is connected (e.g., sintered, soldered, etc.) directly to a terminal pad surface of a SiC transistor or SiC diode, is presumed to be formed from layered sheet 265 with molybdenum layer 266 and copper layers 267 unless otherwise noted. A die substrate, die clip, paddle, pedestal, or bridge that is connected (e.g., sintered, soldered, etc.) directly to a terminal pad surface of another device such as a GaN transistor or GaN diode, may be formed from layered sheet 265 with molybdenum layer 266 and copper layers 267. Section 271 may be sandwiched between metal (e.g., nickel) layers 268. Section 273 may be sandwiched between metal layers 269 of sintering enhancement material (silver, silver alloy, etc.). For purposes of explanation only, layers 268 may be nickel and layers 269 may be silver, it being understood the present disclosure should not be limited thereto. A layer 268 of nickel or other material may prevent migration of copper in layer 267 into a layer 269 of silver. Layers 268 may be formed (e.g., electroplated) on layers 267. Layers 269 may be formed (e.g., electroplated) on layers 268. Layers 268 and/or 269 can be added to pedestals, paddles, bridges, die clips, die substrates or other components after they are formed from a sheet with only layers 266 and 267. Pedestals, paddles, bridges, die clips, die substrates or other components without layers 268 and/or 269 may be suitable for use in embodiments in which the pedestals, paddles, bridges, die clips, die substrates or other components are connected to terminal pads of a transistor or diode using a method (e.g., soldering) other than sintering.

FIG. 2I shows a side view of a portion of layered sheet 279 from which pedestals, paddles, bridges, die clips, die substrates or other components can be formed. Layered sheet 279 may be 0.5-1.5 mm between first and second oppositely facing flat surfaces 275s and 277s. Section 281 consists of a central layer 283 of metal (e.g., copper). For purposes of explanation only, a die substrate, die clip, paddle, pedestal, or bridge that is connected (e.g., sintered, soldered, etc.) directly to a terminal pad surface of a Si transistor or Si diode, is presumed to be formed from layered sheet 279 with copper layer 283 unless otherwise noted. A die substrate, die clip, paddle, pedestal, or bridge that is connected (e.g., sintered, soldered, etc.) directly to a terminal pad surface of another device such as a GaN transistor or GaN diode, may be formed from layered sheet 279 with copper layer 283. Layer 283 is sandwiched between metal layers 268 (e.g., nickel) as shown. Section 281 may be sandwiched between metal layers 269 of sintering enhancement material (silver, silver alloy, etc.). For purposes of explanation only, layers 268 are nickel and layers 269 are silver, it being understood the present disclosure should not be limited thereto. Nickel layers 268 may be formed (e.g., electroplated) on layer 283. Silver layers 269 may be formed (e.g., electroplated) on layers 268. Layers 268 and 269 can be added to pedestals, paddles, bridges, die clips, die substrates or other components after they are formed from a sheet of only copper layer 283.

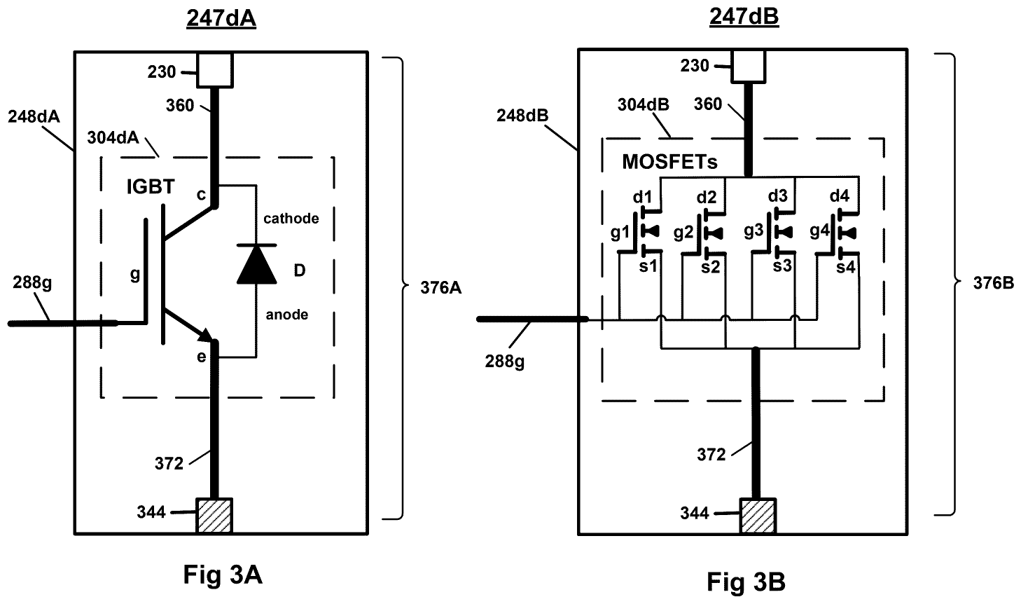

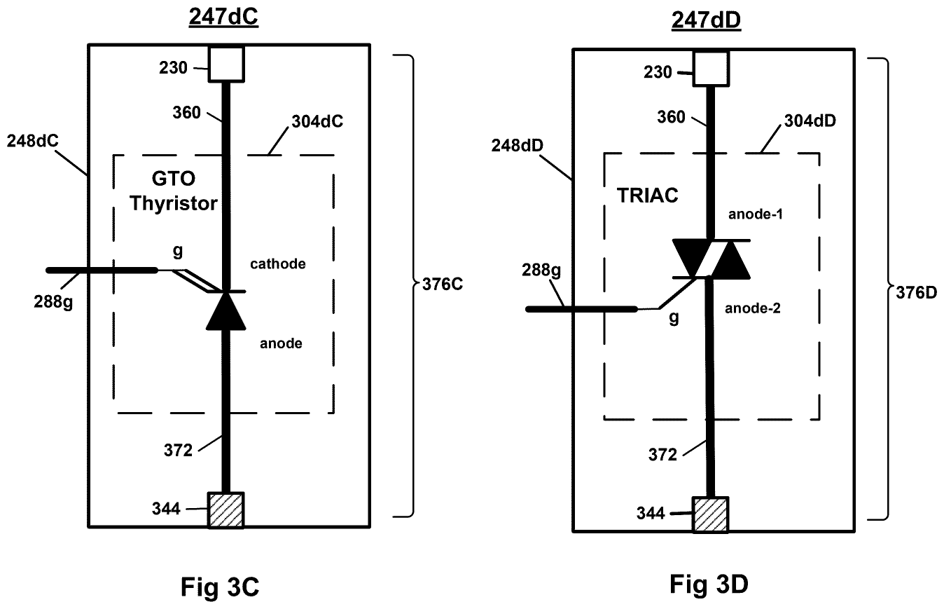

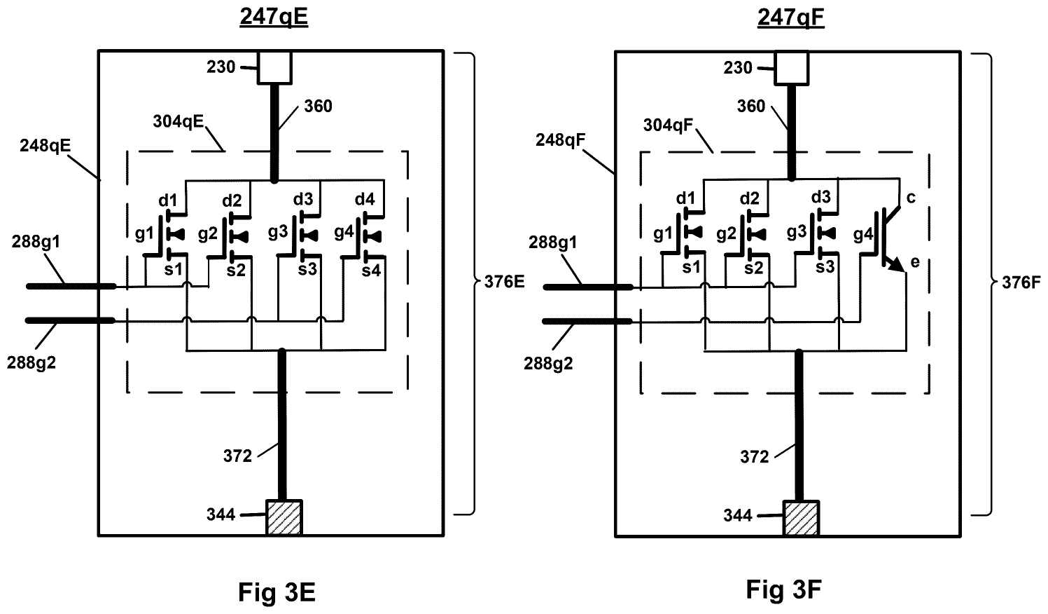

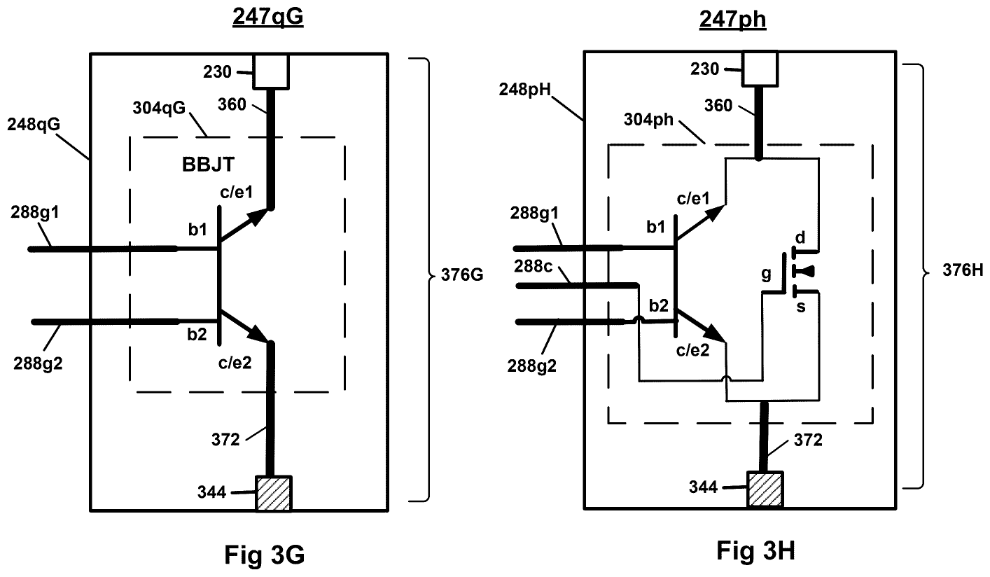

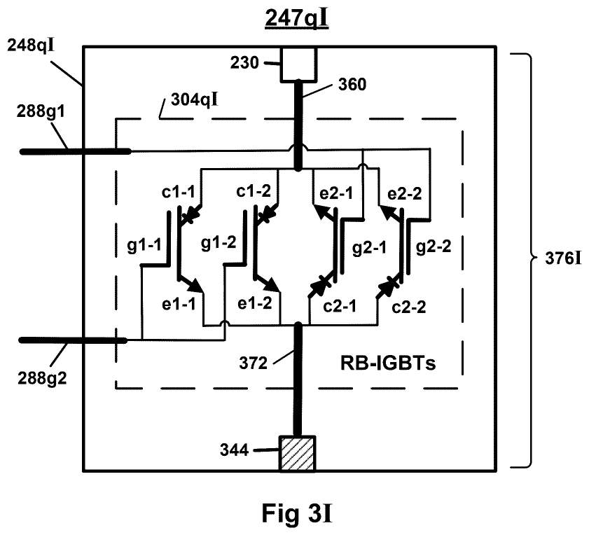

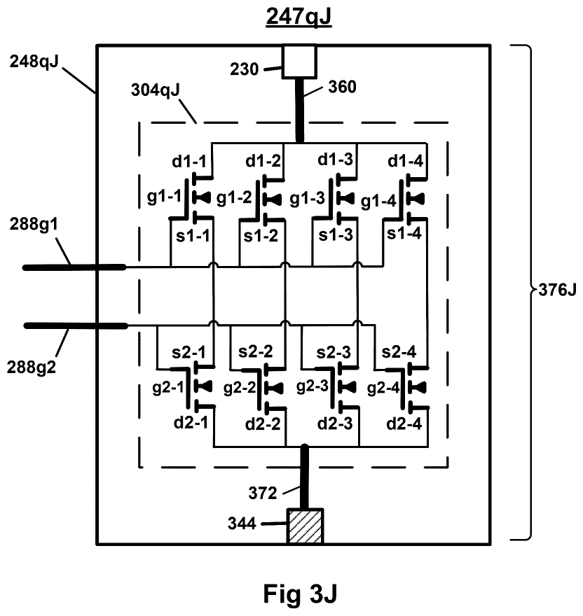

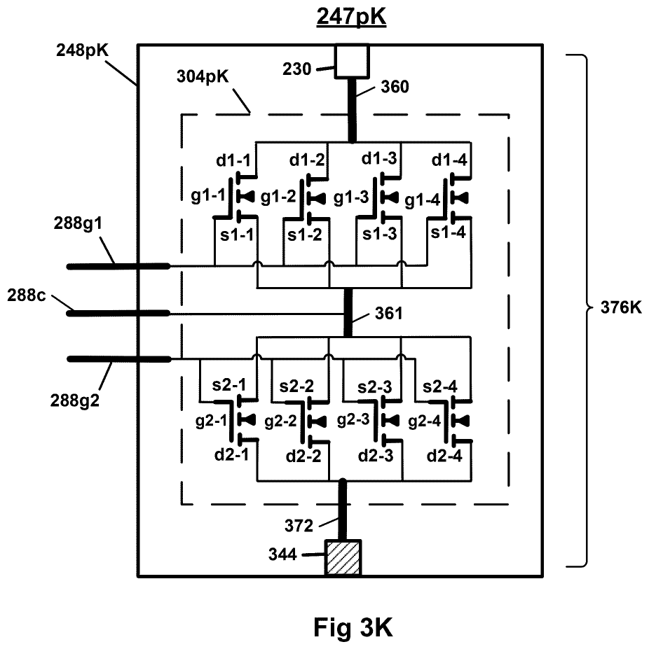

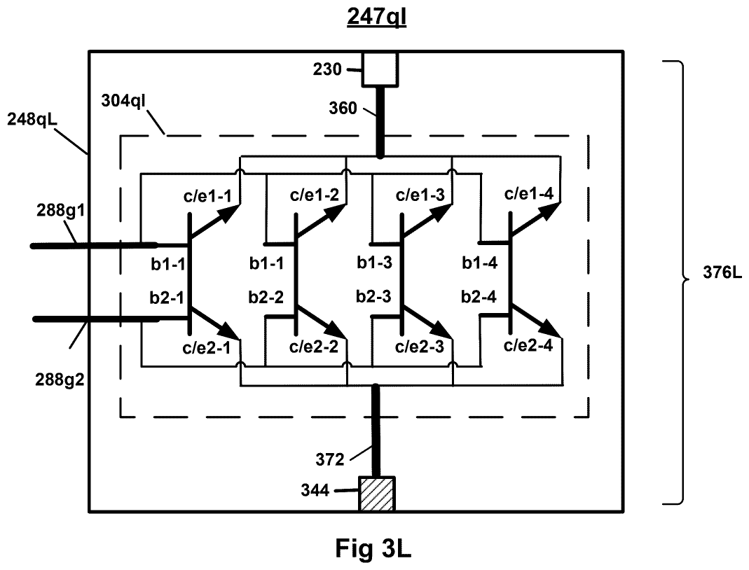

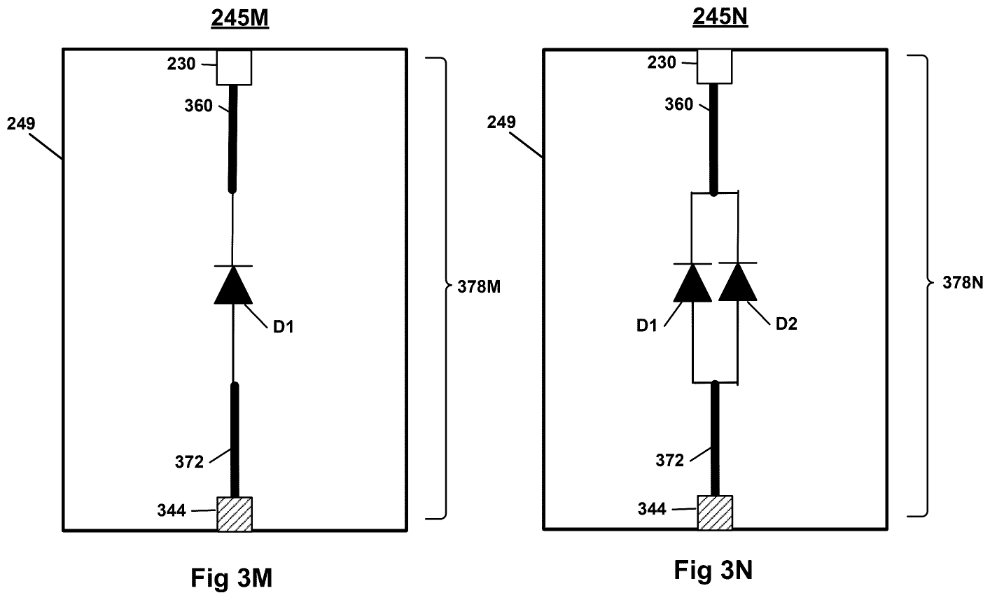

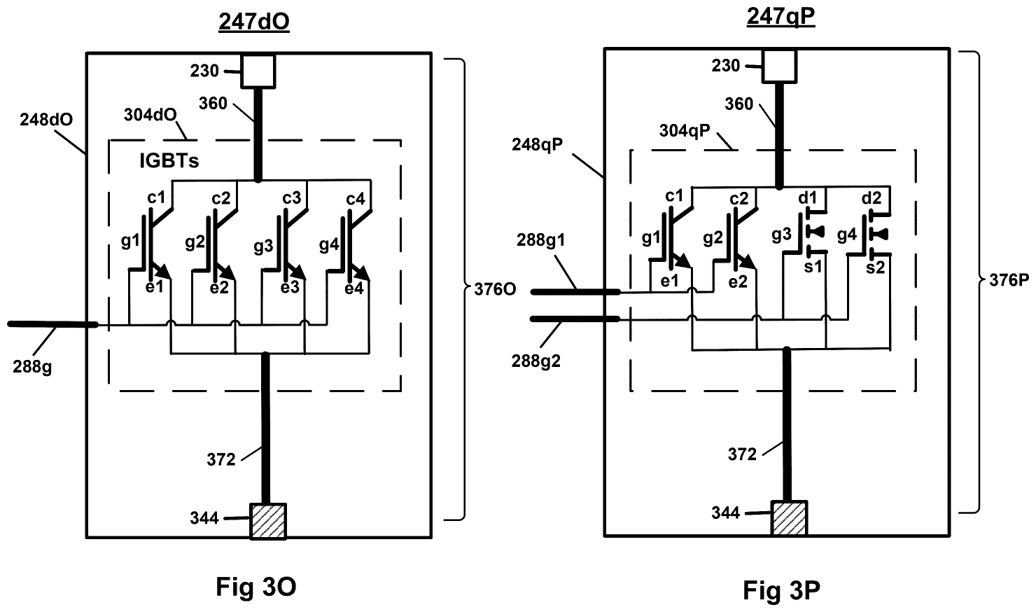

FIG. 2J-1 shows a side view of a portion of layered sheet 285 from which a base of a control-terminal post or other component can be formed. Layered sheet 285 may be 0.5-1.5 mm between oppositely facing flat surfaces. Section 271 consists of a central layer 266 of metal (e.g., molybdenum, copper/diamond, copper/molybdenum, copper/tungsten, etc.) between layers 267 of metal (e.g., copper, etc.). For purposes of explanation only, a control-terminal post or other component connected (e.g., sintered, soldered, etc.) directly to a control terminal pad surface of a SiC transistor (e.g., SiC based BBJT) is presumed to be formed from layered sheet 285 with molybdenum layer 266 and copper layers 267 unless otherwise noted. Layer 268 may be formed (e.g., electroplated) on layer 267-2. A layer of sintering enhancement material (e.g., silver or silver alloy) 269-2 can be formed (e.g., electroplated) on layer 268. For purposes of explanation only, layer 268 is nickel and layer 269 is silver. A base of a control-terminal post can be formed (e.g., machined, cut, stamped, sawed, diced, etc.) from sheet 285. FIG. 2J-2 shows a side view of base 287 formed from layered sheet 285. A thin (e.g., 0.05-0.2 mm) dielectric (e.g., ceramic) layer 289 may be formed on base 287 using any one of many techniques such as thermal spraying, physical vapor deposition, chemical vapor deposition, sol-gel process, etc. In the sol-gel process, a liquid precursor (sol) may be deposited on the exposed layer 267-1, and then transformed into a solid (gel). The coated part may then be heat-treated to remove organic components and to convert the gel into a ceramic layer 289. This technique allows for precise control over the thickness td of layer 289. FIG. 2J-3 shows a current-terminal post 291 which can be made by forming a layer 290 of metal (e.g., silver, nickel, copper, etc.) on the exposed flat surface of dielectric layer 289 of FIG. 2J-2. Physical vapor deposition, chemical vapor deposition, etc., could be used to form metal layer 290. An adhesion layer may be needed on the exposed surface of dielectric layer 289 before metal layer 290 is formed thereon. Materials like chromium or titanium may often be used as an intermediate layer to enhance the adhesion of metal layer 290 to dielectric layer 289. Layers 269-2 and 290 of post 291 may be formed of sintering enhancement material (e.g., sliver). Control-terminal posts or other components without layers 268 and 269-2, and with layer 290 formed of a metal other than silver (e.g., copper), may be suitable for use in embodiments in which the posts or other components are connected to a transistor using a method other than sintering (e.g., soldering).

FIG. 2K-1 shows a side view of a portion of layered sheet 291 from which control-terminal posts or other components can be formed. Layered sheet 291 may be 0.5-1.5 mm between oppositely facing flat surfaces. Sheet 291 consists of a layer 268 of metal (e.g., nickel) between metal layers 283 (e.g., copper) and 269-2 (e.g., silver). Control-terminal posts formed from layered sheet 291 with copper layer 283, nickel layer 268, and silver layer 269-2, may be well suited for attachment (e.g., sintered attachment) to terminals of non-SiC based transistors (e.g., Si based transistors) such as Si BBJTs. Layers 268 may be formed (e.g., electroplated) on layer 283. Layer 269-2 may be formed (e.g., electroplated) on layer 268. For purposes of explanation only, layers 268 may be nickel and layers 269 may be silver or silver alloy. A base of a control-terminal post can be formed (e.g., machined, cut, stamped, sawed, diced, etc.) from sheet 291. FIG. 2K-2 shows a side view of base 293 that may be formed from layered sheet 291. A dielectric layer 289 may be formed on base 293 using any one of many techniques such as thermal spraying, physical vapor deposition, chemical vapor deposition, sol-gel process, etc. FIG. 2K-3 shows a current-terminal post 295, which can be made by forming a layer 290 of metal (e.g., silver, nickel, copper, etc.) on the exposed flat surface of dielectric layer 289 of FIG. 2K-2. Physical vapor deposition, chemical vapor deposition, etc., could be used to form metal layer 290. An adhesion layer may be needed on the exposed surface of dielectric layer 289 before metal layer 290 is formed thereon. Layers 290 and 269-2 of post 295 may be sintering enhancement material (e.g., sliver). Control-terminal posts or other components without layers 268 and 269-2, and with layer 290 formed of a metal other than silver (e.g., copper), may be suitable for use in embodiments in which the posts or other components are connected to a transistor using a method other than sintering (e.g., soldering).

FIG. 2L shows a side view of a control-terminal post 297, which may include a base layer 299 formed of a dielectric (e.g., aluminum nitride) sandwiched between layers 290 of metal (e.g., silver, copper, nickel, etc.) Control-terminal post 297 may be 0.5-1.5 mm between oppositely facing flat surfaces 277 and 275. Physical vapor deposition, chemical vapor deposition, etc., could be used to form metal layers 290. An adhesion layer might be needed on the exposed surface of ceramic layer 299 before metal layers 290 may be formed thereon.

Pedestals connected to current terminals on the same side of a transistor should have substantially the same thickness between their opposite facing flat end surfaces. Control-terminal posts connected to control terminals on the same side of a transistor should have substantially the same thickness between their opposite facing flat end surfaces. Pedestals and control-terminal posts connected to current terminals and control terminals, respectively, on the same side of a transistor should have substantially the same thickness between their opposite facing flat end surfaces.

Layer 266 in FIGS. 2H and 2J-1-2J-3 may have a thickness tc that may be substantially equal to the thickness t1 of layers 267. For example, tc and t1 may both be 0.30-0.35 mm. Layer 266 may have a thickness tc greater than or less than the thickness t1 of layers 267. For example, layer 266 may be two times or four times thicker than layer 267, or layer 266 may be one half or less as thick as layer 267. Layers 268 and 269 in FIGS. 2H-2K-3 may be substantially equal in thickness. For example, each of t2 and t3 may be 0.005-0.015 mm.

Properties such as thickness tc and t1, and composition of flat layers 266 and 267 may vary. Layers 267 may have higher thermal conductivity and provide more efficient heat spreading qualities when compared to layer 266. Central layer 266 may have a coefficient of thermal expansion (CTE) that may be lower than that of layers 267. As more fully noted below, CTE may be a factor in the mechanical integrity of a connection between a bridge, pedestal, die substrate, paddle, die clip, control-terminal post, etc., and a transistor or diode.

A flat surface of a current terminal pad (e.g., drain pad) may be electrically and thermally connected (e.g., sintered, soldered, etc.) directly to the flat surface of a bridge, pedestal, die substrate, paddle, die clip, etc., formed from sheet 265 or 279. A flat surface of a control-terminal pad may be electrically and thermally connected (e.g., sintered, soldered, etc.) directly to a flat surface (e.g., 277 in FIG. 2J-3, 2K-3, or 2L) of a control-terminal post (e.g., 291, 295, or 297), and the flat surface of a die substrate, die clip, or paddle may be electrically and thermally connected (e.g., sintered, soldered, etc.) directly to the flat surface (e.g., 275 in FIG. 2J-3, 2K-3, or 2L) of a control-terminal post (e.g., 291, 295, or 297). A sintered connection may be formed using, for example, a silver or copper sintering paste or preform applied to the surface(s) of items to be sintered. Components with different CTEs may expand and contract at different rates with a change in temperature. The composition and/or thickness of layers 266 and 267 in FIGS. 2H and 2J-3 may be selected so that the CTE of a die substrate, die clip, pedestal, paddle, bridge, control-terminal post etc., is close to or substantially equal to the CTE of the transistor or diode to which the die substrate, die clip, pedestal, paddle, bridge, control-terminal post, etc., is connected (e.g., sintered, soldered, etc.). Substantially equal CTEs may reduce the chance, for example, a MOSFET drain terminal pad detaches or delaminates from the surface of a die substrate due to mechanical stress or strain caused by substantial differences in expansion or contraction rates between the die substrate and the MOSFET when the temperature of the MOSFET cycles between hot and cold. The composition and/or thicknesses of layers 266 and 267 of a bridge, pedestal, die substrate, paddle, die clip surface, control-terminal post, etc., may be chosen based on one or more factors such as the type of transistor or diode to which it may be attached. For example, a molybdenum or molybdenum/copper layer 266 between copper layers 267 of a die substrate may give it a CTE that may be close or substantially equal in value to the CTE of a SiC MOSFET to which the die substrate is silver sinter attached.

Die substrates, die clips, bridges, or paddles may be formed with integrated pedestals. A bridge with integrated pedestals (hereinafter “integrated bridge”) may be formed (machined, cut, stamped, sawed, diced, etc.) from a sheet of metal sheet like that shown in FIGS. 2H and 2I.

A die substrate may have only one terminal exposed through the case of a packaged switch or packaged diode through which heat and current may be simultaneously transmitted. The die substrate terminal may have a substantially flat surface for mechanical, electrical, and thermal mating with a substantially flat surface of, for example, a bus bar. The entire surface of the die substrate terminal may be substantially flat.

A die clip may have only one terminal exposed through the case of the packaged switch or packaged diode through which heat and current may be simultaneously transmitted. A die clip terminal may have a substantially flat surface for mechanical, electrical, and thermal mating with a substantially flat surface of, for example, a bus bar. The entire surface of the die clip terminal may be substantially flat.

The surfaces of die substrate terminals or die clip terminals may be entirely flat and substantially parallel to each other. In addition to being entirely flat and substantially parallel to each other, the surfaces of die substrate terminals and die clip terminals may be substantially flush or coplanar with case surfaces of the packaged switches or packaged diodes. In other versions, the surfaces of die substrate terminals or die clip terminals may be entirely flat, substantially parallel to each other, and recessed below the case surfaces, or they may entirely flat, substantially parallel to each other and protruding beyond the case surfaces. Some die clip terminals may not be exposed through the case of a packaged switch (e.g., packaged switches 247s).

FIGS. 2A-1-2E-2 show example die substrate terminals 230 and example die clip terminals 344. FIGS. 2C-1-2C-3 show an example packaged switch 247s1 in which its die clip terminal is not exposed through case 248s. FIGS. 2A-1-2E-2 have die substrate terminals 230 and die clip terminals 344 with rectangular-shaped, and entirely flat surfaces that may be parallel to and slightly above flat case surfaces of packaged switch 247 and packaged diode 245, even though terminals 230 and 344 may appear in the figures to be flush with the case surfaces.

The size and shape of die substrate terminals or die clip terminals should not be limited to that shown in the figures. In other words, the die substrate terminals and die clip terminals may take different forms, shapes, and sizes. A die clip terminal or a die substrate terminal may include one or more recesses that can mate with similarly shaped extensions of an external device (e.g., phase bus bar, V+ bus bar, V-bus bar, etc., all of which are more fully described below) to facilitate electrical, thermal and/or mechanical connection therebetween. Or a die clip terminal or a die substrate terminal may include one or more extensions that can mate with similarly shaped recesses of an external device (e.g., a phase bus bar, a V+ bus bar, a V-bus bar, etc.,) to facilitate electrical, thermal and/or mechanical connection therebetween.

Current can enter a packaged switch or packaged diode through a die substrate terminal, and then exit through a die clip terminal, or current can flow through a packaged switch or packaged diode in the reverse direction. To illustrate, current can enter packaged switch 247d through die substrate terminal 230 of a die substrate, flow through the die substrate, a switch, a die clip in that order, and then exit packaged switch 247d via die clip terminal 344, or current (e.g., free-wheeling diode current) can flow in the reverse direction in some embodiments. Current can enter packaged diode 245 through die substrate terminal 230 of a die substrate, flow through the die substrate, a diode, a die clip in that order, and then exit packaged diode 245 via die clip terminal 344, or current (e.g., reverse recovery current) can flow in the reverse direction.

Die substrates and die clips can transmit substantial current to or from their connected switches or diodes while concurrently transmitting substantial heat away from their connected switches or diodes. Terminals of die substrates and die clips can transmit substantial current into or out of packaged switches or packaged diodes while concurrently transmitting substantial heat out of packaged switches or packaged diodes. For example, die substrate terminal 230 in FIG. 2A-1, 2B-1, 2C-1, 2D-1, or 2E-1 may be substantially flat and can have a width wds around 14.5 mm or greater and a length lds around 17.5 mm or greater, and may be electrically connected to a substantially flat surface of a bus bar. A die substrate can transmit 10, 20, 50, 100, 200, 400 A or more of current between its connected switch or diode(s) and a bus bar via its die substrate terminal 230. Die clip terminal 344 in FIG. 2A-2, 2B-2, 2D-2, or 2E-2 may be substantially flat, and can have a width wdc around 14.0 mm or greater and a length ldc around 17.0 mm or greater and may be thermally and electrically connected to a substantially flat surface of bus bar. The die clip can transmit 10, 20, 50, 100, 200, 400 A or more of current between its connected switch or diode(s) and the bus bar via its die clip terminal 344. Connector-leads 288ds or 288dc in FIGS. 2A-1-2E-3 can transmit 10, 40, 80, 100, 200 A or more into or out of a packaged switch or packaged diode.

Transistors in a switch may get hot due to conduction and switching losses, especially when they conduct high current at high switching speeds. Diodes can also get hot. A die substrate, depending on its dimensions, can conduct large amounts of transistor and/or diode generated heat out of a packaged switch or packaged diode through its die substrate terminal. For example, die substrate terminal 230 in FIG. 2A-1, 2B-1, 2C-1, 2D-1, or 2E-1 can have a width around 14.5 mm or more and a length around 17.5 mm or more. The substantially flat surface of die substrate terminal 230 may be electrically and thermally connected to a substantially flat surface of heat sink or a bus bar that may also act as a heat sink. Die substrate terminal 230 can transmit 750 Watts or more of heat out of packaged switch 247p, 247q, 247s, or 247d, or packaged diode 245. In other words, a die substrate terminal can transmit 10, 20, 50, 100, 200, 300, 750 Watts or more of heat. A die substrate may be thick (e.g., 0.5, 0.8, 1.0, 2.0, 4.0, 8.0 mm or more when measured between oppositely facing surfaces), and the thicker it is, the more thermal capacitance it provides, which may be important for absorbing a sudden increase in heat from by an attached switch or diode.

Like die substrates, a die clip can conduct large amounts of transistor and/or diode generated heat out of a packaged switch or packaged diode through its die clip terminal. Die clip terminal 344 in FIG. 2A-2, 2B-2, 2D-2, or 2E-2 may be substantially flat, can have a width around 14.0 mm or more, a length around 17.0 mm or more, and may be electrically and thermally connected to a substantially flat surface of a heat sink or bus bar that may also act as a heat sink. Die clip terminal 344 can transmit 750 Watts or more of heat out of packaged switch 247p, 247q, p 247d or packaged diode 245. In other words, a die substrate clip can transmit 10, 20, 50, 100, 200, 300, 750 Watts or more of heat. A die clip may be thick (e.g., 0.5, 0.8, 1.0, 2.0, 4.0, 8.0 mm or more when measured between oppositely facing surfaces), and the thicker it is, the more thermal capacitance it provides, which may be important for absorbing a sudden increase in heat from by an attached switch or diode.

Packaged switches and packaged diodes may contain one or more pedestals. Although not shown in FIGS. 2A-1-2E-3, packaged switch 247p, 247q, 247d, 247s or packaged diode 245 may include one or more pedestals. Multiple pedestals in a packaged switch or packaged diode may be substantially identical in size, shape, and/or composition. Pedestals may vary in size, shape, and/or composition in a packaged switch or packaged diode, or between different types of packaged switches or packaged diodes. For example, pedestals in a hybrid packaged switch, which is more fully described below, having a MOSFET and a BBJT, may have pedestals connected (e.g., sinterted) to current terminals of the MOSFET that may be thicker between their flat end surfaces than pedestals connected to current terminals of the BBJT, and the pedestals connected to the current terminals of the MOSFET may be shorter than the pedestals connected to the current terminals of the BBJT.

Each pedestal or integrated bridge may be formed from layered metal sheet like sheet 265 or 279 shown in FIG. 2H or FIG. 2I. Pedestals formed from layered sheet 265 with molybdenum layer 266 and copper layers 267, may be used in packaged switches or packaged diodes that employ SiC transistors and/or SiC diodes. Pedestals formed from layered sheet 279 with copper layer 283, may be used in packaged switches or packaged diodes that employ Si transistors and/or Si diodes. Each pedestal may have opposite facing first and second substantially flat (e.g., within a tolerance of 0.01 mm) end surfaces. The first and second end surfaces may be entirely flat.

A packaged switch may include one or more control terminal posts. Although not shown in FIGS. 2A-1-2E-3, packaged switch 247p, 247q, 247d, or 247s may include one or more control-terminal posts such as control-terminal posts 291, 295, or 297 shown in FIGS. 2J-3, 2K-3 and 2L, respectively. Multiple control-terminal posts in a packaged switch may be substantially identical in size, shape, and/or composition. Control-terminal posts may vary in size, shape, and/or composition in a packaged switch, or between different types of packaged switches. Control-terminal posts 291 with molybdenum layer 266 and copper layers 267 may be employed in packaged switches with SiC transistors. Control-terminal posts with copper layer 283 may be employed in packaged switches that employ Si transistors. Each control-terminal post may have opposite facing first and second substantially flat (e.g., within a tolerance of 0.01 mm) end surfaces. The first and second end surfaces may be entirely flat.

Pedestals and control-terminal posts may be uniform in cross-section between the opposite facing first and second flat end surfaces. Or pedestals may have a non-uniform cross-section between the opposite facing first and second flat end surfaces. The cross-sectional width may increase from the first flat end surface connected (e.g., sintered, soldered, etc.) to a current terminal pad to the second flat end surface connected, for example, to the flat surface of a die clip.

A first flat end surface of a pedestal may be thermally and electrically connected (e.g., sintered, soldered, etc.) directly to a flat surface(s) of one or more current terminal pads in a transistor of a power stack, and the second flat end surface of the pedestal may be thermally and electrically connected (e.g., sintered, soldered, etc.) directly to the flat surface of a die substrate or a die clip. Or the second flat end surface of the pedestal may be thermally and electrically connected (e.g., sintered, soldered, etc.) directly to the flat surface of a bridge, which in turn may include an oppositely facing flat surface that may be thermally and electrically connected (e.g., sintered, soldered, etc.) directly to the flat surface of the die substrate or die clip. A first flat end surface of a control-terminal post may be thermally and electrically connected (e.g., sintered, soldered, etc.) directly to a flat surface(s) of one or more terminal pads in a transistor (e.g., a BBJT) of a power stack, and the second flat end surface of the control-terminal post may be connected (e.g., sintered, soldered, etc.) directly to the flat surface of a die substrate or a die clip.

The first flat end surface of a single pedestal may be thermally and electrically connected (e.g., sintered, soldered, etc.) directly to flat surfaces of respective current terminal pads in a transistor of a power stack, and the second flat end surface of the pedestal may be thermally and electrically connected (e.g., sintered, soldered, etc.) directly to the flat surface of a die substrate or a die clip. Or the second flat end surface of the single pedestal may be thermally and electrically connected (e.g., sintered, soldered, etc.) directly to a flat surface of a bridge, which in turn may include an oppositely facing flat surface that may be thermally and electrically connected (e.g., sintered, soldered, etc.) directly to a flat surface of the die substrate or die clip.

One or more first transistors may be electrically connected back-to-back with one or more second transistors, respectively, in a power stack. A first flat end surface of a pedestal may be electrically and thermally connected (e.g., sintered, soldered, etc.) directly to one or more flat current terminal (e.g., source) pads in a first transistor, while the second flat end surface of the pedestal may be electrically and thermally connected (e.g., sintered, soldered, etc.) directly to one or more flat current terminal (e.g., source) pads of a second transistor in the power stack. Or the first flat end surface of the pedestals may be electrically and thermally connected (e.g., sintered, soldered, etc.) directly to flat current terminal (e.g., source) pads in a first transistor while the second flat end surface of the pedestals may be electrically and thermally connected (e.g., sintered, soldered, etc.) directly to flat current terminal (e.g., source) pads of the second transistor in the power stack.

Pedestals may be integrally formed with and extending from a surface of die substrate or die clip on the side oppositely facing the side that contains the die substrate terminal 230 or die clip terminal 344, respectively, or the pedestals may be integrally formed with and extending from a flat surface of a bridge on the side oppositely facing a side that may be connected (e.g., sintered, soldered, etc.) to a die substrate or die clip. In this alternative version the first flat end surfaces of the pedestals may be electrically and thermally connected (e.g., sintered, soldered, etc.) directly to respective flat surfaces or respective pairs of current terminals pads in one or more transistors of a power stack.

The first flat end surface of a pedestal may have a shape that may be substantially equal to the shape of the flat surface of the current terminal pad to which it may be connected. The first end of a pedestal may have a flat surface area configured for connection to flat surfaces of a pair of adjacent current terminal pads in a transistor. Flat surfaces of current terminal pads may be connected to first flat surfaces of pedestals, paddles, die clips, die substrates, etc., using any one of many different attachment technologies (e.g., sintering, soldering, transient liquid phase bonding, conductive adhesion process, etc.). Second oppositely facing flat end surfaces of pedestals may be connected to flat surfaces of paddles, die clips, die substrates, etc., using any one of many different attachment technologies (e.g., sintering, soldering, transient liquid phase bonding, conductive adhesion process, etc.). The first flat end surface of a control-terminal post may have a shape that may be substantially equal to the shape of the flat surface of the control terminal pad to which it may be connected. Flat surfaces of control terminal pads may be connected to first flat surfaces of control-terminal posts using any one of many different attachment technologies (e.g., sintering, soldering, transient liquid phase bonding, conductive adhesion process, etc.). Second oppositely facing flat end surfaces of control-terminal posts may be connected to flat surfaces of paddles, die clips, die substrates, etc., using any one of many different attachment technologies (e.g., sintering, soldering, transient liquid phase bonding, conductive adhesion process, etc.).

Bond-wires have been used in the past to transmit large current (1 A or more) in power converters. The connections in FIGS. 1A and 1C of N1 to TL1, N2 to TL2, and N3 to TL3, and V+ to TH1, TH2, and TH3, may take form in bond-wires (not shown) wire bonded to current terminal pads of the IGBTs. These bond-wires may be prone to failure during temperature cycling. For example, bond-wires or the bond-wire connections often crack or fracture during temperature cycling. Bond-wire lift off may also occur. The failure may be attributed to relatively high current density and low thermal capacity in the bond-wires themselves or in the connections between the bond-wires and current terminal pads. In contrast current density is lower and thermal capacity higher in pedestals, which have larger cross-section when compared to bond-wires. Current density may also be lower in the connection (e.g., sintered connection) between a flat surface of current terminal pad and a flat surface of a connected pedestal. Failures like those associated with bond-wires described above may be less likely to occur when end surfaces of pedestals are connected (e.g., sintered, soldered, etc.) to current terminal pad surfaces. Pedestals provide additional advantages over bond-wires, such as lower parasitic parameters (e.g., inductance, resistance, and capacitance). The parasitic inductance in the electrical path, including the pedestal(s), between a die substrate terminal and a die clip terminal in a packaged switch may be 0.2, 0.15, 0.1, 0.05 nH or less. Lower parasitic inductance can improve operational aspects of packaged switches.

A pair of components may be directly or indirectly connected. A pair of components can be directly connected using any one of many methods such as soldering, sintering, brazing, gluing, etc. The material used for soldering, sintering, brazing, gluing, etc., the pair of components together may be electrically and/or thermally conductive. A pair of components can be directly connected by pressing (i.e., “press-fitting”) surfaces of the components against each other using mechanical structures such as clamps and bolts. A pair of components can be directly connected with or without connecting material (e.g., solder paste, sinter paste, sinter preform, conductive adhesive, thermal interface material (TIM), silver thermal paste, electrically insulating glue, etc.) between the pair of components. A pair of components can be indirectly connected through one or more additional components (e.g., die substrate, die clip, pedestal, transistor, wire, ribbon, lead, trace, etc.).

With continued reference to FIGS. 2A-1-2D-24, FIGS. 3A-3L, 3O and 3P symbolically illustrate example packaged switches 247p, 247q, or 247d. Connector-leads 288g are shown extending from sides of cases 248 in these figures. Connector-leads 288ds and 288dc are not shown.

Example packaged switches 247 shown in FIGS. 3A-3L, 3O and 3P include switch modules 376A-376L, 376O, and 376P respectively, each of which may include a power stack, which in turn may include a switch 304 that is electrically and thermally connected between die substrate 360 and die clip 372, all of which are shown symbolically. Die substrate terminals 230 and die clip terminals 344 are also shown symbolically. FIG. 3K includes a symbolic representation of paddle 361. Although not shown in FIG. 3K, paddle 361 may include oppositely facing flat surfaces to which flat ends of respective pedestals may be directly connected (e.g., sintered, soldered, etc.).

FIGS. 3A-3L, 3O and 3P show relative positioning of switch module components even though the switch module components are shown symbolically. For example, the figures show that switches 304 are positioned between die substrates 360 and die clips 372. Also, die substrate terminals 230 and die clip terminals 344, which are shown symbolically, are illustrated as being flush with surfaces of cases 248 even though die substrate terminals 230 and die clip terminals 344 are presumed to be protruding beyond the outer surfaces of cases 248 as noted above.

Although not shown in FIGS. 3A-3L, 3O and 3P each power stack may include one or more pedestals, each of which may have opposite facing first and second end surfaces that are entirely flat. The first flat end surface of a pedestal may be electrically and thermally connected (e.g., sintered, soldered, transient liquid phase bonded, conductive adhesion process, etc.) directly to one or more current terminal pads in a transistor of a switch 304, and the second flat end surface of the pedestal may be electrically and thermally connected (e.g., sintered, soldered, transient liquid phase bonded, conductive adhesion process, etc.) directly to the flat surface of die substrate 360 or die clip 372 on its side facing opposite the side that contains die substrate terminal 230 or die clip terminal 344. Or the second flat end surface of the pedestal may be directly connected to the flat surface of a bridge, which in turn may include an oppositely facing flat surface that may be electrically and thermally connected (e.g., sintered, soldered, transient liquid phase bonded, conductive adhesion process, etc.) directly to the flat surface of die substrate 360 or die clip 372 on its side facing opposite the side that contains the die clip terminal 344 or die substrate terminal 230. Or the second flat end surface of the pedestal may be electrically and thermally connected (e.g., sintered, soldered, transient liquid phase bonded, conductive adhesion process, etc.) directly to one or more current terminals of another transistor. Pedestals may be integrally formed with and extending from a flat surface of a bridge, which in turn may include an oppositely facing flat surface that may be electrically and thermally connected (e.g., sintered, soldered, transient liquid phase bonded, conductive adhesion process, etc.) directly to the flat surface of die substrate 360 or die clip 372 on the side facing opposite the side that contains the die clip terminal 344 or die substrate terminal 230.

Although not shown each power stack in FIG. 3G, 3H, or 3L, may include one or more control-terminal posts, each of which may have opposite facing first and second end surfaces that are entirely flat. The first flat end surface of a control-terminal post may be electrically and thermally connected (e.g., sintered, soldered, transient liquid phase bonded, conductive adhesion process, etc.) directly to a control terminal pad in a transistor of a switch 304, and the second flat end surface of the control-terminal post may be electrically and thermally connected (e.g., sintered, soldered, transient liquid phase bonded, conductive adhesion process, etc.) directly to the flat surface of die substrate 360 or die clip 372 on its side facing opposite the side that contains die substrate terminal 230 or die clip terminal 344. While control terminal pads may be thermally connected to die clips or die substrates through respective control-terminal posts, control terminal pads should be electrically isolated from die substrates or die clips.

FIGS. 3A-3P show relative positioning of components. Die substrate 360, switch 304, and die clip 372 are stacked as shown. In one sense, stacking first and second components means the first and second components may be contained in first and second planes, respectively, which may be separated, but parallel to each other. The first component in the first plane may be directly above the second component in the second plane, or the first component may be laterally offset in the first plane so that the second component is not directly beneath the first component. Electrical current can be transmitted between die clip terminal 344 and die substrate terminal 230 via an activated switch 304.

Switch modules 376 may include connector-leads 288g, 288ds, 288c, and 288dc, but for ease of illustration connector-leads 288dc and 288ds are not shown in FIGS. 3A-3P. Connector-lead 288g may be electrically connected to the control terminal pad(s) of each transistor in switch 304 of FIGS. 3A-3D, and 3O. Connector-lead 288g1 may be electrically connected to the control terminal pad(s) of a first group of one or more first transistors in switch 304 of FIGS. 3E-3L, and 3P. Connector-lead 288g2 may be electrically connected to the control terminal pad(s) of a second group of one or more second transistors in switch 304 of FIGS. 3E-3L, and 3P. The one or more transistors of the first group and/or the second group can be integrated in the same semiconductor die. For example, the transistors (e.g., BJTs) in FIG. 3G or 3L may be integrated into one semiconductor die.

Die substrate 360 and die clip 372 may conduct large current (e.g., 1, 5, 10, 50, 100, 200, 400 A or more) into or out of packaged switches 247q, 247d, and 247p via die substrate terminal 230 and die clip terminal 344, respectively. Switch 304 may get hot. Die substrate 360 and die clip 372 can conduct substantial switch heat (e.g., 1, 5, 10, 50, 100, 200, 400, 750 W or more) out of packaged switch 247 via die substrate terminal 230 and die clip terminal 344, respectively, at the same time die substrate terminal 230 and die clip terminal 344 concurrently conduct large current.

FIG. 3A is an example of a packaged switch 247dA. Packaged switches 247, such as packaged switch 247dA, may include switches 304, such as switch 304da. In FIG. 3A example switch 304dA may include an IGBT electrically connected with a diode D as shown, the combination of which may be electrically connected between a die substrate 360 and a die clip 372 as shown. The IGBT and diode d may be discrete devices in one embodiment, and combined into a single semiconductor die in another embodiment. In an alternative version, packaged switch 247dA may have two, three or more IGBTs electrically connected in parallel with two, three or more parallel connected diodes, the combination of which may be electrically connected between a die substrate and a die clip. Each collector terminal in an IGBT and each cathode terminal in a diode may have one or more conductive pads with entirely flat, outwardly facing surfaces that can be electrically and thermally connected (e.g., sintered, soldered, etc.) directly to a flat surface of, for example, a die substrate. For purposes of explanation only, each collector terminal in an IGBT and each cathode terminal in a diode has only one conductive pad unless otherwise noted. Each emitter terminal in an IGBT may have multiple conductive pads with entirely flat, outwardly facing surfaces that can be electrically and thermally connected (e.g., sintered, soldered, etc.) directly to flat surfaces of respective pedestals or the flat surface of one pedestal. Each anode terminal in a diode may have a pad with an entirely flat, outwardly facing surface that can be electrically and thermally connected (e.g., sintered, soldered, etc.) directly to a flat surface of a pedestal. In other versions the flat surfaces of the emitter terminal and anode terminal pads may be electrically and thermally connected (e.g., sintered, soldered, etc.) directly to a flat surface of a die clip. Transistors and diodes in a switch 304 may each be discrete devices. One or more transistors such as IGBTs of a switch 304 can be integrated into a single semiconductor die that share one or more current terminal pads on one side of the semiconductor die and one or more current terminal pads on the opposite side of the semiconductor die. One or more transistors such as IGBTs and one or more diodes of a switch 304 can be integrated into a single semiconductor die that shares one or more current terminal pads on one side of the semiconductor die and one or more current terminal pads on the opposite side of the semiconductor die.

The flat surfaces of pads in the collector terminal c and the cathode terminal in FIG. 3A may be directly connected (e.g., sintered, soldered, etc.) to a flat surface of die substrate 360, and the flat surfaces of pads in the emitter terminal e and the anode terminal may be directly connected (e.g., sintered, soldered, etc.) to first flat end surfaces of pedestals. The second flat surfaces at the opposite ends of the pedestals (i.e., the second flat end surfaces) may be connected (e.g., sintered, soldered, etc.) directly to a flat surface of die clip 372. Pad surface connections (e.g., sintered connections or sintered joints) enable thermal and electrical transmission.

Connector-lead 288g may be electrically connected to the gate terminal g of the IGBT as shown. In the alternative version in which packaged switch 247dA includes more than one IGBT connected in parallel, connector-lead 288g may be electrically connected to each of the gate terminals g. Although not shown in FIG. 3A, switch module 376A may include a strap that may be attached to the same surface of die substrate 360 to which the pads of collector terminal c and cathode terminal are connected. The strap may be electrically isolated from die substrate 360. One or more bond-wires may electrically connect the strap to the pad(s) of each gate terminal g. For purposes of explanation only, each IGBT in this disclosure is presumed to have only one gate terminal pad unless otherwise noted. Connector-lead 288g may be electrically connected to the strap. An end portion of connector-lead 288g may be directly connected (e.g., soldered) to the strap. Or one or more bond-wires may electrically connect the strap to the end portion of the connector-lead 288g.

FIG. 3B is an example of a packaged switch 247dB. In FIG. 3B switch 304dB may include four n-channel MOSFETs electrically connected in parallel as shown, the combination of which is electrically in series between die substrate 360 and a die clip 372 as shown. In an alternative version, packaged switch 247dB may have only three or two MOSFETs electrically connected in parallel, the combination of which is electrically between a die substrate and a die clip. Packaged switch 247dB may have five or more MOSFETs electrically connected between a die substrate and a die clip. Or packaged switch 247dB may have just one MOSFET electrically connected between a die substrate and a die clip. Each drain terminal in a MOSFET may have one or more conductive pads with entirely flat, outwardly facing surfaces that can be electrically and thermally connected (e.g., sintered, soldered, etc.) directly to a flat surface of, for example, a die substrate. For purposes of explanation only, each drain terminal in this disclosure is presumed to have only one conductive pad unless otherwise noted. Each source terminal in a MOSFET may have multiple conductive pads with entirely flat, outwardly facing surfaces that can be electrically and thermally connected (e.g., sintered, soldered, etc.) directly to, for example, flat surfaces of respective pedestals or the flat surface of one pedestal. In other versions the flat surfaces of the source terminal pads may be directly connected (e.g., sintered, soldered, etc.) to a flat surface of a die clip.

In FIG. 3B the flat surfaces of pads in drain terminals d1-d4 may be directly connected (e.g., sintered, soldered, etc.) to a flat surface of die substrate 360, and the flat surfaces of pads in source terminals s1-s4 may be directly connected (e.g., sintered, soldered, etc.) to first flat end surfaces of respective pedestals. The second flat surfaces at the opposite ends of the pedestals (i.e., the second flat end surfaces) may be electrically and thermally connected (e.g., sintered, soldered, etc.) directly to a flat surface of die clip 372. Connector-lead 288g may be electrically connected to the gate terminals of each MOSFET. For purposes of explanation only, each MOSFET in this disclosure is presumed to have only one gate terminal pad unless otherwise noted. Although not shown in FIG. 3B, switch module 376B may include a strap that may be attached to the same surface of die substrate 360 to which the pads of the drain terminals d1-d4 are connected. The strap may be electrically isolated from die substrate 360. One or more bond-wires may electrically connect the strap to the pads of the gate terminals in each of the MOSFETs. Connector-lead 288g may be electrically connected to the strap. An end portion of connector-lead 288g may be directly connected (e.g., soldered) to the strap. Or one or more bond-wires may electrically connect to the strap to an end portion of the connector-lead 288g.

In FIG. 3C switch 304dC may include a GTO thyristor (e.g., symmetrical GTO thyristor) electrically connected between die clip 360 and die substrate 372 as shown. In an alternative version, switch 304dC may include two or more GTO thyristors electrically connected in parallel, the combination of which is electrically connected between a die substrate and a die clip. A GTO thyristor's cathode terminal may have one or more conductive pads with entirely flat, outwardly facing surfaces that can be electrically and thermally connected (e.g., sintered, soldered, etc.) directly to a flat surface of, for example, a die substrate. For purposes of explanation only, the cathode terminal of a GTO thyristor in this disclosure is presumed to have only one conductive pad unless otherwise noted. A GTO thyristor's anode terminal may include one or more conductive pads with entirely flat, outwardly facing surfaces that can be electrically and thermally connected (e.g., sintered, soldered, etc.) directly to a flat surface of a single pedestal. In other versions the flat surface(s) of the anode terminal pad(s) may be directly connected (e.g., sintered, soldered, etc.) to a flat surface of a die clip.

The flat surface of the pad in the cathode terminal of FIG. 3C may be connected (e.g., sintered, soldered, etc.) directly to a flat surface of die substrate 360, and the flat surface(s) of the anode terminal pad(s) may be connected (e.g., sintered, soldered, etc.) directly to the first flat end surface of a pedestal. The second flat surface at the opposite ends of the pedestal may be electrically and thermally connected (e.g., sintered, soldered, etc.) directly to a flat surface of die clip 372.

For purposes of explanation only, each GTO thyristor in this disclosure is presumed to have only one gate terminal pad unless otherwise noted. Connector-lead 288g may be electrically connected to the gate terminal of the GTO thyristor. In the alternative version in which packaged switch 247dc includes more than one GTO thyristor connected in parallel, connector-lead 288g may be electrically connected to each of the gate terminals g. Although not shown in FIG. 3C, switch module 376C may include a strap that may be attached to the same surface of die substrate 360 to which the pad of the cathode terminal may be connected. The strap may be electrically isolated from die substrate 360. One or more bond-wires may electrically connect the strap to the pad of the gate terminal of the symmetrical GTO thyristor. Connector-lead 288g may be electrically connected to the strap. An end portion of connector-lead 288g may be directly connected (e.g., soldered) to the strap. Or one or more bond-wires may electrically connect to the strap to an end portion of the connector-lead 288g.

In FIG. 3D packaged switch 304dD may include a TRIAC electrically connected between a die clip 360 and die substrate 372 as shown. In an alternative version, switch 304dD may include two or more TRIACs electrically connected in parallel, the combination of which is electrically connected between a die clip and a die substrate. A TRIAC's first current terminal anode-1 may have one or more conductive pads with entirely flat, outwardly facing surfaces that can be electrically and thermally connected (e.g., sintered, soldered, etc.) directly to a flat surface of, for example, a die substrate. For purposes of explanation only, each first current terminal anode-1 is presumed to have only one conductive pad in this disclosure unless otherwise noted. A TRIAC's second current terminal anode-2 may include one or more conductive pads with entirely flat, outwardly facing surfaces that can be electrically and thermally connected (e.g., sintered, soldered, etc.) directly to the flat surface of a pedestal. In one version, the flat surfaces of the anode-2 pads may be electrically and thermally connected (e.g., sintered, soldered, etc.) directly to a flat surface of a die clip.

The flat surface of the pad of anode-1 in FIG. 3D may be directly connected (e.g., sintered, soldered, etc.) to a flat surface of die substrate 360, and the flat surface(s) of anode-2 may be directly connected (e.g., sintered, soldered, etc.) to the first flat end surface of a pedestal. The flat surface at the opposite ends of the pedestal may be electrically and thermally connected (e.g., sintered, soldered, etc.) directly to a flat surface of die clip 372.

For purposes of explanation only, each TRIAC in this disclosure is presumed to have only one gate terminal pad unless otherwise noted. Connector-lead 288g may be electrically connected to the gate terminal pad of the TRIAC. In the alternative version in which packaged switch 247dD includes more than one TRIAC connected in parallel, connector-lead 288g may be electrically connected to each of the gate terminals g. Although not shown in FIG. 3D, switch module 376D may include a strap that may be attached to the same surface of die substrate 360 to which the pad of anode-1 is/are connected. The strap may be electrically isolated from die substrate 360. One or more bond-wires may electrically connect the strap to the pad of the gate terminal of the TRIAC. Connector-lead 288g may be electrically connected to the strap. An end portion of connector-lead 288g may be directly connected (e.g., soldered) to the strap. Or one or more bond-wires may electrically connect to the strap to an end portion of the connector-lead 288g.

FIG. 3E illustrates an example of a packaged switch 247qE. Switch 304qE may include four n-channel MOSFETs electrically connected in parallel, the combination of which is electrically connected between die substrate 360 and die clip 372 as shown. The flat, outwardly facing surfaces of pads in drain terminals d1-d4 may be electrically and thermally connected (e.g., sintered, soldered, etc.) directly to a flat surface of die substrate 360, and the flat, outwardly facing surfaces of pads in source terminals s1-s4 may be electrically and thermally connected (e.g., sintered, soldered, etc.) directly to first flat end surfaces of pedestals. The flat surfaces at the opposite ends of the pedestals (i.e., the second flat end surfaces) may be electrically and thermally connected (e.g., sintered, soldered, etc.) directly to a flat surface of die clip 372. Connector-lead 288g1 may be electrically connected to the gate terminals of a first pair of MOSFETs as shown, while connector-lead 288g2 may be electrically connected to the gate terminals of the other pair of MOSFETs. Although not shown in FIG. 3E, switch module 376E may include first and second separate straps that may be attached to the same surface of die substrate 360 to which the pads of drain terminals d1-d4 may be connected. The straps may be electrically isolated from die substrate 360. One or more bond-wires may electrically connect the first strap to the pads of the gate terminals in the first pair MOSFETs as shown, while one or more bond-wires may electrically connect the second strap to the pads of the gate terminals in the other pair MOSFETs. Connector-lead 288g1 may be electrically connected to the first strap, and connector-lead 288g2 may be electrically connected to the second strap. An end portion of connector-lead 288g1 may be directly connected (e.g., soldered) to the first strap, and an end portion of connector-lead 288g2 may be directly connected (e.g., soldered) to the second strap. Or one or more bond-wires may electrically connect to the first strap to an end portion of connector-lead 288g1, and one or more bond-wires may electrically connect to the second strap to an end portion of connector-lead 288g2.

FIG. 3F illustrates an example of a packaged switch 247qF. Switch 304qF may include three MOSFETs electrically connected in parallel with an IGBT, the combination of which is electrically connected between die clip 372 and die substrate 360 as shown. In an alternative embodiment, the three MOSFETs can be replaced with three IGBTs, respectively, and the IGBT can be replaced with one MOSFET, all of which are electrically connected in parallel between die substrate 360 and die clip 372. The flat, outwardly facing surfaces of pads in collector terminal c and drain terminals d may be electrically and thermally connected (e.g., sintered, soldered, etc.) directly to a flat surface of die substrate 360, and the flat, outwardly facing surfaces of pads in emitter terminal e and source terminals s may be electrically and thermally connected (e.g., sintered, soldered, etc.) directly to first flat end surfaces of pedestals. The flat surfaces at the opposite ends of the pedestals (i.e., the second flat end surfaces) may be electrically and thermally connected (e.g., sintered, soldered, etc.) directly to a flat surface of die clip 372. Connector-lead 288g1 may be electrically connected to the gate terminal(s) g of the MOSFET(s), while connector-lead 288g2 may be electrically connected to the gate terminal(s) g of the IGBT(s). Although not shown in FIG. 3F, switch module 376F may include first and second separate straps that may be attached to the same surface of die substrate 360 to which the pads of drain terminals d and collector terminal c may be connected. The straps may be electrically isolated from die substrate 360. One or more bond-wires may electrically connect the first strap to the pad of the gate terminal in the IGBT as shown, while one or more bond-wires may electrically connect the second strap to the pads of the gate terminals g in the MOSFETs. Connector-lead 288g1 may be electrically connected to the first strap, and connector-lead 288g2 may be electrically connected to the second strap. An end portion of connector-lead 288g1 may be directly connected (e.g., soldered) to the first strap, and an end portion of connector-lead 288g2 may be directly connected (e.g., soldered) to the second strap. Or one or more bond-wires may electrically connect to the first strap to an end portion of connector-lead 288g1, and one or more bond-wires may electrically connect to the second strap to an end portion of connector-lead 288g2.

FIG. 3G illustrates an example packaged switch 247qG, which may include a BBJT electrically connected between die clip 372 and die substrate 360 as shown. Each of a BBJT's current terminals c/e may have multiple conductive pads with entirely flat, outwardly facing surfaces that can be electrically and thermally connected (e.g., sintered, soldered, etc.) directly to flat surfaces of respective pedestals. The flat surfaces of pads in the first current terminal c/e1 may be electrically and thermally connected (e.g., sintered, soldered, etc.) directly to respective first flat surfaces of first pedestals, and the opposite facing second flat surfaces of the first pedestals may be electrically and thermally connected (e.g., sintered, soldered, etc.) directly to a flat surface of die substrate 360. The flat surfaces of pads in the second current terminal c/e2 may be electrically and thermally connected (e.g., sintered, soldered, etc.) directly to the first flat end surfaces of respective second pedestals. The flat surfaces at the opposite ends of the second pedestals may be electrically and thermally connected (e.g., sintered, soldered, etc.) directly to a flat surface of die clip 372.

Connector-lead 288g1 may be electrically connected to base terminal b1 of the BBJT, while connector-lead 288g2 may be electrically connected to base terminal b2. For purposes of explanation only, each base terminal b in a BBJT of this disclosure is presumed to have multiple base terminal pads unless otherwise noted. The base terminal pads on each side of the BBJT may have exposed outwardly facing flat surfaces. Although not shown in FIG. 3G, switch module 376G may include a first signal frame with a flat surface that may be electrically connected (e.g., soldered) directly to surfaces of pads of base terminal b1, and a second signal frame with a flat surface that may be electrically connected (e.g., soldered) directly to surfaces of pads of base terminal b2. The signal frames may be electrically isolated from each other. Connector-lead 288g1 may be electrically connected to the first signal frame, and connector-lead 288g2 may be electrically connected to the second signal frame. An end portion of connector-lead 288g1 may be directly connected (e.g., soldered) to the first signal frame, and an end portion of connector-lead 288g2 may be directly connected (e.g., soldered) to the second signal frame. Or one or more bond-wires may electrically connect the first signal frame to an end portion of connector-lead 288g1, and one or more bond-wires may electrically connect the second signal frame to an end portion of connector-lead 288g2. In an alternative embodiment, switch module 376G may include first control-terminal posts with flat end surfaces that may be electrically and thermally connected (e.g., sintered, soldered, etc.) directly to surfaces of respective pads of base terminal b1, and second control-terminal posts with flat end surfaces that may be electrically and thermally connected (e.g., sintered, soldered, etc.) directly to surfaces of respective pads of base terminal b2. The first control-terminal posts may be electrically isolated from the second control-terminal posts. A first strap (not shown) may electrically connect connector-lead 288g1 to the first control-terminal posts, and a second strap (not shown) may electrically connect connector-lead 288g2 to the second control-terminal posts. An end portion of connector-lead 288g1 may be directly connected (e.g., soldered) to the first strap, and an end portion of connector-lead 288g2 may be directly connected (e.g., soldered) to the second strap. Or one or more bond-wires may electrically connect the first strap to an end portion of connector-lead 288g1, and one or more bond-wires may electrically connect the second strap to an end portion of connector-lead 288g2.

FIG. 3H illustrates an example of a packaged switch 247ph. Switch 304ph may include a MOSFET electrically connected in parallel with a BBJT, the combination of which is electrically connected between die clip 372 and die substrate 360 as shown. Packaged switch 304ph is an example of a hybrid packaged switch. In an alternative version of packaged switch 247ph, two or more MOSFETs may be electrically connected in parallel with one, two, or more BBJTs, the combination of which may be connected in series between die substrate 360 and die clip 372. Or two or more BBJTs may be electrically connected in parallel with one, two, or more MOSFETs, the combination of which may be connected in series between die substrate 360 and die clip 372. The height of the pedestals between sources pads and the die clip in these hybrid switches may be at least twice the height of pedestals between c/e pads and the die clip or die substrate.

Flat, outwardly facing surfaces of pads in the first current terminal c/e1 in FIG. 3H may be electrically and thermally connected (e.g., sintered, soldered, etc.) directly to first flat surfaces of respective first pedestals, and the opposite facing second flat surfaces of the first pedestals can be electrically and thermally connected (e.g., sintered, soldered, etc.) directly to a flat surface of die substrate 360. Flat, outwardly facing surfaces of pads in the second current terminal c/e2 may be electrically and thermally connected (e.g., sintered, soldered, etc.) directly to first flat end surfaces of respective second pedestals. The flat surfaces at the opposite ends of the second pedestals may be electrically and thermally connected (e.g., sintered, soldered, etc.) directly to a flat surface of die clip 372. Connector-lead 288g1 may be electrically connected to base terminal b1 of the BBJT, while connector-lead 288g2 may be electrically connected to base terminal b2. Although not shown in FIG. 3H, switch module 376H may include a first signal frame with a flat surface that is electrically connected (e.g., soldered) to surfaces of pads of base terminal b1, and a second signal frame with a flat surface that may be electrically connected (e.g., soldered) to surfaces of pads of base terminal b2. The signal frames may be electrically isolated from each other. Connector-lead 288g1 may be electrically connected to the first signal frame, and connector-lead 288g2 may be electrically connected to the second signal frame. An end portion of connector-lead 288g1 may be directly connected (e.g., soldered) to the first signal frame, and an end portion of connector-lead 288g2 may be directly connected (e.g., soldered) to the second signal frame. Or one or more bond-wires may electrically connect the first signal frame to an end portion of connector-lead 288g1, and one or more bond-wires may electrically connect the second signal frame to an end portion of connector-lead 288g2. Alternatively, switch module 376H may include first control-terminal posts with flat end surfaces that may be electrically and thermally connected (e.g., sintered, soldered, etc.) directly to surfaces of respective pads of base terminal b1, and second control-terminal posts with flat end surfaces that may be electrically and thermally connected (e.g., sintered, soldered, etc.) directly to surfaces of respective pads of base terminal b2. The first control-terminal posts should be electrically isolated from the second control-terminal posts. A first strap may electrically connect connector-lead 288g1 to the first control-terminal posts, and a second strap may electrically connect the connector-lead 288g2 to the second control-terminal posts. An end portion of connector-lead 288g1 may be directly connected (e.g., soldered) to the first strap, and an end portion of connector-lead 288g2 may be directly connected (e.g., soldered) to the second strap. Or one or more bond-wires may electrically connect to the first strap to an end portion of connector-lead 288g1, and one or more bond-wires may electrically connect to the second strap to an end portion of connector-lead 288g2.

In FIG. 3H the flat, outwardly facing surface of the pad in drain terminal d may be electrically and thermally connected (e.g., sintered, soldered, etc.) directly to a flat surface of die substrate 360, and the flat, outwardly facing surfaces of pad(s) in source terminal s may be electrically and thermally connected (e.g., sintered, soldered, etc.) directly to first flat end surface of a pedestal. The flat surface at the opposite end of the pedestal (i.e., the second flat end surface) may be electrically and thermally connected (e.g., sintered, soldered, etc.) directly to a flat surface of die clip 372. Connector-lead 288c may be electrically connected to the gate terminal pad of the MOSFET. Although not shown in FIG. 3H, switch module 376H may include a strap that is attached to the same surface of die substrate 360 to which the pad of the drain terminal d may be connected. The strap may be electrically isolated from die substrate 360. One or more bond-wires may electrically connect the strap to the pad of the gate terminal. Connector-lead 288c may be electrically connected to the strap. An end portion of connector-lead 288c may be directly connected (e.g., soldered) to the strap. Or one or more bond-wires may electrically connect to the strap to an end portion of the connector-lead 288c.

FIG. 3I illustrates an example of a packaged switch 247qI, which is an example of a bidirectional packaged switch. Switch 304qI may include first and second groups of RB-IGBTs connected in anti-parallel, the combination of which is electrically connected between die clip 372 and a die substrate 360. In an alternative version, the RB-IGBTs may be replaced by NPT-IGBTs, RB-IGCTs or BJTs. Each group may include one, two or more RB-IGBTs, RB-IGCTs or other devices electrically connected in parallel. Each group in FIG. 3I includes two RB-IGBTs electrically connected in parallel. Each of the RB-IGBTs' collector terminals c1 of the first group and each of the RB-IGBTs' collector terminals c2 of the second group may have one conductive pad with an outwardly facing surface that may be entirely flat. Each of the RB-IGBTs' emitter terminals e1 of the first group and each of the RB-IGBTs' emitter terminals e2 of the second group may have conductive pads with outwardly facing surfaces that may be entirely flat. The flat surfaces of the pads in the collector terminals c1-1 and c1-2 may be electrically and thermally connected (e.g., sintered, soldered, etc.) directly to a flat surface of die substrate 360, and the surfaces of the pads in the collector terminals c2-1 and c2-2 may be electrically and thermally connected (e.g., sintered, soldered, etc.) directly to a flat surface of die clip 372. The flat surfaces of the pad(s) in each emitter terminal e may be electrically and thermally connected (e.g., sintered, soldered, etc.) directly to the first flat end surface of a pedestal. The flat surfaces at the opposite ends of the pedestals connected to the pads of emitter terminal e2-1 and e2-2 may be electrically and thermally connected (e.g., sintered, soldered, etc.) directly to a flat surface of die substrate 360, while the flat surfaces at the opposite ends of the pedestals connected to the pads of emitter terminals e1-1 and e1-2 may be electrically and thermally connected (e.g., sintered, soldered, etc.) directly to a flat surface of die clip 372. Connector-lead 288g1 may be electrically connected to gate terminals g2, while connector-lead 288g2 may be electrically connected to gate terminals g1. Although not shown in FIG. 3I, switch module 376I may include a first strap that is attached to the same surface of die substrate 360 to which the pads of collector terminals c1 and emitter terminals e2 may be connected, and a second strap that may be attached to the same surface of die clip 372 to which the pads of collector terminals c2 and emitter terminals e1 may be connected. The first and second straps may be electrically isolated from die substrate 360 and die clip 372, respectively. One or more bond-wires may electrically connect the first strap to the pads of gate terminals g1, while one or more bond-wires may electrically connect the second strap to the pads of gate terminal g2. Connector-lead 288g1 may be electrically connected to the first strap, and connector-lead 288g2 may be electrically connected to the second strap. An end portion of connector-lead 288g1 may be directly connected (e.g., soldered) to the first strap, and an end portion of connector-lead 288g2 may be directly connected (e.g., soldered) to the second strap. Or one or more bond-wires may electrically connect to the first strap to an end portion of connector-lead 288g1, and one or more bond-wires may electrically connect to the second strap to an end portion of connector-lead 288g2.

FIG. 3J illustrates an example of a packaged switch 247qJ, which is an example of a bidirectional packaged switch. In FIG. 3J switch 304qJ may include first and second groups of MOSFETs electrically connected back-to-back, the combination of which is electrically connected between die clip 372 and die substrate 360. Each group may include four MOSFETs, but each group may include fewer than four MOSFETS connected in parallel in an alternative version. Each of the MOSFETs' source terminals s may have conductive outwardly facing pads that may be entirely flat. Each of the MOSFETs' drain terminals d may have an outwardly facing conductive pad that may be entirely flat. The flat surfaces of the pads in the drain terminals d1 and d2 may be electrically and thermally connected (e.g., sintered, soldered, etc.) directly to flat surfaces of die substrate 360 and die clip 372, respectively. The flat surfaces of pads in source terminals s1 may be electrically and thermally connected (e.g., sintered, soldered, etc.) directly to the first flat end surfaces of respective pedestals. The flat surfaces at the opposite ends of the pedestals may be electrically and thermally connected (e.g., sintered, soldered, etc.) directly to flat surfaces of pads in respective source terminals s2. Connector-lead 288g1 may be electrically connected to gate terminals g1, while connector-lead 288g2 may be electrically connected to gate terminals g2. Although not shown in FIG. 3J, switch module 376J may include first and second separate straps that are attached to die substrate 360 and die clip 372, respectively. The first strap may be attached to the same surface of die substrate 360 to which the pads of drain terminals d1 may be connected, and the second strap may be attached to the same surface of die clip 372 to which the pads of drain terminals d2 may be connected. The first and second straps may be electrically isolated from each other and from die substrate 360 and die clip 372. One or more bond-wires may electrically connect the first strap to the pads of the gate terminals g1, while one or more bond-wires may electrically connect the second strap to the pads of the second gate terminals g2. Connector-lead 288g1 may be electrically connected to the first strap, and connector-lead 288g2 may be electrically connected to the second strap. An end portion of connector-lead 288g1 may be directly connected (e.g., soldered) to the first strap, and an end portion of connector-lead 288g2 may be directly connected (e.g., soldered) to the second strap. Or one or more bond-wires may electrically connect to the first strap to an end portion of connector-lead 288g1, and one or more bond-wires may electrically connect to the second strap to an end portion of connector-lead 288g2.

FIG. 3K illustrates an example of a packaged switch 247pK, which is an example of a bidirectional packaged switch. Packaged switch 247pK in FIG. 3K may include components of the packaged switch 247qJ in FIG. 3J in addition to a paddle 361 and connector-lead 288c. Paddle 361 is shown symbolically. Although not shown, paddle 361 has oppositely facing first and second flat surfaces. In FIG. 3K switch 304pK may include first and second groups of MOSFETs electrically connected back-to-back, the combination of which are electrically connected between die clip 372 and die substrate 360 as shown. Each group may include four MOSFETs electrically connected in parallel as shown, it being understood that each group may include fewer than four MOSFETs connected in parallel. Each of the MOSFETs' source terminals s may have outwardly facing conductive pads that may be entirely flat. Each of the MOSFETs' drain terminals d may have an outwardly facing conductive pad that may be entirely flat. The flat surfaces of the pads in the drain terminals d1 and d2 may be electrically and thermally connected (e.g., sintered, soldered, etc.) directly to flat surfaces of die substrate 360 and die clip 372, respectively. The flat surfaces of the pads in source terminals s1 may be electrically and thermally connected (e.g., sintered, soldered, etc.) directly to the first flat end surfaces of respective first pedestals. The flat surfaces at the opposite ends of the first pedestals may be electrically and thermally connected (e.g., sintered, soldered, etc.) directly to the first flat surface of paddle 361. The flat surfaces of the pads in source terminals s2 may be electrically and thermally connected (e.g., sintered, soldered, etc.) directly to the first flat end surfaces of respective second pedestals. The flat surfaces at the opposite ends of the second pedestals may be electrically and thermally connected (e.g., sintered, soldered, etc.) directly to the second flat surface of paddle 361. Connector-lead 288g1 may be electrically connected to gate terminals g1, while connector-lead 288g2 may be electrically connected to gate terminals g2. Although not shown in FIG. 3K, switch module 376K may include first and second separate straps that are attached to die substrate 360 and die clip 372, respectively. The first strap may be attached to the same surface of die substrate 360 to which the pads of drain terminals d1 may be connected, and the second strap may be attached to the same surface of die clip 372 to which the pads of drain terminals d2 may be connected. The first and second straps may be electrically isolated from each other and from die substrate 360 and die clip 372. One or more bond-wires may electrically connect the first strap to the pads of the gate terminals g1, while one or more bond-wires may electrically connect the second strap to the pads of the second gate terminals g2. Connector-lead 288g1 may be electrically connected to the first strap, and connector-lead 288g2 may be electrically connected to the second strap. An end portion of connector-lead 288g1 may be directly connected (e.g., welded, soldered, etc.) to the first strap, and an end portion of connector-lead 288g2 may be directly connected (e.g., welded, soldered, etc.) to the second strap. Or one or more bond-wires may electrically connect to the first strap to an end portion of connector-lead 288g1, and one or more bond-wires may electrically connect to the second strap to an end portion of connector-lead 288g2. Connector-lead 288c may be electrically connected to paddle 361.

FIG. 3L illustrates a packaged switch 247ql, which is an example of a bidirectional packaged switch. FIG. 3L shows a switch 304ql with four BBJTs electrically connected in parallel, the combination of which is electrically connected between die clip 372 and a die substrate 360. In an alternative version, packaged switch 247gL may have only three or two BBJTs connected in parallel between a die substrate and die clip. The outwardly facing flat surfaces of pads in the first current terminal c/e1 of each BBJT may be electrically and thermally connected (e.g., sintered, soldered, etc.) directly to first flat surfaces of respective first pedestals, and the opposite facing second flat surfaces of the first pedestals in each BBJT can be electrically and thermally connected (e.g., sintered, soldered, etc.) directly to a flat surface of die substrate 360. The outwardly facing flat surfaces of pads in the second current terminal c/e2 of each BBJT may be electrically and thermally connected (e.g., sintered, soldered, etc.) directly to first flat end surfaces of respective second pedestals. The flat surfaces at the opposite ends of the second pedestals may be electrically and thermally connected (e.g., sintered, soldered, etc.) directly to a flat surface of die clip 372.

Connector-lead 288g1 may be electrically connected to base terminal b1 of each BBJT, while connector-lead 288g2 may be electrically connected to base terminal b2 of each BBJT. Although not shown in FIG. 3L, switch module 376L may include a first signal frame with a flat surface that is electrically connected (e.g., welded, soldered, etc.) to outwardly facing surfaces of pads of base terminal b1 in each BBJT, and a second signal frame with a flat surface that may be electrically connected (e.g., welded, soldered, etc.) to outwardly facing surfaces of pads of base terminal b2 in each BBJT. The signal frames may be electrically isolated from each other. Connector-lead 288g1 may be electrically connected to the first signal frame, and connector-lead 288g2 may be electrically connected to the second signal frame. An end portion of connector-lead 288g1 may be directly connected (e.g., welded, soldered, etc.) to the first signal frame, and an end portion of connector-lead 288g2 may be directly connected (e.g., welded, soldered, etc.) to the second signal frame. Or one or more bond-wires may electrically connect to the first signal frame to an end portion of connector-lead 288g1, and one or more bond-wires may electrically connect to the second signal frame to an end portion of connector-lead 288g2. In an alternative embodiment, switch module 376L may include first control-terminal posts with flat end surfaces that may be electrically and thermally connected (e.g., sintered, soldered, etc.) to flat surfaces of respective pads of base terminal b1 in each BBJT, and second control-terminal posts with flat end surfaces that may be electrically and thermally connected (e.g., sintered, soldered, etc.) to surfaces of respective pads of base terminal b2 in each BBJT. The first control-terminal posts may be electrically isolated from the second control-terminal posts. Connector-lead 288g1 may be electrically connected to the first control-terminal posts, and connector-lead 288g2 may be electrically connected to the second control-terminal posts. An end portion of connector-lead 288g1 may be directly connected (e.g., welded, soldered, etc.) to a first strap, which in turn may be electrically connected (e.g., welded, soldered, etc.) to surfaces 277 of first control-terminal posts, and an end portion of connector-lead 288g2 may be directly connected (e.g., welded, soldered, etc.) to a second strap, which in turn may be electrically connected (e.g., welded, soldered, etc.) to surfaces 277 of the second control-terminal posts. Or one or more bond-wires may electrically connect the first strap to an end portion of connector-lead 288g1, and one or more bond-wires may electrically connect the second strap to an end portion of connector-lead 288g2.

FIG. 3O is an example of a packaged switch 247dO. In FIG. 3O switch 304dO may include four IGBTs electrically connected in parallel, the combination of which is electrically connected between die clip 372 and die substrate 360. In an alternative version, packaged switch 247dO may have only three or two IGBTs connected in parallel between a die substrate and a die clip, or just one IGBT connected between a die substrate and a die clip. Each of the IGBTs may or may not include an integrated diode with a cathode and anode electrically connected to the collector and emitter, respectively. For purposes of explanation only, each IGBT in FIG. 30 lacks an integrated diode unless otherwise stated. Each collector terminal in an IGBT may have one or more conductive pads with entirely flat, outwardly facing surfaces that can be electrically and thermally connected (e.g., sintered, soldered, etc.) directly to a flat surface of, for example, a die substrate. For purposes of explanation only, each collector terminal in this disclosure is presumed to have only one conductive pad unless otherwise noted. Each emitter terminal in an IGBT may have multiple conductive pads with entirely flat, outwardly facing surfaces that can be electrically and thermally connected (e.g., sintered, soldered, etc.) directly to, for example, flat surfaces of respective pedestals or the flat surface of one pedestal. In other versions the flat surfaces of the emitter terminal pads may be directly connected (e.g., sintered, soldered, etc.) to a flat surface of a die clip.

In FIG. 3O the flat surfaces of pads in collector terminals c1-c4 may be directly connected (e.g., sintered, soldered, etc.) to a flat surface of die substrate 360, and the flat surfaces of pads in emitter terminals e1-e4 may be electrically and thermally connected (e.g., sintered, soldered, etc.) directly to first flat end surfaces of pedestals. The second flat end surfaces at the opposite ends of the pedestals (i.e., the second flat end surfaces) may be electrically and thermally connected (e.g., sintered, soldered, etc.) directly to a flat surface of die clip 372. Connector-lead 288g may be electrically connected to the gate terminals of each IGBT. For purposes of explanation only, each IGBT in this disclosure is presumed to have only one gate terminal pad unless otherwise noted. Although not shown in FIG. 3O, switch module 376O may include a strap that is attached to the same surface of die substrate 360 to which the pads of the collector terminals c1-c4 may be connected. The strap may be electrically isolated from die substrate 360. One or more bond-wires may electrically connect the strap to the pads of the gate terminals in each of the IGBTs. Connector-lead 288g may be electrically connected to the strap. An end portion of connector-lead 288g may be directly connected (e.g., welded, soldered, etc.) to the strap. Or one or more bond-wires may electrically connect to the strap to an end portion of the connector-lead 288g.

FIG. 3P illustrates an example of a packaged switch 247qP. Switch 304qP may include two MOSFETs connected in parallel with two IGBTs, the combination of which is electrically connected between die substrate 360 and die clip 372 as shown. The flat, outwardly facing surfaces of pads in collector terminals c and drain terminals d may be electrically and thermally connected (e.g., sintered, soldered, etc.) directly to a flat surface of die substrate 360, and the flat, outwardly facing surfaces of pads in emitter terminals e and source terminals s may be electrically and thermally connected (e.g., sintered, soldered, etc.) directly to first flat end surfaces of pedestals. The flat surfaces at the opposite ends of the pedestals (i.e., the second flat end surfaces) may be electrically and thermally connected (e.g., sintered, soldered, etc.) directly to a flat surface of die clip 372. Connector-lead 288g1 may be electrically connected to the gate terminals g of the IGBTs, while connector-lead 288g2 may be electrically connected to the gate terminals g of the MOSFETs. Although not shown in FIG. 3P, switch module 376P may include first and second separate straps that are attached to the same surface of die substrate 360 to which the pads of drain terminals d and collector terminal c may be connected. The straps may be electrically isolated from die substrate 360. One or more bond-wires may electrically connect the first strap to the pad of the gate terminals in the IGBTs as shown, while one or more bond-wires may electrically connect the second strap to the pads of the gate terminals g in the MOSFETs. Connector-lead 288g1 may be electrically connected to the first strap, and connector-lead 288g2 may be electrically connected to the second strap. An end portion of connector-lead 288g1 may be directly connected (e.g., welded, soldered, etc.) to the first strap, and an end portion of connector-lead 288g2 may be directly connected (e.g., welded, soldered, etc.) to the second strap. Or one or more bond-wires may electrically connect to the first strap to an end portion of connector-lead 288g1, and one or more bond-wires may electrically connect to the second strap to an end portion of connector-lead 288g2. Packaged switch 304qP should not be limited to two MOSFETs connected in parallel with two IGBTs. In an alternative version, three or four MOSFETs may be connected in parallel with the two IGBTs, three or four IGBTs may connected in parallel with the two MOSFETs, three MOSFETs may be connected in parallel with three IGBTs, or four MOSFETs may be connected in parallel with four IGBTs. The size (i.e., length and width) of the die substrate 360 and die clip 372 should increase to accommodate each of these alternative versions of packaged switch 304qP.

With continued reference to FIGS. 2E-1-2E-3, FIGS. 3M and 3N symbolically illustrate example packaged diodes 245. Example packaged diodes 245 shown in FIGS. 3M and 3N include diode modules 378M and 378N, respectively, each of which may include a power stack, which in turn may include one or more diodes D electrically and thermally connected to and positioned between die substrate 360 and die clip 372, all of which are shown symbolically. Die substrate terminals 230 and die clip terminals 344 may be also shown symbolically.

FIGS. 3M and 3N show relative positioning of diode module components even though the diode module components are shown symbolically. For example, the figures show that diodes D are physically positioned and electrically connected between die substrates 360 and die clips 372. Also, die substrate terminals 230 and die clip terminals 344, which are shown symbolically, are illustrated as being flush with surfaces of cases 249 even though die substrate terminals 230 and die clip terminals 344 are presumed protruding beyond the outside surfaces of cases 249 as noted above.

Although not shown in FIGS. 3M and 3N each power stack may include one or more pedestals, each of which may have opposite facing first and second end surfaces that are substantially and entirely flat. Each first flat end surface of the one or more pedestals may be electrically and thermally connected (e.g., sintered, soldered, etc.) directly to a outwardly facing, flat surface of a current terminal pad of a respective diode D. The second flat end surface of each of the one or more pedestals may be electrically and thermally connected (e.g., sintered, soldered, etc.) directly to a flat surface of die substrate 360 or die clip 372 on its side facing opposite the side that contains die substrate terminal 230 or die clip terminal 344. In an alternative version, pedestals are not used in the power stacks of FIGS. 3M and 3N, and current terminals may be connected (e.g., sintered, soldered, etc.) directly to respective flat surfaces of die clip 372 and die substrate 360.

FIGS. 3M and 3N show relative positioning of components. Die substrate 360, one or more diodes D, and die clip 372 may be stacked as shown. Electrical current can be transmitted between die clip terminal 344 and die substrate terminal 230 via one or more diodes D. Diode modules 376M and 376N may include connector-leads 288ds and 288dc, but for ease of illustration neither is shown in FIGS. 3M and 3N. In other versions of a packaged diode 245, connector-leads 288ds and 288dc are not needed and left out. For example, some or all packaged diodes 245 of FIGS. 6C-1-6F-2, which are more fully described below, may lack connector-leads 288ds and 288dc.

Die substrate 360 and die clip 372 may conduct large current (e.g., 1, 5, 10, 50, 200, 400 A or more) into or out of packaged diode 245 via die substrate terminal 230 and die clip terminal 344, respectively. Diodes generate heat. Die substrates 360 and die clips 372 can transmit substantial heat (e.g., 1, 5, 10, 50, 100, 200, 400, 750 W or more) generated by the one or more diodes D out of packaged diode 245 via die substrate terminals 230 and die clip terminals 344, respectively.

FIGS. 3M and 3N illustrate respective examples of packaged diode 245 that can be cooled through their die substrate and die clip terminals. In FIGS. 3M and 3N the cathode terminal of each of the one or more diodes D may have one or more outwardly facing, conductive pads that may be entirely flat. The anode terminal in each of the one or more diodes D may have one or more outwardly facing, conductive pads that may be entirely flat. The flat surface(s) of the pad(s) in the cathode terminal(s) may be electrically and thermally connected (e.g., sintered, soldered, etc.) directly to a flat surface of die substrate 360, and the flat surface(s) of pad(s) s in the anode terminal(s) may be electrically and thermally connected (e.g., sintered, soldered, etc.) directly to first flat end surfaces of respective pedestals. The flat surfaces at the opposite ends of the pedestal(s) (i.e., the second flat end surface(s)) may be electrically and thermally connected (e.g., sintered, soldered, etc.) directly to a flat surface of die clip 372. Or the flat surface(s) of pad(s) in the anode terminal(s) may be electrically and thermally connected (e.g., sintered, soldered, etc.) directly to a flat surface of die clip 372.

Power stacks may be created by electrically and thermally connecting transistors and/or diodes between die clips and die substrates. The first current terminal (e.g., collector terminal, drain terminal, cathode terminal, etc.) pad(s) of each transistor and/or diode may be sintered to a die substrate (or die clip) using a layer of highly conductive sintering material that may include silver, copper, etc. No dielectric exists between the transistor and/or diode and the die substrate terminal of the connected die substrate (or die clip terminal of the connected die clip). The second current terminal (e.g., emitter terminal, source terminal, anode terminal, etc.) pad(s) of each transistor and/or diode may be sintered to a die clip (or die substrate) through a layer of highly conductive sintering material that may include silver, copper, etc. No dielectric exists between a transistor and/or diode and a die clip terminal of the connected die clip (or die substrate terminal of a die substrate). Accordingly, no dielectric should exist between a die substrate terminal and a die clip terminal in a power stack.

Die substrate and die clips can be exposed through their cases so that their rectangular-shaped, flat surfaced die substrate terminals and die clip terminals may be electrically and thermally connected to, for example, respective bus bars. The dimensions (e.g., width and length) of the exposed terminals may be configured to transmit substantial current and heat. A die substrate terminal may be parallel to, but oppositely facing (i.e., 180 degrees) at least one flat surface of a die substrate to which the first current terminal (e.g., collector terminal, drain terminal, etc.) pad(s) may be sintered. A die clip terminal may be parallel to, but oppositely facing (i.e., 180 degrees) at least one flat surface of a die clip to which the second current terminal (e.g., collector terminal, drain terminal, etc.) pad(s) is/are electrically connected. A die clip terminal may be parallel to, but oppositely facing (i.e., 180 degrees) at least one flat surface of a die clip to which the second current terminal (e.g., collector terminal, drain terminal, etc.) pad(s) is/are sintered.

Example die substrate terminal 230 and die clip terminal 344 of FIGS. 2A-1-2E-3 may be electrically connected to one or more first current terminals (e.g., drain(s)) and one or more second current terminals (e.g., source(s)), respectively, of one or more transistors inside packaged switches 247p, 247q, 247s and 247d, or die substrate terminal 230 and die clip terminal 344 may be electrically connected to one or more first current terminals (e.g., cathode(s)) and one or more second current terminals (e.g., anode(s)), respectively, of diodes inside packaged diode 245.

Die substrate terminals and die clip terminals may be configured for direct or indirect electrical and/or thermal connection to devices. Die substrate terminal 230 or die clip terminal 344 may be electrically and/or thermally connected (e.g., sintered, soldered, press fitted, etc.) to a surface of a heat sink, a bus bar, or a bus bar that also acts as a heat sink. For example, die substrate terminal 230 or die clip terminal 344 may be electrically and/or thermally connected to a surface of a “V+ bus bar,” which in turn may be electrically connected to a V+ terminal of a battery, fuel cell, DC/DC converter, etc., through a filter or filter component. Die substrate terminal 230 or die clip terminal 344 may be electrically and/or thermally connected (e.g., sintered, soldered, press fitted, etc.) to a surface of a “V-bus bar,” which in turn may be electrically connected directly or indirectly to a V-terminal of the battery, fuel cell, DC/DC converter, etc. Die substrate terminal 230 or die clip terminal 344 may be electrically and/or thermally connected (e.g., sintered, soldered, press fitted, etc.) to a surface of an AC bus bar, which is also called a “phase bus bar,” which in turn may be electrically connected to a terminal of a stator winding W of a motor, an inductor L of a filter, or other device. A heat sink or bus bar may include flat surfaces that may be soldered, press-fitted, welded, sintered, or connected in another manner to flat surfaces of one or more die substrate terminals 230 or one or more die clip terminals 344 to create an electrical and thermal connection between them. A press-fit connection can reduce or eliminate problems related to differences in coefficients of thermal expansion described below. A flat surface of die substrate terminal 230 or die clip terminal 344 (or other device) may be electrically and/or thermally connected to a flat surface of a metal heat sink or metal bus bar using solder and a mesh made of woven copper wires in a method more fully described below.

A bus bar of this disclosure may be assembled from several components. For example, bus bars may be formed by connecting (e.g., soldering, sintering, etc.) two metal bus bar portions around one or more tubes. Before they are connected, one or more grooves may be formed in a flat surface of each metal bus bar portion. The grooves may be parallel to each other. The grooves can receive tubes. A tube can be circular, oval, square, rectangular or other shape. The size and shape of bus bar portion grooves may conform to the size and shape of the tubes they receive. For example, the grooves in the metal bus bar portion may be semi-circular with a radius that is substantially equal to or larger than the radius of respective circular tubes to be received. Stated differently, the grooves in the metal bus bar portions may be semi-cylindrical with a radius that is substantially equal to or larger than the radius of respective cylindrical tubes to be received. The width of a flat bottom surface between flat side walls extending perpendicularly from the flat bottom surface of a semi-rectangular groove, may be substantially equal to or larger than the width of a square or rectangular shaped tube to be received in the groove. The major axis and minor axis of semi-oval shaped groove may be substantially equal to or larger than the major axis and minor axis, respectively, of an oval shaped tube to be received in the groove.

Join material (e.g., solder paste, sinter paste, etc.) may be applied to the perimeter or outer surfaces of a tubes at regions to be connected to surfaces of respective bus bar portion grooves, or the material may be applied to surfaces of bus bar portion grooves to be connected to respective tube surfaces. After the join material is applied, grooves in respective metal bus bar portions can be aligned to create at least one channel around a tube. Some join material (e.g., solder paste) can be heated to its melting point, allowing it to flow and create an circular, square, oval, rectangular, etc., interface or joint around the tubes, and between the tubes and respective bus bar channel surfaces. Some of the melted material (e.g., melted solder paste) may also flow between flat surfaces of the metal bus bar portions to be joined. Once the connecting material has adequately flowed and bonded the outer surfaces of tubes to surfaces of respective bus bar channels, the assembly can be cooled, which helps to solidify the interface or joint between the tubes and the channels in which they are received.

In general, a bus bar may distribute high current (e.g., 10, 20, 50, 100, 200, 400, 800, 1000 A or more). The material composition (e.g., copper, aluminum, etc.) and cross-sectional area of a bus bar, or components thereof, determines the maximum amount of current that may be carried, and parasitic parameters. A bus bar with wider cross-sectional areas may have lower parasitic parameters, including parasitic inductance, which can affect voltage overshoot (aka voltage spike) across transistors electrically connected to the bus bar. The inductance of the disclosed bus bars may be 2.0, 1.0, 0.8, 0.6, 0.4, 0.1, 0.01 nH or less between a bus bar terminal (e.g., V+, V−, V0, etc.) and a die substrate terminal or die clip terminal of a packaged switch to which the bus bar may be electrically connected.

A “bus bar tube” refers to a tube received by or thermally coupled to a bus bar, and a “heat sink tube” refers to a tube received by or thermally coupled to a heat sink. A tube is considered “received by” a bus bar or heat sink when some, most, or substantially all the tube's outer surface area is in direct or indirect thermal contact with the bus bar or heat sink. A single tube may be received by more than one bus bar or heat sink. In some embodiments, a bus bar may at least partially surround or enclose a tube such that some or most of the tube resides within the bus bar body. Tubes may facilitate heat transfer from the bus bar or heat sink to a fluid flowing through the tubes. Depending on the configuration, the tubes may provide electrical isolation between the fluid and the associated bus bar or heat sink, or they may not.

Tubes are presumed to extend linearly between opposite ends unless otherwise noted. Tubes are presumed to have a uniform cross section between opposite ends unless otherwise noted. Fluid manifolds may be fluidly connected to ends of bus bar or heat sink channels. Fluid manifolds may be fluidly connected to ends of tubes extending from bus bars or heat sinks.

A fluid may flow through a bus bar or heat sink channel, or a fluid may flow through a tube received in a bus bar or heat sink. The fluid may be a dielectric or non-dielectric (i.e., electrically conducting) liquid. The fluid may be dielectric or non-dielectric gas. The fluid may be a refrigerant such as R134a, R245fa, R365mfc, R600a, carbon dioxide, methanol, ammonia, etc.

Bus bar channels, heat sink channels or tubes may be part of a fluid circuit, which may also include a pump, radiator, manifolds, hoses, etc. Fluid circulates through a fluid circuit. Components of a fluid circuit, such as the bus bar tubes and manifolds, may be in fluid communication with each other. A fluid circuit with bus bar channels, heat sink channels or tubes may include a pump or other device for circulating the fluid through the circuit. A fluid circuit with channels or tubes may lack a pump, and fluid may circulate in the circuit through thermosyphon action. A fluid used for cooling a bus bar may undergo phase changes during circulation. For example, fluid may absorb heat emitted from transistors, which changes the state of the fluid from liquid to gas, and the fluid in gaseous state may return to the liquid state as heat is extracted from the fluid.

Tubes may be formed (e.g., extruded) from a metal such as copper or aluminum, it being understood tubes can be formed of other electrically conductive materials such as alloys. The entire inner and/or outer surfaces of metal tubes can be coated with one or more layers of a thermally conductive and electrically isolating dielectric material. The outer dielectric layer can electrically insulate the tubes, and thus the fluid flowing through the tubes, from heat sinks or bus bars in which they may be received. The inner dielectric layer can electrically insulate the fluid flowing in the tube from the tube. The outer surface of a metal tube may be selectively coated with a dielectric material. For example, the outer surface of one or more metal tube sections can be coated with a dielectric material. In another version no dielectric exists between a fluid (e.g., a dielectric fluid such as oil) flowing in metal tubes and the heat sink or bus bar in which the tubes may be received. In this alternative version, outer surfaces of the metal tubes may be electrically and thermally connected to the heatsinks or bus bars in which they may be received. Tubes in a bus bar may take form in concentric metal tubes. Fluid can flow through the inner tube of the concentric tubes. A dielectric material may be added between the concentric tubes (i.e., between the outer surface of the inner tube and the inner surface of the outer tube). The dielectric material can electrically insulate the concentric tubes from each other.

Tubes may be formed (e.g., extruded) from thermally conductive and electrically non-conductive dielectric material. For example, tubes may be formed (e.g., extruded) of ceramic material such as aluminum nitride or beryllium oxide. The entire inner or outer surface of dielectric tubes can be coated with one or more layers of metal. The outer surface of a dielectric tube may be selectively coated with a layer of metal. For example, the outer surface of one or more dielectric tube sections can be coated with metal. A dielectric tube may be commonly received in separate bus bars (e.g., two or more phase bus bars). A tube commonly received in separate bus bars may mean the tube is received in aligned channels of two or more bus bars. But to avoid electrically connecting the separate bus bars, sections of the commonly received dielectric tube between the bus bars should not be coated with an outer layer of metal. A thin layer of metal may be formed on end sections of tubes (dielectric coated metal tubes or dielectric tubes) to facilitate a seal between the ends of the tubes and respective fluid manifolds. But to avoid electrically connecting to an electrically conductive fluid (e.g., water glycol mixture) flowing through the manifolds and tubes, the thin layer of metal formed on end sections of tubes should be electrically isolated from bus bars. The ends of the dielectric tubes that connect with fluid manifolds may be bare.

Bus bars may have different shapes, sizes, and dimensions (e.g., length, width, height, etc.) to accommodate different design objectives. Bus bars in a power converter may have different shapes, sizes, and dimensions. For example, a rectangular cuboid shaped phase bus bar in a converter may be different in length, width, and height when compared to dimensions of the power converter's rectangular cuboid shaped V+ bus bar or V− bus bar, or rectangular cuboid shaped V+ and V− bus bars in a converter may have different lengths, widths, and heights.

A bus bar may be formed many ways. A bus bar may be formed by casting metal (e.g., aluminum, copper, etc.) around one or more tubes. Casting may be a process in which metal is delivered to a die or mold that contains an inverse or negative impression (i.e., a three-dimensional negative image) of the intended shape (e.g., a rectangular cuboid). One or more tubes may be received in a die or mold before the metal is delivered. For example, one or more metal tubes or metal tubes that may be fully or partially coated with a thin layer of dielectric material or other material, may be received in the die or mold. Or one or more bare dielectric tubes or dielectric tubes that may be partially coated with a thin layer of metal or other material, may be received in the die or mold. The tubes and mold may be preheated before the metal is delivered. For example, the tubes and mold could be preheated to a temperature that is above the melting point of the metal to be added to the mold. Liquid metal can be added to the mold. Or solid metal (e.g. metal paste or pellets) can be added to the mold and then heated to a liquid state so that it flows. After the liquid metal solidifies around the tubes, the resulting structure can be removed from the die or mold. Or the resulting structure can be reheated to re-liquefy the metal around the tubes, which may increase the density of the resulting metal structure around the tubes after it resolidifies.

With continuing reference to FIGS. 3A-3P, FIGS. 4A-41 illustrate example switch modules 376, example diode modules 378, and their components. Each of the example switch modules 376 and diode modules 378 include a switch and/or diode(s) sandwiched between a die substrate and a die clip.

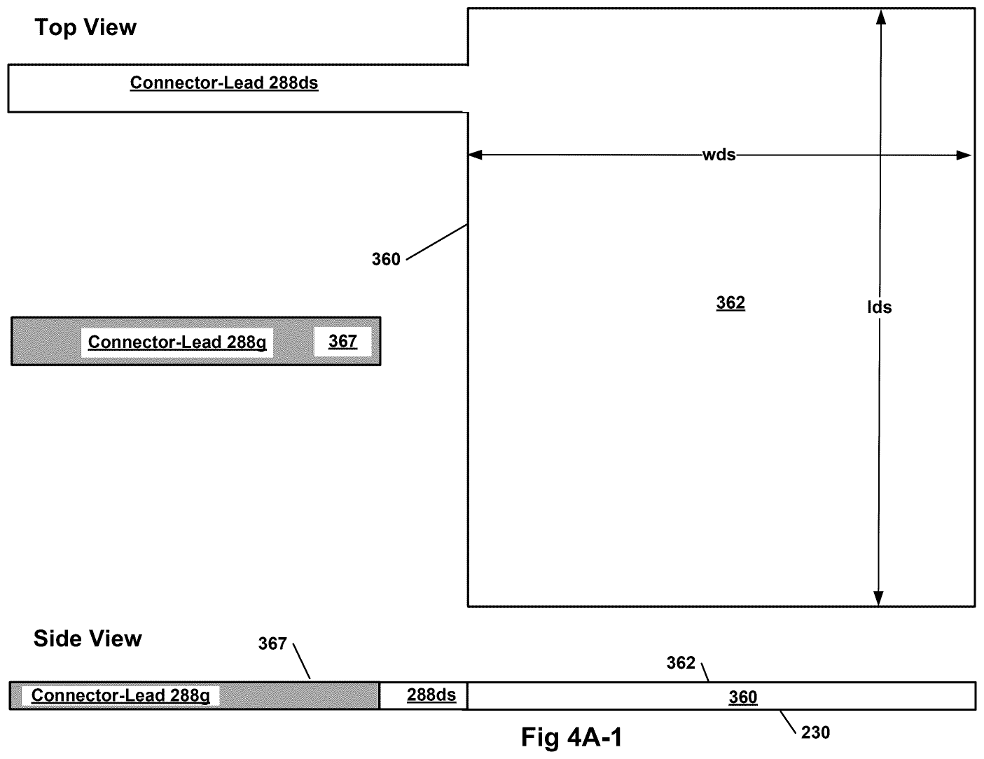

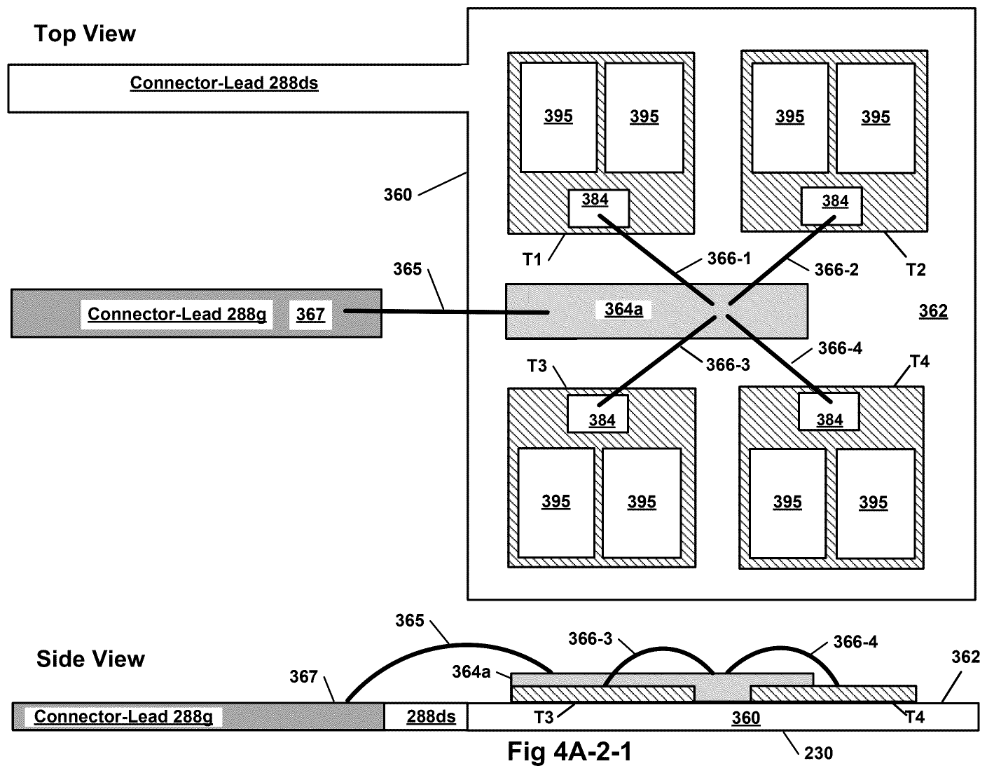

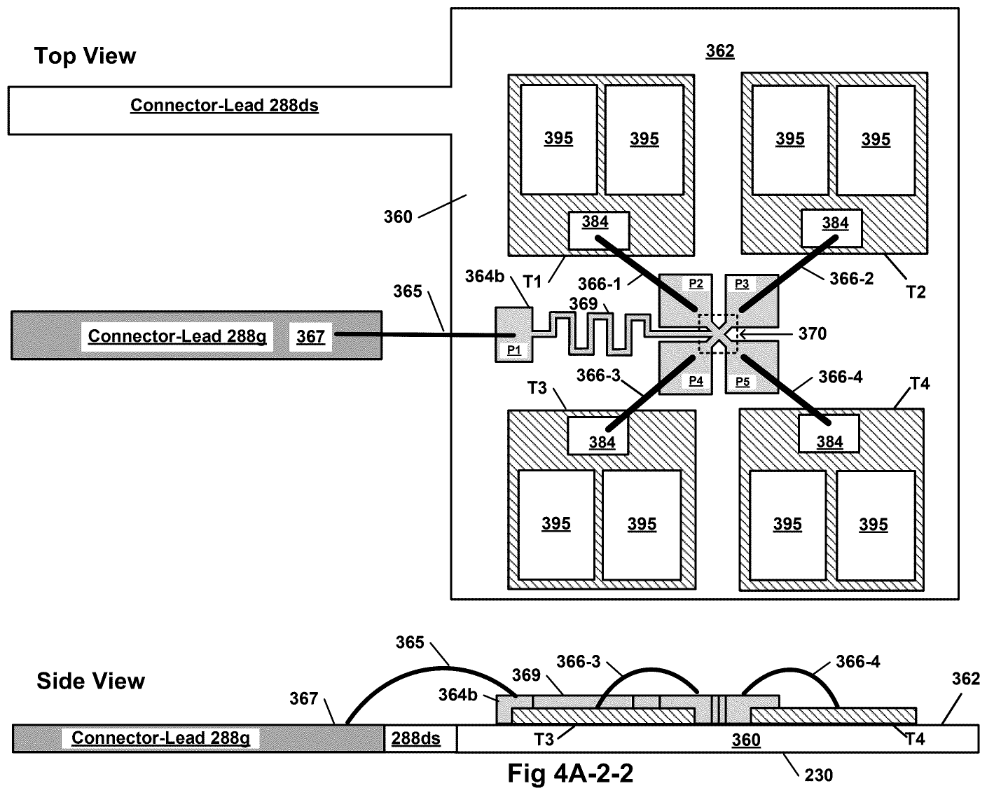

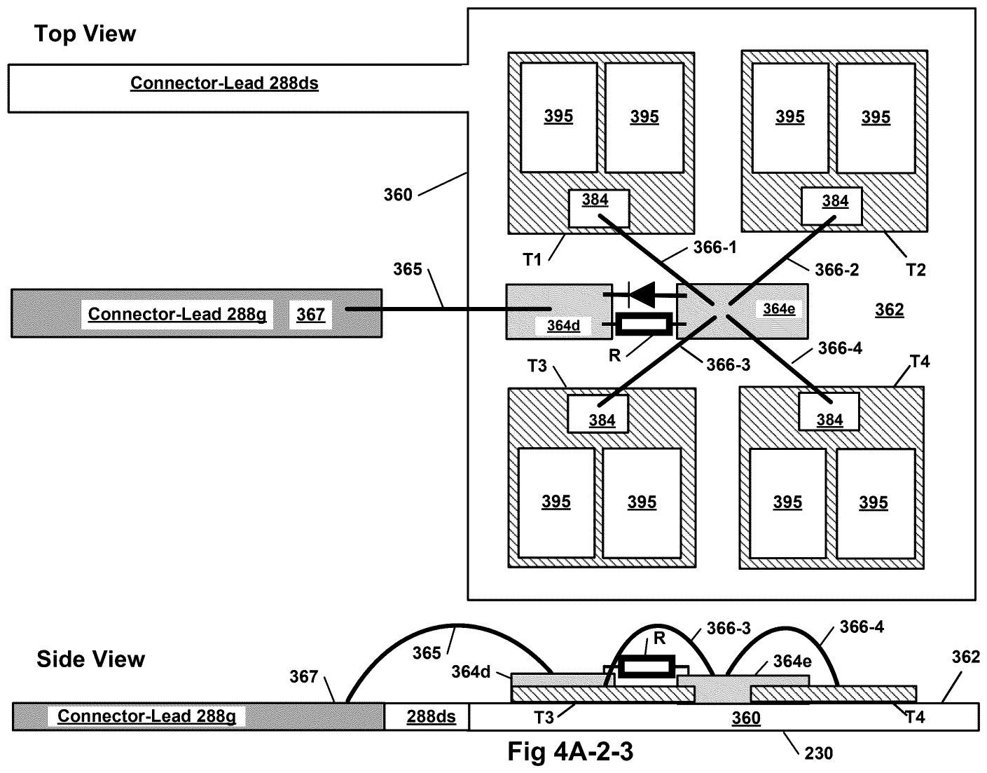

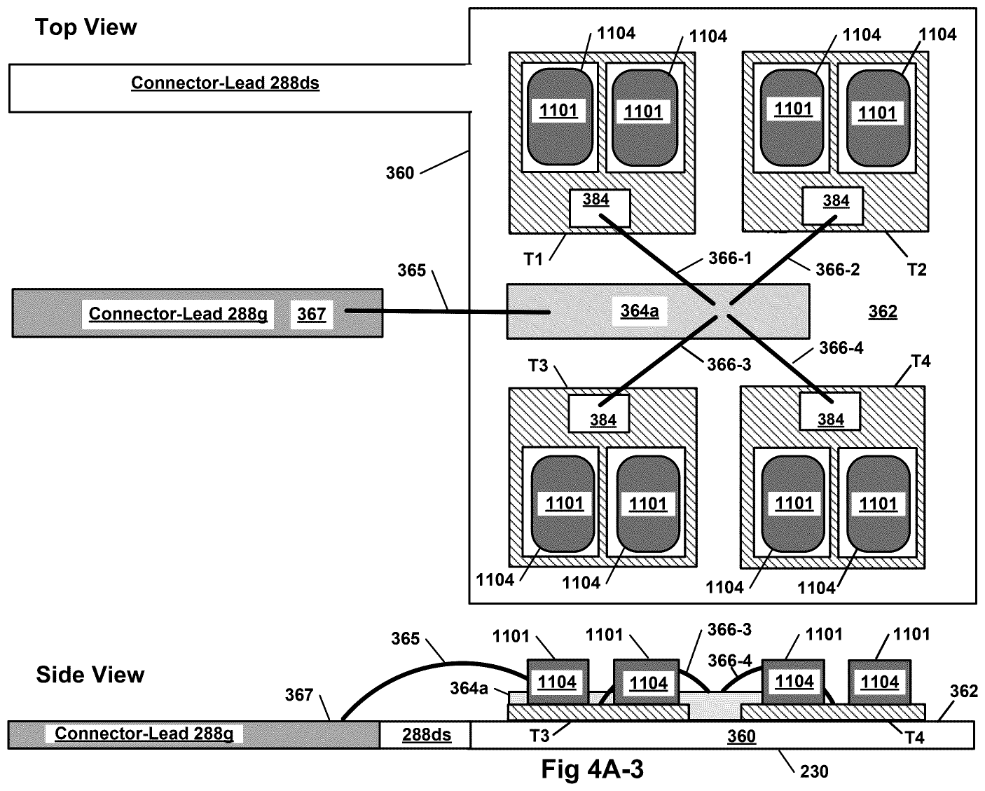

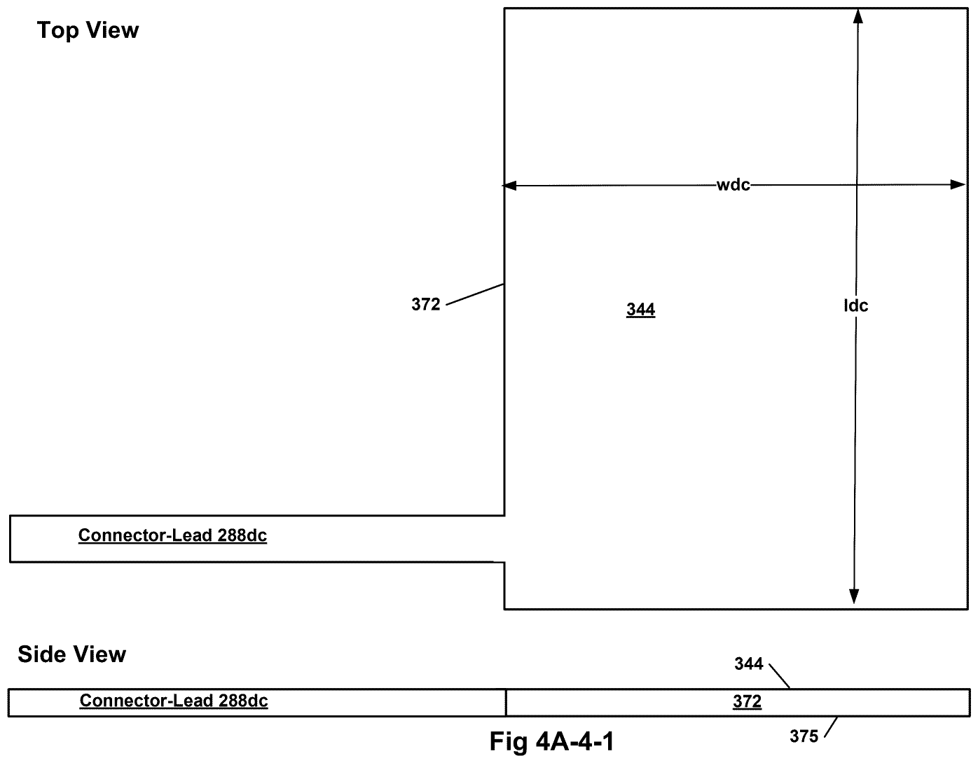

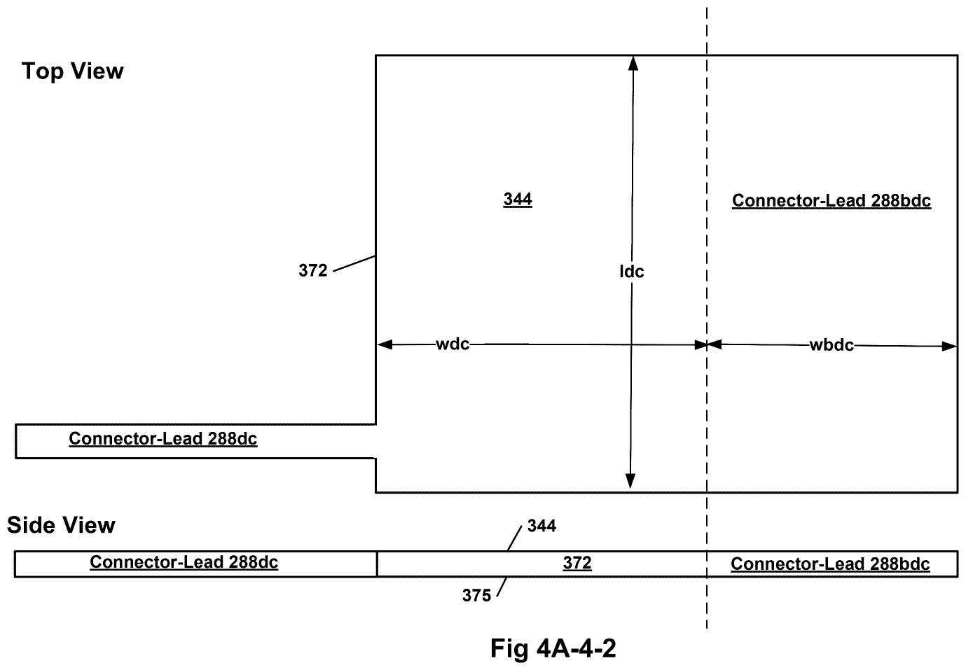

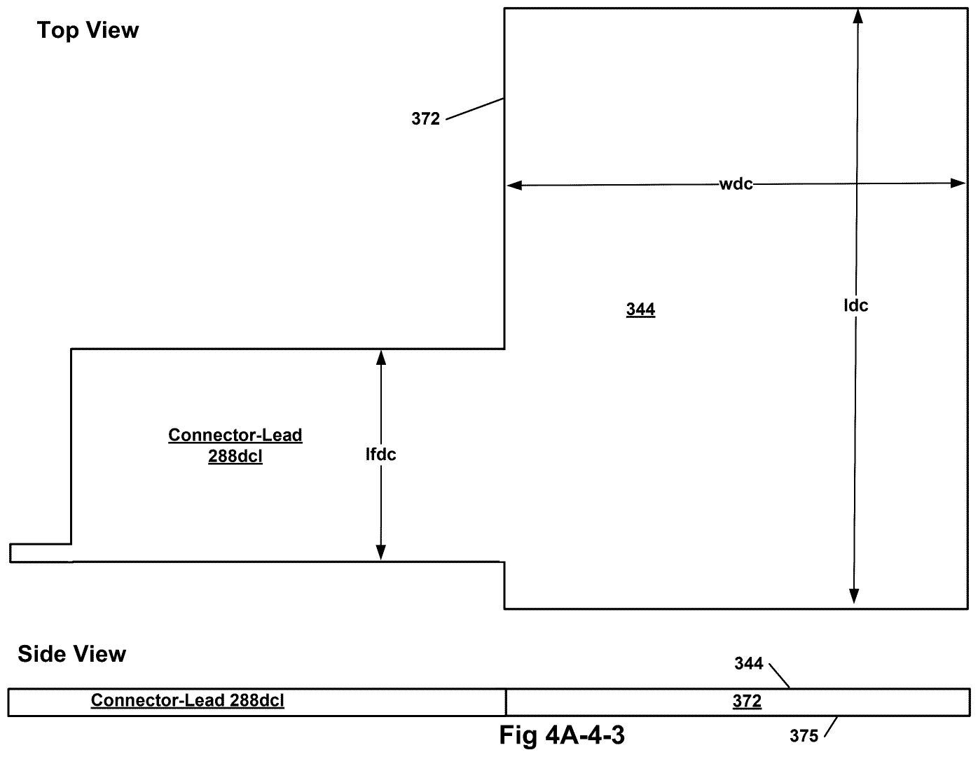

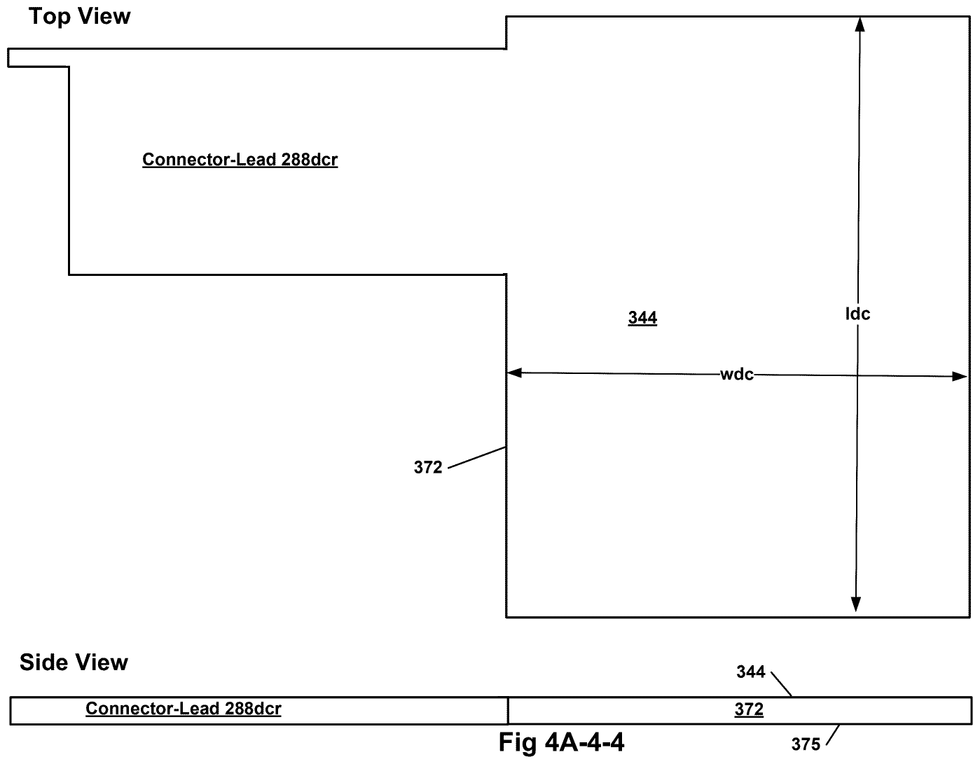

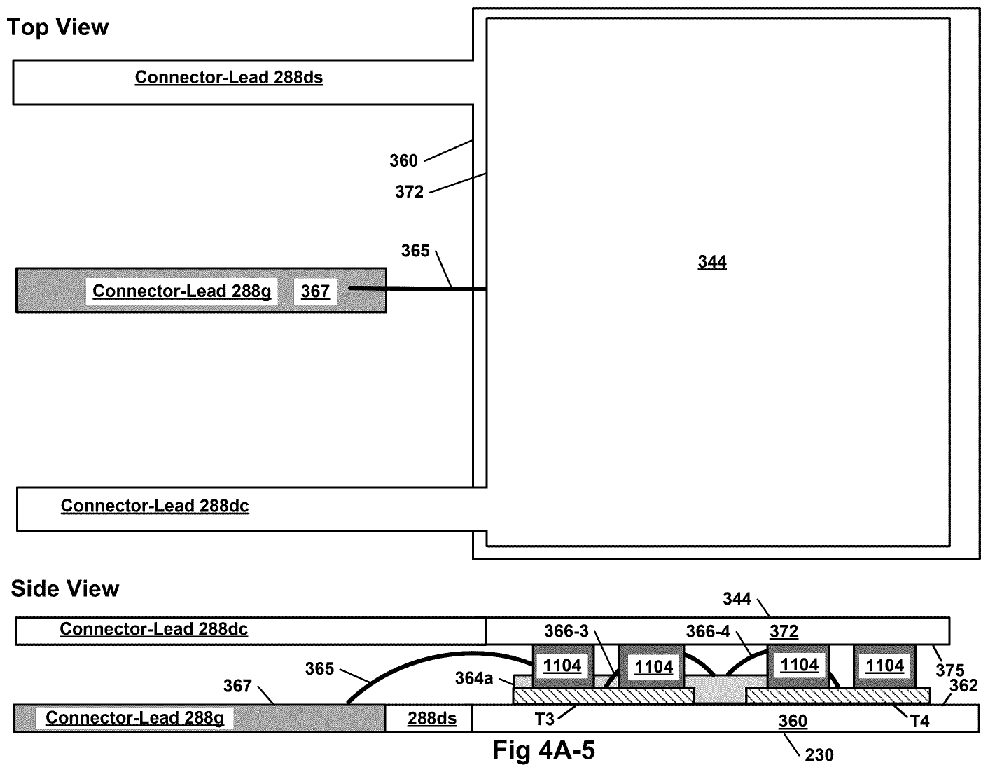

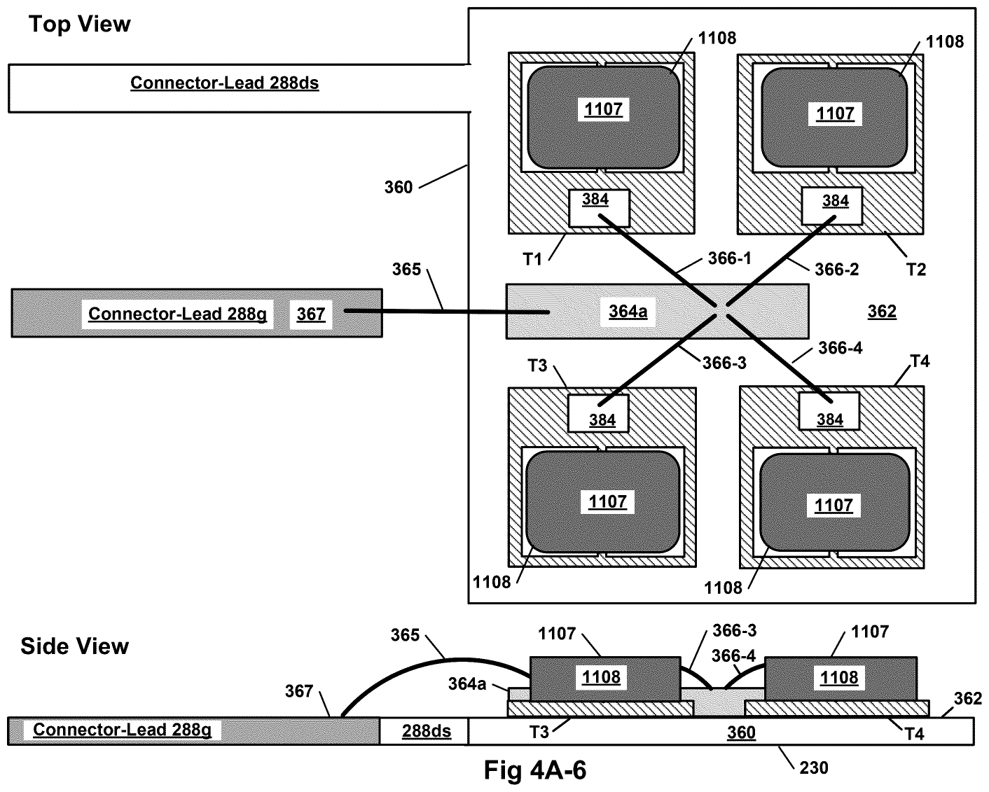

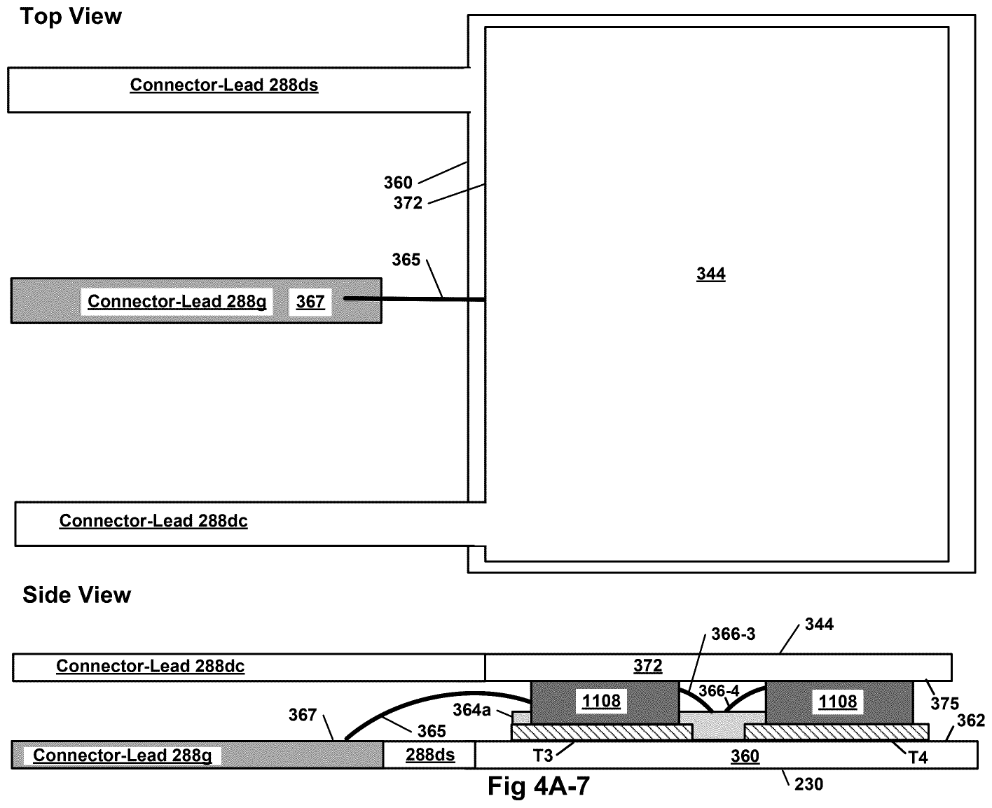

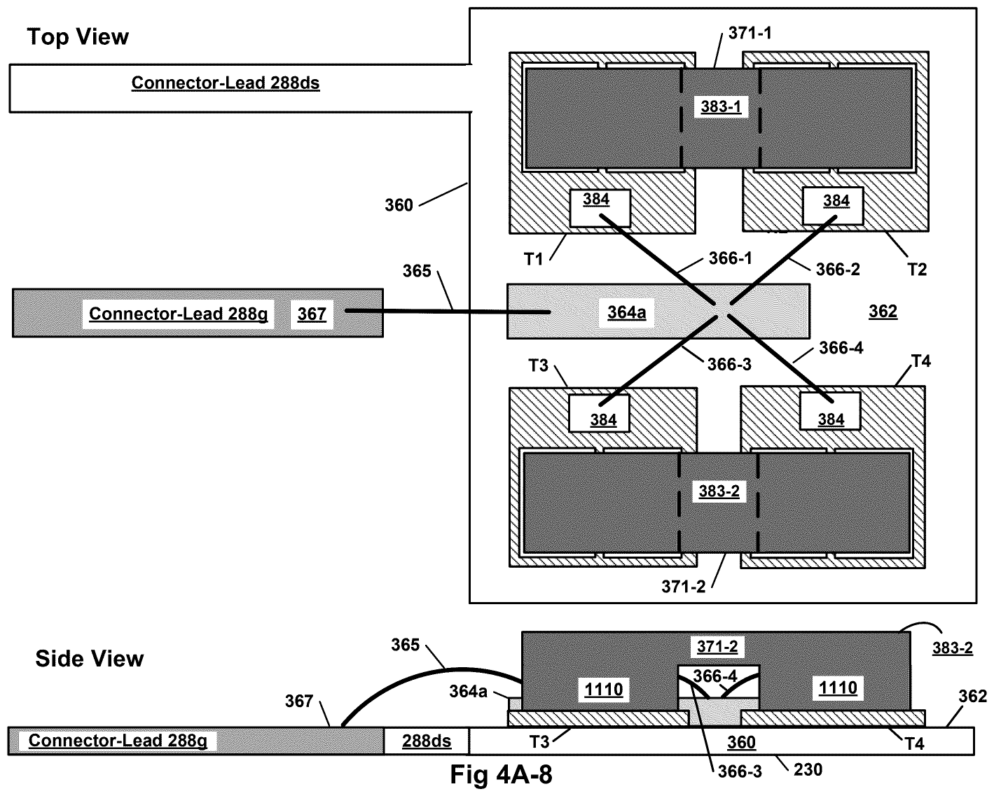

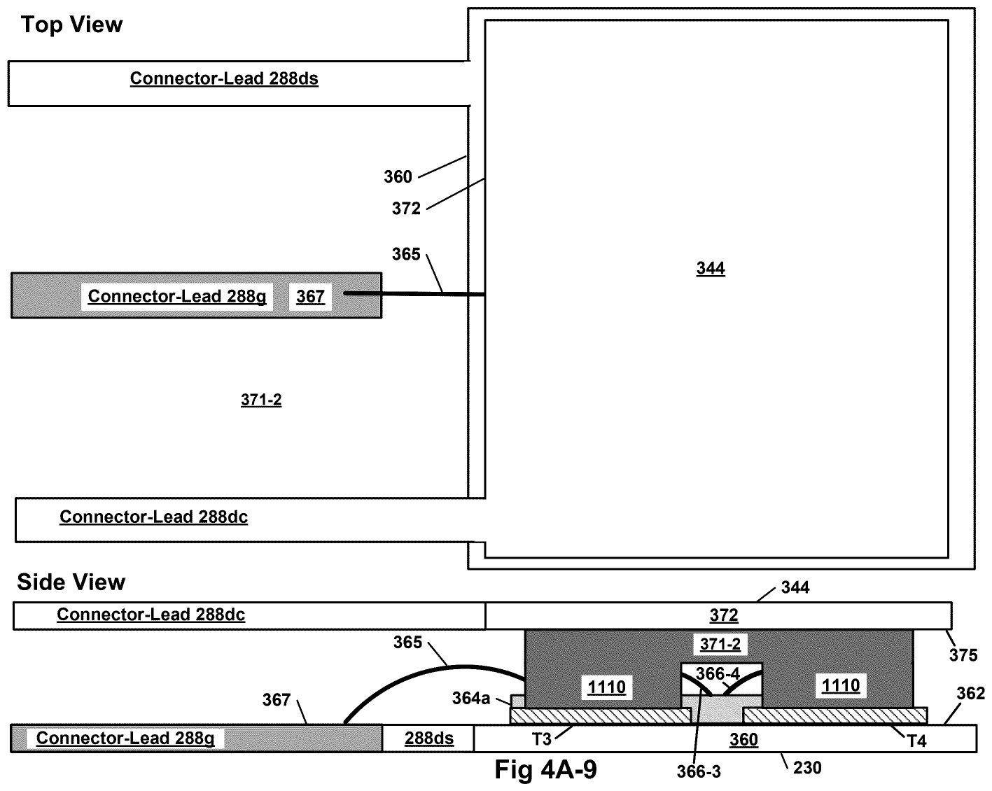

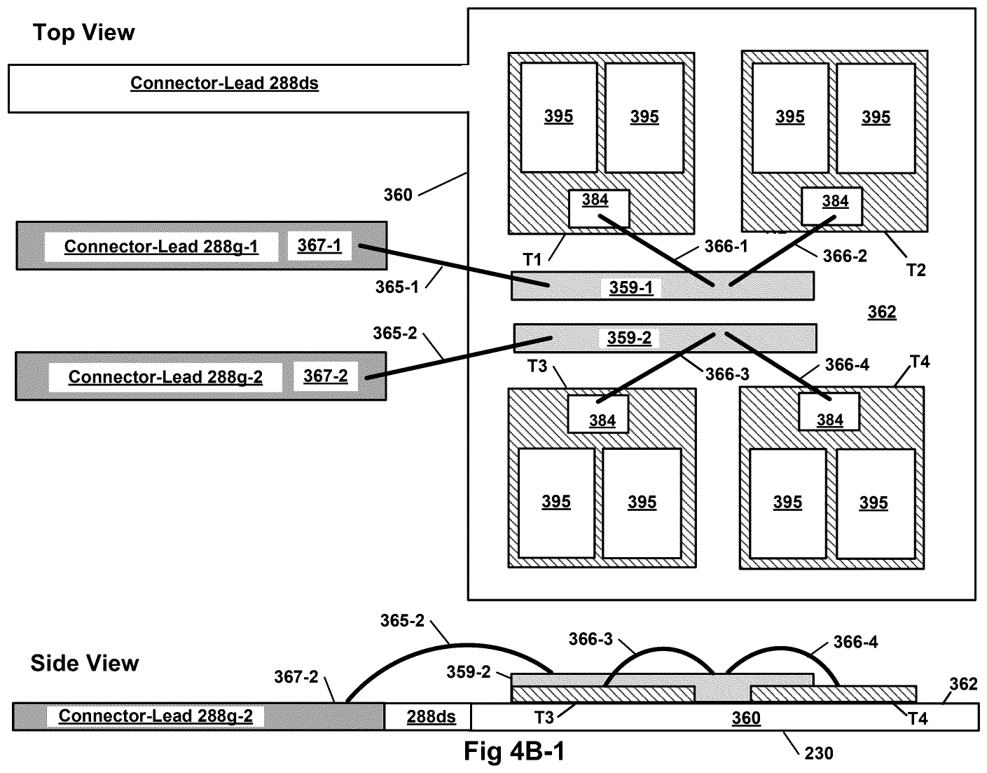

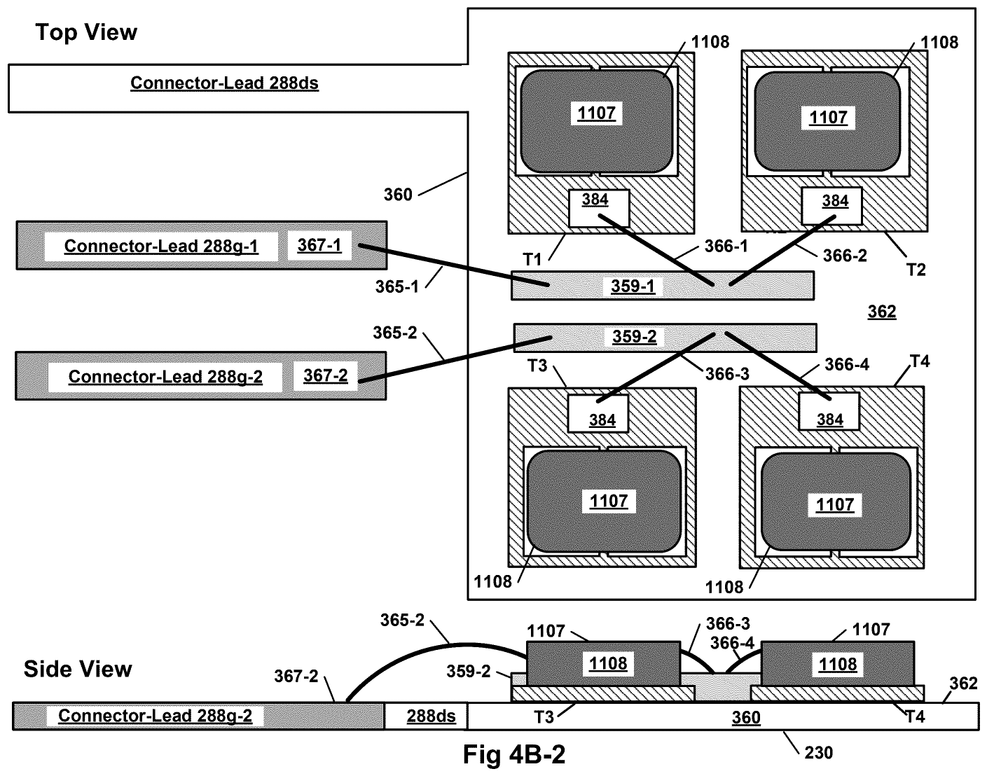

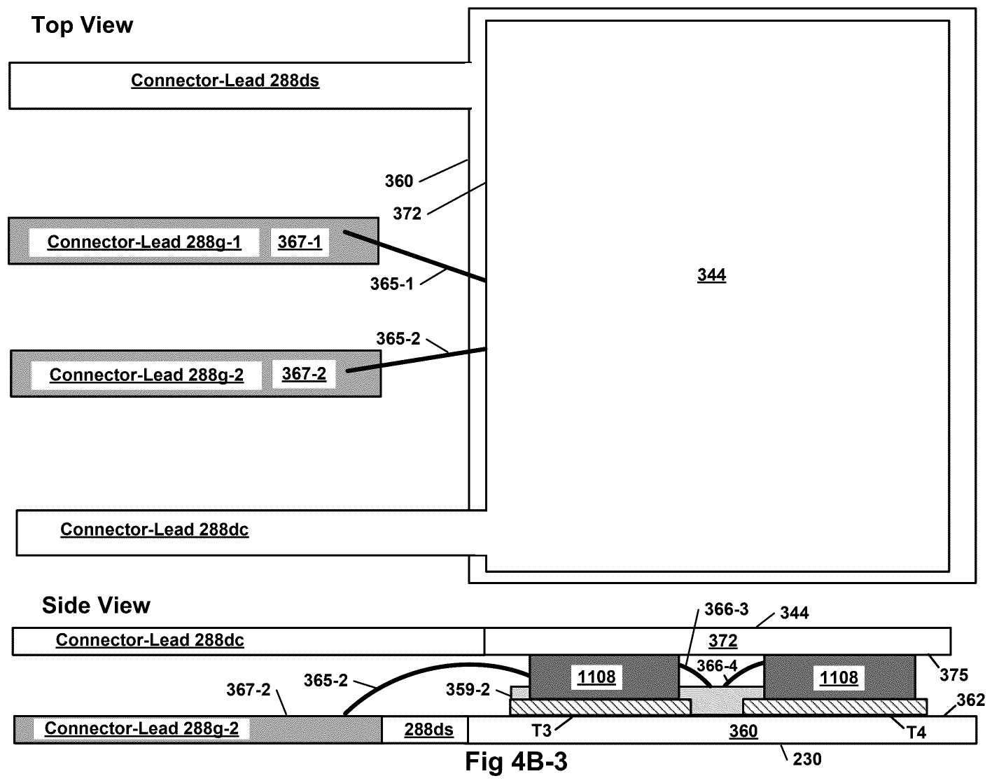

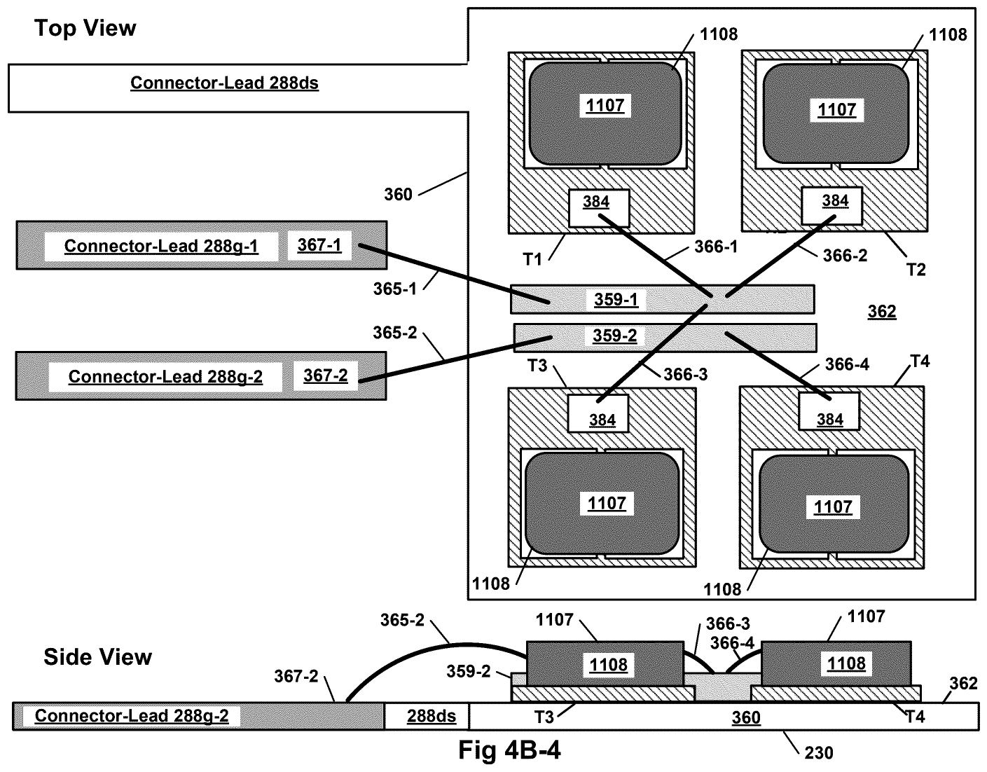

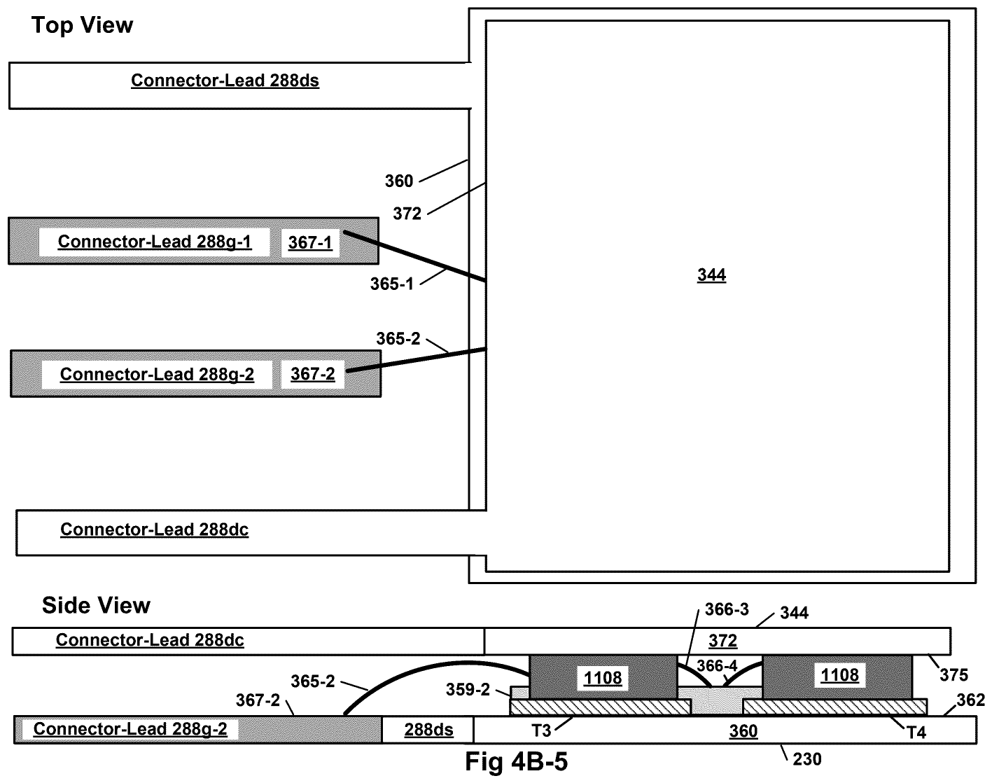

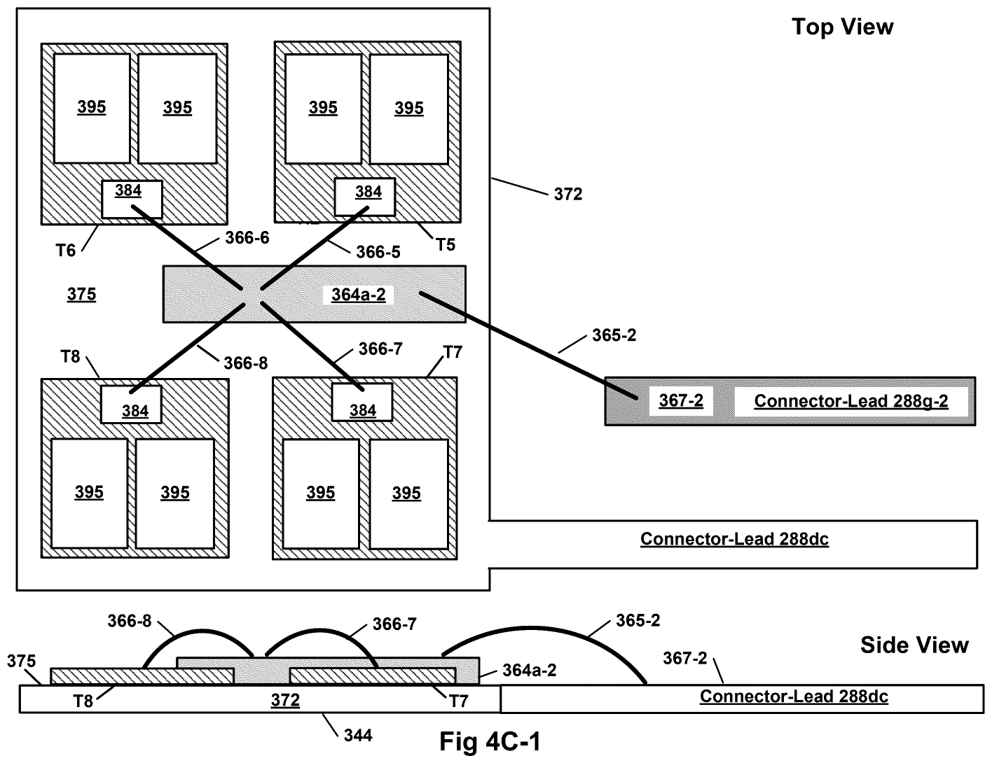

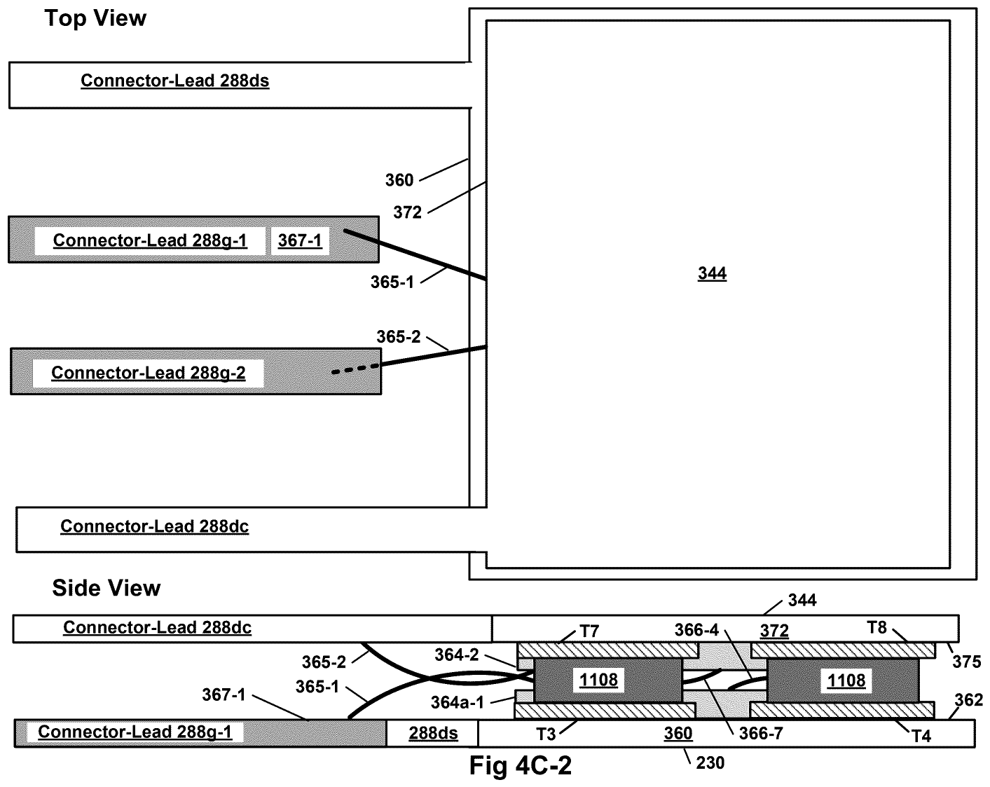

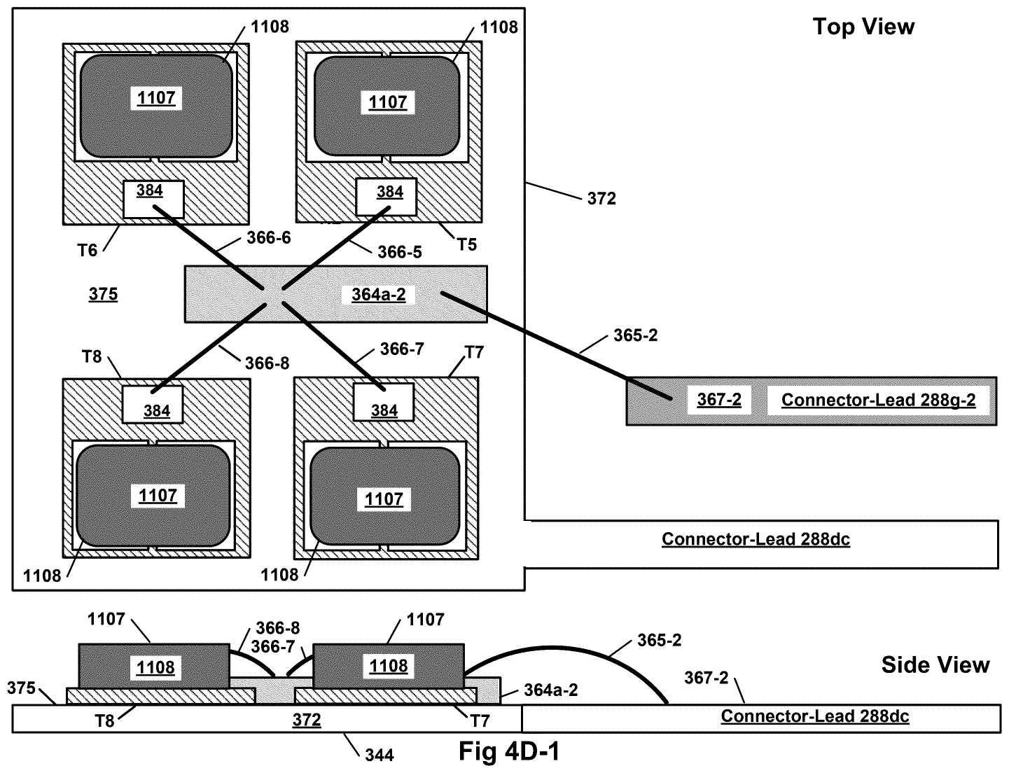

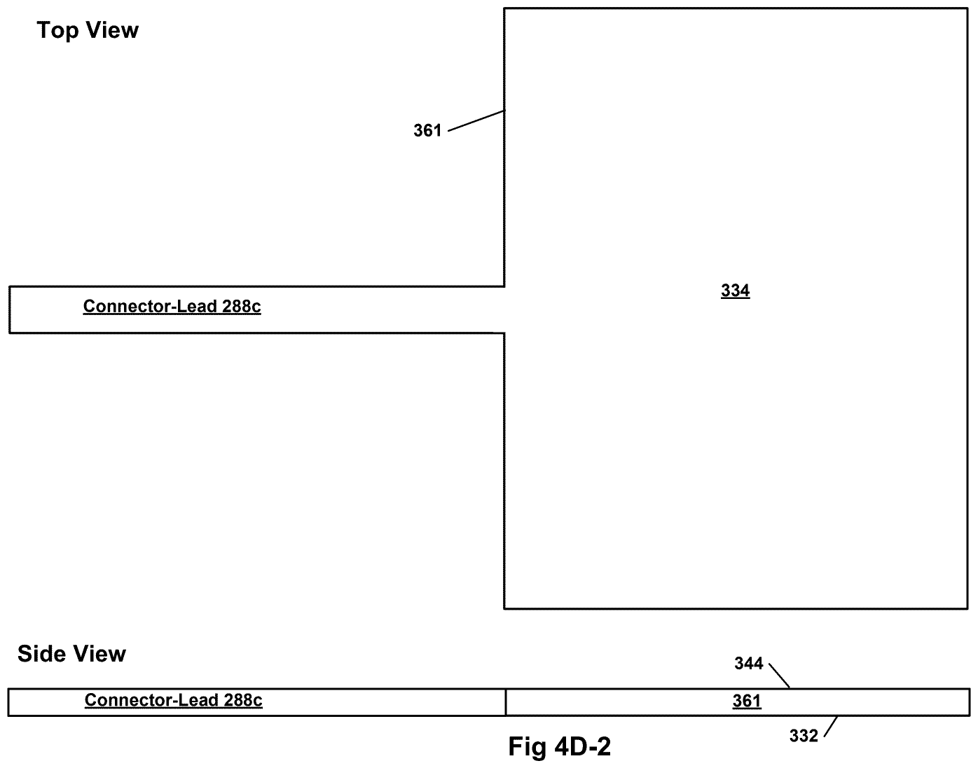

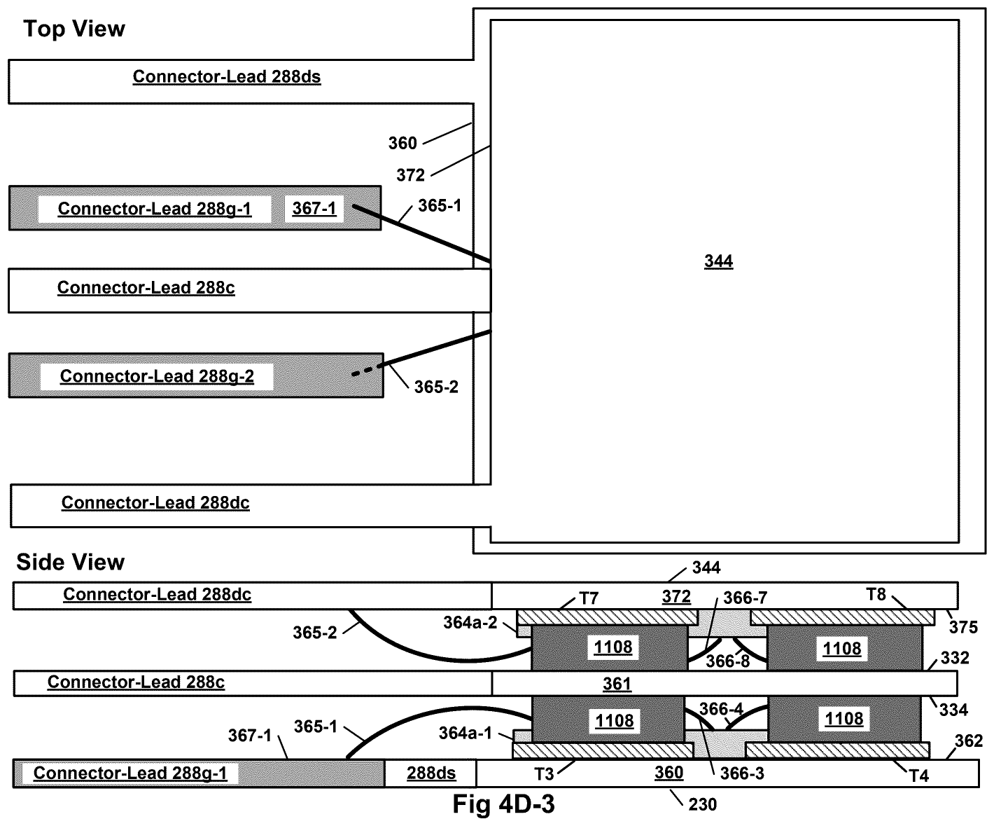

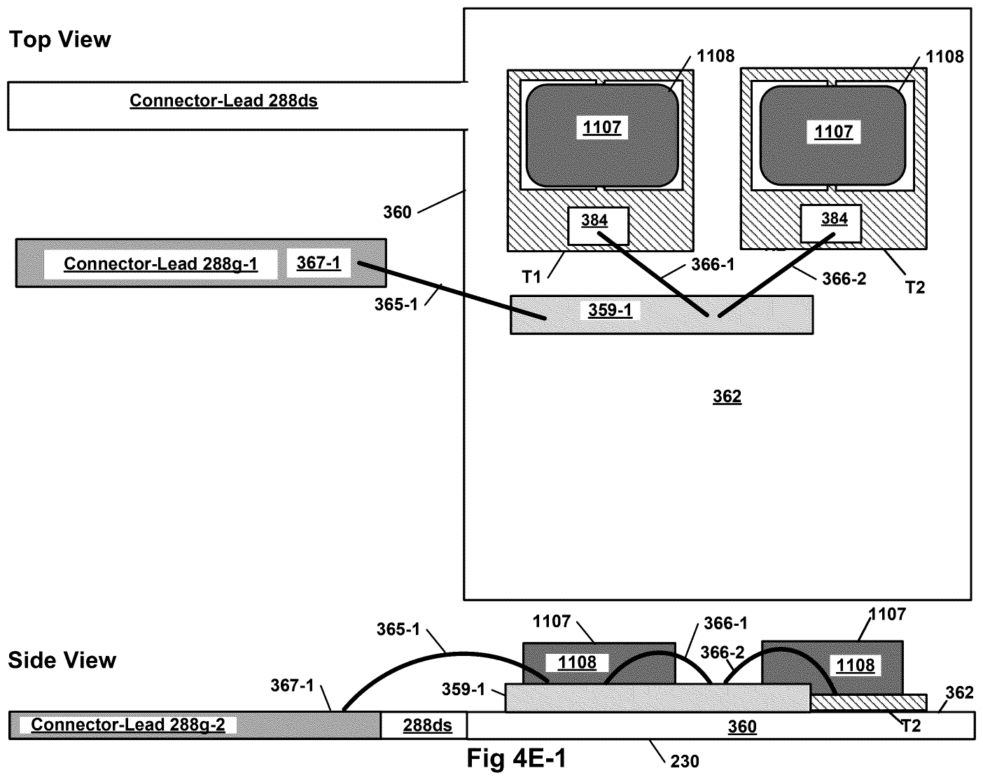

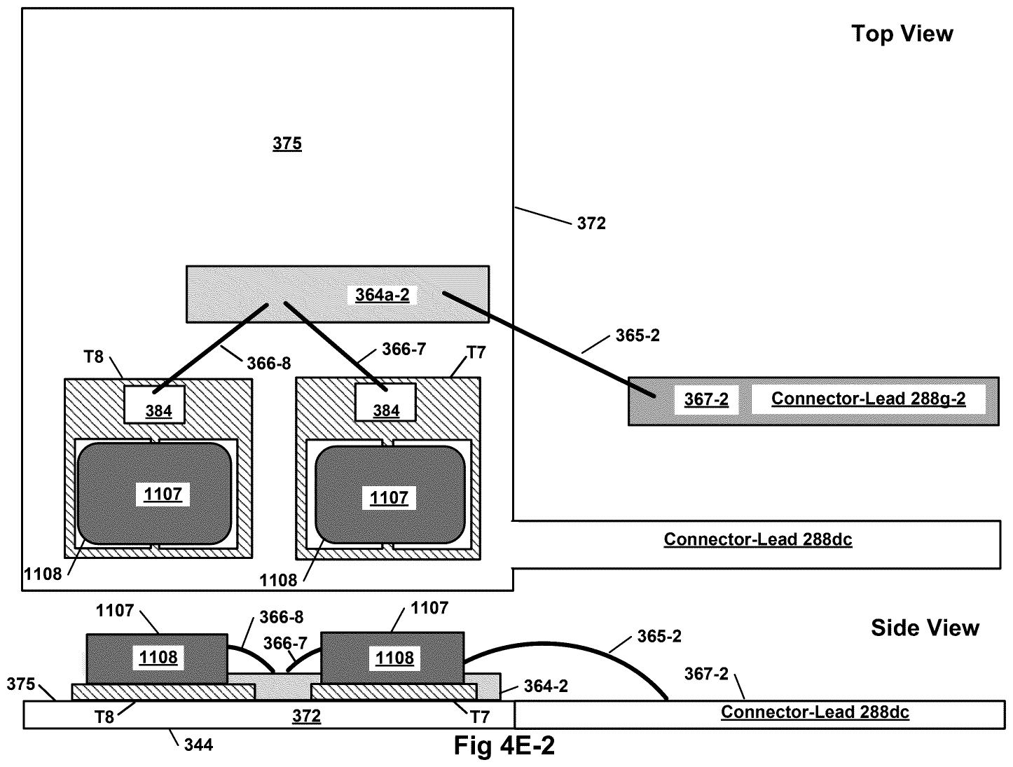

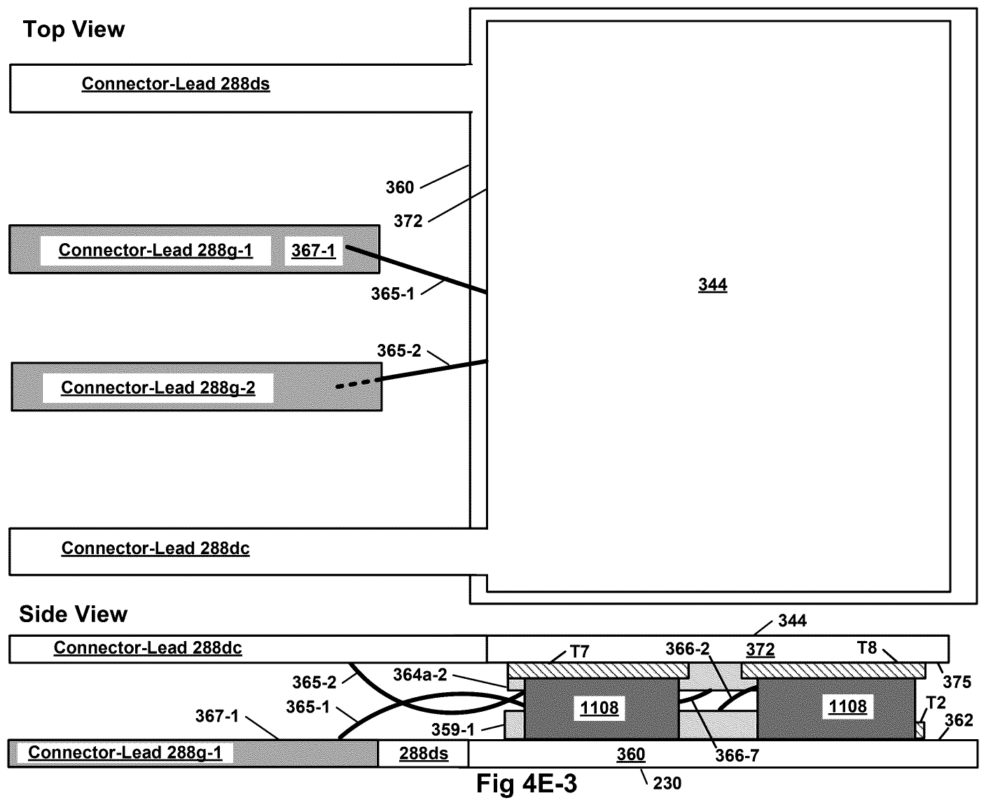

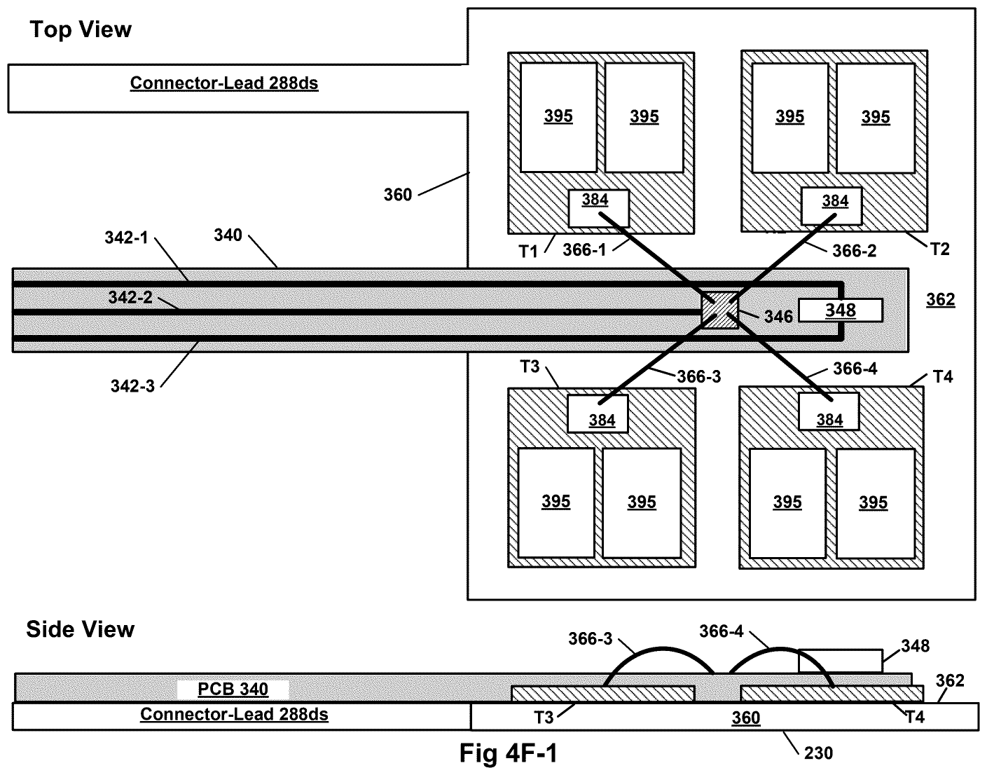

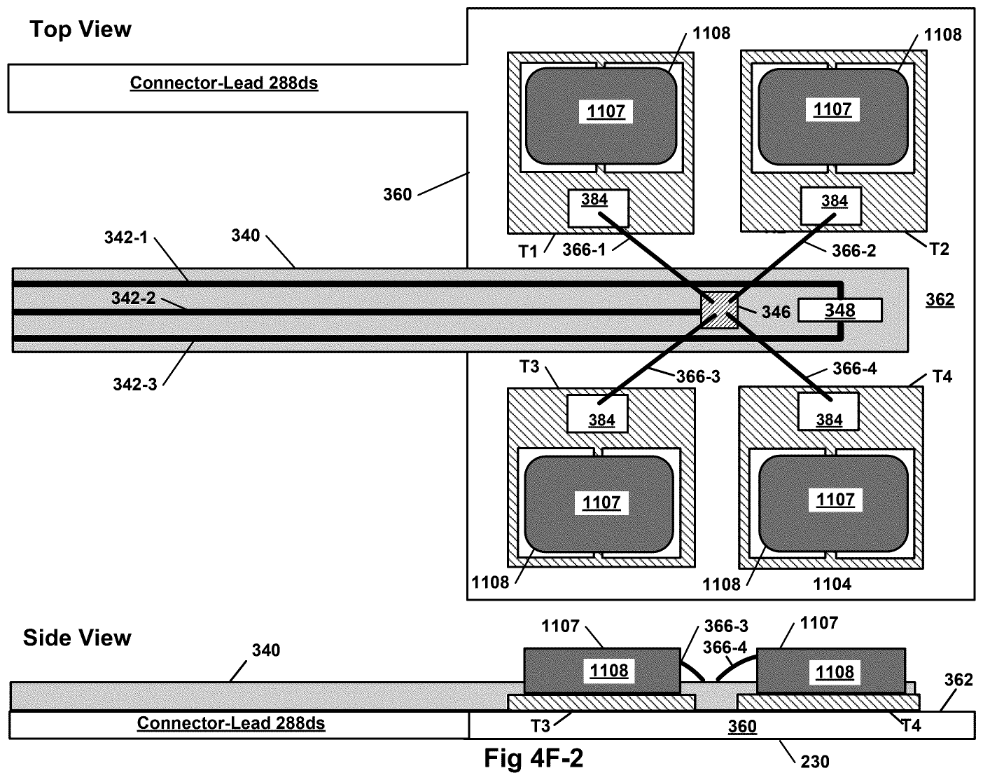

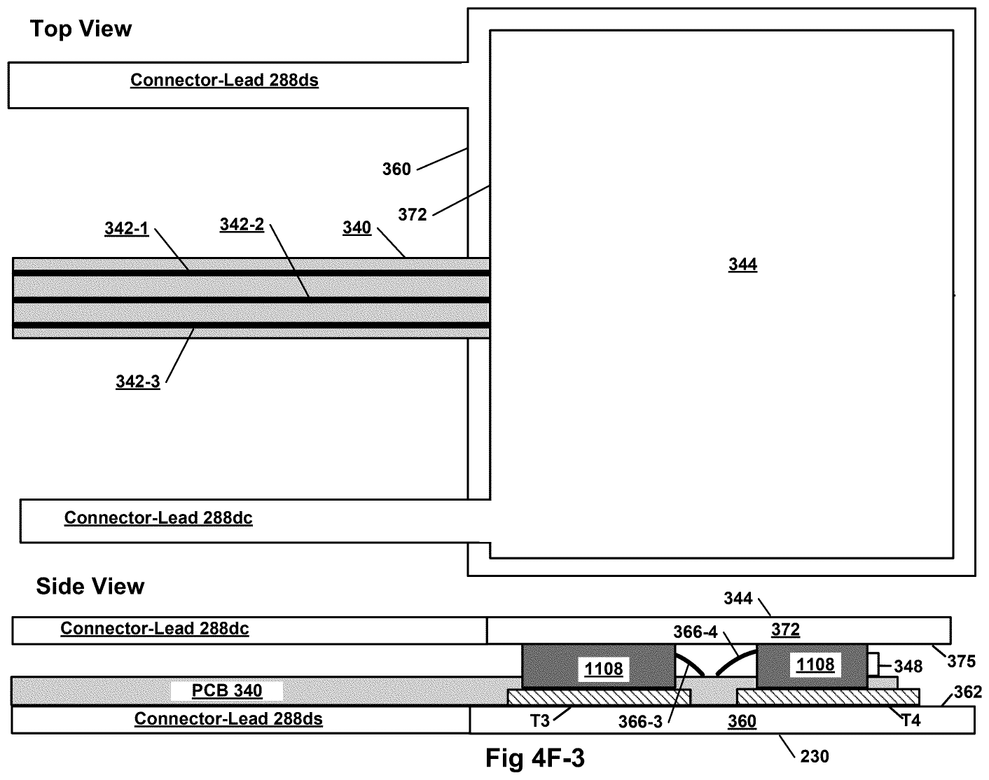

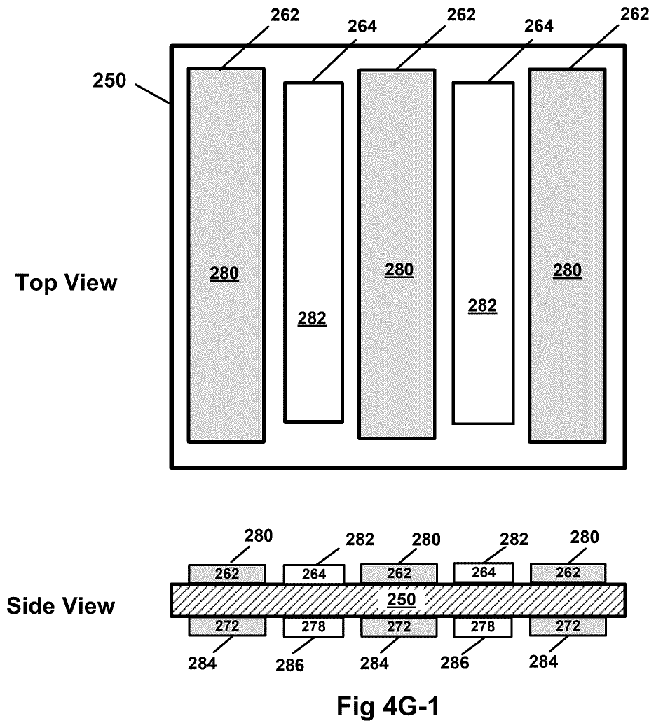

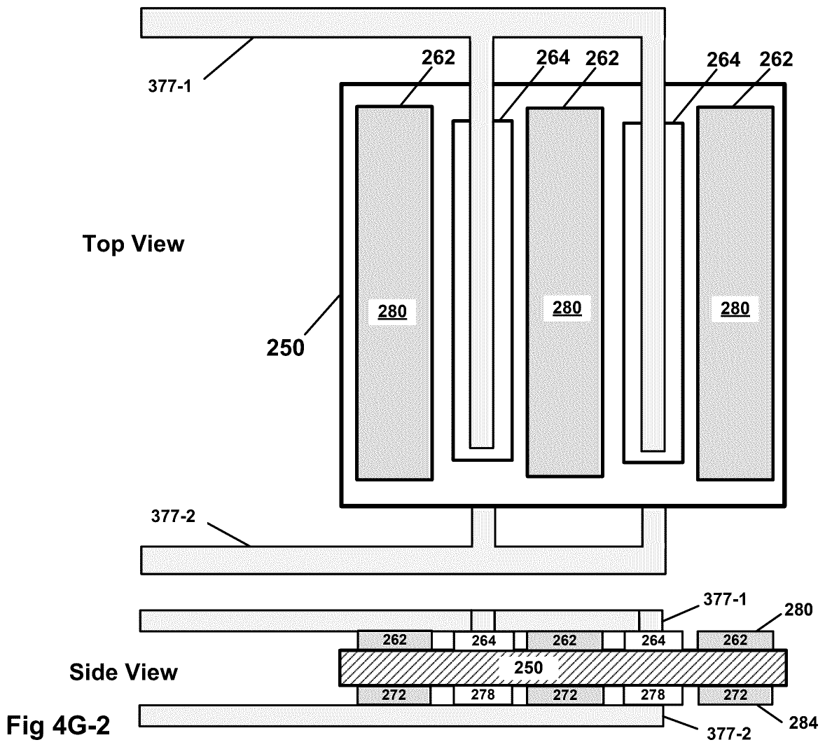

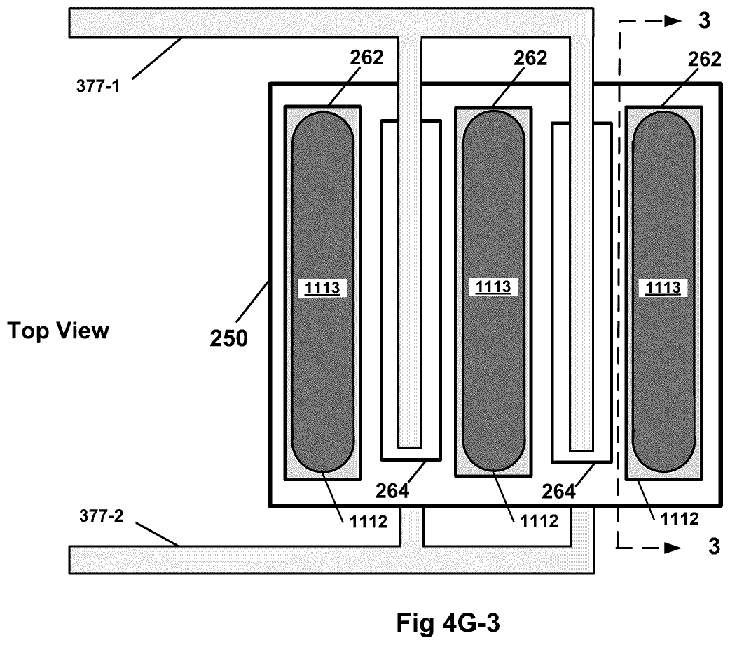

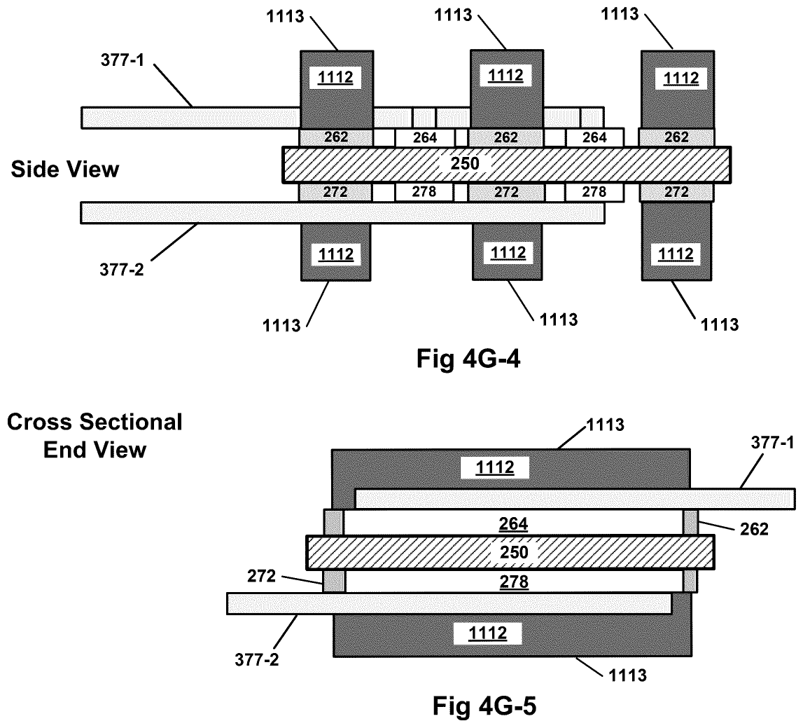

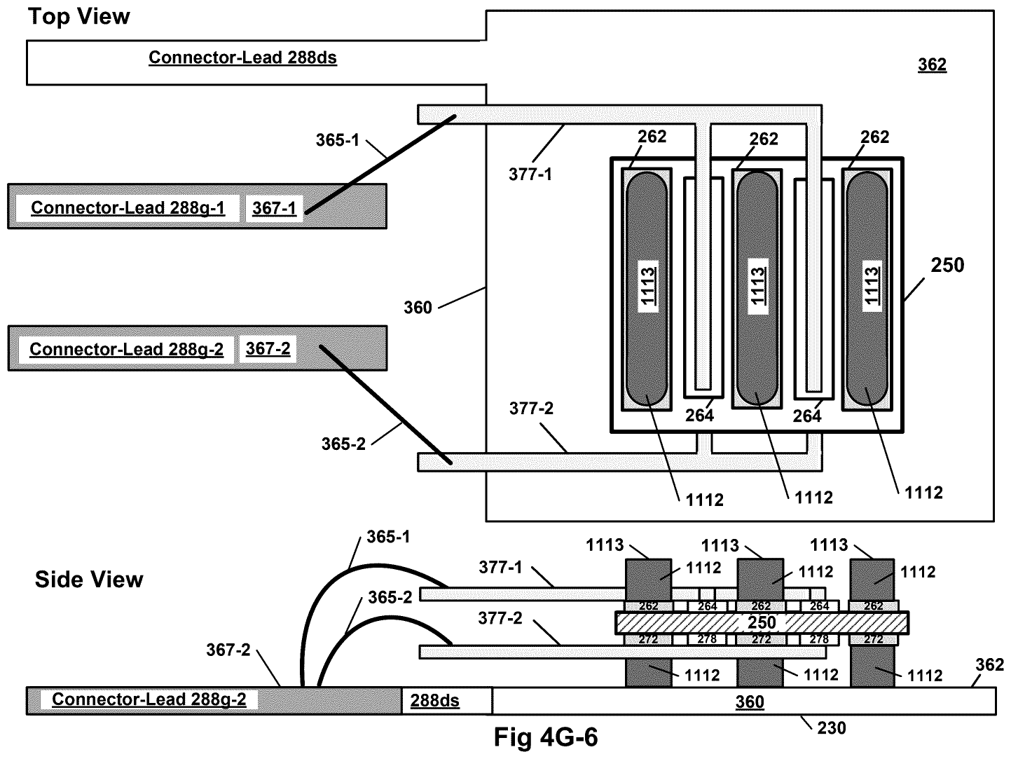

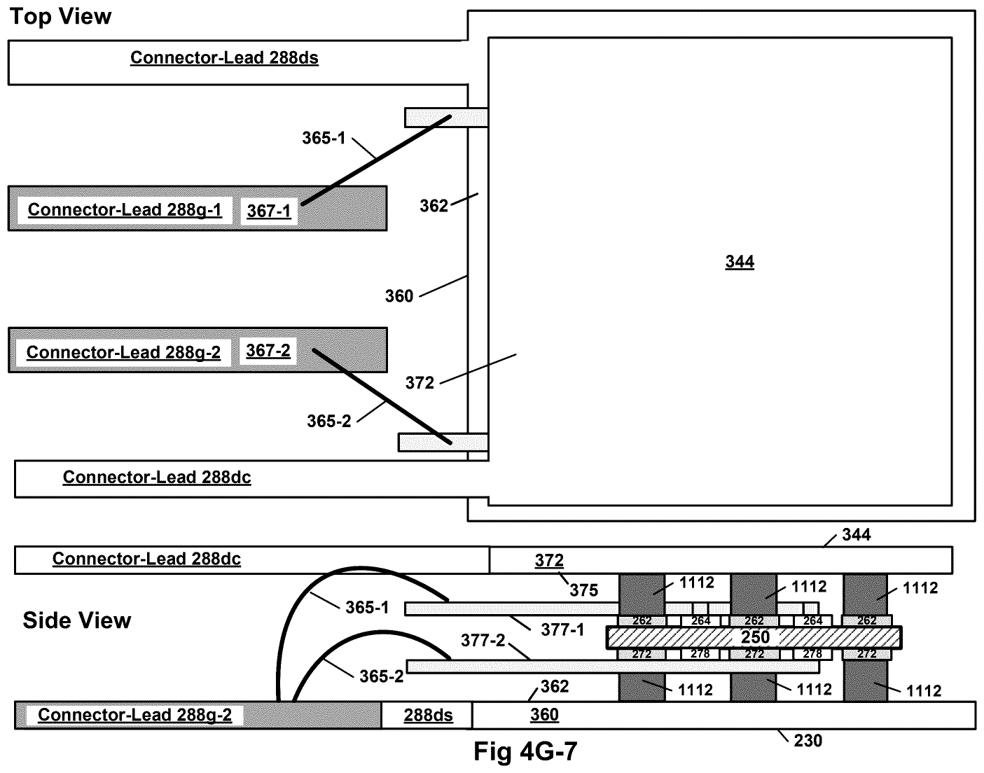

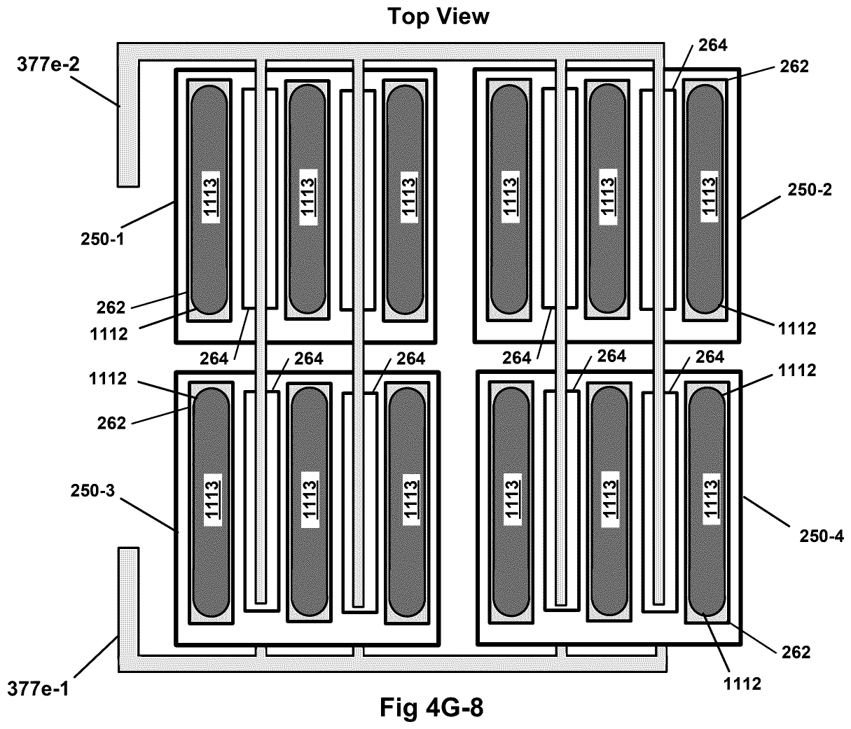

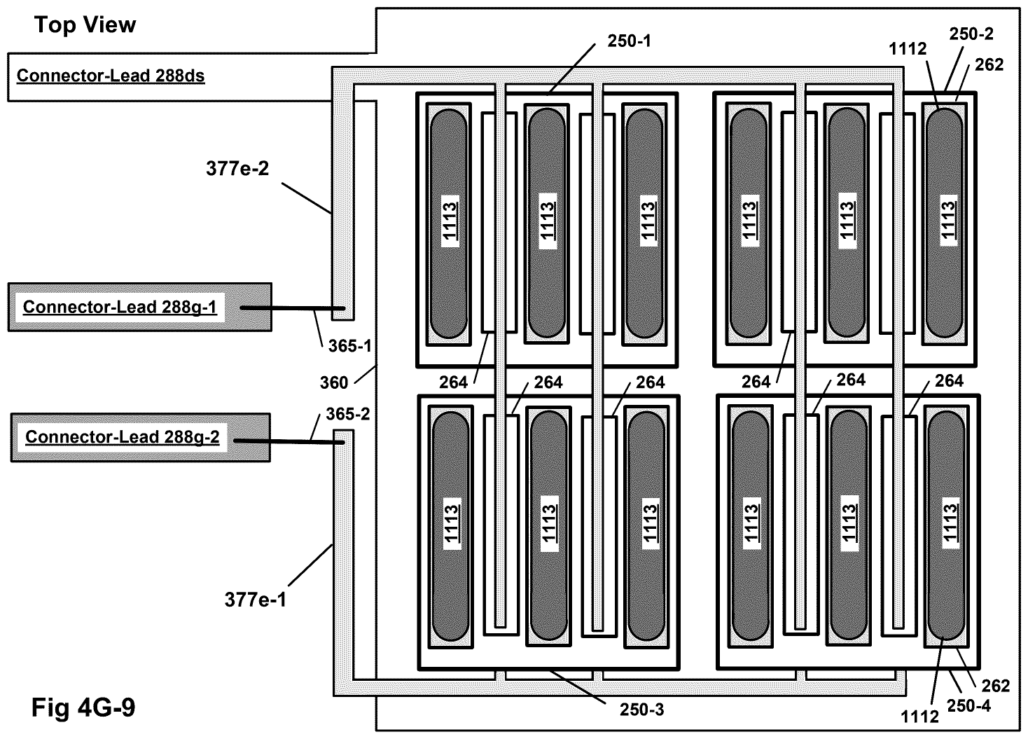

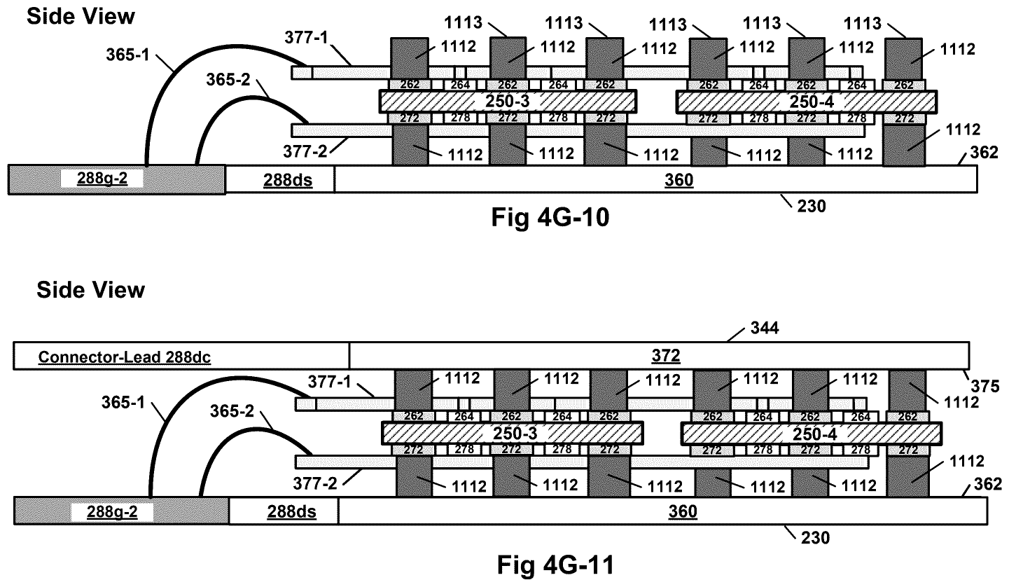

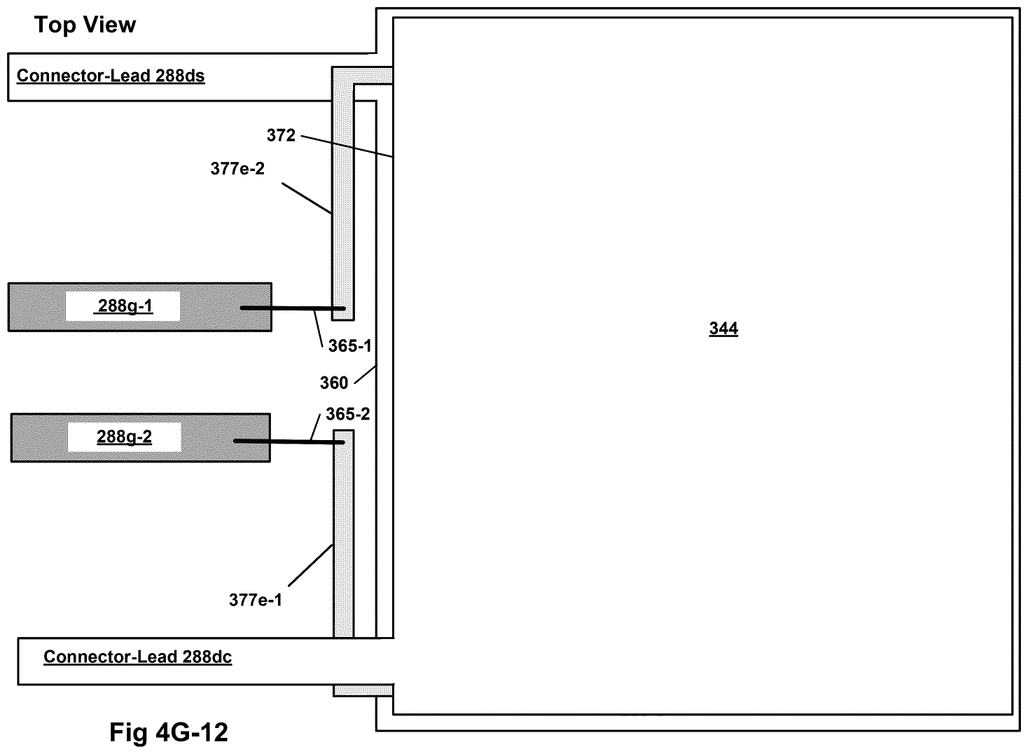

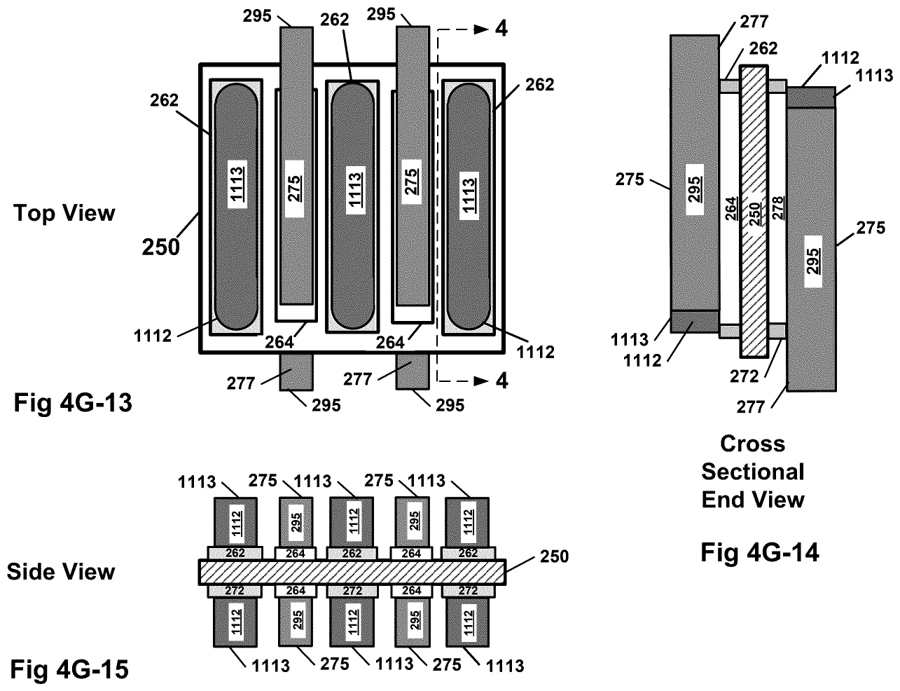

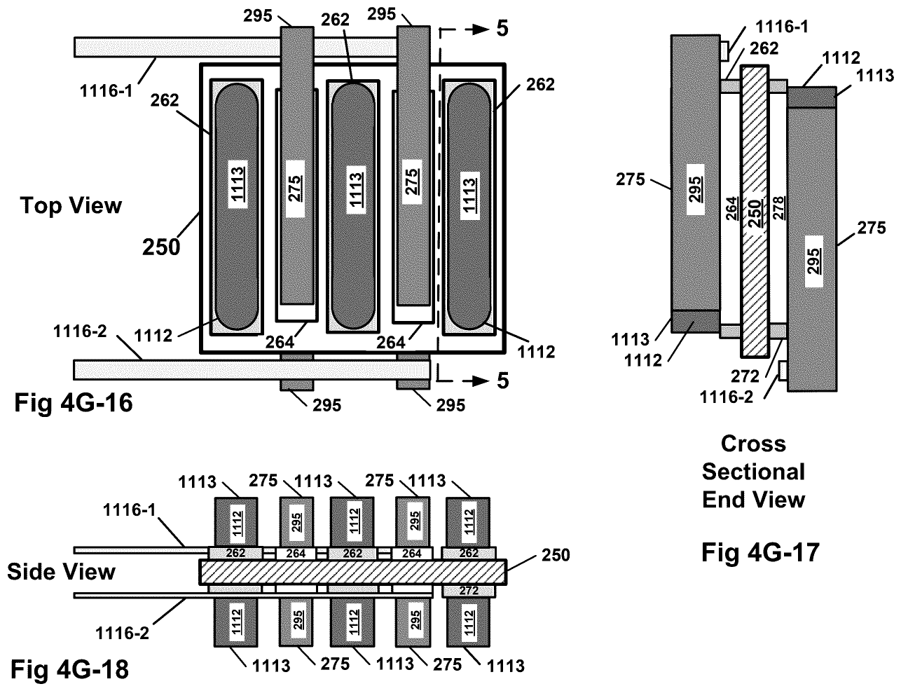

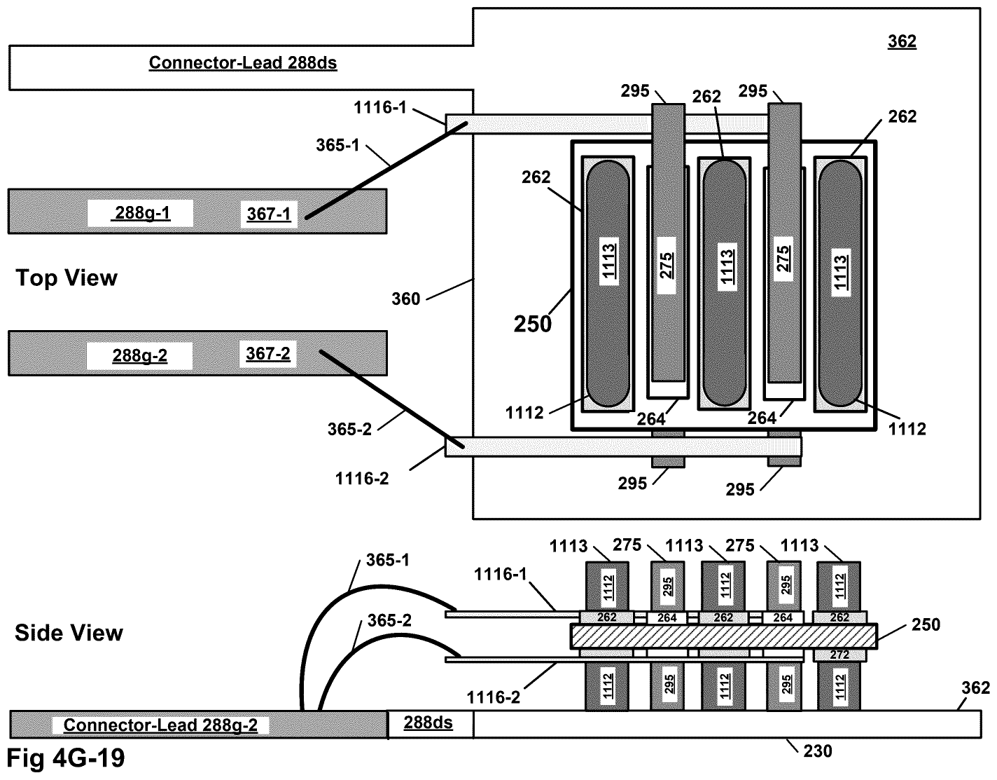

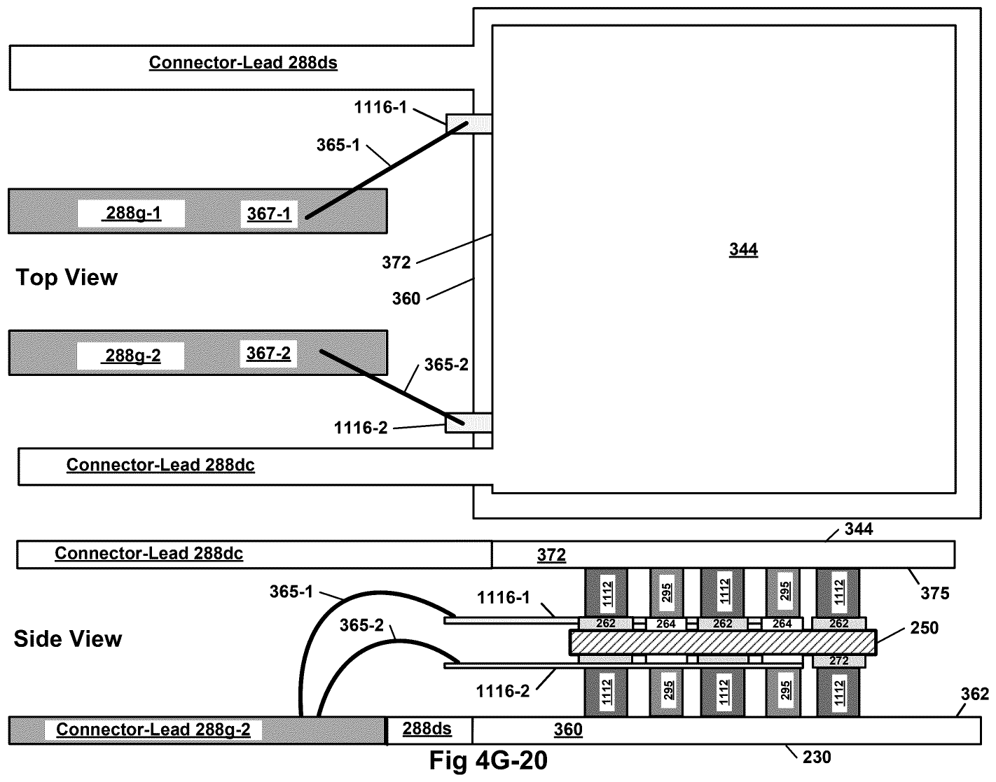

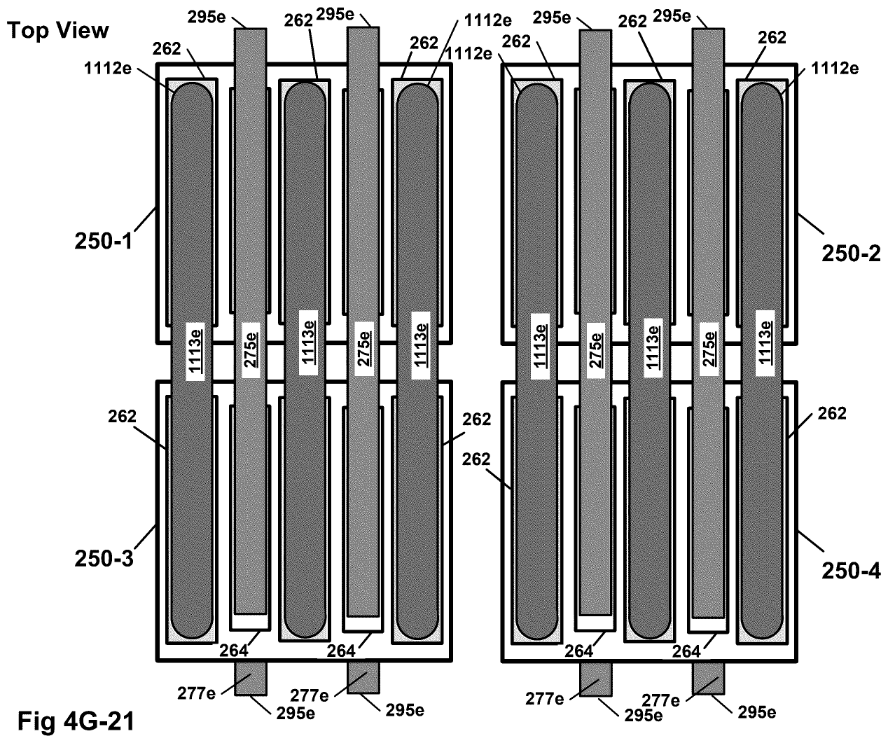

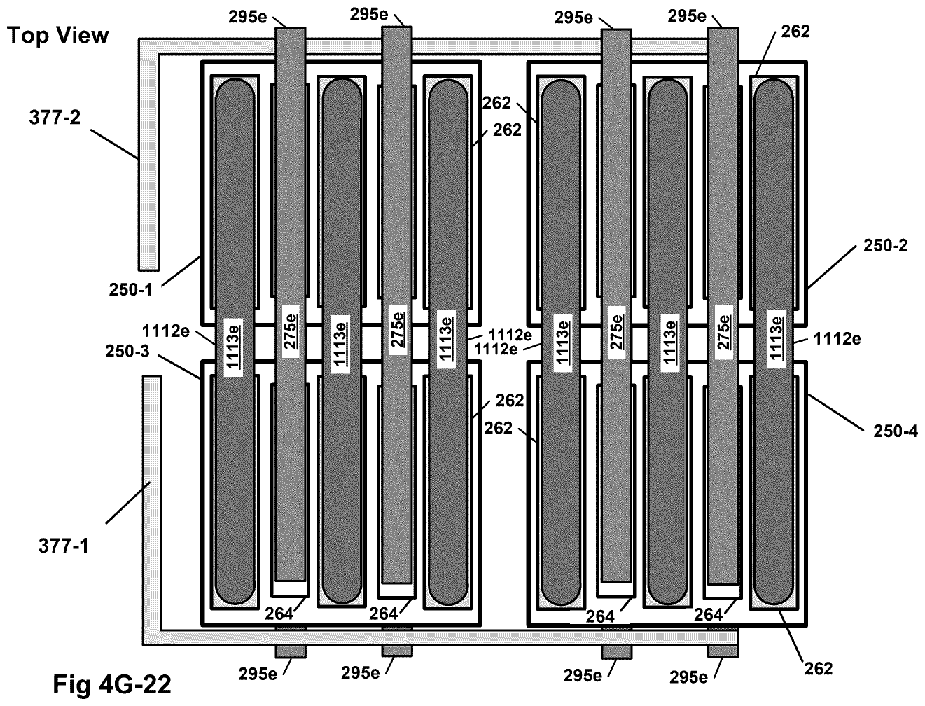

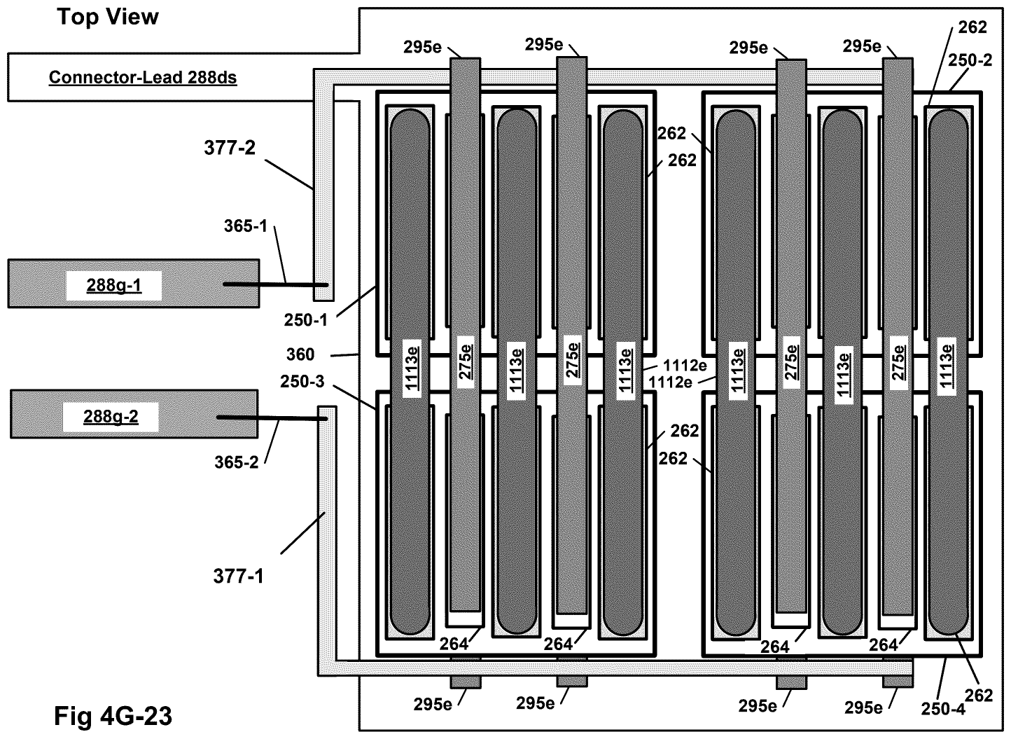

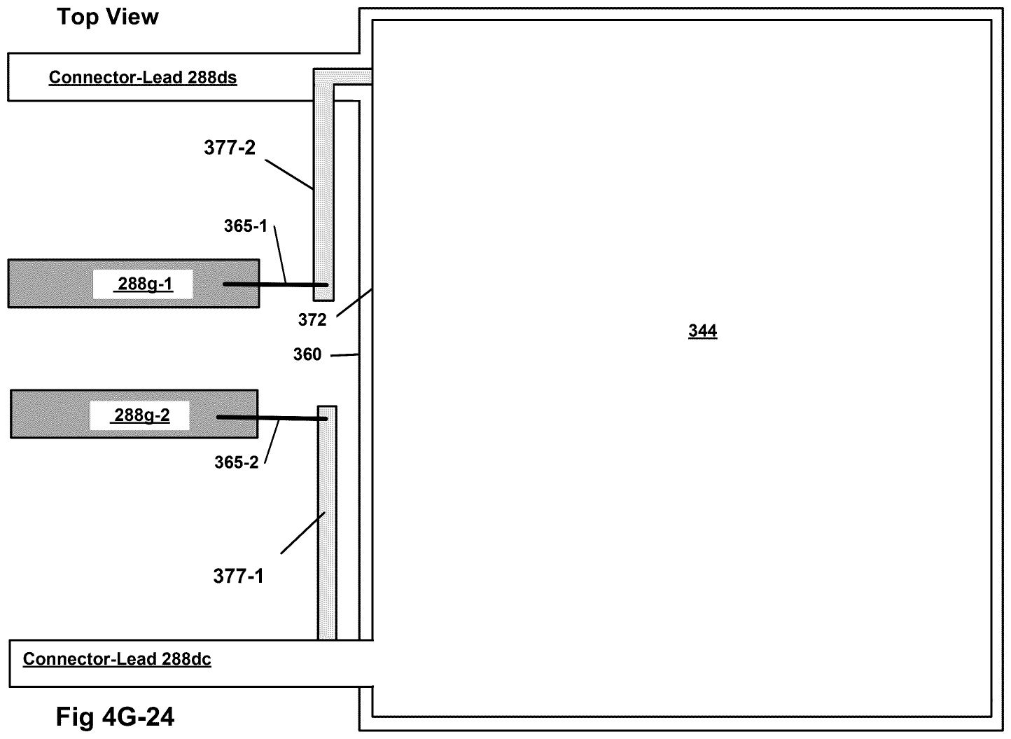

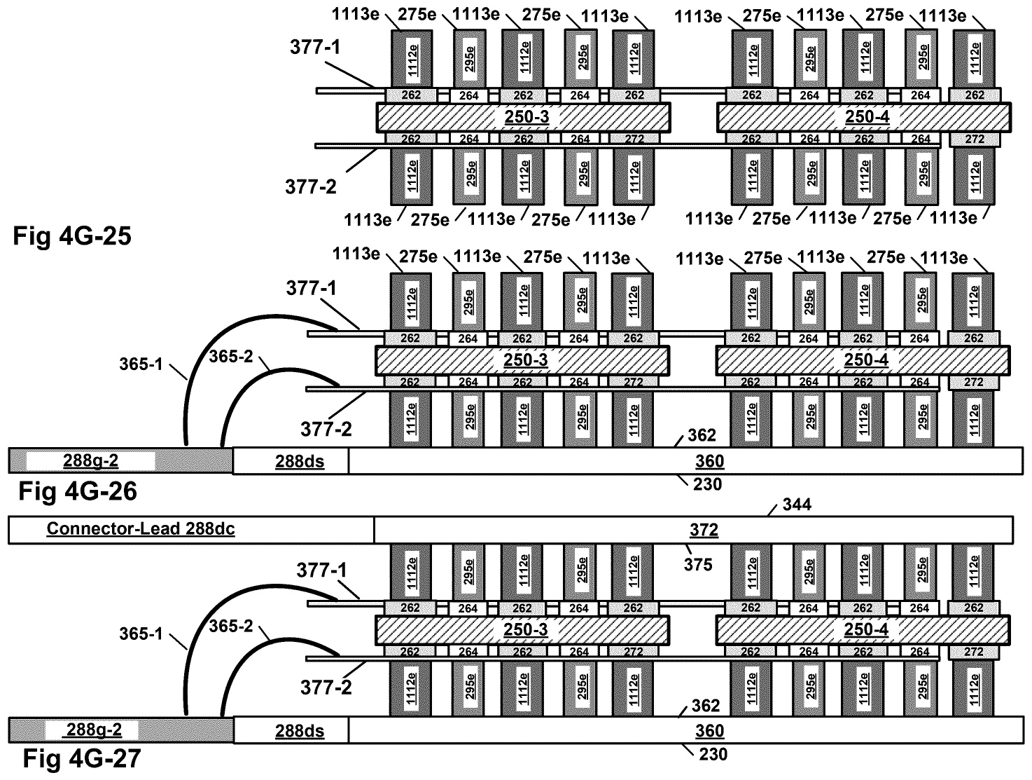

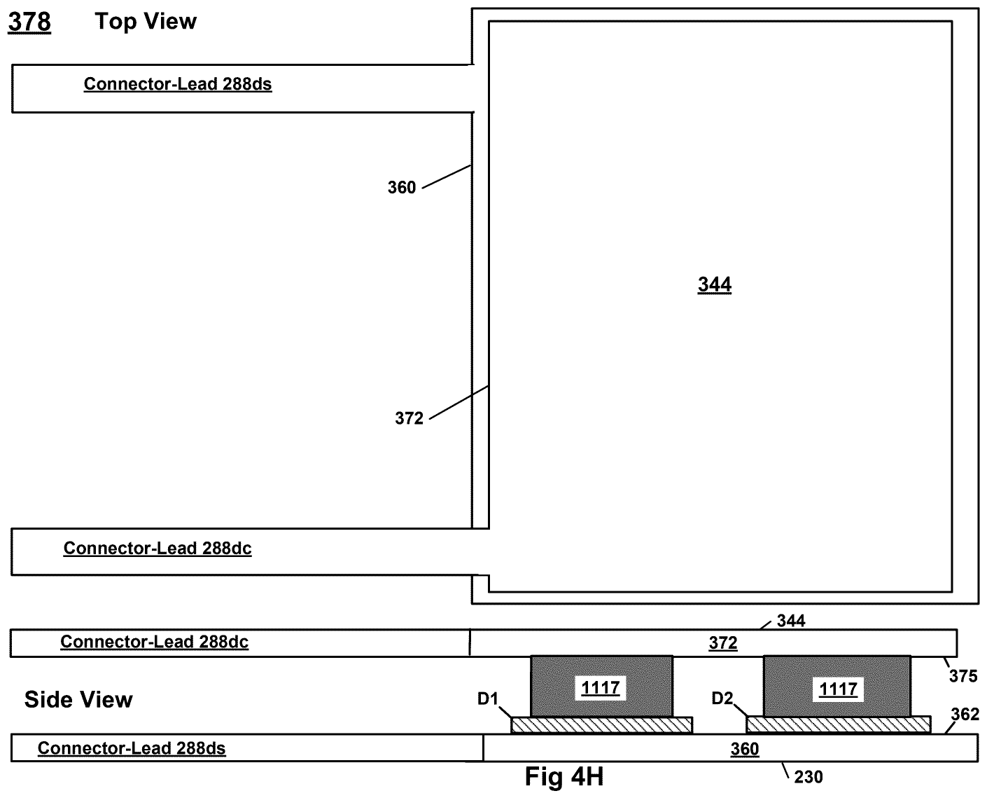

FIG. 4A-1 shows top and side views of an example die substrate 360, connector-lead 288ds, and connector-lead 288g. A die substrate may be formed (e.g., stamped, cut, sawed, diced, etc.) from a thin (e.g., 0.7 mm-1.5 mm, or less, or more) sheet of metal. A die substrate or the metal sheet from which it was formed, may have a thin outer surface layer of sintering enhancement material such as silver. A die substrate or the sheet from which a die substrate is formed, may be electroplated with a sintering enhancement material such as silver. A die substrate may be formed from a thin (e.g., 0.7 mm-1.5 mm, or less, or more) sheet like that shown in FIG. 2H or 21. Example die substrate 360 and collector-lead 288ds may be formed from a thin (e.g., 0.7 mm-1.5 mm or less) sheet like that shown in FIG. 2H or 2I. Connector-lead 288ds may be integrally connected to die substrate 360 as shown. In another version, connector-lead 288ds may be separately formed (e.g., stamped, cut, sawed, diced, etc., from a sheet of copper or other metal) and subsequently attached (e.g., soldered, welded, etc.) to die substrate 360. In yet another version, no connector-lead 288ds may be connected to die substrate 360. FIG. 4A-1 shows connector-lead 288ds integrally connected near the top edge (e.g., within 1.0 mm, or less, or more) of die substrate 360. In other embodiments, connector-lead 288ds may be connected near the middle of die substrate 360 or near the bottom edge (e.g., within 1.0 mm, or less, or more) of die substrate 360. Die substrates may be referred to as “drain paddles.”

Die substrate 360 may include opposite facing, substantially flat surfaces of equal area, one of which is designated 362 while the other defines example die substrate terminal 230. Surfaces 362 and 230 may be entirely flat and substantially parallel to each other. Die substrate terminal 230 may be configured for thermal and electrical connection to a flat surface of a device such as a bus bar as will be more fully described below.

Die substrate 360 may have a width wds around 13.5 mm, and a length lds around 16.5 mm. Connector lead 288ds may have a width around 1.2 mm, and length around 20 mm. Connector lead 288g may have a width around 1.2 mm, and length around 18 mm. Bond area 367 provides a surface where a bond-wire can be wire-bonded.

Surfaces of current terminal (e.g., drain terminal, collector terminal, cathode terminal, etc.) pads in transistors and/or diodes may be electrically and thermally attached (e.g., sintered, soldered, etc.) directly to surface 362 of die substrate 360. For example, flat first current terminal (e.g., drain terminal, collector terminal, cathode terminal, anode-2 terminal, etc.) pad surface(s) of switches 304 or diode(s) D shown in FIGS. 3A-3F, 3H-3K, 3M-3P may be electrically and thermally attached directly to surface 362.

The dimensions (i.e., width wds and length lds) of die substrate 360 may depend on the number and/or type of transistors and/or diodes in a switch 304 to which it is connected. For example, the area of surface 362 needed to fit a switch with four BBJTs or four IGBTs electrically connected in parallel may be larger than the area of surface 362 needed to fit a switch with four MOSFETs electrically connected in parallel, or the area needed to fit a switch with four MOSFETs electrically connected in parallel may be smaller than the area of surface 362 needed to fit a switch with two MOSFETs and two IGBTs electrically connected in parallel, assuming IGBT dies may be larger in size than MOSFET dies. The area of surface 362 needed to fit a switch with four IGBTs electrically connected in parallel may be larger than the area of surface 362 needed to fit a switch with four IGBTS electrically connected in parallel, and four diodes electrically connected in parallel between the four IGBTs. The area of surface 362 needed to fit a switch with four IGBTs electrically connected in parallel may be larger than the area of surface 362 needed to fit a three IGBTs and one MOSFET electrically connected in parallel. For ease of illustration and description, the dimensions (length and width) of transistor dies may be presumed equal regardless of transistor type, unless obvious or otherwise noted.

Transistors can be electrically and thermally attached (e.g., sintered, soldered, etc.) directly to surface 362. FIG. 4A-2-1 shows the die substrate 360 of FIG. 4A-1 after four transistors T1-T4 are electrically and thermally attached (e.g., sintered, soldered, etc.) directly to surface 362. More specifically flat surfaces of first current terminal (e.g., drain terminal, collector terminal, etc., not shown) pads of transistors T1-T4 are attached to surface 362. Flat surfaces of first current terminal pads can be sintered directly to flat surface 362, using sinter paste or preform, or flat surfaces of first current terminal pads can be soldered directly to flat surface 362, using solder paste or preform. A preform may be flat like a film or plate. A sinter preform may be a compacted mixture of metal powders that is heated to fuse the particles. For purposes of explanation only, transistors T1-T4 are presumed sintered to surface 362 using sinter preform.

A low resistance path may exist between die substrate terminal 230 and each first current terminal pad. Each die substrate joint (e.g., sintered joint, not shown) in FIG. 4A-2-1 that connects a first current terminal pad surface to surface 362 may conduct 1, 2, 5, 10, 20, 50, 100, 200, 300, 750 Watts or more of heat while concurrently conducting 1, 5, 10, 50, 100, 200, 400 A or more of electrical current. Each die substrate joint may have a length and width that may be substantially equal to the length and width of a respective first current terminal pad surface.

T1-T4 may be transistors of the same type, or T1-T4 may include a mixture of different types of transistors. For example, T1-T4 may be MOSFETs, and the flat surfaces of drain terminal pads in T1-T4 may be sintered to surface 362. T1-T4 may be IGBTs, and the flat surfaces of collector terminal pads in T1-T4 may be sintered to surface 362. T1 and T2 may be MOSFETs, and T3 and T4 may be IGBTs. In this version flat surfaces of drain terminal pads in T1 and T2 may be sintered to surface 362, and flat surfaces of collector terminal pads in T3 and T4 may be sintered to surface 362. In another example, T1 may be a MOSFET, and T2-T3 may be IGBTs. In this version flat surface of the drain terminal pad in T1 may be sintered to surface 362, and flat surfaces of collector terminal pads in T2-T4 may be sintered to surface 362. In another version, one of the transistors (e.g., T1) can be replaced by a diode, while three other transistors (e.g., T2-T4) take form in IGBTs, or two of the transistors (e.g., T1 and T2) can be replaced by diodes, while two other transistors (e.g., T3 and T4) take form in IGBTs. In this version, flat collector terminal pad surfaces of the IGBTs and the flat cathode terminal pad surface of the diode(s) can be sintered to surface 362.

Each of the transistors T1-T4 may include a pair of second current terminal (e.g., source terminal, emitter terminal, etc.) pads, it being understood that transistors may have fewer or more than a pair of second current terminal pads. Each second current terminal pad may have an outwardly facing flat surface. Example flat second current terminal pad surfaces 395 are shown. The size, shape or number of surfaces 395 may vary from semiconductor-to-semiconductor manufacturer. Each of the transistors T1-T4 may include a control terminal (e.g., gate terminal) pad with a flat surface. Example control terminal pad surfaces 384 are shown. The size, shape or number of surfaces 384 may vary from semiconductor-to-semiconductor manufacturer. The pads are not shown in the side view of FIG. 4A-2-1.

FIG. 4A-2-1 shows an example gate strap 364a, bond-wire 365, and bond-wires 366. A gate strap 364, like gate strap 364a, may be formed of a conductive metal such as copper, and may have a platelike structure with oppositely facing flat and parallel surfaces. A bottom flat surface of a gate strap 364, such as gate strap 364a, may be attached to surface 362 through an electrically insulating material (not shown) thereby electrically isolating gate strap 364 (e.g., 364a) from die substrate 360. Connector-lead 288g may be electrically connected to a gate strap, such as gate strap 364a through bond-wire 365 as shown. Bond-wires 366 of substantially equal length may electrically connect gate strap 364a to respective surfaces 384 of the control terminal pads. Each of the bond-wires 366 may be wire-bonded to strap 364a at substantially equal distances from the point on strap 364a where bond-wire 365 is wire-bonded. In an alternative version an end of a length-extended connector-lead 288g may be attached (e.g., soldered, welded, etc.) to strap 364a. In still another alternative version gate strap 364a is removed, and a flat surface at an end of a length-extended connector-lead 288g may be attached to surface 362 through an electrically insulating layer thereby electrically isolating length-extended connector-lead 288 from die substrate 360. Bond-wires of substantially equal length wire bonded to an outward facing flat surface of the length-extended connector-lead 288g, can electrically connect length-extended connector-lead 288g to respective surfaces 384 of control terminal pads.

FIG. 4A-2-2 shows the structure of FIG. 4A-2-1 with gate strap 364a replaced by gate strap 364b, which may take form in a trace formed on a surface of a PCB (not shown). The flat opposite surface of the PCB upon which gate strap 364b may be formed, may be attached (e.g., glued) to surface 362 of die substrate 360. Gate strap 364b may include a bond pad P1 electrically connected to bond pads P2-P5 through a serpentined section 369 and a spoked section 370. Section 369 may have a substantially constant width (e.g., 0.1, 0.01, 0.001 mm or less) over its length between pad P1 and second 370. Electrical resistance between pad P1 and section 370 depends on the length of section 369. The length and width of serpentined section 370 may vary depending on the type and/or manufacturer of transistors T1-T4. The spokes of section 370 may have substantially the same width and length, where spoke length may be measured from a center point of section 370 to a point where the spokes connect to respective pads P2-P5. Bond-wires 366-1-366-4 of substantially equal length may be wire bonded between pads P2-P5, respectively, and surfaces 384 of transistors T1-T4, respectively. Bond-wires 366-1-366-4 may be wired bonded to pads P2-P5 at respective points that may be substantially equal distance from the center point of section 370. The electrical resistance between a point on connector-lead 288g and each of the points on surfaces 384 where respective bond-wires may be wire bonded, should be substantially equal.

FIG. 4A-2-3 shows the structure of FIG. 4A-2-1 with gate strap 364a replaced by gate straps 364d and 364e, which may take form in traces formed on a surface of a PCB (not shown). The flat opposite surface of the PCB upon which gate straps 364d and 364e may be formed, may be attached (e.g., glued) to surface 362 of die substrate 360. Gate straps 364d and 364e should be electrically isolated from die substrate. A packaged resistor R can be electrically connected between gate straps 364d and 364e. For example, leads of resistor R can be electrically connected to respective gate straps 364d and 364e as shown.

The structure shown in 4A-2-1 employed in devices described below may be replaced with the structure shown in FIG. 4A-2-2 or FIG. 4A-2-3.

Pedestals can be electrically and thermally attached (e.g., sintered, soldered, etc.) directly to transistors using, for example, sinter paste or sinter preform. FIG. 4A-3 shows the structure of FIG. 4A-2-1 after example pedestals 1104 are electrically and thermally attached (e.g., sintered, soldered, etc.) directly to respective surfaces 395 of the second current terminal pads in transistors T1-T4. In an alternative process, pedestals, including pedestals 1104, may be electrically and thermally attached (e.g., sintered, soldered, etc.) directly to a flat surface of a die clip, such as any of the die clips 372 shown in FIGS. 4A-4-1-4A-4-4 and described below, before the pedestals are electrically and thermally attached to respective surfaces, such as surfaces 395, of terminal pads, such as second current terminal pads in transistors T1-T4. In yet another alternative process, pedestals, including pedestals 1104, may be simultaneously attached (e.g., sintered, soldered, etc.) directly to a flat surface of a die clip, such as any of the die clips 372 shown in FIGS. 4A-4-1-4A-4-4 and described below, and respective surfaces, such as surfaces 395, of terminal pads, such as second current terminal pads in transistors T1-T4.

Pedestals, including pedestals 1104, may be formed from thin (e.g., 1.0 mm-1.2 mm, or less, or more) sheets like that shown in FIG. 2H or 21. Pedestals 1104 may have a width around 1.65 mm and a length around 2.8 mm. Pedestals may have opposite facing first and second end surfaces that may be entirely flat and parallel to each other. Only flat first end surfaces 1101 are shown in FIG. 4A-3. The first and second flat end surfaces of a pedestal, including pedestal 1104, may have the same size and shape. The flat end surfaces of pedestals, such as pedestals 1104, can be electrically and thermally attached (e.g., sintered, soldered, etc.) directly to flat surfaces of respective second current terminal pads. For example, the second flat end surfaces of pedestals 1104 can be sintered directly to flat surfaces 395 using sinter paste or preform, or the second flat end surfaces of pedestals 1104 can be soldered directly to flat surfaces 395 using solder paste or preform. Other methods of attachment can be used.

The second flat end surfaces of pedestals 1104 may have a shape (e.g., rectangular with squared corners, rectangular with rounded corners, etc.) like the shape (e.g., rectangular with squared corners) of flat surfaces 395. The width (e.g., around 2.8 mm) and length (e.g., around 1.65 mm) of the second flat end surfaces of pedestals 1104 may be equal to, slightly greater, or slightly smaller than the width and length, respectively, of the flat surfaces 395 of respective second current terminal pads to which the second flat end surfaces may be electrically and thermally attached so that the second flat end surfaces contact all or most (i.e., 51%-99%) of respective flat surfaces 395 through a connection material (e.g., sintering material, soldering material, etc.). A slightly smaller area may ensure that pedestals 1104 do not contact transistors T1-T4 outside the areas occupied by second current terminal (e.g., source terminal) pads. Second flat end surfaces of pedestals 1104 may more evenly distribute mechanical stress. Pedestals, including pedestals 1104, may reduce current flux (i.e., current density) through source terminal pad surfaces 395 when compared to the current flux that flows through small area(s) on source terminal pad surfaces that are connected to bond-wire(s). Each second joint or connection (e.g., sintered connection, soldered connection, etc.) that connects a second current terminal pad surface 395 to a second flat end surface of a pedestal 1104, and each pedestal 1104, may conduct 1, 2, 5, 10, 20, 50, 100, 200, 350 Watts or more of heat while concurrently conducting 1, 5, 10, 20, 50, 100, 200 A or more of electrical current. Each of these second joints or connections may have a length and width that may be substantially equal to the length and width of the respective second flat end surface of pedestals 1104. First flat end surfaces of pedestals, including surfaces 1101 in FIG. 4A-3, may be contained in a common plane to accommodate their attachment to a flat surface of, for example, a die clip. Pedestals, including pedestals 1104, in a module can have different thicknesses between their flat end surfaces to accommodate transistors with current terminal pad surfaces of different heights measured with respect to surface 362, to put first end surfaces of the pedestals in a common plane so that they can be electrically and thermally attached to a flat surface of, for example, a die clip.

Transistors and/or diodes may be electrically and thermally connected to a die clip. A die clip may be formed (e.g., stamped, cut, sawed, diced, etc.) from a thin (e.g., 0.7 mm-1.5 mm, or less, or more) sheet of metal. A die clip or the sheet from which a die clip is formed, may have a thin outer surface layer of sintering enhancement material such as silver. A die clip or the sheet from which a die clip is formed, may be electroplated with a sintering enhancement material such as silver. A die clip may be formed (e.g., stamped, cut, sawed, diced, etc.) from a thin (e.g., 0.7 mm-1.5 mm, or less, or more) sheet of metal like that shown in FIG. 2H or 2I. FIG. 4A-4-1 shows top and side views of an example die clip 372 and example connector-lead 288dc. Die clip 372 may be formed (e.g., stamped, cut, sawed, diced, etc.) from a thin (e.g., 0.7 mm-1.5 mm, or less or more) sheet like that shown in FIG. 2H or 2I. Connector-lead 288dc may be integrally connected to die clip 372 as shown. In another version, connector-lead 288dc may be separately formed and subsequently attached (e.g., soldered, welded, etc.) to die clip 372. In yet another version, no connector-lead 288dc is connected to die clip 372. Die clips may be referred to as “source paddles.”

Die clip 372 may include opposite facing, substantially flat surfaces 344 and 375 of substantially equal area. Surfaces 344 and 375 may be entirely flat and substantially parallel to each other. Surface 344 defines an example die clip terminal 344 and may be configured for thermal and electrical connection to a flat surface of a device such as a bus bar as will be more fully described below. Surface 375 can be electrically and thermally connected (e.g., sintered, soldered, etc.) directly to pedestals, current terminal pads, etc.

In one version, die clip 372 has a width wdc around 13.0 mm, and a length ldc around 16.0 mm. Connector-lead 288dc may have a width around 1.2 mm, and length around 20 mm. Like die substrates, the size of die clip 372 can be adjusted to accommodate the number and/or type of transistors in a switch 304 to which it may be connected. For example, the area of surface 375 needed to fit a switch with four IGBTs electrically connected in parallel or four BBJTs electrically connected in parallel, may be larger or smaller than the area of surface 375 needed to fit a switch with four MOSFETs electrically connected in parallel, or the area needed to fit a switch with four MOSFETs electrically connected in parallel may be smaller than the area of surface 375 needed to fit a switch with two MOSFETs and two IGBTs electrically connected in parallel, assuming IGBT dies are larger in size than MOSFET dies.

FIG. 4A-4-2 shows top and side views of an example die clip 372, connector-lead 288dc, and connector lead 288bdc, which can be formed (e.g., stamped, cut, sawed, diced, etc.) from a thin (e.g., 0.7 mm-1.5 mm, or more, or less) sheet like that shown in FIG. 2H or 2I. The die clip shown in FIG. 4A-4-2 is like the die clip shown in FIG. 4A-4-1, but with added width wbdc to create connector-lead 288bdc. In another version, connector-lead 288bdc may be separately formed and subsequently attached (e.g., soldered, welded, etc.) to die clip 372 of FIG. 4A-4-1. Connector-lead 288dc may have a width wbdc around 10.0 mm. A substantially flat top surface of connector-lead 288bdc is contained in the same plane as die clip terminal 344, the combination of which is parallel to a substantially flat bottom surface of connector-lead 288bdc that is contained in the same plane as surface 375.

FIG. 4A-4-3 shows top and side views of an example die clip 372 and example connector-lead 288dcl, which can be formed (e.g., stamped, cut, sawed, diced, etc.) from a thin (e.g., 0.7 mm-1.5 mm, or more, or less) sheet like that shown in FIG. 2H or 2I. Connector-lead 288dcl may have a width ifdc around 6 mm, and length around 20 mm. Connector-lead 288dcl may be integrally connected to die clip 372 as shown. In another version, connector-lead 288dcl may be separately formed and subsequently attached (e.g., soldered, welded, etc.) to die clip 372.

FIG. 4A-4-4 shows top and side views of an example die clip 372 and example connector-lead 288dcr, which can be formed (e.g., stamped, cut, sawed, diced, etc.) from a thin (e.g., 0.7 mm-1.5 mm, or less, or more) sheet like that shown in FIG. 2H or 2I. Connector-lead 288dcr may have a width around 6 mm, and length around 20 mm. Connector-lead 288fdcl may be integrally connected to die clip 372 as shown. In another version, connector-lead 288dcl may be separately formed and subsequently attached (e.g., soldered, welded, etc.) to die clip 372.

A surface of a component such as a pedestal, including pedestal 1104, may be electrically and thermally attached (e.g., sintered, soldered, etc.) directly to a flat surface of a die clip. For example, first flat end surfaces of pedestals, such as surfaces 1101 shown in FIG. 4A-3, can be electrically and thermally connected (e.g., sintered, soldered, etc.) directly to surface 375. In some versions a flat current terminal pad surface of transistor and/or diode may be electrically and thermally connected (e.g., sintered, soldered, etc.) directly to surface 375. For example, flat pad surfaces of drain terminals may be sintered to surface 375 of a die clip 372 formed from a thin (e.g., 0.7 mm-1.5 mm, or more, or less) sheet like that shown in FIG. 2H or 2I. The Width wdc and/or length Idc may increase or decrease depending on the number of transistors connected in parallel or anti-parallel in a switch.

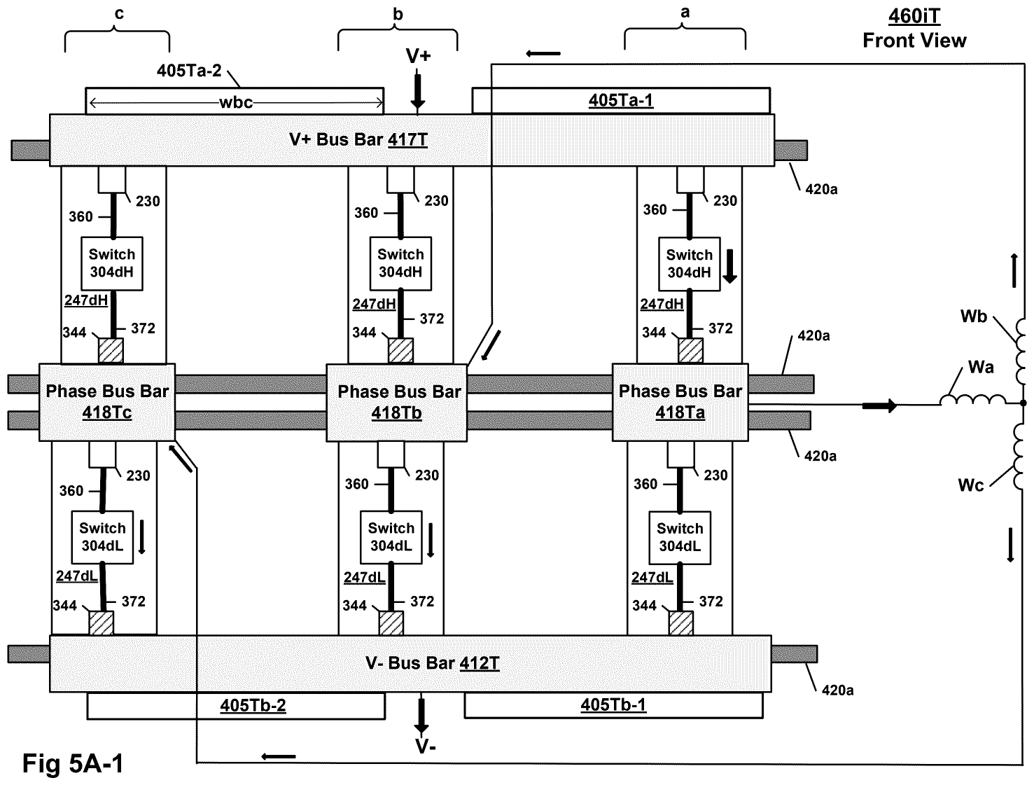

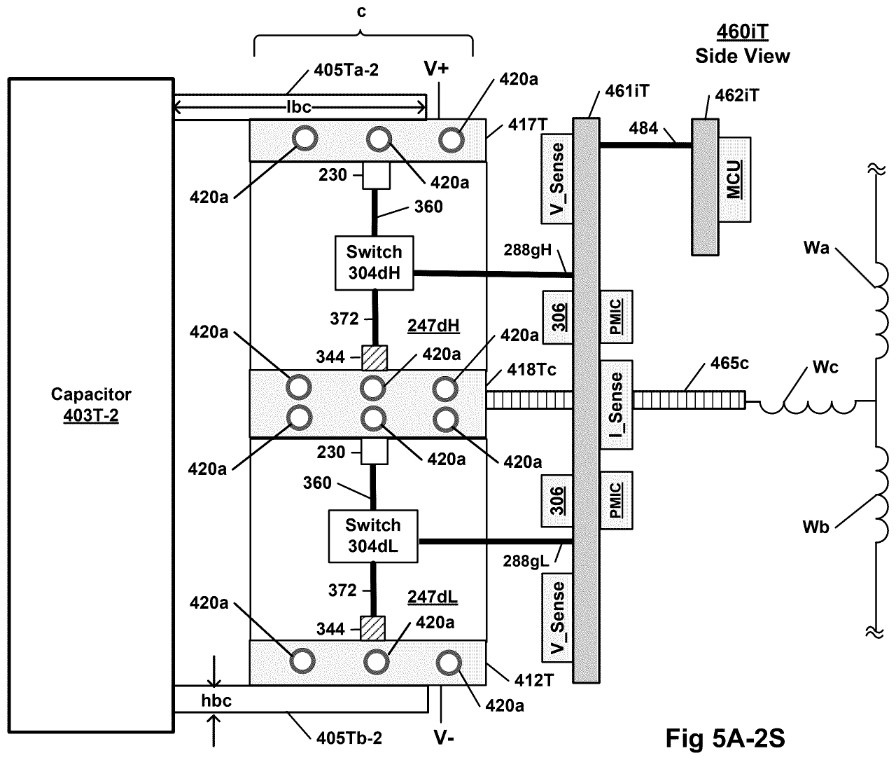

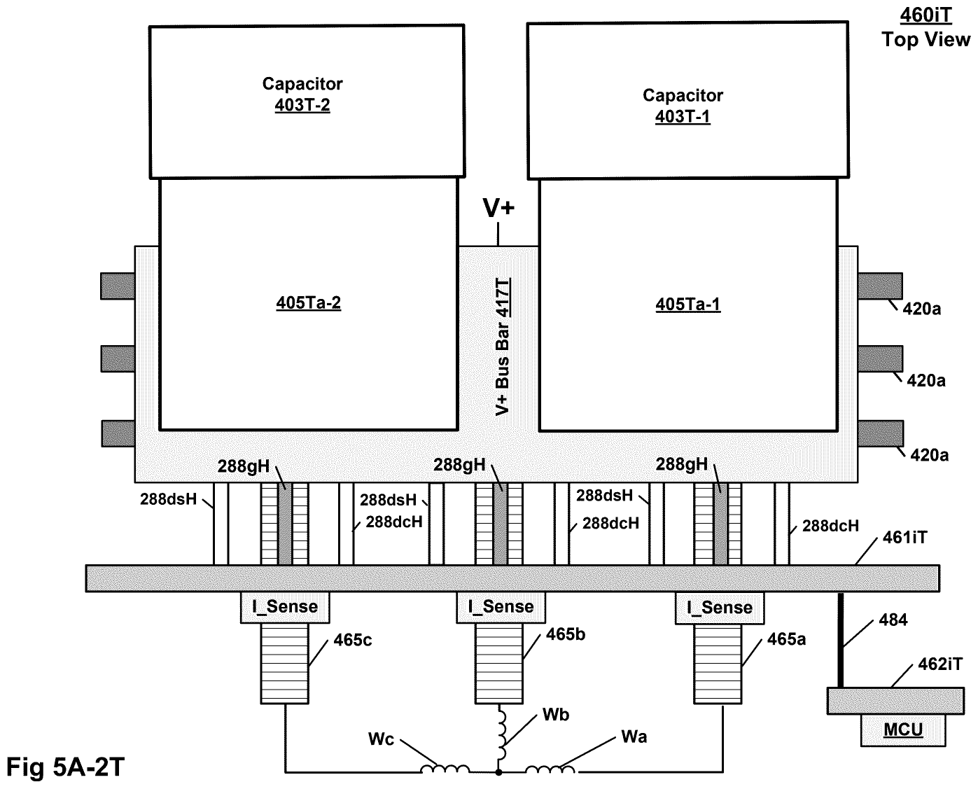

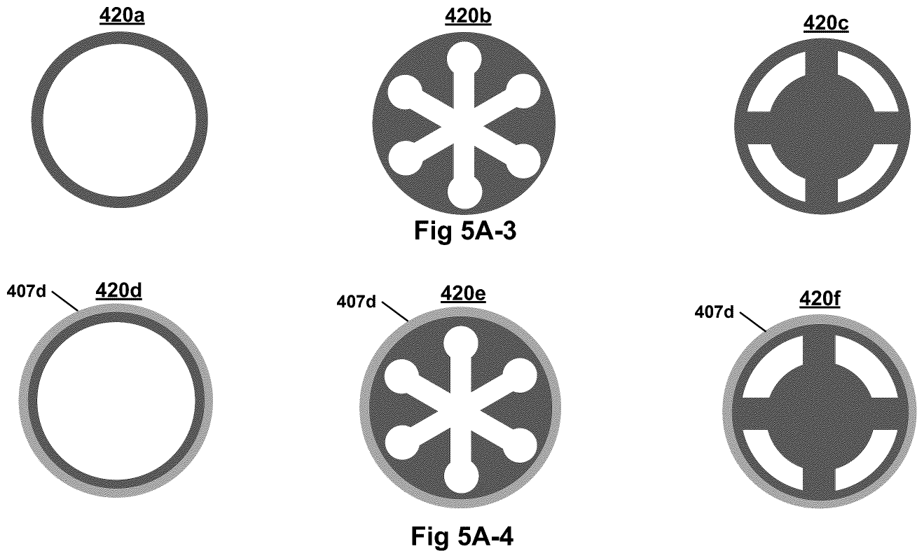

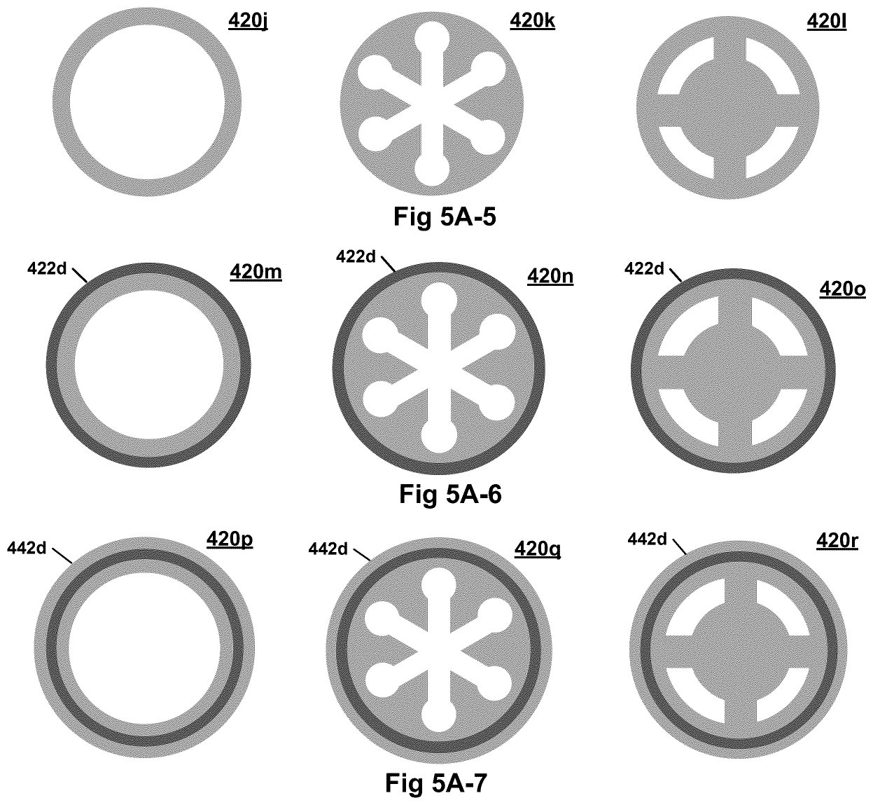

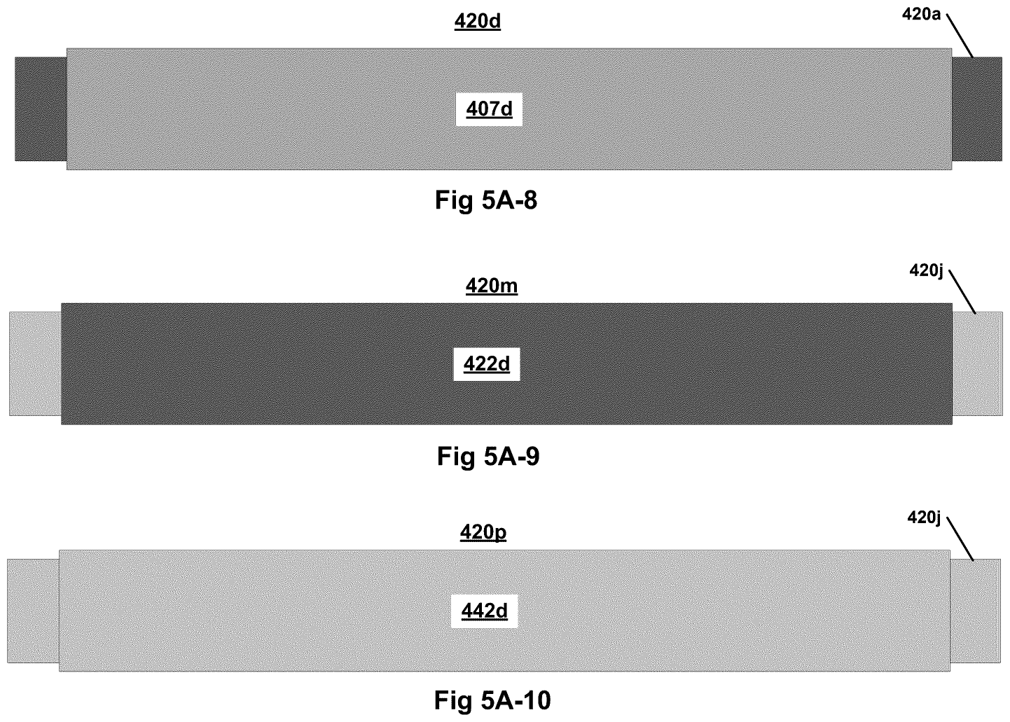

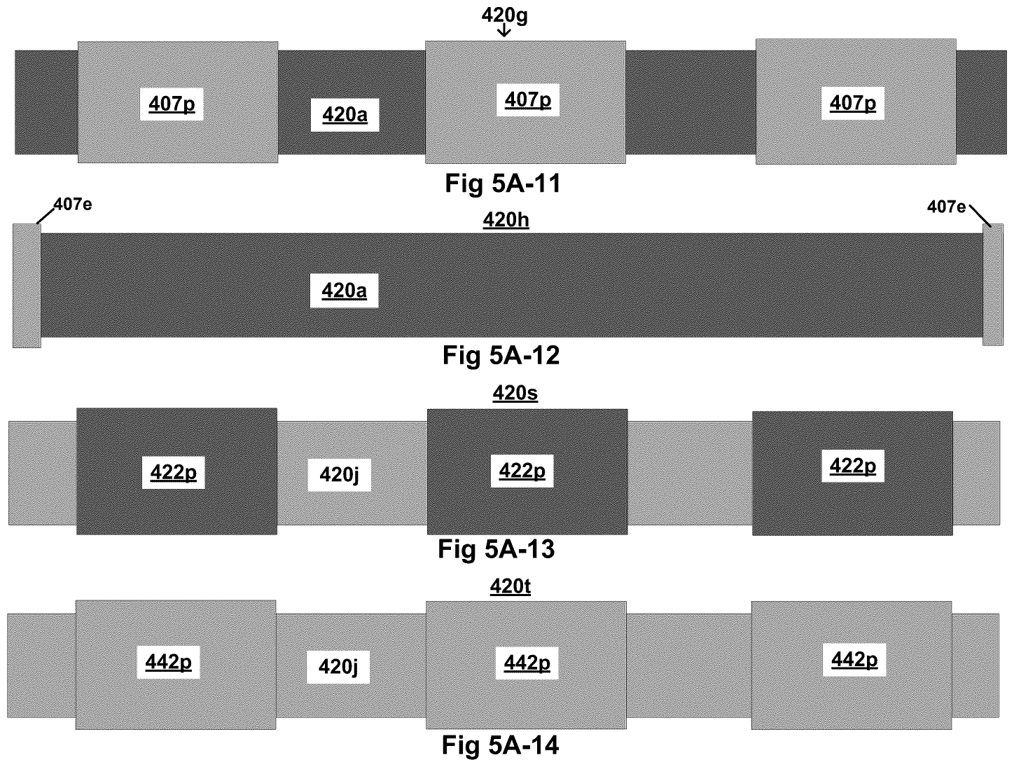

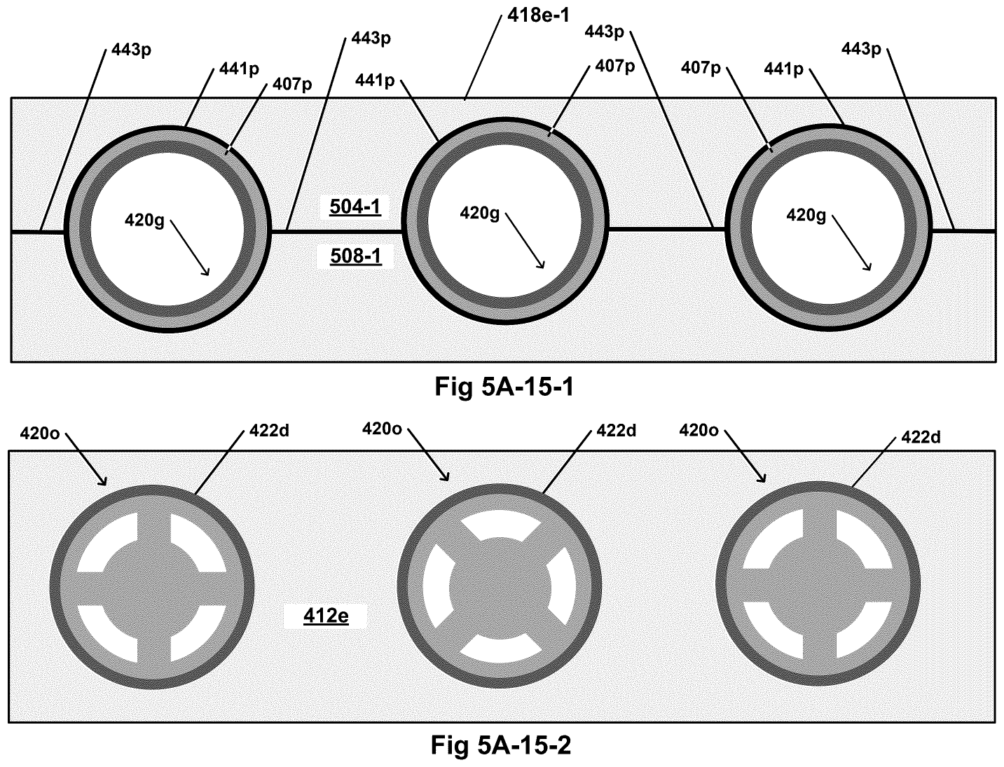

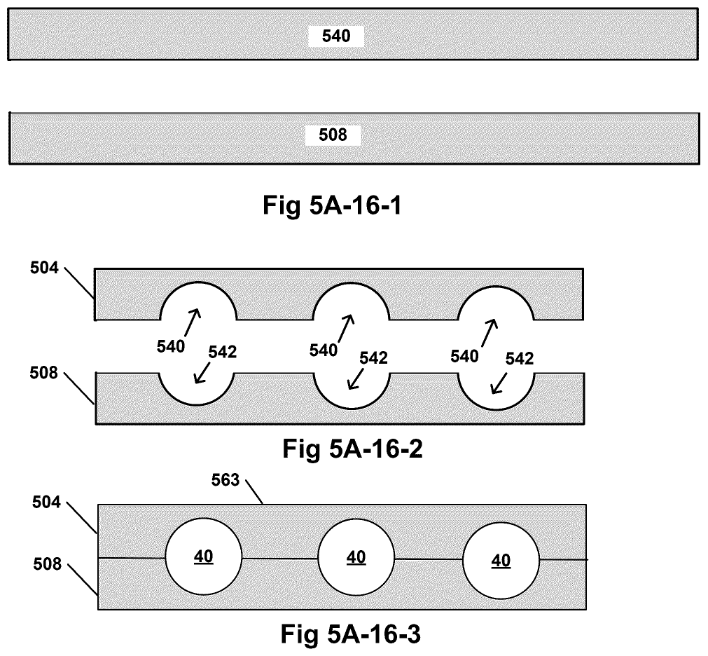

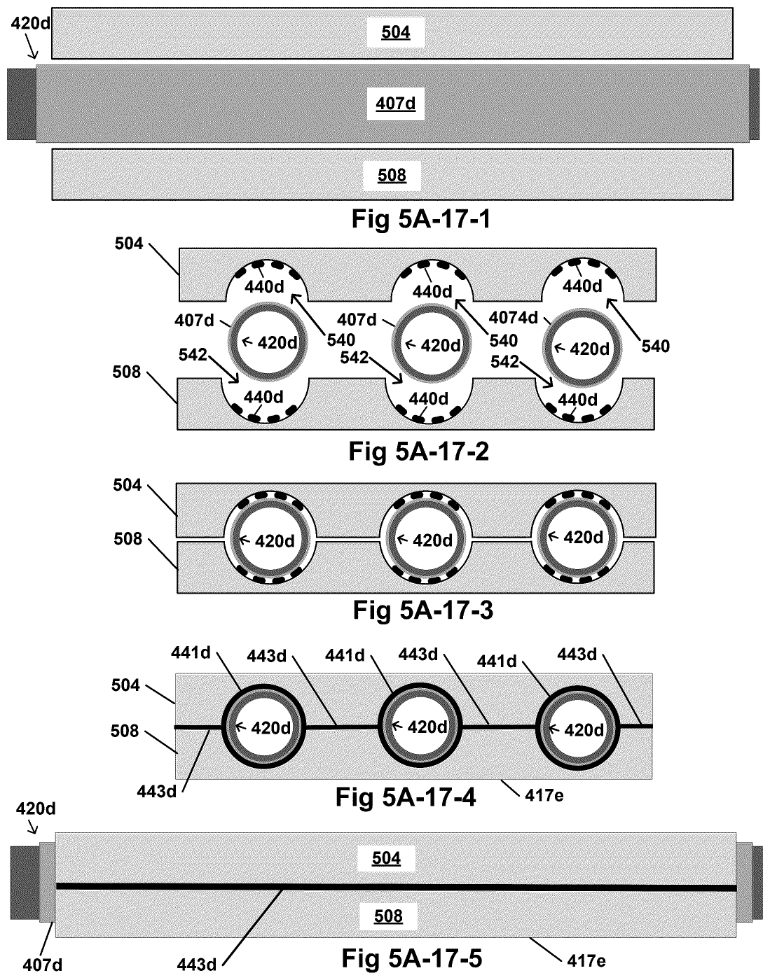

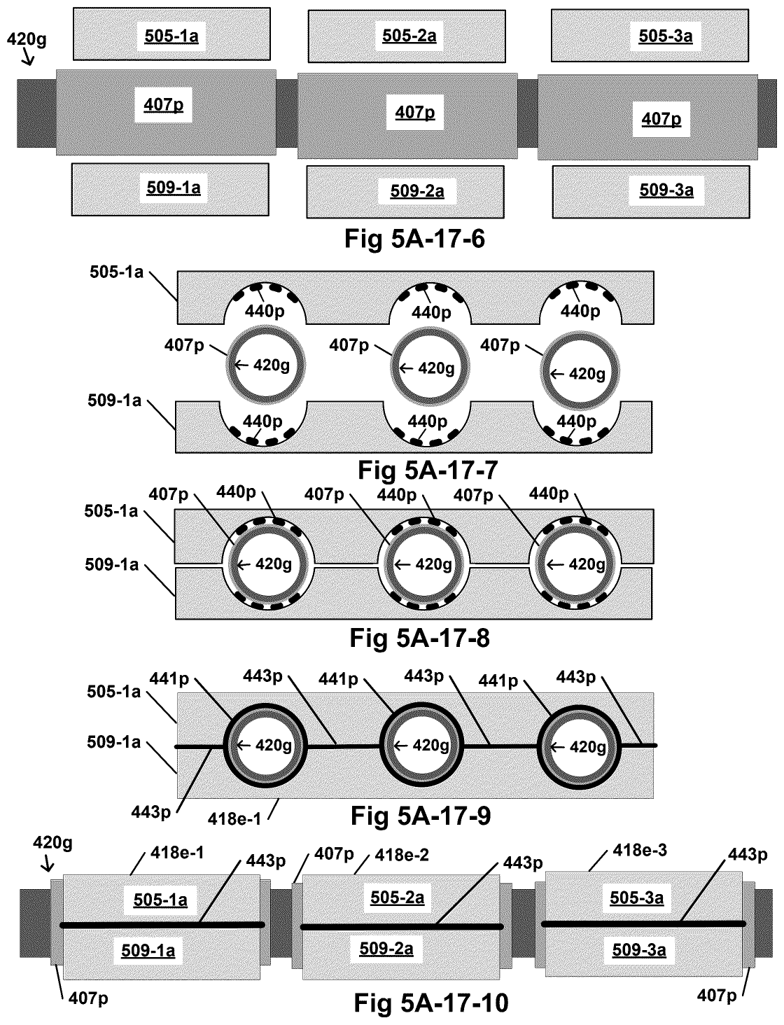

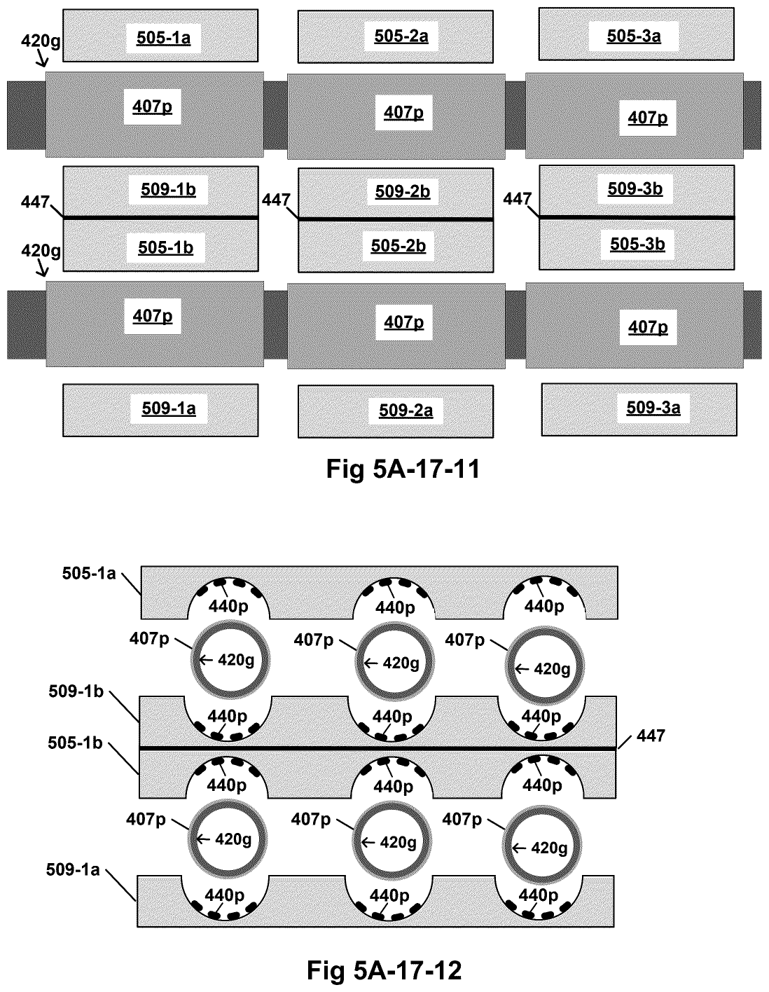

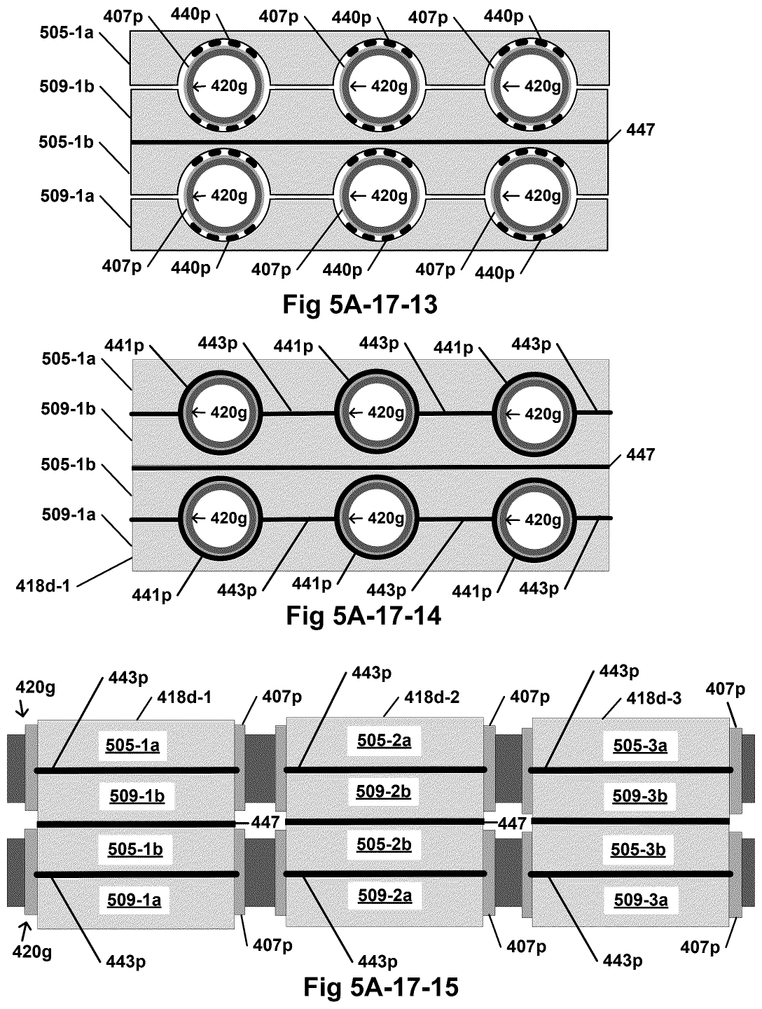

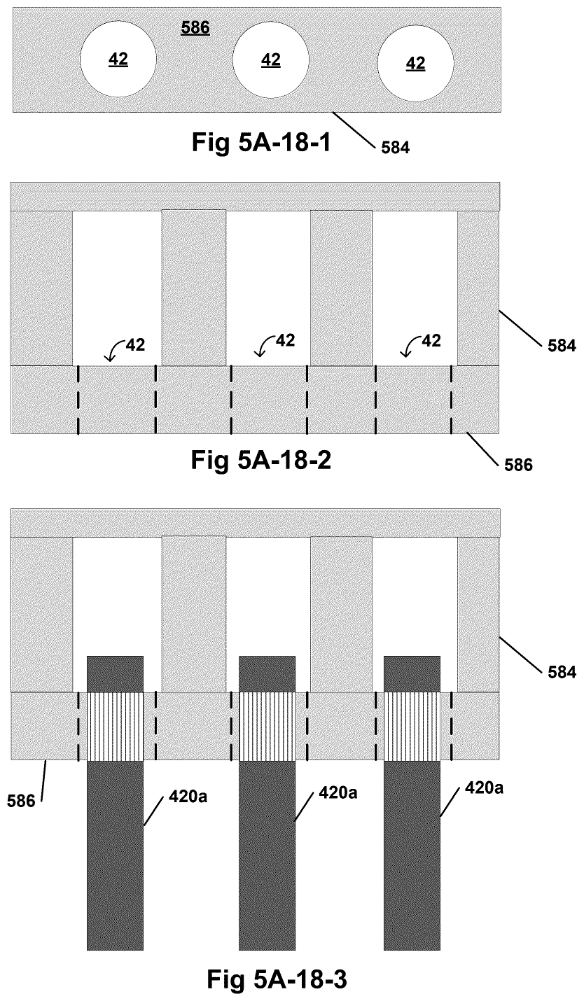

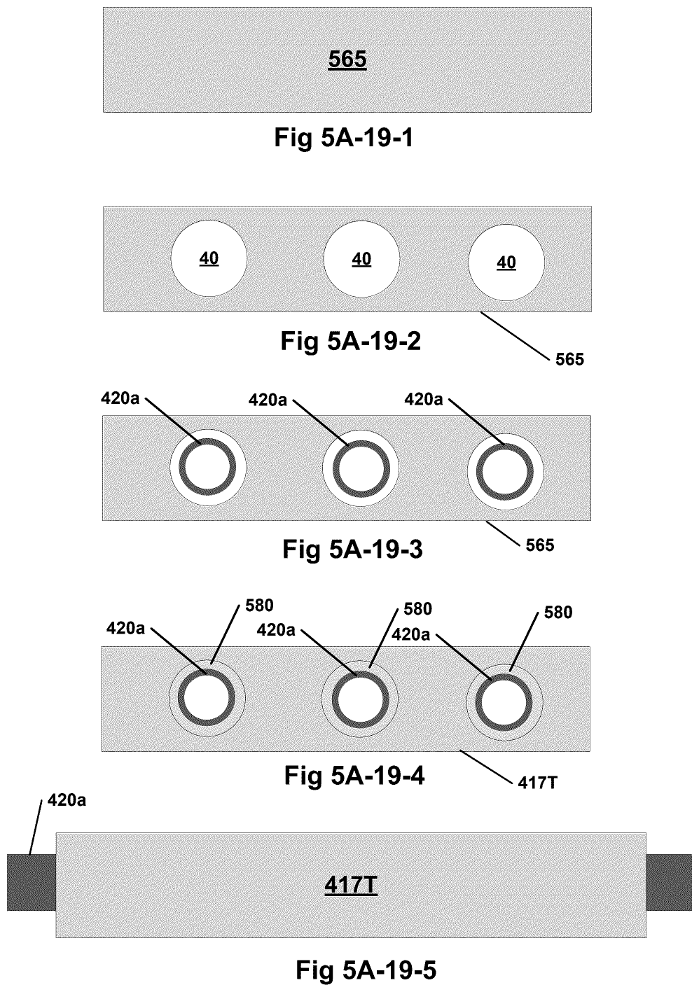

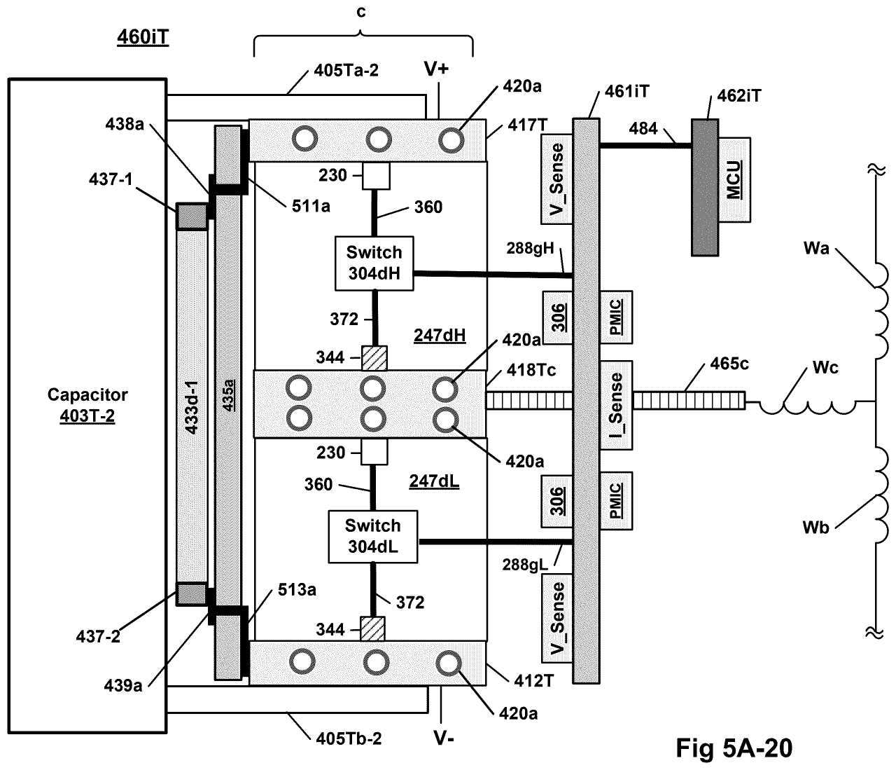

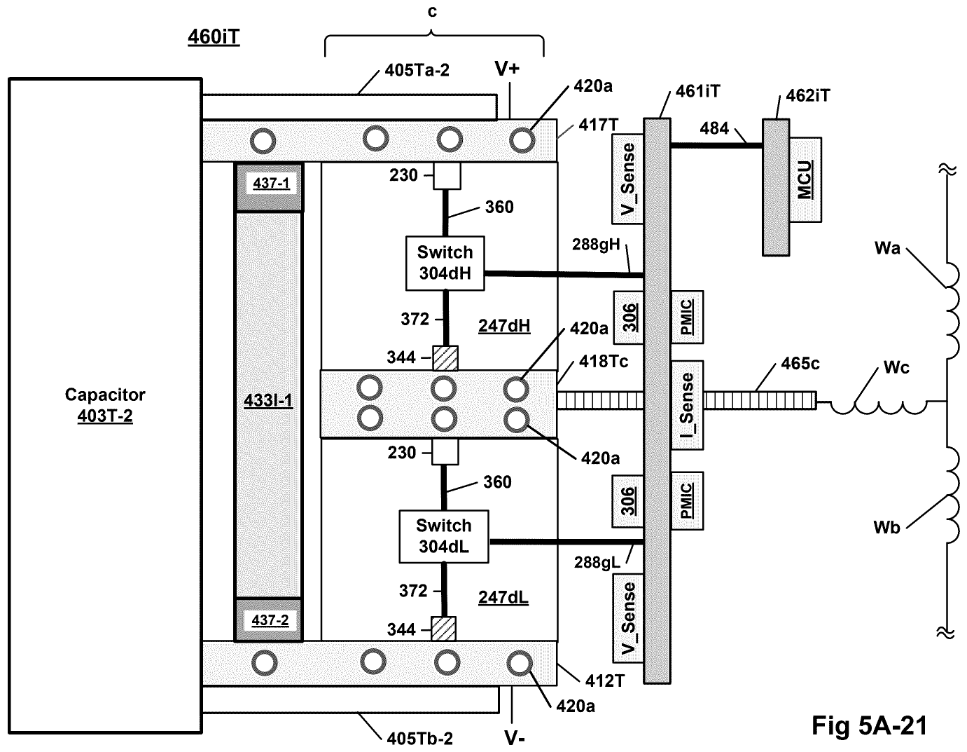

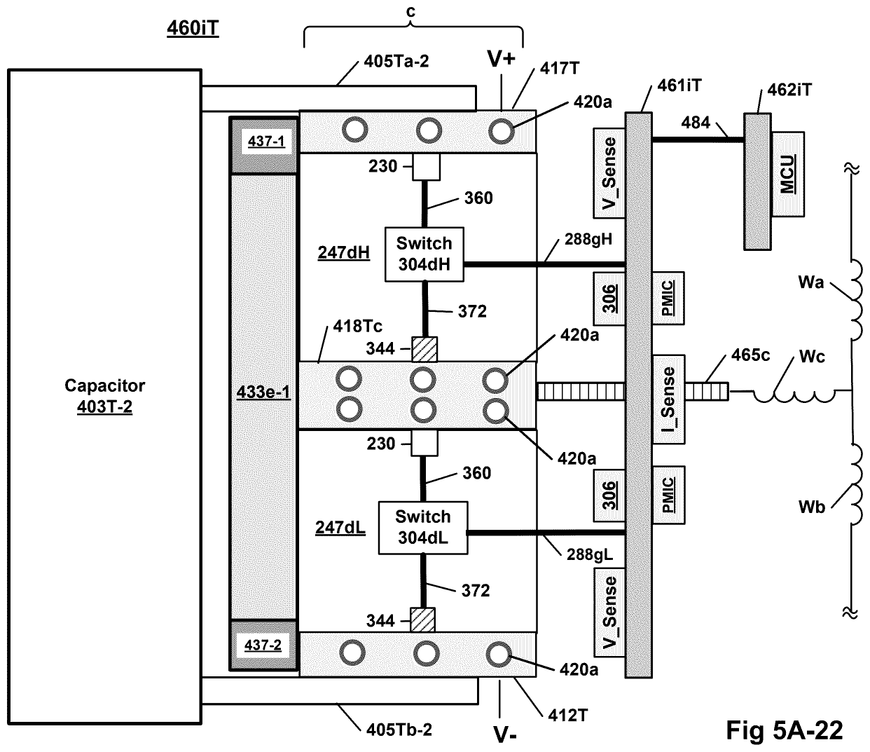

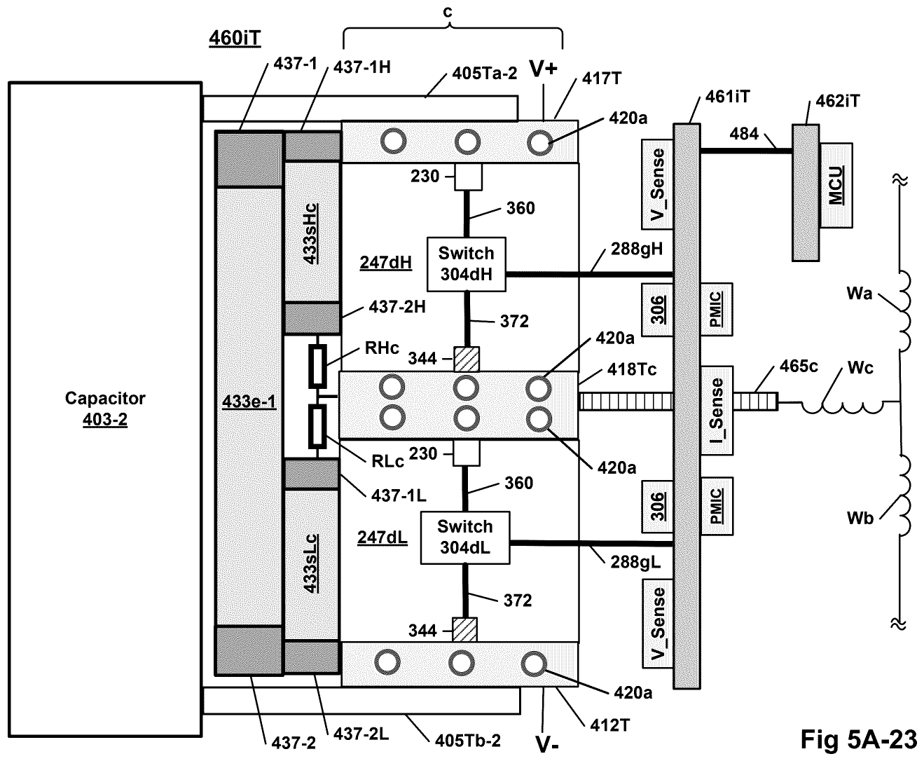

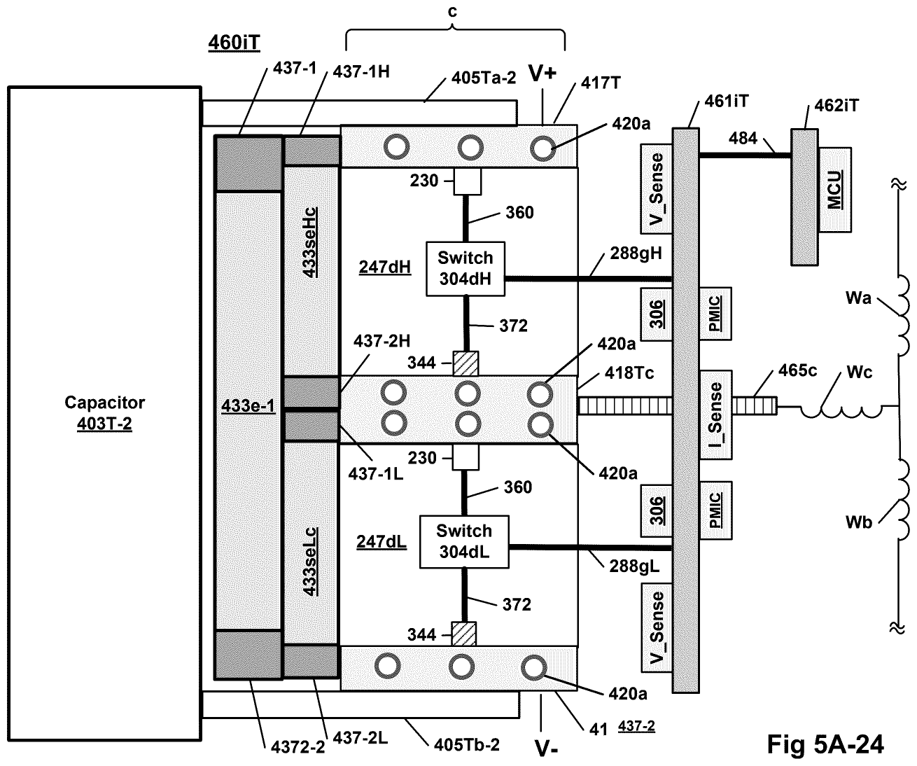

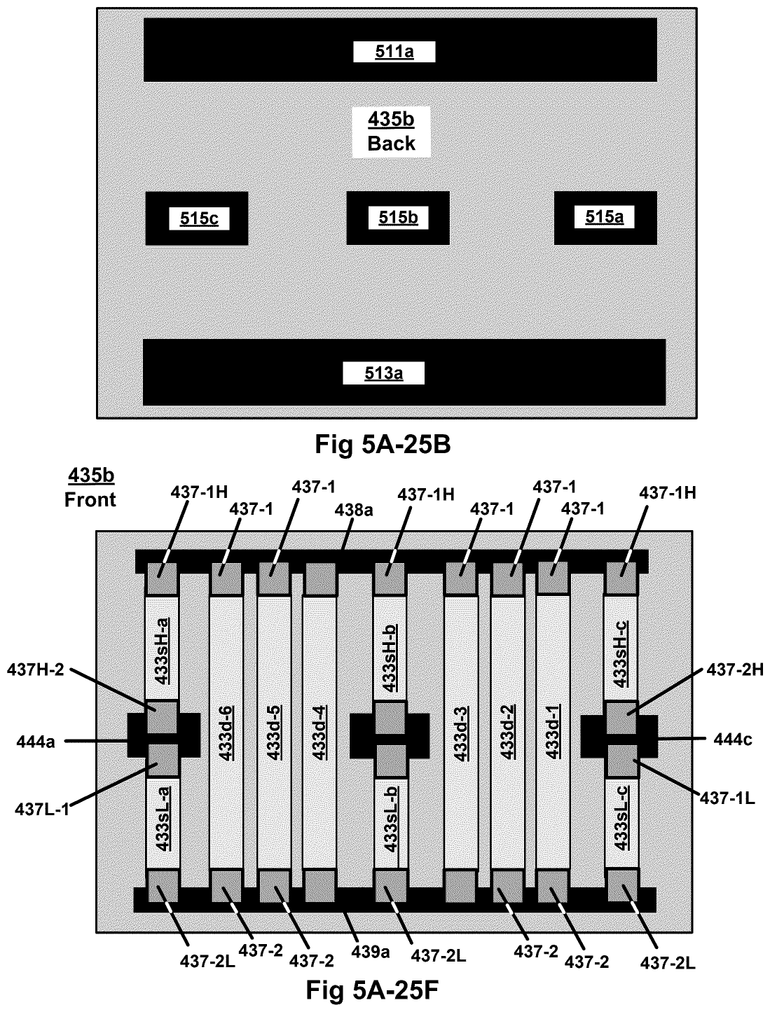

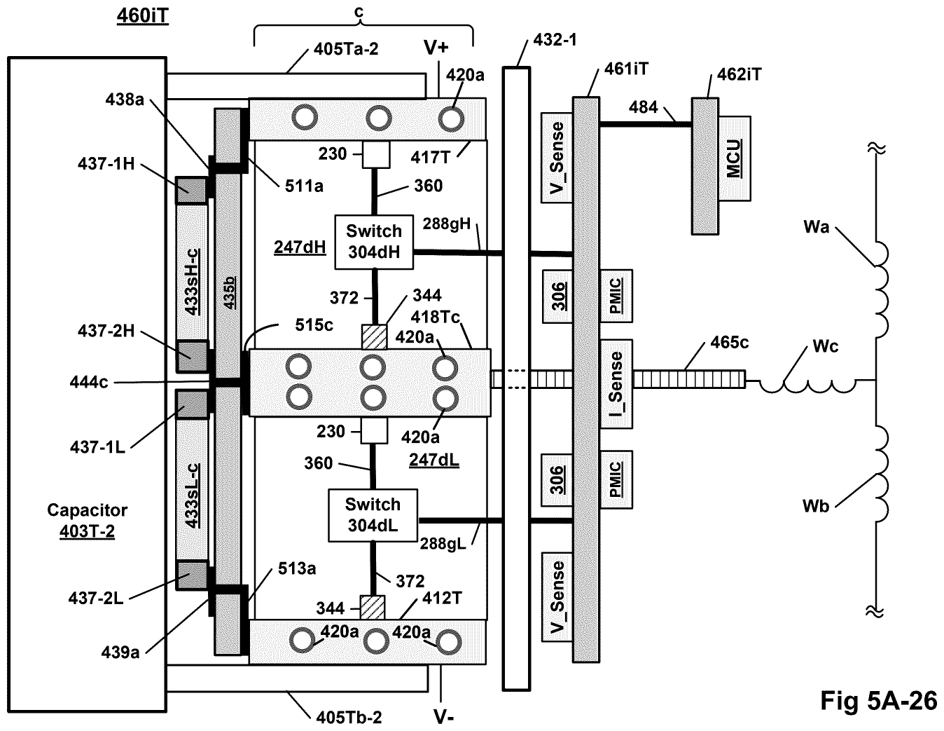

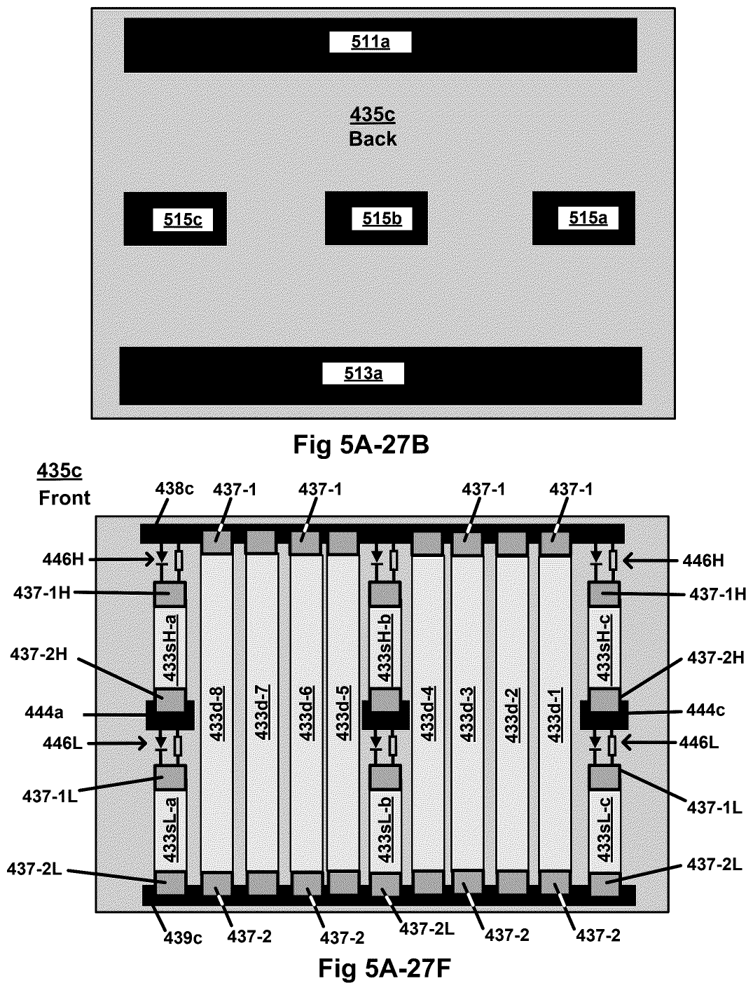

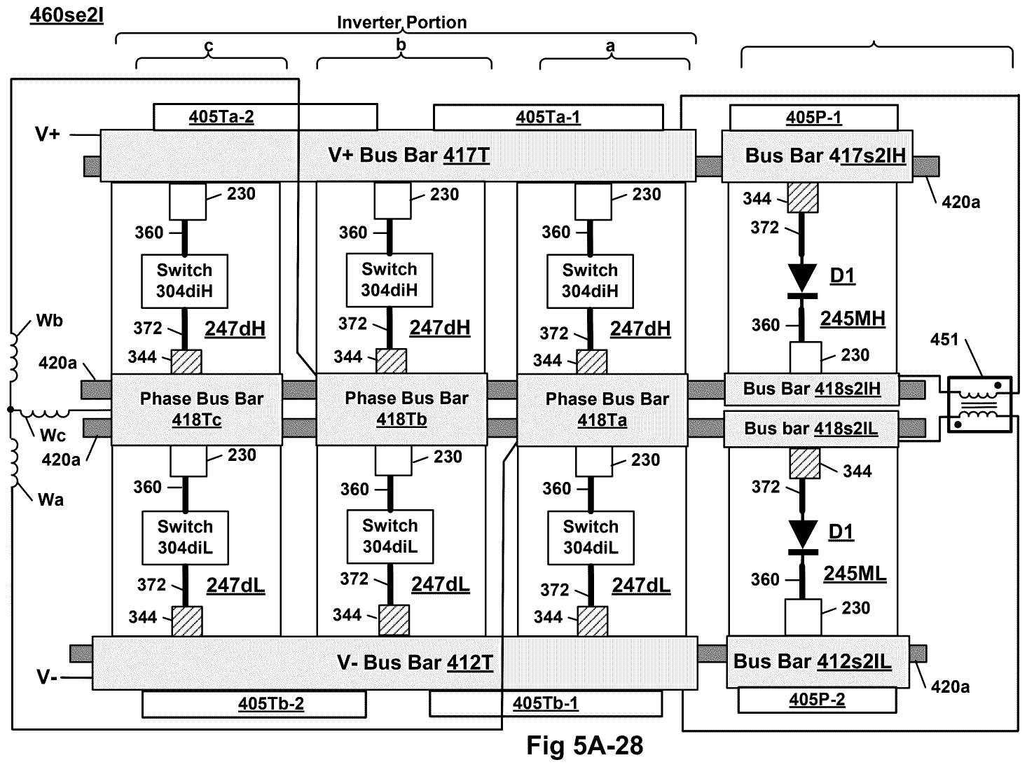

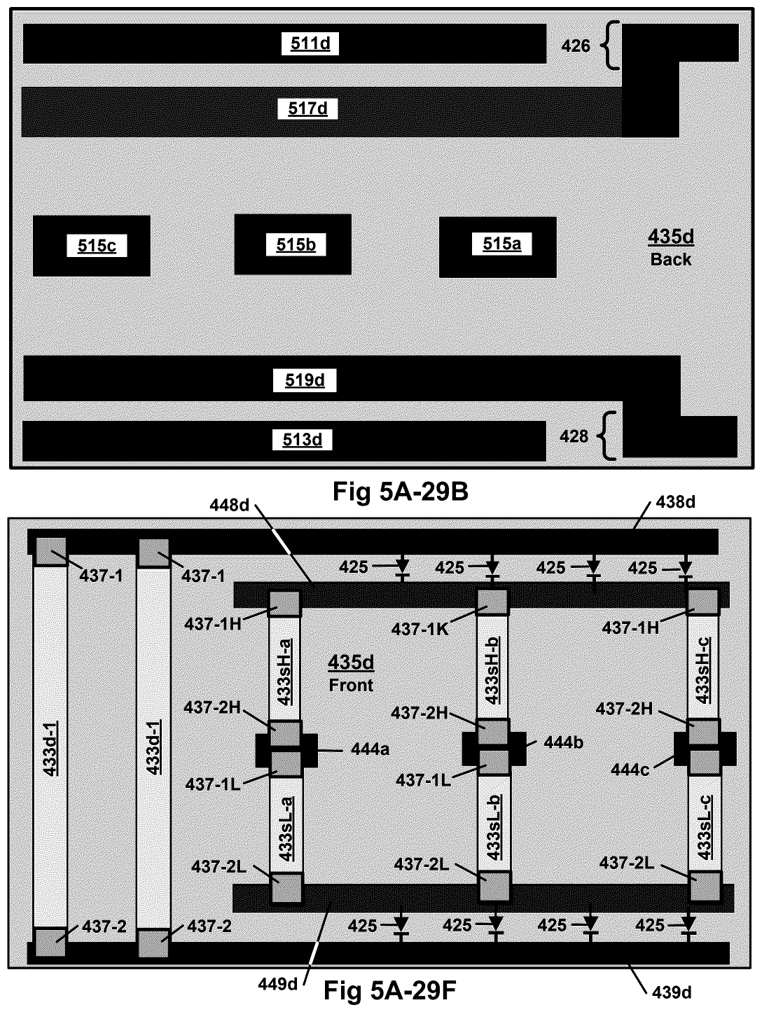

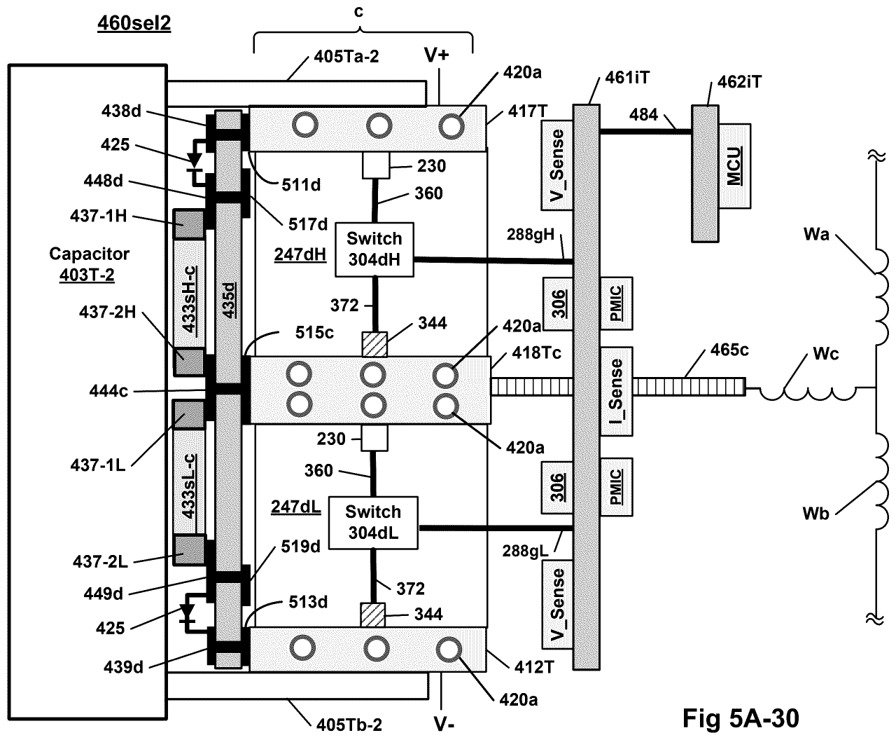

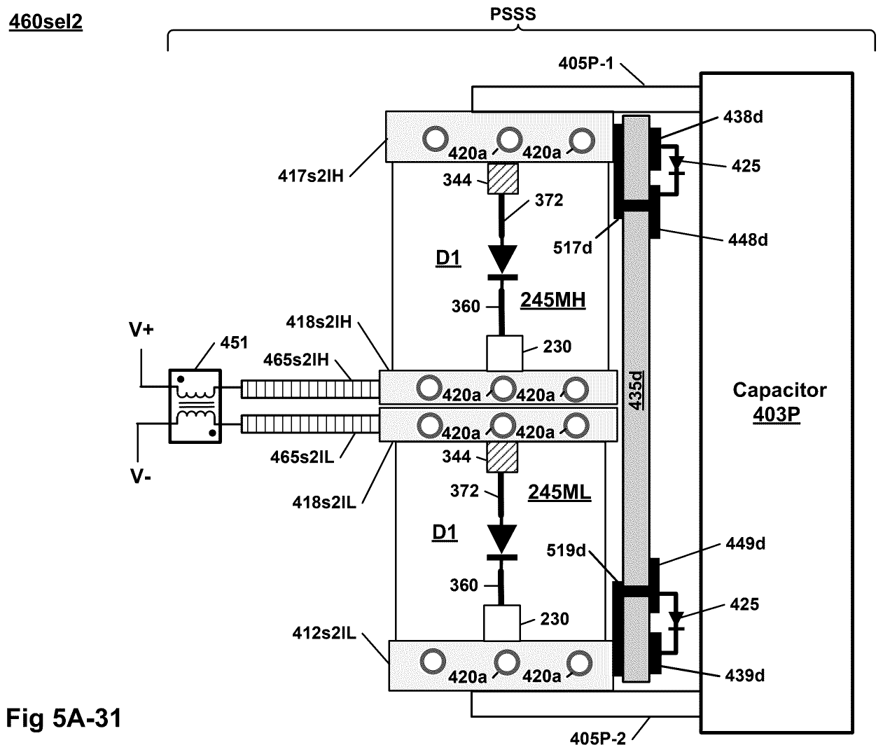

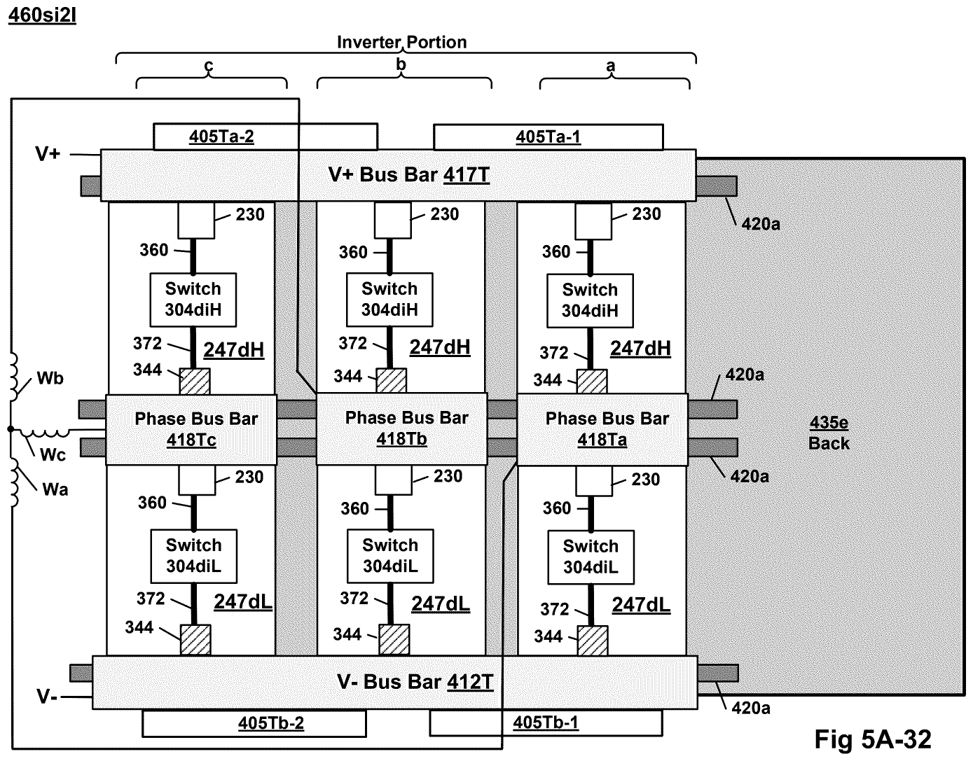

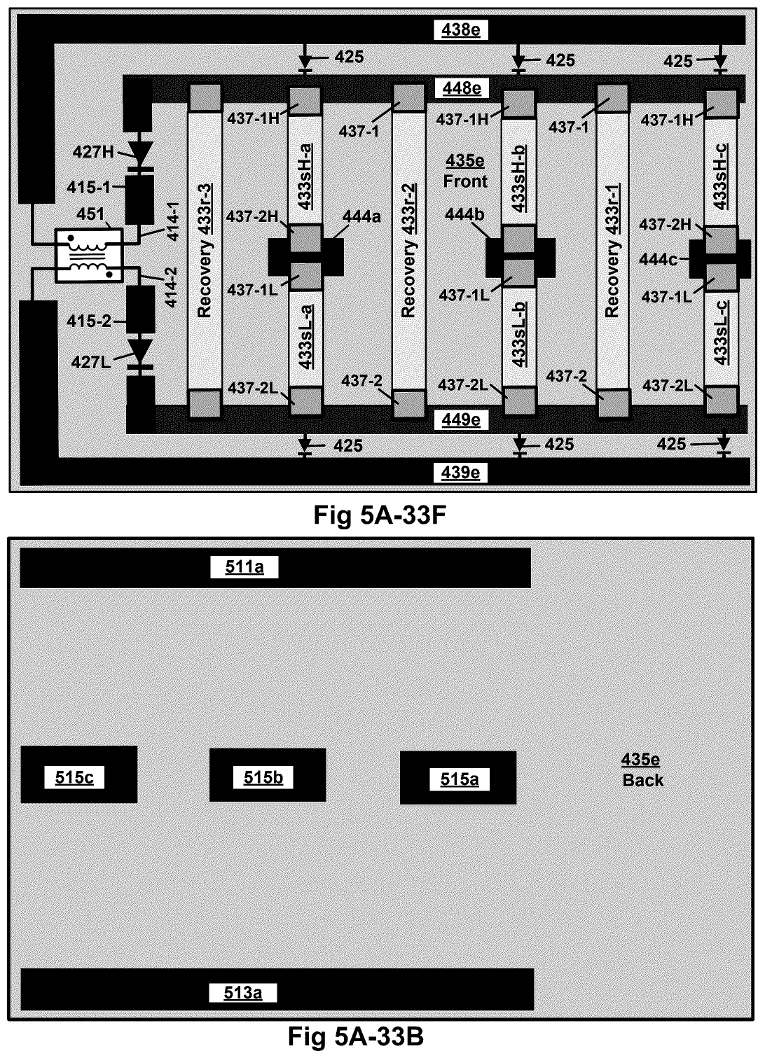

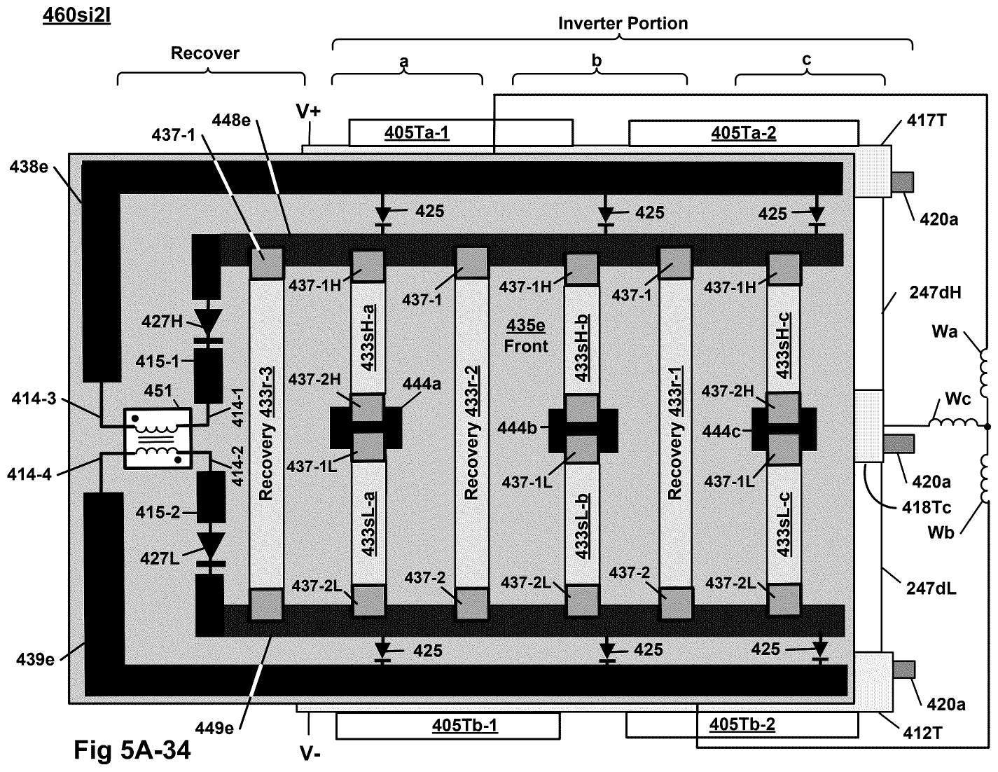

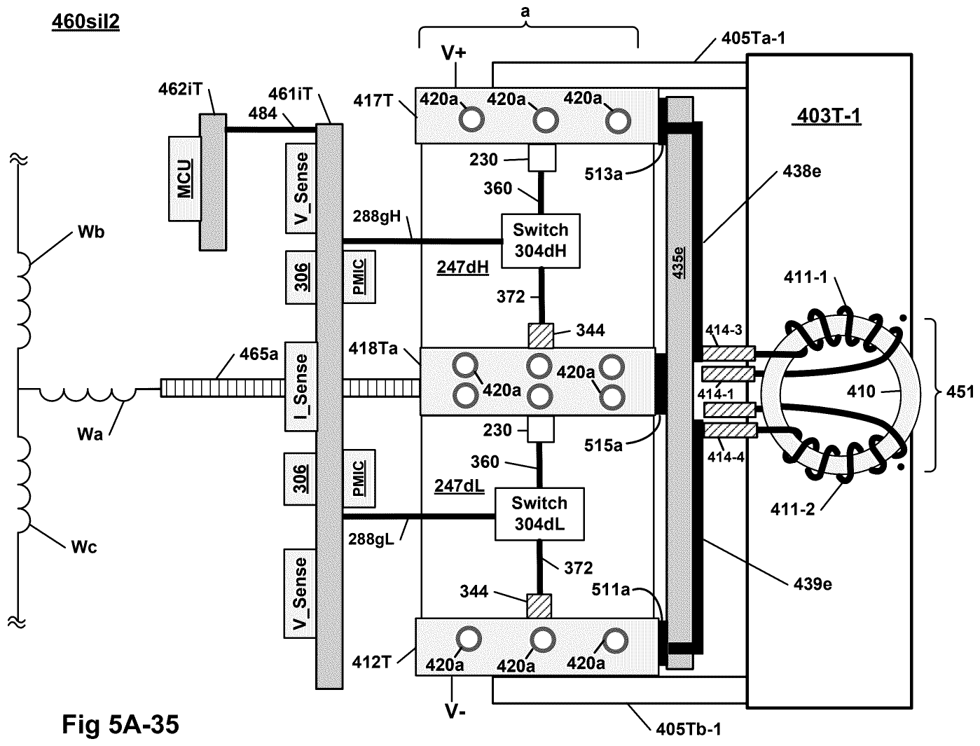

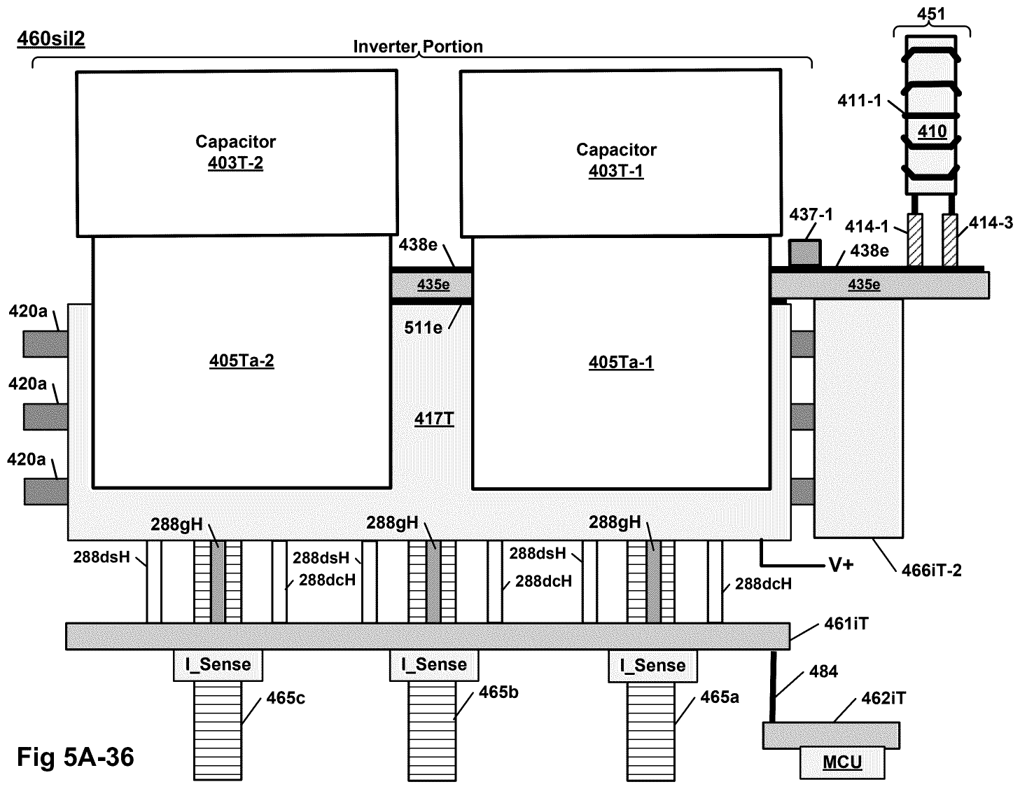

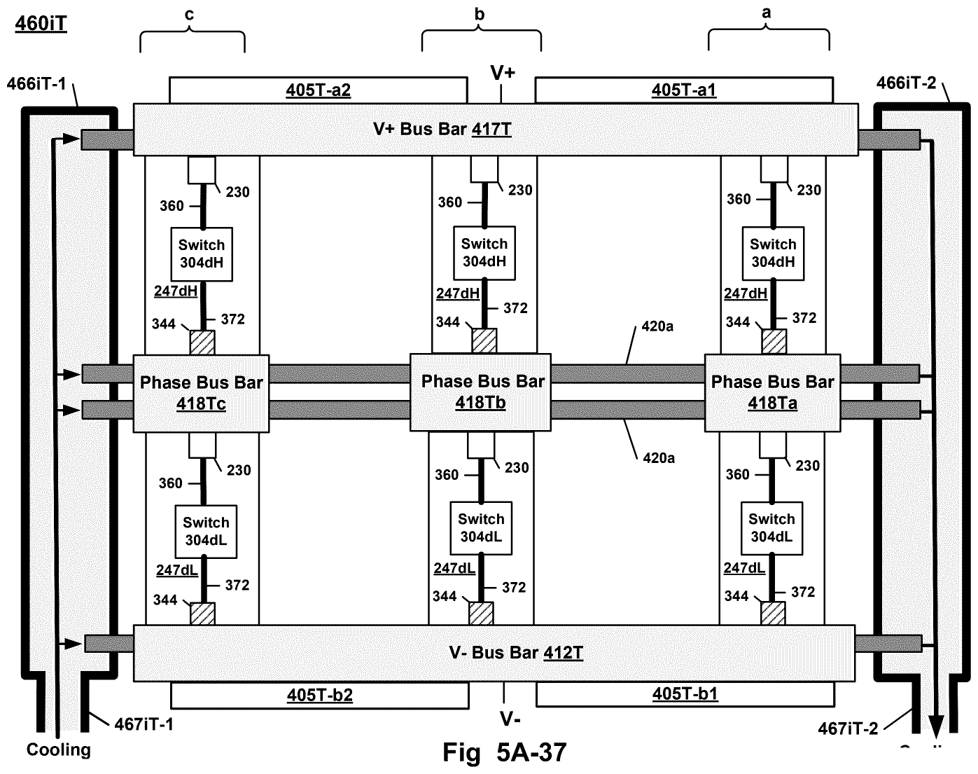

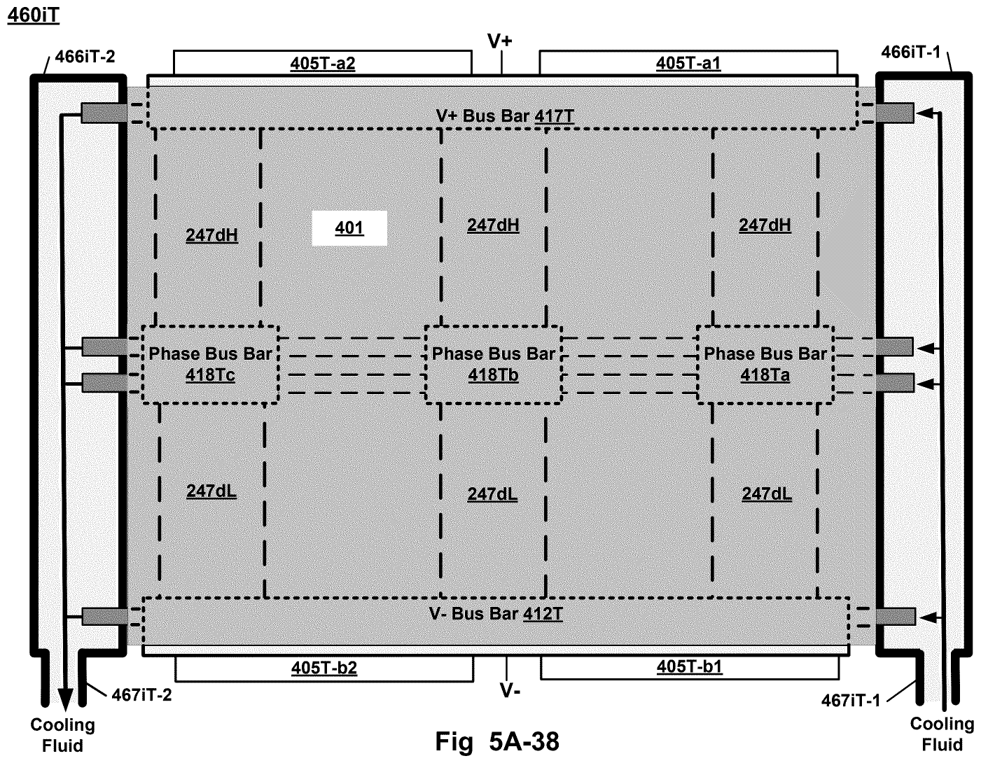

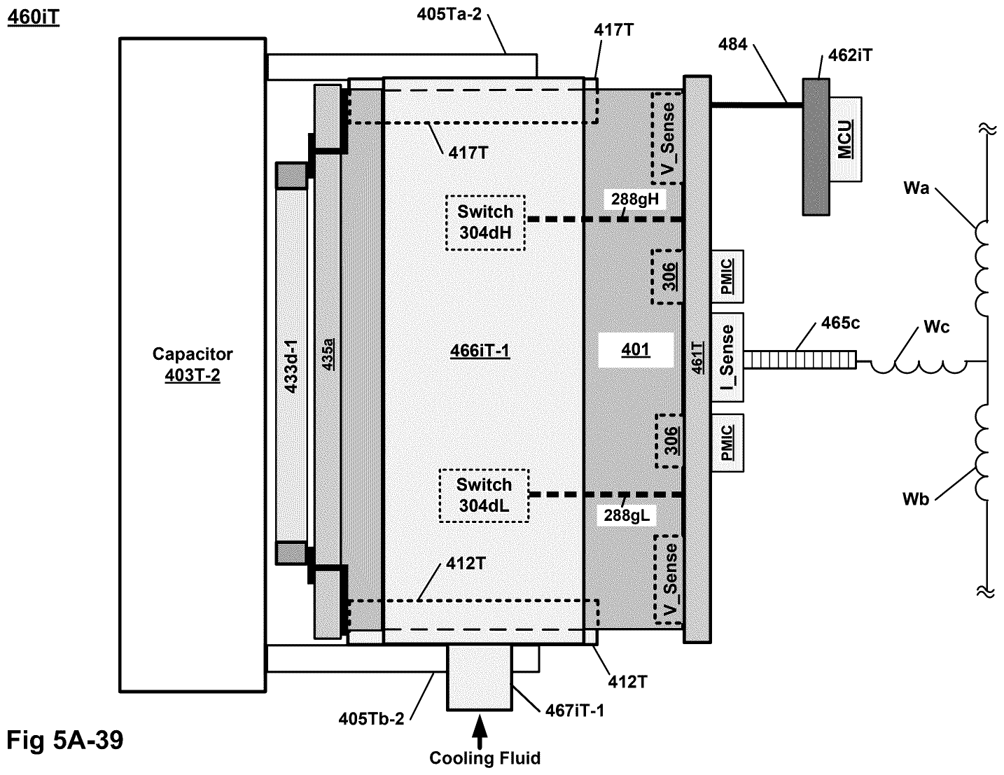

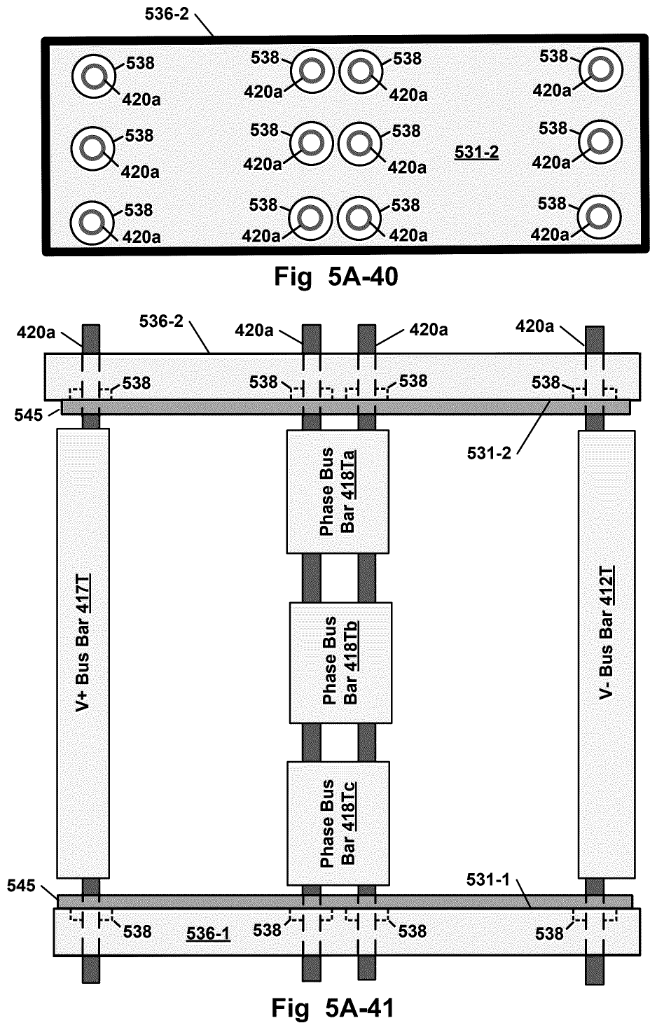

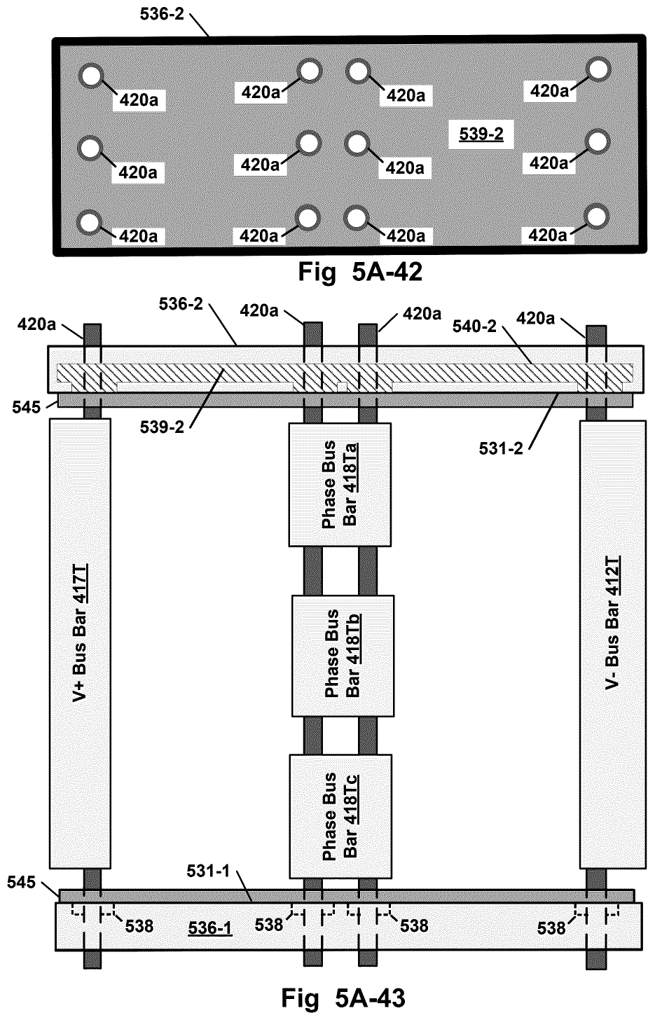

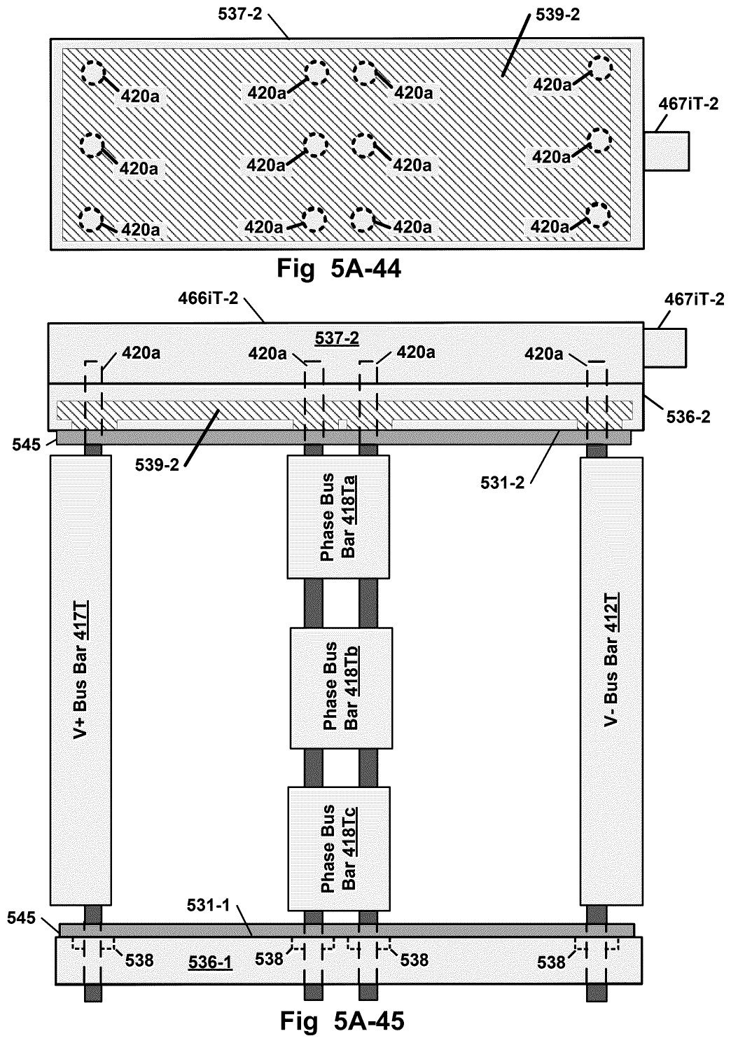

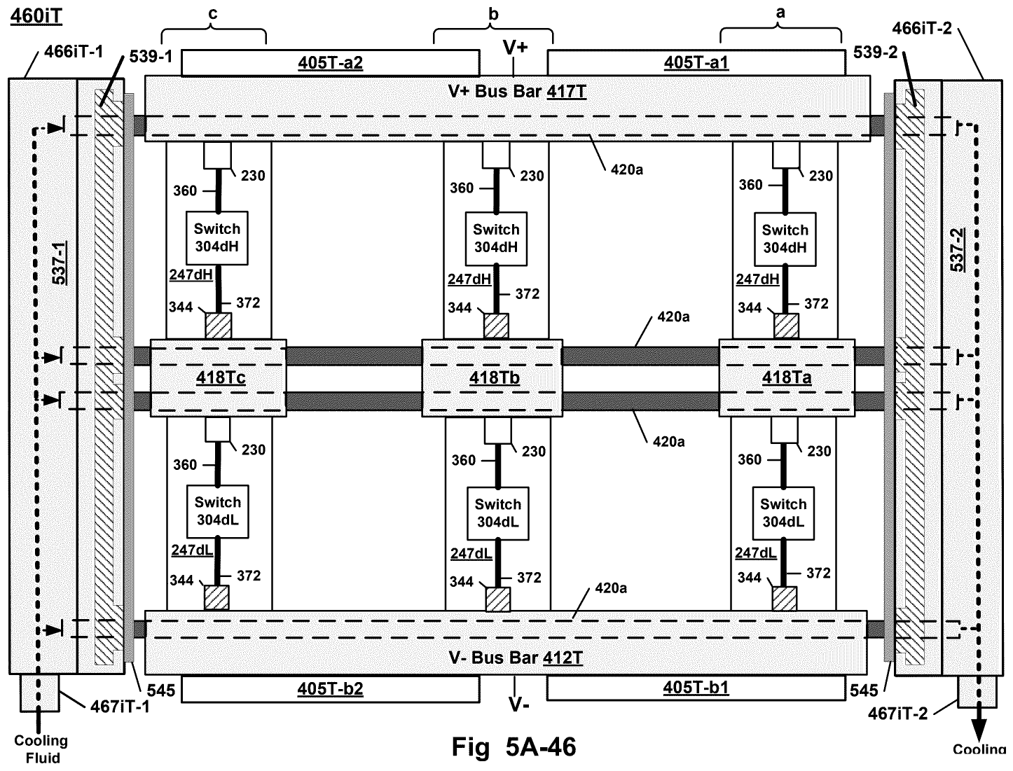

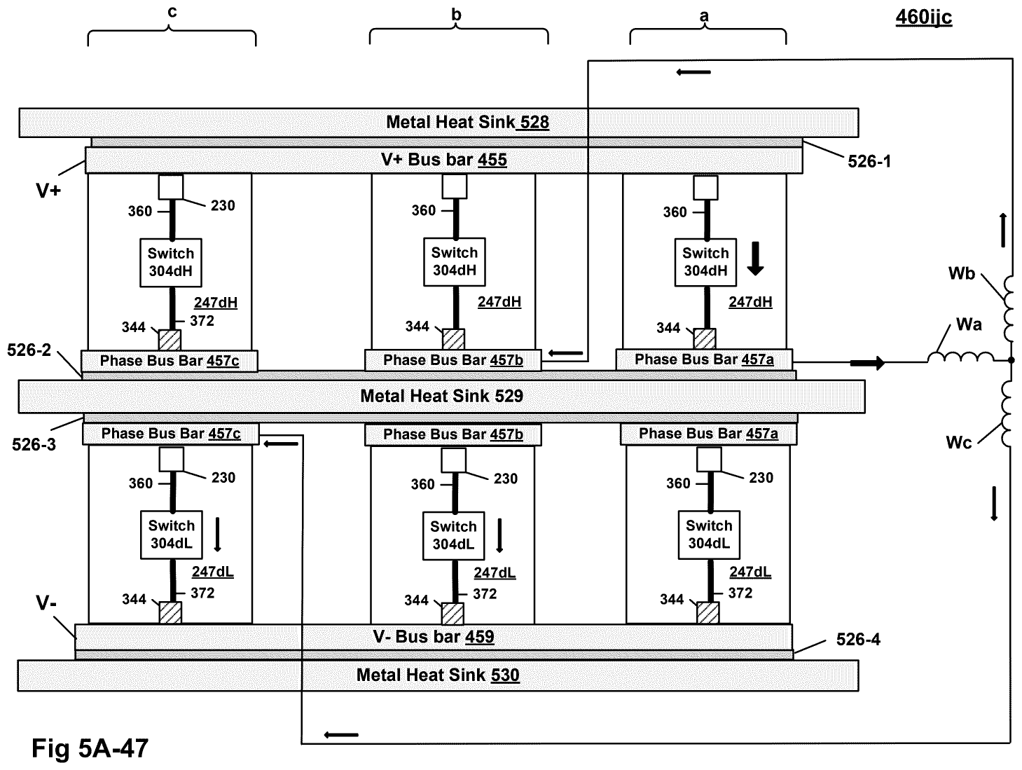

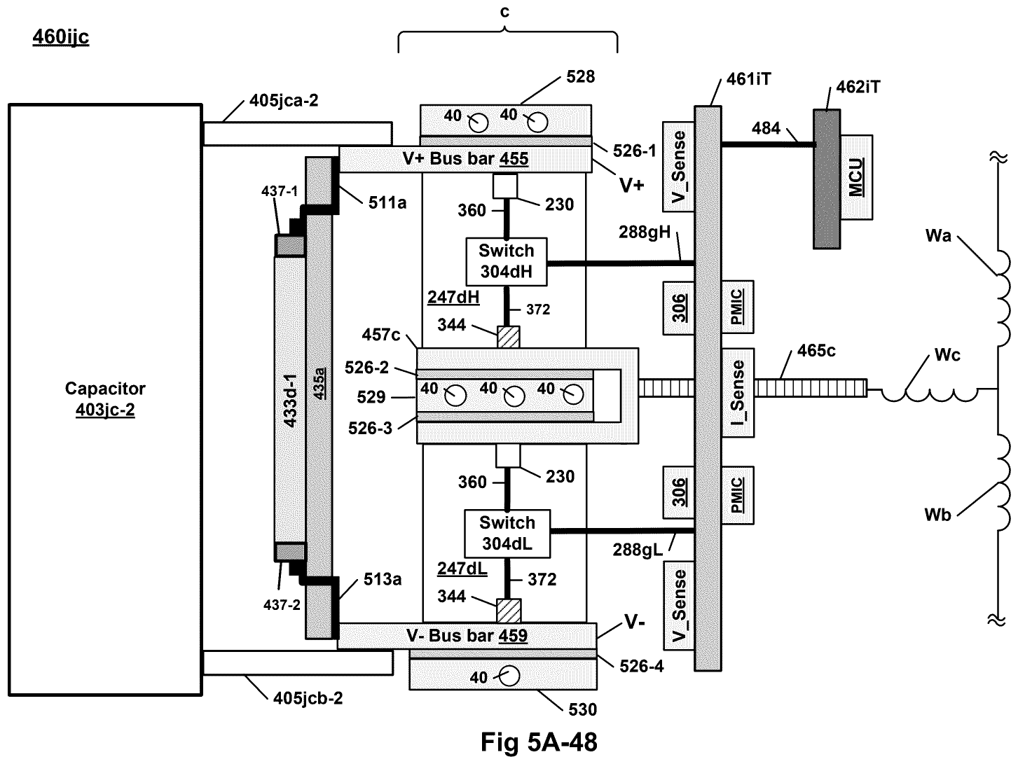

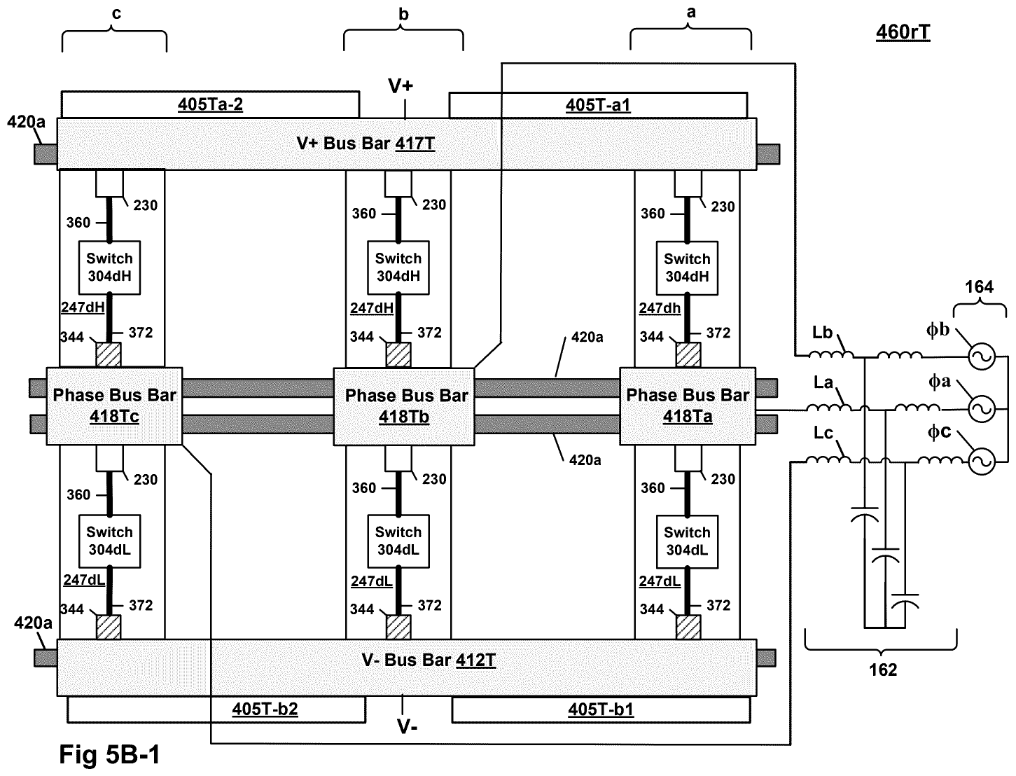

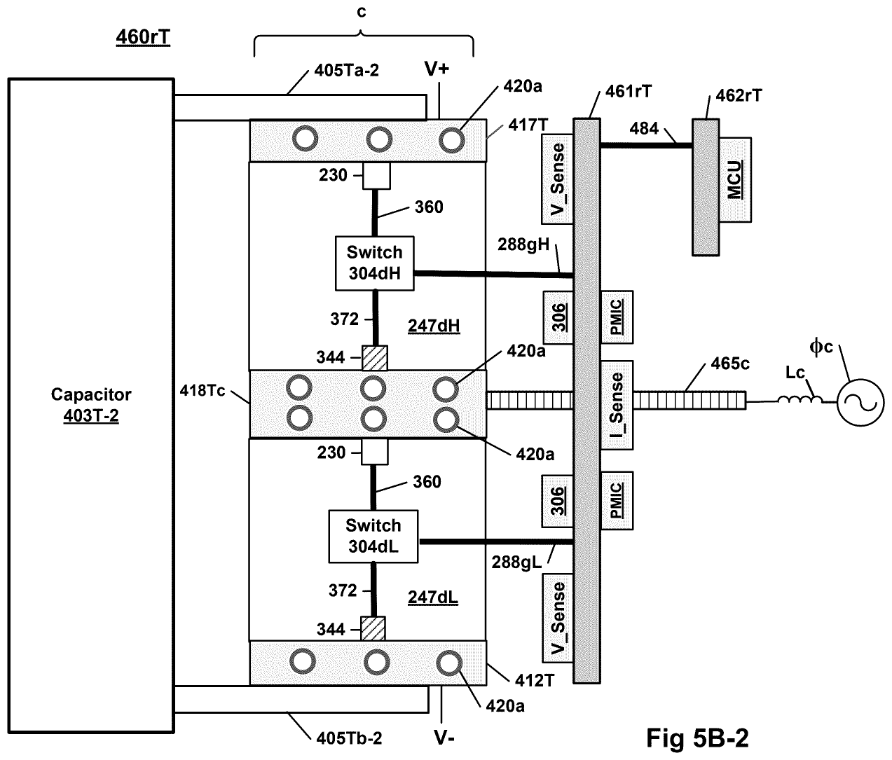

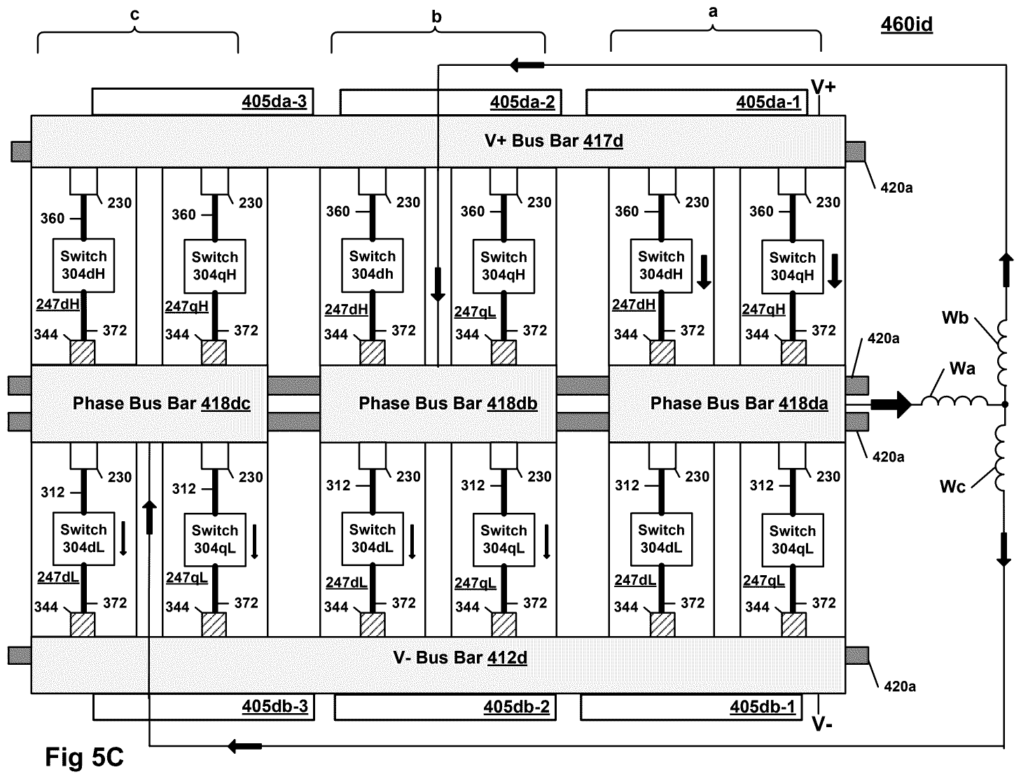

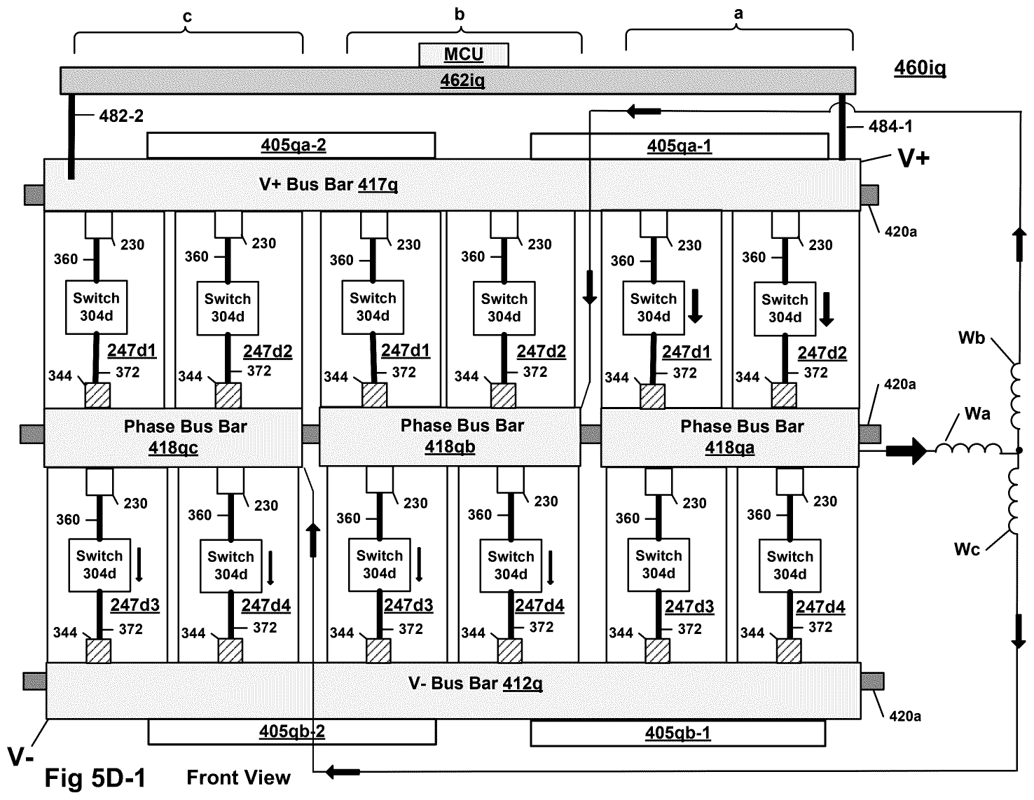

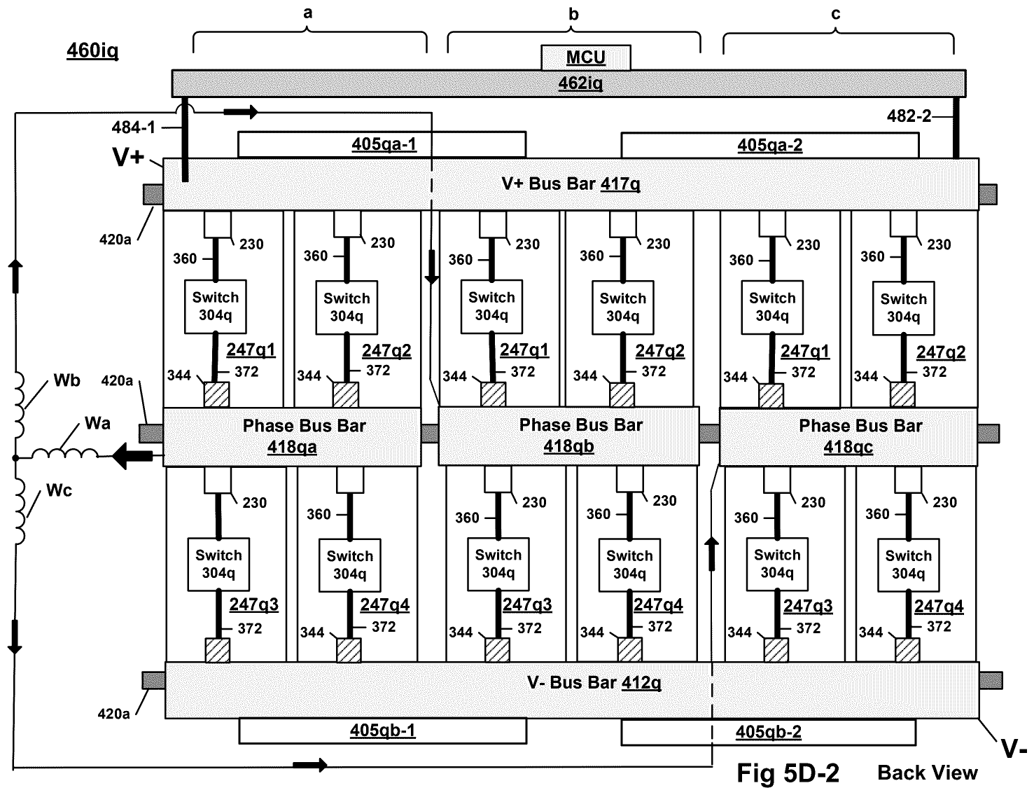

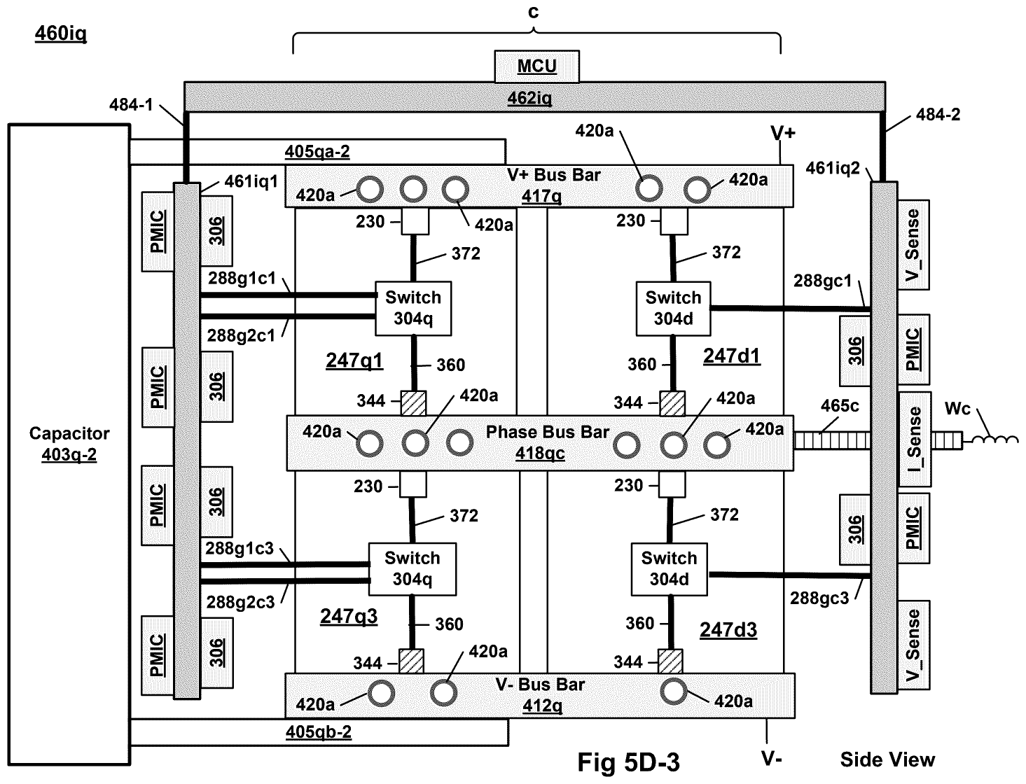

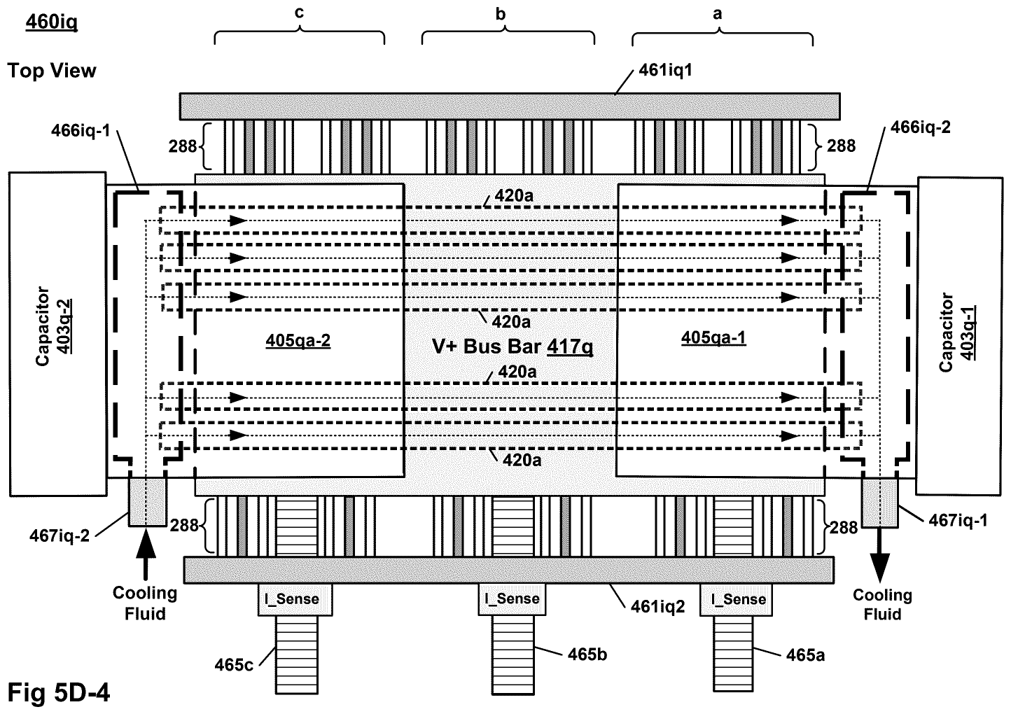

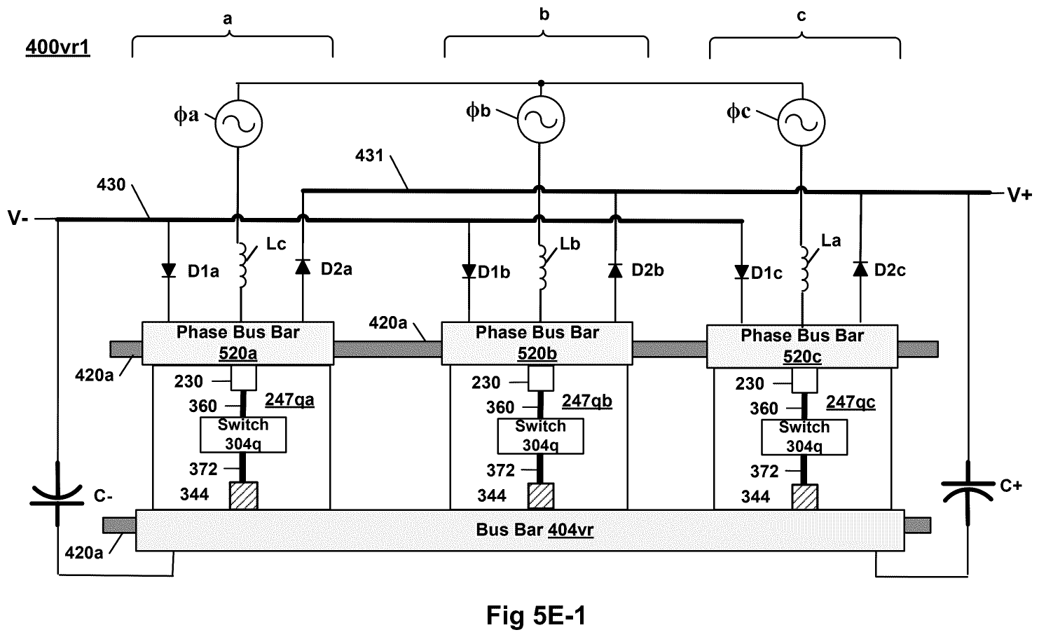

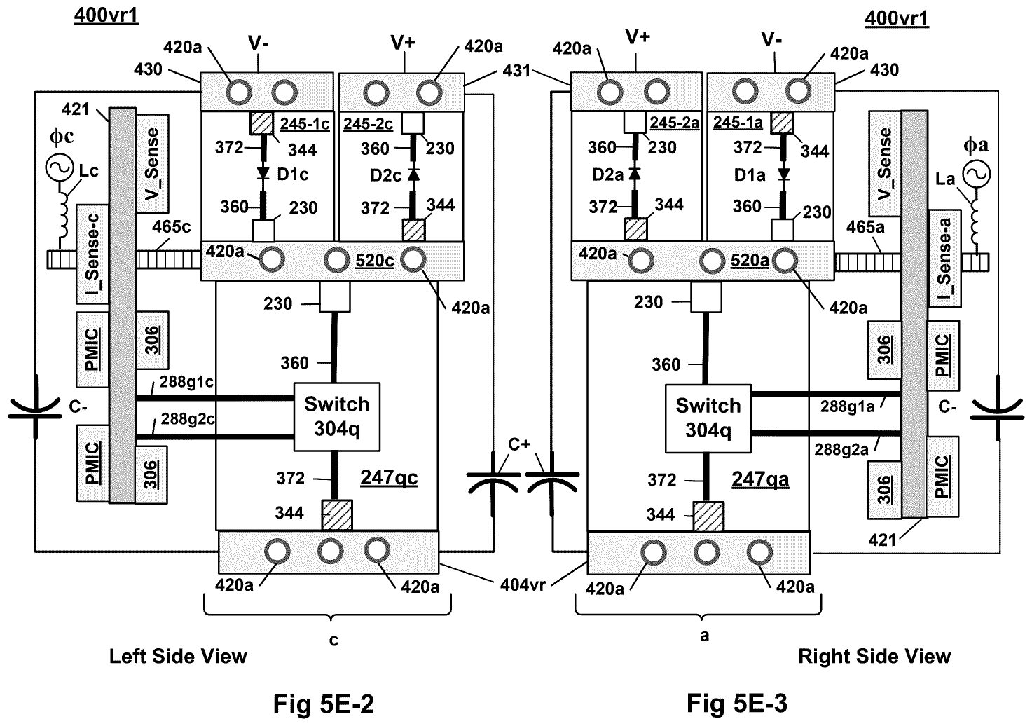

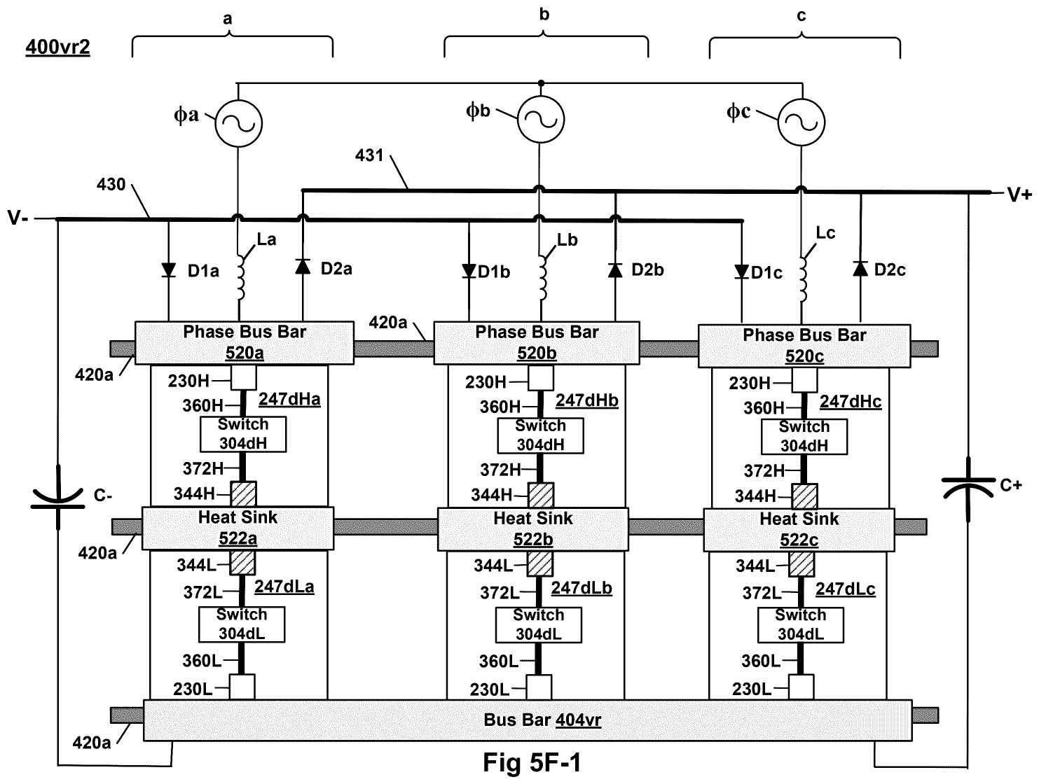

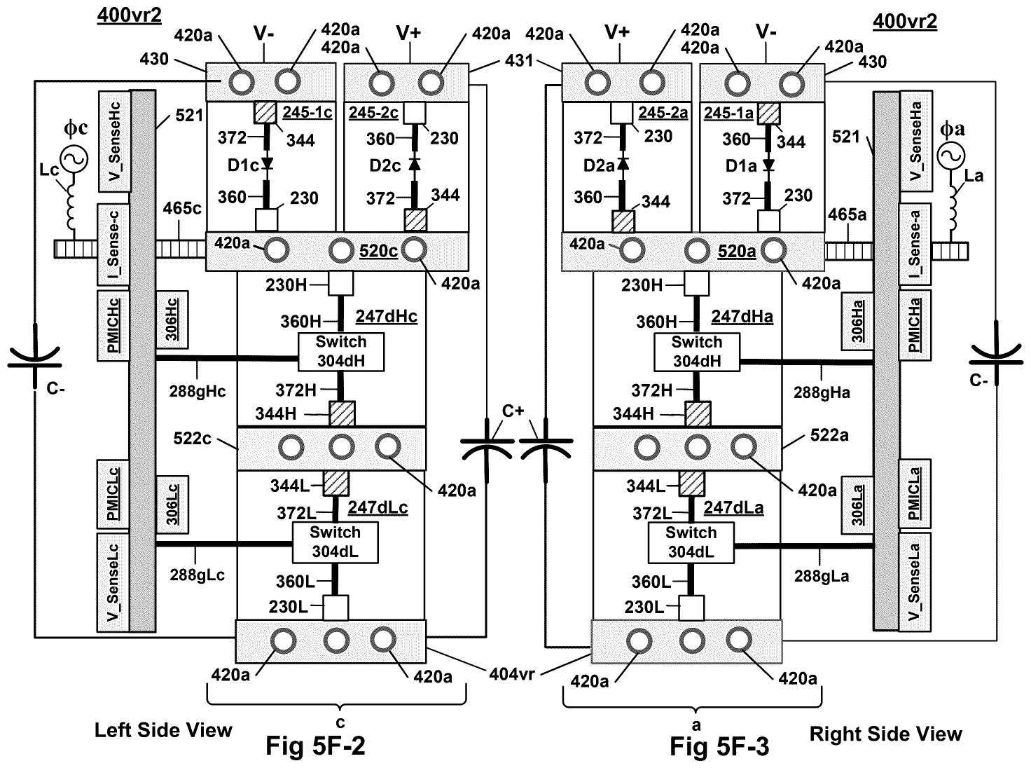

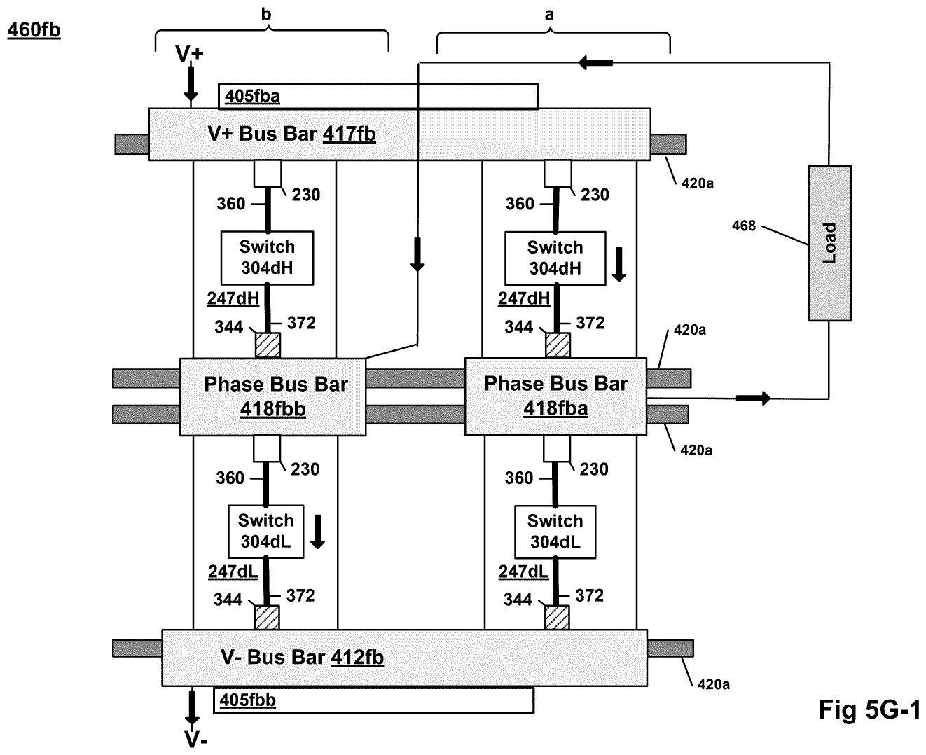

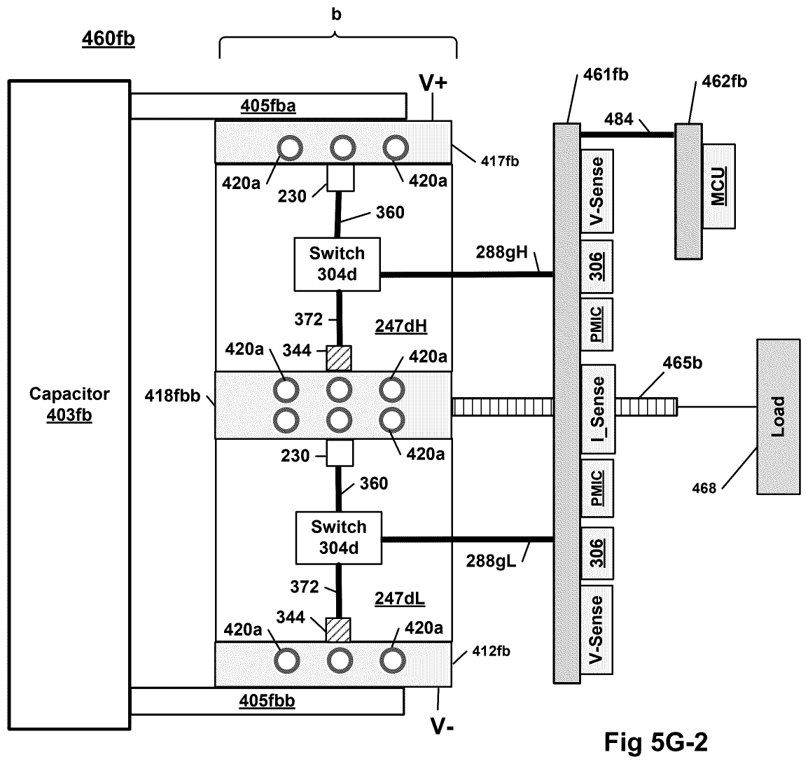

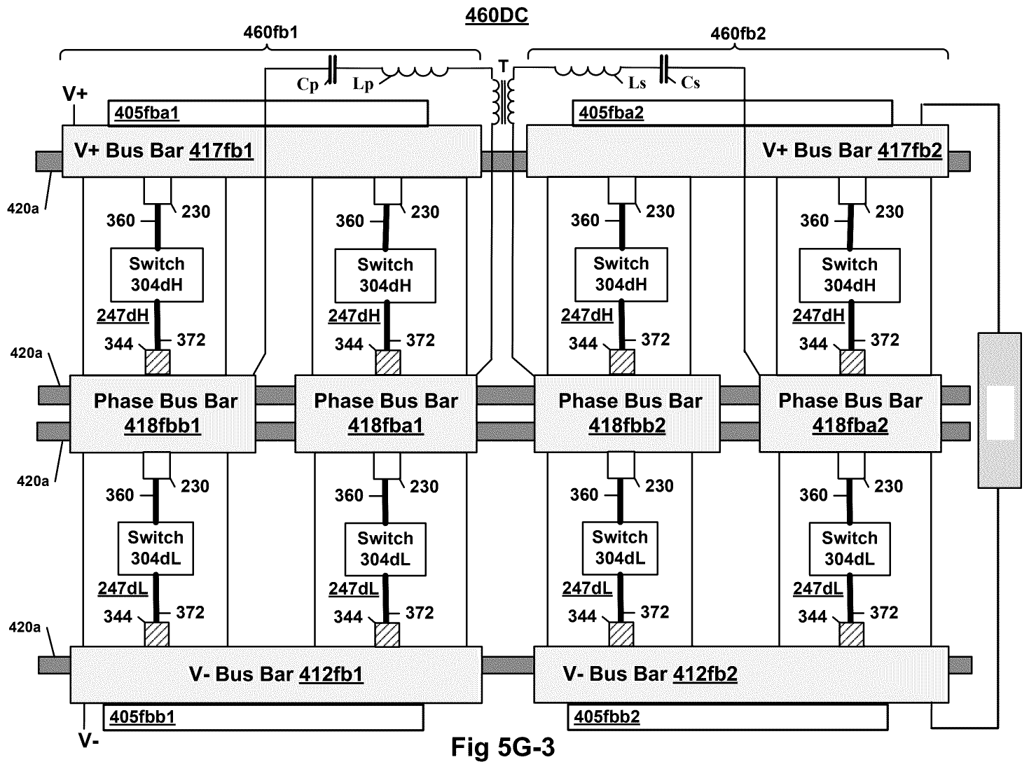

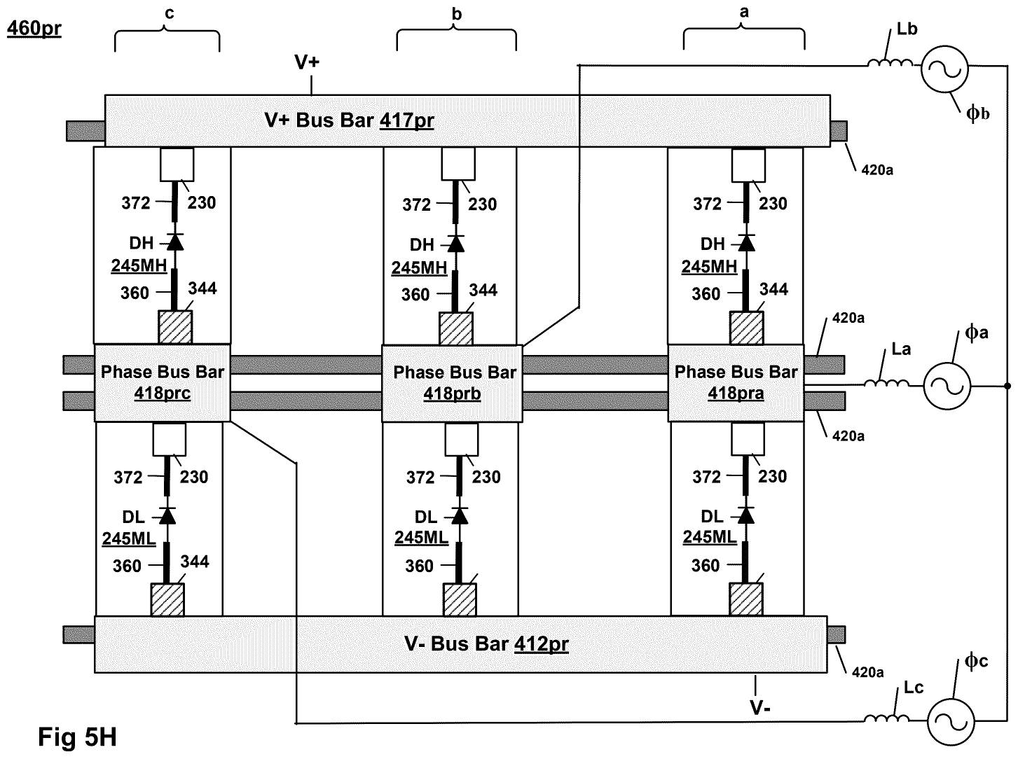

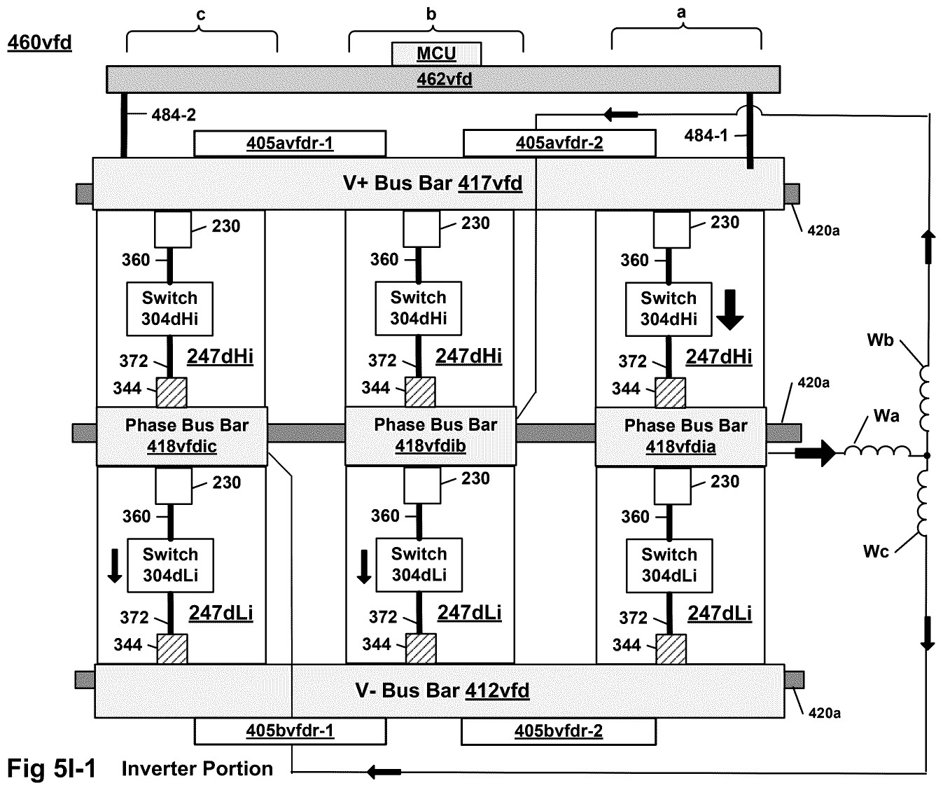

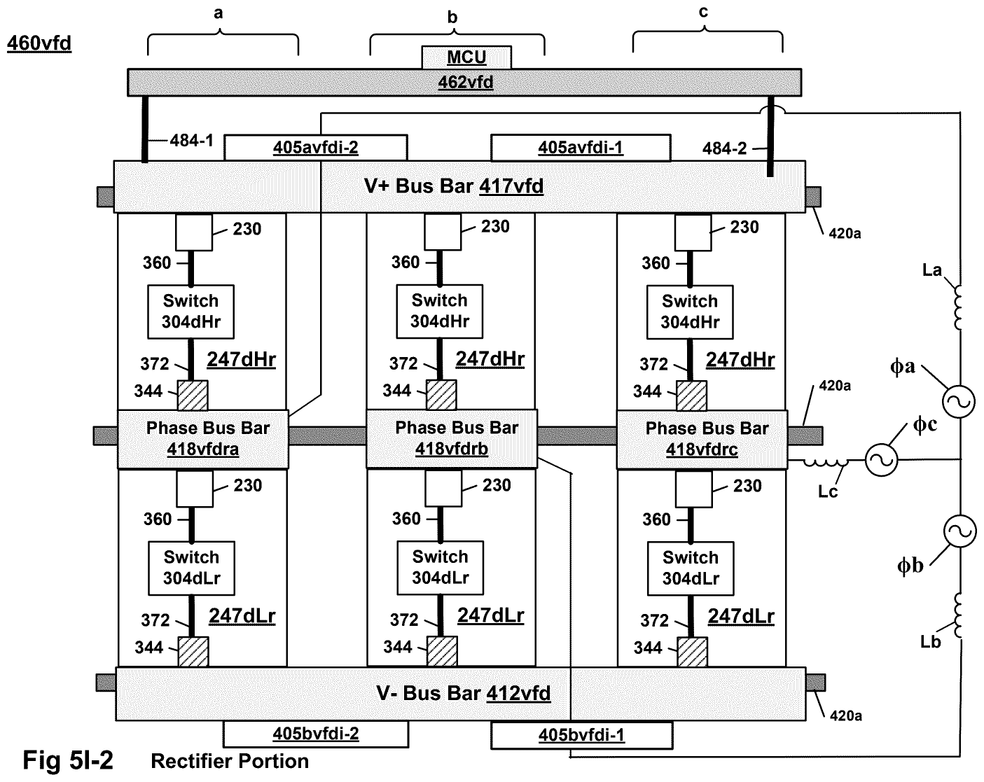

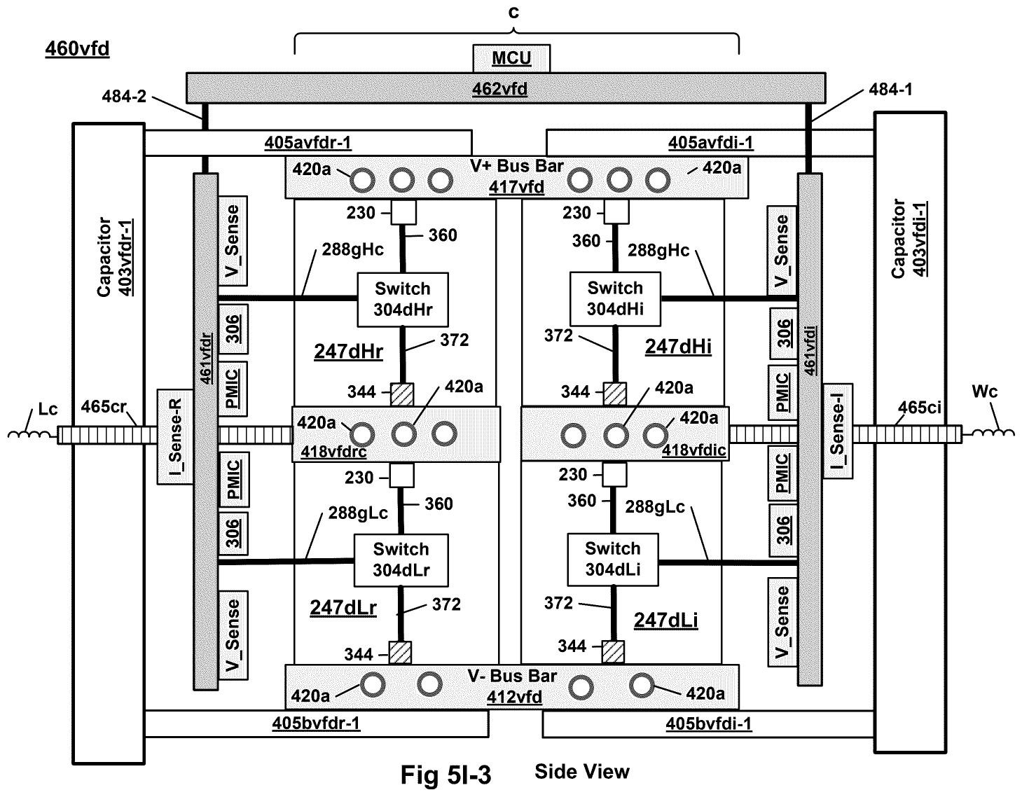

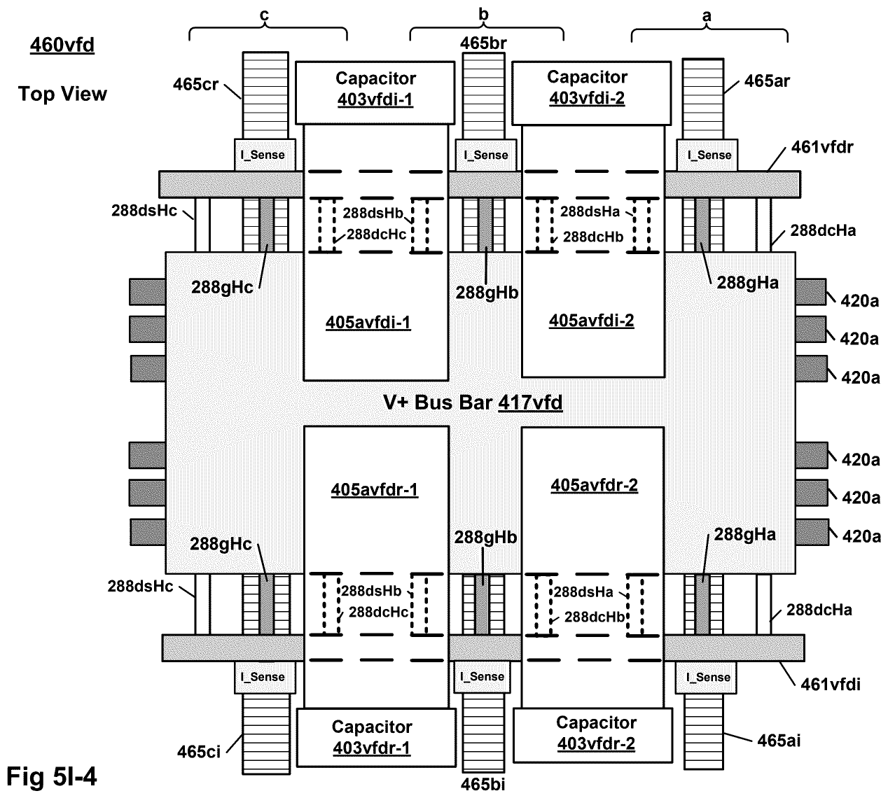

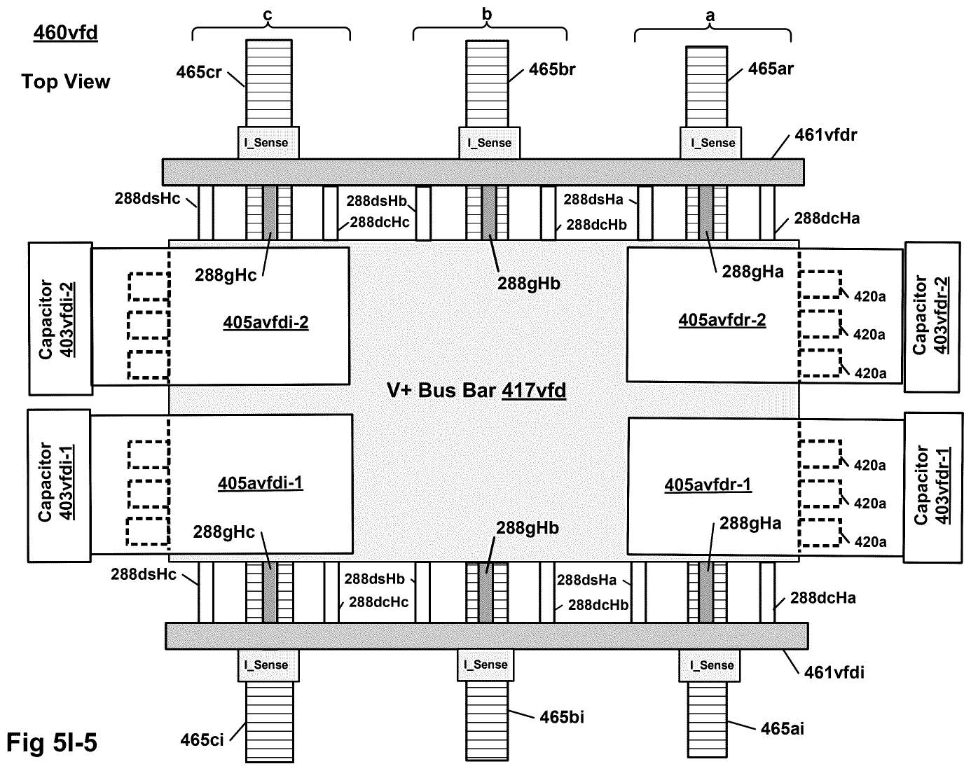

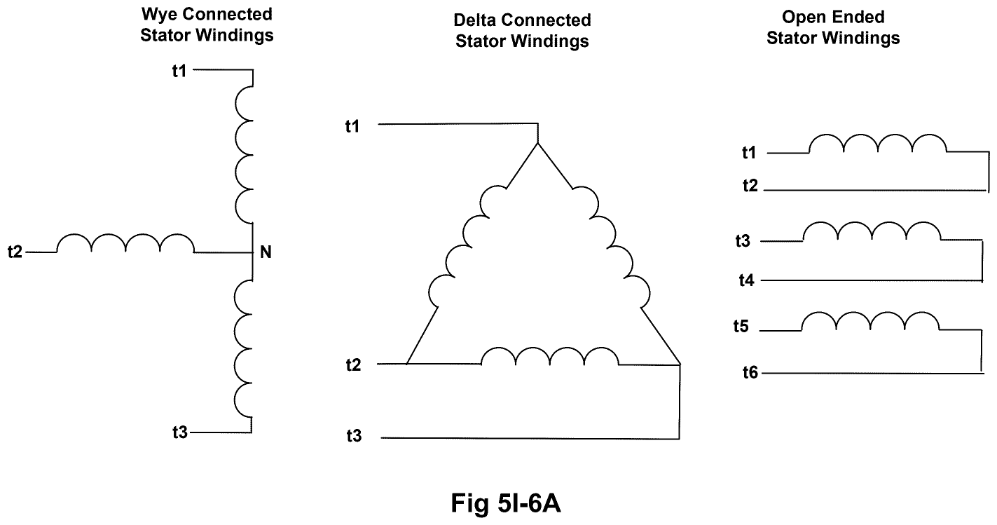

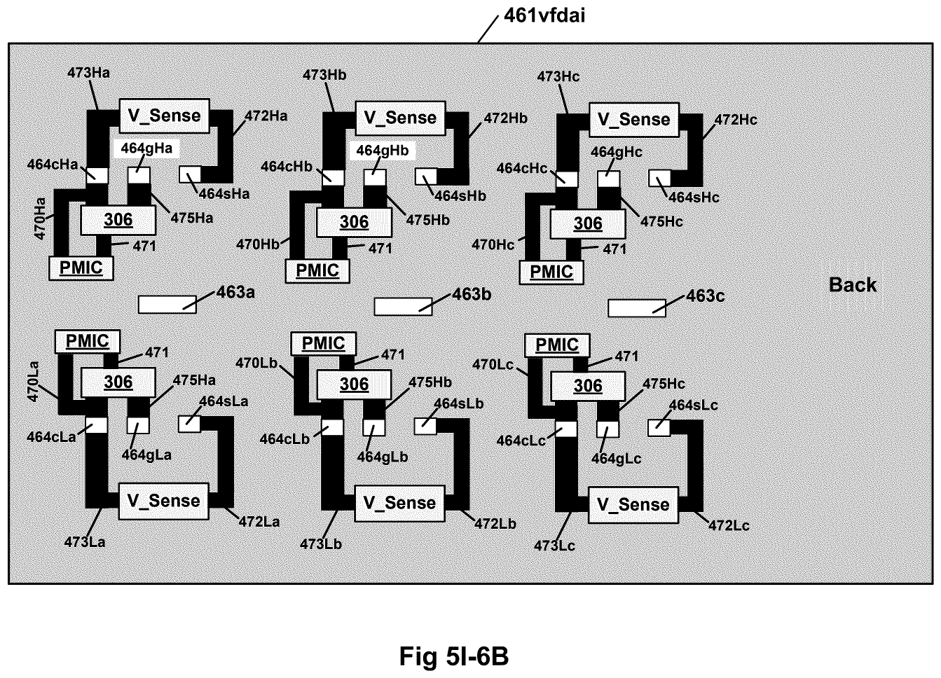

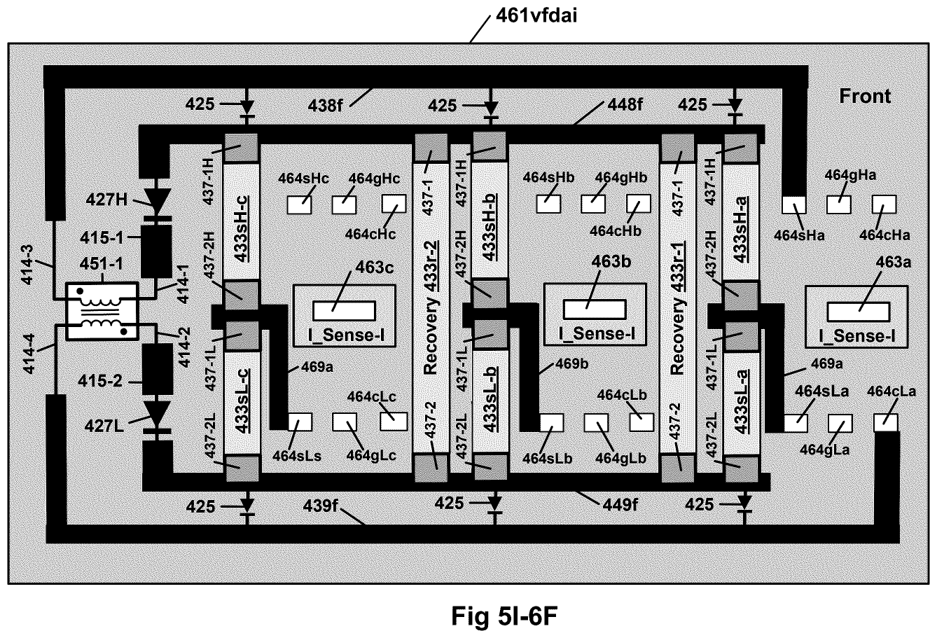

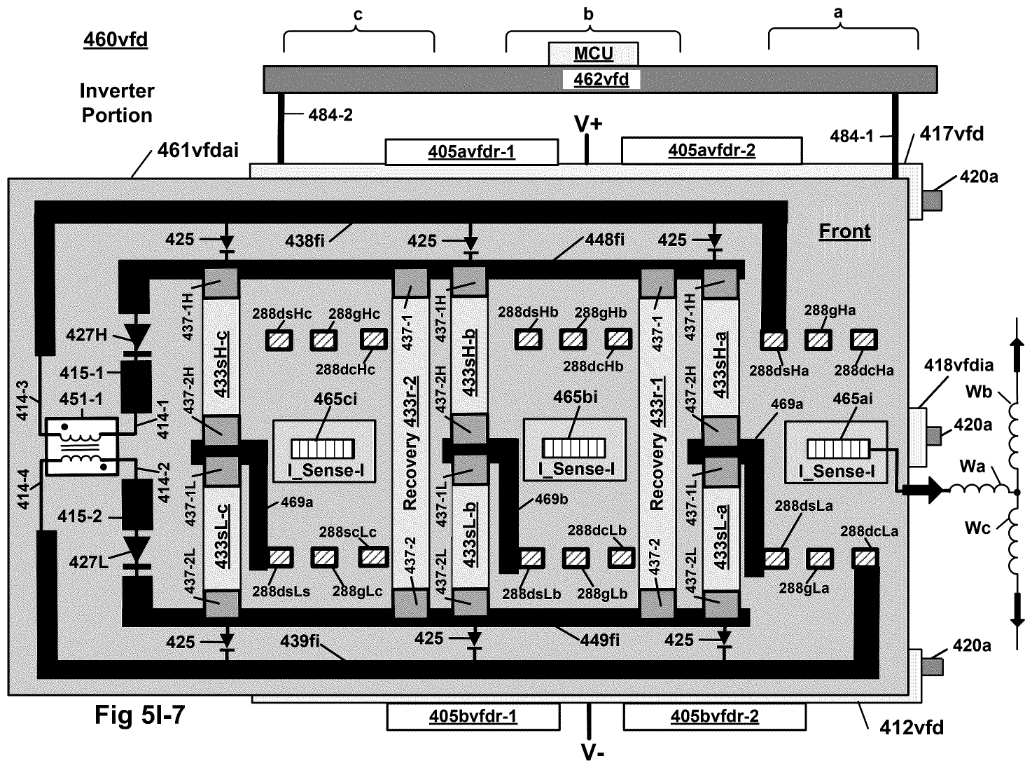

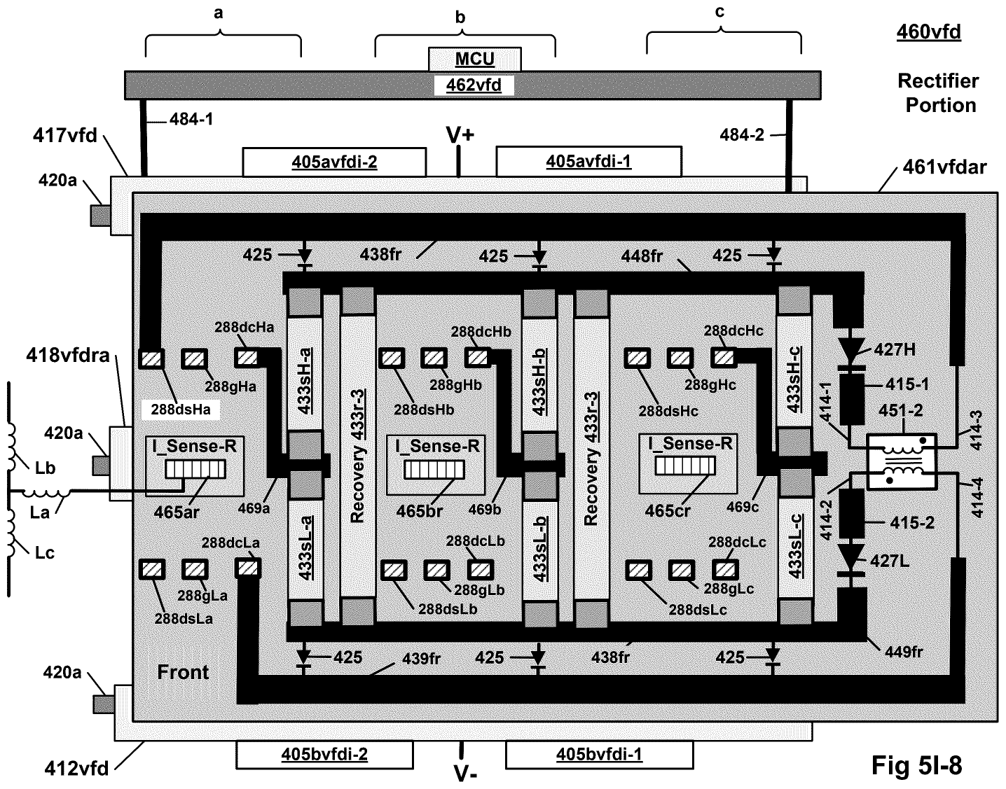

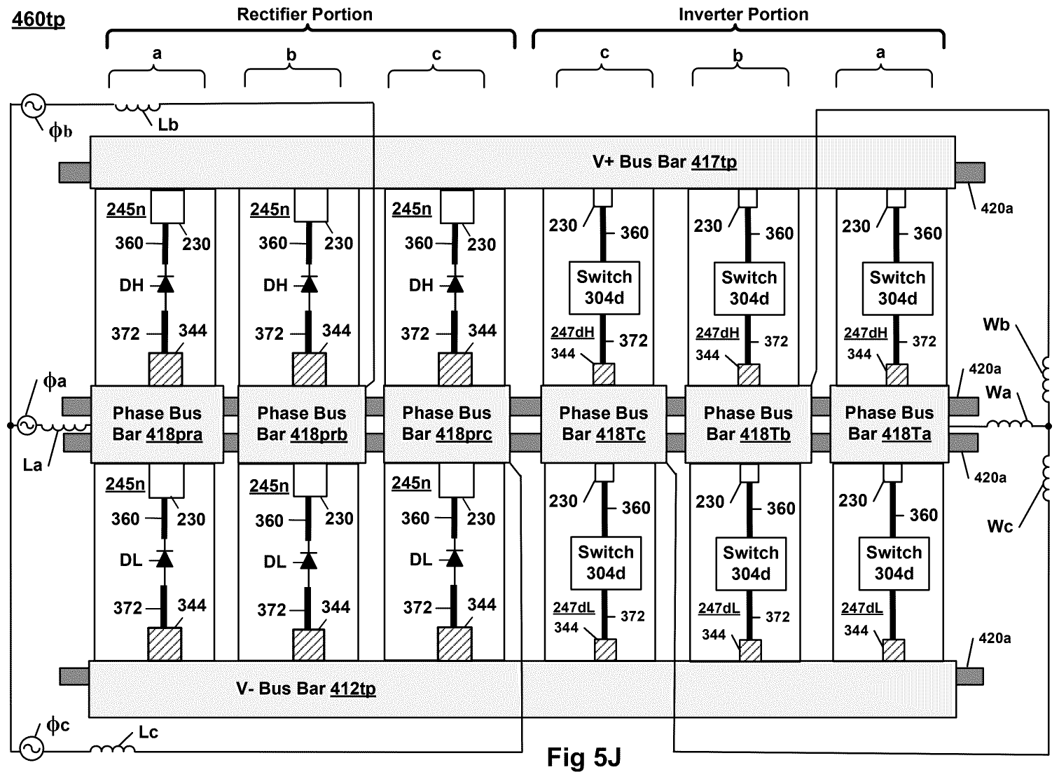

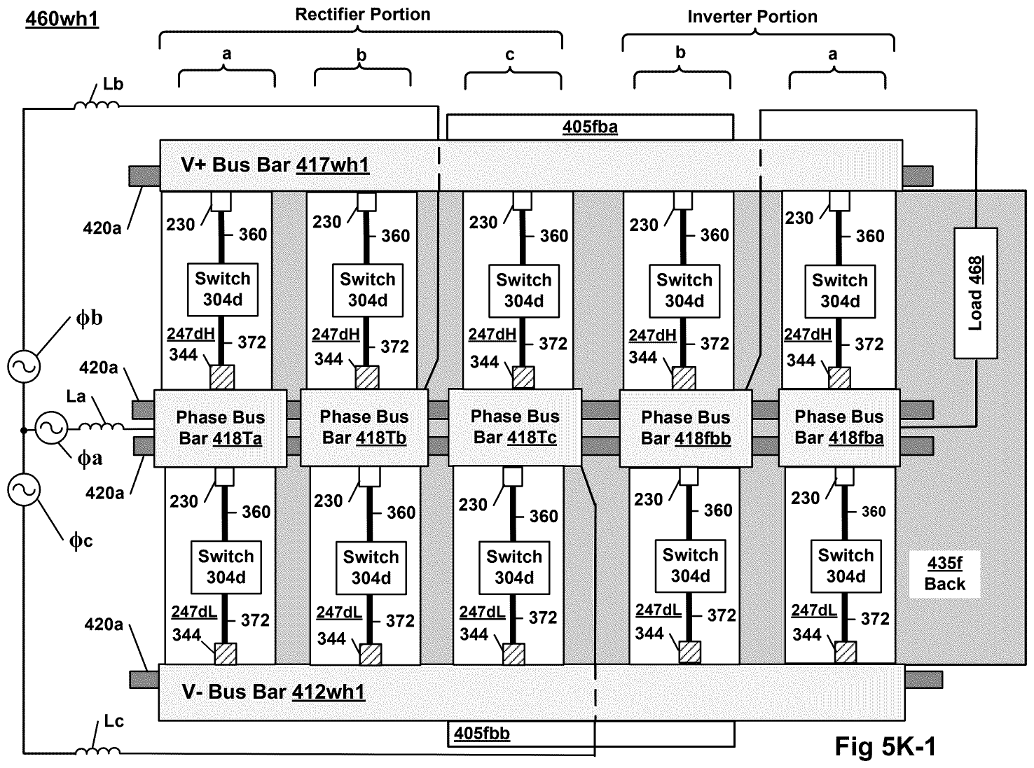

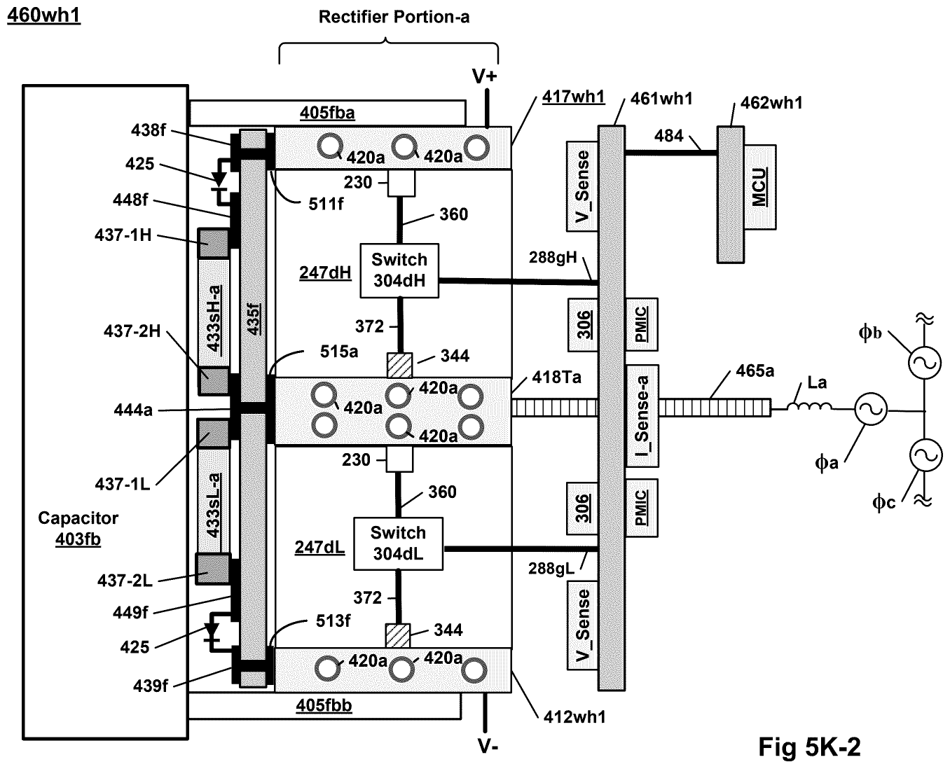

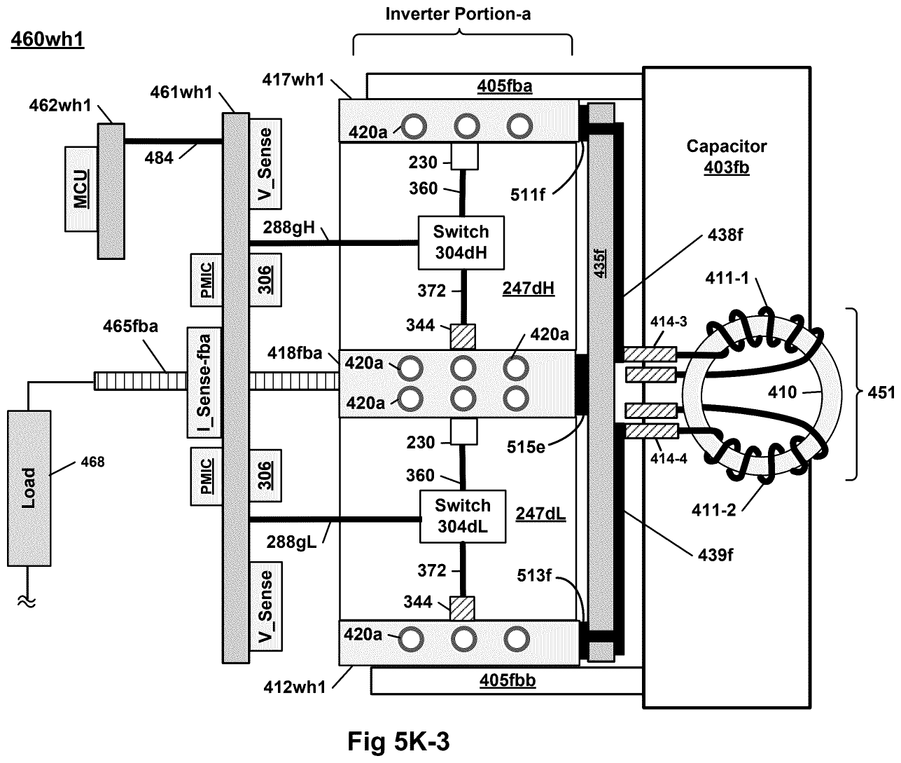

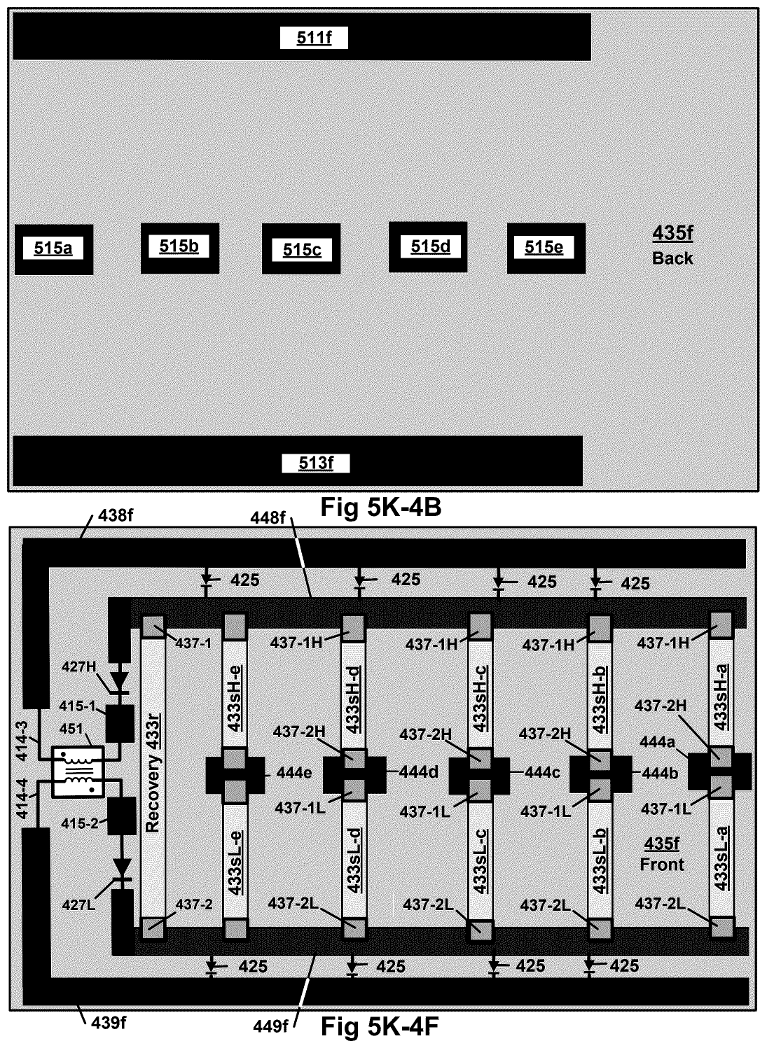

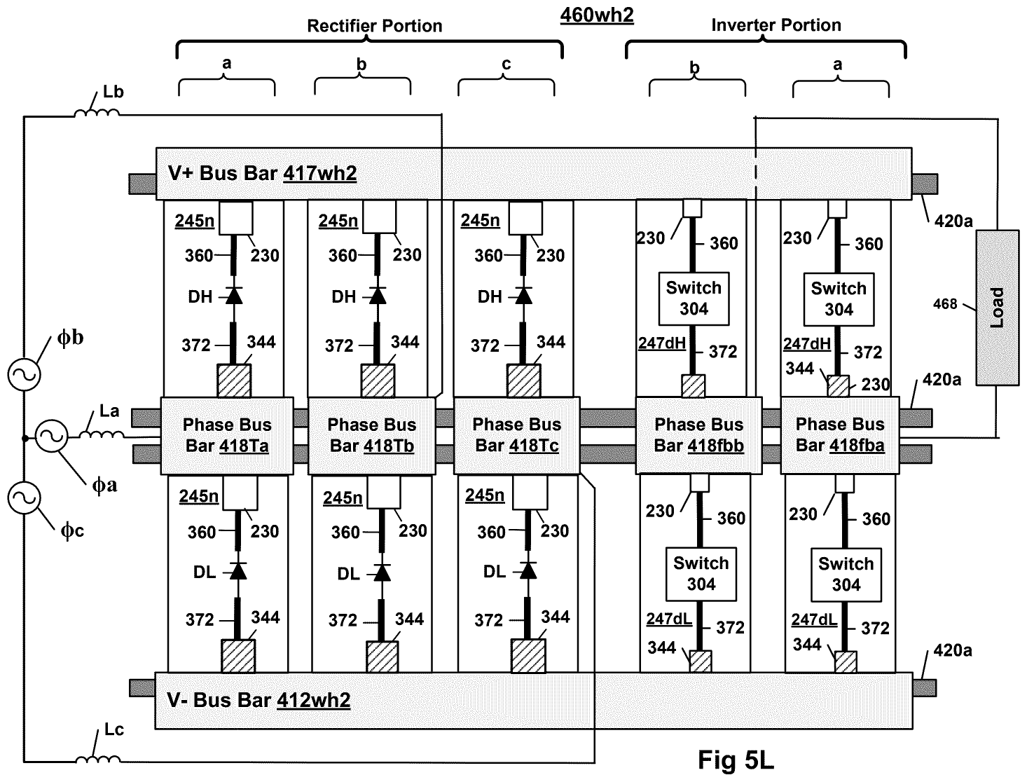

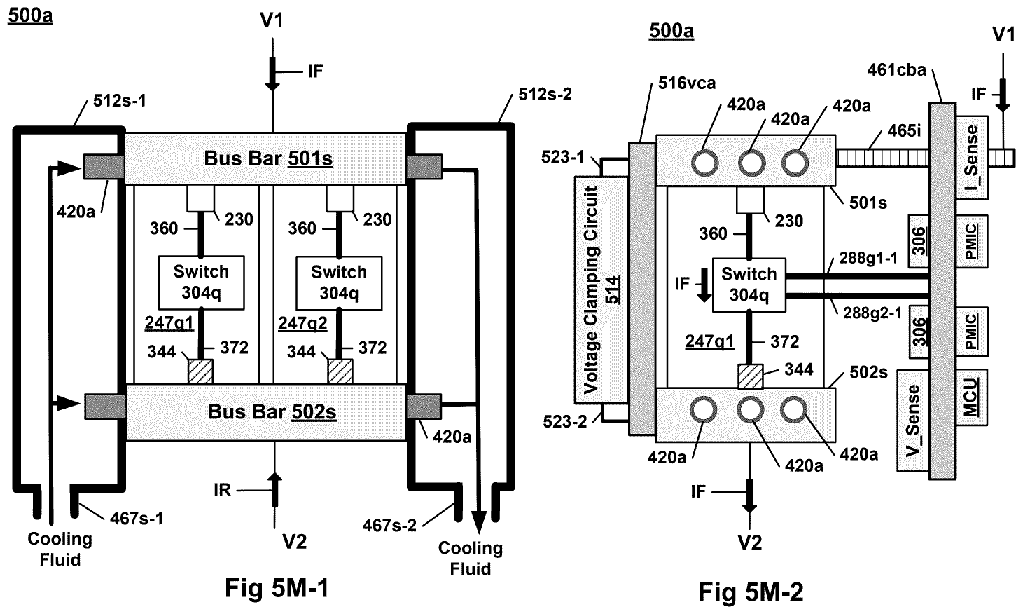

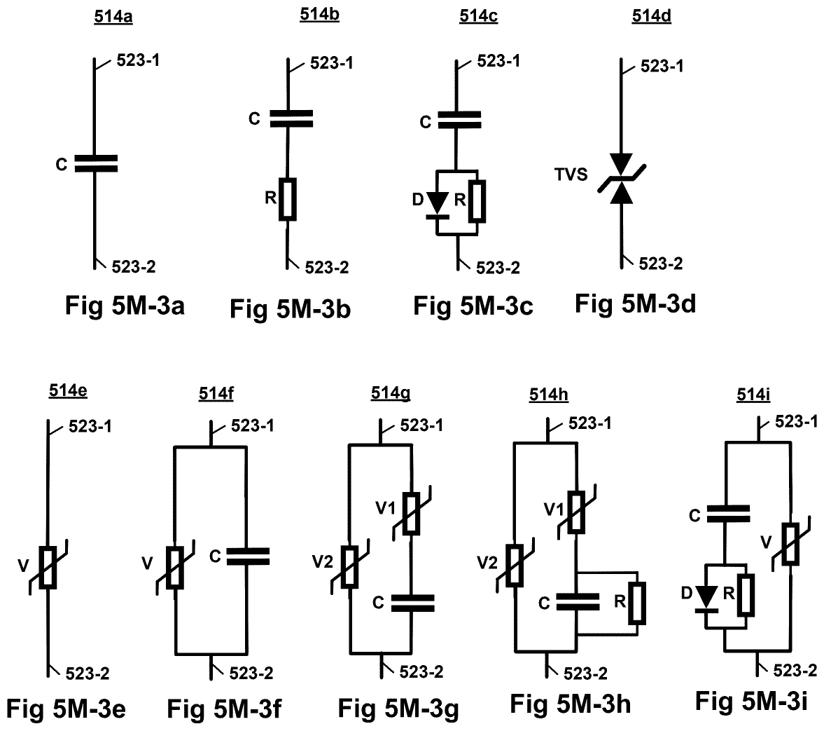

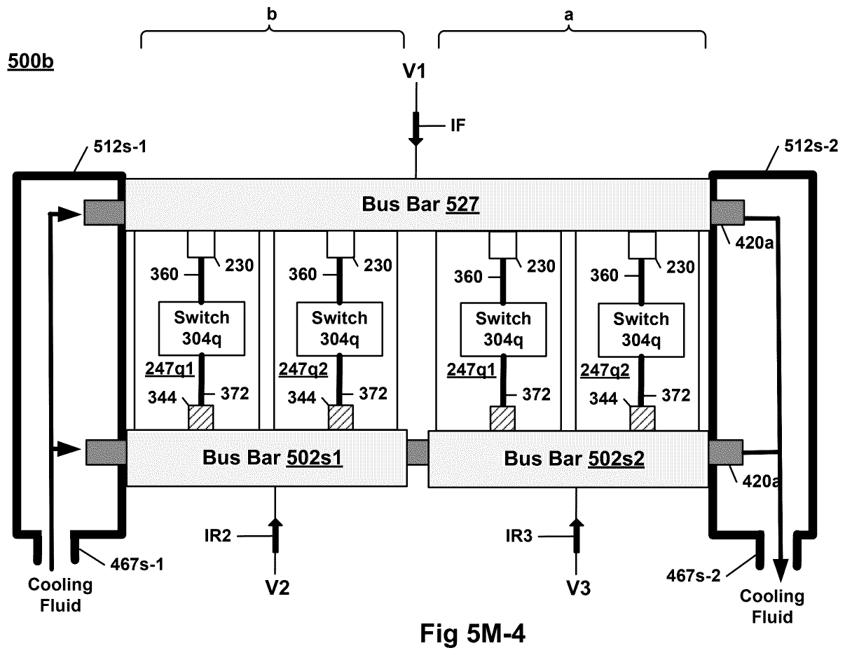

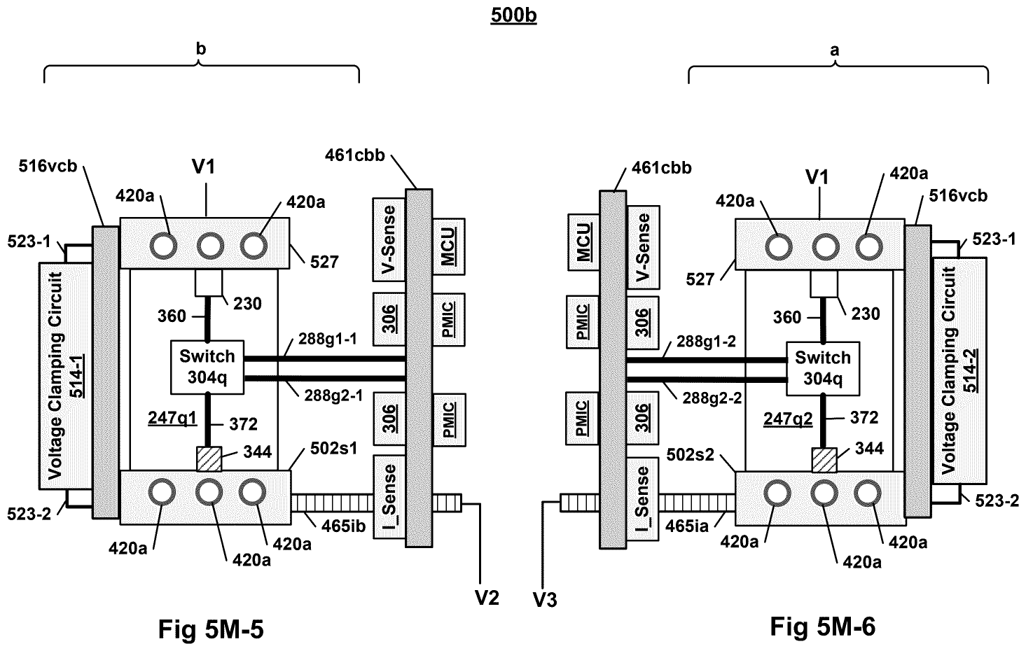

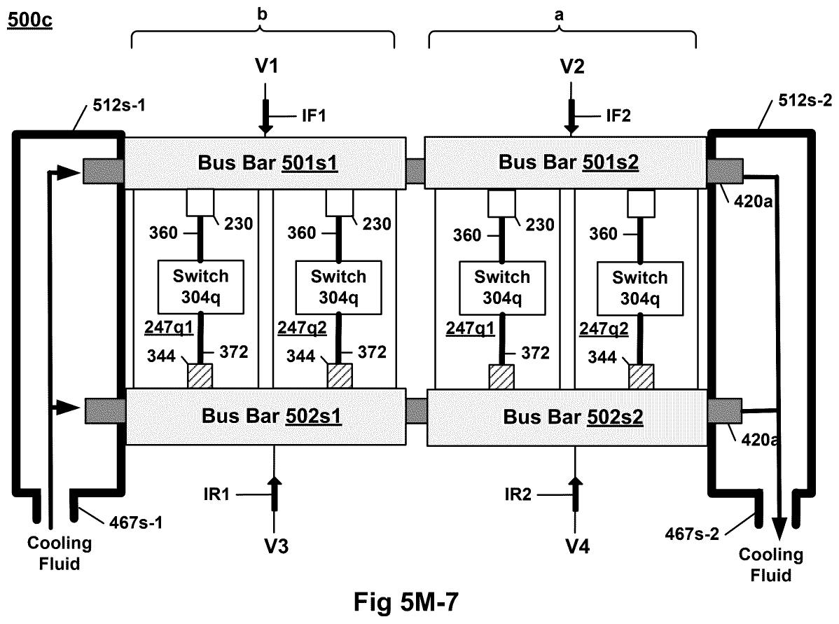

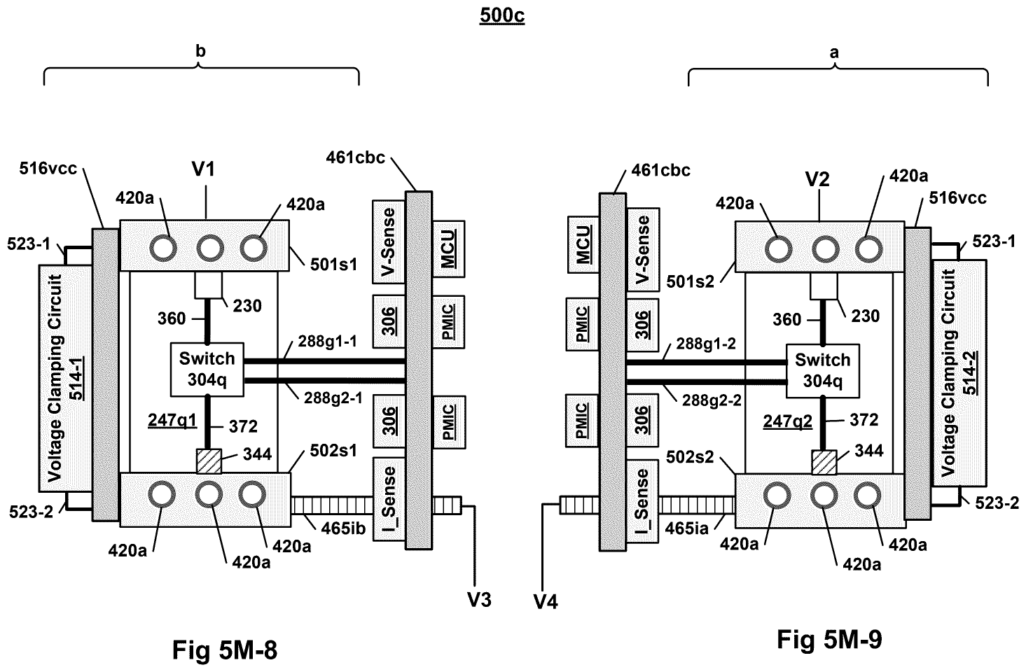

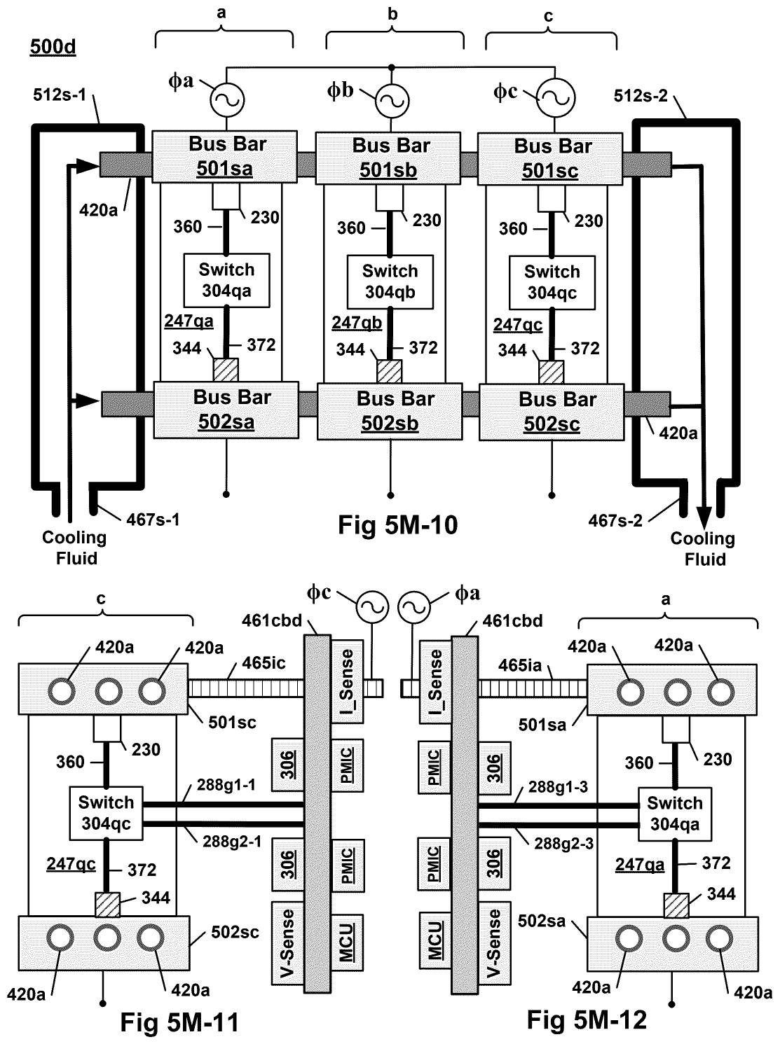

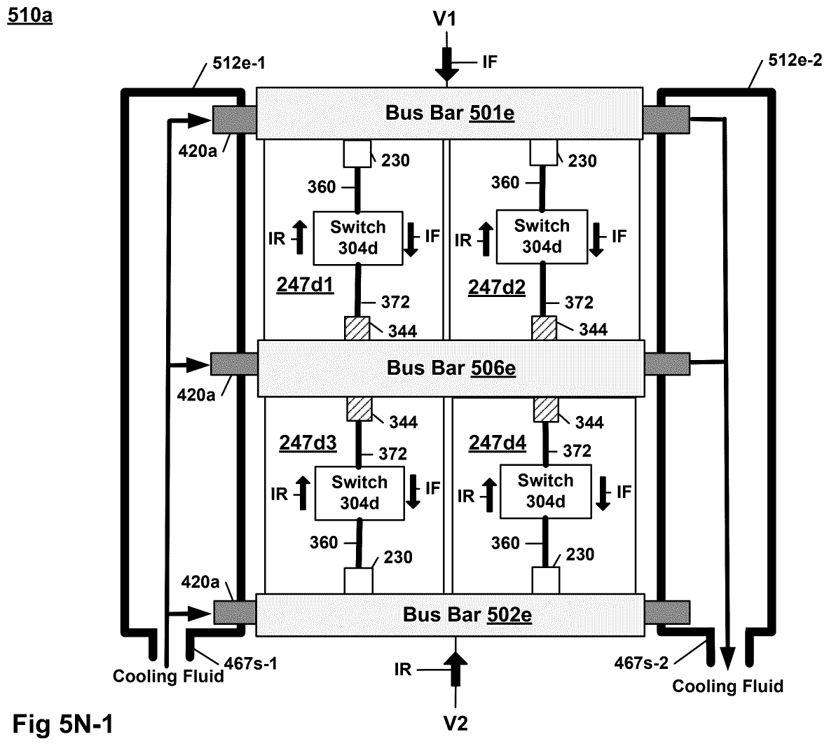

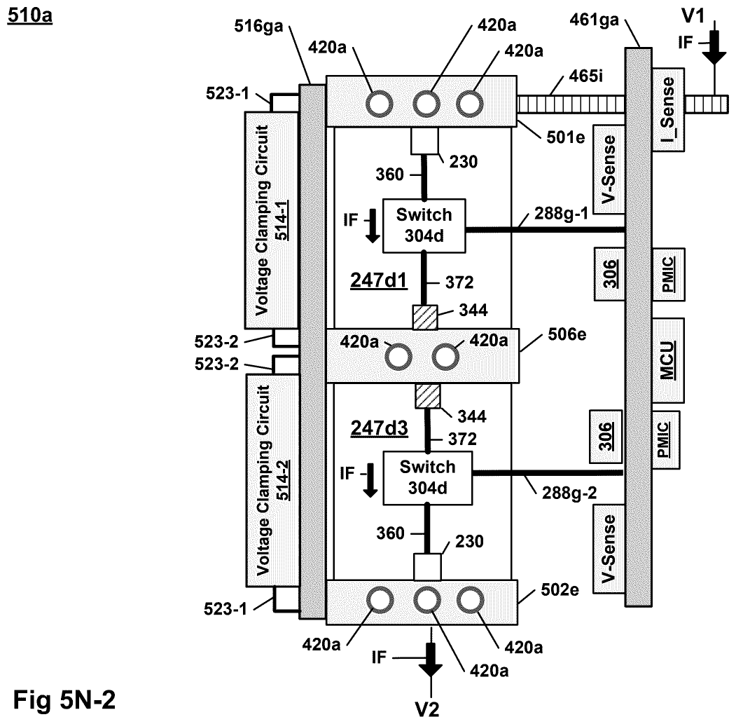

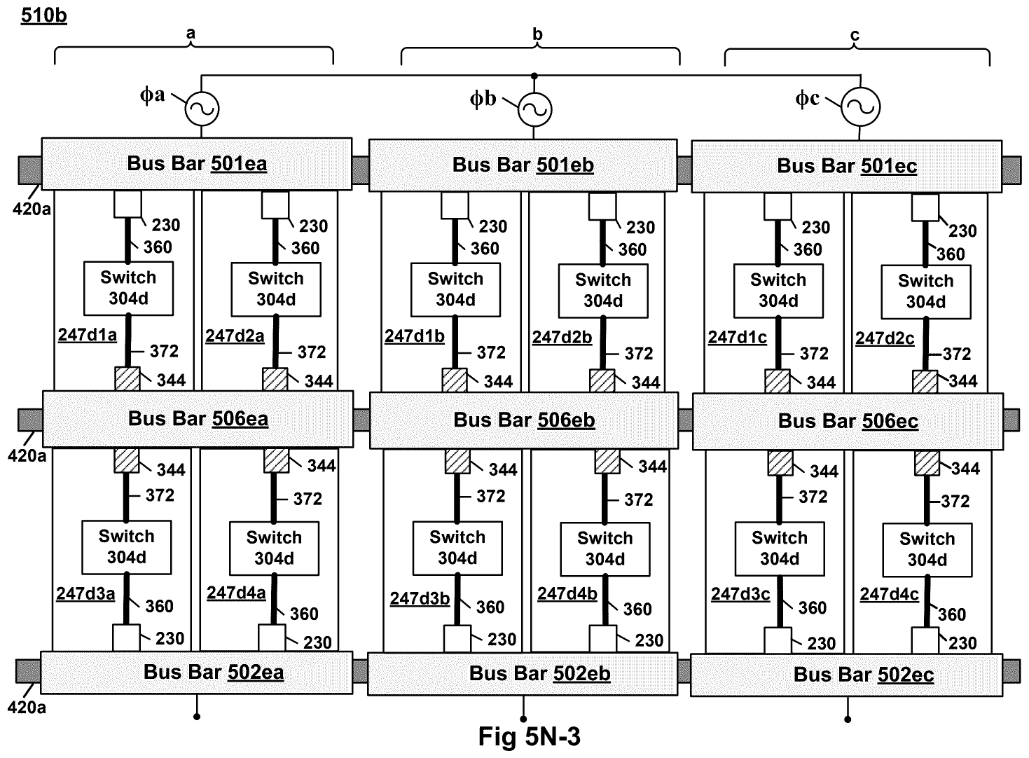

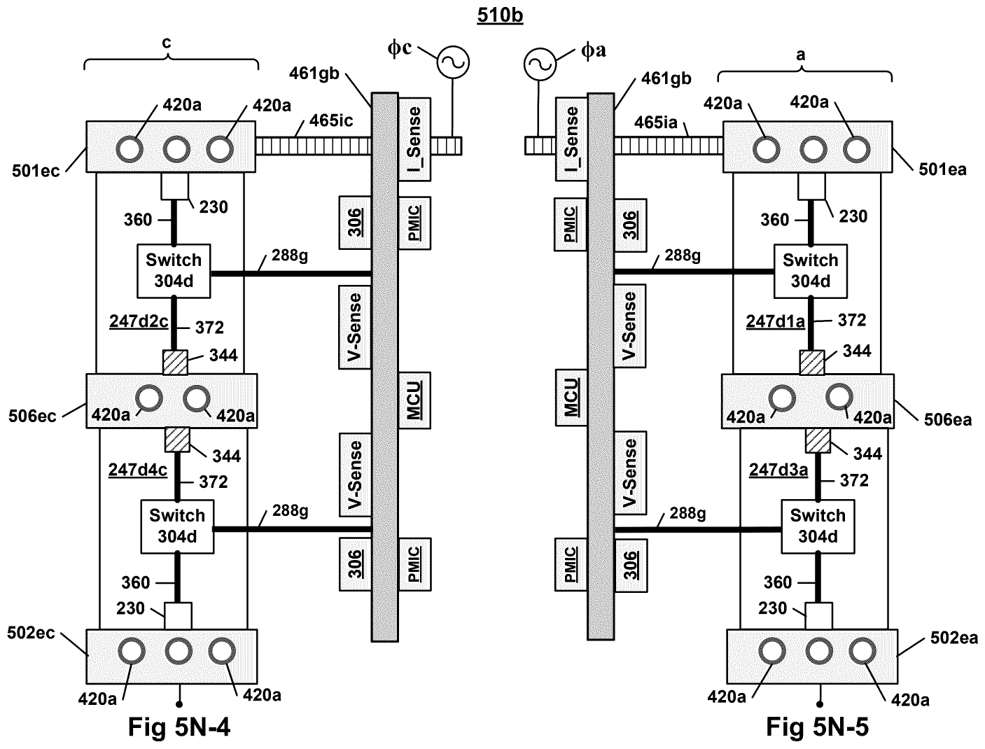

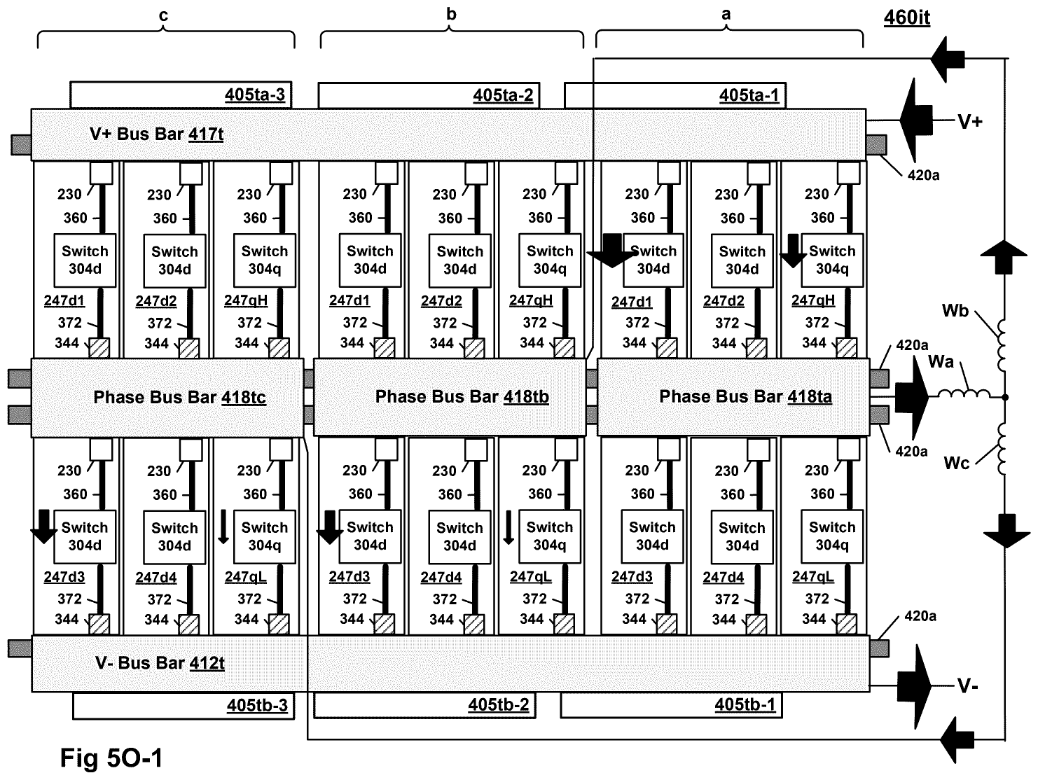

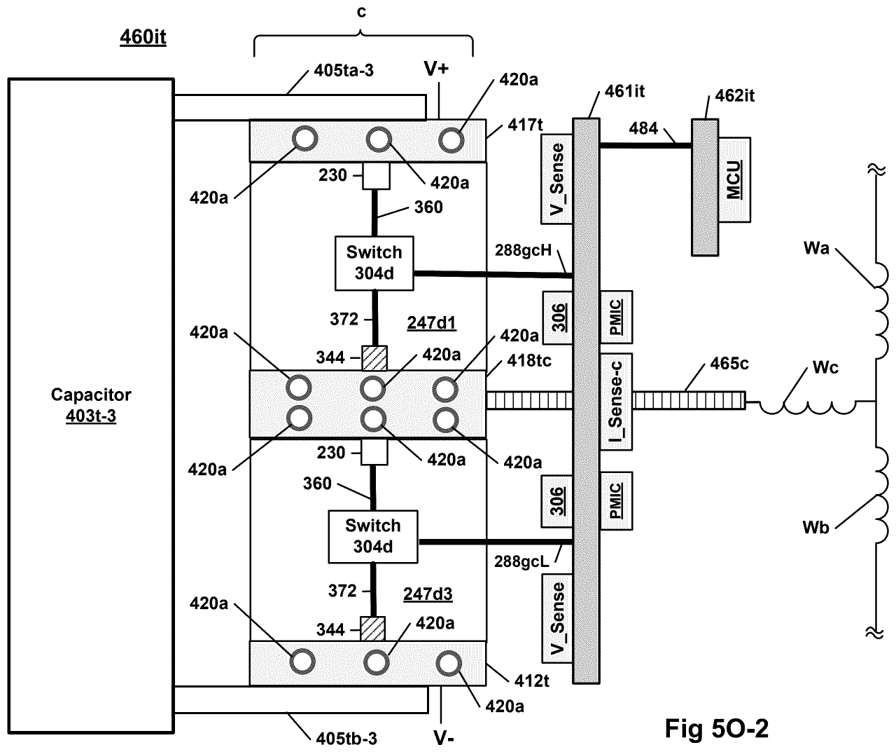

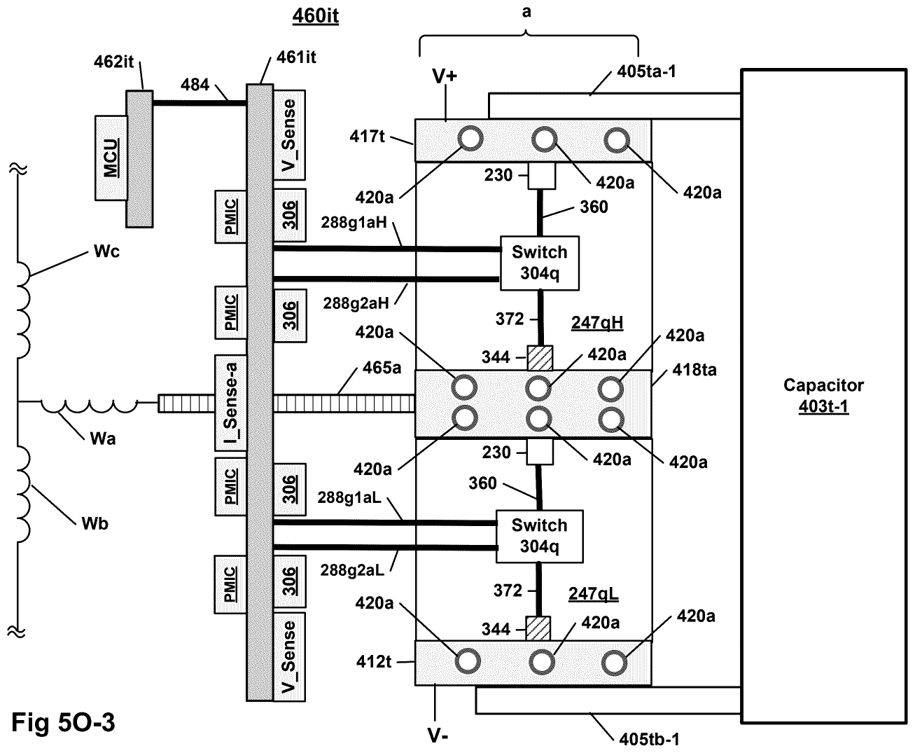

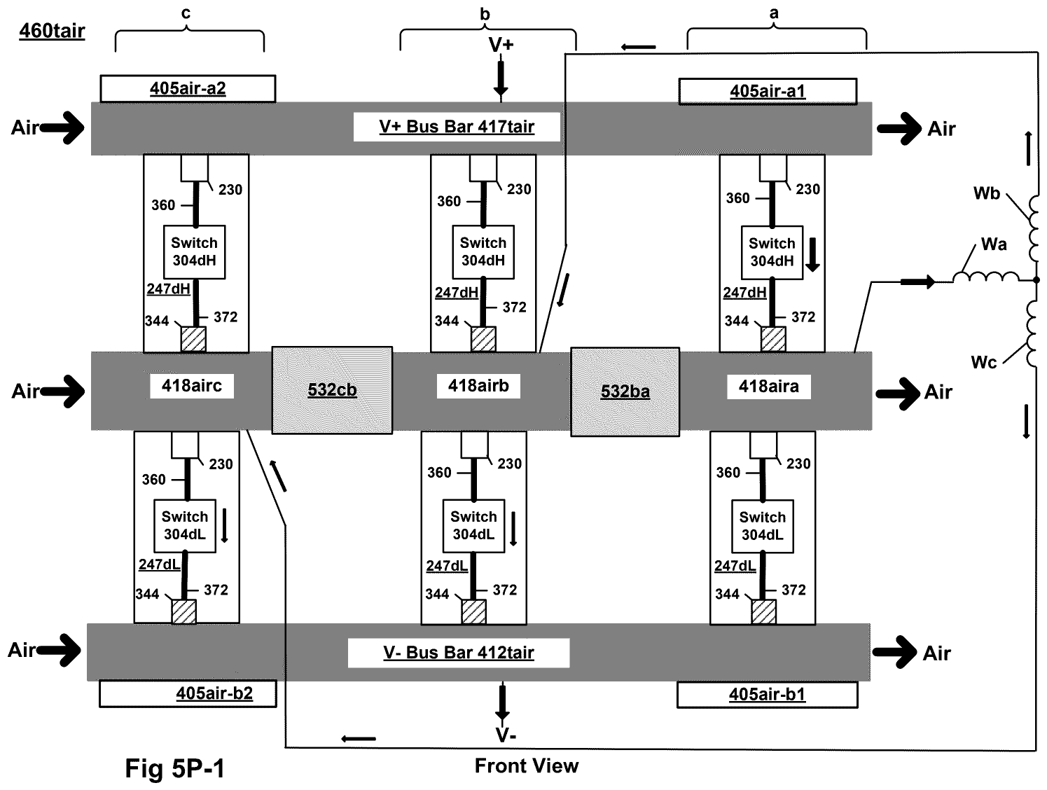

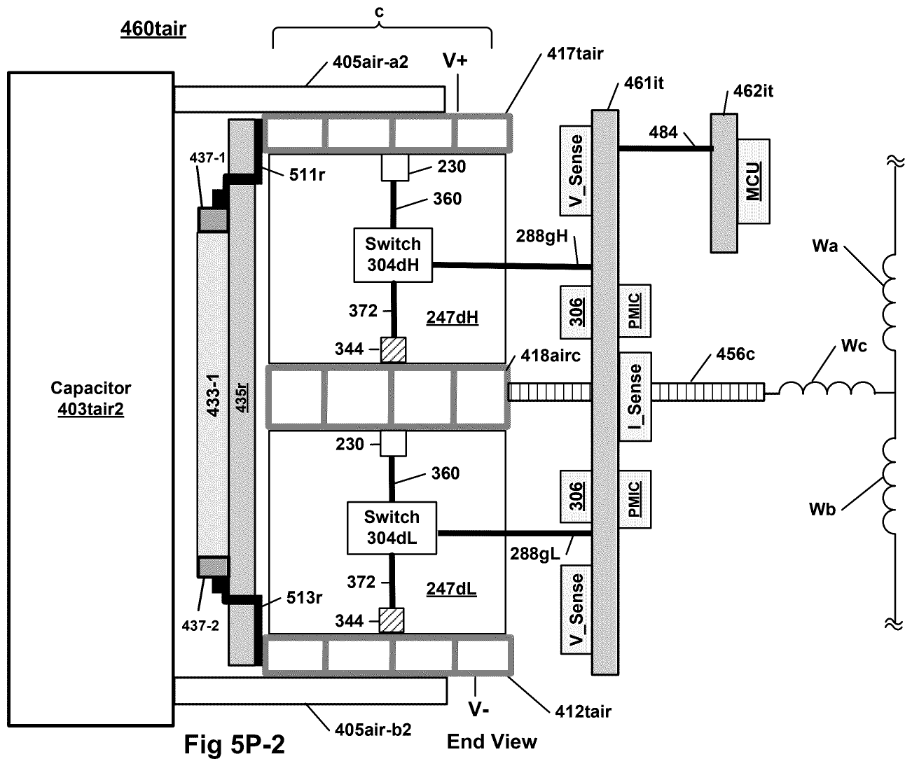

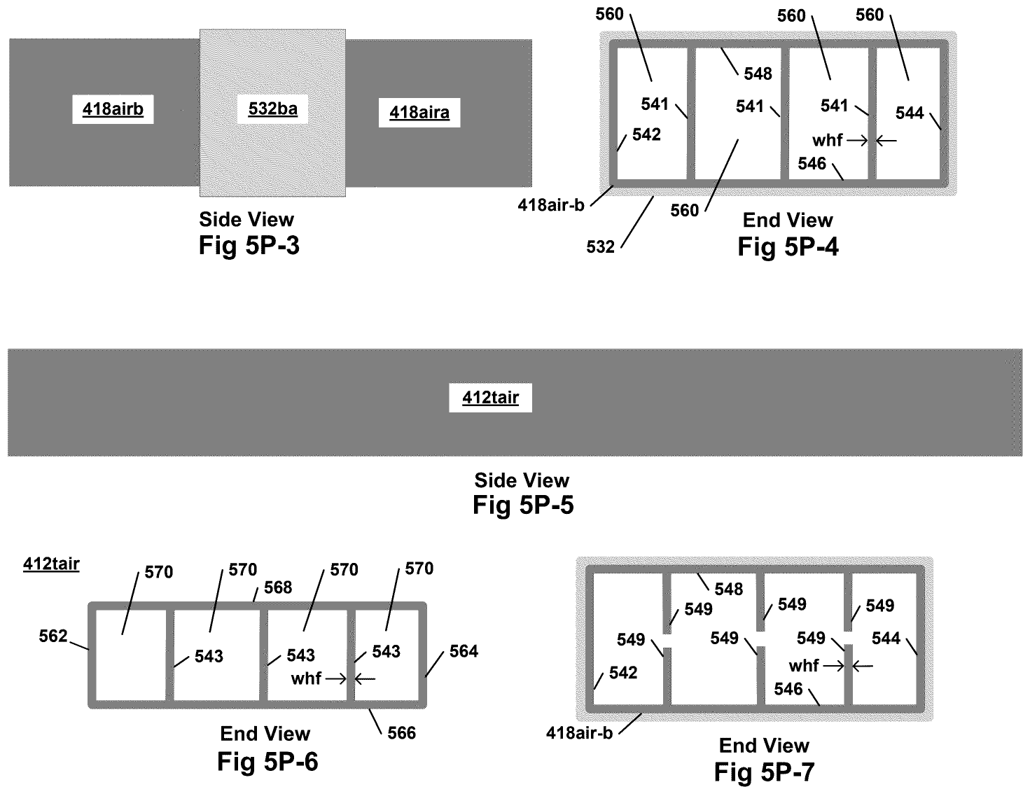

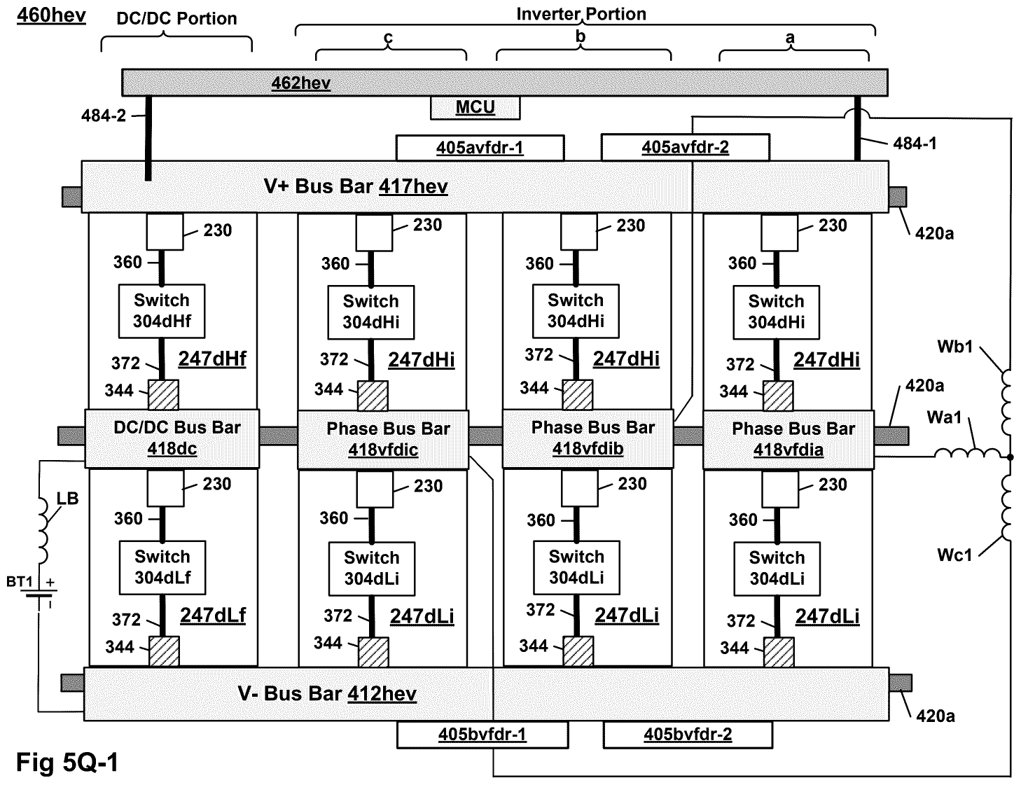

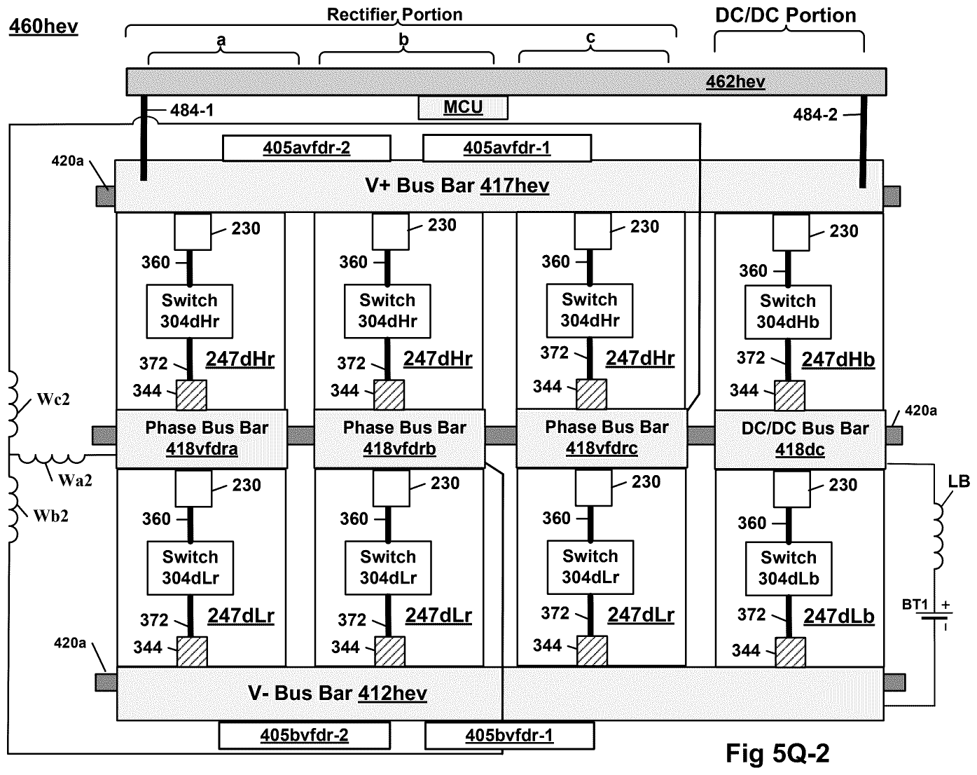

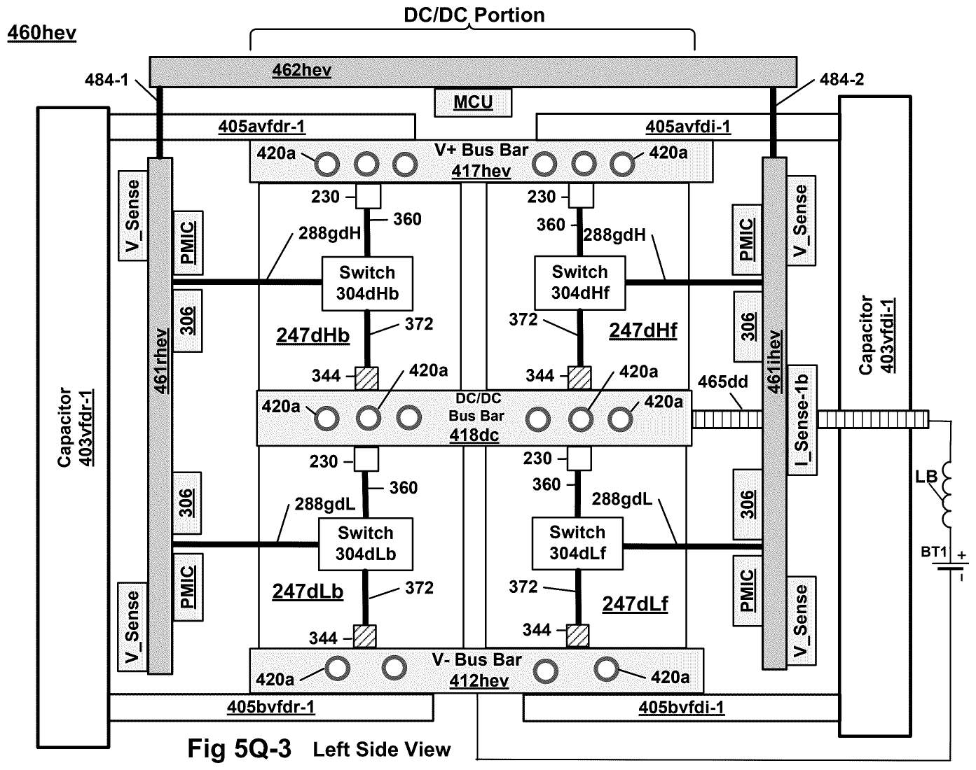

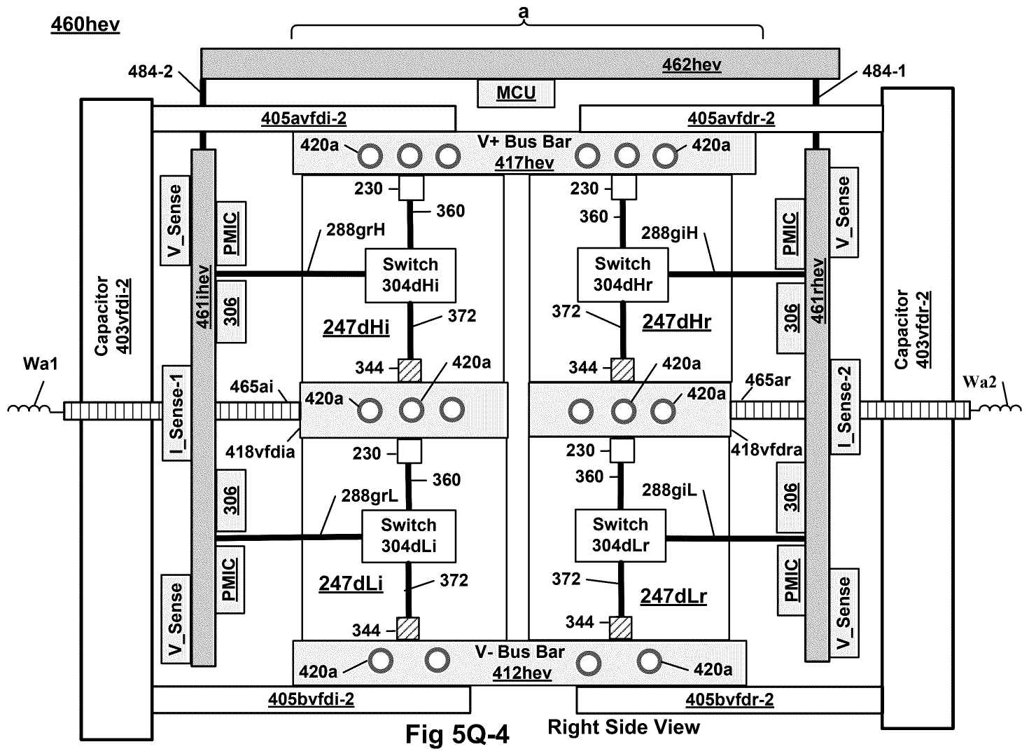

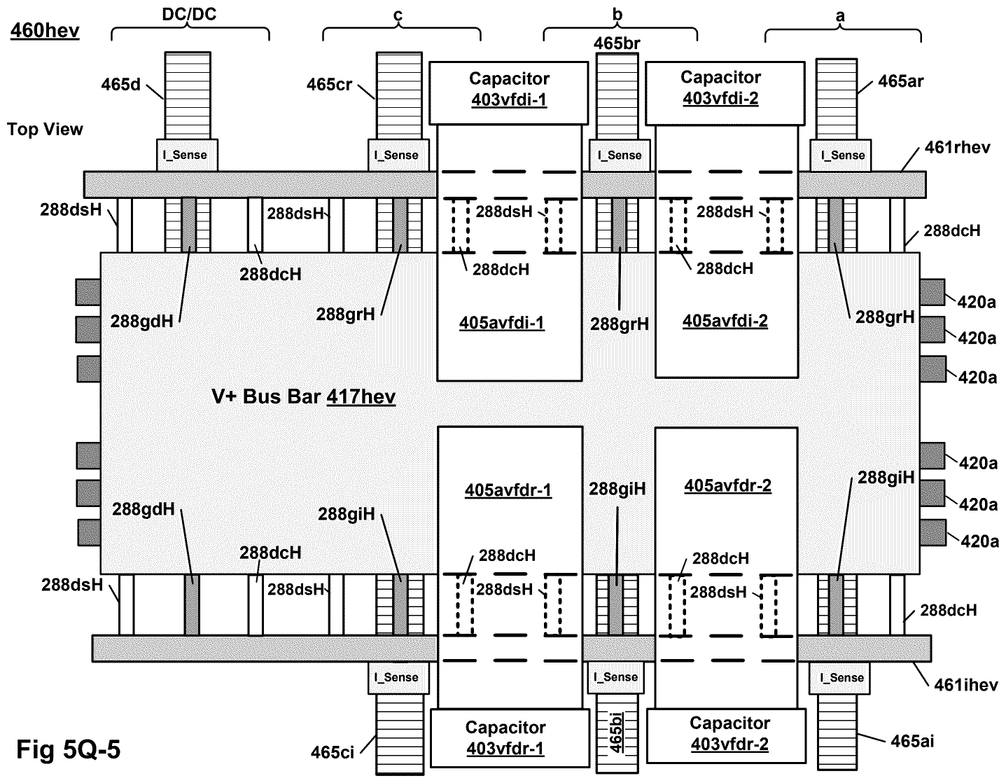

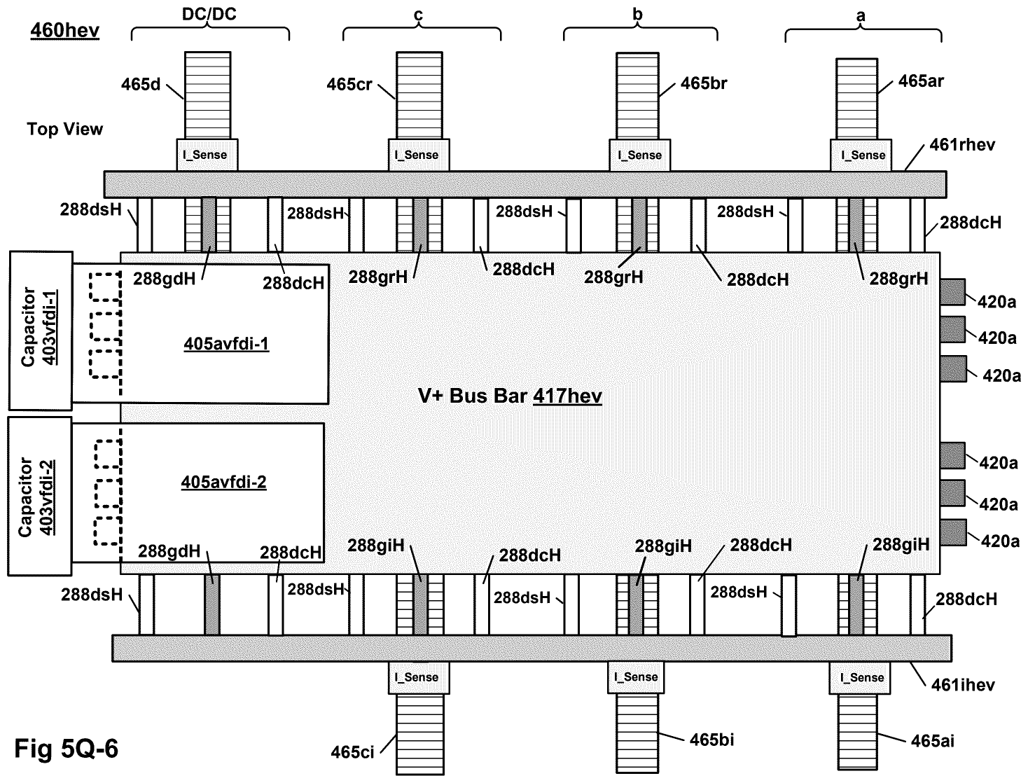

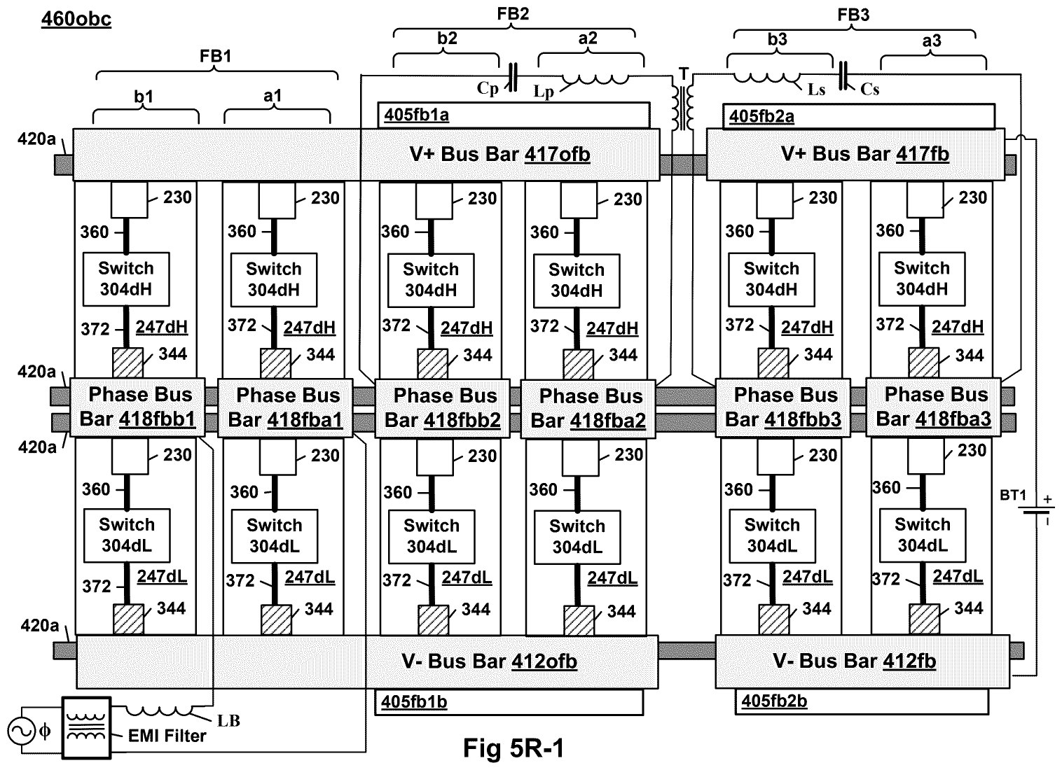

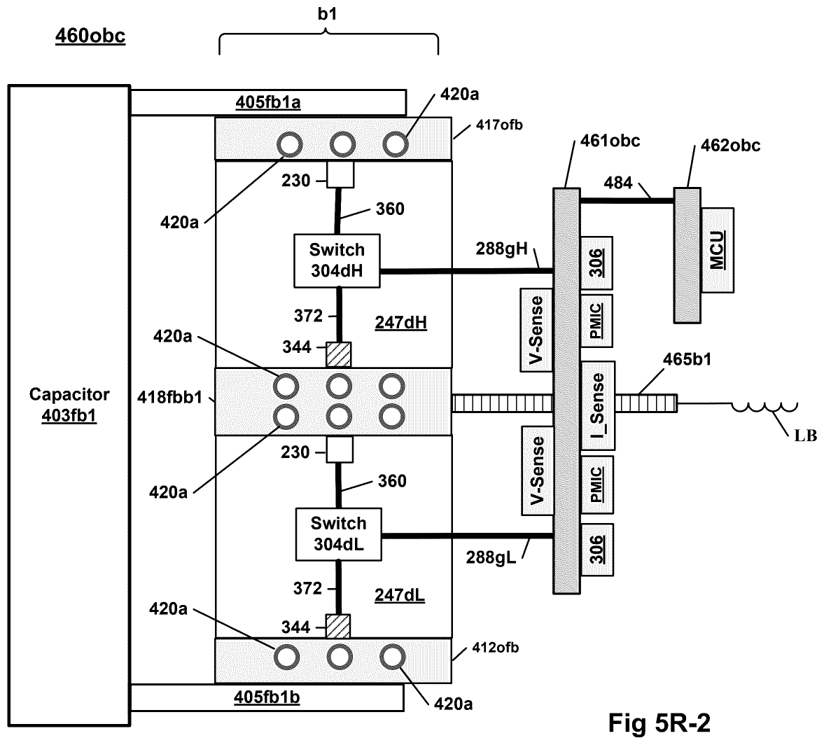

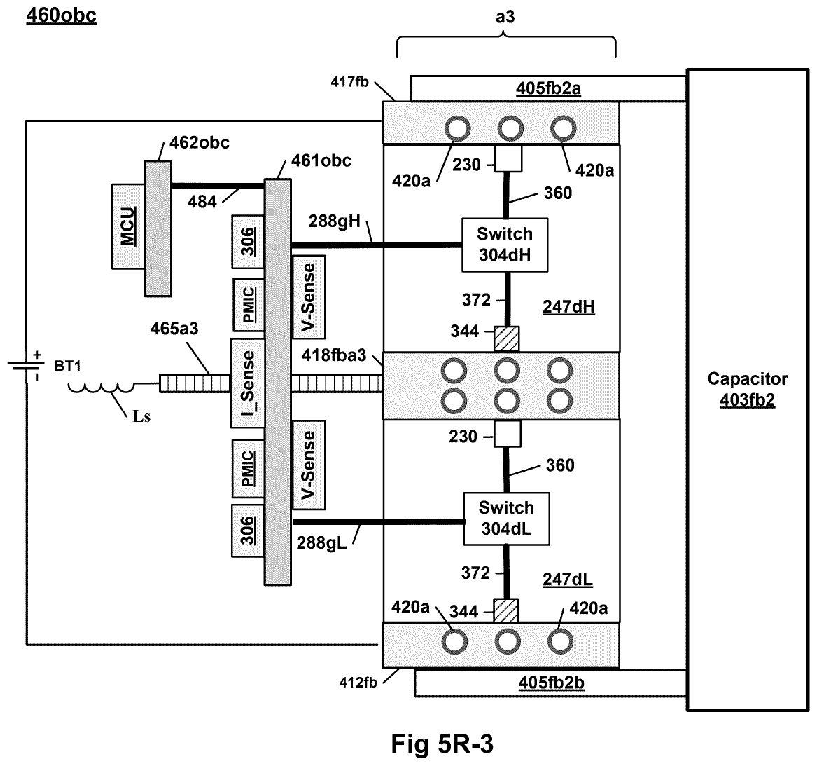

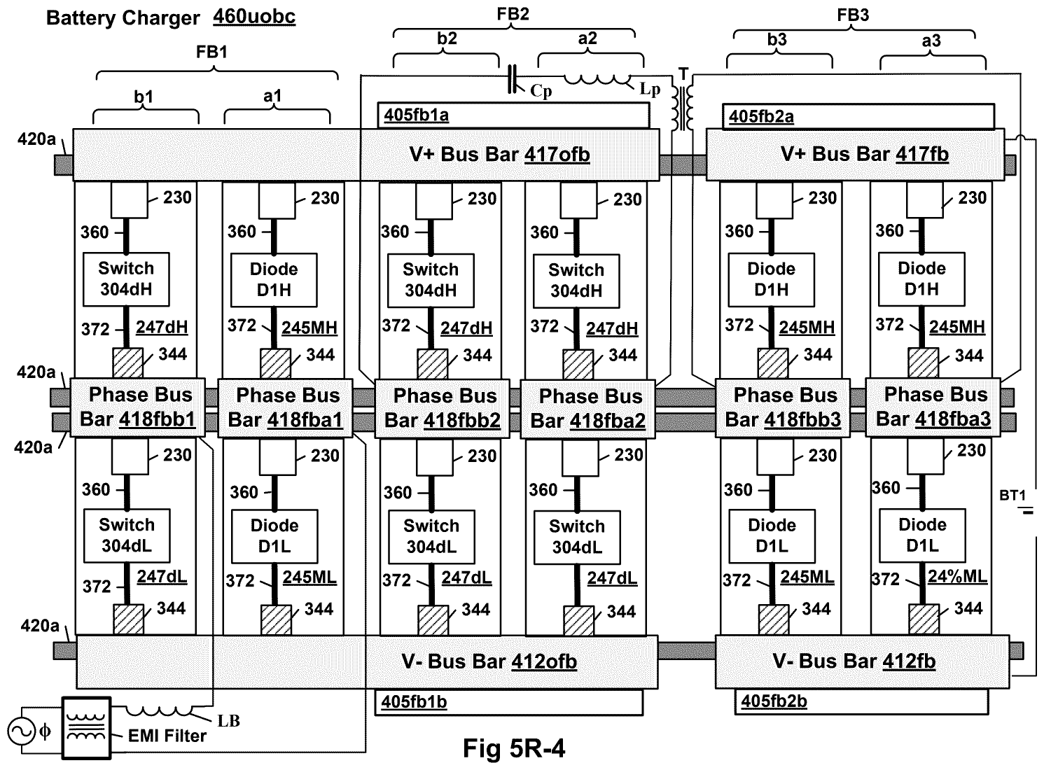

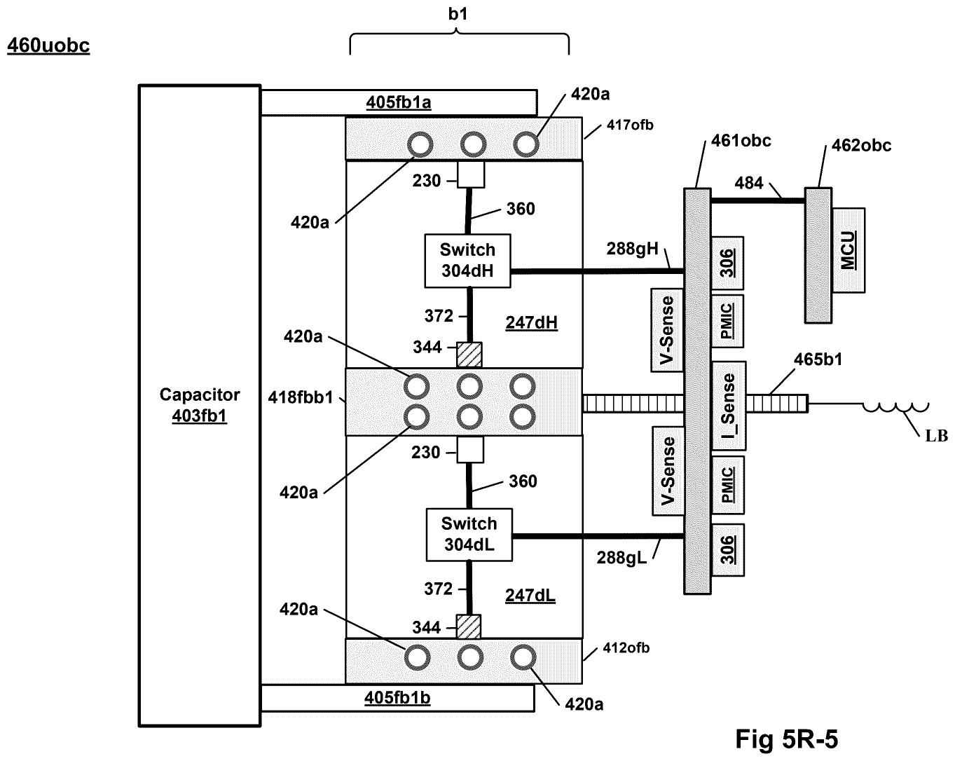

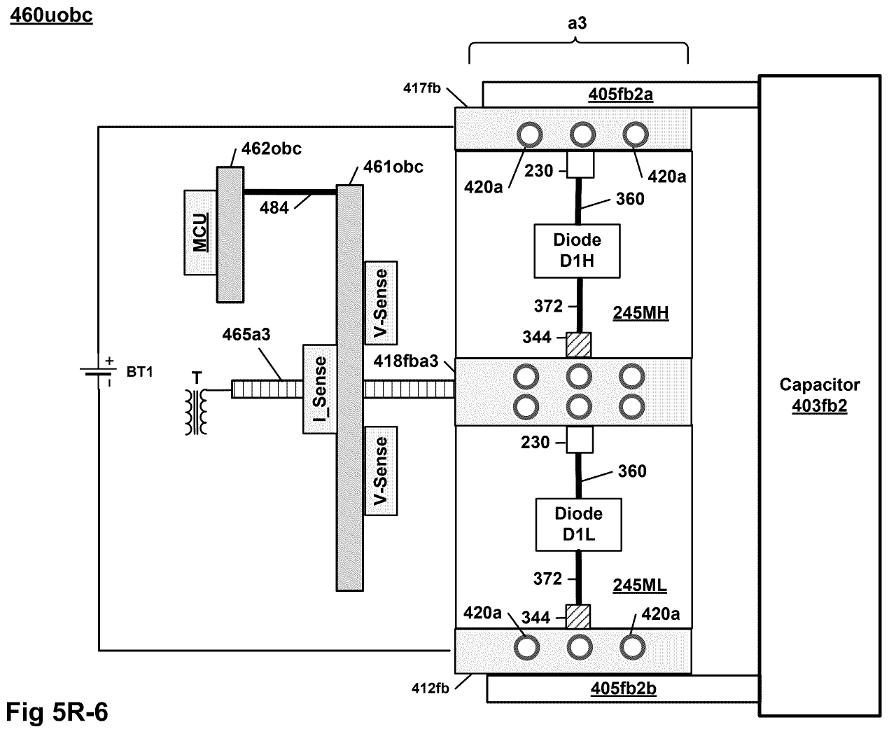

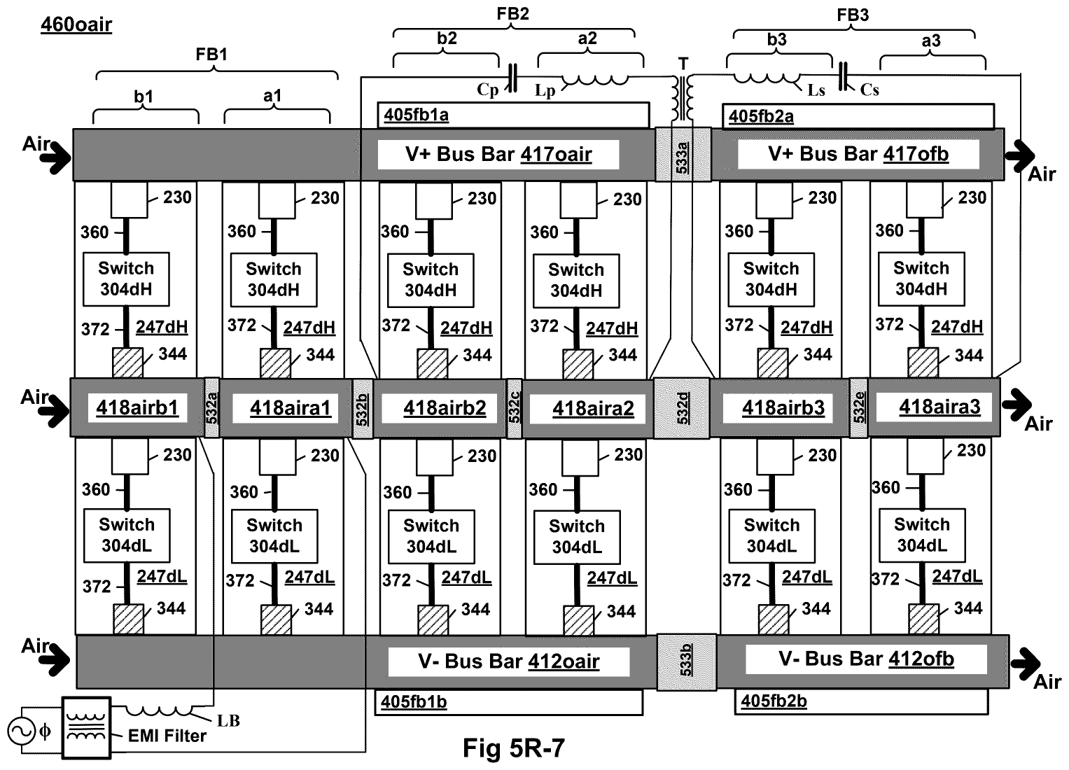

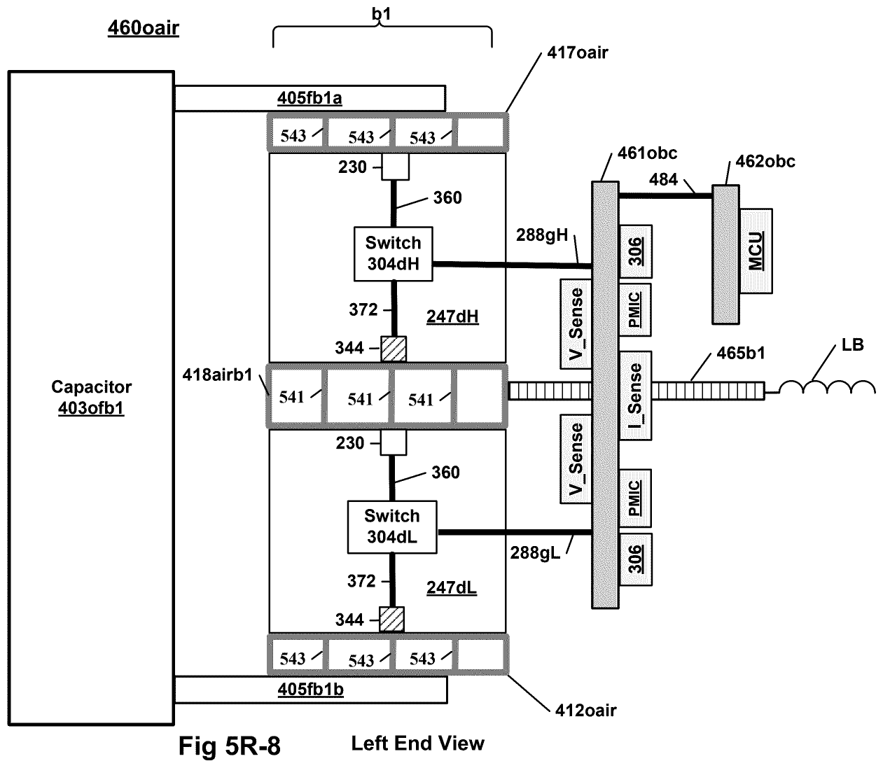

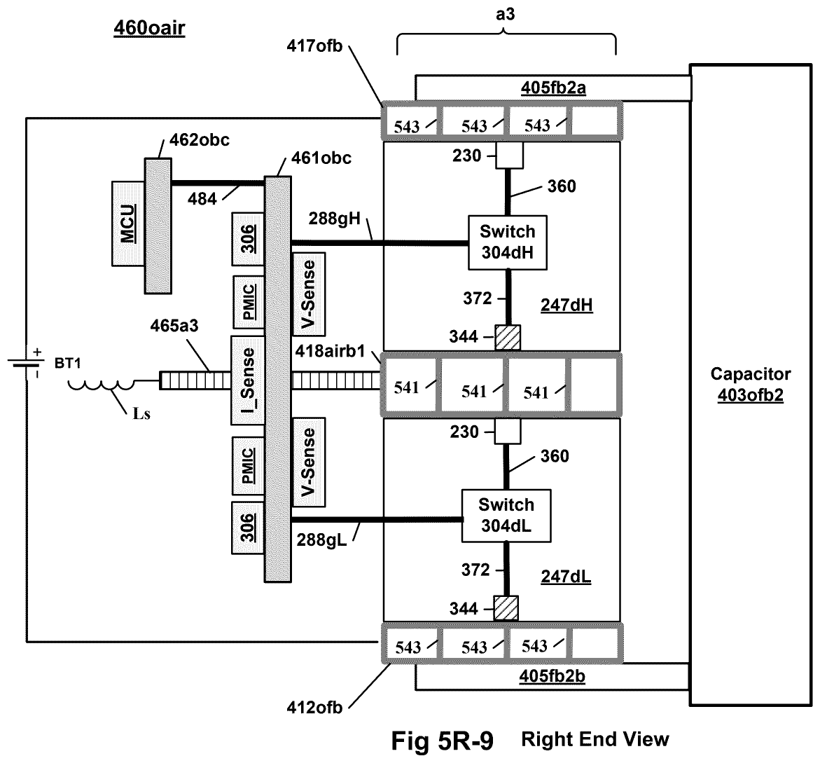

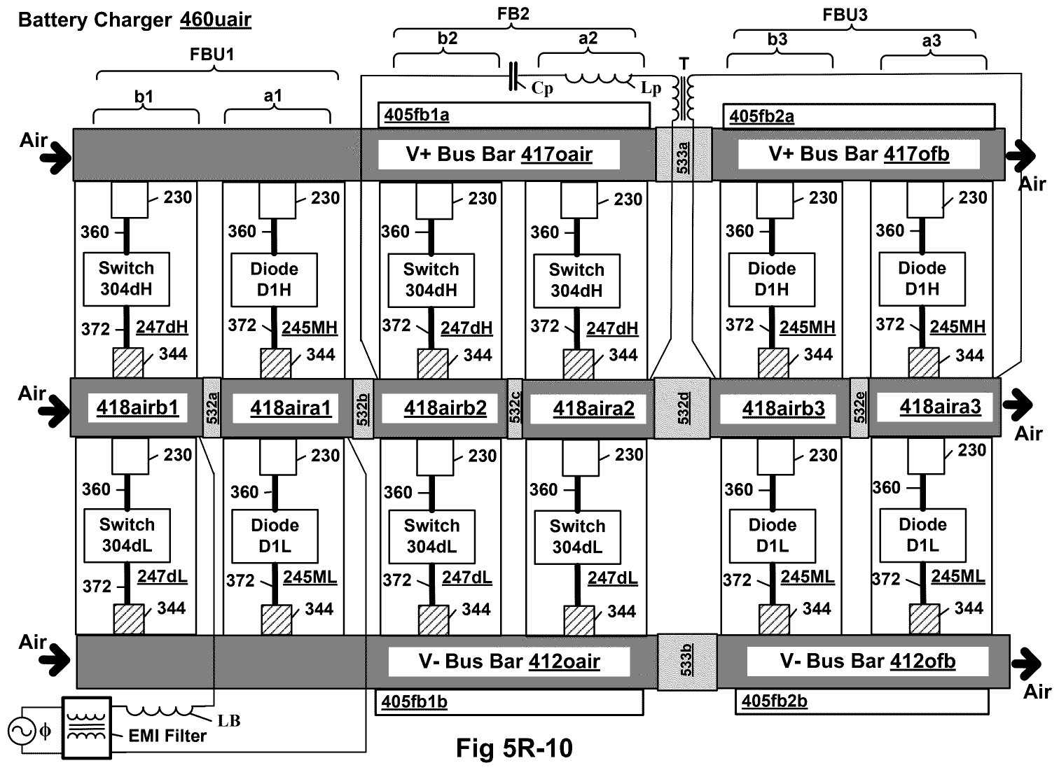

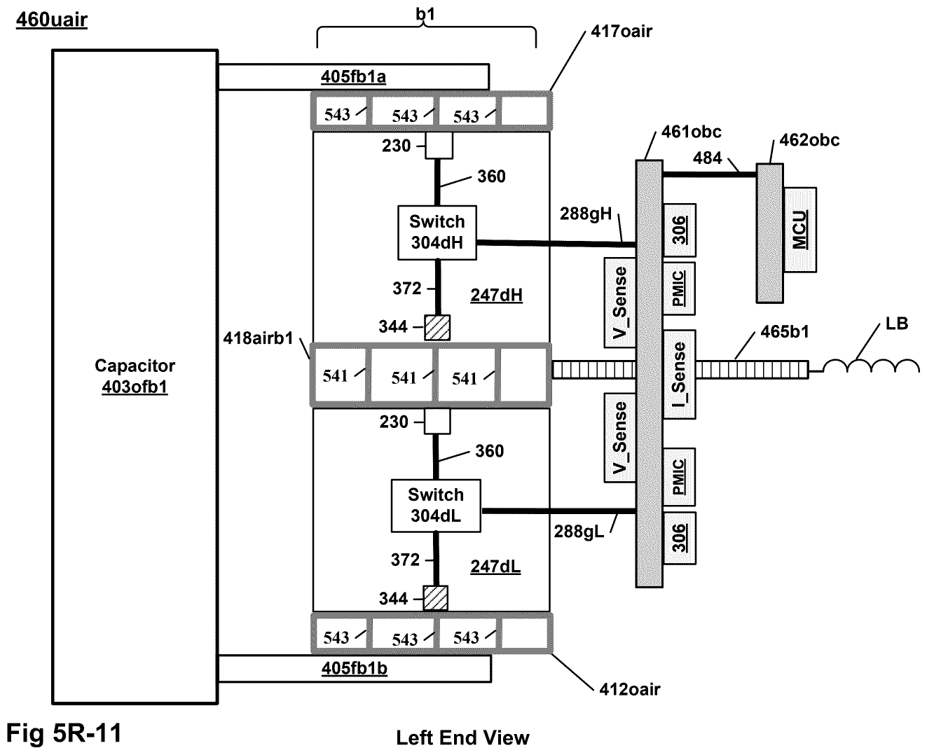

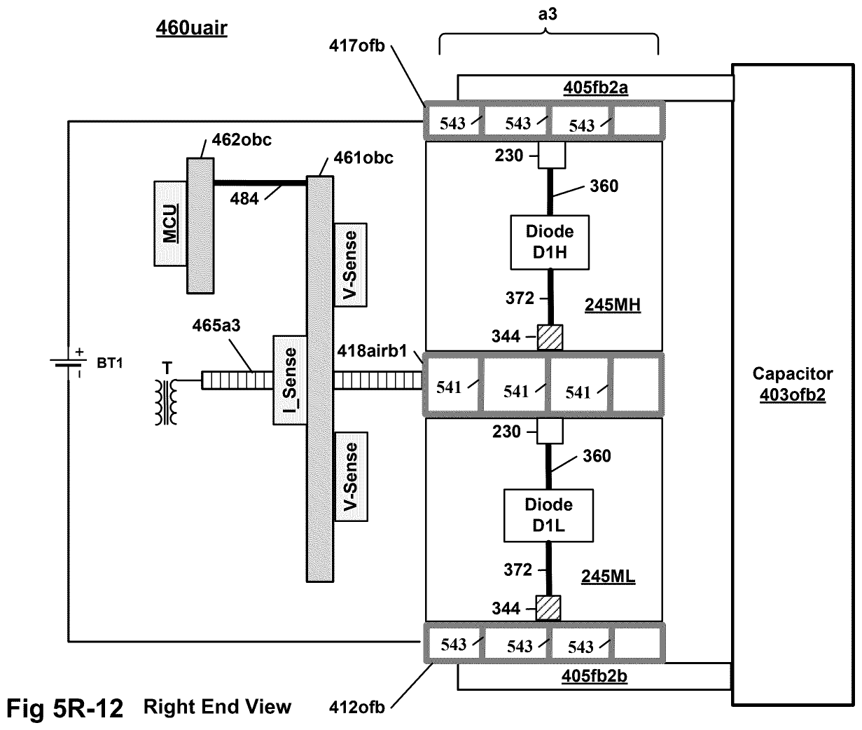

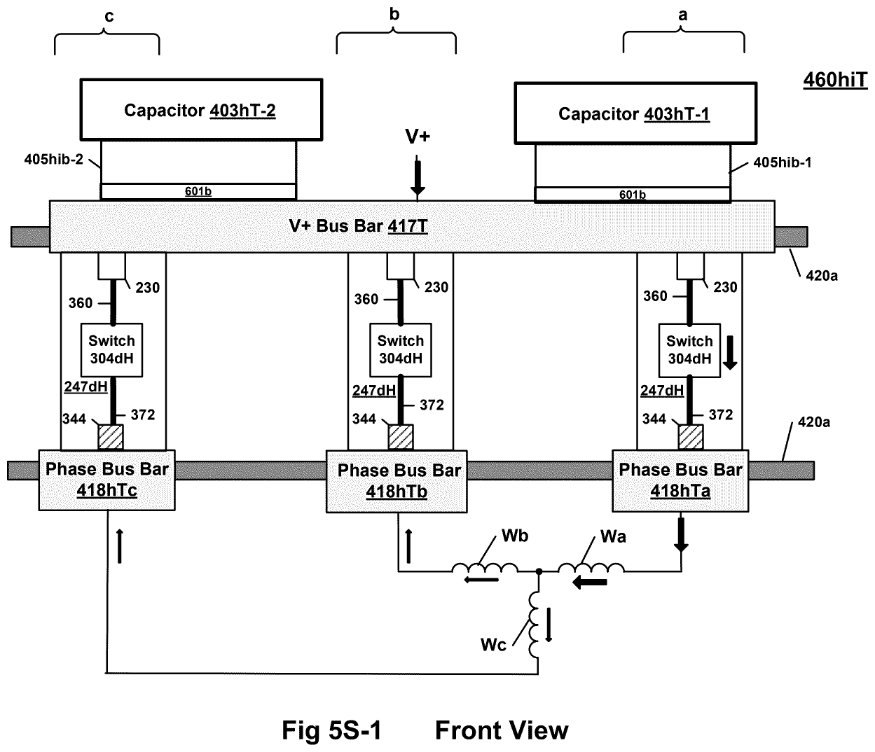

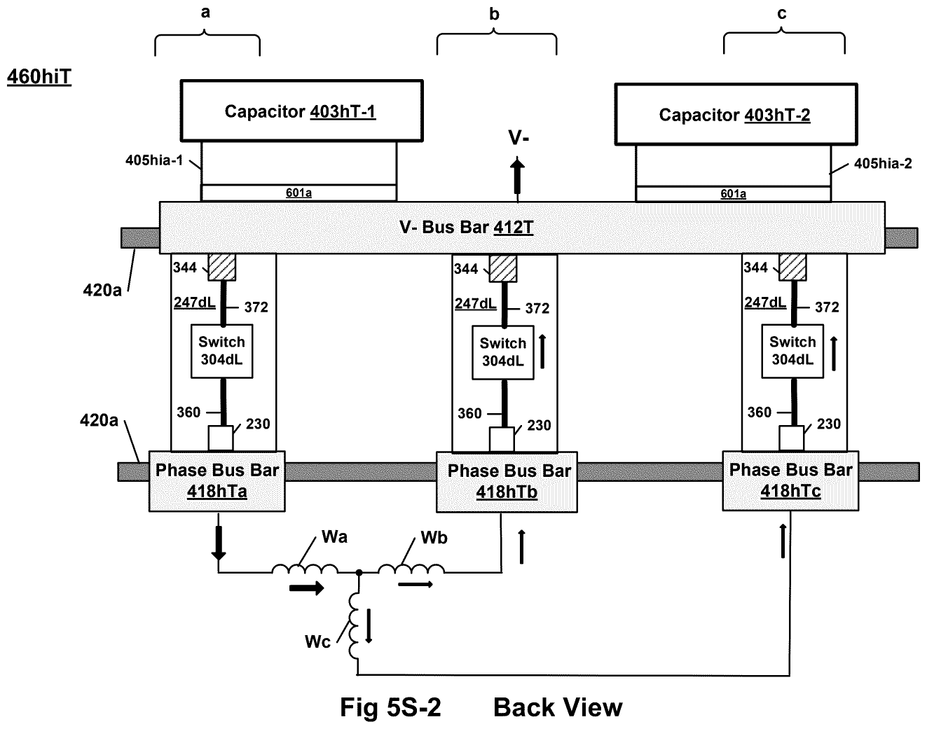

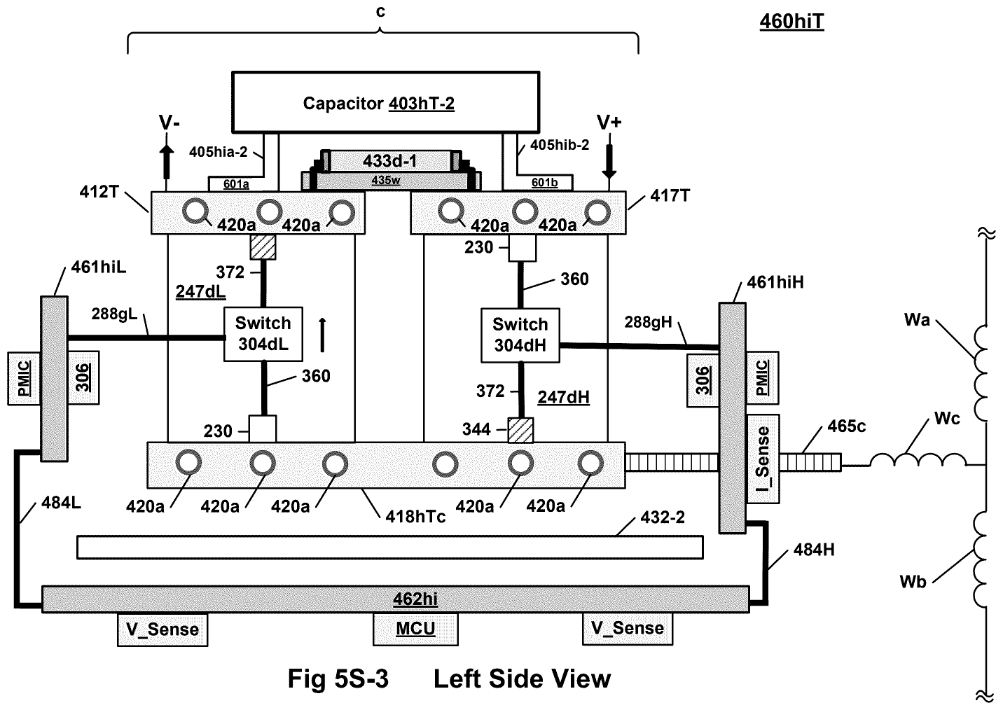

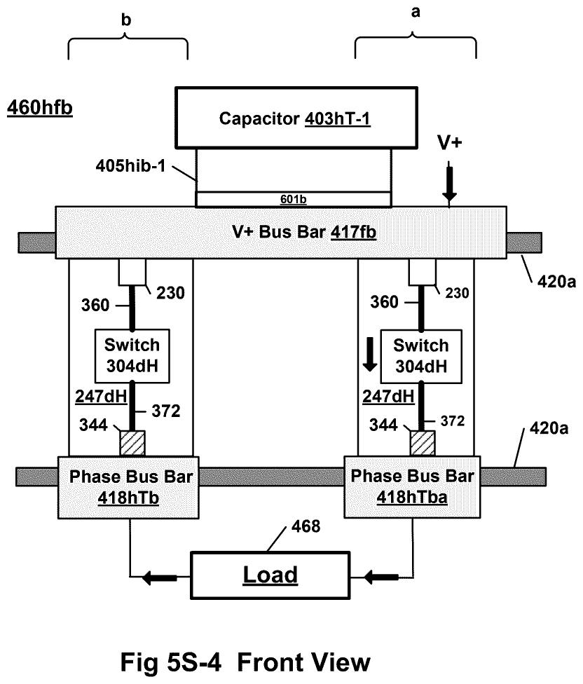

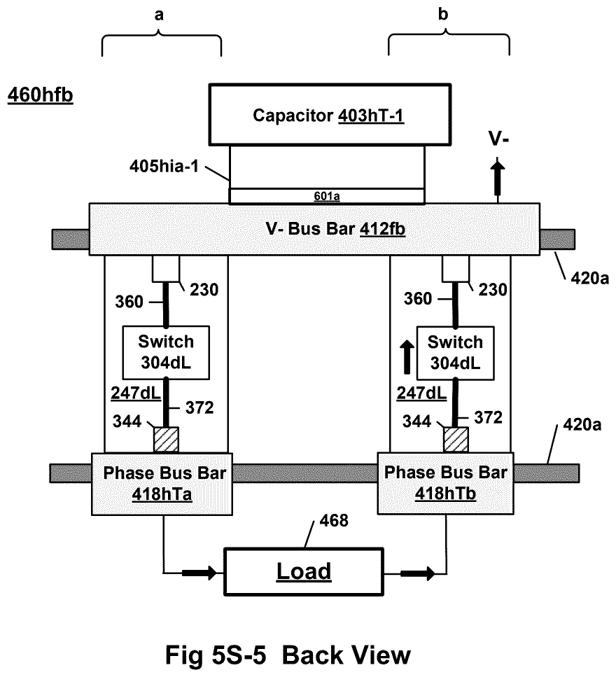

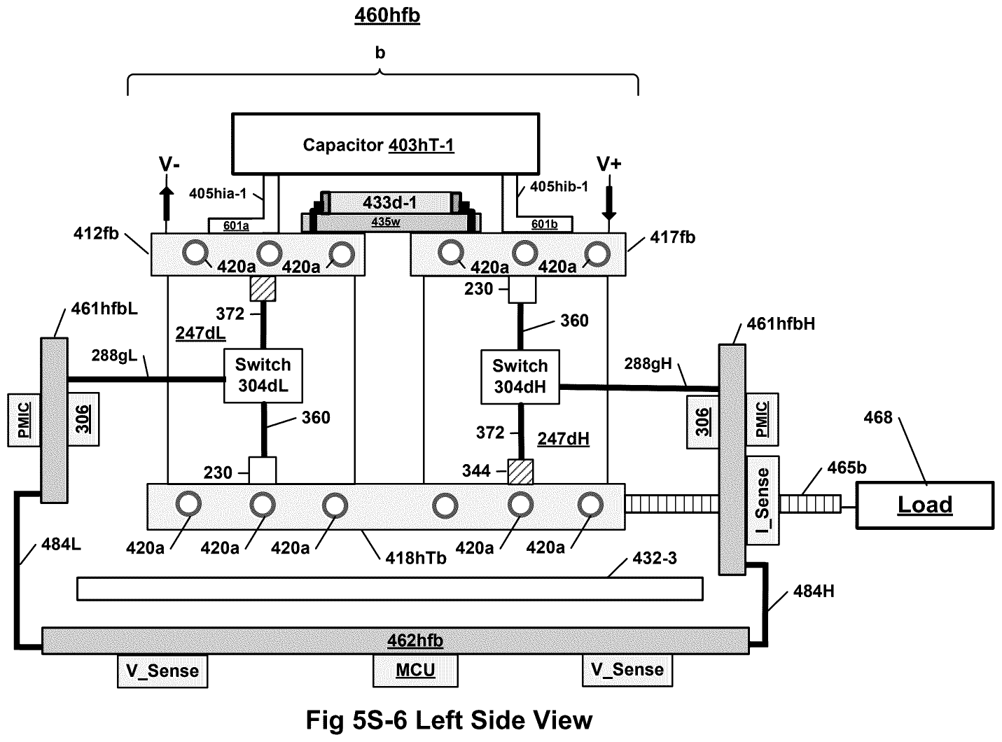

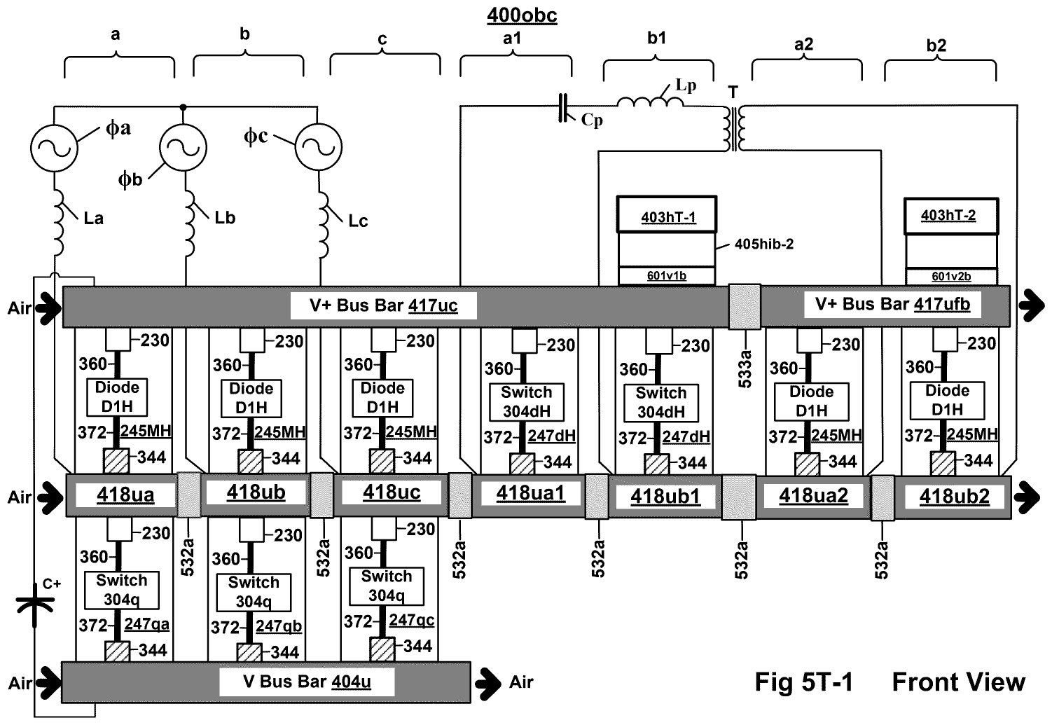

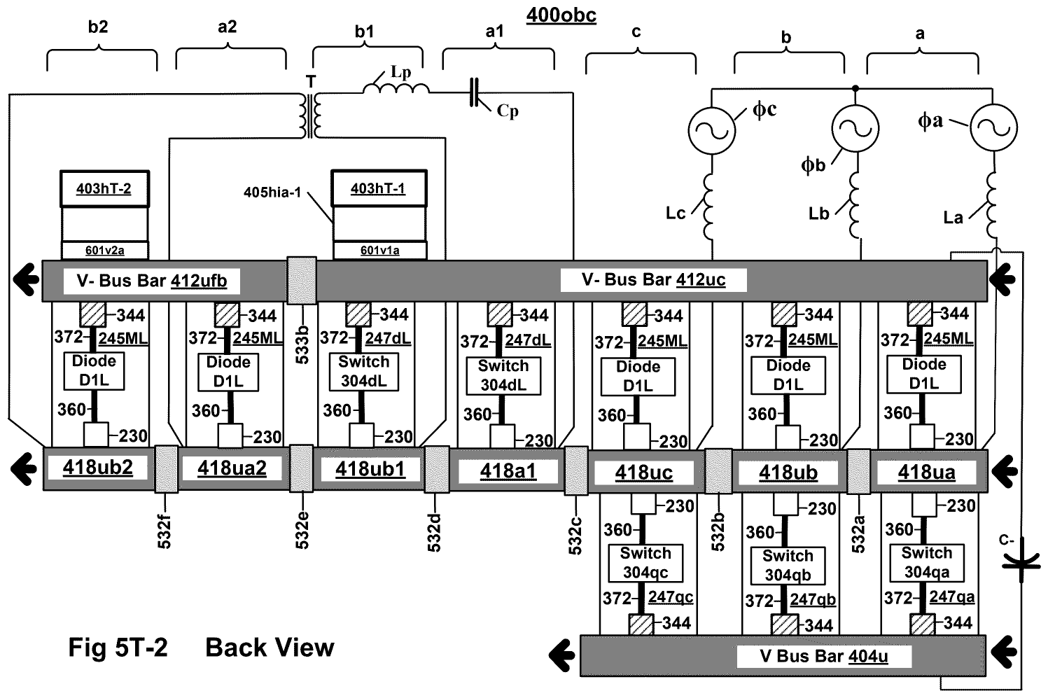

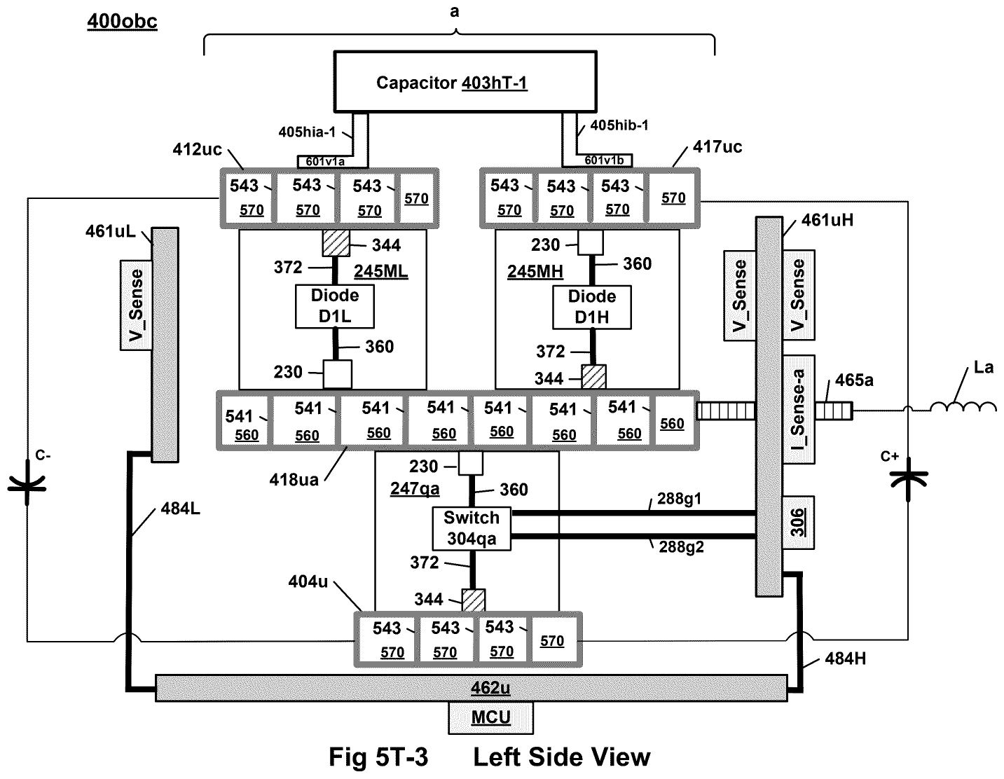

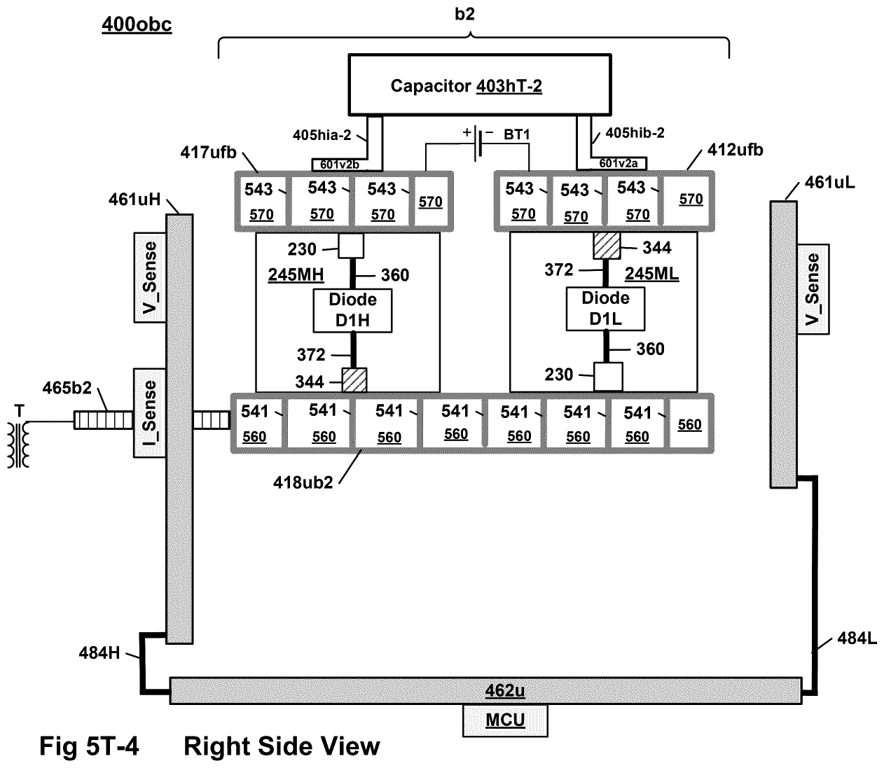

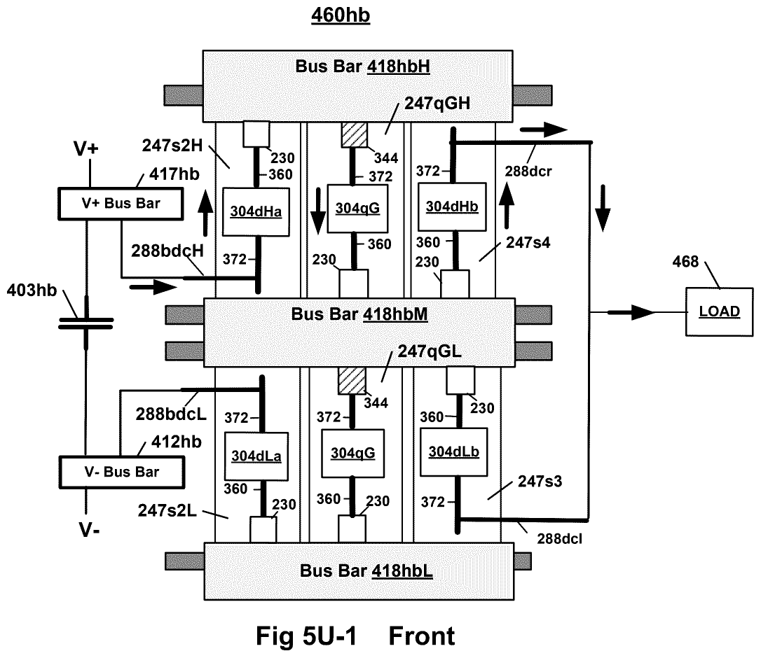

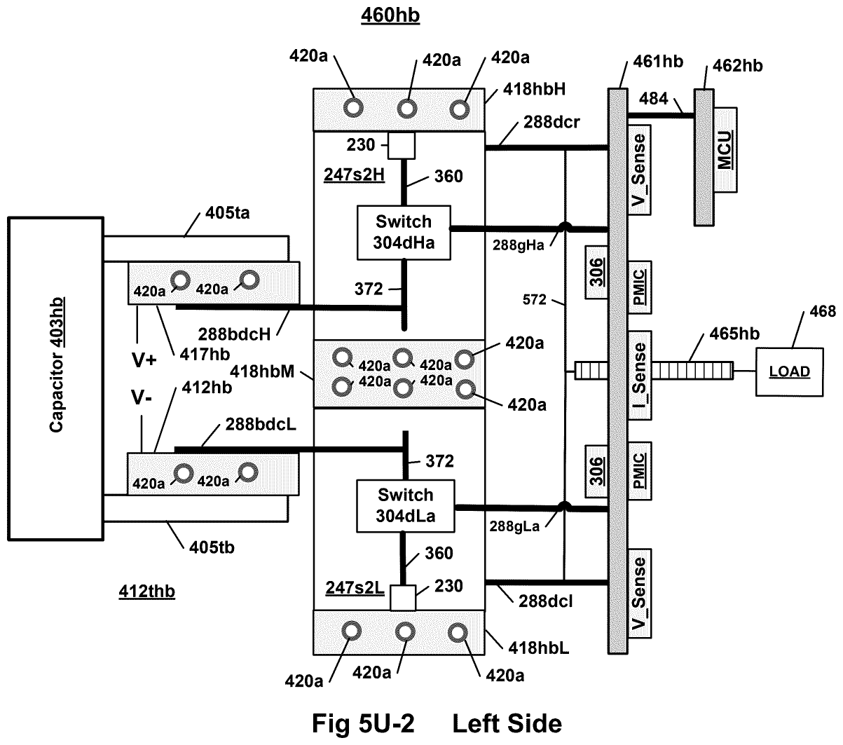

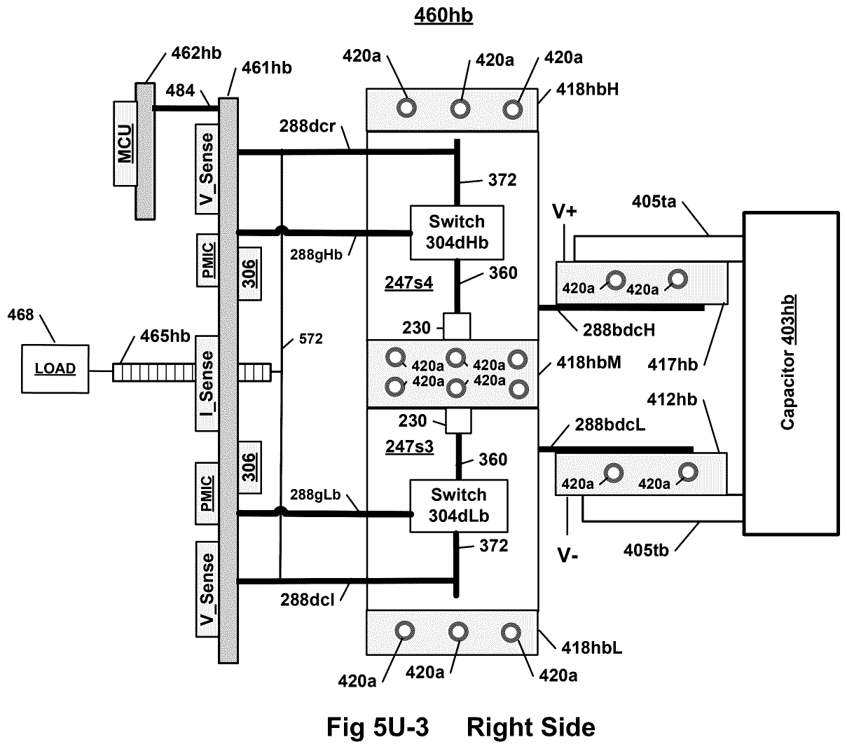

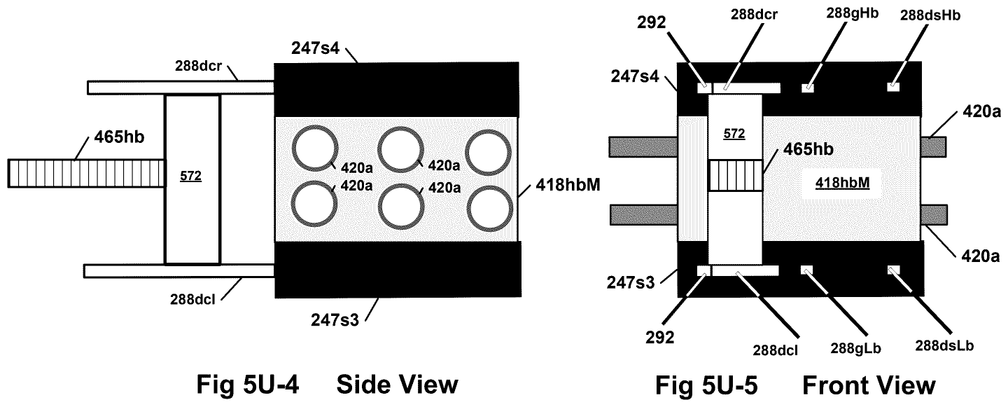

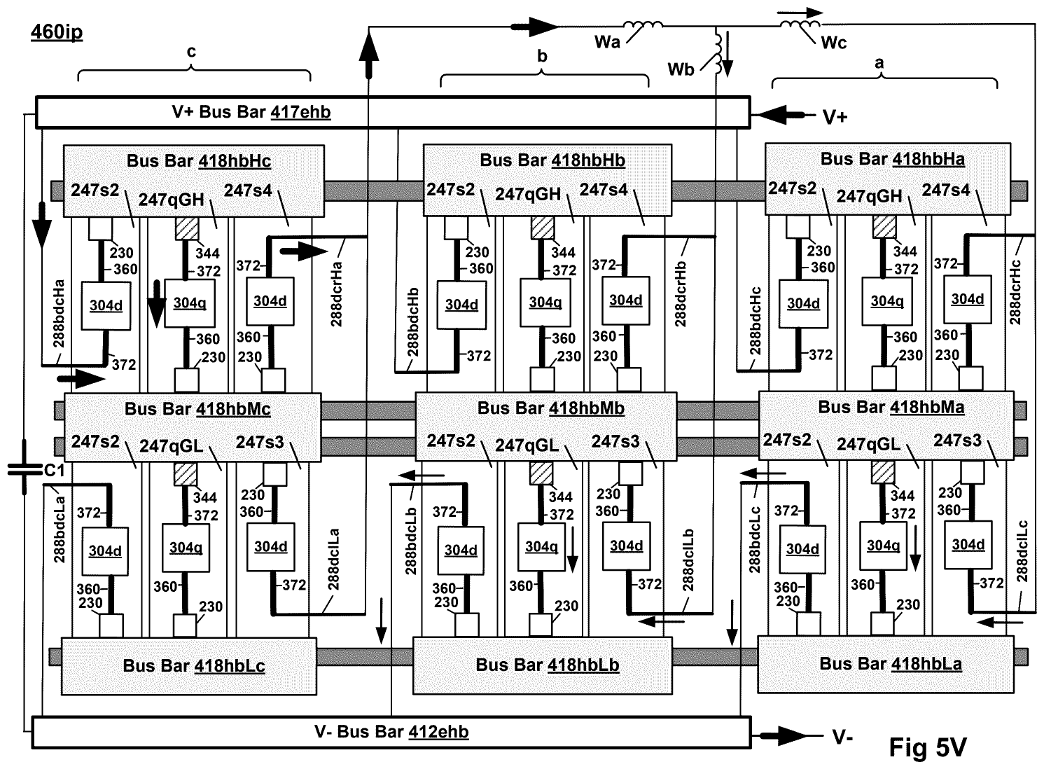

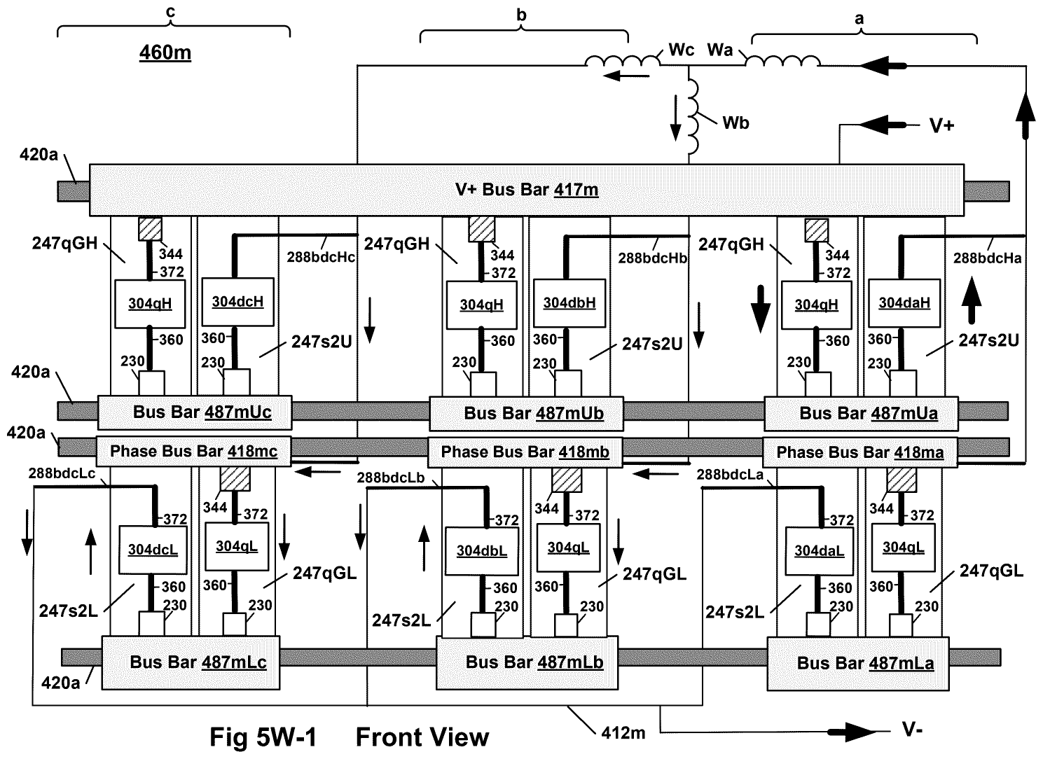

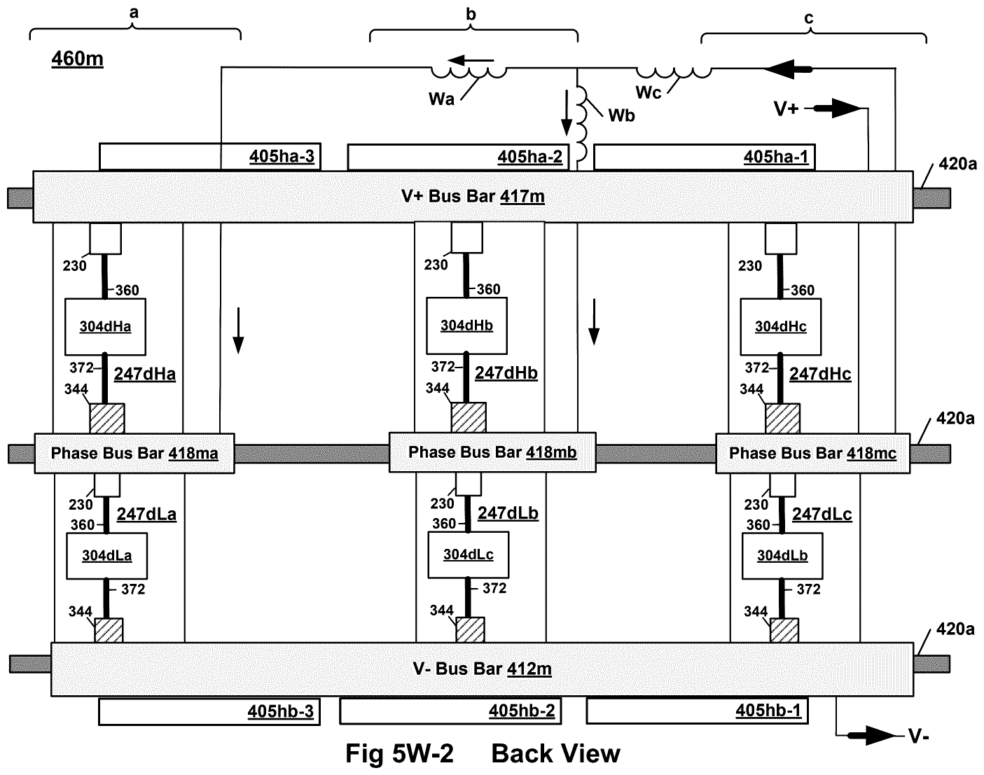

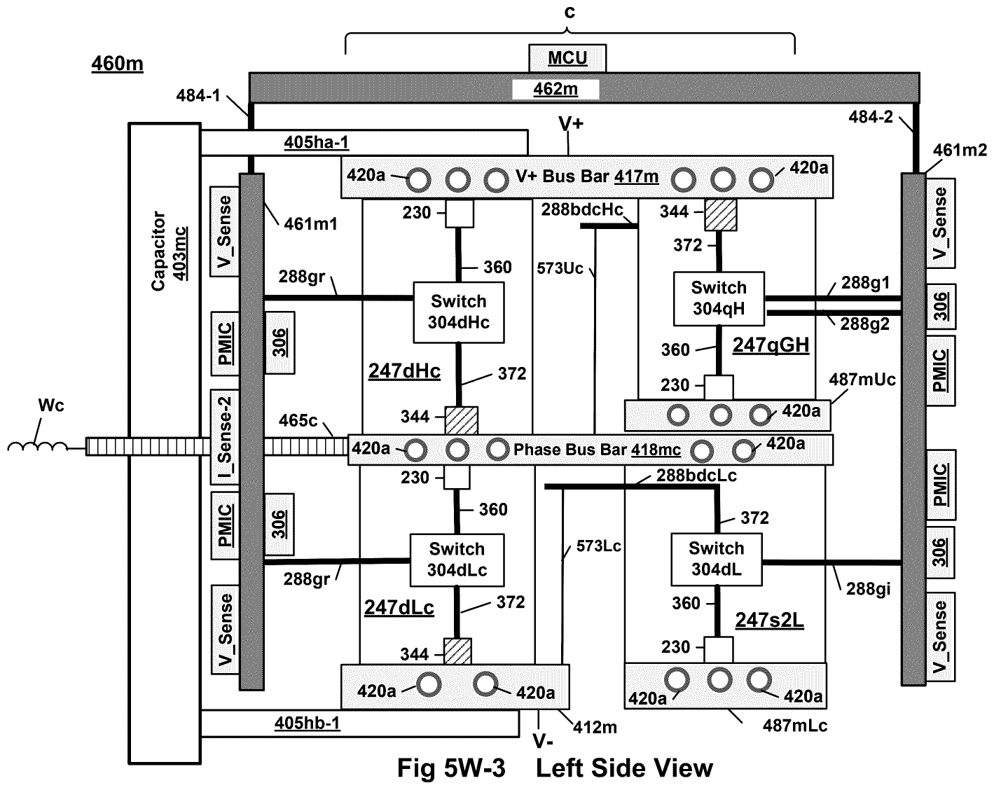

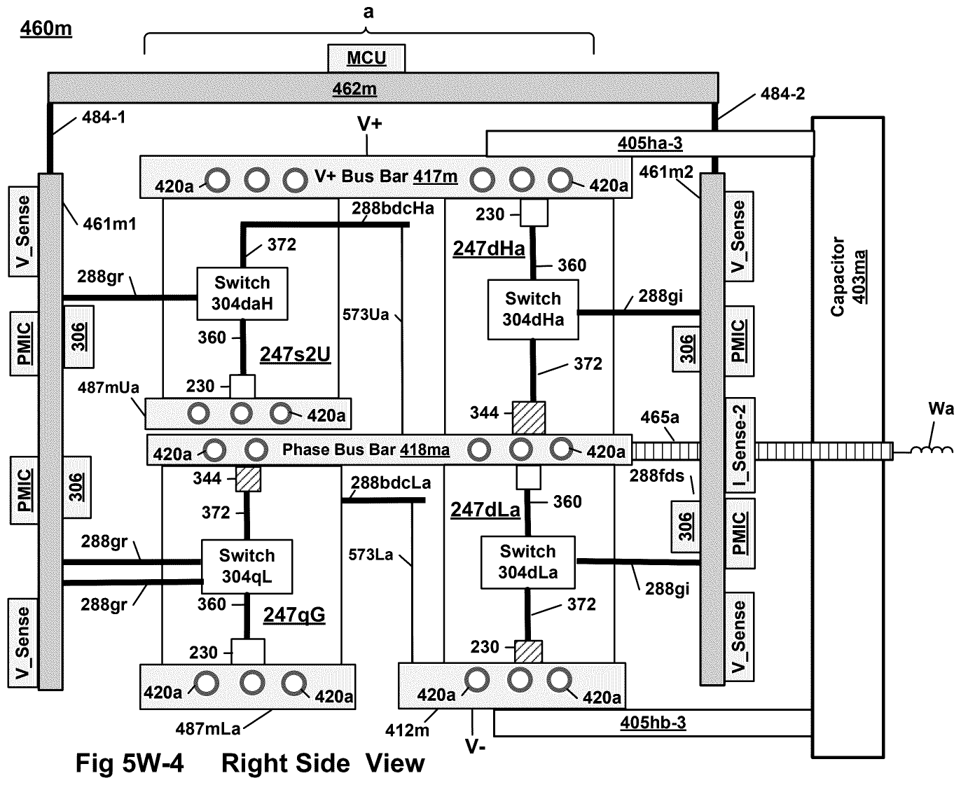

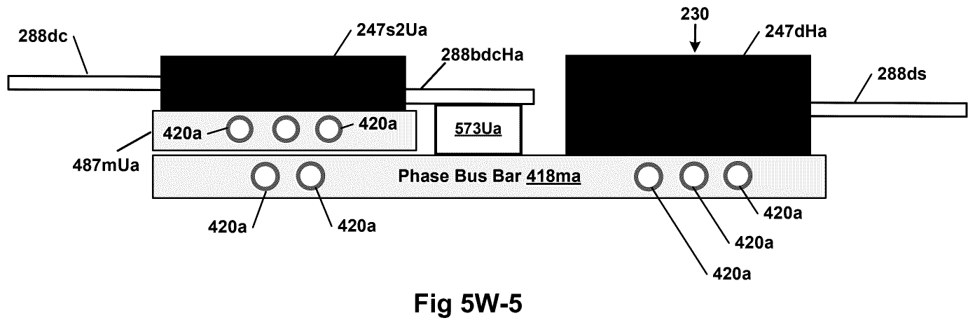

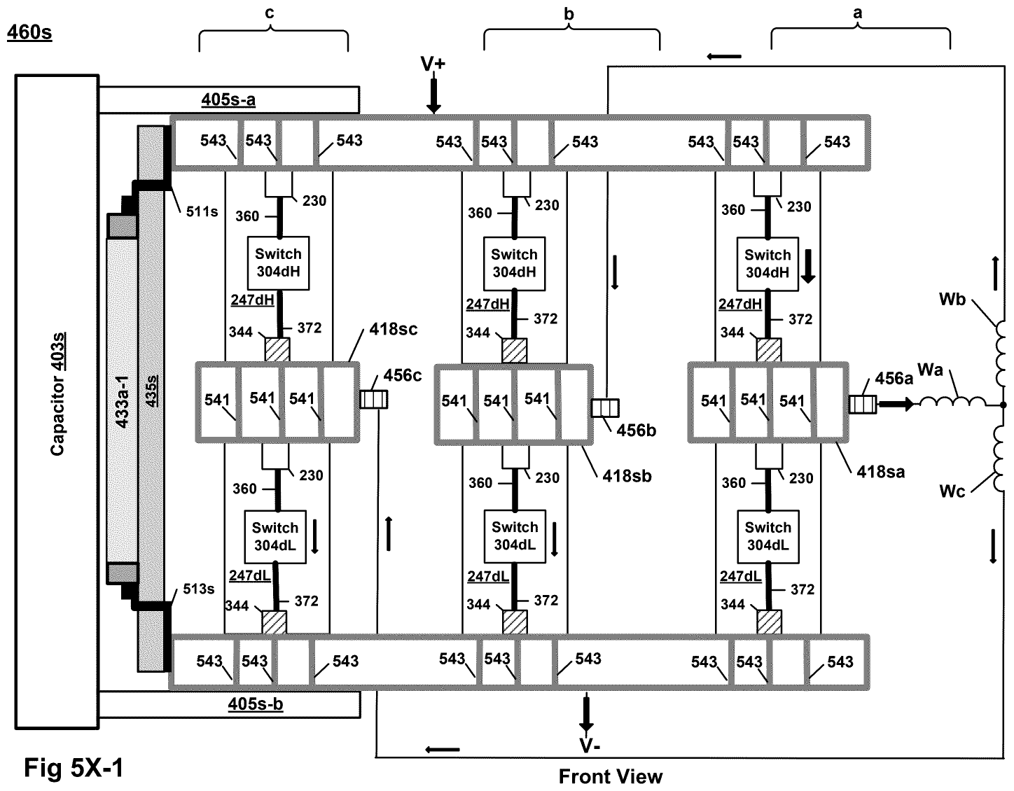

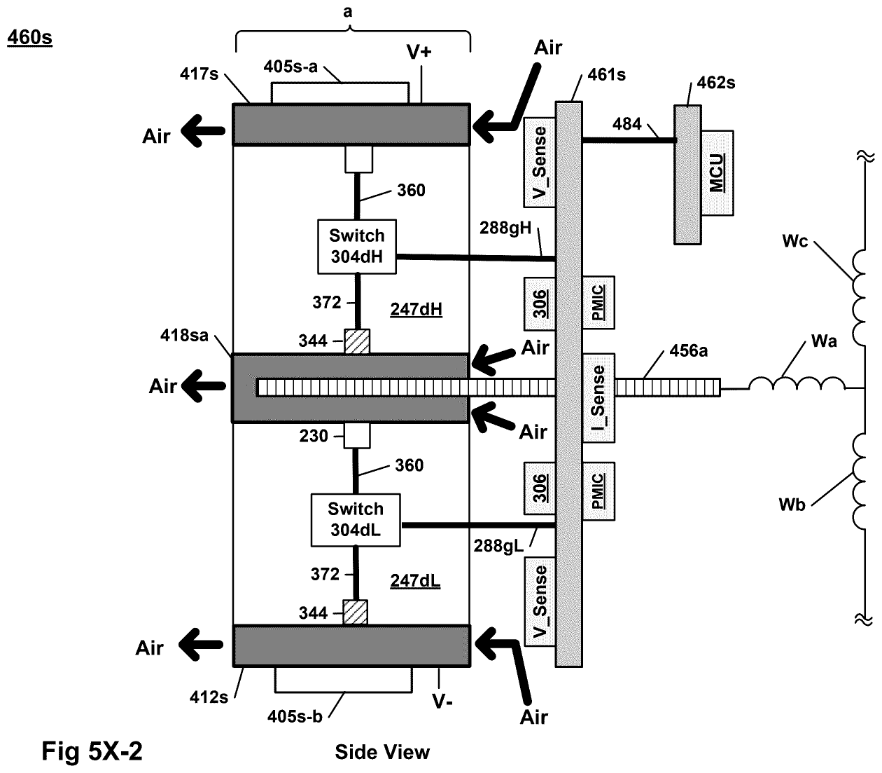

FIG. 4A-5 shows top and side views of the structure in FIG. 4A-3 after flat surface 375 of die clip 372 in FIG. 4A-4-1 is electrically and thermally attached (e.g., sintered, soldered, etc.) directly to flat surfaces 1101 of pedestals 1104. Alternatively, flat surface 375 of die clip 372 in FIG. 4A-4-2, 4A-4-3, or 4A-4-4 can be electrically and thermally attached (e.g., sintered, soldered, etc.) directly to flat surfaces 1101 of pedestals 1104. Flat surface 375 can be sintered directly to flat surfaces of pedestals, such as flat surfaces 1101, using sinter paste or preform, or flat surface 375 can be soldered directly to flat surfaces of pedestals, such as flat surfaces 1101, using solder paste or preform. If flat surfaces of pedestals, such as surfaces 1101, are not be contained in the same plane, solder paste or sinter paste may be preferred over solder preform or sinter preform when attaching the flat pedestal surfaces to the flat surface of the die clip.

Each die clip joint (e.g., sintered joint) that connects a first flat surface of a pedestal, including surface 1101, to surface 375 may conduct 1, 2, 5, 10, 20, 50, 100, 300, 600 Watts or more of heat while concurrently conducting 1, 5, 10, 20, 50, 100, 200, 400 A or more of electrical current. Each die clip joint may have a length and width that may be substantially equal to the length and width of a respective first flat end surface of a pedestal, such as surface 1101. A low resistance path may exist between die clip terminal 344 and each second current terminal pad, including pad 395.

If T1-T4 take form in MOSFETs, the structure shown in FIG. 4A-5 may be a version of the switch module 376B shown in FIG. 3B. If T1-T4 take form in IGBTs, the structure shown in FIG. 4A-5 may be a version of the switch module 3760 shown in FIG. 3O. After die clip 372 is electrically and thermally attached to pedestals 1104, a case may be formed around the switch module of FIG. 4A-5 using, for example, transfer molding, to create an example of packaged switch 247dB or 247dO shown in FIGS. 3B and 3O, respectively, which is an example of packaged switch 247d shown in FIGS. 2D-1-2D-3. Or, a case may be formed around the switch module of FIG. 4A-5 using, for example, transfer molding, to create an example of packaged switch 247s1 shown in FIGS. 2C-1-2C-3. If die clip 372 of 4A-4-2 is electrically and thermally attached to pedestals 1104 of FIG. 4A-3, a case may be formed around the resulting switch module using, for example, transfer molding, to create an example of packaged switch 247s2 shown in FIGS. 2C-4-2C-6. If die clip 372 of FIG. 4A-4-3 is electrically and thermally attached to pedestals 1104 of FIG. 4A-3, a case may be formed around the resulting switch module using, for example, transfer molding, to create an example of packaged switch 247s3 shown in FIGS. 2C-7-2C-9. If die clip 372 of 4A-4-4 is electrically and thermally attached to pedestals 1104 of FIG. 4A-3, a case may be formed around the resulting switch module using, for example, transfer molding, to create an example of packaged switch 247s4 shown in FIGS. 2C-10-2C-12. Prior to case formation some or all of connector-leads 288, other then 288bdc, may be bent to place case-external end portions of the connector-leads 288 in a common plane as shown in FIGS. 2C-3, 2C-6, 2C-9, 2C-12 and 2D-3. In an alternative version, connection-lead 288ds and/or 288dc are not included in FIG. 4A-5 to create an alternative version of packaged switch 247d.

In FIG. 4A-3 pedestals 1104 may be electrically and thermally connected (e.g., sintered, soldered, etc.) directly to respective second current terminal pads. A pedestal can be connected to adjacent second current terminals pads in a transistor. FIG. 4A-6 shows the structure of FIG. 4A-2-1 with example pedestals 1108 that may be electrically and thermally attached (e.g., sintered, soldered, etc.) directly to respective pairs of second terminals. Pedestals 1108 may be longer than pedestals 1104 and may be formed from thin (e.g., 1.0 mm-1.2 mm, or less, or more) sheets like that shown in FIG. 2H or 21, it being understood pedestals 1108 should not be limited thereto.

Like pedestals 1104, pedestals 1108 may have opposite facing flat first and second end surfaces that are substantially parallel to each other. Only first flat end surfaces 1107 are shown in FIG. 4A-6. The first and second flat end surfaces may have the same size and shape. Surfaces 1107 of pedestals 1108 may have a width around 2.8 mm and a length around 3.3 mm. Surfaces 1107 may have a rectangular shape with rounded corners, a rectangular shape with square corners as shown, etc. Other shapes may be contemplated. Each second flat end surface may be electrically and thermally attached (e.g., sintered, soldered, etc.) directly to flat surfaces 395 of adjacent second current terminal pads in a respective transistor. The flat second end surface (not shown) of each pedestal 1108 may have an area that may be equal to, smaller than, or larger than the surface area that may include surfaces 395 of adjacent second current terminal pads in a transistor and the area separating the adjacent second current terminal pads so that the second flat end surface contacts all or most (i.e., 51%-99%) of the adjacent flat surfaces 395 through a connection material (e.g., sintering material, soldering material, etc.). Each second joint (e.g., sintered joints) that connects a pair of adjacent second current terminal pad surfaces 395 to a flat second end surface of a pedestal 1108, and each pedestal 1108, may conduct 10, 20, 50, 100, 300, 700 Watts or more of heat while concurrently conducting 10, 20, 50, 100, 200, 400 A or more of electrical current. Each of the second joints may have a length and width that may be substantially equal to the length and width of the flat second end surface of pedestal 1108.

FIG. 4A-7 shows top and side views of the structure in FIG. 4A-6 after flat surface 375 die clip 372 in FIG. 4A-4-1 is electrically and thermally attached (e.g., sintered, soldered, etc.) directly to flat surfaces 1107 of pedestals 1108. In alternative versions, flat surface 375 die clip 372 in FIG. 4A-4-2, 4A-4-3, or 4A-4-4 can be electrically and thermally attached directly to flat surfaces 1107 of pedestals 1108. A low resistance path may exist between die clip terminal 344 and each second current terminal pad 395. Each die clip joint (e.g., sintered joint) that connects a surface 1107 to surface 375 may conduct 10, 20, 50, 100, 300, 700 Watts or more of heat while concurrently conducting 10, 20, 50, 100, 200, 400 A or more of electrical current. Each die clip joint in FIG. 4A-7 (not shown) may have a length and width that may be substantially equal to the length and width of a respective first flat end surface 1107.

If T1-T4 take form in MOSFETs, the structure shown in FIG. 4A-7 may be a version of the switch module 376B shown in FIG. 3B. If T1-T4 take form in IGBTs, the structure shown in FIG. 4A-7 may be a version of the switch module 3760 shown in FIG. 3O. After die clip 372 is attached, a case may be formed around the switch module of FIG. 4A-7 using, for example, transfer molding, to create an example of packaged switch 247dB or 247dO shown in FIGS. 3B and 3O, respectively, which is an example of a packaged switch 247d shown in FIGS. 2D-1-2D-3. Or, a case may be formed around the switch module of FIG. 4A-7 using, for example, transfer molding, to create an example of packaged switch 247s1 shown in FIGS. 2C-1-2C-3. If die clip 372 of 4A-4-2 is electrically and thermally attached to pedestals 1108 of FIG. 4A-6, a case may be formed around the resulting switch module using, for example, transfer molding, to create an example of packaged switch 247s2 shown in FIGS. 2C-4-2C-6. If die clip 372 of 4A-4-3 is electrically and thermally attached to pedestals 1108 of FIG. 4A-6, a case may be formed around the resulting switch module using, for example, transfer molding, to create an example of packaged switch 247s3 shown in FIGS. 2C-7-2C-9. If die clip 372 of 4A-4-4 is electrically and thermally attached to pedestals 1108 of FIG. 4A-6, a case may be formed around the resulting switch module using, for example, transfer molding, to create an example of packaged switch 247s4 shown in FIGS. 2C-10-2C-12. Prior to case formation some or all of connector-leads 288, but not 288bdc, may be bent to place case-external end portions of the connector-leads 288 in a common plane as shown in FIGS. 2C-3, 2C-6, 2C-9, 2C-12 and 2D-3. In an alternative version, connection-lead 288ds and/or 288dc are not included in FIG. 4A-7 to create an alternative version of packaged switch 247d.

In still another version of switch module 376B, pedestals may be integrally formed with bridges (i.e., integrated bridges). FIG. 4A-8 shows the structure of FIG. 4A-2-1 with example integrated bridges 371, each of which may be electrically and thermally attached (e.g., sintered, soldered, etc.) directly to second current terminals in adjacent transistors. Integrated bridge 371 may have a substantially flat surface 383 with a length around 10.8 mm and a width around 2.8 mm.

Integrated bridge 371 may be formed (e.g., cut) from a thin (e.g., 0.7 mm-1.5 mm, or less, or more) sheet like that shown in FIG. 2H or 21. A channel can be formed in the layered sheet to create integrated pedestals 1110. A flat end surface of each integrated pedestal 1110 can have the same size and shape as flat end surface 1107 of pedestal 1108. Each flat end surface can be electrically and thermally attached (e.g., sintered, soldered, etc.) directly to surfaces 395 of adjacent current terminal pads in a respective transistor. Each flat end surface of an integrated pedestal 1110 may have a shape (e.g., rectangular with squared corners, rectangular with rounded corners, etc.) like the shape (e.g., rectangular with squared corners) of flat surfaces 395. The width (e.g., around 2.8 mm) and length (e.g., around 1.65 mm) of the second flat end surfaces of pedestals 1104 may be equal to, slightly greater, or slightly smaller than the width and length, respectively, of the flat surfaces 395 of respective second current terminal pads to which they may be electrically and thermally attached so that each flat end surface of integrated pedestal 1110 contact all or most (i.e., 51%-99%) of flat surfaces 395 through a connection material (e.g., sinter material, solder material, etc.). Each second joint (e.g., sintered joint) that connects a pair of adjacent second current terminal pad surfaces 395 to a flat second end surface of an integrated pedestal 1110, and each pedestal 1110, may conduct 10, 20, 50, 100, 300, 700 Watts or more of heat while concurrently conducting 10, 20, 50, 100, 200, 400 A or more of electrical current. Each these second joints may have a length and width that may be substantially equal to the length and width of the flat second end surface of pedestal 1110. Each of the bridges 371 may have a flat surface 383 that can be sintered to a flat surface of a die clip 372.

The groove in integrated bridge 371 may extend across its entire width and span a separation between a pair of adjacent transistors. For example, the groove in integrated bridge 371-1 may be positioned over the separation between transistors T1 and T2, and the groove in integrated bridge 371-2 may be positioned over the separation between transistors T3 and T4. A groove can be formed by cutting into a layered sheet using, for example, a rotary burr (also known as die grinder bit) of a rotary tool. The groove may be deep enough to enable liquid mold compound to flow freely between the pedestals 1110 when their flat end surfaces may be electrically and thermally attached (e.g., sintered, soldered, etc.) directly to second current terminal (e.g., source terminal) pad surfaces 395 in respective transistors. The groove can be rectangularly shaped (rectangle-groove) with three sides like those shown in the side-view of FIG. 4A-8, or the groove can be upside-down V shaped (i.e., V-groove) with two sides. In a V-groove, the cross-sectional width of the pedestals increase towards the bridge to which the pedestals 1110 may be integrally connected. V-grooves may provide better heat spreading when compared to rectangle-grooves, but rectangle-grooves may enable better liquid mold-compound flow between pedestals 1110 during transfer molding.

FIG. 4A-9 show top and side views of the structure in FIG. 4A-8 after a die clip, such as die clip 372 of FIG. 4A-4-1, is added. Specifically FIG. 4A-9 shows the structure after flat surface 375 of die clip 372 is electrically and thermally attached (e.g., sintered, soldered, etc.) directly to flat surfaces 383 of integrated bridges 371. In alternative versions, flat surface 375 die clip 372 in FIG. 4A-4-2, 4A-4-3, or 4A-4-4 can be electrically and thermally attached directly to flat surfaces 383 of integrated bridges 371. A low resistance path may exist between die clip terminal 344 and each second current terminal pad 395. Each die clip joint (e.g., sintered joint) that connects a surface 383 to surface 375 may conduct 10, 20, 50, 100, 300, 700, 1400 Watts or more of heat while concurrently conducting 10, 20, 50, 100, 200, 400, 800 A or more of electrical current. Each die clip joint in FIG. 4A-9 (not shown) may have a length and width that may be substantially equal to the length and width of a respective surface 383.

If T1-T4 may be MOSFETs, the structure shown in FIG. 4A-9 may be a version of the switch module 376B shown in FIG. 3B. If T1-T4 may be IGBTs, the structure shown in FIG. 4A-9 may be a version of the switch module 376O shown in FIG. 3O. After die clip 372 is electrically and thermally attached to integrated bridges 371, a case may be formed around the switch module of FIG. 4A-9 using, for example, transfer molding, to create a version of packaged switch 247dB or 247dO shown in FIGS. 3B and 3O, respectively, which is an example of packaged switch 247d shown in FIG. 2D-1-2D-3. Or, a case may be formed around the switch module of FIG. 4A-9 using, for example, transfer molding, to create an example of packaged switch 247s1 shown in FIGS. 2C-1-2C-3. If die clip 372 of 4A-4-2 is electrically and thermally attached to integrated bridges 371 of FIG. 4A-8, a case may be formed around the resulting switch module using, for example, transfer molding, to create an example of packaged switch 247s2 shown in FIGS. 2C-4-2C-6. If die clip 372 of 4A-4-3 is electrically and thermally attached to integrated bridges 371 of FIG. 4A-8, a case may be formed around the resulting switch module using, for example, transfer molding, to create an example of packaged switch 247s3 shown in FIGS. 2C-7-2C-9. If die clip 372 of 4A-4-4 is electrically and thermally attached to integrated bridges 371 of FIG. 4A-8, a case may be formed around the resulting switch module using, for example, transfer molding, to create an example of packaged switch 247s4 shown in FIGS. 2C-10-2C-12. Prior to case formation some or all of connector-leads 288, but not 288bdc, may be bent to place case-external end portions of the connector-leads 288 in a common plane as shown in FIGS. 2C-3, 2C-6, 2C-9, 2C-12 and 2D-3. In an alternative version, connection-lead 288ds and/or 288dc are not included in FIG. 4A-9 to create an alternative version of packaged switch 247d.

Returning to FIG. 4A-2-1, all control terminals of transistors T1-T4 may be electrically connected to gate strap 364a. In an alternative version, control terminals of transistors in a switch may be electrically connected to separate gate straps. FIG. 4B-1 shows the structure of FIG. 4A-2-1 with gate strap 364a replaced by a pair of gate straps 359-1 and 359-2, which in turn may be attached to surface 362 of the die substrate 360 through electrically insulating material (not shown). Gate straps 359-1 and 359-2 may be smaller in width than gate strap 364a. Otherwise, gate straps 359-1 and 359-2 may be substantially like gate strap 364a. FIG. 4B-1 also shows that connector-lead 288g in FIG. 4A-2-1 is replaced with a pair of connector leads 288g-1 and 288g-2. Connector-lead 288g may be substantially like connector leads 288g-1 and 288g-2.

Bond-wires 366-1 and 366-2 of substantially equal length may electrically connect gate strap 359-1 (or length-extended connector-lead 288g-1) to surfaces 384 of respective control terminal (e.g., gate terminal) pads in transistors T1 and T2. Bond-wires 366-3 and 366-4 of substantially equal length may electrically connect gate strap 359-2 (or length-extended connector-lead 288g-2) to surfaces 384 in respective control terminal pads of T3 and T4. Connector-leads 288g-1 and 288g-2 may be electrically connected to gate straps 359-1 and 359-2, respectively, by bond-wires 365-1 and 365-2, respectively. In an alternative version, ends of length-extended connector-leads 288g-1 and 288g-2 may be connected (e.g., welded, soldered, etc.) to gate straps 359-1 and 359-2, respectively. In yet another version, ends of extended 288g-1 and 288g-2 may be attached to surface 362 through electrically insulating material. In this alternative version bond-wires 366-1 and 366-2 of substantially equal length may electrically length-extended connector-lead 288g-1 to surfaces 384 of respective control terminal pads of transistors T1 and T2, and bond-wires 366-3 and 366-4 of substantially equal length may electrically connect length-extended connector-lead 288g-2 to surfaces 384 of respective control terminal pads of T3 and T4.

Transistors T1-T4 in FIG. 4B-1 may be the same type, or transistors T1-T4 may be a mixture of different types. For example, T1-T4 may be MOSFETs or T1-T4 may be IGBTs. T1 and T2 may be MOSFETs while T3 and T4 may be IGBTs, or T1 and T3 may be MOSFETs while T2 and T4 may be IGBTs. In a mixed transistor version, the flat surfaces of first current terminal (e.g., drain and collector terminal) pads in T1-T4 may be electrically and thermally attached (e.g., sintered, soldered, etc.) directly to surface 362. In still another version, one of the transistors (e.g., T1) can be replaced by a diode, while transistors T2-T4 may take form in IGBTs. In a mixed IGBT/diode version the flat collector terminal pad(s) of the IGBT(s) and the flat cathode terminal pad(s) of the diode(s) can be electrically and thermally attached (e.g., sintered, soldered, etc.) directly to surface 362. A low resistance path may exist between the die substrate terminal 230 and drain or collector terminal pad of each transistor T or diode.

FIG. 4B-2 shows the structure of FIG. 4B-1 after pedestals 1108 are electrically and thermally attached (e.g., sintered, soldered, etc.) directly to adjacent surfaces 395 in respective transistors. FIG. 4B-3 shows top and side views of the structure in FIG. 4B-2 after a die clip, such as die clip 372 of FIG. 4A-4-1, is added. Specifically, FIG. 4B-3 shows flat surface 375 of die clip 372 is electrically and thermally attached (e.g., sintered, soldered, etc.) directly to flat surfaces 1107 of pedestals 1108. A low resistance path may exist between die clip terminal 344 and each second current terminal pad 395. Transistors T1 and T2 can be controlled by a first transistor control signal received via connector-lead 288g-1, while transistors T3 and T4 can be independently controlled by a separate second transistor control signal received via connector-lead 288g-2.

If transistors T1-T4 are MOSFETs, the structure shown in FIG. 4B-3 may be one version of the switch module 376E of FIG. 3E. In another version, each of transistors T1-T4 may be IGBTs. If transistors T1 and T2 may be IGBTs, and T3 and T4 may be MOSFETs, the structure shown in FIG. 4B-3 may be one version of the switch module 376P of FIG. 3P. Pedestals 1108 can be attached (e.g., sintered) to current pads of respective transistors T1-T4. Transistors T1 and T2 may have a height that is different than the height of transistors T3 and T4. Pedestals 1108 attached to current pads of transistors T1 and T2 may have a height that is different than the height of pedestal 1108 attached to transistors T3 and T4 so that surfaces 1107 of all pedestals are contained in substantially the same plane. After die clip 372 is electrically and thermally attached to pedestals 1108 using, for example, sintering paste, a case may be formed around the switch module shown in FIG. 4B-3 using, for example, transfer molding, to create a version of packaged switch 247qE or 247qP shown in FIGS. 3E and 3P, respectively, which is an example of the packaged switch 247q shown in FIGS. 2B-1-2B-3. Prior to case formation some or all of connector-leads 288 may be bent to place case-external end portions of the connector-leads 288 in a common plane as shown in FIG. 2B-3. In an alternative version, connection-lead 288ds and/or 288dc are not included to create an alternative version of packaged switch 247q.

FIG. 4B-4 shows the structure of FIG. 4B-2 with bond-wires 366-1-366-3 electrically connecting gate strap 359-1 to control terminal pad surfaces 384 of transistors T1-T3, and with bond-wire 366-4 electrically connecting gate strap 359-2 to control terminal pad surface 384 of transistor T4. Transistors T1-T4 in FIG. 4B-4 may be the same type, or transistors T1-T4 may be a mixture of different types. Transistors T1-T3 can be controlled by a transistor control signal received via connector-lead 288g-1, while transistor T4 can be independently controlled by a separate transistor control signal received via connector-lead 288g-2. FIG. 4B-5 shows top and side views of the structure in FIG. 4B-4 after a die clip, such as die clip 372 of FIG. 4A-4-1, is added. Specifically FIG. 4B-5 shows the structure after flat surface 375 of die clip 372 is electrically and thermally attached (e.g., sintered, soldered, etc.) directly to flat surfaces 1107 of pedestals 1108. If T1-T3 are MOSFETs and transistor T4 is an IGBT, the structure shown in FIG. 4B-5 may be one version of the switch module 376F in FIG. 3F. Alternatively, T1-T3 may be IGBTs and transistor T4 may be a MOSFET in FIGS. 4B-4 and 4B-5. Pedestals 1108 can be attached (e.g., sintered) to current pads of respective transistors T1-T4. Transistors T1-T3 may have a height that is different than the height of transistor T4. Pedestals 1108 attached to current pads of transistors T1-T3 may have a height that is different than the height of pedestal 1108 attached to transistor T4 so that surfaces 1107 of all pedestals are contained in substantially the same plane. After die clip 372 is electrically and thermally attached to pedestals 1108 using, for example, sintering paste, a case may be formed around the switch module shown in FIG. 4B-5 using, for example, transfer molding, to create an example of packaged switch 247qF shown in FIG. 3F, which is an example of packaged switch 247q shown in FIGS. 2B-1-2B-3. Prior to case formation some or all of connector-leads 288 may be bent to place case-external end portions of the connector-leads 288 in a common plane as shown in FIG. 2B-3. In an alternative version, connection-lead 288ds and/or 288dc are not included to create an alternative version of packaged switch 247q.

Surfaces of current terminal pad transistors may be electrically and thermally attached (e.g., sintered, soldered, etc.) to a die clip. FIG. 4C-1 shows die clip 372 after surfaces of first current terminal (e.g., drain, collector, etc.) pads in transistors T5-T8 may be electrically and thermally attached (e.g., sintered, soldered, etc.) directly to surface 375. A low resistance path may exist between die clip terminal 344 and each first current terminal pad of transistors T5-T8. Each joint (e.g., sintered joint) that connects a first current terminal pad surface to surface 375 in FIG. 4C-1 may conduct 10, 20, 50, 100, 200, 300, 750 Watts or more of heat while concurrently conducting 50, 100, 200, 400 A or more of electrical current. Each of these joints (not shown in FIG. 4C-1) may have a length and width that may be substantially equal to the length and width of a respective first current terminal pad surface. In FIG. 4C-1, die clip 372 may be formed from a thin (e.g., 0.7 mm-1.5 mm) layered sheet like that shown in FIG. 2H. T5-T8 may be transistors of the same type, or T5-T8 may include a mixture of different types of transistors. For example, T5 and T6 may be MOSFETs, and T7 and T8 may be IGBTs. In this version flat surfaces of drain terminal pads in T5 and T6, and flat surfaces of collector terminal pads in T7 and T8 may be sintered to surface 375. In another version, one of the transistors (e.g., T5) can be replaced by a diode, while transistors T6-T8 take form in IGBTs. In this version, the flat collector terminal pad(s) of the three IGBT(s) and the flat cathode terminal pad of the diode can be electrically and thermally attached (e.g., sintered, soldered, etc.) directly to surface 375.

Each of the transistors T5-T8 may include a pair of second current terminal (e.g., source terminal, emitter terminal, etc.) pads. Each second current terminal pad may have a flat surface 395. Each of the transistors T5-T8 may include a control terminal (e.g., gate terminal) pad with a flat surface 384. The pads are not shown in the side view of FIG. 4C-1.

FIG. 4C-1 also shows an example gate strap 364a-2, bond-wire 365-2, and bond-wires 366. Gate strap 364a-2, which may be formed of a conductive metal such as copper, may be attached to surface 375 through an electrically insulating layer (not shown) thereby electrically isolating gate strap 364a-2 from die clip 372. Connector-lead 288g-2 may be electrically connected to gate strap 364a-2 through bond-wire 365-2. Bond-wires 366 of substantially equal length may electrically connect gate strap 364a-2 to respective surfaces 384 of control terminal pads. Each of the bond-wires 366 may be wire-bonded to strap 364a-2 at substantially equal distances from the point on strap 364a-2 where bond-wire 365-2 may be wire-bonded. In an alternative version an end of a length-extended connector-lead 288-2 may be attached (e.g., welded, soldered, etc.) to strap 364a-2. In still another alternative version an end of a length-extended connector-lead 288-2 may be attached to surface 375 through an electrically insulating layer thereby electrically isolating length-extended connector-lead 288-2 from die clip 372. Bond-wires of substantially equal length can electrically connect length-extended connector-lead 288g-2 to respective surfaces 384 of control terminal pads.

With continuing reference to FIGS. 4C-1 and 4A-6, FIG. 4C-2 shows the structure of FIG. 4C-1 after second current terminals of transistors T5-T8 may be thermally and electrically attached (e.g., sintered, soldered, etc.) directly to respective end surfaces 1107 of pedestals 1108, which in turn may be thermally and electrically attached (e.g., sintered, soldered, etc.) directly to respective second terminals of transistors T1-T4, respectively, so that transistors T1-T4 may be electrically connected back-to-back with transistors T5-T8, respectively. For purposes of explanation only, the gate strap 364a, bond-wire 365, and surface area 367 of FIG. 4A-6 may be relabeled gate strap 364a-1, bond-wire 365-1, and surface area 367-1 in FIG. 4C-2. Transistors T1-T4 can be controlled by a first transistor control signal received via connector-lead 288g-1, while transistors T5-T8 can be independently controlled by a separate second transistor control signal received via connector-lead 288g-2.

If T1-T8 may be MOSFETs, the structure shown in FIG. 4C-2 may be one version of the switch module 376J of FIG. 3J in which source terminals of MOSFETs T1-T4 may be electrically connected to source terminals of MOSFETs T5-T8, respectively. After die clip 372 is attached to pedestals 1108, a case may be formed around the switch module shown in FIG. 4C-2 using, for example, transfer molding, to create an example of packaged switch 247qJ shown in FIG. 3J, which is an example of packaged switch 247q shown in FIGS. 2B-1-2B-3. Prior to case formation some or all of connector-leads 288 may be bent to place case-external end portions of the connector-leads 288 in a common plane as shown in FIGS. 2B-3. In an alternative version, connection-lead 288ds and/or 288dc are not included to create an alternative version of packaged switch 247q.

FIG. 4D-1 shows the structure of FIG. 4C-1 after second flat end surfaces of pedestals 1108 may be electrically and thermally attached to adjacent second current terminal (e.g., source terminal, emitter terminal, anode terminal, etc.) pad surfaces 395 in respective transistors T5-T8.

A switch module may include a paddle positioned between a die substrate and a die clip. A paddle may be formed (e.g., stamped, cut, sawed, diced, etc.) from a thin (e.g., 0.7 mm-1.5 mm) sheet of metal or composite. Or a paddle may be formed (e.g., stamped, cut, sawed, diced, etc.) from a thin (e.g., 0.7 mm-1.5 mm) layered sheet like that shown in FIG. 2H. FIG. 4D-2 shows top and side views of an example paddle 361 and example connector-lead 288c. Paddle 361 may be formed from a thin (e.g., 0.7 mm-1.5 mm) sheet of copper. Paddle 361 may have the same size, shape, and composition as die clip 372 shown in FIG. 4A-4-1 but with a connector-lead (e.g., connector-lead 288c) positioned at a midpoint as shown. Connector-lead 288c may be integrally connected to paddle 361 as shown. In another version, connector-lead 288c may be electrically and thermally attached (e.g., welded, soldered, etc.) to the paddle.

Paddle 361 may include oppositely facing, substantially flat surfaces 332 and 334 that may be entirely flat. These surfaces can be electrically and thermally connected to current terminal pad surfaces of transistors. For example, flat surface 332 can be electrically and thermally attached (e.g., sintered, soldered, etc.) directly to first flat end surfaces of first pedestals, and the second flat end surfaces of the first pedestals may be electrically and thermally attached (e.g., sintered, soldered, etc.) directly to respective second current terminals in a group of first transistors, while flat surface 344 can be electrically and thermally attached (e.g., sintered, soldered, etc.) directly to first flat end surfaces of second pedestals, and the second flat end surfaces of the second pedestals may be electrically and thermally attached (e.g., sintered, soldered, etc.) directly to respective second current terminals in a second group of transistors, so that the second current terminals in the first group of transistors may be electrically connected together and to the second current terminals in the second group of transistors, thereby connecting the first group back-to-back with the second group.

FIG. 4D-3 shows paddle 361 of FIG. 4D-2 after it is thermally and electrically attached to the structures shown in FIGS. 4A-6 and 4D-1. Specifically, FIG. 4D-3 shows the structures of FIGS. 4A-6 and 4D-1 after end surfaces 1107 of pedestals 1108 in FIG. 4A-6 may be electrically and thermally attached (e.g., sintered, soldered, etc.) directly to flat surface 334 of paddle 361, and after end surfaces 1107 of pedestals 1108 in FIG. 4D-1 may be electrically and thermally attached (e.g., sintered, soldered, etc.) directly to flat surface 332 of paddle 361. For purposes of explanation only, the gate strap 364a, bond-wire 365, and surface area 367 of FIG. 4A-6 may be relabeled gate strap 364a-1, bond-wire 365-1, and surface area 367-1 in FIG. 4D-3.

Transistors T1-T4 can be controlled by a first transistor control signal received via connector-lead 288g-1, while transistors T5-T8 can be independently controlled by a separate second transistor control signal received via connector-lead 288g-2.

If T1-T8 take form in MOSFETs, the structure shown in FIG. 4D-3 may be one version of the switch module 376K of FIG. 3K. After 361 is attached, a case may be formed around the switch module shown in FIG. 4D-3 using, for example, transfer molding, to create an example of packaged switch 247p shown in FIGS. 2A-1-2A-3. Prior to case formation some or all of connector-leads 288 may be bent to place case-external end portions of the connector-leads 288 in a common plane as shown in FIG. 2A-3.

Switches may include anti-parallel connected transistors. FIG. 4E-1 shows the structure of FIG. 4B-2, without strap 359-2, connector-lead 288g-2, transistor T3, transistor T4, and bond-wires 365-2, 366-3 and 366-4. Bond-wire 365-1 could be replaced with an extended length version of connector-lead 288g-1, the flat surface of one end of which is electrically connected (e.g., soldered) to strap 359-1. FIG. 4E-2 shows the structure of FIG. 4D-1, without transistor T5, transistor T6, bond-wire 366-6, and bond-wire 366-5. Bond-wire 365-2 could be replaced with an extended length version of connector-lead 288g-2, the flat surface of one end of which is electrically connected (e.g., soldered) to strap 364a-2. FIG. 4E-3 shows the structures shown in FIGS. 4E-1 and 4E-2 after they may be thermally and electrically attached (e.g., sintered, soldered, etc.) to each other. Specifically, FIG. 4E-3 shows the structures of FIGS. 4E-1 and 4E-2 after end surfaces 1107 of pedestals 1108 in FIG. 4E-1 may be electrically and thermally attached (e.g., sintered, soldered, etc.) directly to flat surface 375 of die clip 372, and after end surfaces 1107 of pedestals 1108 in FIG. 4E-2 may be electrically and thermally attached (e.g., sintered, soldered, etc.) directly to flat surface 362 of die substrate 360. Transistors T1 and T2 can be controlled by a first transistor control signal received via connector-lead 288g-1, while transistors T7 and T8 can be independently controlled by a separate second transistor control signal received via connector-lead 288g-2.

Transistors T1, T2, T7, and T8 in FIGS. 4E-1-4E-3 may block large reverse voltages (e.g., 5, 10, 50, 100, 200, 400, 800, 1600 V or more) without breakdown when turned off. Each of the transistors T1, T2, T7, and T8 in FIGS. 4E-1-4E-3 may be an RB-IGBT, NPT-IGBT, GTO thyristor, etc. For example, each of transistors T1, T2, T7, and T8 in FIGS. 4E-1-4E-3 may be an RB-IGBT, GTO thyristor, or NPT-IGBT with flat collector terminal pad surfaces of T1 and T2 sintered to flat surface 362, and with flat collector terminal pad surfaces of T7 and T8 sintered to flat surface 375. Transistors T1, T2, T7, and T8 in FIGS. 4E-1-4E-3 may be a mix of transistors. For example, each of transistors T1 and T2 may be an RB-IGBT with flat collector terminal pad surfaces sintered to flat surface 362, while each of the transistors T7 and T8 may be NPT-IGBTs with flat collector terminal pad surfaces sintered to flat surface 375.

If each of transistors T1, T2, T7, and T8 in FIGS. 4E-1-4E-3 are an RB-IGBT, the structure shown in FIG. 4E-3 may be a version of the switch module 376I shown in FIG. 3I. Alternatively, transistors T1, T2, T7, and T8 may be NPT-IGBTs. A case may be formed around the structure shown in FIG. 4E-3 using, for example, transfer molding, to create an example of packaged switch 247qI shown in FIG. 3I, which may be an example of packaged switch 247q shown in FIGS. 2B-1-2B-3. Prior to case formation some or all of connector-leads 288 may be bent to place case-external end portions of the connector-leads 288 in a common plane as shown in FIG. 2B-3. In an alternative version, connection-lead 288ds and/or 288dc are not included to create an alternative version of packaged switch 247q.

Switch modules may include sensors and other devices such as drivers. A switch module may include a PCB or DBC upon which devices such as drivers and sensors may be mounted. FIG. 4F-1 shows the structure of FIG. 4A-2-1 with strap 364a, connector-lead 288g, and bond wire 365 replaced by PCB 340, which may include traces 342. In an alternative version, PCB 340 could be replaced with a DCB, which may be capable of transmitting more heat from a mounted device (e.g., a driver) to the underlying die substrate 360 upon which the DCB is attached. A temperature sensor (e.g., a thermistor) 348 may be mounted on PCB 340 and electrically connected to traces 342-1 and 342-3 as shown. A thermistor may be a type of resistor whose resistance is linearly dependent on temperature. Temperature sensor 348 can measure the temperature near transistors T. Temperature sensor 348 can send a signal representing the temperature to an MCU via traces 342-1 and 342-3. Trace 342-2 may be electrically connected to metallic pad 346. Bond-wires 366 may be wire bonded to pad 346. The flat surface at one end of PCB 340 can be attached (e.g., glued) to surface 362 of die substrate 360. The other end of PCB 340 may extend from die substrate 360. Ends of traces 342 may be electrically connected to conductors of a connector (not shown), which in turn may be attached to a driver or control PCB (not shown) that may include an MCU, drivers, voltage regulators, and/or other components.

FIG. 4F-2 shows the structure of FIG. 4F-1 after surfaces of pedestals 1108 may be electrically and thermally attached (e.g., sintered, soldered, etc.) directly to surfaces 395 of second current terminal (e.g., source terminal, emitter terminal, anode terminal, etc.) pads of transistors T1-T4. Flat first surfaces 1107 in FIG. 4F-2 may be substantially contained in a common plane to accommodate attachment to a flat surface of a die clip. FIG. 4F-3 show top and side views of the structure in FIG. 4F-2 after a die clip, such as die clip 372 of FIG. 4A-4-1, is added. Specifically FIG. 4F-3 shows the structure after flat surface 375 of die clip 372 is electrically and thermally attached (e.g., sintered, soldered, etc.) directly to flat surfaces 1107 of pedestals 1108. Each of transistors T1-T4 in FIGS. 4F-1-4F-3 may be a MOSFET. After die clip 372 is attached to pedestals 1108, a case may be formed around the switch module of FIG. 4F-3 using, for example, transfer molding, to create an example of packaged switch 247b shown in FIGS. 2D-22-2D-43. Prior to case formation connector-leads 288ds and/or 288dc may be bent to place case-external end portions of the connector-leads 288dc and 288ds in a common plane. Packaged switch 247b can replace instances of packaged switches 247d employed in converters or other power apparatuses described herein.

The example bidirectional packaged switches shown in FIGS. 3G, 3H and 3L include BBJTs, which may be electrically and thermally connected (e.g., sintered, soldered, etc.) between die substrates and die clips. FIG. 4G-1 shows top and side views of the example BBJT 250 shown in FIG. 2F, which may include example collector/emitter (c/e) terminal pads 262 and base terminal pads 264 on a top side, and example collector/emitter (c/e) terminal pads 272 and base terminal pads 278 on an oppositely facing bottom side. The c/e pads 262 and base terminal pads 264 may have substantially flat surfaces 280 and 282, respectively, and c/e pads 272 and base terminal pads 278 may have substantially flat surfaces 284 and 286, respectively. Surfaces 280 and 282 may be contained in a common plane, and surfaces 284 and 286 may be contained in another common plane. Flat surfaces 280 can be electrically and thermally connected (e.g., sintered, soldered, etc.) directly to flat surfaces of respective pedestals. Flat surfaces 282 can be connected (e.g., welded, soldered, etc.) to a flat surface of a first signal frame. Or flat surfaces 282 can be connected (e.g., sintered, soldered, etc.) to respective flat surfaces of control-terminal posts such as those shown in FIG. 2J-3, 2K-3, or 2L. Likewise, flat surfaces 284 can be electrically and thermally connected (e.g., sintered, soldered, etc.) directly to flat surfaces of respective pedestals. Flat surfaces 286 can be connected (e.g., welded, soldered, etc.) to a flat surface of second signal frame. Or flat surfaces 284 can be connected (e.g., sintered, soldered, etc.) to respective flat surfaces of control-terminal posts such as those shown in FIG. 2J-3, 2K-3, or 2L.

FIG. 4G-2 shows top and side views of BBJT 250 with signal frames 377-1 and 377-2 connected to base terminal pad surfaces 282 and 286, respectively. Specifically, a flat surface of signal frame 377-1 is connected to flat surfaces 282 of base terminal pads 264 on the top side of BBJT 250, and a flat surface of signal frame 377-2 is connected to flat surfaces 286 of base terminal pads 278 on the bottom side of BBJT 250. Signal frames 377 may be formed (e.g., cut, stamped, diced, etc.) from a thin (e.g., 0.2 mm-2.0 mm) sheet of pure metal such as copper. Signal frames can transmit base control signals to base terminal pads.

Pedestals can be connected to flat surfaces of c/e terminal pads. FIG. 4G-3 is a top view of the structure shown in FIG. 4G-2 after pedestals 1112 are electrically and thermally attached (e.g., sintered, soldered, etc.) directly to surfaces 280 on the top side of BBJT 250. Although not shown in FIG. 4G-2 other pedestals 1112 may be similarly attached (e.g., sintered, soldered, etc.) directly to surfaces 284 of the c/e terminals pads on the bottom side of BBJT 250. FIG. 4G-4 shows a side view of the structure in FIG. 4G-3. FIG. 4G-5 shows a cross-sectional view of the structure in FIG. 4G-3 taken along line 3-3. Pedestals 1112 may be formed from sheets 265 or 279 shown in FIGS. 2H and 2I, respectively. Pedestals 1112 may have oppositely facing flat first and second surfaces of the same size (e.g., width 0.5-3 mm and length 5-13 mm) and shape (rectangular with rounded ends as shown, rectangular with squared corners, etc.). Only first flat surfaces 1113 are shown in FIG. 4G-3. The second flat surfaces may be electrically and thermally attached (e.g., sintered, soldered, etc.) directly to flat surfaces 280 or 284 of respective c/e terminal pads 262 or 272. The flat second end surfaces of pedestals 1112 may have a shape (e.g., rectangular with rounded ends as shown, rectangular with square corners, etc.) that may be like the shape of flat surfaces 280 or 284 to which pedestals 1112 may be electrically and thermally attached. The flat second end surfaces of pedestals 1112 may have a surface area that may be equal to, slightly larger than, or slightly smaller than the surface areas, respectively, of the substantially flat surfaces 280 or 284 of respective second current terminal pads 262 or 272 to which they may be electrically and thermally attached so that the flat second end surfaces contact all or most (i.e., 51%-99%) of flat surfaces 280 or 284 through a connection material (e.g., sintered material). FIG. 4G-4 shows flat first surfaces 1113 may be contained substantially in a common plane to accommodate attachment to a flat surface of a bridge, die clip or other device.

A die clip and a die substrate can be electrically and thermally attached (e.g., sintered, soldered, etc.) directly to surfaces 1113 of pedestals 1112. FIG. 4G-6 illustrates top and side views of the of the structure shown in FIG. 4G-3 after a die substrate, such as die substrate 360 of FIG. 4A-1, is electrically and thermally attached (e.g., sintered, soldered, etc.) directly to flat end surfaces 1113 of pedestals 1112 on the bottom side of BBJT 250. More specifically, the first flat surfaces of pedestals 1112 may be sintered to surface 362 of die substrate 360. FIG. 4G-6 also shows connector leads 288g-1 and 288g-2, which may be electrically connected to signal frames 377-1 and 377-2, respectively, through bond-wires 365-1 and 365-2, respectively. FIG. 4G-7 illustrates top and side views of the of the structure shown in FIG. 4G-6 after a die clip, such as die clip 372 of FIG. 4A-4-1, is electrically and thermally attached (e.g., sintered, soldered, etc.) directly to pedestals 1112 on the top side of BBJT 250 as shown. More specifically, the first flat surfaces 1113 of pedestals 1112 may be sintered to surface 375 of die clip 372. Die substrate 360 and/or die clip 372 may be formed metal sheets such as sheet 265 or 279 shown in FIGS. 2H and 2I, respectively.

The structure shown in FIG. 4G-7 is one example of the switch module 376G shown in FIG. 3G. A case may be formed around the structure shown in FIG. 4G-7 using, for example, transfer molding, to create an example of packaged switch 247qG shown in FIG. 3G, which is an example of packaged switch 247q of FIGS. 2B-1-2B-3. Prior to case formation some or all of connector-leads 288 may be bent to place case-external end portions of the connector-leads 288 in a common plane as shown in FIG. 2B-3. In an alternative version, connection-lead 288ds and/or 288dc are not included to create an alternative version of packaged switch 247q.

The bidirectional packaged switch shown in FIG. 3L may include four BBJTs electrically and thermally connected (e.g., sintered, soldered, etc.) between a die substrate 360 and die clip 372. FIG. 4G-8 shows a top view of four BBJTs 250. Signal frames 377e-1 and 377e-2 may be connected to base terminal pad surfaces on the top and bottom sides, respectively, of BBJTs 250-1-250-4. Specifically, a flat surface of signal frame 377e-1 may be connected (e.g., soldered) to flat surfaces 282 of base terminal pads on the top sides of BBJTs 250-1-250-4, and a flat surface of signal frame 377e-2 may be connected (e.g., soldered) to flat surfaces of base terminal pads 286 on the bottom side of BBJTs 250-1-250-4. Signal frames 377 may be formed (e.g., cut, stamped, diced, etc.) from a thin (e.g., 0.5 mm-2.0 mm) sheet of metal such as copper. Signal frames can transmit base control signals to base terminal pads.

Pedestals 1112 can be connected to flat surfaces of c/e terminal pads on both side of BBJTs 250-1-250-4. First flat surfaces 1113 are shown in FIG. 4G-8. The second flat surfaces of pedestals 1112 may be electrically and thermally attached (e.g., sintered, soldered, etc.) directly to flat surfaces 280 or 284 of respective c/e terminal pads 262 or 272. The second flat end surfaces of pedestals 1112 may have a shape (e.g., rectangular with rounded ends as shown, rectangular with square corners, etc.) like the shape of flat surfaces 280 or 284 of respective second current terminal pads 262 or 272 to which they may be electrically and thermally attached. The second flat end surfaces of pedestals 1112 may have a surface area that may be equal to, slightly larger than, or slightly smaller than the surface areas, respectively, of the substantially flat surfaces 280 or 284 of respective second current terminal pads 262 or 272 to which they may be electrically and thermally attached so that the flat second end surfaces contact all or most (i.e., 51%-99%) of flat surfaces 280 or 284 through a connection material (e.g., sintering material). A die clip and a die substrate can be electrically and thermally attached (e.g., sintered, soldered, etc.) directly to pedestals 1112 of the structure shown in FIG. 4G-8. FIGS. 4G-9 and 4G-10 illustrate top and side views of the of the structure shown in FIG. 4G-8 after a die substrate, such as die substrate 360 of FIG. 4A-1, is electrically and thermally attached (e.g., sintered, soldered, etc.) directly to pedestals 1112 on the bottom sides of BBJTs 250-1-250-4. More specifically, the first flat end surfaces 1113 of pedestals 1112 on the bottom sides of BBJTs 250-1-250-4 may be sintered to surface 362 of die substrate 360. FIG. 4G-9 also shows connector leads 288g-1 and 288g-2, which may be electrically connected to signal frames 377e-1 and 377e-2, respectively, by bond-wires 365-1 and 365-2, respectively. FIGS. 4G-11 and 4G-12 illustrate side and top views of the of the structure shown in FIG. 4G-10 after a die clip, such as die clip 372 of FIG. 4A-4-1, is electrically and thermally attached (e.g., sintered, soldered, etc.) directly to pedestals 1112 on the top sides of BBJTs 250-1-250-4. More specifically, the first flat end surfaces 1113 of pedestals 1112 on the top side of BBJTs 250-1-250-4 may be sintered to surface 375 of die clip 372.

The structure shown in FIGS. 4G-11 and 4G-12 is one example of the switch module 376L shown in FIG. 3L. A case may be formed around the structure shown in FIG. 4G-11 using, for example, transfer molding, to create an example of packaged switch 247ql shown in FIG. 3L, which is an example of packaged switch 247q shown in FIGS. 2B-1-2B-3. Prior to case formation some or all of connector-leads 288 may be bent to place case-external end portions of the connector-leads 288 in a common plane as shown in FIG. 2B-3. In an alternative version, connection-lead 288ds and/or 288dc are not included to create an alternative version of packaged switch 247q.

FIGS. 4G-2-4G-12 illustrate examples of power stacks in which signal frames may be electrically connected to the base terminals surfaces 282 and 286 of example BBJT 250. In an alternative embodiment, control-terminal posts, such as control-terminal posts 191, 295, or 296 shown in FIG. 2J-3, 2K-3, or 2L, respectively, can be electrically connected (e.g., sintered, soldered, etc.) to base terminals surfaces 282 and 286 of BBJTs. In addition to transmitting transistor control signals (e.g., base control signals) to base terminals surfaces 282 and 286, control-terminal posts can transmit heat, but not electrical current, from base terminals surfaces 282 and 286 to a die clip or die substrate.

FIG. 4G-13 shows the structure of FIG. 4G-3 with the signal frames 377 replaced by control-terminal posts 295, it being understood that other control-terminal posts, such as control-terminal posts 291 or 297, can be connected (e.g., sintered, soldered, etc.) to base terminals surfaces 282 and 286. First flat surfaces 277 of control-terminal posts 295 may be connected (e.g., sintered, soldered, etc.) to respective flat surfaces 282 of base terminal pads 264 on the top side of BBJT 250, and first flat surfaces 277 of control-terminal posts 295 may be connected to respective flat surfaces 286 of base terminal pads 278 on the bottom side of BBJT 250. Pedestals 1112 and control-terminal posts 295 on the top side of BBJT 250 may have substantially the same height (or thickness) so that surfaces 1113 and 275 of pedestals 1112 and control-terminal posts 295, respectively, may be contained in a common plane to accommodate connection of surfaces 1113 and 275 to a flat surface of a die substrate, die clip or another device. Pedestals 1112 and control-terminal posts 295 on the bottom side of BBJT 250 may have substantially the same height (or thickness) so that surfaces 1113 and 275 of pedestals 1112 and control-terminal posts 295, respectively, may be substantially contained in a common plane to accommodate connection of surfaces 1113 and 275 to a flat surface of a die substrate, die clip or another device.

Control-terminal posts can be connected to flat surfaces of base terminal pads. FIG. 4G-13 shows control-terminal posts 295 electrically and thermally attached (e.g., sintered, soldered, etc.) directly to surfaces 280 on the top side of BBJT 250. Although not shown in FIG. 4G-13 other control-terminal posts 295 may be similarly attached (e.g., sintered, soldered, etc.) directly to surfaces 286 on the bottom side of BBJT 250. FIG. 4G-15 shows a side view of the structure in FIG. 4G-13. FIG. 4G-14 shows a cross-sectional view of the structure in FIG. 4G-13 taken along line 4-4. Control-terminal posts 295 may have oppositely facing first and second flat surfaces 275 and 277, respectively, with the same size (e.g., width 0.3-3.0 mm and length 5.0-13.0 mm) and shape (rectangular with rounded ends, rectangular with squared corners as shown, etc.). Only the first flat surfaces 275 are shown in FIGS. 4G-13 and 4G-15. The second flat surfaces 277 may be electrically and thermally attached (e.g., sintered, soldered, etc.) directly to flat surfaces 282 or 286 of respective control-terminal pads 264 or 278. The second flat end surfaces 277 of control-terminal posts 295 may have a shape (e.g., rectangular with rounded ends, rectangular with square corners as shown, etc.) that may be like the shape of flat surfaces 282 or 286 of respective control-terminal pads 262 or 272 to which they may be electrically attached. The flat second end surfaces 277 of control-terminal posts 295 may have a width that may be equal to, slightly larger than, or slightly smaller than width of surfaces 282 or 286 to which they may be electrically and thermally attached. The second flat end surfaces 277 of control-terminal posts 295 may have a length that may be greater than the length of surfaces 282 or 286 to which they may be electrically attached. The flat second end surfaces 277 of control-terminal posts 295 connect to all or most (i.e., 51%-99%) of flat surfaces 282 or 286 through a connection material (e.g., sintering material). However, control-terminal posts 295 extend beyond borders of BBJT 150 as shown, which exposes a portion of the second flat end surfaces 277 for electrical connection to a strap as will be more fully described below.

FIG. 4G-16 shows a top view of the structure of FIG. 4G-13 with flat surfaces of straps 1116-1 and 1116-2 connected (e.g., welded, soldered, etc.) to surfaces 277 of control-terminal posts 295 that extend beyond the borders of BBJT 250. Specifically, a flat surface of strap 1116-1 may be connected to second flat surfaces 277 of control-terminal posts 295 on the top side of BBJT 250, and a flat surface of strap 1116-2 may be connected to second flat surfaces 277 of control-terminal posts 295 on the bottom side of BBJT 250. Straps 1116 may be formed (e.g., cut, stamped, diced, etc.) from a thin (e.g., 0.2 mm-2.0 mm) sheet of pure metal such as copper. Straps 1116 can transmit base control signals (e.g., current signals of 1, 5, 10 A or more) to base terminal pads. FIG. 4G-17 shows a cross-sectional view of the structure in FIG. 4G-16 taken along line 5-5. FIG. 4G-17 shows a side view of the structure in FIG. 4G-16.

FIG. 4G-19 illustrates top and side views of the of the structure shown in FIG. 4G-16 after a die substrate, such as die substrate 360 of FIG. 4A-1, is electrically and thermally attached (e.g., sintered, soldered, etc.) directly to flat end surfaces 1113 and 275 of pedestals 1112 and control-terminal posts 295, respectively, on the bottom side of BBJT 250 as shown. More specifically, the first flat surfaces of pedestals 1112 and control-terminal posts 295 may be sintered to surface 362 of die substrate 360. FIG. 4G-19 also shows connector leads 288g-1 and 288g-2, which may be electrically connected to straps 1116-1 and 1116-2, respectively, by bond-wires 365-1 and 365-2, respectively. FIG. 4G-20 illustrates top and side views of the of the structure shown in FIG. 4G-19 after a die clip, such as die clip 372 of FIG. 4A-4-1, is electrically and thermally attached (e.g., sintered, soldered, etc.) directly to pedestals 1112 and control-terminal posts 295 on the top side of BBJT 250 as shown. More specifically, the first flat surfaces of pedestals 1112 and control-terminal posts 295 may be sintered to surface 375 of die clip 372.

FIG. 4G-21 shows four BBJTs 250 with pedestals 1114e and control-terminal posts 295e electrically and thermally connected (e.g., sintered, soldered, etc.) directly to c/e terminal pads and base terminal pads, respectively. FIG. 4G-25 shows a side view of the structure in FIG. 4G-21. With continuing reference to FIGS. 4G-21 and 4G-25, control-terminal posts 295e may be the same as control-terminal posts 295 but with longer lengths (i.e., length of 10-26 mm). Pedestals 1112e may be the same as pedestals 1112 but with longer lengths (i.e., length of 10-26 mm). Pedestals 1112e and control-terminal posts 295e on the top side of BBJT 250 may have substantially the same height (or thickness) so that surfaces 1113e and 275e of pedestals 1112e and control-terminal posts 295e, respectively, may be contained in a common plane to accommodate connection of surfaces 1113e and 275e to a flat surface of a die substrate, die clip or another device. Pedestals 1112e and control-terminal posts 295e on the bottom side of BBJT 250 may have substantially the same height (or thickness) so that surfaces 1113 and 275 of pedestals 1112 and control-terminal posts 295e, respectively, may be substantially contained in a common plane to accommodate connection of surfaces 1113e and 275e to a flat surface of a die substrate, die clip or another device.

The second flat surface 277e of each control-terminal post 295e may be electrically and thermally connected (e.g., sintered, soldered, etc.) directly to flat surfaces 282 or 286 of a pair of base terminal pads 264 on the top or bottom side of two adjacent BBJT 250s. The second flat surface of each pedestal 1112e may be electrically and thermally attached (e.g., sintered, soldered, etc.) directly to flat surfaces 280 or 284 of a pair of c/e terminals 262 or 282 on the top or bottom side of two adjacent BBJT 250s. The substantially flat surfaces 282 or 286 of each pair of base terminal pads 264 or 278 in adjacent BBJTs may be fully or mostly (i.e., 51%-99%) connected (e.g., sintered, soldered, etc.) electrically and thermally to the second flat surface 277e of a control-terminal post 295e so that the second flat end surface 277e contacts all or most of the adjacent pair of flat surfaces 282 or 286 through a connection material (e.g., sintering material). The substantially flat surfaces 280 or 284 of each pair of c/e terminal pads 262 or 272 in adjacent BBJTs may be fully or mostly (i.e., 51%-99%) connected (e.g., sintered, soldered, etc.) electrically and thermally to the second flat surface of a pedestal 1112e so that the second flat end surface contacts all or most of the adjacent pair of flat surfaces 280 or 284 through a connection material (e.g., sintering material). Control-terminal posts 295e extend beyond borders of BBJTs 150 as shown, which exposes a portion of the second flat end surfaces 277e for electrical connection to a strap as will be more fully described below.

FIG. 4G-22 shows a top view of the structure of FIG. 4G-21 with straps 377-1 and 377-2 connected (e.g., welded, soldered, etc.) to surfaces 277e of control-terminal posts 295e extending beyond borders of BBJTs 250. FIG. 4G-26 shows a side view of the structure shown in FIG. 4G-22. A flat surface of strap 377-1 may be connected to flat surfaces 277e of control-terminal posts 295e on the top side of BBJTs 250, and a flat surface of strap 377-2 may be connected to flat surfaces 277e of control-terminal posts 295e on the bottom side of BBJTs 250. Straps 377 may be formed (e.g., cut, stamped, diced, etc.) from a thin (e.g., 0.2 mm-2.0 mm) sheet of pure metal such as copper. Straps 377 can transmit base control signals to base terminal pads.

FIGS. 4G-23 and 4G-26 illustrate top and side views of the of the structure shown in FIG. 4G-12 after a die substrate, such as die substrate 360 of FIG. 4A-1, is electrically and thermally attached (e.g., sintered, soldered, etc.) directly to flat end surfaces of pedestals 1112e and control-terminal posts 295e on the bottom side of BBJTs 250 as shown. More specifically, the first flat surfaces of pedestals 1112e and control-terminal posts 295e may be sintered to surface 362 of die substrate 360. FIG. 4G-23 also shows connector leads 288g-1 and 288g-2, which may be electrically connected to straps 377-1 and 377-2, respectively, by bond-wires 365-1 and 365-2, respectively. Bond-wires, such as bond-wires 356, may be swapped with bond-ribbons. FIGS. 4G-24 and 4G-27 illustrate top and side views of the of the structure shown in FIG. 4G-23 after a die clip, such as die clip 372 of FIG. 4A-4-1, is electrically and thermally attached (e.g., sintered, soldered, etc.) directly to pedestals 1112e and control-terminal posts 295e on the top side of BBJTs 250 as shown. More specifically, the first flat surfaces of pedestals 1112e and control-terminal posts 295e may be sintered to surface 375 of die clip 372.

FIG. 4H shows top and side views of an example diode module 278N of FIG. 3N, which may include a pair of diodes D1 and D2 sandwiched between die clip 372 and die substrate 360. D1 and D2 may be diodes of the same type, or D1 and D2 may include a mixture of different types of diodes.

FIG. 4H shows diodes D1 and D2 after flat surfaces of their first current terminal (e.g., cathode terminal, not shown) pads may be electrically and thermally connected (e.g., sintered, soldered, etc.) directly to surface 362. A low resistance path may exist between die substrate terminal 230 and each first current terminal pad. Each die substrate joint (e.g., sintered joint, not shown) in FIG. 4H that connects a first current terminal pad surface to surface 362 may conduct 10, 20, 50, 100, 200, 300, 750 Watts or more of heat while concurrently conducting 50, 100, 200, 400 A or more of electrical current. Each die substrate joint may have a length and width that may be substantially equal to the length and width of a respective first current terminal pad surface.

Each diode D1 and D2 may include a second current terminal (e.g., anode terminal, not shown) pad. Each second current terminal pad may have a flat surface. FIG. 4H shows pedestals 1117, which may be substantially like pedestals 1108 described above. Each pedestal 1117 may have opposite facing first and second flat end surfaces. Second flat end surfaces of pedestals 1117 may be electrically and thermally attached (e.g., sintered, soldered, etc.) directly to respective flat surfaces of second current terminal pads in diodes D1 and D2. The flat second end surfaces of pedestals 1117 may have a shape and size substantially like, but slightly smaller than the shape and size of flat surfaces of respective second current terminal pads to which they may be electrically and thermally attached. Each second joint (e.g., sintered joint) that connects a second current terminal pad surface to a second flat end surface of a pedestal 1117, and each pedestal 1117, may conduct 10, 20, 50, 100, 100, 200, 300, 600 Watts or more of heat while concurrently conducting 10, 20, 50, 100, 400 A or more of electrical current. Each of these second joints may have a length and width that may be substantially equal to the length and width of the respective second flat end surface of pedestals 1117.

FIG. 4H shows flat surface 375 of die clip 372 electrically and thermally attached (e.g., sintered, soldered, etc.) directly to first flat end surfaces of pedestals 111. Each die clip joint (e.g., sintered joint) that connects a first flat end surface of a pedestal 1117 to surface 375 may conduct 10, 20, 50, 100, 300 Watts or more of heat while concurrently conducting 10, 20, 50, 100, 200 A or more of electrical current. Each die clip joint may have a length and width that may be substantially equal to the length and width of a respective first flat end surface of a pedestal 1117. A low resistance path may exist between die clip terminal 344 and each second current terminal pad of diodes D1 and D2.

A case may be formed around example diode module 378 of FIG. 4H using, for example, transfer molding, to create an example of packaged diode 245 shown in FIGS. 2E-1-2E-3. Prior to case formation connector-leads 288 may be bent to place case-external end portions of the connector-leads 288 in a common plane as shown in FIG. 2E-3. In an alternative version, connection-lead 288ds and 288dc are not connected to die substrate 360 and die clip 372 to create a “connector-lead less” version of packaged diode 245.

Power converters include inverters. FIGS. 5A-1, 5A-2S, and 5A-2T illustrate relevant components of an example three-phase inverter 460iT when seen from the front, side, and top, respectively. Several components (e.g., PCB 461iT, PCB 462iT, and capacitors 403T) shown in FIGS. 5A-2S and 5A-2T are not shown or fully shown in FIG. 5A-1 but are described below. Several components (e.g., packaged switches 247, drivers 306, voltage sensors V_sense, PMICs, etc.) shown in FIGS. 5A-1 and 5A-2S are not shown in FIG. 5A-2T but are described below. PCB 462iT is omitted from FIG. 5A-2T.

Inverter 460iT is electrically connected to windings Wa-Wc, which may be part of a stator in a motor/generator. Inverter 460iT should not be limited to use with a motor/generator. Inverter 460iT could be used to convert DC power into three-phase AC power to an electric grid (e.g., microgrid, wide area grid, etc.).

Inverter 460iT may be bidirectional. Inverter 460iT can convert DC power from a battery or other source (e.g., DC/DC converter) connected between terminals V+ and V− into three-phase AC power. Inverter 460iT can convert three-phase AC power into DC power for any one of many purposes such as charging a battery electrically connected between terminals V+ and V−.

Converters and other power apparatuses of this disclosure may employ packaged switches 247 and/or packaged diodes 245. For ease of illustration and explanation, packaged switches 247 are symbolized in FIGS. 5A-1, 5A-2S and other figures described below. The connector-leads 288 of packaged switches 247 are not symbolized in FIG. 5A-2T. Packaged diodes 245 are symbolized in figures described below.

Example inverter 460iT employs packaged switches 247d, it being understood that packaged switches 247d can be replaced with packaged switches 247p or packaged switches 247q. Some, most or all packaged switches 247 of a converter such as inverter 460iT may be the same type. Packaged switches 247d of inverter 460iT may be packaged switch 247dA, 247dB, or 247dD of FIGS. 3A, 3B, and 3D, respectively.

Converters and other power apparatuses of this disclosure may employ bus bars to distribute electric current to and from switches 304 or diodes D. Inverter 460iT includes five bus bars; V+ bus bar 417T, V-bus bar 412T, and three phase bus bars 418T. Bus bars, like V+ bus bar 417T, V-bus bar 412T, and phase bus bars 418T, may also act as heat sinks to cool switches 304 or diodes D electrically connected thereto as will be more fully described below. Case surfaces of packaged switches 247, like packaged switches 247d in FIG. 5A-1, may be thermally connected to flat surfaces of bus bars, like V+ bus bar 417T, V-bus bar 412T, and phase bus bars 418T.

Bus bars may have different shapes or dimensions to accommodate differences in converter design. Bus bars, like the bus bars shown in FIGS. 5A-1, 5A-2S, and 5A-2T, may have a generally rectangular cuboid shape. Each bus bar may have substantially flat top and bottom surfaces that are parallel to each other, substantially flat side walls that are parallel to each other and perpendicular to the top and bottom surfaces, and end surfaces that are parallel to each other and perpendicular to the top, bottom, and side surfaces.

Phase bus bars 418, such as phase bus bar 418T, are generally rectangular cuboid in shape. Phase bus bar 418T may have a height, width, and length around 12 mm, 25 mm, and 20 mm, respectively. DC bus bars 417 and 412, including V+ bus bar 417T and V− bus bar 412T, are generally rectangular cuboid in shape. V+ bus bar 417T and V− bus bar 412T may have a height, width, and length around 8 mm, 25 mm, and 70 mm, respectively. FIG. 5A-1 shows the height and length of bus bars of inverter 460iT, while FIG. 5A-2S shows the height and width. FIG. 5A-2T shows the width and length of V+ bus bar 417T. In general, bus bars in a converter may be parallel to each other. Phase bus bars 412T, 417T, and 418T in FIGS. 5A-1 and 5A-2S are shown parallel to each other so that all top and bottom surfaces of the bus bars are parallel to each other, and all side walls of the bus bars are parallel to each other and perpendicular to the top surfaces, the bottom surfaces and the end surfaces.

A converter, such as inverter 460iT, may have one or more legs, each of which may include: packaged switches electrically connected in series; a first set of packaged switches electrically connected in parallel, the combination of which is electrically connected in series with a second set of packaged switches that are electrically connected in parallel; packaged diodes electrically connected in series; a first set of diodes electrically connected in parallel, the combination of which is electrically connected in series with a second set of diodes that are electrically connected in parallel; a packaged switch electrically connected in series with a packaged diode; a set of packaged switches electrically connected in parallel, the combination of which is electrically connected in series with a set of packaged diodes that are electrically connected in parallel; a first packaged diode electrically connected in parallel or anti-parallel with a first packaged switch, the combination of which is connected in series a second packaged diode electrically connected in parallel or anti-parallel with a second packaged switch, or; a first combination of one or more packaged switches electrically connected to one or more packaged diodes, the combination of which is electrically connected in series with a second combination of one or more packaged switches electrically connected to one or more packaged diodes. Other leg configurations are contemplated. Each packaged switch or diode in a leg may be thermally and electrically connected to and sandwiched between a pair of bus bars. Each packaged switch or diode in a leg may be thermally connected and sandwiched between a pair of heat sinks.

Inverter 460iT is shown with three legs designated a-c. Each leg may include packaged switches 247dH and 247dL that are electrically and thermally connected to a respective phase bus bar 418T, which in combination may be sandwiched between V+ bus bar 417T and V-bus bar 412T as shown. Phase bus bars 418Ta-418Tc may be electrically connected to respective windings Wa-Wc as shown. Packaged switches 247dH and 247dL may be also electrically and thermally connected to V+ bus bar 417T and V− bus bar 412T, respectively, as shown. V+ bus bar 417T and V− bus bar 412T may be electrically connected as shown to terminals V+ and V−, respectively, of DC supply such as a battery.

Converters and other power apparatuses of this disclosure have high power densities. For example, an inverter can deliver 5, 50, 100, 200, 400 kW or more of power while occupying a small volume. The volume of converters may be conserved in part by stacking bus bars with packaged switches 247 and/or packaged diodes 245. FIG. 5A-1 illustrates the relative positioning of packaged switches 247d, V+ bus bar 417T, phase bus bars 418T, and V-bus bar 412T. The stacks of bus bars and packaged switches 247 as connected in FIG. 5A-1 should not be limited to use in an inverter. The stacks of connected bus bars and packaged switches 247 shown in FIG. 5A-1 can be employed in other types of power converters. Further the connected stack(s) of bus bars, heat sinks, packaged switches 247 and/or packaged diodes in the figures of this disclosure should not be limited to any type of power converter (e.g., battery charger, Vienna rectifier, etc.), solid-state circuit breaker, solid-state contactor or other power apparatus.

Packaged switches 247, such as packaged switch 247dH in FIG. 5A-1, may have die substrate terminals, such as die substrate terminals 230 in FIG. 5A-1, that are electrically and thermally connected (e.g., soldered, sintered, press-fitted, etc.) to a flat surface or respective flat surfaces of a bus bar, such as V+ bus bar 417T as shown for example in FIG. 5A-1, and die clip terminals, such as die clip terminals 344 in FIG. 5A-1, that are electrically and thermally connected (e.g., soldered, sintered, press-fitted, etc.) to flat surfaces of respective phase bus bars, such as phase bus bars 418Ta-418Tc as shown for example in FIG. 5A-1. Packaged switches 247, such as packaged switches 247L in FIG. 5A-1, may have die substrate terminals 230 that are electrically and thermally connected (e.g., soldered, sintered, press-fitted, etc.) to flat surfaces of respective phase bus bars, such as phase bus bars 418Ta-418Tc as shown for example in FIG. 5A-1, and die clip terminals 344 that may be electrically and thermally connected (e.g., soldered, sintered, press-fitted, etc.) to a flat surface or respective flat surfaces of a bus bar, such as V-bus bar 412T as shown for example in FIG. 5A-1

A bus bar or heat sink may receive one or more tubes. A tube may be considered received in a bus bar or heat sink when the bus bar or heat sink is formed (e.g., cast, sintered, soldered, etc.) around the tube. FIGS. 5A-1 and 5A-2S show example tubes 420a received in bus bars of inverter 460iT. FIGS. 5A-1 and 5A-2S show cylindrical shaped tubes 420a with circular channels, it being understood that tubes of other shapes (e.g., oval, square, rectangular) may be received in bus bars or heat sinks. Tube channels may have cross-sectional shapes (e.g., oval, square, rectangular, etc.) other than circular. A fluid such as air, dielectric liquid, or non-dielectric liquid may flow through tubes that are received in bus bars or heat sinks. Tubes received in bus bars or heat sinks may be in fluid communication with a pump, pipes, heat exchanger, radiator, manifolds, or other components of a fluid circuit.

Two or more bus bars, such as phase bus bars 418T, may commonly receive one or more tubes. Two or more bus bars with at least one commonly received tube, may be substantially identical in size and shape. Bus bars that commonly receive one or more tubes, may be generally rectangular cuboid in shape with substantially the same height, width, and length. Tubes commonly received by two or more bus bars, such as phase bus bars 418T, may thermally couple the two or more bus bars, but the tubes should not electrically couple the two or more bus bars.

Bus bars, such as phase bus bars 418T, that commonly receive tubes may be aligned so that flat surfaces of bus bars may face the same direction and may be substantially coplanar. Aligned bus bars with at least one commonly received tube, such as phase bus bars 418T, may have flat surfaces that are coplanar with each other and electrically and thermally connected to respective die substrate terminals or die clip terminals of respective packaged switches 247 or packaged diodes 245.

A tube may be received in a bus bar or heat sink through a “tube joint,” which may also be known as a “tube interface.” A tube joint may be circular and may connect an outer surface of a circular tube (also known as a cylindrical tube) to a bus bar or heat sink in which it is received. A tube joint may be oval, rectangular, or square and may connect an outer surface of an oval, rectangular, or square shaped tube, respectively, to a bus bar or heat sink in which it is received. A tube joint is thermally conductive. A tube joint may electrically connect a tube to the bus bar or heat sink in which it is received, or a tube joint may electrically isolate the tube from the bus bar or heat sink in which it is received. When a tube is received in a bus bar or heat sink without a tube joint, the outer surface of the tube is directly connected with the bus bar or heat sink. A tube may be considered received in a bus bar without a tube joint when, for example, the bus bar is sintered or cast around the tube.

A tube joint may be created from “join material” such as thermal grease, thermal interface material (TIM), thermal gel, heat paste, heat sink compound, heat sink paste, CPU grease, solder paste or preform, sinter paste or preform, silver paste or preform, thermosetting conductive adhesive, electrically insulating glue, multi-layer foil including reactive multi-layer foil fabricated by vapor-depositing alternating layers of aluminum and nickel, etc. Join material is thermally conductive. Join material may be electrically conductive or electrically non-conductive (i.e., dielectric).

Each bus bar or heat sink may receive one or more rows of tubes. Each V+ bus bar 417T and V-bus bar 412T may have single row of three tubes 420a, and each phase bus bar 418T may have two rows of three tubes 420a as shown. In an alternative version, each phase bus bar 418T may have only one row of tubes 420a and could be formed using the process described below with reference to FIGS. 5A-17-6-5A-17-10. All tubes in all bus bars or heat sinks of a converter or other power apparatus may have the same cross-sectional dimensions and shape. The cross-sectional dimensions and/or shapes of tubes may vary in a bus bar or heat sink. The cross-sectional dimensions and/or shapes of tubes can vary between bus bars or heat sinks in a converter or other power apparatus. For example, circular tubes in a phase bus bar, such as phase bus bar 418T, of a converter may have a larger diameter than tubes in a V− bus bar, such as V− bus bar 417T, of the converter.

Each row of tubes in a converter or other power apparatus may have the same number of tubes. The number of tubes in rows may differ in or between bus bars or heat sinks in a converter or other power apparatus. For example, a V− bus bar in a converter may have one row of two tubes, while a V+ bus bar in the converter may have one row of three tubes, or vice versa. A V− bus bar in a converter may have one row with one tube, a V+ bus bar in the converter may have one row of two tubes, and a phase bus bar positioned between the V+ and V− bus bars may have one row of three tubes. A bus bar (e.g., a phase bus bar) may have two rows of tubes, the first row having two tubes and the second row having three tubes.

Tubes may be positioned parallel with and near (e.g., within 8, 4, 3 mm or less) a flat surface of a bus bar that is connected (e.g., sintered, soldered, etc.) to a die clip or die substrate terminal. Tubes may extend parallel to each other and to the long axis of heat sinks or bus bars. In an alternative version, tubes could extend parallel to each other and perpendicular to the long axis of heat sinks or bus bars. The remaining disclosure will presume that tubes extend parallel to each other and to the long axis of heat sinks or bus bars in which they are contained unless otherwise noted.

A tube may be formed (e.g., extruded) from a dielectric material. These tubes are referred to as “dielectric tubes.” Dielectric tubes include “ceramic tubes” or tubes formed (e.g., extruded) from a ceramic material, such as aluminum nitride or beryllium oxide. Ceramic tubes may be formed from other materials listed in the table of this disclosure. Tubes can be formed from other dielectric materials not listed in the table of this disclosure.

The dielectric strength of dielectric tubes, including ceramic tubes, may adversely decrease after they are subjected to high voltages. The decrease in dielectric strength may be due to voids in the dielectric material. A material such as indium can be added to the dielectric material (e.g., ceramic material such as aluminum nitride or beryllium oxide) to fill the voids and mitigate the adverse effects of voltage across the dielectric.

A dielectric tube may be received by a bus bar or heat sink with a tube joint, or a dielectric tube may be received by a bus bar or heat sink without a tube joint. When a dielectric tube is received in a bus bar or heat sink without a tube joint, the outer surface of the dielectric tube may directly connect to the bus bar or heat sink. When a dielectric tube is received in a bus bar or heat sink with a tube joint, the outer surface of the dielectric tube is connected to the bus bar or heat sink through the tube joint, which may be electrically conducting or electrically non-conducting.

A thin (e.g., 4.0, 2.0, 1.0, 0.5, 0.1, 0.05, 0.01, 0.005, 0.001 mm or less) metal layer can be added to an outer surface of a dielectric tube. These tubes are referred to as “metalized dielectric tubes.” When a metalized dielectric tube is received in a bus bar or heat sink without a tube joint, the outer surface of the metalized dielectric tube may be directly connected to the bus bar or heat sink. When a metalized dielectric tube is received in a bus bar or heat sink with a tube joint, the outer surface of the dielectric tube is connected to the bus bar or heat sink through the tube joint, which may be electrically conducting or electrically non-conducting.

A tube may be formed of metal (e.g., copper, aluminum, etc.) or metal alloy. These tubes are referred to as “metal tubes.” When a metal tube is received in a bus bar or heat sink without a tube joint, the outer surface of the metal tube may directly connect to the bus bar or heat sink. When a metal tube is received in a bus bar or heat sink with a tube joint, the outer surface of the metal tube is connected to the bus bar or heat sink through the tube joint, which may be electrically conducting or electrically non-conducting.

A thin (e.g., 4.0, 2.0, 1.0, 0.5, 0.1, 0.05 mm or less) layer of dielectric material may be added to the outer surface of a metal tube. These tubes are referred to as “insulated metal tubes.” When an insulated metal tube is received in a bus bar or heat sink without a tube joint, the outer surface of the insulated metal tube may directly connect to the bus bar or heat sink. When an insulated metal tube is received in a bus bar or heat sink with a tube joint, the outer surface of the insulated metal tube is connected to the bus bar or heat sink through the tube joint, which may be electrically conducting or electrically non-conducting.

A thin (e.g., 4.0, 2.0, 1.0, 0.5, 0.1, 0.05 mm or less) layer of metal can be added to the outer surface of an insulated metal tube. These tubes are referred to as “metalized, insulated metal tubes.” When a metalized, insulated metal tube is received in a bus bar or heat sink without a tube joint, the outer surface of the metalized, insulated metal tube may directly connect to the bus bar or heat sink. When metalized, insulated metal tube is received in a bus bar or heat sink with a tube joint, the outer surface of the metalized, insulated metal tube is connected to the bus bar or heat sink through the tube joint, which may be electrically conducting or electrically non-conducting.

FIGS. 5A-3-5A-14 illustrate example cylindrical (or circular) shaped tubes 420 with channels of various size and shape. FIGS. 9A-1-9A-7 illustrate example tubes 420 that are not cylindrical. FIGS. 9A-1-9A-7 are more fully described below. The term tube should not be limited to that shown in figures of this disclosure.

FIG. 5A-3 shows end views of example dielectric tubes 420a-420c, which may be formed (e.g., extruded, extruded hot pressed, cast, isostatic pressed, grown, 3D printed, sintered, etc.) from a thermally conductive dielectric material such as aluminum nitride or beryllium oxide. Tubes 420a-420c are examples of tubes that can electrically insulate fluid flowing through them from bus bars in which they are received. When received by only one bus bar, such as a V+ or V− bus bar, the outer cylindrical surface of a dielectric tube 420a-420c may directly connect to the bus bar, or the outer cylindrical surface of the dielectric tube 420a-420c may connect to the bus bar through an electrically conducting or electrically non-conducting cylindrical tube joint. Tubes 420a of FIGS. 5A-1 and 5A-2S may be received in bus bars 417T and 412T without a tube joint. A dielectric tube 420a-420c may be commonly received in two or more bus bars, such as phase bus bars 418T. When commonly received in two or more bus bars, the outer cylindrical surface of the dielectric tube 420a-420c may directly connect with the two or more bus bars, or the outer cylindrical surface of the dielectric tube 420a-420c may connect with the two or more bus bars through an electrically non-conducting cylindrical tube joint to maintain electrical isolation between the two or more bus bars. Tubes 420a of FIGS. 5A-1 and 5A-2S may be commonly received in phase bus bars 418T without a tube joint.

FIG. 5A-4 shows end views of metalized dielectric tubes 420d-420f, which may be tubes 420a-420c, respectively, with a thin (e.g., 4.0, 2.0, 1.0, 0.5, 0.1, 0.05, 0.01, 0.005, 0.001 mm or less) layer of metal 407d formed on most or substantially all outer cylindrical surfaces of the tubes.

A metal layer 407 can be formed using any one of many methods such as chemical vapor deposition, physical vapor deposition, spraying, roll coating, pad printing, etc. A metal layer 407, including metal layer 407d or metal layer 407p described below, may be formed by direct copper bonding (DCB) in which copper is wetted onto a surface of a dielectric tube to form an intermetallic bond. A metal layer 407, including metal layer 407d or metal layer 407p described below, may be formed by physical vapor deposition (e.g., physical vapor deposition sputtering) in which copper or other material is ionized and condensed on the surface of the dielectric tube. A metal layer 407, including metal layer 407d or metal layer 407p described below, may be formed by thick film metallization in which a metal paste (e.g., copper metal paste) is printed onto the surface of the dielectric tube and then baked on with heat. A metal layer 407, including metal layer 407d or metal layer 407p described below, may be formed by electroless metal plating in which a metal (e.g., copper) plating is grown directly onto the surface of the dielectric tube from a solution. A metal layer 407, including metal layer 407d or metal layer 407p described below, may be formed by copper electro-plating in which a conductive metallization is used as an interface material on the dielectric tube to which copper is then bonded. A metal layer 407, including metal layer 407d or metal layer 407p described below, may be formed by painting an outer surface of a dielectric tube with conductive ink (palladium ink, silver ink, etc.). The conductive ink can be cured into layer 407 with heat. A metal layer 407, including a cured conductive ink layer, may be sanded to smooth the outer surface of the tube. A metal layer 407 made with conductive ink may be more suitable for sintering to the surface of another object, such as slats 551 described below.

End sections of metalized dielectric tubes may lack a metal layer. FIG. 5A-8 is a side view of tube 420d, which shows end sections of tube 420d that lack metallization. Tubes 420e and 420f may have similar structure when seen from the side. End sections of a tube may extend partially or fully through respective walls of respective fluid manifolds as will be more fully described below. If the metal layer 407 on a tube is electrified, the metal layer 407 should not contact electrically conductive fluid flowing in the manifolds.

With continuing reference to FIGS. 5A-4 and 5A-8, when received in only one bus bar, such as a V+ bus bar or V-bus bar, the outer surface of metal layer 407d may directly connect with the bus bar, or the outer surface of metal layer 407d may connect with the bus bar through an electrically conducting or electrically non-conducting tube joint. When commonly received in two or more bus bars, such as phase bus bars, the outer surface of metal layer 407d of a tube 420d-420f may connect to the two or more bus bars through an electrically non-conducting tube joint to maintain electrical isolation between the two or more bus bars.

Metal layers may be formed on selected portions of a dielectric tube's outer surface. For example, thin (e.g., 4.0, 2.0, 1.0, 0.5, 0.1, 0.05, 0.01, 0.005, 0.001 mm or less) layers of metal may be formed on those portions of a dielectric tube to be connected to respective bus bars. FIG. 5A-11 is a side view of tube 420g, which is dielectric tube 420a with thin (e.g., 4.0, 2.0, 1.0, 0.5, 0.1, 0.05, 0.01, 0.005, 0.001 mm or less) metal layers 407p formed on three separate portions of the outer cylindrical surface. Alternatively, metal layers 407p may be formed on two, four, five, six or more sections of dielectric tube 420a. The axial length of metal layers 407p need not be the same as shown in FIG. 5A-11. Similar metal layers 407p may be formed on tube 420b or 420c.

Tubes with metal layers 407p, like tube 420g, can be commonly received by multiple (e.g., three) bus bars (e.g., phase bus bars). When received in bus bars, the outer surface of metal layers 407p may directly connect to the bus bars, respectively, or the outer surface of metal layers 407p may connect to the bus bars, respectively, through respective tube joints, which may be electrically conducting or electrically non-conducting. FIG. 5A-15-1 is a cross-sectional view of an example phase bus bar 418e-1 that receives tubes 420g. Phase bus bar 418e-1 may be one of three aligned phase bus bars 418e that commonly receive tubes 420g. Outer cylindrical surfaces of tubes 420g in FIG. 5A-15-1 are connected to phase bus bar 418e-1 through respective cylindrical tube joints 441p. An example process for building a phase bus bar, such as phase bus bar 418e-1, is described below with reference to FIGS. 5A-17-6-5A-17-10.

Like tube 420d shown in FIG. 5A-8, the end sections of tube 420g may lack a metal layer 407. End sections of metalized tube 420g may extend partially or fully through respective walls of respective fluid manifolds. The metal layers 407p, if electrified, should not contact electrically conductive fluid flowing in the manifolds.

FIG. 5A-5 shows end views of example metal tubes 420j-4201, which may be formed (e.g., extruded, cast, hot pressed, powder compacted, sintered, 3D printed, etc.) of copper, aluminum, or other metal. When received in only one bus bar, such as a V+ bus bar or V− bus bar, the outer cylindrical surface of a metal tube 420j-4201 may directly connect to the bus bar, or the outer cylindrical surface of the metal tube may connect to the bus bar through an electrically conducting or electrically non-conducting tube joint. A metal tube may be received in two or more bus bars. When received in two or more bus bars, the outer cylindrical surface of a metal tube 420j-4201 may be connected to the two or more bus bars through an electrically non-conducting tube joint to maintain electrical isolation between the two or more bus bars.

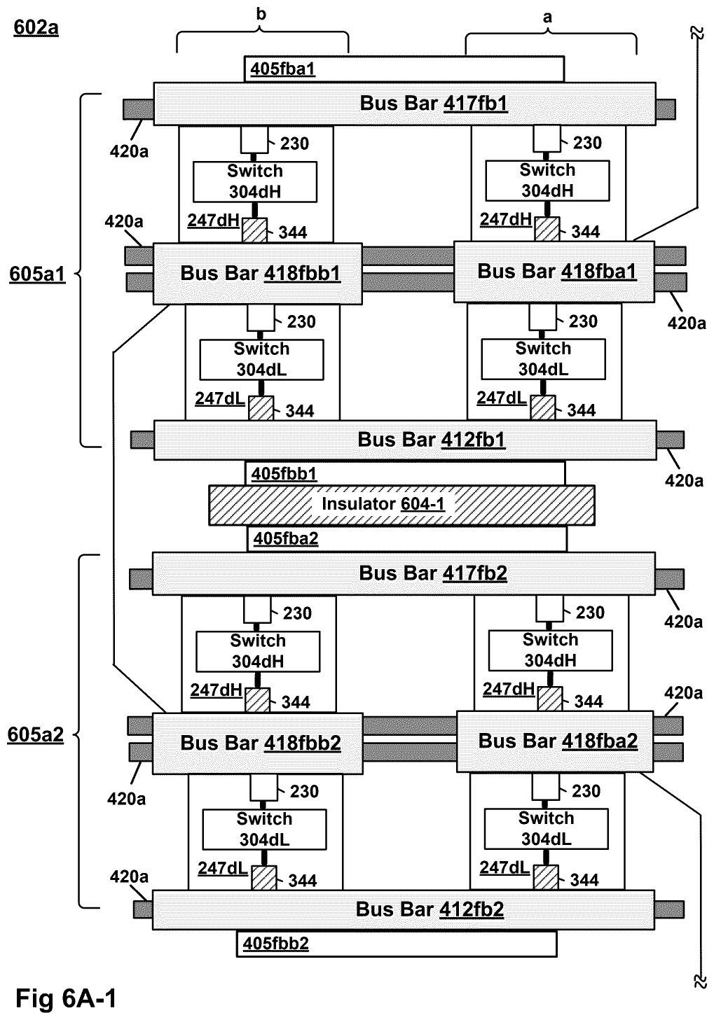

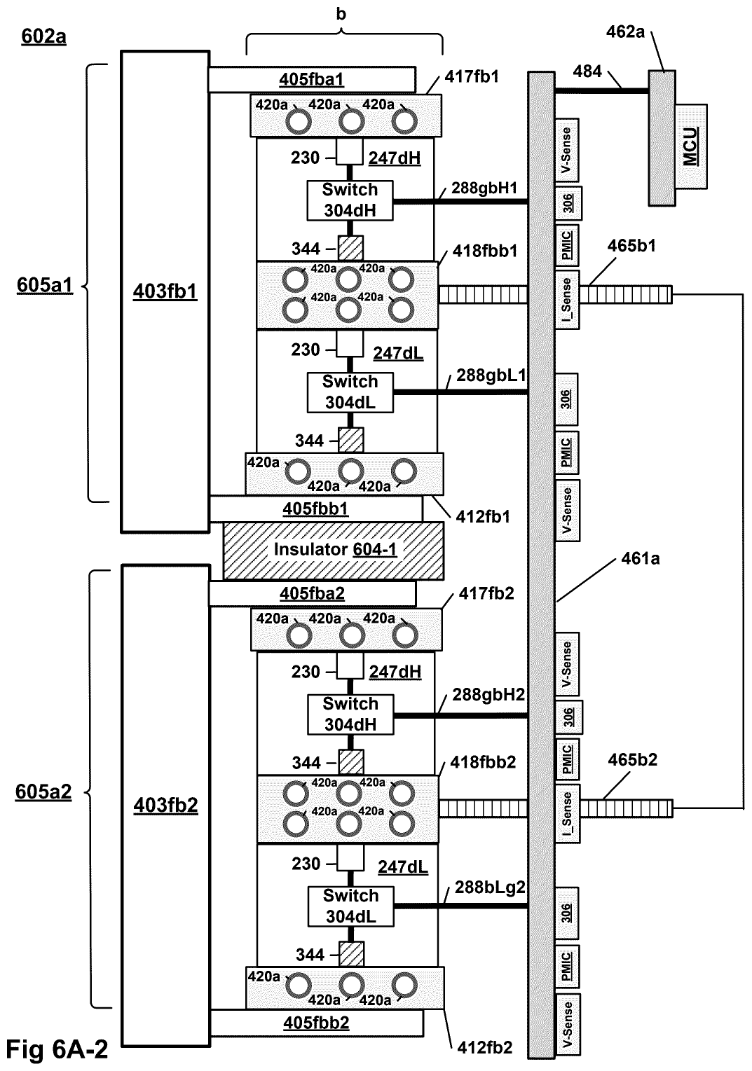

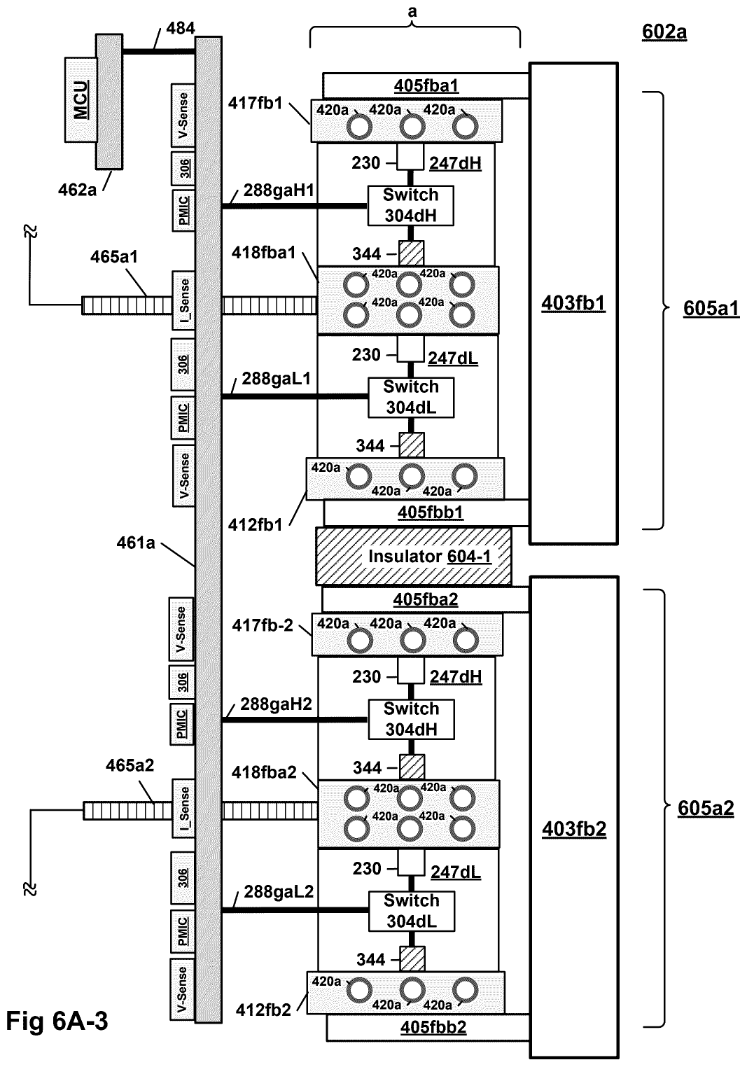

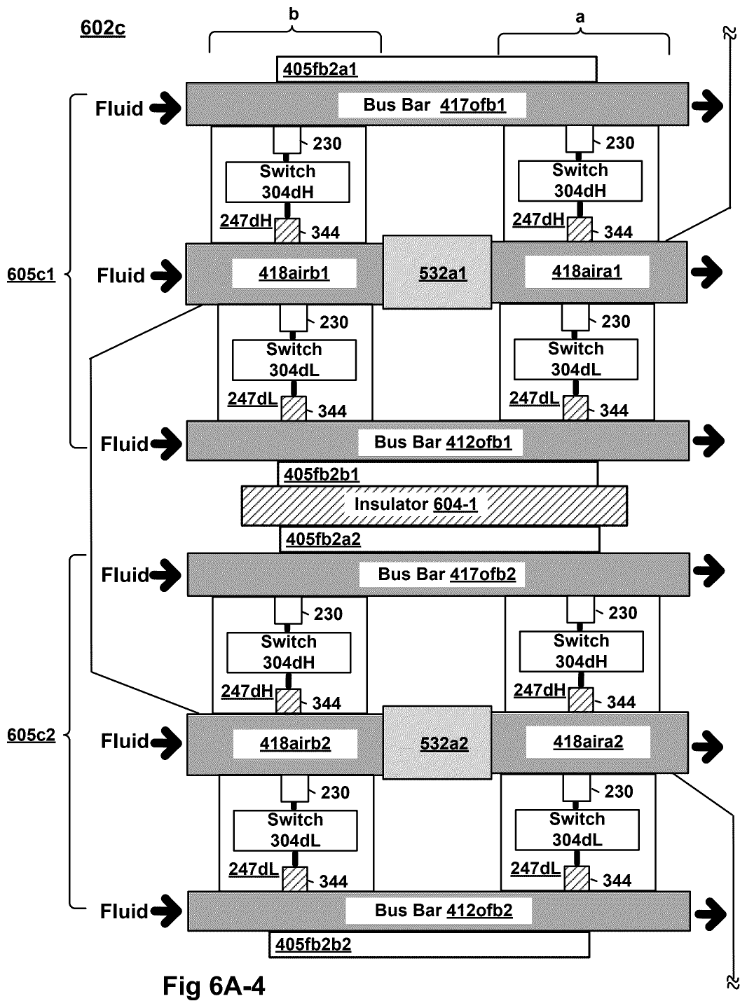

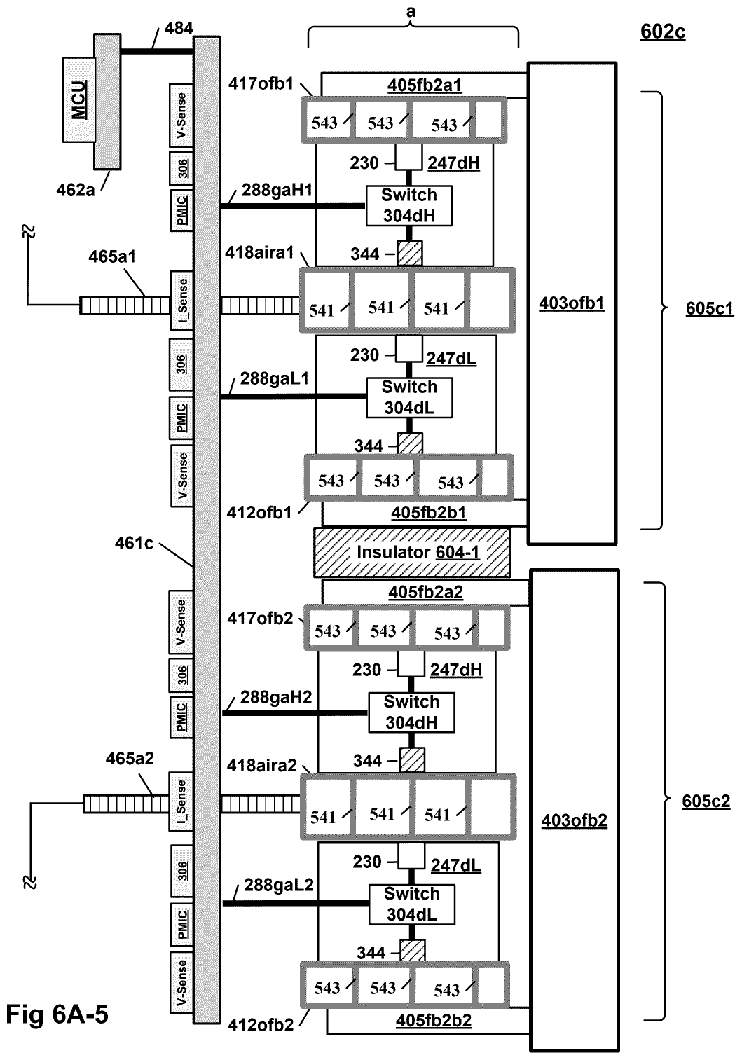

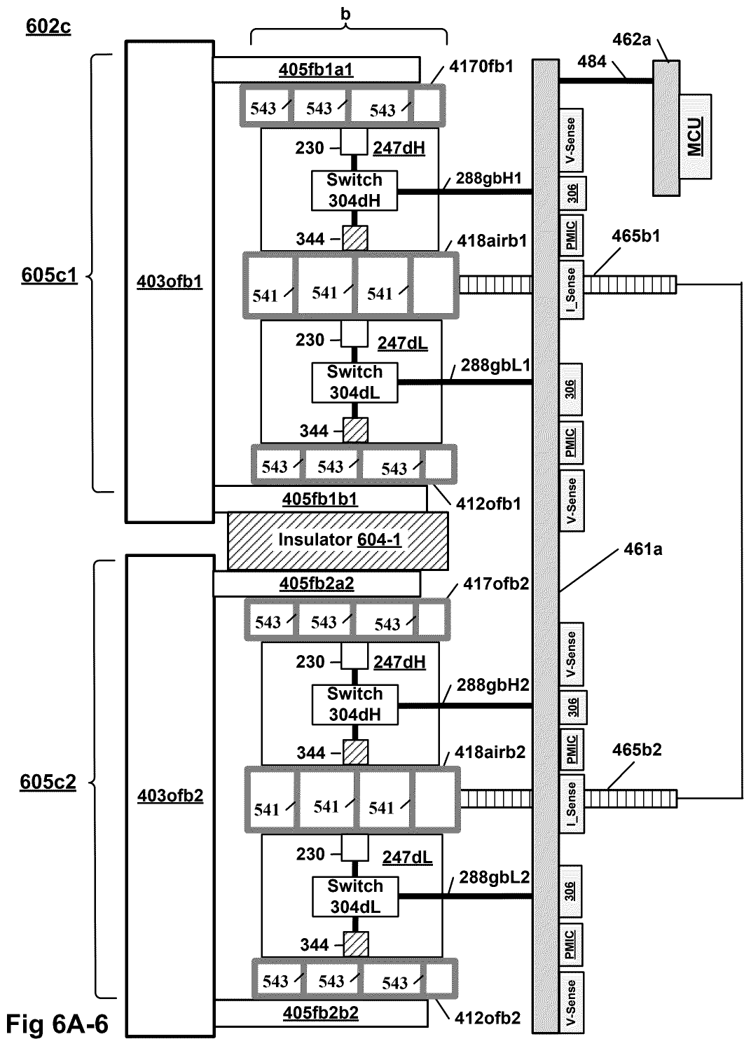

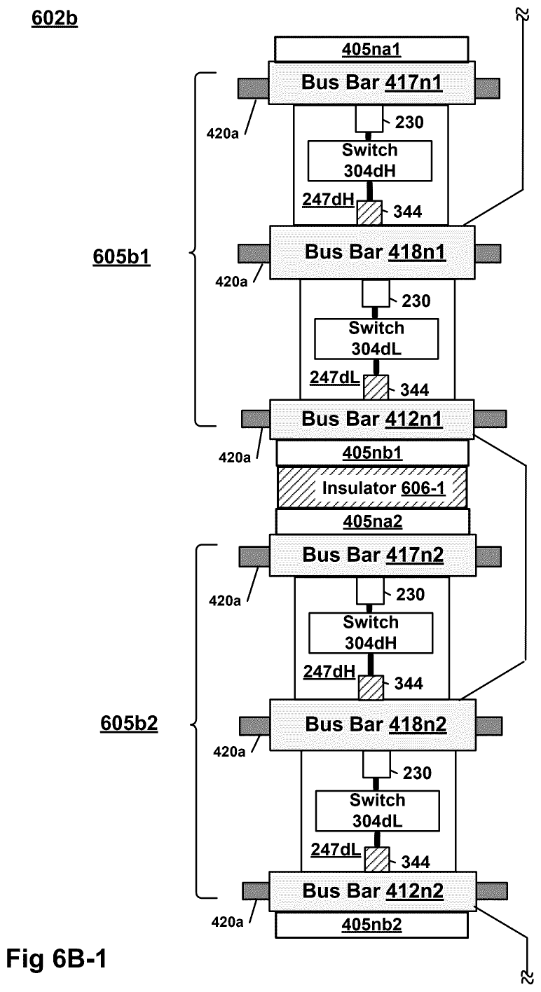

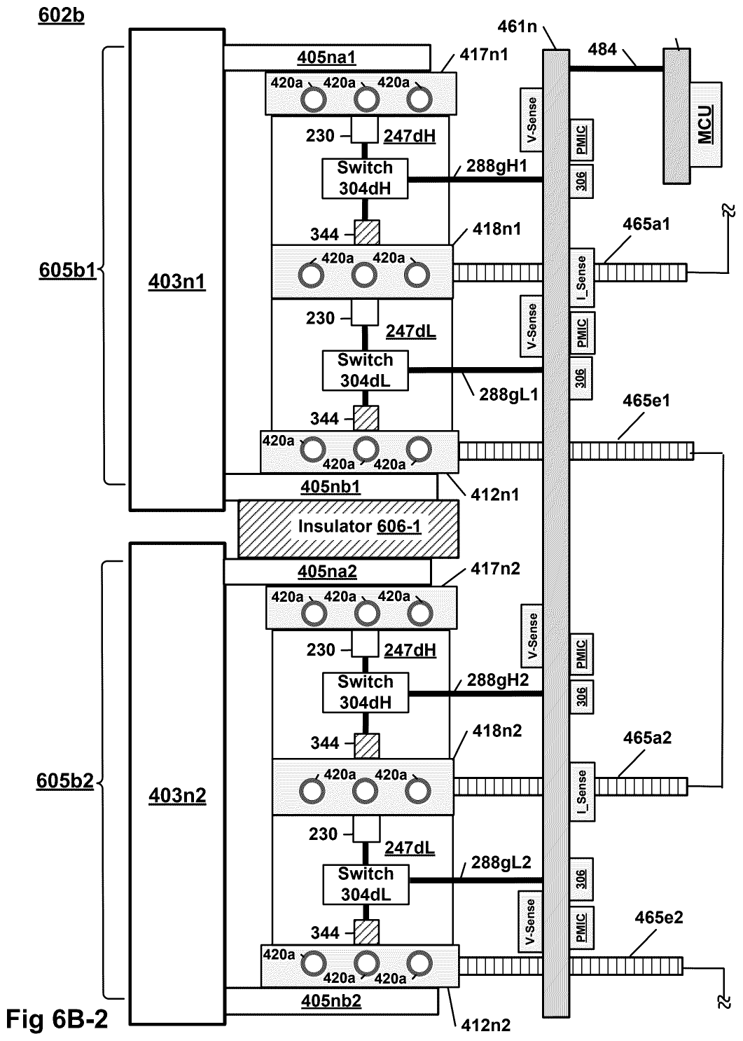

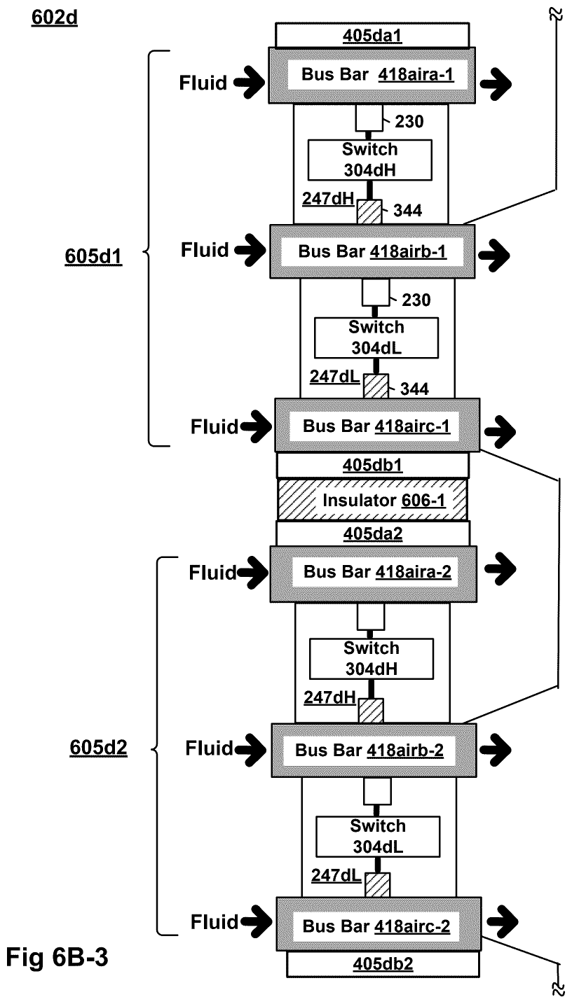

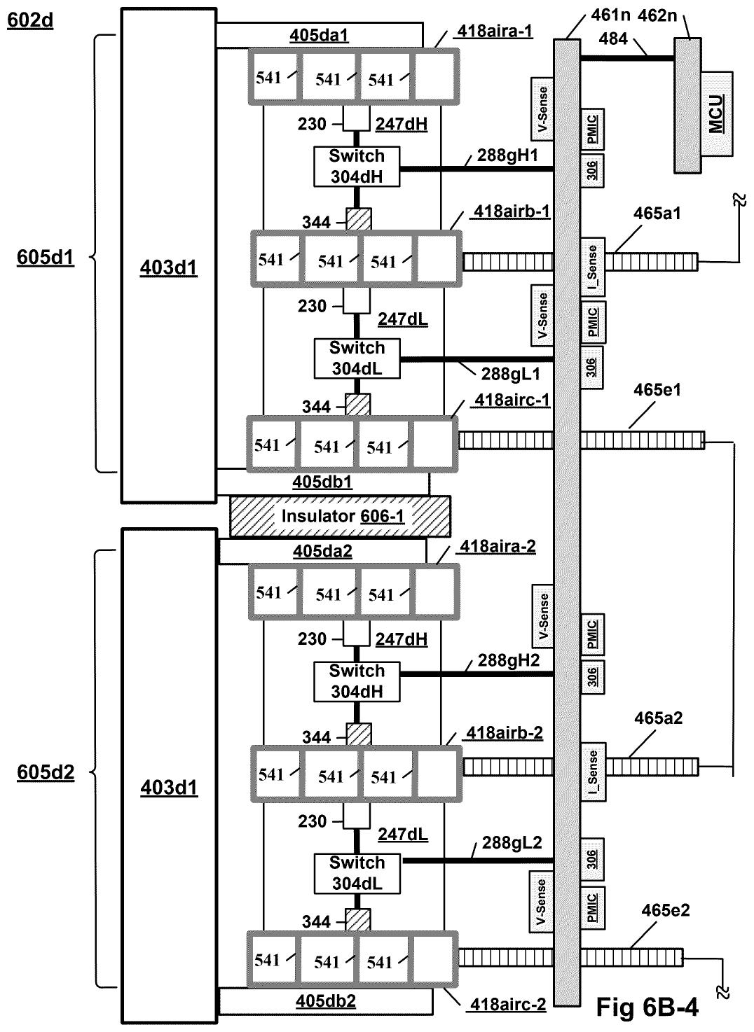

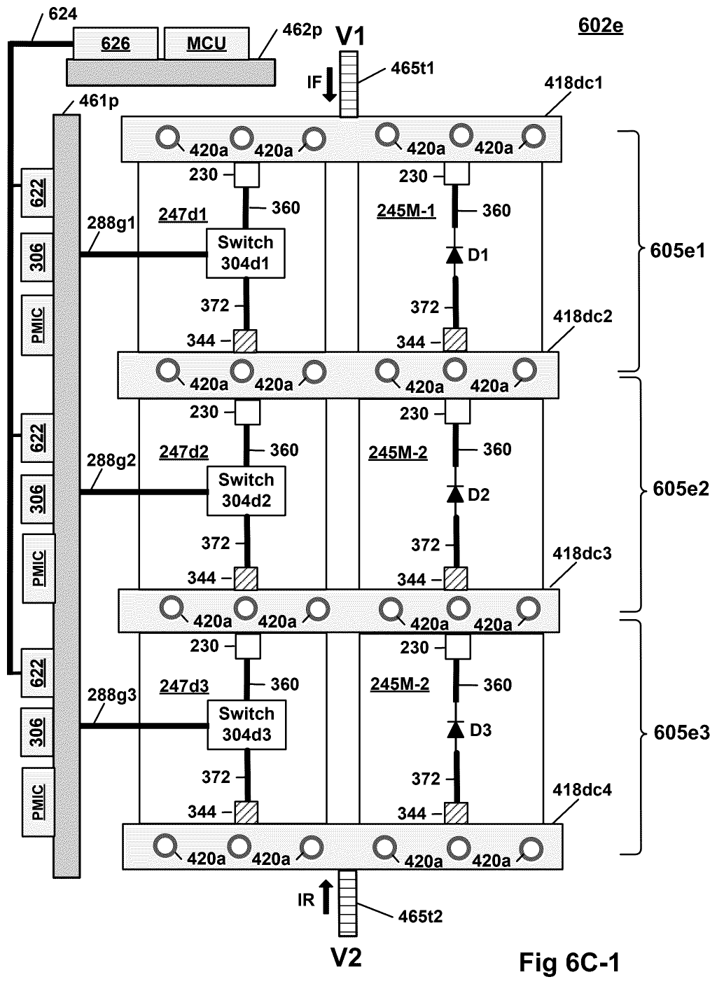

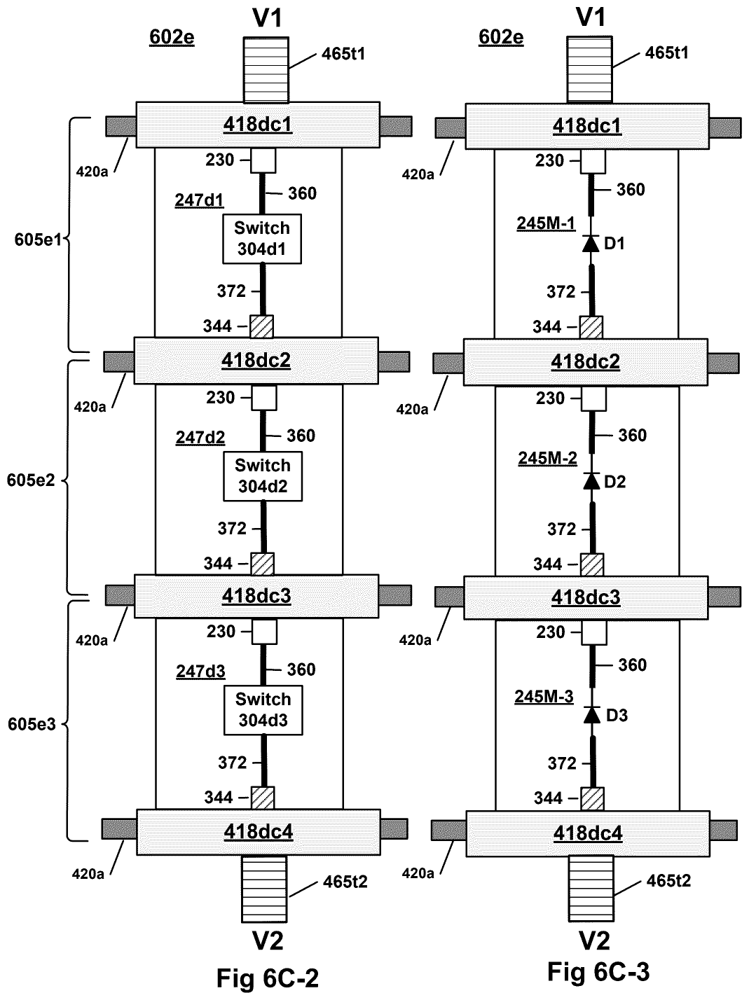

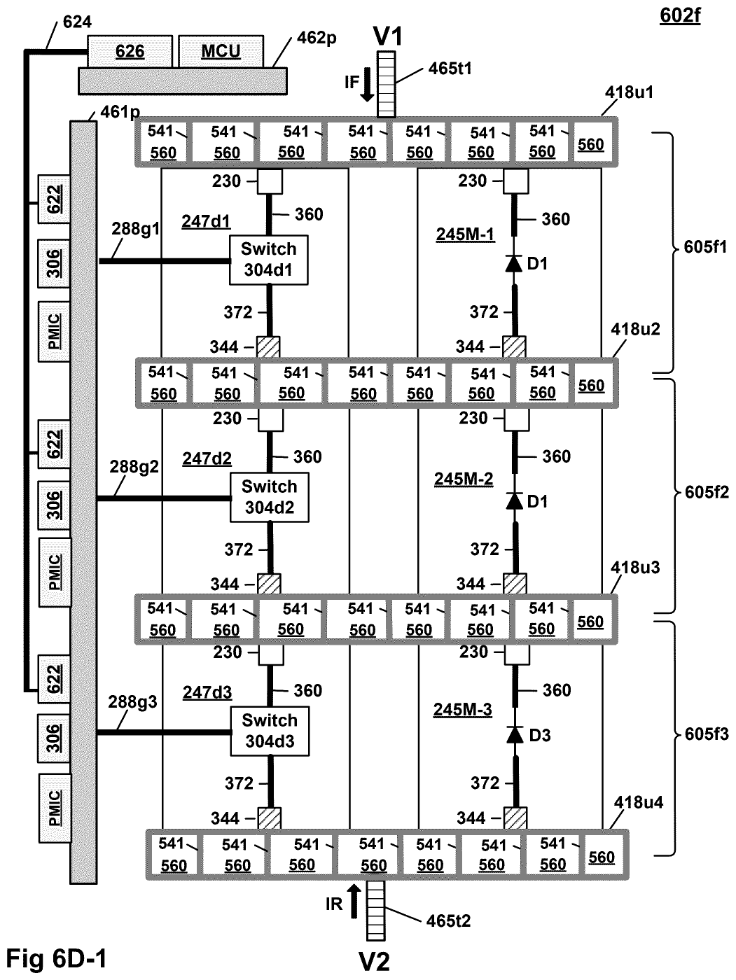

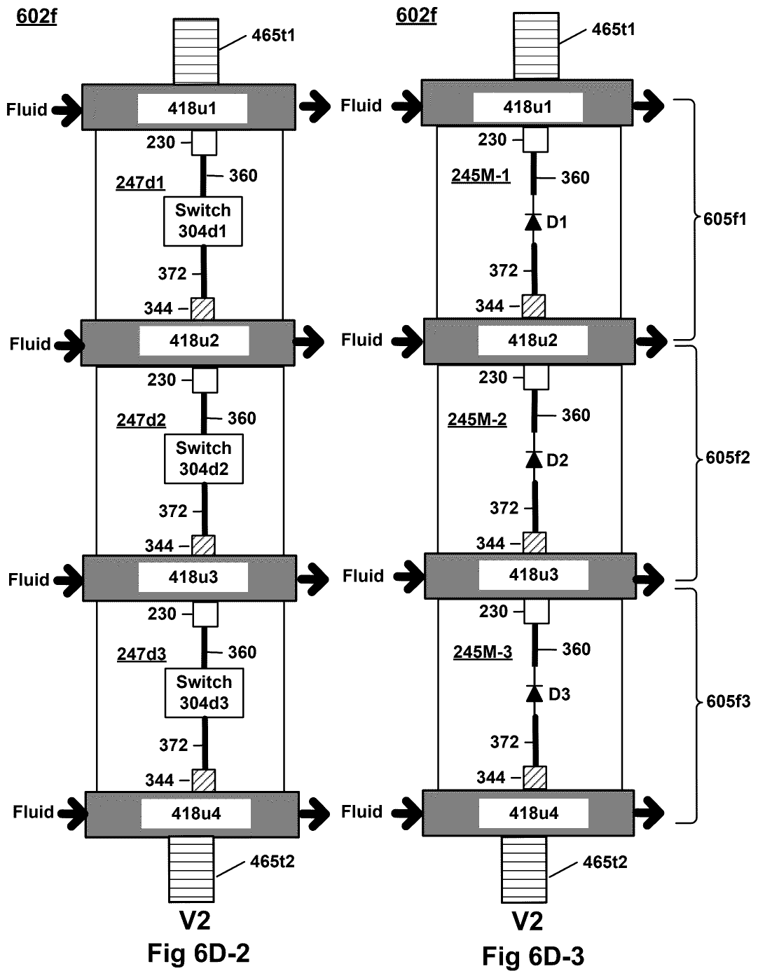

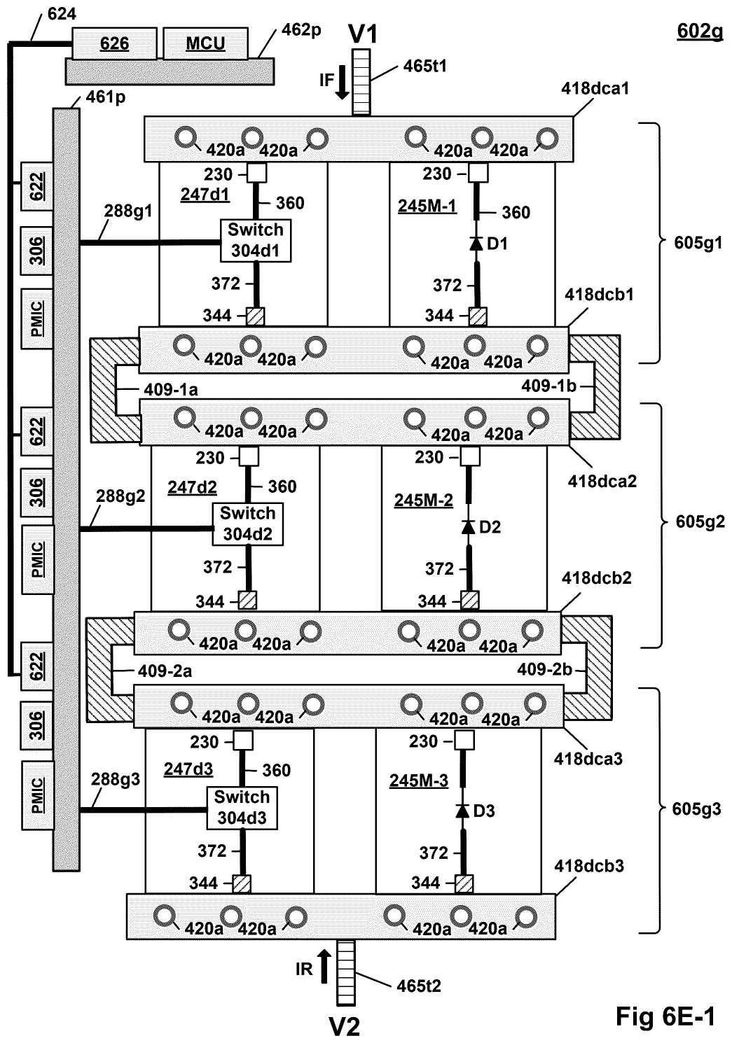

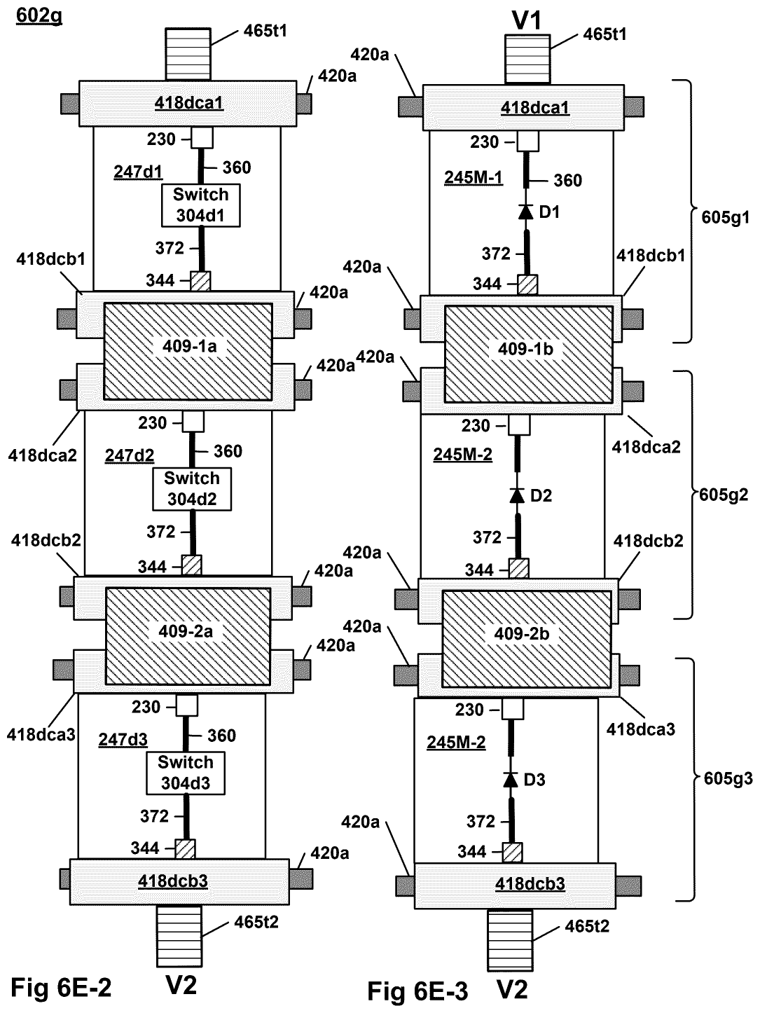

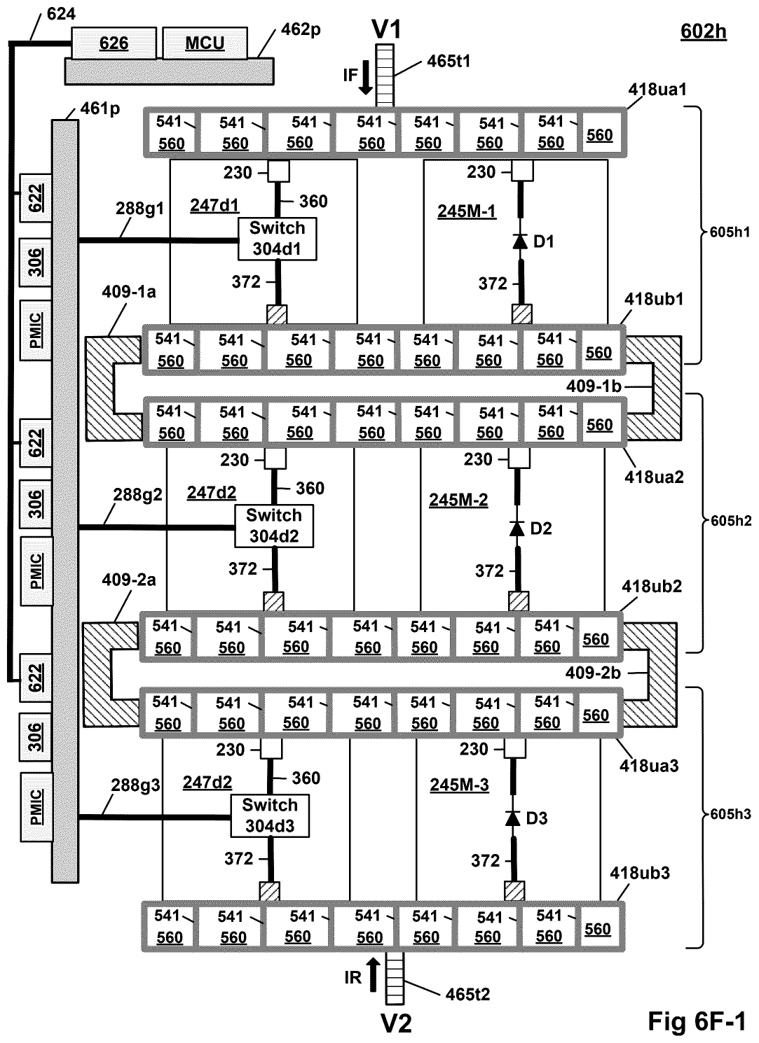

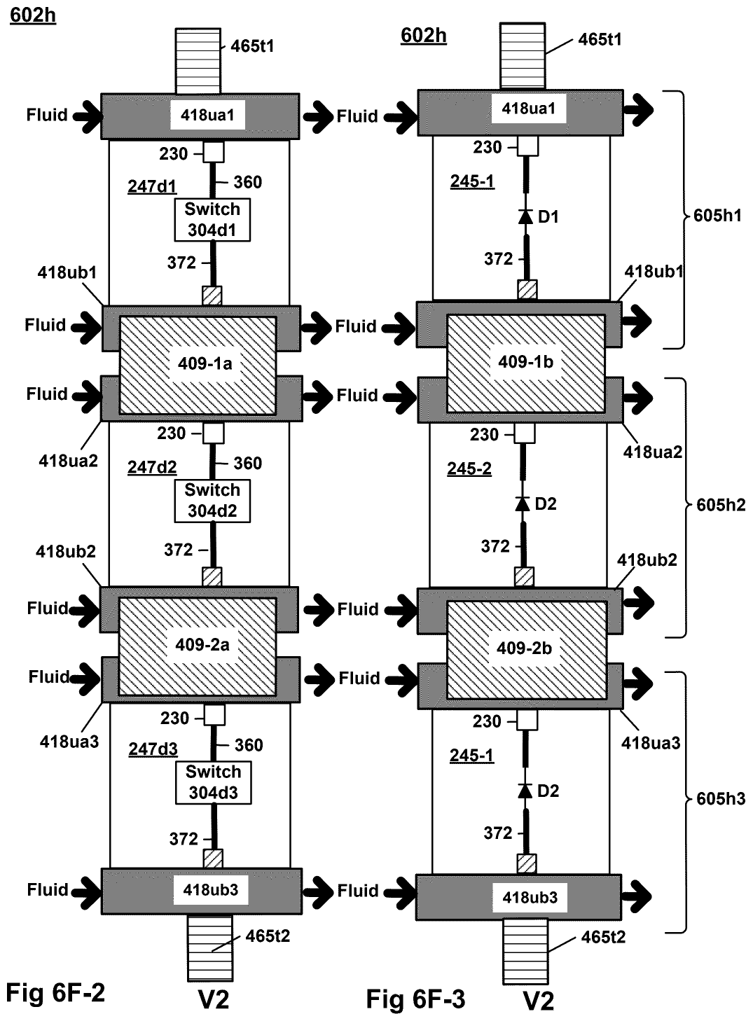

A thin layer of dielectric material (e.g., aluminum oxide, aluminum nitride, silicon nitride, beryllium oxide, deposited diamond coating, etc.) may be formed on most or substantially all a metal tube's outer surface. FIG. 5A-6 shows end views of example insulated metal tubes 420m-4200, which may be metal tubes 420j-4201, respectively, with a thin layer (e.g., 4.0, 2.0, 1.0, 0.5, 0.1, 0.05 mm or less) 422d of dielectric material formed on the outer cylindrical surfaces. Tubes 420m-4200 are examples of tubes that can electrically insulate fluid flowing through them from bus bars in which they are received. Several methods for adding thin layer 422 are described below.

End sections of insulated metal tubes may lack a dielectric layer. FIG. 5A-9 is a side view of tube 420m. As shown in FIG. 5A-9, small end sections of insulated metal tube 420m lack dielectric layer 422d. Tubes 420n and 420o may have similar structure when seen from the side. When received by a bus bar, such as a V+ bus bar or V− bus bar, without a tube joint the outer cylindrical surface of dielectric layer 422d may directly connect to the bus bar. FIG. 5A-15-2 is a cross-sectional view of an example bus bar 412e that receives tubes 4200 without tube joint. Outer cylindrical surfaces of tubes 4200 in FIG. 5A-15-2 directly connect to bus bar 412e. Example bus bar 412e may be formed by, for example, casting liquid metal around tubes 4200. Example bus bar 412e may be formed by, for example, sintering metal around tubes 4200. It is noted that the middle tube 4200 of FIG. 5A-15-2 is rotated by an angle (e.g., 45 degrees) with respect to outer tubes 4200. A different angular orientation of the middle tube 4200 with respect to one or both outer tubes 4200, like that shown in FIG. 5A-15-2, may increase heat extraction from a switch 304 (not shown) electrically and thermally connected to example bus bar 412e at the middle of the top or bottom flat surface.

An insulated metal tube 420m-4200 may be commonly received in two or more bus bars, such as phase bus bars. When commonly received in two or more bus bars the outer cylindrical surface of dielectric layer 422d may directly connect with the two or more bus bars, or the outer cylindrical surface of dielectric layer 422d may connect with the two or more bus bars through an electrically non-conducting tube joint to maintain electrical isolation between the two or more bus bars.

A thin layer of dielectric could be formed on selected outer portions of a metal tube. For example, a thin (e.g., 4.0, 2.0, 1.0, 0.5, 0.1, 0.05 mm or less) layer of dielectric may be formed on those portions of a metal tube to be connected to respective bus bars. FIG. 5A-13 is a side view of tube 420s, which is metal tube 420j after a thin (e.g., 4.0, 2.0, 1.0, 0.5, 0.1, 0.05 mm or less) dielectric layer 422p is formed on three portions of metal tube 420j's outer cylindrical surface. Alternatively, dielectric layers 422p may be formed on two, four, five six or more sections of metal tube 420j. The axial length of dielectric layers 422p need not be equal as shown in FIG. 5A-13. Tube 420s can be commonly received by aligned bus bars (e.g., phase bus bars). When commonly received in the aligned bus bars, the outer surface of dielectric layers 422p may directly connect to the bus bars, respectively, or outer surfaces of dielectric layers 422p may be connected to the aligned bus bars, respectively, through electrically conducting or electrically isolating tube joints, respectively.

FIG. 5A-7 shows end views of example metalized, insulated tubes 420p-420r, which may be tubes 420m-4200, respectively, after a thin (e.g., 4.0, 2.0, 1.0, 0.5, 0.1, 0.05, 0.01, 0.005, 0.001 mm or less) metal layer 442d is formed on most or substantially all the outer cylindrical surfaces of dielectric layer 422d. A metal layer 442 could be formed using many methods such as chemical vapor deposition, physical vapor deposition or spraying, roll coating, pad printing, etc. A metal layer 442 may also be formed by painting an outer surface of a dielectric layer 422 with conductive ink (palladium ink, silver ink, etc.). The conductive ink can be cured with heat. A metal layer 442 may be sanded to smooth the outer surface.

FIG. 5A-10 is a side view of tube 420p. Tubes 420q and 420r may have similar structure when seen from the side. When received by a bus bar, such as a V+ bus bar or V-bus bar, the outer cylindrical surface of metal layer 442d may directly connect to the bus bar, or the outer cylindrical surface of metal layer 442d may connect to the bus bar through an electrically conducting or electrically non-conducting tube joint.

A metalized, insulated metal tube 420p-420r may be commonly received in two or more bus bars, such as phase bus bars. When received in two or more bus bars, the outer surface metal layer 442d should be connected to the two or more bus bars through an electrically non-conducting tube joint to maintain electrical isolation between the two or more bus bars.

End sections of a tube 420p-420r may extend partially or fully through respective walls of respective fluid manifolds. The metal layer 442d, if electrified, should not contact electrically conductive fluid flowing in the manifolds.

A thin layer of metal may be formed on dielectric layers 422p shown in FIG. 5A-13. FIG. 5A-14 shows tube 420t, which is tube 420s after a thin (e.g., 4.0, 2.0, 1.0, 0.5, 0.1, 0.05 mm or less) metal layer 442p is added to the surface of each dielectric layer 422p. When received in aligned bus bars (e.g., phase bus bars), the outer surface of metal layers 442p may be directly connected to the aligned bus bars, respectively, or the outer surfaces of metal layers 442p may be connected to aligned bus bars, respectively, through electrically conducting or electrically isolating tube joints, respectively.

End sections of tube 420t may extend partially or fully through respective walls of respective fluid manifolds. The metal layers 442p, if electrified, should not contact electrically conductive fluid flowing in the manifolds.

A dielectric tube (e.g., dielectric tube 420a, 420b, or 420c) or dielectric layer 422 of an insulated metal tube should electrically insulate fluid in the tube from a bus bar in which the tube may be received. A dielectric tube or a dielectric layer 422 should have a high dielectric strength (e.g., 1-10 k V).

Dielectric layer 422 may be thin (e.g., 3.0, 5.0, 10.0, 50.0, 100.0, 200.0, 250.0 μm or more). Dielectric layer 422 is presumed to be around 200.0 μm, it being understood the layer may be thinner or thicker in other versions. The thickness of a dielectric tube wall or dielectric layer 422 affects the heat transfer to the fluid. The table below includes a calculated heat transfer W for dielectric layer 422 of different materials and thicknesses. W is proportional to k·A·(T1−T2)/d, where k is the thermal conductivity, A is area, ΔT=70 is the temperature difference across the dielectric layer, and d is the thickness in micrometers. A voltage of 4 k V is presumed across the dielectric for the calculated heat transfer W.

| | Thermal | Dielectric | Thickness | | Heat Transfer (W) | | |
|---|---|---|---|---|---|---|---|
| | Conductivity | Strength | (@4000 V) | | (@ΔT-° C., area-cm²) | | |
| | (W/mK) | (kV/mm) | (μm) | (mils) | (W) | ΔT = 70 | A = 1 |
| Al₂O₃ | 24.0 | 16.9 | 236.7 | 9.3 | 710 | | |
| Si₃N₄ | 90.0 | 12.0 | 333.3 | 13.1 | 1,890 | | |
| AlN | 170.0 | 16.7 | 239.5 | 9.4 | 4,968 | | |
| BN-Hex | 30.0 | 40.0 | 100.0 | 3.9 | 2,100 | | |
| AlN + AO (50/50) | 92.0 | 26.6 | 150.5 | 5.9 | 4,279 | | |
| AlN + AO (75/25) | 126.0 | 21.7 | 184.7 | 7.3 | 4,775 | | |
| HBN + AO (50/50) | 27.5 | 35.7 | 112.0 | 4.4 | 1,718 | | |
| Diamond | 1500.0 | 1000.0 | 4.0 | 0.2 | 2,625,000 | | |
| Epoxy | 4.0 | 19.7 | 203.0 | 8.0 | 138 | | |
| Teflon | 0.3 | 60.0 | 66.7 | 2.6 | 34 | | |
| HDPE | 0.2 | 20.0 | 200.0 | 7.9 | 7 | | |
| Nylon | 0.3 | 14.0 | 285.7 | 11.2 | 6 | | |
| Rubber | 0.1 | 12.0 | 333.3 | 13.1 | 3 | | |
| Phenolic | 0.2 | 6.9 | 579.7 | 22.8 | 2 | | |
| Polyamide | 0.3 | 55.0 | 72.7 | 2.9 | 29 | | |
| Polycarbonate | 0.2 | 38.0 | 105.3 | 4.1 | 15 | | |
| Liquid Crystal | 1.6 | 25.6 | 156.3 | 6.2 | 72 | | |
| Polymer | | | | | | | |
| BeO | 330.0 | 30.0 | | | | | |

A dielectric layer 422 may be formed by spraying (e.g., plasma spraying or flame spraying) dielectric material on the outer surface of tubes. The inner or outer surface of a tube is distinct from end surfaces (e.g., flat circular end surfaces, square end surfaces, oval end surfaces, etc.) of the tube. A dielectric layer 422 may be formed by rolling a tube in dielectric material (e.g., a TIM). A dielectric layer 422 can be formed on the outer surface of tubes by CVD, PVD, coating (pad printing, brushing, dipping, electro-depositing (in the case of porcelain enamels or electrostatic painting) etc., and heated). A dielectric layer 422 can be formed by wrapping a thin (e.g., 3.0, 5.0, 10.0, 50.0, 100.0, 200.0, 250.0 μm or more) dielectric film around an outer surface of a tube.

A dielectric layer 422 may be grown on the end, outer and/or inner surfaces of tubes. For example, a dielectric layer 422 may be grown on the end, inner and/or outer cylindrical surface of aluminum tubes 420j-4201 using plasma electrolysis oxidation, or by using a type II or III hard anodizing process. A tube can have multiple dielectric layers. For example, a thin layer (e.g., 3.0, 5.0, 10.0, 50.0, 100.0 μm or more) of dielectric material (e.g., aluminum nitride) may be formed on the outer surface of a metal tube after the tube's outer surface is anodized. Other processes for forming a dielectric layer or dielectric layers may be contemplated.

Anodization is an electrolytic passivation process for creating or increasing the thickness of a natural oxide layer on the surface of metal parts. Anodization builds up an oxide on the surface of the metal part as well as into the metal too, about half and half. The resulting oxide layer is electrically insulating. The oxide layer may be grown by passing a direct current through an electrolytic solution, typically sulphuric acid, or chromic acid, in which all or a part of the metal part (e.g., a tube) is suspended and exposed. The metal part serves as the anode (the positive electrode in an electrolytic cell). Current flow through the electrolytic solution releases hydrogen at the cathode (the negative electrode) and oxygen at the surface of the metal part, creating a build-up of the oxide. The voltage required may range from 1 to 300 V DC. Higher voltages may be typically required for thicker oxide coatings formed in sulfuric and organic acid. The anodizing current varies with the overall area of the metal part sections being anodized and typically ranges from 30 to 300 A/m2. Conditions such as electrolyte concentration, acidity, solution temperature, and current may be controlled to allow the formation of a consistent oxide layer. Harder, thicker oxide layers tend to be produced by more concentrated solutions at lower temperatures with higher voltages and currents.

An anodizing process may be used for growing a dielectric layer of oxide on the end, outer and/or inner surfaces of aluminum tubes. The tube serves as the anode for the process. Current flows through the electrolytic bath solution in which some or all the tube is suspended, and releases hydrogen at the cathode (the negative electrode) and oxygen at the outer and/or surface of the tube, creating a build-up of the oxide. The anodizing process may be used to grow dielectric layer, such as dielectric layer 422, on only the outer surface of aluminum tubes employed in converters or other power apparatuses.

Plasma electrolytic oxidation (PEO) is another electrochemical surface treatment process for growing insulating layers on metal tubes. It is like anodizing, but it typically employs higher potentials, so that discharges occur, and the resulting plasma modifies the structure of the oxide layer. This process may be used to grow thick (50, 100, 200, 250, 300 μm or more), largely crystalline, oxide coatings on tubes made of metals such as aluminum, magnesium, and titanium. The coating is a chemical conversion of the metal into oxide and grows both inwards and outwards from the original metal surface. In plasma electrolytic oxidation of aluminum, at least 200 V should be applied. This locally exceeds the dielectric breakdown potential of the growing oxide film, and discharges occur. These discharges result in localized plasma reactions, with conditions of high temperature and pressure which modify the growing oxide. Processes may include melting, melt-flow, re-solidification, sintering and densification of the growing oxide. One of the most significant effects may be that the oxide is partially converted from amorphous alumina into crystalline forms such as corundum (α-Al2O3) which may be much harder. Plasma electrolytic oxidation may include immersing a tube in a bath of electrolyte, which usually consists of a dilute alkaline solution such as KOH. The tube is electrically connected to become one of the electrodes in an electrochemical cell, with the other electrode typically being made from an inert material such as stainless steel, and often consisting of the wall of the bath itself. Potentials over 200 V may be applied between these two electrodes. Higher voltages may be used to form thicker oxide layers.

Anodization or plasma electrolysis oxidation may provide several advantages when compared to other methods (e.g., spraying a dielectric on the outer surface of tubes, which may require smoothing to ensure a better thermally conductive interface to the bus bar channel surface in which the tube is received) for forming dielectric layer such as dielectric layer 422. For example, anodization may provide a more mechanically robust dielectric layer. The outer surface of an anodized dielectric layer may be smoother when compared to other methods, which may increase heat transfer between the heat sink or bus bar on one side of the dielectric and the tube on the other side.

Tube channels can have different cross-sectional shapes as shown in FIGS. 5A-3-5A-7. Each tube 420 may include one or more channels through which a fluid can flow. Tubes 420a, 420b, 420d, 420e, 420j, 420k, 420m, 420n, 420p, and 420q include a single channel, while tubes 420c, 420f, 4201, 4200, and 420r include four tube channels, which may be defined by a solid cylindrical center that is connected to an inner circular surface by rectangular horizontal and vertical spokes as shown. The shape of tube channels should not be limited to that shown in the figures. A tube may include one, two or more tube channels that are oval, square, rectangular, etc., in cross-section.

Tubes 420a, 420d, 420j, 420m, and 420p may have a smooth cylindrical inner wall. In an alternative version, tubes 420a, 420d, 420j, 420m, and 420p may have a rifled inner cylindrical wall. Rifling is a process of machining helical grooves into the inner surface of a tube for the purpose of creating or increasing fluid turbulence or molecular contact.

The channel of tubes 420b, 420e, 420k, 420n, and 420q is “flower” shaped with a ring of small cylindrical sub-channels, which have substantially the same cross section, and which may be in fluid communication with a centrally located cylindrical sub-channel that may be larger in cross section when compared to those of cylindrical sub-channels in the ring. Spoke sub-channels enable fluid communication between respective cylindrical sub-channels in the ring with the centrally located cylindrical sub-channel. Each spoke sub-channel may have any one of many cross-sectional shapes. In the illustrated version, each spoke sub-channel may be substantially rectangular in cross section although square or circular cross sections may be also contemplated. The flower shaped tube may provide increased heat transfer to the cooling liquid flow through the tube when compared to a tube with a flat and smooth (e.g., not rifled) inner cylindrical surface like that shown in tube 420a. Each tube 420c and 420l has four channels through which fluid can flow as shown in FIGS. 5A-3 and 5A-5.

Metal tubes or dielectric tubes may be constructed using three-dimensional printing techniques or an extrusion process. Extrusion is a process used to create objects of a fixed cross-sectional profile by pushing material through a die of the desired cross-section. It may be done with hot or cold material. Commonly extruded materials include metals, polymers, ceramics, etc.

Dielectric layer 422 can electrically insulate fluid in a tube from a bus bar or heat sink in which the tube is received. Dielectric layer 422 can transfer heat to the fluid flowing through the tube albeit with higher thermal resistance when compared to metal such as copper. In an alternative version, no dielectric (e.g., layer 422) exists between the fluid and a switch 304. However, in this alternative version, the fluid should be dielectric.

Dimensions (e.g., diameter) of tubes in a bus bar or heat sink need not be equal. The number, position, and/or dimensions of tubes in a bus bar or heat sink may depend on one or more variables. For example, the number, position, and/or dimensions of the tubes may depend on a desired thermal capacitance of the bus bar or heat sink in which the tubes may be received. Or the number, position, and/or dimensions of the tubes in a bus bar may depend on a desired thermal resistance between a switch 304 and fluid in the tubes. Or the number, position, and/or diameter of tubes in a bus bar may depend on optimizing the thermal capacitance in the bus bar.

A bus bar may be formed by joining (e.g., welding, soldering, sintering, brazing, press-fitting, etc.) metal bus bar portions. Each metal bus bar portion may have one or more grooves formed in a flat surface thereof. Grooves can receive tubes. Grooves can be shaped according to the shape of the tubes they receive. Grooves in metal bus bar portions may be semi-cylindrical in shape to receive cylindrical tubes. Grooves in metal bus bar portions may be semi-oval, or semi-rectangular in shape to receive oval, square, rectangular shaped tubes. Other groove shapes are contemplated.

Grooves in a metal bus bar portion may be the same size and shape, and parallel to each other. Each groove may extend the full length of the metal bus bar portion in which the groove is formed. FIGS. 5A-16-1 and 5A-16-2 are front and end views, respectively, of example metal bus bar portions 504 and 508, respectively, with semi-cylindrical grooves 540 and 542, respectively. Semi-cylindrical grooves, including grooves 540 and 542, may have the same radius. Metal bus bar portions 504 and 508 are aligned in FIG. 5A-16-2 so that semi-cylindrical grooves 540 are aligned with respective semi-cylindrical grooves 542. Bus bar portions, including bus bar portions 504 and 508, can be joined together after alignment of metal bus bar portion grooves using a join material such as solder paste, sinter paste, sinter preform, etc. FIG. 5A-16-3 shows flat surfaces of portions 504 and 508 are joined to each other to create an example bus bar structure 563 with cylindrical channels 40 extending therethrough.

A bus bar may be formed by joining (e.g., welding, soldering, sintering, brazing, press-fitting, etc.) metal bus bar portions, such as metal bus bar portions 504 and 508, around one or more tubes. With continuing reference to FIG. 5A-16-1, FIGS. 5A-17-1-5A-17-5 illustrate relevant aspects of a method of forming an example bus bar 417e around example cylindrical tubes 420d, it being understood the method can be applied to forming bus bars around tubes of other shapes such as tubes with oval, square, or rectangular shapes.

A tube can be received in a groove of a metal bus bar portion such as groove 540 or 542. The dimension(s) of a groove may be substantially equal to or larger than the dimension(s) of the tube it partially receives. For example, the radius of a semi-cylindrical metal bus bar portion groove may be substantially equal to or larger than the radius of a cylindrical tube it partially receives. FIGS. 5A-17-1 and 5A-17-2 are side and end views, respectively, of metal bus bar portions 504 and 508 and metalized ceramic tubes 420d. Pairs of semi-cylindrical grooves 540 and 542 are aligned with each other and with respective tubes 420d as shown in FIGS. 5A-17-1 and 5A-17-2. Metal layer 407d may be axially longer than the lengths of bus bar portions 504 and 508 as shown. Tubes 420d in FIGS. 5A-17-1-5A-17-5 can be swapped with other tubes 420 such as tubes 420a, 420b, 420c, 420e, 420f, 420m, 420n, 4200, 420p, 420q, 420r, etc., assuming they have the same diameter.

Join material (e.g., solder paste) may be added to some, most, or substantially all surface of a metal bus par portion groove, such as groove 540 or 542, to which a tube will be connected. FIG. 5A-17-2 shows join material 440d added to surfaces of semi-cylindrical grooves 540 and 542. About half of each metal bus bar portion groove surface may be covered with join material. In an alternative embodiment, metal bus bar portion groove surfaces, such as those of grooves 540 and 542, may be bare, and join material may be applied to outer surfaces of tubes 420, such as tubes 420d, before they are aligned between aligned grooves of metal bus bar portions, such as groves 540 and 542 of FIG. 5A-17-2.

Join material (e.g., join material 440d or join material 440p described below) can be used to create tube joints. Join material can be used to create joints between opposing flat surfaces of metal bus bar portions. For purposes of explanation only, join material 440 is a solder paste, which may contain bits of metal (e.g., tin and/or silver) and a flux or a chemical agent that can clean metal surfaces of oxidation, it being understood that other types of thermally and electrically conducting join material 440d can be used.

Metal bus bar portions 504 and 508 can be positioned so that solder paste 440d contacts tubes 420d as shown in FIG. 5A-17-3. Then heat can be applied to solder paste 440d. Metal bits of solder paste 440d may melt with the application of heat. Heated flux of solder paste 440d may remove oxidation from surfaces of metal bus bar portions, including surfaces of grooves such as grooves 540 and 542. Flux of solder paste 440d may also burn off as it is heated. Heated solder paste 440d can flow around tubes 420d to create cylindrical tube joints 441d shown in FIG. 5A-17-4. Some heated solder paste 440d may flow into spaces between flat surfaces of metal bus bar portions 504 and 508 to create thin rectangular joints 443d shown in FIG. 5A-17-4. The assembly can be cooled, which solidifies joints 441d and 443d. FIG. 5A-17-5 is a front view of bus bar 417e shown in FIG. 5A-17-4.

Some heated solder paste 440d may flow into spaces between flat surfaces of metal bus bar portions 504 and 508 to create joints 443d as described above. However, the amount of solder paste 440d added to the surfaces of grooves may provide little to no heated solder paste flow into spaces between opposing flat surfaces of metal bus bars. Join material like solder paste 440d may also be added to one or both opposing flat surfaces of metal bus bar portions, such as metal bus bar portions 504 and 508 in FIG. 5A-17-2. When heated, this added solder paste can flow to create joints 443d.

It is noted that joints 441d and joints 443d can be made with a join material other than solder paste. Tube joints 441d could be made with a join material that is thermally conductive and electrically isolating such as electrically insulating glue. However, some, most or all of each or most of joints 443d should be made with an electrically conductive join material, such as the solder paste 440d described above, to enable an electrical connection between metal bus bar portions 504 and 508.

Multiple bus bars, such as phase bus bars, may be formed by joining (e.g., welding, soldering, sintering, brazing, press-fitting, etc.) sets of metal bus bar portions around one or more tubes using a process like that described above with reference to FIGS. 5A-17-1-5A-17-5. FIGS. 5A-17-6-5A-17-10 show relevant aspects of an example process for building example bus bars 418e around cylindrical tubes 420g, it being understood the process can be applied to forming bus bars 418e around tubes of other shapes such as tubes with oval, square, or rectangular cross-sections.

FIGS. 5A-17-6 and 5A-17-7 are front and side views of a set of three linearly aligned metal bus bar portions 505, a set of three linearly aligned metal bus bar portions 509, and a set of three metalized ceramic tubes 420g, each of which is positioned between and aligned with a respective pair of semi-cylindrical grooves that are formed in flat surfaces of metal bus bar portions 505 and 509, it being understood that grooves of other shapes may be formed in the flat surfaces to accommodate tubes of other shapes. The size and shape of metal bus bar portions 505 may be substantially equal, and the size and shape of metal bus bar portions 509 may be substantially equal. The size and shape of metal bus bar portions 505 and 509 may be substantially equal. The size and shape of metal bus bar portions 505 may be different than the size and shape of metal bus bar portions 509. Metal layers 407p are aligned with respective pairs of bus bar portions 505 and 509 as shown. Metal layers 407p may be axially longer than the lengths of respective pairs of bus bar portions 505 and 509 as shown. Gaps exist between metal layers 407p on a tube. The axial length of metal layers 407p need not be the same as shown in FIG. 5A-17-6. Tubes 420g of FIGS. 5A-17-1-5A-17-5 can be swapped with other types of tubes such as tubes such as 420a, 420b, 420c, 420m, 420n, 4200, 420s.

Tube 420g can be received in the set of linearly aligned semi-cylindrical grooves of metal bus bar portions 505 or metal bus bar portions 509. The radius of each of the semi-cylindrical grooves in metal bus bar portions 505 and 509 may be substantially equal to or larger than the outer radius of metal layers 407p of tube 420g. Semi-cylindrical grooves in metal bus bar portions 505 and 509 are substantially the same size and shape, and parallel to each other in the figures. Each semi-cylindrical groove extends the full length of the metal bus bar portion 505 or 509 in which the groove is formed.

FIG. 5A-17-7 shows join material 440p added to surfaces of semi-cylindrical grooves of metal bus bar portions 505 and 509. About half of each semi-cylindrical groove surface receives join material 440p in the figures. In an alternative embodiment, groove surfaces of metal bus bar portions may be bare and join material may be applied to the outer surfaces of tubes. For purposes of explanation only, join material 440p takes form in solder paste, which contains bits of metal (e.g., tin and/or silver) and a flux or a chemical agent that can remove oxidation from metal surfaces, it being understood that another type of thermally conducting and electrically conducting join material 440p can be used.

Metal bus bar portions 505 and 509 can be positioned with solder paste 440p contacting tubes 420g as shown in FIG. 5A-17-8. Then heat can be applied to solder paste 440p. Metal bits of solder paste 440p may melt with the application of heat. Heated flux of solder paste 440p may remove oxidation from surfaces of metal bus bar portions 505 and 509, including surfaces of semi-cylindrical grooves in metal bus bar portions 505 and 509. Flux of solder paste 440p may also burn off as it is heated. Heated solder paste 440p can flow around tubes 420g to create tube joints 441p of FIG. 5A-17-9. Some heated solder paste 440p may flow into spaces between flat surfaces of metal bus bar portions 505 and 509 to create electrically conductive joints 443p in FIG. 5A-17-9. The assembly can be cooled, which solidifies 441p and 443p. FIG. 5A-17-10 is a front view of bus bars 418e shown in FIG. 5A-17-9.

Some heated solder paste 440p may flow into spaces between flat surfaces of metal bus bar portions 505 and 509 to create joints 443p as described above. However, the amount of solder paste 440p added to the surfaces of the grooves may provide little to no solder flow into spaces between opposing flat surfaces of respective pairs of metal bus bar portions 505 and 509. Join material like solder paste 440p (or other electrically conductive join material) may also be added to one or both opposing flat surfaces of metal bus bar portions 505 and 509 in FIG. 5A-17-7. When heated, this added solder paste can flow to create joints 443p.

It is noted that joints 441p and joints 443p can be made with a join material other than solder paste. Tube joints 441p could be made with a join material that is thermally conductive and electrically isolating such as electrically insulating glue. However, some, most or all of each or most of joints 443p should be made with an electrically conductive join material, such as the solder paste 440p described above, to enable an electrical connection between respective metal bus bar portion pairs 505 and 509.

Multiple bus bars, such as phase bus bars, may be formed by joining (e.g., welding, soldering, sintering, brazing, press-fitting, etc.) sets of metal bus bar portions around one or more tubes using a process like that described above with reference to FIGS. 5A-17-1-5A-17-5. FIGS. 5A-17-6-5A-17-10 show relevant aspects of an example process for building three bus bars 418e around partially metalized ceramic tubes 420g.

Bus bars can be formed around multiple rows of tubes. For example, phase bus bars 418T of FIG. 5A-1 are formed around two rows of three tubes 420a. Multiple bus bars, such as phase bus bars, may be formed by joining (e.g., welding, soldering, sintering, brazing, press-fitting, etc.) sets of metal bus bar portions around two or more rows of tubes using a process like that described above with reference to FIGS. 5A-17-6-5A-17-10. FIGS. 5A-17-11-5A-17-15 show relevant aspects of an example process for building example bus bars 418d around two rows of partially metalized ceramic tubes 420g.

FIGS. 5A-17-11 and 5A-17-12 are front and side views of two sets of three linearly aligned metal bus bar portions 505, two sets of three linearly aligned metal bus bar portions 509, and two sets of three metalized ceramic tubes 420g, each of which is positioned between and aligned with a respective pair of semi-cylindrical grooves that are formed in flat surfaces of metal bus bar portions 505 and 509. Metal bus bar portions 509-1b, 509-2b, and 509-3b are shown connected (e.g., welded, soldered, sintered, etc.) back-to-back with metal bus bar portions 505-1b, 505-2b, and 5053b, respectively, via respective joints 447. In an alternative embodiment back-to-back connected metal portions, such as 509-1b and 505-1b, can be formed as a unitary structure using manufacturing process such as extrusion, milling, casting, etc., thereby eliminating the step of joining (e.g., soldering) metal portions, such as 509-1b and 505-b. Tubes 420g of FIGS. 5A-17-11-5A-17-15 can be swapped with other types of tubes such as tubes such as 420a, 420b, 420c, 420m, 420n, 4200, 420s.

Just like tubes 420g in FIGS. 5A-17-5-5A-17-10, each tube 420g can be received in a set of three linearly aligned semi-cylindrical grooves of metal bus bar portions 505 or metal bus bar portions 509. The radius of each of the semi-cylindrical grooves in metal bus bar portions 505 and 509 may be substantially equal to or larger than the outer radius of metal layers 407p of tube 420g.

FIG. 5A-17-12 shows join material 440p added to surfaces of semi-cylindrical grooves of metal bus bar portions 505 and 509. About half of each semi-cylindrical groove surface receives join material 440p in the figures. In an alternative embodiment, semi-cylindrical groove surfaces of metal bus bar portions 505 and 509 may be bare and join material may be applied to the outer surfaces of tubes 420g. Join material 440p may take form in solder paste, which contains bits of metal (e.g., tin and silver) and a flux or a chemical agent that can remove oxidation from metal surfaces, it being understood that another type of thermally conducting and electrically conducting join material 440p can be used.

Metal bus bar portions 505 and 509 can be positioned with solder paste 440p contacting tubes 420g as shown in FIG. 5A-17-13. Then heat can be applied to solder paste 440p. Metal bits of solder paste 440p may melt with the application of heat. Heated flux of solder paste 440p may remove oxidation from surfaces of metal bus bar portions 505 and 509, including surfaces of semi-cylindrical grooves in metal bus bar portions 505 and 509. Flux of solder paste 440p may also burn off as it is heated. Heated solder paste 440p can flow around tubes 420g to create tube joints 441p of FIG. 5A-17-14. Some heated solder paste 440p may spill into spaces between flat surfaces of metal bus bar portions 505 and 509 to create electrically conductive joints 443p in FIG. 5A-17-14. The assembly can be cooled, which solidifies 441p and 443p. FIG. 5A-17-15 is a front view of bus bars 418d shown in FIG. 5A-17-19.

Some heated solder paste 440p may flow into spaces between flat surfaces of metal bus bar portions 505 and 509 to create joints 443p as described above. However, the amount of solder paste 440p added to the surfaces of the grooves may provide little to no heated solder paste flow into spaces between opposing flat surfaces of respective pairs of metal bus bar portions 505 and 509. Join material like solder paste 440p (or other electrically conductive join material) may also be added to one or both opposing flat surfaces of metal bus bar portions 505 and 509 in FIG. 5A-17-12. When heated, this added solder paste can flow to create joints 443p.

It is noted that joints 441p and joints 443p can be made with a join material other than solder paste. Tube joints 441p could be made with a join material that is thermally conductive and electrically isolating such as electrically insulating glue. However, some, most or all of each or most of joints 443p should be made with an electrically conductive join material, such as the solder paste 440p described above, to enable an electrical connection between respective metal bus bar portion pairs 505 and 509. Bus bars 418Ta-418Tc in FIGS. 5A-1 and 5A-2S can be with bus bars 418d-1-418d-3 of FIG. 5A-17-15.

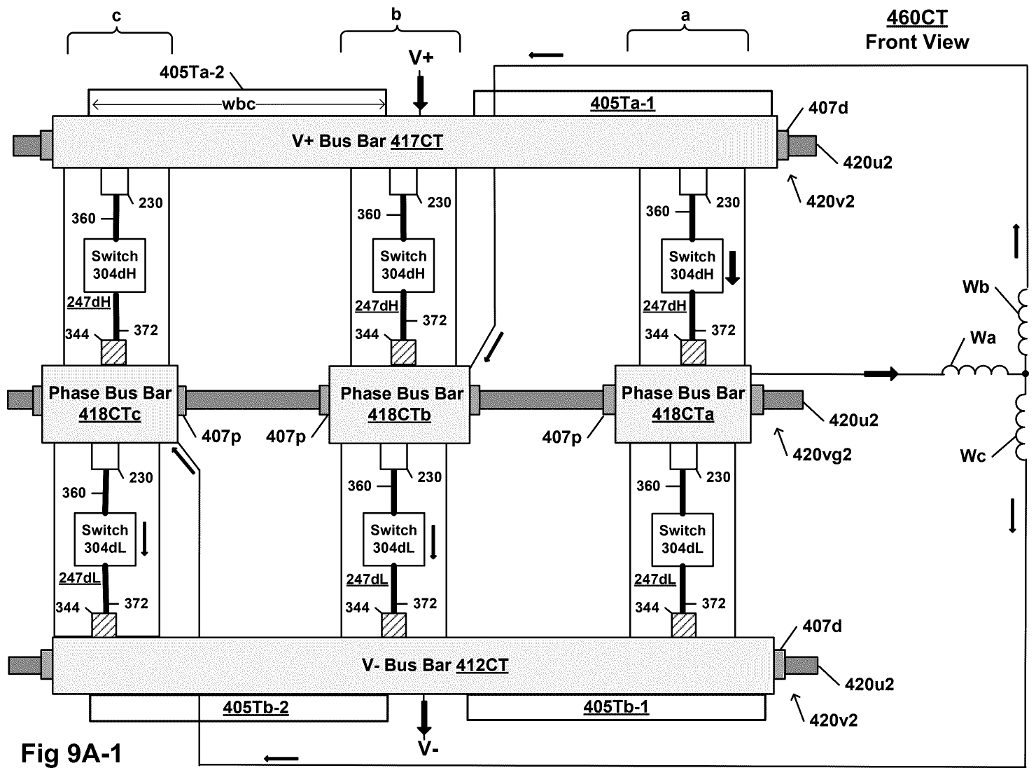

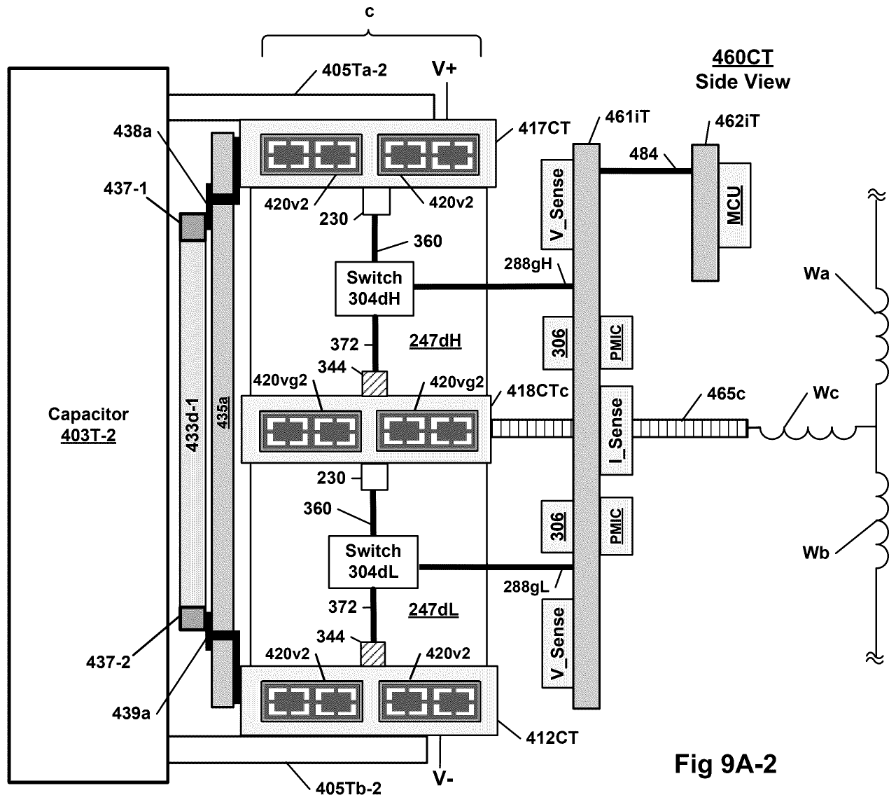

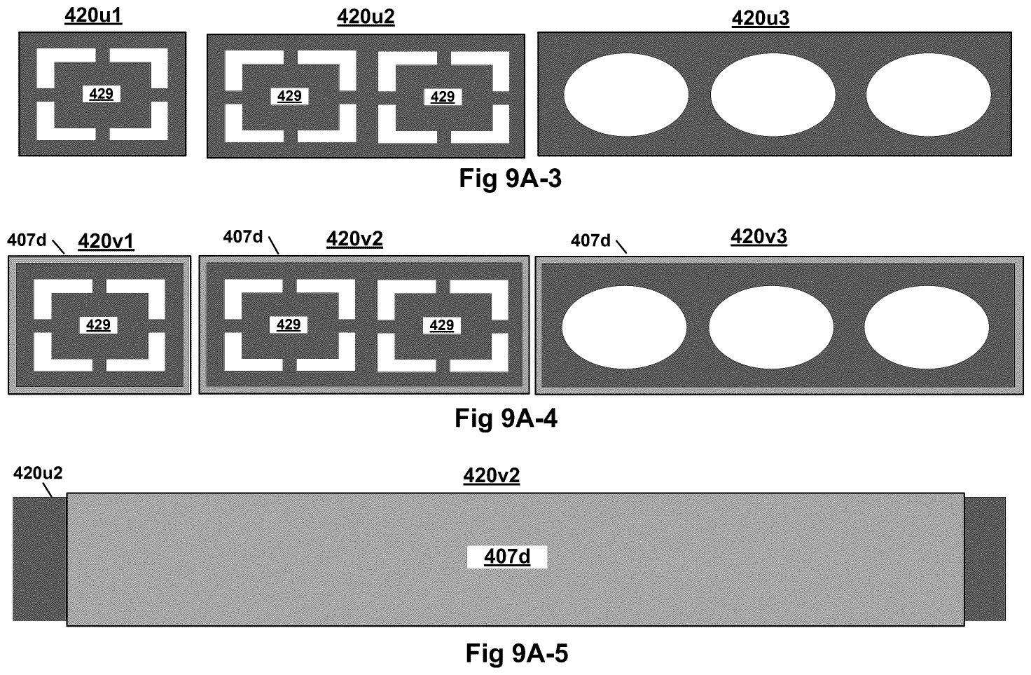

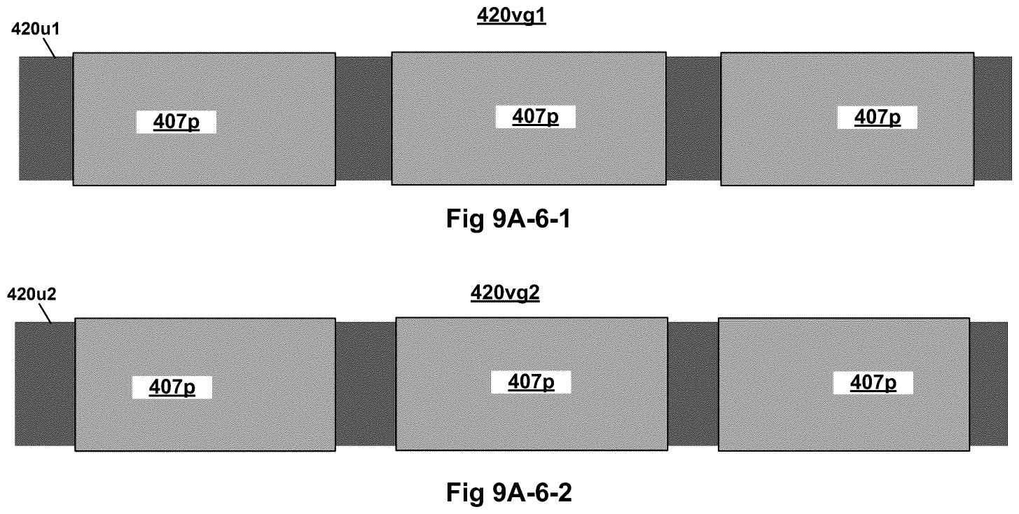

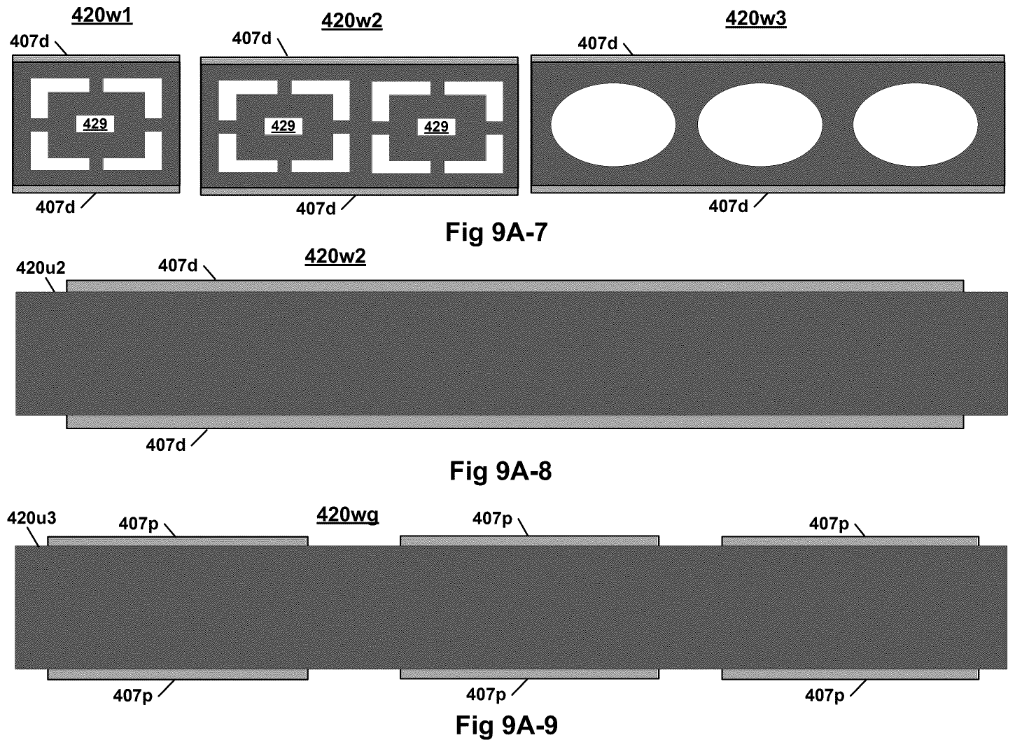

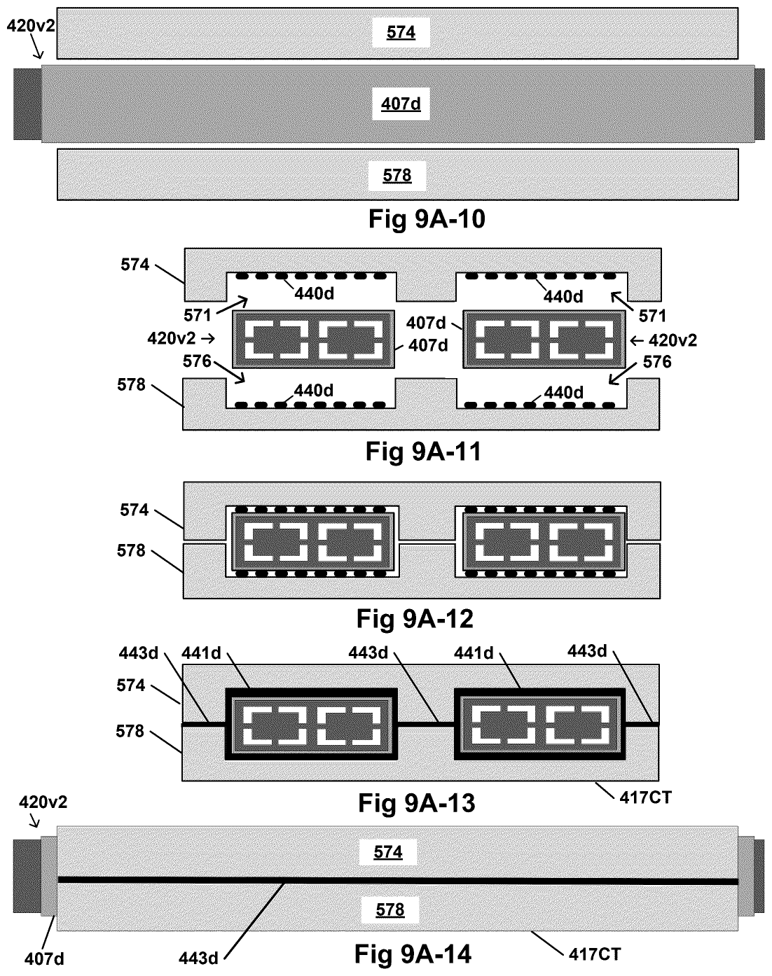

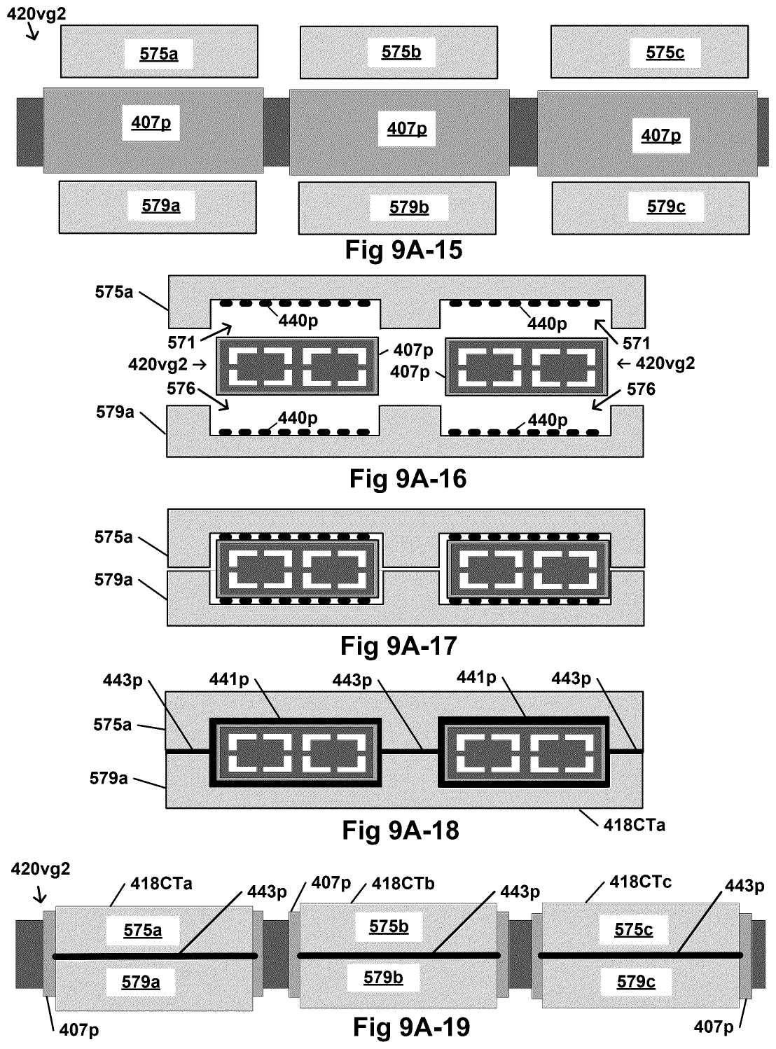

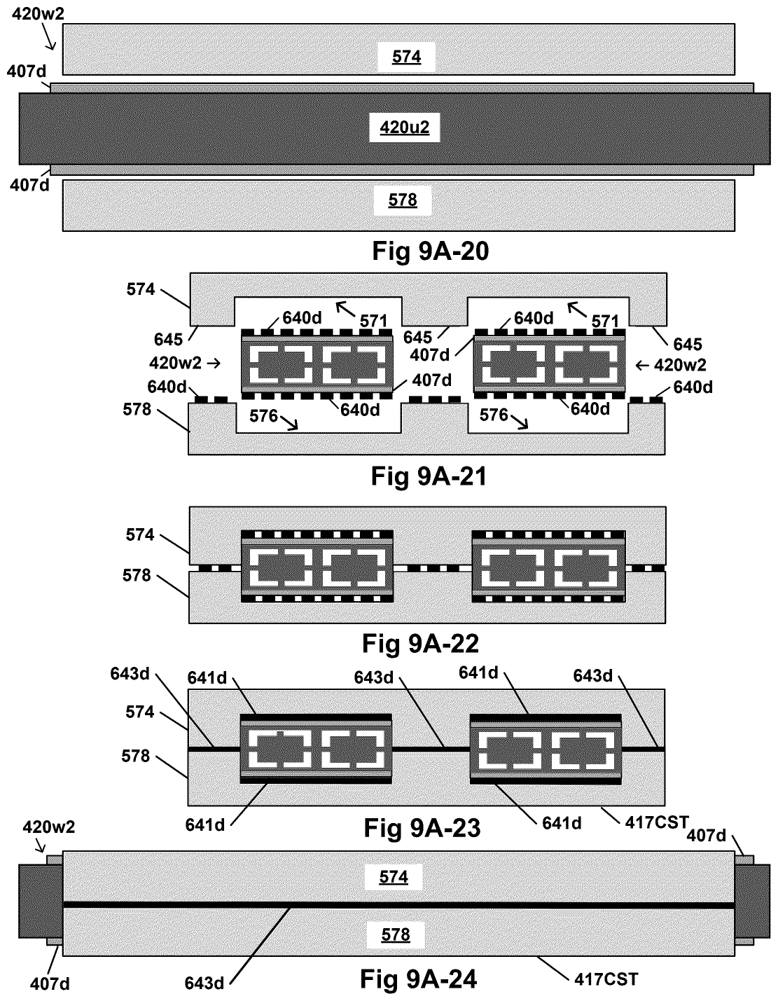

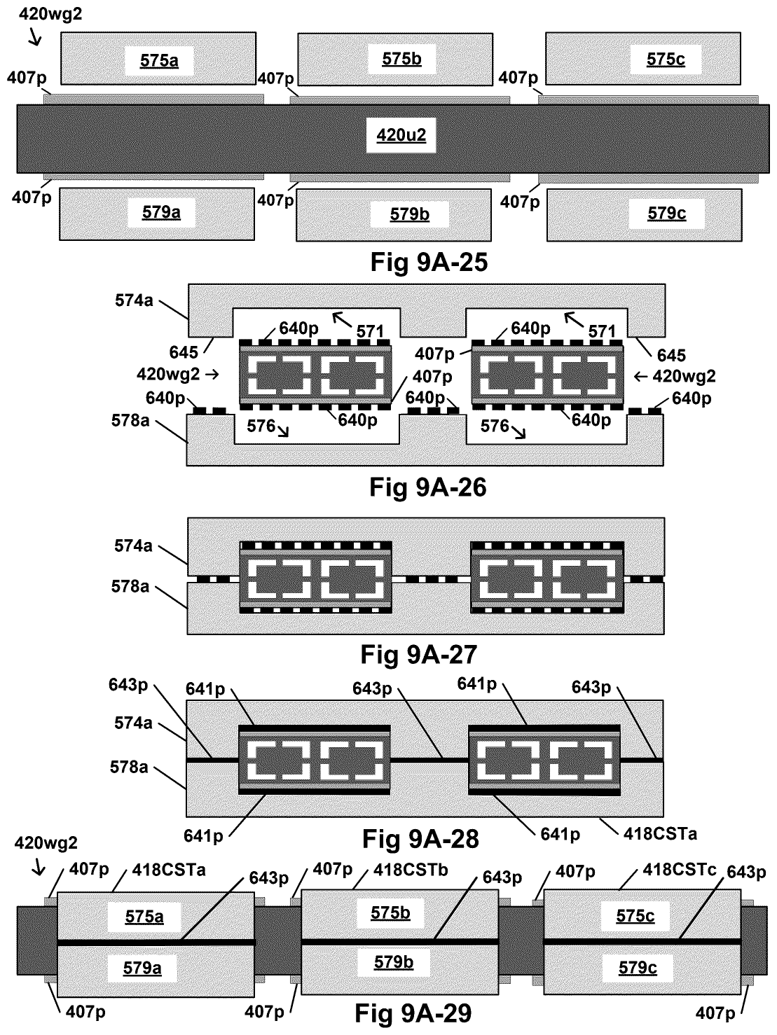

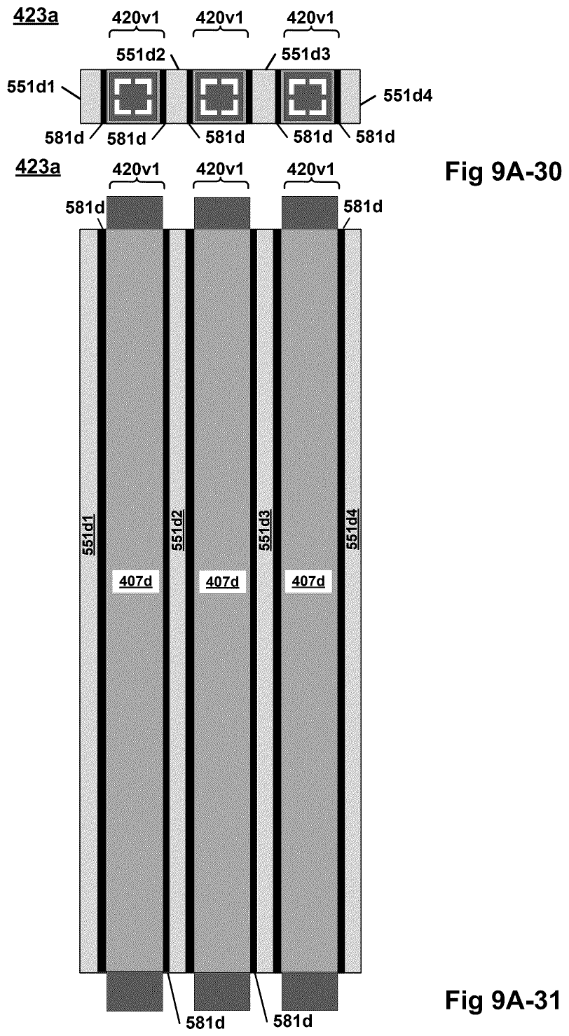

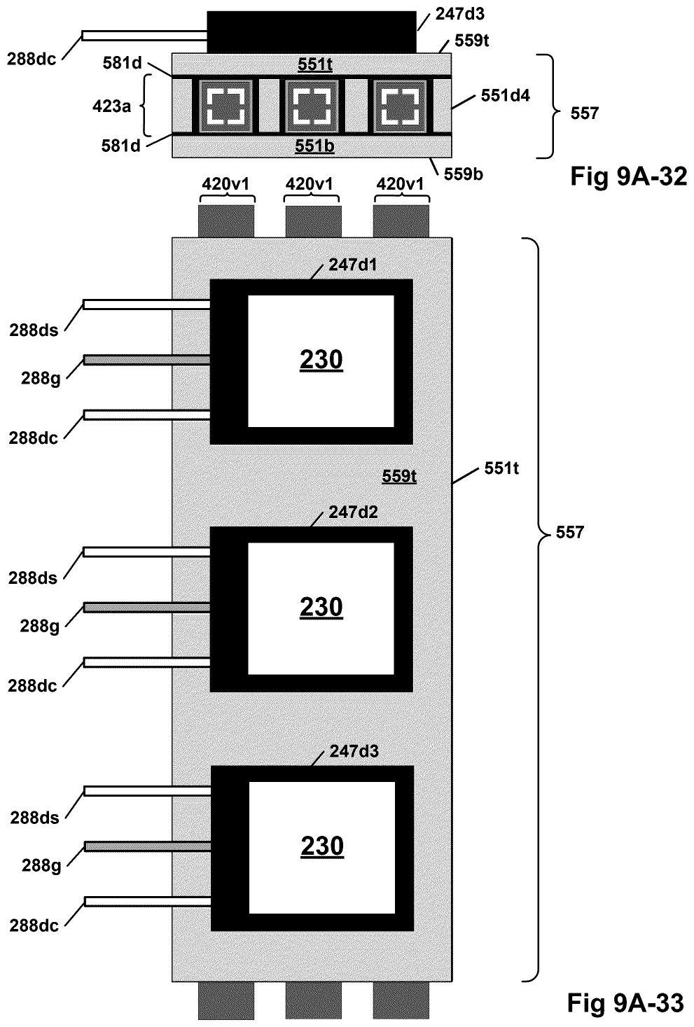

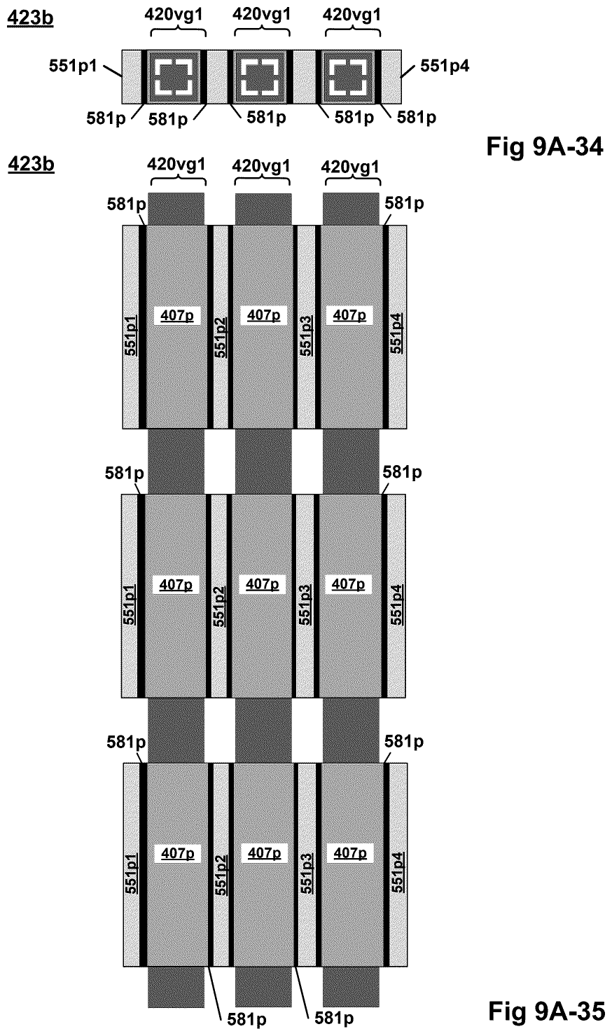

Bus bars (e.g., bus bars of FIGS. 5A-1 and 5A-2S) can be sintered around one or more tubes 420. For example, one or more tubes 420, such as tubes 420a shown in FIGS. 9A-1, and a powdered sintering material (e.g., powdered copper, powdered aluminum, powdered silver, a mixture of two or more powdered metals, a mixture of two or more powdered metal alloys, a mixture of powdered metal and powdered metal alloys, etc.) can be added to a negative impression die or mold (e.g., a graphite die or mold). The added powder sintering material may enable solid state sintering around tubes 420. The die can have a space, similar in shape (e.g., rectangular cuboid) to the shape of the desired bus bar, into which the powdered sintering material (hereinafter powder) and one or more tubes 420 are added. After the powder and tubes 420 are added, end surfaces of upper and lower metal punches can apply pressure to the powder inside the sintering die or mold. The upper and lower punches may have flat end surfaces with a shape (e.g., rectangular) and dimensions (e.g., length and width) that substantially match the cross-sectional shape and dimensions of the die's inner space into which the power and tubes are added. The upper and lower punches can have one or more apertures through which opposite ends, respectively, of the one or more tubes, respectively, may extend and move. The upper and/or lower punches can be moved into position to engage the powder in the die while ends of the one or more tubes extend through these apertures. FIGS. 5A-18-1 and 5A-18-2 are bottom and side views of an example upper punch 584. Although not shown, a lower punch may be substantially similar. Punch 584 can be formed of metal with apertures 42 that are sized to receive ends of cylindrical tubes 420, it being understood the apertures may take a different shape such as oval, square, or rectangle to receive oval shaped, square shaped, or rectangular shaped tubes, such as tubes 420u1-420u3, in an alternative embodiment.

FIG. 5A-18-3 shows punch 584 with ends of example tubes 420a extending through apertures 42. Punch 584 includes a flat surface 586 that can engage powder contained in a sintering die during a sintering process. Pressure can be applied uniaxially to the powder at one or both ends by the upper and/or punches while heat is transferred to the powder through the upper and/or lower punches. In time the pressure and heat can sinter the powder into a substantially solid mass around the one or more tubes 420. With respective ends of one or more tubes 420 extending through one or more apertures, respectively, of the upper and lower punches, and freely movable therethrough, the force applied to the powder is parallel to the tubes, which may prevent or reduce damage to the tubes during the sintering process. Spark plasma sintering (SPS), also known as field assisted sintering technique (FAST), is a technique that could be used to sinter bus bars around tubes. SPS may combine the application of pressure from the upper and lower punches and a pulsed or unpulsed DC or AC electric current to joule heat and sinter the powder around tubes. The pulsed or unpulsed DC or AC current can be conducted through the die and/or the metal powder while pressure is applied, causing rapid localized heating. The upper punch (e.g., punch 584) and lower punch can be electrically connected to respective terminals of a source that supplies the pulsed or unpulsed DC or AC electric current. Pulsed DC electric current can create a series of high-temperature phenomena at contact points between particles in the powder, resulting in rapid, localized heating and material densification. When a pulsed electric current is applied, a high-energy spark discharge may occur in tiny gaps between conductive powder particles. This discharge can create a transient, high-temperature plasma state, which can reach thousands of degrees Celsius. This extreme, localized heat can clean the particle surfaces by evaporating or melting contaminants and activating the particles for sinter bonding. High-density pulsed current can be forced through the contact points of the powder particles, where the electrical resistance is greatest. This may cause intense Joule heating. Heat generation through pulsed or unpulsed DC or AC electric current is internal to the powder, in contrast to the hot pressing as described above, where the heat is transferred to the powder through the upper punch (e.g., punch 584) and/or lower punch. In yet another embodiment external pressure and an electric field may be applied simultaneously to enhance the densification of the powder. For example, the die, powder, and tubes 420 can be subjected to an electromagnetic field while the punches are applying uniaxial pressure. The electromagnetic field can inductively heat the powder while the upper and lower punches apply pressure to the powder. FIGS. 5A-18-1-5A-18-3 are described with reference to sintering bus bars around cylindrical tubes 420. Bus bars can be sintered around square or rectangular shaped tubes 420, which are more full described below. However, the apertures formed in the upper and lower punches should be square or rectangular in cross section to accommodate square or rectangular shaped tubes 420 extending through the apertures. Once a bus bar is formed around one or more tubes using a sintering method, the bus bar can be further processed. For example, surfaces of the bus bar to be attached to a die substrate terminal 230 or die clip terminal 344 of a packaged switch 247 or packaged diode 245, may be smoothed to increase the thermal and/or electrical conductivity between the bus bar and the die substrate terminal 230 or die clip terminal 344. Or the bus bar may be machined so that its dimensions meet requirements for the bus bar's inclusion into a power converter such as inverter 460iT.

Other patentable methods of forming bus bars around tubes are disclosed. For example, liquid metal (e.g., indium, cadmium, lead, zinc, etc.) or alloy (e.g., brass, solder, etc.) can be injected into spaces surrounding tubes 420, which are positioned in channels. FIG. 5A-19-1 shows a generally rectangular cuboid shaped block of 565 made of metal (e.g., copper, aluminum, etc.) or alloy when seen from a side. Cylindrical channels 40 can be formed (e.g., drilled) through cuboid 518 to create example bus bar structure 565 of FIG. 5A-19-2. Tubes 420, such as tubes 420a as shown, with diameters less than the diameters of channels 40, can be positioned in respective cylindrical channels 40 as seen in FIG. 5A-19-3. Alternatively, tubes 420 with smaller diameters can be positioned in channels 40 of bus bar structure 563 shown in FIG. 5A-16-2. Liquid metal or liquid alloy (e.g., indium, cadmium, lead, tin, zinc, solder, brass, etc.) can be added (e.g., injected) to fill the empty spaces between tubes 420a and the surfaces of the respective channels 40. FIG. 5A-19-4 shows the structure of FIG. 5A-19-3 with liquid metal or liquid alloy 580 added to the empty spaces. Tubes 420a and example bus bar 417T may be heated to a temperature that is greater than the melting point of liquid metal or liquid alloy 580 so that liquid metal or liquid alloy 580 remains in the liquid state as it is added to the cylindrical spaces between tubes 420a and surfaces of respective channels 40. Bus bar structure 565 and liquid metal or liquid alloy 580 may be the same type of material, or they may be different (e.g., bus bar structure 565 can be copper, aluminum, etc., and liquid metal or liquid alloy 580 can be silver, indium, cadmium, lead, bismuth, tin, zinc, solder, brass, etc.). The liquid metal or liquid alloy 580 in the cylindrical spaces between tubes 420a and surfaces of respective channels 40 can cool and form a solid thermal connection between tubes 420a and surfaces of the cylindrical respective channels 40, thereby creating example bus bar 417T of FIG. 5A-19-4. Zinc may be a preferred liquid metal 580 over cadmium since zinc has a higher thermal conductivity (i.e., 116 W/mK). Brass may be a preferred liquid material 580 over solder since brass has a higher thermal conductivity (i.e., 109 to 125 W/mK). FIG. 5A-19-5 shows example bus bar 417T of FIG. 5A-19-4 from the side. FIGS. 5A-19-1-5A-18-5 are described with reference to forming bus bars around tubes 420 positioned in circular channels 40. Bus bars can be formed around oval, square or rectangular shaped tubes 420 using a process like that described with reference to FIGS. 5A-19-1-5A-18-5. However, the channels formed in the upper and lower punches should be oval, square or rectangular in cross section to accommodate square or rectangular shaped tubes 420.

In general, a converter's DC bus bars (i.e., V+ and V-bus bars) may receive one or more tubes 420a-420f, or 420j-420r without tube joint. If a metal tube 420j-4201 is received without tube joint by a V+ and V-bus bar, the fluid flowing through the tube to extract heat should be a dielectric (e.g., air, oil, deionized water, etc.). Bus bars with commonly receive tubes should be electrically isolated from each other. Bus bars (e.g., phase bus bars) may commonly receive one or more tubes 420a-420c, 420m-4200, 420g, 420s, or 420t without tube joint.

FIGS. 5A-1 and 5A-2S show inverter 460iT with bus bars 412T, 417T, and 418T that receive dielectric tubes 420a with or without tube joint. Tubes other than 420a can be received by the bus bars. For example, each of bus bars 412T and 417T can be formed around tubes 420d or 420e using a process like that described with reference to FIGS. 15-17-1-15-17-5, and bus bars 418T can be formed around tubes 420g using a process like that described with reference to FIGS. 5A-17-11-5A-17-15. Or the bus bars can be swapped with bus bars formed around tubes like tubes 420v1 using a process like that described with reference to FIGS. 9A-30-9A-33 or FIGS. 9A-34-9A-37. Phase bus bars 418Ta-418Tc may be thermally connected to each other and electrically isolated from each other by commonly received dielectric tubes 420a.

For purposes of explanation only, many figures of this disclosure show tubes 420a received in bus bars or heat sinks without tube joint, it being understood other types of tubes 420 can be received in the bus bars or heat sinks without tube joint or with tube joint. All tubes 420 in bus bars or heat sinks of a power converter may be the same. A power converter may employ a mix of tube types. For example, phase bus bars in a converter may commonly receive tube 420g with or without tube joint, while the converter's DC bus bars, may receive tubes 420d with or without tube joint. Or phase bus bars in a converter may commonly receive tubes 420b with or without tube joint, while the converter's DC bus bars may receive tubes 420n with or without tube joint.

A die substrate terminal 230 or die clip terminal 344 of a packaged switch or packaged diode may be electrically and/or thermally connected to a flat metal surface of a bus bar or heat sink after the bus bar or heat sink is formed around one or more tubes 420. A die substrate terminal 230 or die clip terminal 344 may be electrically and/or thermally connected to the flat metal surface using any one of several methods. In one method (hereinafter “wire mesh bonding method”), a die substrate terminal 230 or die clip terminal 344 (or other device) may be electrically and/or thermally connected using a wire mesh made of woven copper wires or wires of another type of metal or metal alloy. The wire of the mesh may have a diameter of 400.0, 200.0, 100.0, 50.0, 25.0 μm or less. The distance between parallel wires in the mesh may be 2.0, 1.0, 0.5, 0.1, 0.05, 0.01 mm or less. In a wire mesh bonding method, a layer of solder (e.g., solder paste or solder preform) can be applied to a flat metal surface of a heat sink or bus bar. The applied solder layer may contain flux, which can remove oxidation from the metal surface of the bus bar or heat sink. The applied solder layer may contain tin. The applied solder layer may also contain lead, silver and/or bismuth. A layer of the same or similar type of solder can also be applied to the flat surface of the die substrate terminal 230 or die clip terminal 344 to be connected to the metal bus bar or heat sink. The die substrate terminal 230 or die clip terminal 344, with or without the layer of solder applied to it, may then be placed on top of the copper wire mesh. Heat can be applied to the solder and mesh between the die substrate 230 or die clip terminal 344 on one side, and the metal bus bar or heat sink on the other side. In one embodiment, heat can be applied to the stack consisting of the metal bus bar or heat sink; die substrate terminal 230 or die clip terminal 344, and; the wire mesh and solder layer(s). The stack may be pressed together while the heat is applied. The applied heat should be sufficient to melt metal in the solder paste or solder preform layer(s). In other words, the temperature of the solder paste or solder preform layer(s) may be raised beyond its melting point during the method. In an alternative embodiment, the wire mesh can be incorporated into solder preform before the wire mesh incorporated solder preform is positioned between bus bar and the die substrate terminal 230 or die clip terminal 344, and before heat is applied to the stack having a layer or layers of solder preform incorporated with wire mesh. The wire mesh bonding methods can produce a solder/mesh connection between the die substrate terminal 230 or die clip terminal 344 and the metal heat sink or bus bar. The layer(s) of solder and/or wire mesh may have a melting point that is less than the melting point of a tube joint, such as tube joint 441d or 441p described above so that the tube joint does not reflow during the wire mesh bonding method. The resulting solder/mesh connection may be a solid or integrated mass, with a thickness of 400.0, 200.0, 100.0, 50.0, 25.0, 10.0 μm or less between the bus bar or heat sink on the one side and the die substrate terminal 230 or die clip terminal 344 on the other side. This method of connecting two objects using a wire mesh and solder could be used for connecting flat surfaces of other components. For example, this method could be used to connect flat surfaces of capacitor-leads to flat surfaces of bus bars.

Different materials expand at different rates when heated. Materials such as solder or silver sintering paste or preform could be used to connect die substrate or die clip terminals to bus bars, for example, but these materials may crack when heated or cooled due to mismatches in CTEs (coefficients of thermal expansion) between them and die substrate or die clip terminals. A mechanical structure (e.g., a clamp) can press-fit die substrate terminals 230 and die clip terminals 344 against respective flat surfaces of bus bars. Press-fitting may reduce or eliminate problems related to mismatched CTEs. Ideally, the surfaces of components that may be pressed together should be smooth to optimize electrical and thermal conduction therebetween. A silver thermal paste or similar electrically and thermally conductive material may added to increase electrical and thermal conduction between surfaces of press-fitted components. For example, a silver thermal paste may be added between a bus bar surface and a die substrate terminal or die clip terminal before they are press-fitted together.

A thin (e.g., 0.001-2.0 mm) layer of a first metal (e.g., nickel, not shown) may be formed (e.g., electroplated) on some or all the outer surfaces of a metal bus bar such as V+ bus bar 417T, phase bus bar 418T, and/or V-bus bar 412T. A thin (e.g., 0.001-2.0 mm) layer of sintering enhancement material (e.g., silver, silver alloy, etc., not shown) may then be formed (e.g., electroplated) on the thin layer of first metal (e.g., nickel). Die substrate or die clip terminals, such as substrate terminals 230 and die clip terminals 344, may then be sintered to the thin layer of sintering enhancement material. The sintering enhancement material may improve the thermal, mechanical and/or electrical properties a sintered connection between the bus bar and die substrate terminals or die clip terminals.

A converter like inverter 460iT may include a control PCB 462, such as control PCB 462i of FIG. 5A-2S. A converter like inverter 460iT may include a driver PCB 461, such as driver PCB 461iT of FIG. 5A-2. Driver PCBs 461, like driver PCB 461iT, may be electrically connected to switches 304, such as switch 304d, through respective sets of connector-leads 288ds, 288g, and 288dc. Only connector-leads 288gH and 288gL of leg-c are shown in FIG. 5A-2.

Driver and control PCBs may be in data communication with each other. Driver and control PCBs may have opposite facing surfaces. Components (e.g., drivers (e.g., base drivers, drivers, etc.), diodes, resistors, capacitors, current sensors, voltage sensors, PMICs, MCUs, transformers, ethernet transceivers, CAN transceivers, etc.) may be mounted on one or each side of driver and control PCBs such as PCBs 461iT or 462i. Terminals of the components such as drivers, capacitors, ethernet transceivers, CAN transceivers, etc., may be electrically connected to traces on the driver and control PCBs. Metal vias can connect traces on opposite sides of PCBs such as PCBs 461iT and 462i. Traces of a driver PCB may be electrically connected to respective connector-leads 288.

A driver PCB, such as driver PCB 461iT, may include components, such as drivers 306, PMICs, voltage sensors V_Sense, etc., mentioned above and below and shown, for example, in FIG. 5A-2S. Many of these driver PCB components can be electrically connected to connector-leads 288 of packaged switches 247 or packaged diodes 245. For example, drivers 306 on a driver PCB 461 can be electrically connected to respective packaged switches 247 through their connector-leads 288g or sets of connecter-leads 288g1 and 288g2. This enables data communication between drivers 306 and respective packaged switches 247. For example, the drivers may generate and send respective control signals to respective transistor control terminals (e.g., gates) or respective groups of transistor control terminals of switches 304 within packaged switches 247 via respective connector-leads 288g or respective sets of connector-leads 288g1 and 288g2. Additionally, the drivers 306 may be electrically connected to respective transistor current terminals (e.g., MOSFET sources) or respective groups of transistor current terminals of switches 304 through their connector-leads 288dc or 288ds. Voltage sensors V_Sense of a driver PCB 461 may be in data communication with switches 304 via respective sets of connector-leads 288dc and 288ds. For example, the voltage sensors V_Sense may sense voltages across first and second current terminals (e.g., MOSFET source and drain) of switches 304 via respective sets of connector-leads 288dc and 288ds. V_Sense can send a signal representing the sensed voltage to the MCU via connector 484 for processing in accordance with MCU executable instructions stored in memory. A PCB 461 may include PMICs that provide and/or regulate DC supply voltages to respective drivers. PMICs may be electrically connected to respective pairs of connector-leads 288dc or 288ds. Other components, such as capacitors or snubber circuits, mounted on a PCB 461 may be electrically connected to respective sets of connector-leads 288dc and 288ds of packaged switches 247 or packaged diodes 245 as more fully described below. Converters and other apparatuses of this disclosure may include an MCU mounted on a control PCB 462 that is separate from a driver PCB 461. The MCU may be in data communication with components (e.g., drivers 306, current sensors I_Sense, voltage sensors V_Sense, etc.) on the driver PCB 461 through a connector 484. In alternative embodiments of the converters and other apparatuses of this disclosure, the MCU and other devices mounted on a control PCB could instead be mounted on the driver PCB. These components, including the MCU, added to the driver PCB can be connected and to other driver PCB components via traces. The driver PCB 461 in these alternative embodiments may need lengthening and/or widening to accommodate the MCU and/or other components added from control PCB 461. The control PCB 461 and connector 484 could then be eliminated.

Power apparatuses of this disclosure may include capacitors such as film capacitors (e.g., a polypropylene film capacitor), ceramic capacitors (e.g., class 1 or class 2 multilayer ceramic capacitors), electrolytic capacitors, etc. A capacitor is a device that stores electrical energy by accumulating electric charges on two closely spaced surfaces that are insulated from each other. Capacitors may contain first and second electrical conductors or plates separated by an dielectric material, the combination of which may be contained in a dielectric package or case.

Capacitors of this disclosure may be electrically connected to bus bars such as V+ or V− bus bars. Capacitors of this disclosure also may be thermally connected to bus bars such as V+ or V− bus bars. Example capacitors 403T in FIGS. 5A-1, 5A-2S, and 5A-2T may be thermally and electrically connected between V+ bus bar 417T and V− bus bar 412T as shown. The size and shape of capacitors may vary from power apparatus to power apparatus.

Capacitors electrically connected between V+ and V− bus bars may be referred to as DC link capacitors. A DC link capacitor can take form in a film capacitor, a ceramic capacitor, an electrolytic capacitor, etc. A power apparatus of this disclosure may include a mix of DC link capacitor types. For example, a converter may include one or more film capacitors and one or more ceramic capacitors, all electrically connected in parallel between, for example, V+ and V− bus bars.

Power apparatuses of this disclosure may include film capacitors 403. Film capacitors 403, such as DC link film capacitors 403T, may have first and second metal capacitor-leads 405, such as capacitor-leads 405T shown in FIGS. 5A-1, 5A-2S and 5A-2T, extending laterally from a flat wall surface of the capacitor's dielectric package. Ends of first and second metal capacitor-leads may be electrically and thermally connected to first and second electrical conductors, respectively, inside the film capacitor's dielectric package. Flat surfaces of first and second metal capacitor-leads 405 external to the package, such as capacitor-leads 405T shown in FIGS. 5A-1, 5A-2S and 5A-2T, may be electrically and thermally connected (e.g., soldered, welded, etc.) to respective flat surfaces of bus bars such as V+ and V− bus bars. Some capacitor-leads 405 may have bent portions, such as bent portions 601 described below, with flat surfaces that may be electrically and thermally connected to flat surfaces of bus bars such as V+ and V− bus bars. A flat surface of a dielectric side wall of a film capacitor 403, such as 403T, may be thermally connected to a flat surface of a bus bar. Opposite facing flat surfaces of dielectric side walls of a film capacitor may be thermally connected to respective flat surfaces of bus bars such as V+ and V− bus bars, respectively. The side wall surface and/or capacitor-lead thermal connections may enable heat extraction from a film capacitor 403. Capacitors, including film capacitors 403, may be cooled by direct contact with dielectric fluid such as castor oil.

With continuing reference to FIGS. 5A-1, 5A-2S and 5A-2T, packages of film capacitors 403, including DC link film capacitors 403T, may have four dielectric side wall surfaces extending between a dielectric top surface and a dielectric bottom surface. Each capacitor 403T may have first and second metal capacitor-leads 405Ta and 405Tb, respectively, extending from the capacitors' front dielectric side wall. Capacitor-leads 405, including capacitor-leads 405T, may be rectangular in cross section. Example capacitor-leads 405T have a height hbc, length lbc, and width wbc around 6 mm, 20 mm, and 20 mm, respectively. Capacitor-leads 405. such as capacitor-leads 405T, may have substantially flat, rectangular-shaped opposite facing top and bottom surfaces. The top and bottom surface areas may be around 400 mm². A substantial portion (e.g., 10, 20, 50, 75, 90% or more) of a capacitor-lead's flat surface area may be electrically and thermally connected (e.g., welded, soldered, press-fitted by screws or other fasteners, etc.) to a flat surface of a bus bar such as a V+ or V− bus bar. For example, a substantial portion (e.g., 10, 20, 50, 75, 90% or more) of capacitor-lead 405Ta's flat bottom surface area may be electrically and thermally connected to a flat surface of V+ bus bar 417T, and a substantial portion (e.g., 10, 20, 50, 75, 90% or more) of capacitor-lead 405Tb's flat top surface area may be electrically and thermally connected to a flat surface of V− bus bar 412T. Bus bars such as V+ bus bar 417, including V+ bus bar 417T, and V− bus bar 412 including V− bus bar 412T, can extract heat (e.g., 1, 2, 5, 10, 20, 40, 80, 100, 200, 300 Watts or more) from connected capacitors such as film capacitors 403 through flat surfaces of their capacitor-leads 405.

FIG. 5A-2S shows a space between capacitor 403T-2 and flat side walls of bus bars 417T, 418T, and 412T. In an alternative version, the flat surfaces of the dielectric front side walls of film capacitors 403T may be thermally connected to flat side wall surfaces of bus bars 417T, 418T, and/or 412T.

Power apparatuses of this disclosure may include ceramic capacitors 433, such as ceramic capacitors 433d shown in FIG. 5A-20. Example ceramic capacitors 433d, which are more fully described below, may be electrically connected between DC bus bars. A ceramic capacitor 433 may have metal terminals 437 at opposite ends. First and second metal terminals 437 of a ceramic capacitor 433 may be electrically and thermally connected to first and second isolated electrical conductors, respectively, inside the ceramic capacitor's dielectric package. Terminals 437 of ceramic capacitors 433 may be electrically connected to bus bars such as V+ and V-bus bars, or other devices. Each metal terminal 437 may have a flat end surface and flat side wall surfaces extending therefrom. The flat end surfaces of the first and second metal terminals 437 of a ceramic capacitor 433 may face opposite directions. Flat surfaces of metal terminals 437 may be electrically and thermally connected to bus bars such as V+ and V-bus bars. First and second metal terminals 437 of a ceramic capacitor 433 may be electrically connected (e.g., soldered) to first and second metal traces of a PCB, and the first and second metal traces may be electrically connected to respective bus bars such as V+ and V-bus bars.

Power apparatuses of this disclosure may include a PCB 535 upon which ceramic capacitors and other devices may be mounted. FIG. 5A-20 shows inverter 460iT of FIG. 5A-2S with example PCB 435a positioned between DC link film capacitors 403T on one side and bus bars 417T, 412T, and 418T on the other side as shown. PCB 435a is also positioned between connector-leads 405Ta and 405Tb as shown. Terminals of ceramic capacitors 433, such as ceramic capacitors 433d, can be electrically connected to traces 438 and/or 439, such as traces 438a and 439b on a PCB 435, such as PCB 435a. A row of example DC link ceramic capacitors 433d are mounted PCB 435a and electrically connected to traces 438a and 439a thereof. For ease of illustration, only one ceramic capacitor 433d-1 of the row is shown, but the ceramic capacitors 433d mounted on PCB 435a are electrically connected in parallel. In an alternative embodiment, each of the ceramic capacitors 433d may be replaced by two ceramic capacitors that are electrically connected in series between traces 438 and 439. Each of two ceramic capacitors may be shorter in length between terminals 437 when compared to capacitors 433d. If an electrical short is created between one of the two series connected capacitors, the other of the two should be able to prevent a short circuit between traces 438 and 439.

Metal vias can electrically connect traces on one side of a PCB, such as traces 511 and 513, including 511a and 513a, to respective traces, such as traces 438 and 439, including 438a and 439a, on the other side of the PCB. Metal traces 511 and 513, including metal traces 511a and 513a, may be electrically connected to respective bus bars such as V+ bus bar 417T and V-bus bar 412T. Each of the ceramic capacitors 433d may include first and second metal terminals 437-1 and 437-2, respectively, electrically connected to the V+ and V-bus bars, respectively, through example metal traces 438a and 439a, respectively, and example metal traces 511a and 513a, respectively. Ceramic capacitors 433 may have lower equivalent series inductance (ESL) when compared to the ESL of film capacitors 403, and because of their lower ESL, ceramic DC link capacitors 433d may be better able to attenuate higher frequency voltage components compared to film DC link capacitors 403T. On the other hand, ceramic capacitors 433 may have lower capacitance when compared to the capacitance of film capacitors 403.

Dielectric side walls may extend between first and second metal terminals 437 of a ceramic capacitor 433. First and second metal terminals, such as first and second terminals 437-1 and 437-2, respectively, may be electrically connected (e.g. soldered) to respective metal traces, such as first and second metal traces 438a and 439a, respectively, on a side of the PCB, such as PCB 435a. Traces, such as traces 511a and 513a, may be widened to create large surface areas that can be electrically and thermally connected (e.g., soldered) to respective flat side wall surfaces of bus bars, such as V+ and V− bus bars 417T and 412T, respectively.

A row of ceramic capacitors can fit between opposing flat surfaces of V+ and V− bus bars. FIG. 5A-21 shows inverter 460iT of FIG. 5A-2S with a row of example ceramic DC link capacitors 4331. For ease of illustration, only one ceramic capacitor 4331-1 of the row is shown. FIG. 5A-21 also shows that a surface of the front dielectric wall in capacitor 403T-1 is thermally connected to side wall surfaces of bus bars 417T and 412T, it being understood that the front dielectric wall need not be thermally connected to the bus bars.

Each of the ceramic capacitors 4331 in FIG. 5A-21 may be longer than the ceramic capacitors 433d in FIG. 5A-20. Ceramic capacitors 4331 may be electrically connected between the V+ and V− bus bars. In an alternative two or more rows of ceramic capacitors 4331 may be electrically connected in parallel and positioned between opposite facing surfaces of the V+ and V− bus bars. Like the ceramic capacitors 433d shown in FIG. 5A-20, ceramic capacitors 4331 in FIG. 5A-21 may have first and second metal terminals, 437-1 and 437-2, respectively. Metal terminals 437-1 and 437-2 have opposite facing substantially flat end surfaces. Flat end surfaces of the first terminals connectors 437-1 may be electrically and thermally connected directly or indirectly to a flat surface of bus bar 417T, and flat end surfaces of the second terminals 437-2 may be electrically and thermally connected directly or indirectly to a flat surface of V-bus bar 412T. V+ bus bar 417T and V-bus bar 412T can extract heat (e.g., 1, 2, 5, 10, 20, 40, 80 Watts or more) from capacitors 4331 through flat end surfaces of their metal terminals 437-1 and/or 437-2, respectively. Lengths and/or widths of bus bars 417T and 412T may need to be extended by 5-15 mm to accommodate the ceramic capacitors 4331 positioned therebetween.

First and second metal terminals 437-1 and 437-2 of ceramic capacitors may be electrically and thermally attached (e.g., welded, soldered, etc.) directly to respective flat side wall surfaces of bus bars 417T and 412T. FIG. 5A-22 shows inverter 460iT of FIG. 5A-2S with a row of example ceramic DC link capacitors 433e. For ease of illustration, only one ceramic capacitor 433e-1 of the row is shown. Each of the ceramic capacitors 433e in FIG. 5A-22 may be longer than the ceramic DC link capacitors 433d in FIG. 5A-2. The ceramic DC link capacitors 433e in the row may be electrically connected between the V+ and V− bus bars. Like the capacitors 433d shown in FIG. 5A-20, capacitors 433e in FIG. 5A-22 may have first and second metal terminals, 437-1 and 437-2, respectively. Metal terminals 437-1 and 437-2 have flat side wall surfaces, which may be electrically and thermally connected (e.g., soldered, welded, etc.) directly to flat side wall surfaces of bus bar 417T and V-bus bar 412T, respectively. V+ bus bar 417T and V-bus bar 412T can extract heat (e.g., 1, 2, 5, 10, 20, 40, 80 Watts or more) from capacitors 433e through flat side wall surfaces of their metal terminals 437-1 and/or 437-2, respectively.

Power losses may occur when a transistor switches between its on and off state. Soft switching can reduce these losses. Soft switching can be implemented passively or actively using snubber capacitors. A snubber capacitor may take form in a ceramic capacitor, it being understood that snubber capacitors may take other forms such as electrolytic or film capacitors. Like the ceramic DC link capacitors described above, each ceramic snubber capacitor may have first and second metal terminals at opposite ends.

Some or all switches 304 of a power apparatus, such as inverter 460iT, may be electrically connected in parallel with respective snubber capacitors. Some or all switches 304 of a power apparatus, such as inverter 460iT, may be electrically connected in parallel with respective RC snubber circuits, each of which may include a snubber capacitor connected in series with a resistor. Some or all switches 304 of a power apparatus, such as inverter 460iT, may be electrically connected in parallel with respective CD snubber circuits, each of which may include a snubber capacitor connected in series with a diode. The anode of the diode in a CD snubber circuit may be electrically connected to the snubber capacitor terminal in some embodiments, and the cathode of the diode in a CD snubber circuit may be electrically connected to the snubber capacitor terminal in other embodiments. Some or all switches 304 of a power apparatus, such as inverter 460iT, may be electrically connected in parallel with respective RCD snubber circuits, each of which may include a snubber capacitor connected in series with a combination that includes a resistor and a diode connected in parallel. The cathode of the diode in an RCD snubber circuit may be electrically connected to the snubber capacitor terminal.

Snubber capacitors and snubber circuits (e.g., RC snubber circuits, CD snubber circuits, and RCD snubber circuits) may be located external to packaged switches 247 and electrically connected between their die substrate and die clip terminals. Snubber capacitors or snubber circuits can be mounted in whole or in part on PCBs. For example, snubber capacitors or snubber circuits may be mounted on a driver PCB 461, such as driver PCB 461iT shown in FIG. 5A-2, and electrically connected between respective pairs of connector-leads 288ds and 288dc. Snubber capacitors or snubber circuits may be electrically connected directly between respective pairs of bus bars, where each of the respective pairs of bus bars may include a phase bus bar and a DC bus bar such as a V+ bus bar 417T or V-bus bar 412T.

FIG. 5A-23 shows the inverter 460iT of FIG. 5A-22 with example high-side and low-side RC snubber circuits for leg-c. Although not shown, legs a and b may include similar high-side and low-side RC snubber circuits. Each of the RC snubber circuits includes an example ceramic snubber capacitor 433s electrically connected in series with a resistor R. Snubber capacitors 433s may be like ceramic DC link capacitors 433d of FIG. 5A-20 but shorter. Snubber capacitor 433s may have first and second metal terminals, 437-1 and 437-2, respectively. Opposite facing flat side wall surfaces of terminal 437-1H may be electrically and thermally connected (e.g., welded, soldered, etc.) directly to flat side wall surface of V+ bus bar 417T and flat side wall surface of first terminal 437-1 of ceramic capacitor 433e, respectively. Opposite facing flat side wall surfaces of terminal 437-2L may be electrically and thermally connected (e.g., welded, soldered, etc.) directly to flat side wall surface of V-bus bar 412T and flat side wall surface of first terminal 437-2 of ceramic capacitor 433e, respectively. First electrodes of resistors RHc and RLc may be electrically connected (e.g., welded, soldered, etc.) to terminals 437-2H and 437-1L, respectively. Second electrodes of resistors RHc and RLc may be electrically connected to each other and to a flat surface of phase bus bar 418Tc. Alternatively, snubber RC circuits may be connected in parallel with respective high-side switches 304dH of inverter 460iT or connected in parallel with respective low-side switches 304dL, but not both.

RC snubber circuits may be mounted on a driver PCB 461. High-side RC snubber circuits of FIG. 5A-23, each of which includes a capacitor 433sH connected in series with a resistor RH, can mounted on driver PCB 461iT and connected via a PCB trace. Each high-side RC snubber circuit on PCB 461itT can be electrically connected in parallel with a respective switch 304dH via PCB traces and a pair of connector-leads 288dc and 288ds of the switch 304dH. Low-side RC snubber circuits of FIG. 5A-23, each of which includes a capacitor 433sL connected in series with a resistor RH via a PCB trace, can mounted on driver PCB 461it. Each low-side RC snubber circuit can be electrically connected in parallel with a respective switch 304dL via PCB traces and a pair of connector-leads 288dc and 288ds of the switch 304dL. Diodes can be added to a driver PCB 461 (e.g., PCB 461iT) that contains the RC snubber circuits. The diodes can be electrically connected in parallel with respective resistors of the PCB mounted RC snubber circuits via PCB traces.

FIG. 5A-24 shows inverter 460iT of FIG. 5A-23 without resistors R. In this version, flat side wall surfaces of terminals 437-2H and 437-1L of capacitors 433seHc and 433seLc, respectively, may be electrically and thermally connected (e.g., soldered) directly to a flat side wall surface of phase bus bar 418Tc. Flat end surfaces of terminals 437-2H and 437-1L also may be electrically and thermally connected (e.g., soldered) directly together. Similarly, capacitors 433seH and 433seL in legs a and b may be electrically connected in series between V+ bus bar 417T and V− bus bar 412T, capacitors 433seH in legs a and b may be electrically connected between V+ bus bar 417T and respective phase bus bars 418Ta and 418Tb, and capacitors 433seL in legs a and b may be electrically connected between V− bus bar 412T and respective phase bus bars 418Ta and 418Tb. V+ bus bar 417T and V− bus bar 412T can extract heat (e.g., 1, 2, 5, 10, 20, 40, 80, 100 Watts or more) from capacitors 433seH and 433seL through flat side wall surfaces of metal terminals 437-1H and 437-2L, respectively. Phase bus bars 418T in FIG. 5A-24 can extract heat (e.g., 1, 2, 5, 10, 20, 40, 80 Watts or more) from capacitors 433seH and 433seL through flat side wall surfaces of metal terminals 437-2H and/or 437-1L, respectively. Alternatively, snubber capacitors 433se may be connected in parallel with respective high-side switches 304H of inverter 460iT in FIG. 5A-23 or connected in parallel with respective low-side switches 304L, but not both.

Ceramic snubber capacitors 433se may be mounted on a driver PCB 461. Each high-side snubber capacitor 433seH can mounted on driver PCB 461it and electrically connected in parallel with a respective switch 304dH via PCB traces and a pair of connector-leads 288dc and 288ds electrically connected to the switch 304dH. Each low-side snubber capacitor 433seL can mounted on driver PCB 461it and electrically connected in parallel with a respective switch 304dL via PCB traces and a pair of connector-leads 288dc and 288ds electrically connected to the switch 304dL. Diodes can be added to a driver PCB 461 (e.g., PCB 461iT) that contains the snubber capacitors 433se. The diodes can be electrically connected in series via PCB traces with respective capacitors 433se mounted on the PCB 461 such as PCB 461iT. In one embodiment the cathode of each diode is connected to only one terminal of a respective PCB 461 mounted snubber capacitor 433se. Alternatively, cathodes of some diodes mounted on PCB 461 are connected to respective terminals of PCB 461 mounted high-side snubber capacitors 433seH and a first terminal of another capacitor, also mounted on PCB 461, and anodes of some diodes mounted on PCB 461 are connected to respective terminals of PCB 461 mounted low-side snubber capacitors 433seL and a second terminal of the other capacitor.

DC link capacitors and snubber capacitors may be added to a driver PCB. For example, one or more DC link capacitors (e.g., ceramic DC link capacitors) may be added (e.g., surface mounted) to a driver PCB, such as driver PCB 461iT. The first metal terminal 437-1 of each of the one or more DC link capacitors may be electrically connected to a first trace on the driver PCB, and the second terminal 437-2 of each of the one or more DC link capacitors may be electrically connected to a second trace on the driver PCB. The first trace may be electrically connected to connector-leads 288ds (see, e.g., FIGS. 2D-1-2D-3) of respective high-side packaged switches 247, such as packaged switches 247dH in FIGS. 5A-1 and 5A-2S, which in turn are electrically connected to a V+ bus bar, such as V+ bus bar 417T, through respective die substrate terminals 230. The second trace may be electrically connected to connector-leads 288dc (see, e.g., FIGS. 2D-1-2D-3) of respective low-side packaged switches 247, such as packaged switches 247dL in FIGS. 5A-1 and 5A-2S, which in turn are electrically connected to a V− bus bar, such as V− bus bar 412T, through respective die clip terminals 344. In addition to the DC link capacitors, snubber capacitors (e.g., ceramic snubber capacitors) may be added to a driver PCB, such as driver PCB 461iT. First metal terminals 437-1H from a first group of three snubber capacitors added to a driver PCB, may be electrically connected to the first trace on the driver PCB, and second metal terminals 437-2L from a second group of three capacitors added to a driver PCB, may be electrically connected to the second trace on the driver PCB. Second metal terminals 437-2H from the first group of three snubber capacitors, may be electrically connected to respective phase bus bars, such as phase bus bars 418Ta-418Tc in FIGS. 5A-1 and 5A-2S, via respective connector-leads 288dc of respective high-side packaged switches, such as packaged switches 247dH in FIGS. 5A-2 and 5A-2, and respective third traces on the driver PCB. First metal terminals 437-1L from the second group of three snubber capacitors, may be electrically connected to respective phase bus bars, such as phase bus bars 418Ta-418Tc in FIGS. 5A-1 and 5A-2S, via respective connector-leads 288ds of respective low-side packaged switches, such as packaged switches 247dL in FIGS. 5A-1 and 5A-2S, and respective fourth traces on the driver PCB.

FIG. 5A-20 shows PCB 435a with mounted DC link capacitors 433d electrically connected between DC bus bars 417T and 412T. Snubber capacitors can be added to a PCB 435 like PCB 435a. FIGS. 5A-25B and 5A-25F show back and front views of PCB 435b, which is PCB 435a modified to include ceramic snubber capacitors 433s. FIG. 5A-26 is a side view of the inverter shown in FIG. 5A-20 with PCB 435a replaced by PCB 435b. In an alternative embodiment, each of the snubber capacitors 433sH shown in FIG. 5A-25 can be replaced by a pair of snubber capacitors electrically connected in series between trace 438a and a respective trace 444, and each of the snubber capacitors 433sL can be replaced by a pair of snubber capacitors electrically connected in series between trace 439a and a respective trace 444. Additionally, each of the snubber capacitors 433d in FIG. 5A-25F can be replaced with a pair of snubber capacitors electrically connected in series between traces 438a and 439a. A thin (e.g., 20, 10, 5, 4 mm or less) plate-like shield 432-1 may be positioned between bus bars 418T on one side and PCB 461iT on the other side as shown in FIG. 5A-26. Shield 432-1 may have oppositely facing, substantially flat surfaces as shown. Shield 432-1 may be formed (e.g., stamped, cut, etc.) from a sheet of metal or other electrically conductive material. Shield 432-1 can act as an electrostatic shield (or “Faraday shield”) and mitigate capacitive coupling or other adverse effects the phase bus bars 418T may have on components mounted on control PCB 462iT and/or driver PCB 461iT such as the MCU or voltage sensors V_Sense. Shield 432-1 may be part of a Faraday cage that surrounds driver PCB 461iT and/or control PCB 462iT. The height of shield 432-1 may be greater than the height of driver PCB 461iT as shown. Although not shown, the length of shield 432-1 may be longer than the length of driver PCB 461iT or the length of bus bars 412T and 417T. The height and width of shield 432-1 is shown in FIG. 5A-26. Metal bus bar-leads 465 (more fully described below) of inverter 460iT may extend through apertures (not shown) of shield 432-1 but should be electrically isolated from shield 432-1. A portion of bus bar-lead 465c extending through shield 432-1 is shown with hidden lines. Each bus bar-lead 465 may be isolated from shield 432-1 by dielectric material positioned in a gap between the bus bar-lead 465 and the aperture in shield 432-1 through which the bus bar-lead 465 extends. Shield 432-1 may be electrically connected to V− through a bus bar such as V− bus bar 412T. All connector-leads 288 may extend through apertures (not shown) of shield 432-1. All connector-leads 288 may be electrically isolated from shield 432-1. Or some connector-leads 288 may be electrically isolated from shield 432-1 while one or several of the other connector-leads 288 may be electrically connected to shield 432-1. For example, all connector-leads 288 of the high-side packaged switches 247dH may be electrically isolated from shield 432-1 while one or more of connector-leads 288dc of low-side packaged switches 247dL are electrically connected to shield 432-1, which electrically connects shield 432-1 to the V− bus bar 412T.

Each of the snubber capacitors 433s in FIGS. 5A-25F and 5A-26 includes first and second terminals 437-1 and 437-2, respectively. First terminals 437-1H of snubber capacitors 433sH-a-433sH-c, may be electrically connected (e.g., soldered) to trace 438a on PCB 435b, and second terminals 437-2L of snubber capacitors 433sL-a-433sL-c, may be electrically connected (e.g., soldered) to trace 439a. Terminals 437-1 and 437-2 of DC link capacitors 433d-1-433d-8 may be electrically connected (e.g., soldered) to PCB traces 438a and 439a, respectively. Second terminals 437-2H of snubber capacitors 433sH-a-433sH-c and respective first terminals 437-1L of snubber capacitors 433sL-a-433sL-c may be electrically connected (e.g., soldered) together and to respective traces 444, such as 444a-444c, on a PCB 435 such as PCB 435b. PCB trace 438a may be electrically connected to PCB trace 511a shown in FIG. 5A-25B through one or more metal vias, and PCB trace 439a may be electrically connected to PCB trace 513a through one or more metal vias. PCB traces 444, such as PCB traces 444a-444c, may be electrically connected to respective traces 515, such as PCB traces 515a-515c, respectively, through respective metal vias or groups of metal vias. Surfaces of PCB traces 511a and 513a may be electrically connected (e.g., soldered) to side wall surfaces of V+ bus bar 417T and V− bus bar 412T, respectively. Surfaces of PCB traces 515, such as PCB traces 515a-515c, may be electrically connected (e.g., soldered) to side wall surfaces of respective phase bus bars 418, such as 418Ta-418Tc.

FIGS. 5A-27B and 5A-27F shows example PCB 435c, which is PCB 435b modified to include RD circuits 446H and 446L, each of which includes a resistor connected in parallel with a diode. RD circuits 446H are electrically connected in series between snubber capacitors 433sH-a-433sH-c, respectively, and trace 438c, and RD circuits 446L are electrically connected in series between snubber capacitors 433sL-a-433sL-c, respectively, and traces 444a-444c, respectively, as shown. The resistors and diodes are shown symbolically in FIG. 5A-27. The resistors and diodes can be electrically connected to terminals 437 as shown. The PCB 435b shown in FIG. 5A-26 can be replaced with PCB 435c. In an alternative embodiment, the diodes in RD circuits 446 can be reversed so that the cathodes diodes in RD circuits 446H are electrically connected to trace 438c while the anodes are electrically connected to respective terminals 437-1H, and the cathodes of diodes in RD circuits 446L are electrically connected to respective traces 444 and the anodes are electrically connected to respective terminals 437-1L. In still another embodiment, a second resistor can be connected in series between the cathode of the diode in each RD circuit 446H and its corresponding terminal 437-1H in FIG. 5A-27F, and a second resistor can be connected in series between the cathode of the diode in each RD circuit 446L and its corresponding terminal 437-1L in FIG. 5A-27F.

Power converters may employ passive soft switching snubber (PSSS) circuits. FIG. 5A-28 illustrates an inverter 460se2l, which is inverter 460T with an example PSSS circuit. More particularly, FIG. 5A-28 along with FIGS. 5A-30 and 5A-31 illustrate relevant components of inverter 460se2l when seen from the front, left side, and right side, respectively. Several components (e.g., PCB 461iT, PCB 462iT, capacitors 403T, 433 and 403P, etc.) shown in FIGS. 5A-30 and 5A-31 are not shown or fully shown in FIG. 5A-28 but are described below. Several components (e.g., drivers 306, voltage sensors V_sense, PMICs, a film recovery capacitor 403P, etc.) shown in FIGS. 5A-30 and 5A-31 are not shown in FIG. 5A-28 but are described below. Drivers 306, voltage sensors V_sense, current sensors I_Sense, and PMICs are shown symbolically in this disclosure.

With reference to FIG. 5A-28 inverter 460se2l includes nine bus bars; V+ bus bar 417T, V− bus bar 412T, three phase bus bars 418T, bus bar 417s2lH, bus bar 412s2lL, and two bus bars 418s2l. Phase bus bars 418s2l are generally rectangular cuboid in shape and may have height, width, and length around 6 mm, 25 mm, and 20 mm, respectively. V+ bus bar 417s2l and V− bus bar 412s2l are generally rectangular cuboid in shape and may have height, width, and length around 8 mm, 25 mm, and 20 mm, respectively. FIG. 5A-28 shows the height and length of bus bars of inverter 460se2l.

Inverter 460se2l is shown with inverter and PSSS portions. The inverter portion is substantially like inverter 460iT shown in FIG. 5A-1. The PSSS portion employs packaged diodes 245M with or without connector-leads, it being understood that packaged diodes 245M with or without connector-leads can be replaced with packaged diodes 245N with or without connector-leads. Packaged diode 245MH is electrically and thermally connected between bus bars 417s2lH and 418s2lH. Packaged diode 245ML is electrically and thermally connected between bus bars 412s2lL and 418s2lL. Although not shown, a dielectric separator (e.g., a flat sheet of ceramic material and/or layer(s) of electrically insulating glue) can be positioned between and connect to bus bars 418s2lL and 418s2lH. This dielectric separator can electrically isolate bus bars 418s2lL and 418s2lH from each other. Bus bars bus bars 418s2lL and 418s2lH are electrically connected to respective terminals of a transformer 451, which is shown schematically in FIG. 5A-28. Transformer 451 may be a unitary turns ratio transformer formed around a core that lacks a gap. Transformer 451 may be electrically connected as shown to V+ and V− bus bars 417T and 412T, respectively.

FIG. 5A-28 illustrates the relative positioning of packaged switches 247d, packaged diodes 245M, V+ bus bar 417T, phase bus bars 418T, bus bar 417s2lH, bus bar 412s2lL, and bus bars 418s2l. Packaged diode 245MH may have a die substrate terminal 230 that is electrically and thermally connected (e.g., soldered, sintered, press-fitted, etc.) to a flat surface of bus bar 418s2lH, and a die clip terminal 344 that is electrically and thermally connected (e.g., soldered, sintered, press-fitted, etc.) to a flat surface of bus bar 417s2lH. Packaged diode 245ML may have a die substrate terminal 230 that is electrically and thermally connected (e.g., soldered, sintered, press-fitted, etc.) to a flat surface of bus bar 412s2lL, and a die clip terminal 344 that is electrically and thermally connected (e.g., soldered, sintered, press-fitted, etc.) to a flat surface of bus bar 418s2lL.

With reference to FIGS. 5A-28, 5A-30, and 5A-31, phase bus bars 418Ta-418Tc may be thermally connected to each other and to bus bar 418s2lH by commonly received dielectric tubes 420a. Phase Bus bars 418Ta-418Tc may also be thermally connected to bus bar 418s2lL by a different set of commonly received dielectric tubes 420a. Bus bars 417T and 417s2lH may be thermally connected to each other by commonly received dielectric tubes 420a. Bus bars 412T and 412s2lL may be thermally connected to each other by commonly received dielectric tubes 420a. Inverter 460sel2 is shown with bus bars that receive dielectric tubes 420a with or without tube joint. Tubes other than 420a can be received by the bus bars. For example, bus bars 417T and 417s2lH can be formed around tubes 420g using a process like that described with reference to FIGS. 5A-17-6-5A-17-10. Bus bars 412T and 412s2lL can be formed around tubes 420g using a process like that described with reference to FIGS. 5A-17-6-5A-17-10. Bus bars 418T and 418s31 can be formed around tubes 420g, but with four layers of metal 407p instead of three, using processes like that described with reference to FIGS. 5A-17-1-5A-17-5 and 5A-17-11-5A-17-15.

FIGS. 5A-29B and 5A-29F show back and front views of PCB 435d, which include snubber capacitors 433s. Each of the snubber capacitors 433s in FIGS. 5A-29F includes first and second metal terminals 437-1 and 437-2, respectively. First terminals 437-1H of snubber capacitors 433sH-a-433sH-c, may be electrically connected (e.g., soldered) to trace 448d, and second terminals 437-2L of snubber capacitors 433sL-a-433sL-c, may be electrically connected (e.g., soldered) to trace 449d. Second terminals 437-2H of snubber capacitors 433sH-a-433sH-c and first terminals 437-1L of snubber capacitors 433sL-a-433sL-c may be electrically connected (e.g., soldered) to respective traces 444a-444c. Anodes and cathodes of a first group of snubber diodes 425 are electrically connected between traces 438d and 448d, respectively. Anodes and cathodes of a second group of snubber diodes 425 are electrically connected between traces 449d and 439d, respectively. Snubber diodes 425 are shown symbolically. Snubber diodes 425 may transmit less than or more than 1 A of current. DC link capacitors 433d are electrically connected in parallel between traces 438d and 439d. PCB trace 438d may be electrically connected to PCB trace 511d shown in FIG. 5A-29B through one or more metal vias, and PCB trace 439d may be electrically connected to PCB trace 513d through one or more metal vias. PCB traces 444a-444c may be electrically connected PCB traces 515b-a-515b-c, respectively, through respective metal vias or groups of metal vias. Trace 448d may be electrically connected to PCB trace 517d through one or more metal vias. Trace 449d may be electrically connected to PCB trace 519d through one or more metal vias. With continuing reference to FIGS. 5A-29B and 5A-29F, FIGS. 5A-30 and 5A-31 show side views of inverter 460s2l with PCB 435d. Surfaces of PCB traces 515a-515c may be electrically connected (e.g., soldered) to side wall surfaces of respective phase bus bars 418Ta-418Tc. Surfaces of PCB traces 511d and 513d may be electrically connected (e.g., soldered) to side wall surfaces of V+ bus bar 417T and V− bus bar 412T, respectively. Surfaces of portions 426 and 428 in PCB traces 517d and 519d, respectively, may be electrically connected (e.g., soldered) to side wall surfaces of bus bar 417s2lH and bus bar 412s2lL, respectively.

With continuing reference to FIG. 5A-31, the PSSS portion of inverter 460sel2 includes a film capacitor 403P electrically connected between traces 517d and 519d via bus bars 417s2LH and 412s2il, respectively. Capacitor 403P may take form in a film capacitor with first and second metal capacitor-leads 405P-1 and 405P-2 extending from a flat wall surface of the capacitor dielectric package. The first and second metal capacitor-leads 405P may be electrically and thermally connected to first and second electrical conductors, respectively, inside film capacitor 403P's dielectric package or case. Flat surfaces of first and second metal capacitor-leads 405P-1 and 405P-2 may be electrically and thermally connected (e.g., soldered, welded, etc.) to respective flat surfaces of respective bus bars 417s2lH and 412s2iL. Capacitor-leads 405P may have the same length and height as capacitor-leads 405. FIG. 5A-31 also shows lead 465s2lH electrically connected between bus bar 418s2lH and a first terminal of transformer 451, and lead 465s2lL electrically connected between bus bar 418s2lL and a second terminal of transformer 451.

FIG. 5A-32 shows an inverter 460si2l when seen from the front. Inverter 460si2l is inverter 460T with an example PSSS circuit mounted on a PCB 435e. As seen in FIG. 5A-32, a portion of PCB 435e extends from the side of the inverter portion. FIGS. 5A-33F and 5A-33B show front and back views of PCB 435e. FIGS. 5A-34-5A-36 illustrate relevant components of inverter 460si2l when seen from the back, side, and top, respectively. Several components (e.g., transformer 451, PCB 461iT, PCB 462iT, capacitors 403T and 433, etc.) shown in FIGS. 5A-34 and 5A-35 are not shown or fully shown in FIG. 5A-32 but are described below. Several components (e.g., drivers 306, voltage sensors V_Sense, PMICs, etc.) shown in FIGS. 5A-34 and 5A-35 are not shown in FIG. 5A-32 but are described below.

With continuing reference to FIGS. 5A-32 and 5A-34-5A-36, FIG. 5A-33F shows snubber capacitors 433s, recovery capacitors 433r, transformer 451, snubber diodes 425, and recovery diodes 427, which are electrically connected (e.g., soldered) to traces on PCB 435e. Recovery capacitors 433r may take form in ceramic capacitors, it being understood that other types of recovery capacitors, including film or electrolytic capacitors, can be used in the alternative. Each of the recovery capacitors 433r includes first and second metal-terminals 437-1 and 437-2, respectively, which may be electrically and thermally connected to first and second electrical conductors, respectively, inside the capacitor's dielectric case or package.

First terminals 437-1H of snubber capacitors 433sH-a-433sH-c, may be electrically connected (e.g., soldered) to PCB trace 448e, and second terminals 437-2L of snubber capacitors 433sL-a-433sL-c, may be electrically connected (e.g., soldered) to PCB trace 449e. Second terminals 437-2H of snubber capacitors 433sH-a-433sH-c and first terminals 437-1L of snubber capacitors 433sL-a-433sL-c may be electrically connected (e.g., soldered) to respective PCB traces 444a-444c as shown. Anodes and cathodes of a first group of snubber diodes 425 are electrically connected to PCB traces 438e and 448e, respectively. Anodes and cathodes of a second group of snubber diodes 425 are electrically connected to traces 449e and 439e, respectively. The anode and cathode of recovery diode 427H are electrically connected respectively to PCB traces 448e and 415-1, respectively. The anode and cathode of recovery diode 427L are electrically connected to PCB traces 415-2 and 449e, respectively. First and second transformer-leads 414-1 and 414-2, respectively, of transformer 451 are electrically connected to traces 415-1 and 415-2, respectively. Third and fourth transformer-leads 414-3 and 414-4, respectively, of transformer 451 are electrically connected to traces 438e and 439e, respectively. Transformer 451, including transformer-leads 415, are shown symbolically in FIG. 5A-33.

PCB trace 438e may be electrically connected to PCB trace 511a shown in FIG. 5A-33B through one or more metal vias, and PCB trace 439e may be electrically connected to PCB trace 513a through one or more metal vias. PCB traces 444a-444c may be electrically connected to PCB traces 515a-515c, respectively through respective metal vias or groups of metal vias.

With continuing reference to FIGS. 5A-33B and 5A-35, surfaces of PCB traces 515a-515c may be electrically connected (e.g., soldered) to side wall surfaces of respective phase bus bars 418Ta-418Tc. Surfaces of PCB traces 511a and 513a may be electrically connected (e.g., soldered) to side wall surfaces of V+ bus bar 417T and V− bus bar 412T, respectively.

Example transformer 451 shows a closed (i.e., ungapped) toroidal magnetic core 410 made of, for example, ferrite, around which wires 411-1 and 411-2 are wound. Alternative unitary turns ratio transformers are contemplated. One or both wires 411-1 an 411-2 could be wound in directions different than that shown. Ends of wire or winding 411-1 may be electrically connected between transformer-leads 414-1 and 414-3, and ends of wire or winding 411-2 may be electrically connected between transformer-leads 414-2 and 414-4. Transformer-leads 414 may take form in cylindrical metal pins with flat end surfaces that may be connected (e.g., soldered) to surfaces of PCB traces. In FIG. 5A-35, flat end surfaces of transformer-leads 414-3 and 414-4 are connected to PCB traces 438e and 439e, respectively. Although not shown in FIG. 5A-35 for ease of illustration, flat end surfaces of transformer-leads 414-1 and 414-2 are connected to PCB traces 415-1 and 415-2, respectively (see Figures and 5A-33F and 5A-34).

FIG. 5A-36 shows inverter 460sil2 when seen from the top. FIG. 5A-36 also shows a side view of example transformer 451 shown in FIG. 5A-35. Two of the four transformer-leads 414 are shown in FIG. 5A-36. A flat end surface of lead 414-3 is electrically connected (e.g., soldered) to trace 438. Although lead 414-1 appears to be connected to trace 438 in the figure, lead 414-1 is connected electrically to trace 415-1 (not shown in FIG. 5A-36, but shown in FIG. 5A-34). Although first metal terminal 437-1 of recovery capacitor 433r-3 appears to be connected to trace 438 in the figure, terminal 437-1 is connected electrically to trace 448e (not shown in FIG. 5A-36 but shown in FIG. 5A-34). Both transformer 451 and recovery capacitor 433r-3 are mounted on the portion of PCB 435e that extends beyond the inverter portion. There is sufficient space between transformer 451 and capacitor 403T-1 that ceramic recovery capacitor 433r-3 can be replaced with a physically larger film or electrolytic capacitor. PCB 435e is shown mechanically connected (e.g., glued) to a flat surface of manifold 466iT-2, which is more fully described below with reference to FIG. 5A-37. The mechanical connection can provide structural support to the portion of PCB 435e that extends beyond the inverter portion. Manifolds 466 may be formed from a dielectric material. In other embodiments, PCB 435e is not mechanically connected to manifold 466iT-2.

Returning to FIG. 5A-1, electrical current symbols are shown representing electrical current flow through inverter system 460iT at an instant in time. More particularly, FIG. 5A-1 shows electrical current flow through activated high-side switch 304dH of leg-a, while low-side switches 304dL of legs b and c are activated and conducting current to the V− terminal through the V− bus bar 412T. All other switches may be deactivated in the figure. Each electrical current symbol in inverters of this document is drawn with substantially the same length. The electrical current symbols in inverters of this document may be drawn with varying widths. Wider electrical current symbols represent electrical currents with larger magnitudes.

Die substrate terminals 230 and die clip terminals 344 may be pressed-fitted, soldered (e.g., mesh soldered as described above), sintered, welded, or connected by other means directly to corresponding flat surfaces of bus bars to establish thermal and electrical connectivity. Each of the die substrate terminals 230 of packaged switches 247dH of FIG. 5A-1, may be pressed-fitted, soldered, sintered, welded, or connected by other means directly to a flat surface or respective flat surfaces of V+ bus bar 417T. The die clip terminals 344 of packaged switches 247dH of FIG. 5A-1, may be pressed-fitted, soldered, sintered, welded, or connected by other means directly to flat surfaces of respective bus bars 418T. The die substrate terminals 230 of packaged switches 247dL of FIG. 5A-1, may be pressed-fitted, soldered, sintered, welded, or connected by other means directly to flat surfaces of respective bus bars 418T. Each of the die clip terminals 344 of packaged switches 247dL of FIG. 5A-1, may be pressed-fitted, soldered, sintered, welded, or connected by other means directly to a flat surface or respective flat surfaces of V− bus bar 412T.

A driver PCB, such as driver PCB 461iT, may include voltage sensors that can sense voltages across respective packaged switches 247 or packaged diodes 245 via respective sets of connector-leads 288dc and 288ds. A voltage sensor can sense a voltage across current terminals of a switch 304 or diode D in a packaged switch 247 or packaged diode 245, respectively, via connector-leads 288dc and 288ds.

Bus bar-leads may be electrically connected (e.g., welded) to bus bars. FIG. 5A-2S shows an example phase bus bar-lead 465c. A driver PCB, such as driver PCB 461iT, may include apertures through which respective bus bar-leads 465, including phase bus bar-lead 465c, may extend. FIG. 5A-2T shows all three phase bus bar-leads 465 of inverter 460iT along with all connector leads of packaged switches 247dH.

A bus bar-lead 465 may formed of metal such as copper. A bus bar lead 465 may have a rectangular cuboid shape. A bus bar-lead 465 may have a uniform rectangular cross-section from end to end. A bus bar-lead 465 may extend linearly between first and second ends. A bus bar lead 465 may extend linearly between first and second opposite facing flat end surfaces. The first flat end surface may be electrically connected (e.g., welded, soldered, etc.) to a flat surface of a bus bar. Alternatively, a bus bar-lead 465 may be integrally formed with a bus bar or bus bar portion (more fully described below) and extend linearly from a flat surface thereof at a right angle thereto. For example, a bus bar portion with bus bar-lead may cast, extruded, machined from metal to create unitary structure.

A driver PCB, such as driver PCB 461iT, may include current sensors I_Sense connected to traces on the driver PCB and configured to measure electrical current flow through respective phase bus bar-leads. Each of the current sensors I_Sense may take form in a current transformer (CT) sensor, which may have an aperture through which a respective phase bus bar-lead may extend. If the current sensors have apertures for receiving bus bar-leads, they may align with respective apertures in the driver PCB through which respective phase bus bar-leads extend. Current sensors without apertures can be positioned on the driver PCB near (e.g., within 5 mm, 3 mm, 1 mm, or less) respective phase bus bar-leads.

Driver PCB 461iT in FIG. 5A-2S may include drivers 306 that can control switches 304 of respective packaged switches 247d in leg-c through respective connector-leads 288g, which are symbolically shown. Drivers 306 may be positioned on PCB 461iT near (e.g., within 8 mm, 3 mm, 1 mm, or less) respective connector-leads 288g to reduce stray inductance, capacitance, and resistance therebetween. For example, trace connections between terminals of drivers 306 and respective connector-leads 288g may be 5 mm or less. PMICs can supply and/or regulate DC voltages needed by respective drivers 306 for generating control signals to control transistor control terminals (e.g., gates). PMICs and corresponding drivers 306 may be placed as close as possible on the same side or opposite sides of a driver PCB. PMICs and drivers 306 may be on opposite sides of driver PCB 461iT as shown. Driver PCB 461iT in FIG. 5A-2S may include voltage sensors V_Sense that can sense voltages between respective pairs of connector-leads 288ds and 288dc (not shown). Example phase bus bar-lead 465c may extend laterally between first and second ends. The first end of phase bus bar-lead 465c may be electrically connected to phase bus bar 418Tc, and the second end may be electrically connected to winding Wc. Phase bus bar-lead 465c may extend through an aperture in PCB 460i. Current sensor I_Sense measures electrical current flowing through phase bus bar-lead 465c. A current sensor I_Sense can send a signal representing the measured electrical current to the MCU via connector 484 for processing in accordance with MCU executable instructions stored in memory. I_Sense may include an aperture through which phase bus bar-lead 465c may extend. FIG. 5A-2S shows drivers 306, voltage sensors V_Sense, PMICs, current sensor I_Sense, and a phase bus bar-lead 465 for leg-c. Similar groups of drivers 306, voltage sensors V_Sense, PMICs, current sensor I_Sense, and phase bus bar-lead 465 may be mounted on or extending through PCB 461iT for legs a and b.

Drivers, voltage sensors, current sensors, etc., mounted on a driver PCB may be in data communication with a data processing control unit, which may be mounted on a control PCB and connected to traces thereon. For purposes of explanation only, control PCBs of this disclosure include an MCU for controlling a converter, it being understood control PCBs may use other types of data processing control units such as ECUs. MCUs of control PCBs may vary from converter to converter. Instructions executed by an MCU of a control PCB may vary from converter to converter.

The MCU may be positioned on a control PCB at point furthest away from phase bus bar-leads to reduce adverse effects of electromagnetic interference (EMI). Data may be communicated between driver and control PCBs through a connection that may include pin and socket connectors, which may be also known as “headers,” mounted on driver and control PCBs, respectively. The data connection may include a flexible data bus such as a flexible circuit or flexible PCB. The ends of a flexible circuit or flexible PCB may be electrically connected to pin and socket headers.

FIGS. 5A-2S and 5A-2T show an MCU mounted on control PCB 462i. The MCU may be in data communication with each driver 306, V_Sense, and I_Sense mounted on driver PCB 461iT through a data connection 484, which may include pin and socket connectors (not shown) that may be electrically connected to traces on driver PCB 461iT and control PCB 462iT, respectively. Pins of the pin connector may be directly received by respective sockets of the socket connector. Driver PCBs and control PCBs may be parallel to each other. Driver PCB 461iT and control PCB 462i may be parallel to each other as shown in FIGS. 5A-2S and 5A-2T. Alternatively, control PCB 462i may be positioned above and parallel to the flat surface of V+ bus bar 417T. Other configurations may be considered. Ethernet transceivers, CAN transceivers, and other devices may be mounted on a control PCB 462, such as control PCB 462i, and in data communication with the MCU thereof.

Tubes, such as tubes 420a in FIG. 5A-1, or channels of a converter may be fluidly connected between first and second manifolds. Manifolds can be used to split a fluid flow into multiple smaller streams or combine multiple fluid streams into one. A manifold may have an fluid input port or a fluid output port. For purposes of explanation, a first manifold of a converter has a fluid input port, and a second manifold of converter has a fluid output port. A fluid can enter the input port of the first manifold, travel through one or more tubes or channels connected between the first and second manifolds and exit the output port of the second manifold. The input port may be in fluid communication with a device that moves fluid by mechanical action. For example, the input port may be fluidly connected to an output of a pump through a hose. The output port may be in fluid communication with a heat exchange system. For example, the output port may be fluidly connected to a radiator through a hose.

A manifold may have an inner chamber. The input port may be in fluid communication with the first manifold's inner chamber, and the output port may be in fluid communication with second manifold's inner chamber. Tubes 420 or channels extend between first and second ends. The first ends of tubes 420 or channels in a converter may be in fluid communication with an inner chamber of the first manifold, while the second ends of the tubes 420 or channels may be in fluid communication an inner chamber of the second manifold. The first manifold may have one or more apertures through which respective first ends of tubes 420 or channels extend. The second manifold may have one or more apertures through which respective second ends of tubes 420 or channels extend. A seal can be added between a manifold aperture and a tube 420 or channel. A seal may be a device that joins items (e.g., a tube and an aperture) together to prevent fluid leakage. The first and second manifolds may be substantially similar in size, shape, composition, etc. Manifolds may be formed (e.g., molded) from a dielectric material.

FIG. 5A-37 shows inverter 460iT of FIG. 5A-1 with example first and second manifolds 466iT-1 and 466iT-2, respectively, in fluid communication with first and second ends, respectively, of tubes 420a. As shown, first ends of tubes 420a extend through respective apertures of manifold 466iT-1, and second ends of tubes 420a may extend through respective apertures of manifold 466iT-2. Manifolds 466iT are shown in cross section to facilitate a better understanding of how fluid flows through them. Manifolds may include fluid ports 467 through which fluid can flow into or out of the manifolds. For example, input, and output ports 467iT-1 and 467iT-2, respectively, of manifolds 466iT-1 and 466iT-2, respectively, may be positioned at ends of manifolds 466iT-1 and 466iT-2, respectively, and closer to the V− bus bar 412T than the V+ bus bar 417T as shown. Alternative positions of the input and output ports 467iT-1 and 467iT-2 for manifolds 466iT-1 and 466iT-2, respectively, are contemplated.

Electrical arching and dendrites degrade operation of converters or other power apparatuses. Electrical arcing occurs when an electrical current travels through a generally nonconductive medium, like air, between electrical conductors. Dendrites can slowly grow to bridge air gaps between electrical conductors and create a short circuit therebetween. High humidity can accelerate dendritic growth.

The clearance (i.e., air gaps or empty spaces) between electrical conductors, such as adjacent bus bars, adjacent connector-leads, adjacent bus bars and connector leads, etc., could be sufficient to prevent arcing and dendrite short circuits. For example, connector-leads 288 of a packaged switch 247 could be spaced far enough from each other to avoid electrical arching therebetween. The clearance between connector-leads 288 of a packaged switch 247 may depend on the voltage across the connector-leads 288; higher voltage may require greater clearance between connector-leads 288 to prevent arching. Dielectric material such as epoxy, silicon, urethane, parylene, etc., can be added to the air gaps and/or empty spaces between electrical conductors to essentially suppress dendrite growth and arcing therebetween. A dielectric filler such as alumina, silicon nitride, AlN, BeO, SiC, etc., may be added to the dielectric material (e.g., epoxy) to increase its thermal conductivity while maintaining its electrical isolation property. The dielectric material with or without filler can be injected into the air gaps and/or empty spaces primarily as a liquid, and then cured to form a solid. Once cured the dielectric material may contact and cover some, most or all exposed surfaces of some, most or all bus bars, connector-leads and other electrical conductors of a power apparatus.

Converters and other power apparatuses of this disclosure may be assembled with naked packaged switches 247 (i.e., packaged switches that lack cases 248). Naked packaged switches may include connector-leads 288g with ends connected (e.g., soldered) directly to gate straps 364. Substrate terminals 230 and/or die clip terminals 344 of naked packaged switches 247 may be electrically connected (e.g., sintered, soldered, etc.) to bus bars during converter assembly as described herein. Then dielectric material (e.g., epoxy) in substantially liquid form, with or without filler (e.g., alumina, silicon nitride, AlN, BeO, SiC, etc.,), can be added to fill the air gaps and/or empty spaces in and around the naked packaged switches 247 in addition to filling the air gaps and/or empty spaces between adjacent bus bars, adjacent connector-leads, between adjacent bus bars and connector leads, etc. The liquid dielectric material can be cured to form a solid, which may contact and cover some or all exposed surfaces of die substrates die clips 372, pedestals, etc. of naked packaged switches 247.

With reference to FIGS. 2D-1-2D-3, 5A-20 and 5A-37, packaged switches 247d and inverter 460iT show example air gaps or empty spaces between electrical conductors. Dielectric material with or without filler (e.g., alumina, silicon nitride, AlN, BeO, SiC, etc.,) can partially or fully fill some or all air gaps or empty spaces between: bus bars 417T and 418T; adjacent bus bars 418T; bus bars 412T and 418T; bus bars 417T and 412T; adjacent connector-leads 288, and; connector-leads 288, bus bars 417T, 418T and/or 412T. Air gaps between ends of bus bar 417T, outer ends of outer phase bus bars 418Tc and 418Ta, and ends of bus 412T, on one side and manifolds 466iT-1 or 466iT-2 on the other side that contain portions of tubes 420a, may also be partially or fully filled with dielectric material. Alternatively, no air gap or space may exist between ends of bus bar 417T, outer ends of outer phase bus bars 418Tc and 418Ta, and ends of bus 412T, on one side and manifolds 466iT-1 or 466iT-2 on the other side. Dielectric material may be injected to encapsulate manifolds 466iT, except for their ports 467iT so that fluid may pass through the ports without obstruction.

Once cured the dielectric material may contact and cover some, most, or all surfaces of some or all the bus bars 417T, 418T and/or 412T, connector-leads 288, manifolds 466iT, etc. Not only can the dielectric material inhibit electrical arcing and dendrite growth, but the dielectric material can: add an additional seal between tubes 420 and manifolds 466 to prevent fluid from leaking from the connection of tubes 420 to manifolds 466; increase thermal conductance between packaged switches 247 and fluid flowing through bus bar channels or tubes 420, and; mechanically reinforce tubes 420 to prevent damage (e.g., cracking) from mechanical shock or vibration. Dielectric material can mechanically reinforce portions of tubes 420a between phase bus bars 418T. Dielectric material can partially or fully fill air gaps or empty spaces between conductors at the front and back of inverter 460iT. With continuing reference to FIGS. 2D-1-2D-3, and 5A-20, dielectric material may be added that partially or fully fills air gaps or empty space between driver board 461iT and bus bars 417T, 418T, and 412T. This dielectric material may encase some or all of bus bar-connectors 465 between bus bars 418T and driver board 461iT, and some or all of connector-leads 288 extending between packaged switches 247d and driver board 461iT. Exposed ends of connector-leads 288 or bus bar connectors 465 that extend through driver board 461iT can be partially or fully covered with dielectric material.

Components on one or both sides of driver board 461iT, including traces electrically connected to connector-leads 288, can be conformally coated with dielectric material. Conformal coating can be applied to surfaces of a PCB such as driver board 461iT to protect the components from environmental stresses such as humidity. This coating essentially “conforms” to the contours of the PCB, providing a continuous protective layer over some or all exposed surface areas, including those of traces, and solder joints. Dielectric material may be applied on one or both sides of PCB 435a. Dielectric material may be added that partially or fully fills the space between PCB 435a and bus bars 417T, 418T, and 412T. Components, including capacitors and traces electrically connected to bus bars 412T or 418T, on one or both sides of PCB 435a may be conformally coated with dielectric material to suppress arcing and dendrite growth. Dielectric material may be formed that partially or fully fills the space between film capacitors 403T and bus bars 417T, 418T, and 412T, which may also contain the space between PCB 435a and bus bars 417T, 418T, and 412T.

FIGS. 5A-38 and 5A-39 are front and side views of inverter 460iT shown in FIG. 5A-37 with a dielectric material added and cured to form case 401, which as noted can prevent dendrite growth and/or electric arcing between adjacent electrical conductors. FIGS. 5A-38 and 5A-39 show several components with hidden lines, such as phase bus bars 418, packaged switches 247d, connector-leads 288g, etc., that are fully or partially encased in the dielectric material of case 401 and/or behind manifold 466iT-1. FIGS. 5A-38 and 5A-39 show manifolds 466iT engaging case 401. Manifolds 466iT are not enveloped within case 401. In an alternative embodiment manifolds 466iT may be enveloped in case 401, except for port 467iT, which may provide an added benefit of a better fluid seal between the manifolds 466iT and tubes 420a. FIG. 5A-39 also shows manifold 466iT-1 separated from driver PCB 461T. However, manifolds 466 may be configured to engage a driver PCB 461T to provide added mechanical support thereto. For example, flat surfaces of manifolds 466 may be clamped to a flat surface of driver PCB 461 using a fastener such as glue or bolts.

Manifolds, including manifolds 466iT, may include an inner chamber defined by walls as more fully described below. Apertures may extend through at least one of the chamber walls. Tubes, such as tubes 420a of inverter 460iT, can extend through the manifold apertures to enable fluid communication with the manifold chamber. This fluid communication enables fluid exchange between the tubes and the manifold chamber.

FIGS. 5A-40-5A-46 illustrate relevant aspects of an example process for building manifolds 466iT of inverter 460iT. FIGS. 5A-41 shows the inverter 460iT of FIG. 5A-1 rotated 90 degrees and without packaged switches 247d and capacitor-leads 405T. While the process of FIGS. 5A-40-5A-46 is described with reference to building manifolds 466iT, steps of the process can be used to build other manifolds such as manifolds 512 and 736 described below.

FIGS. 5A-40-5A-45 show first manifold components or “tubs” 536. FIG. 5A-40 shows tub 536-2 when seen from above. Tubs 536 can be formed (e.g., molded, including injection molded, 3-D printed, machined, etc.) from a metal such as aluminum or a non-metal such as a thermoplastic material (e.g., nylon, glass filled nylon, polyetherimide, polyether ketone, etc.). For purposes of explanation only, manifolds are presumed to be formed from a thermoplastic material, it being understood that manifolds should not be limited thereto. Seals 545 are also shown. Seals 545 may be adhered (e.g., glued) to flat surfaces of tubs 536. Alternatively, seals 545 may be co-molded with tubs 536, or seals 545 may be formed using a two-shot injection process, which is an advanced injection molding process in which different plastic materials, one for tub 536 and one for seal 545, can be molded into a single finished part with one machine cycle. Seals 545 may extend across most if not substantially all flat surface of the tubs to which the seals 545 are connected. FIGS. 5A-40-5A-45 show gaps between seals 545 and ends of bus bars 417T, 417T, 418Tc and 418Ta. Alternatively flat surfaces of seals 545 may contact flat end surfaces of bus bars 417T, 412T, 418Tc, and 418Ta.

Each of tubs 536 includes thick (e.g., 0.5, 1.0, 5, 10, 20, 30 mm or more) walls including base wall 531. Each wall extends between oppositely facing flat surfaces. Side walls extend from base wall 531. With continuing reference to FIGS. 5A-40 and 5A-41, example apertures 538 may be formed in base wall 531 of each tub 536. Tubes, such as tubes 420a, may extend through respective apertures tub apertures, such as apertures 538 as shown. FIG. 5A-40 shows cylindrical shaped apertures 538 with a diameter that may be substantially equal to or larger than the diameter of respective cylindrical shaped tubes 420a extend therethrough. Apertures 538 may have different shapes to accommodate tubes of different shapes. For example, oval shaped apertures may have a major axis and a minor axis that may be substantially equal to or larger than the major axis and minor axis, respectively, of an oval shaped tube extending through the aperture. Square or rectangular shaped apertures may have a width and length that may be substantially equal to or larger than the width and length, respectively, of square or rectangular shaped tube extending through the aperture. Seals 545 may also include apertures through which tubes such as tubes 420a extend. Seal and tub apertures may be aligned. Apertures of seals 545 may have shapes and dimensions that conform to shapes and dimensions of tubes extending therethrough. For example, a circular shaped aperture of seal 545 may have a diameter that is substantially equal to or smaller than the diameter of a cylindrical tube, such as tubes 420a, extending through the aperture. An oval shaped aperture of seal 545 may have a major axis and a minor axis that may be substantially equal to or smaller than the major axis and minor axis, respectively, of an oval shaped tube extending through the aperture. A square or rectangular shaped aperture of seal 545 may have a width and length and a minor axis that may be substantially equal to or smaller than the width and length, respectively, of a square or rectangular shaped tube extending through the aperture. Seal 545 and tub 536 may or may not be formed of the same material. Seal 545 may be a membrane that can flexibly engage and slide over outer surfaces of tubes, such as tubes 420a, as tub 536 and attached seal 545 are pushed over the ends of the tubes. FIG. 5A-41 shows tubs 536 and attached seals 545 after they are pushed over the ends of tubes 420a.

FIGS. 5A-42 and 5A-43 show the structures of FIGS. 5A-40 and 5A-41, respectively, with example plug 539-2 received in the lower space inside tub 536-2 as shown. Plugs 539 are configured to create fluid tight seals to prevent fluid from leaking out of manifolds 466iT. In one embodiment, plug 539-2 may be formed by adding a liquid material (e.g., a liquid adhesive such as Methyl Methacrylate, Silyl Modified Polymer, Silyl Terminated Polymer, Acrylated Urethane, 2K Epoxy/Amine Resin, etc.) into tub 536-2 until it reaches a fill line 540-2. The liquid material may have a viscosity between 2,000, 10,000, 50,000, 100,000, 200,000 mPa·s or more. The liquid material may completely fill the cylindrical gap between each tube 420a and the cylindrical wall of a respective aperture 538. The liquid material can be cured into a substantially solid mass using heat, ultraviolet light, etc. Seal 545 may create a seal around the tubes so that liquid material does not leak while it is being cured. Plug 539-2 may create a fluid tight seal fully around the outer cylindrical surface of tubes 420a. Cylindrical shaped portions of plug 539-2 may extend into respective cylindrical gaps between tubes 420a and the walls of respective apertures 538 as shown, to create fluid tight seals between the tubes 420a and the walls of respective apertures 538. Plug 539-2 may also create a fluid tight seal with the side walls of tub 536-2, and a fluid tight seal with the base wall 531-2. An additional fluid tight seal (e.g., example seals 545) may be added around each of the tubes 420a to further prevent fluid from leaking between tubes 420a and wall 531 and between apertures 538 and wall 531. Plug 539-2 and portions of tubes 420a are drawn in FIG. 5A-43 with hidden lines to indicate they are inside tub 536-2.

FIGS. 5A-44 and 5A-45 show the structures of FIGS. 5A-42 and 5A-43, respectively, after a second manifold component or “cap” 537-2 is connected to tub 536-2. Like tubs 536, caps 537 may be formed (e.g., molded, including injection molded, 3-D printed, machined, etc.) from a thermoplastic material (e.g., nylon, glass filled nylon, polyetherimide, polyether ketone, etc.). Caps 537 may have planar, flat surfaced rims are that are shaped and sized to engage planar, flat surfaced rims of tubs 536. Alternatively, caps 537 may have rim surfaces that are not entirely flat and planar, which are configured to connect surface-to-surface with rims of tubs 536 that are correspondingly shaped. For example, an outer flat portion of a rim on a cap 537 may extend at an angle from a flat inner portion, which can connect surface-to-surface with corresponding flat outer portion of a rim of tub 536 that extends at an angle from on inner flat portion of the tub's rim. A cap 537 can be connected (e.g., fused by the application of heat provided by a laser welder or other device, ultrasonically welded, glued using a solvent of adhesive, etc.) to tub 536 at their respective planar, flat surfaced rims to create a fluid tight seal therebetween. FIG. 5A-46 shows the inverter 460iT of FIG. 5A-45 after caps 537 are connected to respective tubs 536 to create manifolds 466iT. Plugs 539 and portions of tubes 420a are drawn in FIG. 5A-46 with hidden lines to indicate they are inside manifolds 466iT.

A bus bar or heat sink of this disclosure may contain one or more channels through which fluid may flow. A heat sink should not be electrically connected to another device. Bus bar or heat sink channels may be rectangular, circular, oval, square, etc., in cross section. A fluid such as air, dielectric liquid, or non-dielectric liquid may flow through channels of bus bars or heat sinks that lack tubes. Packaged switches 247 can be used in power converters with bus bars that lack channels or tubes. FIGS. 5A-47 and 5A-48 illustrate relevant components of an example inverter 460ijc when seen from the front and side, respectively, with bus bars that lack channels or tubes 420. Several components (e.g., driver PCB 461iT, control PCB 462iT, and capacitors 403jc) shown in FIG. 5A-48 are not shown in FIG. 5A-47 but are described below.

Inverter 460ijc employs packaged switches 247d, it being understood that in an alternative version packaged switches 247d may be swapped with packaged switches 247p or packaged switches 247q. When a packaged switch 247 is “swapped” or “replaced” with another packaged switch 247 in a converter or other power apparatus, the other or replacement packaged switch 247 will be connected in the same way as the original packaged switch 247. For example, if the die substrate terminal 230 and die clip terminal 344 of an original packaged switch 247 is electrically and thermally connected to a flat surface of a first bus bar and a flat surface of a second bus bar, respectively, then when swapped, the die substrate terminal 230 and die clip terminal 344 of the replacement packaged switch 247 will also be electrically and thermally connected to the flat surface of the first bus bar and the flat surface of the second bus bar, respectively. The same holds for swapping a packaged switch 247 with a packaged diode 245, or vice versa.

All packaged switches 247 of inverter 460ijc may be the same type. Packaged switches 247d of inverter 460ijc may be packaged switch 247dA, 247dB, 247dC, or 247dD of FIGS. 3A, 3B, 3C, and 3D, respectively.

Inverter 460ijc may include V+ bus bar 455, V− bus bar 459, and phase bus bars 457. As seen in FIGS. 5A-47 and 5A-48 the bus bars may be solid metal and lack channels. V+ bus bar 455 and V− bus bar 459 have the same shapes (e.g., generally rectangular cuboid) and sizes. As seen in FIG. 5A-48, phase bus bars 457, including bus bar 457c, may be C-shaped.

Inverter 460ijc may include metal heat sinks 528-530, which may be electrically isolated from each other. Each may include a row of channels 40 through which fluid may flow. Heat sink 528 is thermally connected to but electrically isolated from V+ bus bar 455 by thin (e.g., 20, 10, 5 mm or less in height as measured between the bus bar and heat sink) insulator 526-1 of dielectric material (e.g., diamond-based dielectric, aluminum nitride, beryllium oxide, etc.). Heat sink 529 is thermally connected to but electrically isolated from phase bus bars 457 by thin insulators 526-2 and 526-3 of dielectric material. Heat sink 530 is thermally connected to but electrically isolated from V− bus bar 459 by thin insulator 526-4 of dielectric material. Insulators 526 may be formed of any of the materials listed in the table above. Other dielectric materials may be also contemplated.

Insulators 526 can be metalized to create metalized insulators or insulators with metalized flat surfaces. For example, a thin (e.g., 4.0, 2.0, 1.0, 0.5, 0.1, 0.05, 0.01, 0.005, 0.001 mm or less, not shown) layer of metal may be formed on most or substantially all flat, outer opposite facing surfaces of insulators 526-1 and 526-4 to be connected to surfaces of metal bus bars 455 or 459 and heat sinks 528 or 530, and a thin layer of metal may be formed on most or substantially all of the flat surfaces of insulators 526-2 and 526-3 to be connected to surfaces of heat sink 529. A thin layer of metal may be formed on separate sections of flat, outer opposite surfaces of insulators 526-2 and 526-3 to be connected to respective phase bus bars 457. All thin layers of metal should be electrically isolated from each other. A thin layer of metal may be formed, for example, by painting the outer flat surfaces of the insulators 526 with conductive ink containing silver or other sintering conducive material and then curing the ink. Insulators 526-1 and 526-4 can be metalized by bonding a sheet of copper or other metal to each side of the insulators 526 using a high-temperature oxidation process like that used to create DBC or AMB substrates. Other methods of forming the metal layer are contemplated. Surfaces of the metal layer could be smoothed (e.g., sanded). A layer of sintering enhancement material (e.g., silver) may be formed (e.g., electroplated) on surfaces of the bus bars and heat sinks to be connected to metalized surfaces of insulators 526. A layer of sintering enhancement material may also be formed (e.g., electroplated) on the flat metalized surfaces of metalized insulators 526. Then flat surfaces (e.g., electroplated surfaces) of the bus bars and heat sinks can be sintered to the flat surfaces of metalized insulators 526 using a sintering material such as sinter paste or sinter preform. Or flat surfaces of the bus bars and heat sinks can be connected to the flat surfaces of metalized insulators 526 using solder and wire mesh, like the method described above.

Inverter 460ijc has three legs designated a-c. Each leg a-c in FIG. 5A-47 may include two packaged switches 247dh and 247dL that may be electrically and thermally connected to a phase bus bar 457, which in combination is sandwiched between V+ bus bar 455 and V− bus bar 459. Packaged switches 247dH and 247dL may be also electrically and thermally connected to V+ bus bar 455 and V− bus bar 459, respectively.

FIG. 5A-47 illustrates the relative positioning of packaged switches 247d, V+ bus bar 455, phase bus bars 457, V− bus bar 459, and insulators 526-1-526-4 with respect to each other. Packaged switches 247dH in FIG. 5A-47 may have die substrate terminals 230 that may be electrically and thermally connected (e.g., soldered, sintered, press-fitted, etc.) to a flat surface or respective flat surfaces of V+ bus bar 455, and die clip terminals 344 that may be electrically and thermally connected (e.g., soldered, sintered, press-fitted, etc.) to flat surfaces of respective phase bus bars 457a-457c, which in turn have terminals that may be electrically connected to windings Wa-Wc, respectively. Packaged switches 247dL in FIG. 5A-47 may have die substrate terminals 230 that may be electrically and thermally connected (e.g., soldered, sintered, press-fitted, etc.) to flat surfaces of respective phase bus bars 457a-457c, and die clip terminals 344 that may be electrically and thermally connected (e.g., soldered, sintered, press-fitted, etc.) to a flat surface or respective flat surfaces of V− bus bar 459.

Example V+ bus bar 455 and V− bus bar 459 may have a height, width, and length around 4 mm, 25 mm, and 70 mm, respectively. Heat sinks 528-530 may have a height, width, and length around 8 mm, 25 mm, and 70 mm, respectively. FIG. 5A-47 shows the height and length of the bus bars and heat sink.

Inverter 460ijc may include driver PCB 461ijc and control PCB 462ijc Driver PCB 461ijc in FIG. 5A-48 may include drivers 306 that can send transistor control signals to respective packaged switches 247d of leg-c through respective connector-leads 288g. Current sensor I_Sense measures electrical current flowing through phase bus bar-lead 465c. FIG. 5A-48 shows an MCU mounted on control PCB 462ijc. The MCU may be in data communication with each driver 306, V_Sense, and I_Sense mounted on driver PCB 461ijc through data connection 484.

All heat sinks 528-530 may be substantially equal in length. All heat sinks 528-530 have first and second ends. The first ends of heat sinks 528-530 may be in fluid communication with the first manifold, while the second ends of heat sinks 528-530 may be in fluid communication with the second manifold.

Liquid dielectric material such as epoxy, silicon, etc., can be added to air gaps or empty spaces between electrical conductors of inverter 460ijc, including electrical conductors of naked packaged switches 247 if employed, and then cured to create structures that suppress dendrite growth and electrical arcing therebetween.

Packaged switches 247 may be employed in rectifiers. FIGS. 5B-1 and 5B-2 illustrate relevant components of an example rectifier 460rT when seen from the front and side, respectively. Rectifier 460rT could be connected to inductive elements like inductors La-Lc of an LCL filter 162 of FIG. 1C, which in turn may be coupled to a three-phase AC power source 164 also shown in FIG. 1C. For ease of illustration only, LCL filter 162 is not shown in the figures for rectifiers of this disclosure. The AC sources φa-φc are shown directly connected to phase bus bars of rectifiers, including phase bars 418Ta-418Tc, respectively, of FIG. 5B-1.

Rectifier 460rT and inverter 460iT may be substantially similar, but differences exist. The MCU mounted on the control PCB 462rT in rectifier system 460rT may be different than the MCU mounted on the control PCB 462iT in inverter system 460i, or the instructions executed by MCU mounted on the control PCB 462rT in rectifier system 460rT may be different than instructions executed by the MCU mounted on the control PCB 462iT in inverter system 462i. In general, the instructions executable by the MCU mounted on the control PCB 462 may vary from power apparatus (e.g., converter) to power apparatus of this disclosure. Control PCB 462rT may also include a phase-lock loop (PLL) and other components for synchronizing the control of switches 304 to the frequency (e.g., 60 Hertz) of the three-phase AC input voltages provided by the AC sources φa-φc.

Liquid dielectric material such as epoxy, silicon, etc., can be added to air gaps or empty spaces between electrical conductors of rectifier 460rT, including adjacent electrical conductors of naked packaged switches 247 if employed, and then cured to create structures that suppress dendrite growth and electrical arcing therebetween.

Rectifier 460rT is an example of an “active” rectifier since it employs packaged switches 247. Passive rectifiers may be also contemplated. Passive rectifiers do not employ transistor based switches. Rather, passive rectifiers employ diodes. The compact rectifier 460rT shown in FIGS. 5B-1 and 5B-2 may be converted into a passive rectifier by replacing packaged switches 247d with packaged diodes 245M or 245N shown in FIGS. 3M and 3N, respectively.

FIG. 5H shows an example passive three-phase rectifier 460pr using packaged diodes 245M. Rectifier 460pr can be built in part by replacing the packaged switches 247d of FIG. 5B-1 with packaged diodes 245M. The packaged diodes 245M may be connector-lead less. V+ bus bar 417T, V− bus bar 412T, and phase bus bars 418T of FIG. 5B-1 are renamed 417pr, 412pr, 418pr, respectively, in FIG. 5H. Passive rectifier 460pr may lack a control PCB and/or a driver PCB.

Die substrate terminals 230 of packaged diodes 245MH may be electrically and thermally attached (e.g., soldered, sintered, press-fitted, etc.) directly to a flat surface or respective flat surfaces of V+ bus bar 417pr. Die clip terminals 344 of packaged diodes 245MH may be electrically and thermally attached (e.g., soldered, sintered, press-fit, etc.) to a flat surface of a respective phase bus bar 418pr.

Die substrate terminals 230 of packaged diodes 245ML may be electrically and thermally connected (e.g., soldered, sintered, press-fit, etc.) directly to a flat surface of a respective phase bus bar 418pr. Die clip terminals 344 of packaged diodes 245ML may be electrically and thermally connected (e.g., soldered, sintered, press-fit, etc.) directly to a flat surface or respective flat surfaces of V− bus bar 404pr.

FIG. 5C illustrates relevant components of an example three-phase inverter 460id when seen from the front. Several components (e.g., driver PCB, control PCB, manifolds, and DC link capacitors) are not shown or fully shown in FIG. 5C.

Inverter 460id has three legs designated a-c. Each of the legs may include four packaged switches 247, and a phase bus bar 418d, which in combination may be sandwiched between V+ bus bar 417d and V− bus bar 412d as shown. The figure illustrates the relative positioning of packaged switches 247, V+ bus bar 417d, phase bus bars 418d, and V− bus bar 412d with respect to each other. Phase bus bars 418da-418dc may be electrically connected to windings Wa-Wc, respectively.

In FIG. 5C, each leg of inverter 460id has a mix of packaged switch versions. Each leg may include a pair of packaged switches 247d, and a pair of packaged switches 247q. Each of the packaged switches 247d may be packaged switch 247dA, 247dB, 247dC, 247dD or 247dO of FIGS. 3A, 3B, 3C, 3D, and 3O, respectively, and each of the packaged switches 247q may be packaged switch 247qE, 247qF, 247qG, 247q1, 247qJ, 247ql, or 247qP of FIGS. 3E, 3F, 3F, 3G, 3I, 3J, 3L, and 3P, respectively. For example, each of packaged switches 247d pf FIG. 5C may be packaged switch 247dO shown in FIG. 3O or packaged switch 247dB shown in FIG. 3B, and each of packaged switches 247q may be packaged switch 247qP shown in FIG. 3P or packaged switch 247qF shown in FIG. 3F. In another version, each packaged switch 247q in FIG. 5C may be swapped with packaged switch 247dB, while each packaged switch 247d is packaged switch 247dA or 247dO. All packaged switches 247 of inverter 460id may be a version of packaged switch 247d, 247p or 247q. For example, all packaged switches 247 shown in FIG. 5C can be swapped with packaged switches 247qP, all packaged switches 247 can be swapped with packaged switches 247qF, or all packaged switches 247 can be swapped with packaged switches 247dB. Packaged switches 247 in inverter 460id may take form in packaged switches that lack connector-lead 288ds and/or 288dc. Each of the switches 304 in inverter 460id can be independently controlled by an MCU or other data processing device. Each group of one or more transistors in each switch 247q or 247p, which is electrically connected to a respective connector-lead 288, can be independently controlled by the MCU or other data processing device.

Packaged switches 247dH and 247qH in each leg may have die substrate terminals 230 that may be electrically and thermally connected (e.g., soldered, sintered, press-fitted, etc.) directly or indirectly to a flat surface or respective flat surfaces of V+ bus bar 417d, and die clip terminals 344 that may be electrically and thermally connected (e.g., soldered, sintered, press-fitted, etc.) directly or indirectly to a flat surface or respective flat surfaces of a corresponding phase bus bar 418d, which in turn have terminals that may be electrically connected to windings Wa-Wc, respectively. Packaged switches 247dL and 247qL in each leg may have die substrate terminals 230 that may be electrically and thermally connected (e.g., soldered, sintered, press-fitted, etc.) directly or indirectly to a flat surface or respective flat surfaces of a corresponding phase bus bar 418d, and die clip terminals 344 that may be electrically and thermally connected (e.g., soldered, sintered, press-fitted, etc.) directly or indirectly to a flat surface or respective flat surfaces of V− bus bar 412d.

V+ bus bar 417d, V− bus bar 412d, and phase bus bars 418d in FIG. 5C may have a generally rectangular cuboid shape as shown. Example phase bus bars 418d may have a height, width, and length around 12 mm, 25 mm, and 45 mm, respectively. Example V+ bus bar 417d and V− bus bar 412d may have a height, width, and length around 8 mm, 25 mm, and 145 mm, respectively. FIG. 5C shows the height and length of the bus bars.

FIG. 5C shows inverter 460id with dielectric tubes 420a received by bus bars. All tubes 420a in FIG. 5C may be substantially equal in length. Each tube 420a has first and second ends, which may be in fluid communication with first and second fluid manifolds (not shown), respectively, like those shown in FIG. 5A-37. Phase bus bars 418da-418dc may be thermally connected to each other and electrically isolated from each other by commonly received dielectric tubes 420a.

Inverter 460id may include film DC link capacitors, like those shown in FIG. 5A-2, with capacitor-leads 405T. Inverter 460id may also include packaged multilayer ceramic capacitors with first and second metal terminals electrically and thermally connected directly or indirectly to bus bars 417d and 412d, respectively.

FIG. 5C includes electrical current symbols that represent electrical current flow through inverter system 460id at an instant in time. More particularly, FIG. 5C shows electrical current flow through activated switches 304 of packaged switches 247dH and 247qH in leg-a, while switches 304 of packaged switches 247dL and 247qL in legs b and c may be activated and conducting current to the V-terminal through the V− bus bar 412d. All other switches may be deactivated in the figure.

Inverter 460id may include a control PCB and a driver PCB like those shown FIG. 5A-2. The driver PCB may include drivers that may be electrically connected to and control respective switches 304 in packaged switches 247d through respective connector-leads 288g, and drivers that may be electrically connected to and control respective switches 304 in packaged switches 247q through respective sets of connector-leads 288g1 and 288g2. The driver PCB may include surface mounted snubber capacitors (e.g., multilayer ceramic capacitors, not shown) that are connected in parallel with respective switches 304 through respective sets of connector-leads 288ds and 288dc (not shown).

FIG. 5C shows inverter 460id with bus bars 412d, 417d, and 418d that receive dielectric tubes 420a with or without tube joint. Tubes other than 420a can be received by the bus bars. For example, each of bus bars 412d and 417d can be formed around tubes 420d or 420e using a process like that described with reference to FIGS. 15-17-1-15-17-5, and aligned bus bars 418d can be formed around tubes 420g using a process like that described with reference to FIGS. 5A-17-11-5A-17-15. Or the bus bars can be swapped with bus bars formed around tubes like tubes 420v1 using a process like that described with reference to FIGS. 9A-30-9A-33 or FIGS. 9A-34-9A-37.

Liquid dielectric material such as epoxy, silicon, etc., can be added to air gaps or empty spaces between electrical conductors, including adjacent electrical conductors of naked packaged switches 247 if employed in inverter 460id, to suppress dendrite growth and electrical arcing therebetween, and subsequently cured.

FIGS. 5D-1, 5D-2 and 5D-3 illustrate relevant components of an example three-phase inverter 460iq when seen from the front, back, and side, respectively. Several components (e.g., driver PCB 461iq1, driver PCB 461iq2, and film capacitors 403q) are not shown or fully shown in all figures but are described below.

FIGS. 5D-1 and 5D-2 show front and back views of example inverter 460iq. FIGS. 5D-1 and 5D-2 show 405q of film capacitors 403q. Inverter 460iq has three legs designated a-c, each of which may include eight packaged switches 247.

Inverter 460iq is shown with a mix of packaged switches 247d and 247q. As seen in FIG. 5D-1, each leg may include packaged switches 247d1-247d4 and packaged switches 247q1-247q4. Alternatively, each switch 247q of inverter 460iq as shown may be swapped with a version of packaged switch 247p or 247d, each packaged switch 247d of inverter 460iq as shown may be swapped with a version of packaged switch 247q or packaged switch 247p, or each packaged switch 247q and 247d of inverter 460iq as shown may be swapped with a version of packaged switch 247p. Each of the switches 304 in inverter 460iq, regardless of whether the switches 304 may be in packaged switches 247d, 247p, or 247q, can be independently controlled by an MCU on control PCB 462iq. Each group of one or more transistors in each switch 247q or 247p, which is electrically connected to a respective connector-lead 288, can be independently controlled by the MCU or other data processing device. Packaged switches 247d2, 247d4, and 247q1-247q4 in each leg may take form in packaged switches that lack connector-lead 288dc and/or 288ds.

All packaged switches 247d1-247d4 may be the same type, and all packaged switches 247q1-247q4 may be the same type. Packaged switches 247d of inverter 460iq may be packaged switch 247dA, 247dB, 247dC, 247dD or 247dO of FIGS. 3A, 3B, 3C, 3D, and 3O, respectively, and packaged switches 247q may be packaged switch 247qE, 247qF, 247qG, 247qI, 247qJ, 247ql, or 347qP of FIGS. 3E, 3F, 3G, 3I, 3J, 3L, and 3P, respectively. For example, each of packaged switches 247d1-247d4 may be packaged switch 247dO shown in FIG. 3O or packaged switch 247dB shown in FIG. 3B, and each of packaged switches 247q1-247q4 may be packaged switch 247qP shown in FIG. 3P or packaged switch 247qF shown in FIG. 3F.

Inverter 460iq may include V+ bus bar 417q, V− bus bar 412q, and phase bus bars 418q. Bus bars, like V+ bus bar 417q, V− bus bar 412q, and phase bus bars 418q, may also act as heat sinks to cool switches 304 or diodes D.

Each leg a-c may include packaged switches 247d1-247d4 and packaged switches 247q1-247q4 that may be electrically and thermally connected to a phase bus bar 418q, which in combination is sandwiched between V+ bus bar 417q and V− bus bar 412q. Packaged switches 247d1, 247d2, 247q1, and 247q2 may be electrically and thermally connected to V+ bus bar 417q, and packaged switches 247d3, 247d4, 247q3, and 247q4 may be electrically and thermally connected to V− bus bar 412q.

FIGS. 5D-1 and 5D-2 illustrate the relative positioning of packaged switches 247, V+ bus bar 417q, phase bus bars 418q, and V− bus bar 412q with respect to each other. Packaged switches 247d1 and 247d2 in each leg may have die substrate terminals 230 that may be electrically and thermally connected (e.g., soldered, sintered, press-fitted, etc.) directly or indirectly to a flat surface or respective flat surfaces of V+ bus bar 417q, and die clip terminals 344 that may be electrically and thermally connected (e.g., soldered, sintered, press-fitted, etc.) directly or indirectly to a flat surface or respective flat surfaces of a corresponding phase bus bar 418q, which in turn have terminals that may be electrically connected to windings Wa-Wc, respectively. Packaged switches 247q1 and 247q2 in each leg may have die substrate terminals 230 that may be electrically and thermally connected (e.g., soldered, sintered, press-fitted, etc.) directly or indirectly to the flat surface or respective flat surfaces of V+ bus bar 417q, and die clip terminals 344 that may be electrically and thermally connected (e.g., soldered, sintered, press-fitted, etc.) directly or indirectly to a flat surface or respective flat surfaces of a corresponding phase bus bar 418q. Packaged switches 247d3 and 247d4 in each leg may have die substrate terminals 230 that may be electrically and thermally connected (e.g., soldered, sintered, press-fitted, etc.) directly or indirectly to a flat surface or respective flat surfaces of a corresponding phase bus bar 418q, and die clip terminals 344 that may be electrically and thermally connected (e.g., soldered, sintered, press-fitted, etc.) directly or indirectly to a flat surface or respective flat surfaces of V− bus bar 412q. Packaged switches 247q3 and 247q4 in each leg may have die substrate terminals 230 that may be electrically and thermally connected (e.g., soldered, sintered, press-fitted, etc.) directly or indirectly to a flat surface or respective flat surfaces of a corresponding phase bus bar 418q, and die clip terminals 344 that may be electrically and thermally connected (e.g., soldered, sintered, press-fitted, etc.) directly or indirectly to the flat surface or respective flat surfaces of V− bus bar 412q.

Bus bars, like V+ bus bar 417q, V− bus bar 412q, and phase bus bars 418q in FIGS. 5D-1-5D-3, may have a generally rectangular cuboid shape. Example phase bus bars 418q may have a height, width, and length around 8 mm, 60 mm, and 45 mm, respectively. Example V+ bus bar 417q and V− bus bar 412q may have a height, width, and length around 8 mm, 60 mm, and 145 mm, respectively. Bus bars may have different dimensions to accommodate differences in converter design. FIG. 5D-1 shows the height and length of the bus bars.

FIGS. 5D-1-5D-3 show inverter 460iq with dielectric tubes 420a received by bus bars. Tubes other than 420a can be received by the bus bars. For example, each of bus bars 412q and 417q can be formed by soldering metal bus bar portions around tubes 420d or 420e using a process like that described with reference to FIGS. 15-17-1-15-17-5, and aligned bus bars 418q can be formed by soldering metal bus bar portions around tubes 420g using a process like that described with reference to FIGS. 5A-17-6-5A-17-10. Or the bus bars can be swapped with bus bars formed around tubes like tubes 420v1 using a process like that described with reference to FIGS. 9A-30-9A-33 or FIGS. 9A-34-9A-37.

Inverter 460iq may include film capacitors 403q. First and second metal capacitor-leads 405qa and 405qb may extend from one of the capacitor's dielectric wall. Example capacitor-leads 405q have a height hbc, length lbc, and width wbc around 6 mm, 40 mm, and 30 mm, respectively. Capacitor-leads, including capacitor-leads 405q, may have substantially flat, rectangular-shaped opposite facing top and bottom surfaces. A substantial portion (e.g., 10, 20, 50, 75, 90% or more) of each capacitor-lead 405qa's flat bottom surface area may be electrically and thermally connected (e.g., welded, soldered, press-fitted by screws or other fasteners, etc.) directly to a flat surface of V+ bus bar 417q, and a substantial portion (e.g., 10, 20, 50, 75, 90% or more) of each capacitor-lead 405qb's flat top surface area may be electrically and thermally connected (e.g., welded, soldered, press-fitted by screws or other fasteners, etc.) directly to a flat surface of V− bus bar 412q.

FIG. 5D-4 is top view of inverter 460iq, but with capacitors 403q rotated to 90 degrees. Although not shown in FIG. 5D-4, a substantial portion of each capacitor-lead 405qa's flat bottom surface area may be electrically and thermally connected (e.g., welded) directly to a flat surface of V+ bus bar 417q, and a substantial portion of each capacitor-lead 405gb's flat top surface area may be electrically and thermally connected directly to a flat surface of V− bus bar 412q. FIG. 5D-4 shows tubes 420a and fluid flow through them, which are drawn with hidden lines. FIG. 5D-4 shows manifolds 466iq, most of which are drawn with hidden lines. Although not fully shown, manifold 466iq-1 is positioned between capacitor-lead 405qa-1 and capacitor-lead 405qb-1, while manifold 466iq-2 is positioned between capacitor-lead 405qa-2 and capacitor-lead 405qb-2. Opposite facing flat surfaces of manifolds 466iq-1 may or may not contact 405qa-1's flat bottom surface and 405qb-1's flat top surface, respectively. Opposite facing flat surfaces of manifolds 466iq-2 may or may not contact 405qa-2's flat bottom surface and 405qb-2's flat top surface. Capacitor-leads 405qa and 405qb may need to be longer when rotated and electrically connected to the bus bars, to provide space adjacent the bus bars for manifolds 466iq that are fluidly connected to ends of tubes 420a. In an alternative embodiment, a second set of capacitors 403q can be added to the version of inverter 460iq shown in FIG. 5D-4. The second set of capacitors 403q can be rotated 90 degrees relative to capacitors 403q of FIG. 5D-4, and oriented in the same as the capacitors 403q illustrated in FIGS. 5D-1-5D-3. Although the second set of capacitors 403q are not shown, substantial portions of the second set of capacitor-lead 405qa's flat bottom surface area may be electrically and thermally connected (e.g., welded) directly to respective flat top surface area of the capacitor-leads 405qa shown in FIG. 5D-4, and substantial portions of the added, second set of capacitor-lead 405qb's flat bottom surface area may be electrically and thermally connected (e.g., welded) directly to respective bottom top surface area of the capacitor-leads 405qb. The length of capacitor-leads 405qa and 405qb may need to be further increased beyond the length needed to provide space for manifolds 466, to provide sufficient surface area to be connected to respective capacitor-leads 405qa and 405qb of the second set of capacitors 403q. For example, the length of capacitor-leads 405qa shown in FIG. 5D-4 may be increased so that they are separated by 30, 20, 10, 5 mm or less, and the length of capacitor-leads 405qb (not shown) of capacitors 403q shown in FIG. 5D-4, may be increased so that they too are separated by 30, 20, 10, 5 mm or less.

Inverter 460iq may include one or more ceramic DC link capacitors (e.g., multilayer ceramic capacitors) with first and second metal terminals that may be electrically and thermally connected directly or indirectly to flat surfaces V+ bus bar 417q and V− bus bar 412q, respectively.

FIG. 5D-1 includes electrical current symbols that represent electrical current flow through inverter system 460iq at an instant in time. More particularly, FIG. 5D-1 shows electrical current flow through activated switches 304 in packaged switches 247d1 and 247d2 of leg-a, while switches 304 in packages 247d3 and 247d4 of legs b and c may be activated and conducting current to the V-terminal through the V− bus bar 412q. All other switches, including switches 304 in packaged switches 247q, may be deactivated, it being understood that a combination of packaged switches 247d and 247 may operate to convert power.

Inverter 460iq may include driver PCBs 461iq1 and 461iq2 with drivers 306 that may control respective switches 304 through respective connector-leads 288g (e.g., 288gcl) or respective sets of connector-leads 288g1 and 288g2. Only connector-leads 288gc, 288g1, and 288g2 of leg-c are represented in FIG. 5D-3. Driver PCBs 461iq1 and/or 461iq2 may include surface mounted snubber capacitors (e.g., multilayer ceramic capacitors, not shown) that are connected in parallel with respective switches 304 through respective sets of connector-leads 288ds and 288dc. Inverter 460iq may include a control PCB 462iq with an MCU that may be in data communication with drivers 306, current sensor I_Sense, voltage sensors, and other components mounted on driver PCBs 461iq1 and 461iq2. Data connections 484-1 and 484-2 may facilitate data communication.

Driver PCB 461iq1 in FIG. 5D-3 may include drivers 306 that can send transistor control signals to respective packaged switches 247q of leg-c through respective sets of connector-leads 288g1 and 288g2. Driver PCB 461iq1 also may include drivers that may control respective packaged switches 247q in legs a and b. Driver PCB 461iq2 in FIG. 5D-3 may include drivers 306 that can send transistor control signals to respective switches 304 of leg-c through respective connector-leads 288gc. Driver PCB 462iq2 also may include drivers that can control respective switches 304 in legs a and b.

Driver PCB 461iq2 may include voltage sensors V_Sense that can sense voltages between respective pairs or connector-leads 288ds and 288dc (not shown). Example phase bus bar-lead 465c may extend laterally between first and second ends. The first end of phase bus bar-lead 465c may be electrically connected to phase bus bar 418qc, and the second end may be electrically connected to winding Wc. Phase bus bar-lead 465c may extend through an aperture in PCB 461iq2. Current sensor I_Sense measures electrical current flowing through phase bus bar-lead 465c. I_Sense may include an aperture through which phase bus bar-lead 465c may extend. FIG. 5D-3 shows voltage sensors V_Sense, PMICs, current sensor I_Sense, and a phase bus bar-lead 465 for leg-c. Similar groups voltage sensors V_Sense, PMICs, current sensor I_Sense, and phase bus bar-lead 465 may be mounted on or extending through PCB 461iq2 for legs a and b.

All tubes 420a received in all bus bars, such as bus bar 412q, may be substantially equal in length. Each tube 420a has first and second ends. The first ends of all tubes 420a may be in fluid communication with the first manifold, while the second ends of all the tubes 420a may be in fluid communication with the second manifold.

Liquid dielectric material such as epoxy, silicon, etc., can be added to air gaps or empty spaces between electrical conductors of inverter 460iq, including adjacent electrical conductors of naked packaged switches 247 if employed, and then cured to create structures that suppress dendrite growth and electrical arcing therebetween.

FIGS. 5E-1-5E-3 illustrate relevant components of an example rectifier 400vr1 when seen from the front and the sides. Rectifier 400vr1 can function as a three-phase “Vienna” rectifier. Rectifier system 400vr1 cannot operate bi-directionally. Driver PCB 421 is shown in FIGS. 5E-2 and 5E-3 but not in FIG. 5E-1. Although not shown, rectifier 400vr1 may have manifolds and a control PCB with an MCU.

Referencing FIG. 5E-1, rectifier 400vr1 has three legs designated a-c. Each leg may include a bidirectional packaged switch 247. Legs a-c include packaged switches 247qa-247qc, respectively. Each of packaged switches 247qa-247qc may be packaged switch 247qG, 247qI, 247qJ, or 247ql of FIGS. 3G, 3I, 3J, and 3L, respectively. In an alternative version, each packaged switch 247q may be replaced by a packaged switch 247pK shown in FIG. 3K. Each of the switches 304 of rectifier 400vr1 can be independently controlled by an MCU or other data processing device. Each group of one or more transistors in each switch 247q or 247p, which is electrically connected to a respective connector-lead 288, can be independently controlled by the MCU or other data processing device.

Rectifier 400vr1 may include generally rectangular cuboid-shaped V+ bus bar 431, V-bus bar 430, phase bus bars 520, and common bus bar 404vr, each of which may also act as heat sinks to cool switches 304 or diodes D.

Each of the phase bus bars 520 may have a height, width, and length around 10 mm, 55 mm, and 20 mm, respectively. Flat surfaces of cases of packaged switches 247qa-247qc may be thermally connected directly or indirectly to phase bus bars 520a-520c, respectively. Packaged switches 247qa-247qc may have die substrate terminals 230 that may be electrically and thermally connected directly or indirectly to surfaces of phase bus bars 520a-520c, respectively. Phase bus bars 520a-520c may be electrically connected to AC sources φa-φc, respectively. All figures show a common bus bar 404vr, which may have a height, width, and length around 10 mm, 25 mm, and 70 mm, respectively. Flat surfaces of cases of packaged switches 247q may be thermally connected directly or indirectly to surfaces of bus bar 404vr and/or respective phase bus bars 520.

FIGS. 5E-2 and 5E-3 may be left and right-side views of rectifier 400vr1 of FIG. 5E-1. As seen, V− bus bar 430 and V+ bus bar 431 have a generally rectangular cuboid shape. Bus bars 430 and 431 may have a height, width, and length around 10 mm, 25 mm, and 70 mm, respectively. Bus bars 430 and 431 may have dimensions that may be unequal to each other in another version. V− bus bar 430 and V+ bus bar 431 have terminals that may provide DC power to a device such as a DC/DC converter. Like bus bar 404vr and phase bus bars 520, bus bar 430 and bus bar 431 have channels that hold tubes 420a through which a fluid can flow. FIGS. 5E2 and 5E-3 show the height and width of the bus bars. FIG. 5E-1 shows the height and length of bus bars 520 and 404.

FIGS. 5E-2 and 5E-3 show the relative positioning of packaged switches 247q, phase bars 520, V− bus bar 430, V+ bus bar 431 and bus bar 404vr with respect to each other in legs a and c.

Each leg of rectifier 400vr1 may include a pair of packaged diodes 245-1 and 245-2, which include diodes D1 and D2, respectively. For purposes of explanation only, packaged dies 245-1 and 245-2 take form in packaged diode 245M shown of FIG. 3M. Die substrate terminals 230 of packaged diodes 245-2 and die clip terminals 344 of packaged diodes 245-1 in each leg may be electrically and thermally attached (e.g., soldered, sintered, press-fitted, etc.) directly to a flat surface or respective flat surfaces of V+ bus bar 431 and V− bus bar 430, respectively. Die substrate terminals 230 of packaged diodes 245-1 and die clip terminals 344 of packaged diodes 245-2 in each leg may be electrically and thermally attached (e.g., soldered, sintered, press-fit, etc.) directly to a flat surface or respective flat surfaces of a corresponding phase bus bar 520.

Die substrate terminals 230 of packaged switches 247qa-247qc may be electrically and thermally connected (e.g., soldered, sintered, press-fit, etc.) directly to flat surfaces of phase bus bars 520a-520c, respectively. Die clip terminals 344 of packaged switches 247qa-247qc may be electrically and thermally connected (e.g., soldered, sintered, press-fit, etc.) directly to a flat surface or respective flat surfaces of common bus bar 404vr. In an alternative version, packaged switches 247q (or packaged switches 247p) may be turned upside down so that their die substrate terminals 230 may be electrically and thermally connected (e.g., soldered, sintered, press-fit, etc.) directly to a surface or respective surfaces of bus bar 404vr.

Capacitors C− and C+, which may be polar capacitors as shown, may be electrically connected to bus bar 404vr. Capacitors C− and C+ may also be thermally connected to bus bar 404vr. Capacitors C− and C+ may be film capacitors like capacitors 403 described above. Flat surfaces of the positive and negative terminals or leads of capacitors C− and C+ may be sintered, soldered, press-fitted, welded, or connected by other means to a flat surface or respective flat surfaces of bus bar 404vr. Capacitors C− and C+ may be electrically connected bus bars 430 and 431, respectively. Capacitors C− and C+ may have substantially the same capacitance so that bus bar 404vr is maintained at a voltage (i.e., zero volage or neutral voltage) that is halfway between V+ and V−. Flat surfaces of the negative and positive terminals or leads of capacitors C− and C+, respectively, may be sintered, soldered, press-fitted, welded, or connected by other means to flat surfaces of V− bus 430 and V+ bus bar 431, respectively. Bus bars 430 and 431 are shown symbolically in FIG. 5E-1.

FIGS. 5E-1-5E-3 show rectifier 400vr1 with dielectric tubes 420a received by bus bars. Tubes other than 420a can be received by the bus bars. For example, each of bus bars 430, 431, and 404vr can be formed by soldering metal bus bar portions around tubes 420d or 420e using a process like that described with reference to FIGS. 15-17-1-15-17-5, and bus bars 420 can be formed by soldering metal bus bar portions around tubes 420g using a process like that described with reference to FIGS. 5A-17-6-5A-17-10. Or the bus bars can be swapped with bus bars formed around tubes like tubes 420v1 using a process like that described with reference to FIGS. 9A-30-9A-33 or FIGS. 9A-34-9A-37.

Rectifier 400vr1 may include driver PCB 421 with drivers 306 that can send transistor control signals to respective switches 304 through respective sets of connector-leads 288g1 and 288g2. Only connector-leads 288g1 and 288g2 of legs c and a are represented in FIG. 5E-2 and FIG. 5E-3, respectively. Driver PCB 421 may include surface mounted snubber capacitors (e.g., multilayer ceramic capacitors, not shown) that are connected in parallel with respective switches 304 through respective sets of connector-leads 288ds and 288dc. Rectifier 400vr1 may include a control PCB with an MCU in data communication with drivers 306, current sensors I_Sense, voltage sensors V_Sense, and other components mounted on driver PCB 421. A connector (e.g., a flexible PCB, not shown) may facilitate the data communication.

Driver PCB 421 may include voltage sensors V_Sense that can sense voltages across respective packaged switches 247q through their connector-leads 288ds and 288dc (not shown). Example phase bus bar-leads 465a and 465c extend laterally between first and second ends. The first ends of phase bus bar-leads 465a and 465c may be electrically connected to phase bus bars 520a and 520c, respectively, and the second ends may be electrically connected to AC sources φa and φc, respectively. Phase bus bar-leads 465a and 465c extend through respective apertures in PCB 421. Current sensors I_Sense-a and I_Sense-c measure electrical current flowing through phase bus bar-connectors 465a and 465c, respectively. I_Sense-a and I_Sense-c may include respective apertures through which phase bus bar-connectors 465a and 465c, respectively, extend. FIGS. 5E-2 and 5E-3 show voltage sensors V_Sense, PMICs, drivers 306, current sensors I_Sense, and phase bus bar-leads 465 for legs a and c, respectively. A voltage sensor V_Sense, PMICs, drivers 306, current sensor I_Sense, and phase bus bar-lead 465 may be mounted on or extending through PCB 421 for leg-b.

Control PCB of rectifier 400vr1 may include a phase-lock loop (PLL) and other components for synchronizing the control of switches 304 to the frequency (e.g., 60 Hertz) of the three-phase AC input voltages provided by the AC sources φa-φc. Additional components may be added for power factor correction.

All tubes 420, such as tubes 420a in FIG. 5E-1, received in all bus bars may be substantially equal in length. Each tube 420a has first and second ends. The first ends of all tubes 420a may be in fluid communication with a first manifold, while the second ends of all the tubes 420a may be in fluid communication with the second manifold.

Liquid dielectric material such as epoxy, silicon, etc., can be added to air gaps or empty spaces between electrical conductors of rectifier 400vr1, including adjacent electrical conductors of naked packaged switches 247 if employed, and then cured to create structures that suppress dendrite growth and electrical arcing therebetween.

FIGS. 5F-1-5F-3 illustrate relevant components of an example rectifier 400vr2 when seen from the front and the sides. Rectifier 400vr2 can function as a three-phase Vienna rectifier. Rectifier system 400vr2 cannot operate bi-directionally. Driver PCB 521 is shown in FIGS. 5F-2 and 5F-3 but not in FIG. 5F-1. Although not shown, rectifier 400vr2 may have manifolds and a control PCB with an MCU.

Referencing FIG. 5F-1, rectifier 400vr2 has three legs designated a-c. Each leg may include a pair of packaged switches 247dH and 247dL. Each of packaged switches 247d may be packaged switch 247dA, 247dB, or 247dD of FIGS. 3A, 3B, and 3D, respectively. Each of the switches 304 of rectifier 400vr2 can be independently controlled by an MCU or other data processing device. Each group of one or more transistors in each switch 247q or 247p, which is electrically connected to a respective connector-lead 288, can be independently controlled by the MCU or other data processing device.

Rectifier 400vr2 may include generally rectangular cuboid shaped V+ bus bar 431, V− bus bar 430, phase bus bars 520, and common bus bar 404vr, each of which may also act as heat sinks to cool switches 304 or diodes D. In addition, rectifier 400vr2 may include metal heat sinks 522.

Each of the phase bus bars 520 may have a height, width, and length around 10 mm, 55 mm, and 20 mm, respectively. Each of the metal heat sinks 520 may be generally rectangular cuboid in shape and may have a height, width, and length around 10 mm, 25 mm, and 20 mm, respectively. Cases of packaged switches 247dHa-247dHc may be thermally connected to phase bus bars 520a-520c, respectively. Packaged switches 247dHa-247dHc may have die substrate terminals 230 that may be electrically and thermally connected to surfaces of phase bus bars 520a-520c, respectively. Phase bus bars 520a-520c may be electrically connected to AC sources φa-φc, respectively. Packaged switches 247dHa-247dHc may have die clip terminals 344 that may be electrically and thermally connected to surfaces of metal heat sinks 522a-522c, respectively.

All figures show a common bus bar 404vr, which may have a height, width, and length around 10 mm, 25 mm, and 70 mm, respectively. Flat surfaces of cases of packaged switches 247dLa-247dLc may be thermally connected directly or indirectly to flat surfaces of bus bar 404vr and respective heat sinks 522qa-522c. Packaged switches 247dLa-247dLc may have die substrate terminals 230 that may be electrically and thermally connected to a surface or respective surfaces of common bus bar 404vr. Packaged switches 247dLa-247dLc may have die clip terminals 344 that may be electrically and thermally connected to surfaces of heat sinks 522qa-522c, respectively.

FIGS. 5F-2 and 5F-3 may be left and right-side views of rectifier 400vr2 of FIG. 5F-1. As seen, V− bus bar 430 and V+ bus bar 431 have a generally rectangular cuboid shape. Bus bars 430 and 431 may have a height, width, and length around 10 mm, 25 mm, and 70 mm, respectively. Bus bars 430 and 431 may have dimensions that may be unequal to each other in another version. V− bus bar 430 and V+ bus bar 431 have terminals that may provide DC power to a device such as a DC/DC converter. Like bus bar 404vr, metal heat sinks 522, and phase bus bars 520, bus bar 430 and bus bar 431 have channels that hold tubes 420a through which a fluid can flow. FIGS. 5F-2 and 5F-3 show the height and width of the bus bars and heat sinks. FIG. 5F-1 shows the height and length of bus bars 520 and 404, and heat sink 522.

FIGS. 5F-2 and 5F-3 show the relative positioning of packaged switches 247d, phase bars 520, V− bus bar 430, heat sinks 522, V+ bus bar 431 and bus bar 404vr with respect to each other in legs a and c.

Each leg of rectifier 400vr2 may include a pair of packaged diodes 245-1 and 245-2, which include diodes D1 and D2, respectively. For purposes of explanation only, packaged dies 245-1 and 245-2 take form in packaged diode 245M shown of FIG. 3M. Die substrate terminals 230 of packaged diodes 245-2 and die clip terminals 344 of packaged diodes 245-1 in each leg may be electrically and thermally attached (e.g., soldered, sintered, press-fitted, etc.) directly to a flat surface or respective flat surfaces of V+ bus bar 431 and V− bus bar 430, respectively. Die substrate terminals 230 of packaged diodes 245-1 and die clip terminals 344 of packaged diodes 245-2 in each leg may be electrically and thermally attached (e.g., soldered, sintered, press-fit, etc.) to a flat surface or respective flat surfaces of a corresponding phase bus bar 520.

Die substrate terminals 230 of packaged switches 247dHa-247dHc may be electrically and thermally connected (e.g., soldered, sintered, press-fit, etc.) directly to flat surfaces of phase bus bars 520a-520c, respectively. Die clip terminals 344 of packaged switches 247dHa-247dHc may be electrically and thermally connected (e.g., soldered, sintered, press-fit, etc.) directly to flat surfaces of respective metal heat sinks 522a-522c, respectively. Die clip terminals 344 of packaged switches 247dLa-247dLc may be electrically and thermally connected (e.g., soldered, sintered, press-fit, etc.) directly to flat surfaces of metal heat sinks 522a-522c, respectively. Die substrate terminals 230 of packaged switches 247dLa-247dLc may be electrically and thermally connected (e.g., soldered, sintered, press-fit, etc.) directly to flat surfaces of common bus bar 404vr.

Capacitors C− and C+, which may be polar capacitors as shown, may be electrically connected to bus bar 404vr. Capacitors C− and C+ may have substantially the same capacitance so that bus bar 404vr is maintained at a voltage that is halfway between V+ and V−. Capacitors C− and C+ may also be thermally connected to bus bar 404vr. Surfaces of first terminals or leads of capacitors C− and C+ may be sintered, soldered, press-fitted, welded, or connected by other means to a flat surface of bus bar 404vr. Capacitors C− and C+ may be electrically connected to bus bars 430 and 431, respectively. Capacitors C− and C+ may also be thermally connected to bus bars 430 and 431, respectively. Surfaces of second terminals or leads of capacitors C− and C+ may be sintered, soldered, press-fitted, welded, or connected by other means to surfaces of V− bus 430 and V+ bus bar 431, respectively. Bus bars 430 and 431 are shown symbolically in FIG. 5F-1.

FIGS. 5F-1-5F-3 show rectifier 400vr2 with dielectric tubes 420a received in bus bars and heat sinks. Tubes other than 420a can be received by the bus bars and heat sinks. For example, each of bus bars 430, 431 and 404vr can be formed by soldering metal bus bar portions around tubes 420d or 420e using a process like that described with reference to FIGS. 15-17-1-15-17-5, bus bars 520 can be formed by soldering metal bus bar portions around tubes 420g using a process like that described with reference to FIGS. 5A-17-6-5A-17-10, and heat sinks 522 can be formed by soldering metal bus bar portions around tubes 420g using a process like that described with reference to FIGS. 5A-17-6-5A-17-10. Or the bus bars and heat sinks can be swapped with bus bars and heat sinks formed around tubes like tubes 420v1 using a process like that described with reference to FIGS. 9A-30-9A-33 or FIGS. 9A-34-9A-37.

Rectifier 400vr2 may include driver PCB 521 with drivers 306 that can send transistor control signals to respective switches 304 through respective connector-leads 288g. Only connector-leads 288gH, and 288gL of legs c and a are represented in FIG. 5F-2 and FIG. 5F-3, respectively. Driver PCB 521 may include surface mounted snubber capacitors (e.g., multilayer ceramic capacitors, not shown) that are connected in parallel with respective switches 304 through respective sets of connector-leads 288ds and 288dc. Rectifier 400vr2 may include a control PCB with an MCU in data communication with drivers 306, current sensors I_Sense, voltage sensors V_Sense, and other components mounted on driver PCB 521. A connector (e.g., a flexible PCB, not shown) may facilitate the data communication.

Driver PCB 521 may include voltage sensors V_Sense that can sense voltages between respective pairs of connector-leads 288ds and 288dc (not shown). Example phase bus bar-leads 465a and 465c extend laterally between first and second ends. The first ends of phase bus bar-leads 465a and 465c may be electrically connected to phase bus bars 520a and 520c, respectively, and the second ends may be electrically connected to AC sources φa and φc, respectively. Phase bus bar-leads 465a and 465c extend through respective apertures in PCB 521. Current sensors I_Sense-a and I_Sense-c measure electrical current flowing through phase bus bar-connectors 465a and 465c, respectively. I_Sense-a and I_Sense-c may include respective apertures through which phase bus bar-connectors 465a and 465c, respectively, extend. FIGS. 5F-2 and 5F-3 show voltage sensor V_Senses, PMICs, current sensors I_Sense, drivers 306, and a phase bus bar-leads 465 for legs a and c, respectively. A voltage sensor V_Sense, current sensor I_Sense, PMICs, drivers 306, and phase bus bar-lead 465 may be mounted on or extending through PCB 521 for leg-b.

A control PCB of rectifier 400vr2 may include a PLL and other components for synchronizing the control of switches 304 to the frequency of the three-phase AC input voltages provided by the AC sources φa-φc. Additional components may be added for power factor correction.

All tubes 420, such as tubes 420a in FIG. 5F-1, received in all bus bars and heat sinks may be substantially equal in length. Each tube 420a has first and second ends. The first ends of all tubes 420a may be in fluid communication with a first manifold, while the second ends of all the tubes 420a may be in fluid communication with the second manifold.

Liquid dielectric material such as epoxy, silicon, etc., can be added to air gaps or empty spaces between electrical conductors of rectifier 400vr2, including adjacent electrical conductors of naked packaged switches 247 if employed, and then cured to create structures that suppress dendrite growth and electrical arcing therebetween.

FIGS. 5G-1 and 5G-2 illustrate relevant components of an example full bridge converter 460fb when seen from the front and side, respectively. Full bridge converter 460fb is shown connected to load 468.

Converter 460fb may include packaged switches 247d, it being understood that in an alternative version packaged switches 247d may be replaced by packaged switches 247p, packaged switches 247q, or packaged diodes 245.

All packaged switches 247 of converter 460fb may be the same type. Packaged switches 247d of converter 460fb may be packaged switch 247dA, 247dB, or 247dD of FIGS. 3A, 3B, and 3D, respectively. Alternatively, packaged switches of converter 460fb may be mixed. For example, high-side packaged switches 247dH of converter 460fb may take form in packaged switches 247dA, while low-side packaged switches 247dL may take form in packaged switches 247dB, or vice versa. Or high-side packaged switches 247dH may take form in packaged switches 247dB, while low-side packaged switches 247dL are replaced by packaged switches 247q, such as packaged switches 247qP, or vice versa

Converter 460fb may include V+ bus bar 417fb, V− bus bar 412fb, and phase bus bars 418fb. Flat case surfaces of packaged switches 247 may be thermally connected directly or indirectly to flat surfaces of bus bars, like V+ bus bar 417fb, V− bus bar 412fb, and phase bus bars 418fb.

Converter 460fb has two legs designated a and b. Each leg may include packaged switches 247dH and 247dL that may be electrically and thermally connected to a respective phase bus bar 418fb, which in combination may be sandwiched between V+ bus bar 417fb and V− bus bar 412fb. Packaged switches 247dH and 247dL may be also electrically and thermally connected to V+ bus bar 417fb and V− bus bar 412fb, respectively.

FIG. 5G-1 illustrates the relative positioning of packaged switches 247d, V+ bus bar 417fb, phase bus bars 418fb, and V− bus bar 412fb with respect to each other. Die substrate terminals 230 and die clip terminals 344 may be pressed-fitted, soldered, sintered, welded, or connected by other means directly to corresponding flat surfaces of bus bars to establish thermal and electrical connectivity. Packaged switches 247dH in FIG. 5G-1 may have die substrate terminals 230 that may be electrically and thermally connected (e.g., soldered, sintered, press-fitted, etc.) directly or indirectly to a flat surface or respective flat surfaces of V+ bus bar 417fb, and die clip terminals 344 that may be electrically and thermally connected (e.g., soldered, sintered, press-fitted, etc.) directly or indirectly to flat surfaces of respective phase bus bars 418fba and 418fbb. Packaged switches 247dL in FIG. 5G-1 may have die substrate terminals 230 that may be electrically and thermally connected (e.g., soldered, sintered, press-fitted, etc.) directly or indirectly to flat surfaces of respective phase bus bars 418fba and 418fbb, and die clip terminals 344 that may be electrically and thermally connected (e.g., soldered, sintered, press-fitted, etc.) directly or indirectly to a flat surface or respective flat surfaces of V− bus bar 412fb.

Bus bars may be electrically connected to respective terminals of a load. FIG. 5G-1 shows phase bus bars 418fba and 418fbb electrically connected to respective terminals of a load 468. A load may include one or more active elements (e.g., transistor, battery, etc.) and/or one or more passive elements (e.g., inductor, capacitor, resistor, transformer, etc.) electrically connected between a pair of terminals. A load may include any combination of one or more batteries, one or more transistors, one or more diodes, one or more resistors, one or more capacitors, one or more inductors, one or more resonant coils, one or more stator windings, one or more transformers, etc., electrically connected between a pair of terminals. Two or more of a resistor, a capacitor, an inductor, a resonant coil, stator winding, transformer winding, battery, etc., may be electrically connected in series between terminals of a load. A load such as load 468 may include a capacitor electrically connected in series or in parallel with a winding of a transformer. A load such as load 468 may include an inductor electrically connected in series or in parallel with a winding of a transformer. A load such as load 468 may include a capacitor, inductor, and a winding of a transformer connected in series. A load may include a battery connected in series with an inductor. A load such as load 468 may include just one element such as a resonant coil. Resonant coils include coils that resonate with their internal capacitance. A load such as load 468 may include a power converter such as inverter 460iT with bus bars 417T and 412T electrically connected to bus bars 417fb and 412fb, respectively.

Bus bars, like V+ bus bar 417fb, V− bus bar 412fb, and phase bus bars 418fb in FIGS. 5G-1 and 5G-2, may have a generally rectangular cuboid shape. Example phase bus bars 418fb may have height, width, and length around 12 mm, 25 mm, and 20 mm, respectively. Example V+ bus bar 417fb and V− bus bar 412fb may have height, width, and length around 8 mm, 25 mm, and 45 mm, respectively. Bus bars may have different dimensions to accommodate differences in converter design. FIG. 5G-1 shows the height and length of the bus bars.

FIGS. 5G-1 and 5G-2 show converter 460fb with dielectric tubes 420a received by bus bars. Tubes other than 420a can be received by the bus bars. For example, each of bus bars 412fb and 417fb can be formed by soldering metal bus bar portions around tubes 420d or 420e using a process like that described with reference to FIGS. 15-17-1-15-17-5, and aligned bus bars 418fb can be formed by soldering metal bus bar portions around metalized ceramic tubes like tube 420g, but with two metal layers 407p instead of three, using a process like that described with reference to FIGS. 5A-17-11-5A-17-15 in which two pairs of metal bus bar portions 505 and 509 are soldered around the two metal layers 407p, respectively. Or the bus bars can be swapped with bus bars formed around tubes like tubes 420v1 using a process like that described with reference to FIGS. 9A-30-9A-33 or FIGS. 9A-34-9A-37. Tubes 420a may be received in V+ bus bar 417fb, V− bus bar 412fb, and phase bus bars 418fb. Phase bus bars 418fba and 418fbb of converter 460fb may be thermally connected to each other and electrically isolated from each other by commonly received dielectric tubes 420a.

Two instances of converter 460fb can be combined through shared tubes 420 to create, for example, an isolated DC/DC converter. FIG. 5G-3 illustrates a converter 460DC that combines two instances converter 460fb (i.e., 460fb1 and 460fb2). Although not shown, packaged switches 247d of converter 460DC may be controlled by drivers 306 of a unified driver PCB that incorporates elements from two instances of driver PCB 461fb described above. An MCU can be mounted on the unified driver PCB. The MCU may be in data communication through PCB traces with drivers 306 that control packaged switches 247d via respective connector-leads 288g, voltage sensors V_Sense, and current sensors I_Sense, all of which may be mounted on the unified driver PCB. Snubber capacitors (e.g., ceramic capacitors 433s) may be mounted on the unified driver PCB as well and electrically connected in parallel with switches 304d via respective sets of connector-leads 288ds and 288dc (not shown) of packaged switches 247d. DC/DC converter 460DC shares tubes 420 of the same length as shown. Tubes 420a in FIG. 5G-3 may be extended length versions of tubes 420a of FIG. 5G-1. Extended tubes 420a can be commonly received by aligned V+ bus bars 417fb1 and 417fb2 as shown. Extended tubes 420a can be commonly received by aligned V− bus bars 412fb1 and 412fb2 as shown. Extended tubes 420a can be commonly received by four linearly aligned phase bus bars 418fb as shown. First and second manifolds (not shown) can be fluidly connected to the first and second ends, respectively, of the extended tubes 420a. Although not shown, V+ bus bar 417fb 1 and V− bus bar 412fb1 may be electrically connected to the V+ and V− terminals, respectively, of a DC voltage supply such as a rectifier. For example, V+ bus bar 417fb1 and V− bus bar 412fb1 may be electrically connected to bus bars 417T and 412T, respectively, of rectifier 460rT (described above), V+ bus bar 417fb1 and V− bus bar 412fb1 may be electrically connected to bus bars 417pr and 412pr, respectively, of rectifier 460pr (described below), or V+ bus bar 417fb1 and V− bus bar 412fb1 may be electrically connected to bus bars 431 and 430, respectively, of rectifiers 400vr1 or 400vr2 (described above). V+ bus bar 417fb2 and V− bus bar 412fb2 may be electrically connected to respective terminals of a load as shown. The load may be a battery, and V+ bus bar 417fb2 and V− bus bar 412fb2 may be electrically connected to respective terminals of the battery. V+ bus bar 417fb2 and V− bus bar 412fb2 may be electrically connected to the V+ and V-terminals, respectively, of a converter such as an inverter. For example, V+ bus bar 417fb2 and V− bus bar 412fb2 may be electrically connected to bus bars 417T and 412T, respectively, of inverter 460iT. FIG. 5G-3 shows phase bus bars 418fb electrically connected to respective terminals of a transformer T. Phase bus bar 418fbb1 is shown indirectly connected to the top terminal of transformer T on the primary side through inductor Lp and capacitor Cp, and phase bus bar 418fba2 is shown indirectly connected to the top terminal of transformer T on the secondary side through inductor Ls and capacitor Cs. FIGS. 5G-3 shows phase bus bar 418fbb2 electrically connected directly to the bottom terminal of transformer T on the secondary side, and phase bus bar 418fba1 electrically connected directly to the bottom terminal of transformer T on the primary side. In an alternative embodiment, phase bus bar 418fbb2 may be electrically connected indirectly to the top terminal of transformer T on the secondary side via inductor Ls and capacitor Cs, and phase bus bar 418fba2 may be electrically connected directly to the bottom terminal of transformer T on the secondary side, while phase bus bars 418fbb1 an 418fba1 remain connected to transformer T as shown in FIG. 5G-3. Inductor Lp of this disclosure may represent leakage induction of the primary side of transformer T, and inductor Ls may represent leakage induction of the secondary side of transformer T. Inductor Lp may represent a combination of leakage induction of the primary side of transformer T and leakage inductance of the secondary side that is reflected to the primary side. Inductor Ls may represent a combination of leakage induction of the secondary side of transformer T and leakage inductance of the primary side that is reflected to the secondary side. Reflected leakage inductance may describe the leakage inductance of one winding of the transformer as it appears in the other winding, after being scaled. One or both inductors Lp and Ls may be discrete devices. Inductor Lp may represent a series combination of a discrete inductor and leakage inductance on the primary side of transformer T, and inductor Ls may represent a series combination of a discrete inductor and leakage inductance on the secondary side of transformer T. Converter 460DC as shown may function as an isolated, resonant DC/DC converter. In an alternative embodiment, capacitor Cs is eliminated, capacitor Cp is eliminated, inductor Ls is eliminated or reflected into Lp, phase bus bar 418fbb1 is electrically connected to the top terminal of transformer T on the primary side through inductor Lp, phase bus bar 418fba1 is electrically connected directly to the bottom terminal of transformer T on the primary side, phase bus bar 418fba2 is electrically connected directly to the top terminal of transformer T on the secondary side, and bus bar 418fbb2 is electrically connected directly to the bottom terminal of transformer T on the secondary side. This alternative converter 460DC may function as an isolated, dual-active bridge DC/DC converter. In yet another alternative embodiment, both capacitors C and both inductors L are eliminated, phase bus bars 418fbb1 and 418fba1 are electrically connected directly to the top and bottom terminals, respectively, of transformer T on the primary side, and phase bus bars 418fba2 and 418fbb2 are electrically connected directly to the top and bottom terminals, respectively, of transformer T on the secondary side. In still another alternative embodiment, capacitors Cs and Cp are eliminated, phase bus bar 418fbb1 is electrically connected to top terminal of transformer T on the primary side through inductor Lp, phase bus bar 418fba1 is electrically connected directly to bottom terminal of transformer T on the primary side, phase bus bar 418fba2 is electrically connected to top terminal of transformer T on the secondary side through inductor Ls, and phase bus bar 418fbb2 is electrically connected directly to the bottom terminal of transformer T on the secondary side. In one more embodiment, Ls and Cs may be eliminated, phase bus bars 418fbb2 and 418fba2 may be electrically connected directly to the bottom and top terminals, respectively, of transformer T, and packaged switches 247 of 460fb2 may be replaced by packaged diodes 245M or 245N. In transformer representations, the dot convention indicates the relative polarity of windings. Some or all transformers of this disclosure are shown without dots. The dot placement may depend on the configuration of the converter in which the transformer, such as transformer T, is used. For example, placement of the dots may depend on whether the transformer is employed in a resonant DC/DC converter, a duel-active bridge DC/DC converter, or some other converter or apparatus. The dots for a transformer T may be placed at the top terminals of both the primary and secondary sides, or a dot may be placed on the top of the primary side terminal and a dot may be placed on the bottom of the secondary side terminal. FIG. 5G-3 shows converter 460DC with dielectric tubes 420a received in bus bars. Tubes other than 420a can be received by the bus bars. For example, the four aligned bus bars 418fb can be formed by soldering metal bus bar portions around tubes like tubes 420g, but with four metal layers 407p instead of three, using a process like the process described with reference to FIGS. 5A-11-5A-15, but with four groups of metal bus bar portions 505 and 509 soldered around the four metal layers 407p, respectively. The two aligned bus bars 417fb1 and 417fb2 can be formed by soldering metal bus bar portions around tubes like tubes 420g, but with two metal layers 407p instead of three, using a process like the process described with reference to FIGS. 5A-17-6-5A-17-10, but with two pairs metal bus bar portions 505 and 509 soldered around the two sized metal layers 407p, respectively. The two aligned bus bars 412fb1 and 412fb2 can be formed by soldering metal bus bar portions around tubes like tubes 420g, but with two metal layers 407p instead of three, using a process like the process described with reference to FIGS. 5A-17-6-5A-17-10, but two pairs of metal bus bar portions 505 and 509 are soldered around respective metal layers 407p.

Converter 460fb may include film capacitor 403fb. First and second metal capacitor-leads 405fba and 405fbb extend from a dielectric wall of the capacitor. A flat bottom surface of capacitor-lead 405fba may be electrically and thermally connected (e.g., welded, soldered, press-fitted by screws or other fasteners, etc.) directly to a flat surface of a bus bar such as V+ bus bar 417fb, and a flat top surface area of capacitor-lead 405fbb may be electrically and thermally connected to a flat surface of V− bus bar 412fb.

One or more ceramic DC link capacitors may be electrically and thermally connected between V+ bus bar 417fb and V− bus bar 412fb. The one or more ceramic DC link capacitors may have first and second metal terminals that may be electrically and thermally connected to a flat surface of V+ bus bar 417fb and V− bus bar 412fb, respectively.

FIG. 5G-1 includes electrical current symbols that represent electrical current flow through converter 460fb at an instant in time. More particularly, FIG. 5G-1 shows electrical current flow through activated high-side switch 304dH of leg-a, while low-side switch 304dL of leg-b is activated and conducting current to the V-terminal through the V− bus bar 412fb. All other switches 304 may be deactivated in the figure.

Converter 460fb may include control PCB 462fb and driver PCB 461fb. Drivers on driver PCB 461fb can control respective switches 304 through respective connector-leads 288g. Only drivers and connector-leads 288gH and 288gL of leg-b are represented in FIG. 5G-2. Driver PCB 461fb in FIG. 5G-2 may include voltage sensors V_Sense that can sense voltages between respective pairs of connector leads 288ds and 288dc (not shown). Example phase bus bar-lead 465a may extend laterally between first and second ends. The first end of phase bus bar-lead 465a may be electrically connected to phase bus bar 418fba, and the second end may be electrically connected to a load, which may include a primary or secondary coil of a transformer. Phase bus bar-lead 465a may extend through an aperture in PCB 461fb. Current sensor I_Sense measures electrical current flowing through phase bus bar-lead 465a. I_Sense may include an aperture through which phase bus bar-lead 465a may extend. FIG. 5G-2 shows drivers 306, voltage sensors V_Sense, PMICs, current sensor I_Sense, and a phase bus bar-lead 465 for leg-a. A similar group of drivers 306, voltage sensors V_Sense, PMICs, current sensor I_Sense, and phase bus bar-lead 465 may be mounted on or extending through PCB 461fb for leg-b. FIG. 5G-2 shows an MCU mounted on control PCB 462fb. The MCU may be in data communication with each driver 306, V_Sense, and I_Sense mounted on driver PCB 461fb through a data connection 484.

All tubes 420, such as tubes 420a in FIG. 5G-1, received in all bus bars may be substantially equal in length. Although not shown in FIGS. 5G-1 and 5G-2, first and second manifolds like manifolds 466iT, may be in fluid communication with first and second ends, respectively, of tubes 420a.

Liquid dielectric material such as epoxy, silicon, etc., can be added to air gaps or empty spaces between electrical conductors of converter 460fb, including adjacent electrical conductors of naked packaged switches 247 if employed, and then cured to create structures that suppress dendrite growth and electrical arcing therebetween.

FIGS. 5O-1, 5O-2 and 5O-3 illustrate relevant components of an example three-phase inverter 460it when seen from the front and sides. Several components (e.g., driver PCB 461it, driver PCB 461it, and capacitors 403t) are not shown or fully shown in all figures but are described below.

FIG. 5O-1 shows a front view of example inverter 460it, and FIGS. 5O-2 and 5O-3 show side views. Inverter 460it has three legs designated a-c, each of which may include six packaged switches 247.

Inverter 460it is shown with a mix of packaged switches 247d and 247q. As seen in FIG. 5O-1, each leg may include four packaged switches 247d1-247d4 and two packaged switches 247qH and 247qL. Alternatively, all packaged switches of inverter 460it may be a version of packaged switch 247p, 247q, or 247d. For example, all packaged switches 247 may be packaged switch 247qP of FIG. 3P, or all packaged switches 247 may be packaged switch 247qF of FIG. 3F. Each of the switches 304 in packaged switches 247 of inverter 460it can be independently controlled by an MCU on control PCB 462it. Each group of one or more transistors in each switch 247q or 247p, which is electrically connected to a respective connector-lead 288, can be independently controlled by the MCU or other data processing device. Packaged switches 247d2, 247d4, and 247qH and 247qL in each leg of inverter 460it may take form in packaged switches that lack connector-lead 288dc and/or 288ds.

All packaged switches 247d1-247d4 may be the same type, and all packaged switches 247qH and 247qL may be the same type. Packaged switches 247d of inverter 460it may be packaged switch 247dA, 247dB, 247dC, 247dD or 247dO of FIG. 3A, 3B, 3C, 3D, and 3O, respectively, and packaged switches 247q may be packaged switch 247qE, 247qF, 247qG, 247qI, 247qJ, 247ql, or 347qP of FIGS. 3E, 3F, 3G, 3I, 3J, 3L, and 3P, respectively.

Inverter 460it may include V+ bus bar 417t, V− bus bar 412q, and phase bus bars 418t. Bus bars, like V+ bus bar 417t, V− bus bar 412t, and phase bus bars 418t, may also act as heat sinks to cool switches 304 or diodes D.

Each leg a-c may include packaged switches 247d1-247d4, 247qH, and 247qL that may be electrically and thermally connected to a respective phase bus bar 418t, which in combination may be sandwiched between V+ bus bar 417t and V− bus bar 412t. Packaged switches 247d1, 247d2, and 247qH may be electrically and thermally connected to V+ bus bar 417t, and packaged switches 247d3, 247d4, and 247qL may be electrically and thermally connected to V− bus bar 412t.

FIGS. 5O-1 and 5O-2 illustrate the relative positioning of packaged switches 247, V+ bus bar 417t, phase bus bars 418t, and V− bus bar 412t with respect to each other. Packaged switches 247d1, 247d2 and 247qH in each leg may have die substrate terminals 230 that may be electrically and thermally connected (e.g., soldered, sintered, press-fitted, etc.) directly or indirectly to a flat surface or respective flat surfaces of V+ bus bar 417t, and die clip terminals 344 that may be electrically and thermally connected (e.g., soldered, sintered, press-fitted, etc.) directly or indirectly to a flat surface or respective flat surfaces of a corresponding phase bus bar 418t, which in turn have terminals that may be electrically connected to windings Wa-Wc, respectively. Packaged switches 247d3, 247d4 and 247qL in each leg may have die substrate terminals 230 that may be electrically and thermally connected (e.g., soldered, sintered, press-fitted, etc.) directly or indirectly to a flat surface or respective flat surfaces of a corresponding phase bus bar 418t, and die clip terminals 344 that may be electrically and thermally connected (e.g., soldered, sintered, press-fitted, etc.) directly or indirectly to a flat surface or respective flat surfaces of V− bus bar 412t.

V+ bus bar 417t, V− bus bar 412t, and phase bus bars 418t in FIGS. 5O-1-5O-3, may have a generally rectangular cuboid shape. Example phase bus bars 418t may have a height, width, and length around 12 mm, 25 mm, and 70 mm, respectively. Example V+ bus bar 417t and V− bus bar 412t may have a height, width, and length around 8 mm, 25 mm, and 230 mm, respectively. FIG. 5O-1 shows the height and length of the bus bars.

FIGS. 5O-1-5O-3 show inverter 460it with dielectric tubes 420a received by bus bars. Tubes other than 420a can be received by the bus bars. For example, each of bus bars 412t and 417t can be formed by soldering metal bus bar portions around tubes 420d or 420e using a process like that described with reference to FIGS. 15-17-1-15-17-5, and bus bars 418t can be formed by soldering metal bus bar portions around tubes 420g using a process like that described with reference to FIGS. 5A-17-11-5A-17-15. Or the bus bars can be swapped with bus bars formed around tubes like tubes 420v1 using a process like that described with reference to FIGS. 9A-30-9A-33 or FIGS. 9A-34-9A-37.

Inverter 460it may include capacitors 403t. FIGS. 5O-1 shows leads 405t of capacitors 403t. First and second metal capacitor-leads 405ta and 405tb may extend from one of the capacitor's dielectric wall. Example capacitor-leads 405t have a height hbc, length lbc, and width wbc around 6 mm, 30 mm, and 50 mm, respectively. Capacitor-leads, including capacitor-leads 405t, may have substantially flat, rectangular-shaped opposite facing top and bottom surfaces. A substantial portion (e.g., 10, 20, 50, 75, 90% or more) of each capacitor-lead 405ta's flat bottom surface area may be electrically and thermally connected (e.g., welded, soldered, press-fitted by screws or other fasteners, etc.) directly to a flat surface of V+ bus bar 417t, and a substantial portion (e.g., 10, 20, 50, 75, 90% or more) of each capacitor-lead 405tb's flat top surface area may be electrically and thermally connected (e.g., welded, soldered, press-fitted by screws or other fasteners, etc.) directly to a flat surface of V− bus bar 412t.

Inverter 460it may include one or more ceramic DC link capacitors (e.g., multilayer ceramic capacitors) with first and second metal terminals that may be electrically and thermally connected directly or indirectly to flat surfaces V+ bus bar 417t and V− bus bar 412t, respectively.

FIG. 5O-1 includes electrical current symbols that represent electrical current flow through inverter 460it at an instant in time. More particularly, FIG. 5O-1 shows electrical current flow through activated transistors of switches 304 in packaged switches 247d1 and 247qH of leg-a, and electrical current flow through activated transistors of switches 304 in packages 247d3 and 247qL of legs b and c.

For purposes of explanation only: each of packaged switches 247d1 and 247d3 may be packaged switch 247dB of FIG. 3B, which may include four commonly controlled MOSFETs connected in parallel; each of packaged switches 247d2 and 247d4 may be packaged switch 247dO of FIG. 3O, which may include four commonly controlled IGBTs connected in parallel, and; each of packaged switches 247qH and 247qL may be packaged switch 247qP of FIG. 3P, which may include two IGBTs and two MOSFETs connected in parallel but separately controlled. In this configuration, two, four, six, eight, ten, or twelve transistors in a leg of inverter 460it can be activated at the same time. The current symbols in FIG. 5O-1 presume that six transistors in each leg may be activated at the same time. Specifically, all four MOSFETs in switch 304d of packaged switch 247d1 in leg-a may be activated, all four MOSFETs in switches 304d of packaged switches 247d3 in legs b and c may be activated, only two (e.g., two MOSFETs or two IGBTs) transistors in switch 304q of packaged switch 247qH in leg-a may be activated, and only two (e.g., two MOSFETs or two IGBTs) transistors in switch 304q of packaged switches 247qL in legs b and c may be activated. All other transistors may be deactivated. The current symbols may be drawn with widths that represent their respective current magnitudes, and the widths may be drawn to scale with respect to each other in FIG. 5O-1.

Inverter 460it may include driver PCBs 461it and 461it with drivers 306 that can send transistor control signals to respective switches 304 through respective connector-leads 288g or respective sets of connector-leads 288g1 and 288g2. Only connector-leads 288gc of leg-c are represented in FIG. 5O-2, and only 288g1a, and 288g2a of leg-a are represented in FIG. 5O-3. Driver PCBs 461it and 461it may include surface mounted snubber capacitors (e.g., multilayer ceramic capacitors, not shown) that are connected in parallel with respective switches 304 through respective sets of connector-leads 288ds and 288dc. Inverter 460it may include a control PCB 462it with an MCU that may be in data communication with drivers 306, current sensor I_Sense, voltage sensors, and other components mounted on driver PCBs 461it and 461it. Data connection 484 may facilitate the data communication.

Driver PCB 461it in FIG. 5O-3 may include drivers 306 that can send transistor control signals to respective packaged switches 247q of leg-a through respective sets of connector-leads 288g1 and 288g2. Driver PCB 461it1 also may include drivers that may similarly send transistor control signals to respective packaged switches 247q in legs c and b. Driver PCB 461it in FIG. 5O-2 may include drivers 306 that can send transistor control signals to respective packaged switches 247d of leg-c through respective connector-leads 288. Driver PCB 462it1 also may include drivers that may similarly send transistor control signals to respective packaged switches 247d in legs a and b.

Driver PCB 461it2 may include voltage sensors V_Sense that can sense voltages between respective pairs or connector-leads 288ds and 288dc (not shown). Example phase bus bar-leads 465a and 465c extend laterally between first and second ends. The first end of phase bus bar-leads 465a and 465c may be electrically connected to phase bus bars 418ta and 418tc, respectively, and the second ends may be electrically connected to windings Wa and Wc, respectively. Phase bus bar-leads 465a and 465c extend through respective apertures in PCB 461it. Current sensors I_Sense-a and I_Sense-c measure electrical current flowing through phase bus bar-connectors 465a and 456c. I_Sense-a and I_Sense-c may include respective apertures through which phase bus bar-connectors 465a and 465c extend. FIG. 5O-2 shows voltage sensors V_Sense, PMICs, current sensor I_Sense-c, and a phase bus bar-lead 465 for leg-c, and FIG. 5O-3 shows voltage sensors V_Sense, PMICs, current sensor I_Sense-a, and a phase bus bar-lead 465 for leg-a. A similar group voltage sensor V_Sense, PMICs, current sensor I_Sense, and phase bus bar-lead 465 may be mounted on or extending through PCB 461it for leg-b.

All tubes 420a received in all bus bars of inverter 460it may be substantially equal in length. Each tube 420a has first and second ends. The first ends of all tubes 420a may be in fluid communication with a first manifold like manifold 466iT-1, while the second ends of all the tubes 420a may be in fluid communication with a second manifold like manifold 466iT-2.

Liquid dielectric material such as epoxy, silicon, etc., can be added to air gaps or empty spaces between electrical conductors of inverter 461it, including adjacent electrical conductors of naked packaged switches 247 if employed, and then cured to create structures that suppress dendrite growth and electrical arcing therebetween.

Solid-state circuit switches (SSCSs) are disclosed. SSCSs such as solid-state circuit breakers, solid-state contactors, solid-state relays, etc., are devices that can open or close an electrical circuit. For example, an SSCS can open an electrical circuit that connects a power converter such as an inverter or battery charger to a source such as a battery, or the SSCS can close the electrical circuit to connect the power converter to the source. An SSCS can open or close a circuit in response to receiving a control signal from a device external to the SSCS.

SSCSs (solid-state circuit switches) provide advantages over traditional circuit switches such as electromechanical breakers and electromechanical contactors that have moving parts. For example, SSCSs can open or close a circuit in a few microseconds in response to receiving a control signal. Electromechanical circuit switches are slower to open or close a circuit. It may take several milliseconds for an electromechanical circuit switch to open or close a circuit in response to receiving a control signal. Also, electromechanical circuit switches are subject to electrical arcing. A very high inrush of electrical current during closing may generate an electrical arc that permanently welds moving parts together in the closed position. SSCSs lack moving parts that can be inadvertently welded together.

SSCSs can open an electric circuit and interrupt the flow of AC or DC current. For example, an SSCS can interrupt DC current flowing through it when it detects the current is excessive. SSCSs of this disclosure can be bidirectional or capable of interrupting current in the forward or reverse directions. SSCSs of this disclosure may be unidirectional or capable of interrupting current in only one direction; forward or reverse but not both.

An SSCS of this disclosure may be electrically connected between a source of AC or DC power and a load. For example, an SSCS of this disclosure may be electrically connected in series between battery and an inverter. An SSCS of this disclosure may be electrically connected in parallel with a device. For example, an SSCS of this disclosure may be electrically connected in parallel with an uninterruptible power supply (UPS).

FIGS. 5M-1 and 5M-2 illustrate relevant components of an example SSCS 500a when seen from the front and side, respectively. Manifolds 512s are shown in FIG. 5M-1 but not in FIG. 5M-2. Driver PCB 461cba and voltage clamping circuit (a.k.a., voltage suppression circuit) 514 are shown in FIG. 5M-2 but not in FIG. 5M-1. Voltage clamping circuits 514 are more fully described below.

SSCS 500a includes bus bar 501s and bus bar 502s, which may have a generally rectangular cuboid shape as shown. Example bus bars 501s and 502s may have a height, width, and length around 12 mm, 25 mm, and 45 mm, respectively. Bus bars 501s and 502s may be electrically connected to distinct devices. For example, bus bar 501s may be electrically connected to a battery terminal, and bus bar 502s may be electrically connected to the terminal of a power converter (e.g., a three-phase inverter), or bus bar 502s may be electrically connected to a battery terminal, and bus bar 501s may be electrically connected to a terminal of the power converter.

SSCS 500a is shown with packaged switches 247q, it being understood packaged switches 247q may be swapped with packaged switches 247pK or 247dD in an alternative embodiment. Each of the packaged switches 247q of SSCS 500a may be packaged switch 247qG, 247qI, 247qJ, or 247ql of FIGS. 3G, 3I, 3J, and 3L, respectively. All packaged switches 247 of SSCS 500a may be the same type. In an alternative embodiment, SSCS 500a may use a mix of packaged switches 247. For example, packaged switch 247q1 may be packaged switch 247qG, and packaged switch 247q2 may be packaged switch 247qI.

FIG. 5M-1 illustrates the relative positioning of packaged switches 247q, bus bar 501s, and bus bar 502s. Packaged switches 247q in FIG. 5M-1 have die substrate terminals 230 that may be electrically and thermally connected (e.g., soldered, sintered, press-fitted, etc.) directly or indirectly to a flat surface or respective flat surfaces of bus bar 501s, and die clip terminals 344 that may be electrically and thermally connected (e.g., soldered, sintered, press-fitted, etc.) directly or indirectly to a flat surface or respective flat surfaces of bus bar 502s as shown.

Example SSCS 500a is shown with two packaged switches 247q electrically connected in parallel between bus bars 501s and 502s. In an alternative version, SSCS 500a may include only one packaged switch 247q, 247pK or 247dD electrically connected between bus bars 501s and 502s. In still another version, three or more packaged switches 247q, three or more packaged switches 247pK, or three or more packaged switches 247dD can be positioned between and electrically connected between bus bars 501s and 502s. The lengths or widths of tubes 420a, bus bar 501s and bus bar 502s may be extended to accommodate three or more packaged switches 247.

Switches 304 in an SSCS may be subject to overvoltage (i.e., a voltage that exceeds a predetermined value) when the SSCS is turned off. Overvoltage can damage transistors in switches 304. One or more voltage clamping circuits can be added to an SSCS, such as SSCS 500a, to limit overvoltage.

One or more voltage clamping circuits may be electrically connected in parallel with parallel coupled switches 304 of an SSCS, or one or more voltage clamping circuits may be electrically connected in parallel with series connected switches 304 of an SSCS. FIG. 5M-2 shows a voltage clamping circuit 514 electrically connected in parallel with parallel coupled switches 304 of SSCS 500a. More particularly, FIG. 5M-2 includes a voltage clamping circuit 514 with voltage clamping circuit terminals 523-1 and 523-2, which are electrically connected to bus bars 501s and 502s, respectively. Terminals 523 are symbolically shown in the figures but represent metal elements that can be electrically connected to respective traces on a PCB such as PCB 516vca. A terminal 523-1 or 523-2 could be a solder joint, weld joint, etc., that electrically connects a varistor terminal or capacitor terminal of a voltage clamping circuit 514 to a trace of a PCB. A terminal 523 could be several solder joints that electrically connect a PCB trace and respective terminals of capacitors, varistors, etc., of a voltage clamping circuit 514. Voltage clamping circuit 514 can be mounted on PCB 516vca and electrically connected to bus bars 501s and 502s via terminals 523, traces on opposite sides of PCB 516vca, and connecting PCB 516vca vias. In an alternative embodiment of SSCS 500a, voltage clamping circuit 514 may be mounted on driver PCB 461cba with terminals 523-1 and 523-2 electrically connected to connector-leads 288ds and 288dc (not shown), respectively, of one or both packaged switch 247q via traces on opposite sides of driver PCB 461cba and connecting driver PCB 461cba vias.

A voltage clamping circuit 514 may include one component electrically connected between terminals 523-1 and 523-2, or voltage clamping circuit 514 may include several electrically connected components, the combination of which may be electrically connected between terminals 523-1 and 523-2. A voltage clamping circuit, such as voltage clamping circuit 514, of this disclosure may include several components that are electrically connected via traces of a PCB, such as PCB 516vca or PCB 461cba, between terminals 523-1 and 523-2, which in turn can be electrically connected to PCB traces as noted above.

FIGS. 5M-3a-5M-3i illustrate example voltage clamping circuits 514. Voltage clamping circuit 514a is a capacitor (e.g., a film capacitor, ceramic capacitor, electrolytic capacitor, etc.) C electrically connected between terminals 523-1 and 523-2 as shown. Voltage clamping circuit 514b is capacitor C electrically connected in series with a resistor R between terminals 523-1 and 523-2 as shown. Voltage clamping circuit 514c includes resistor R electrically connected in parallel with a diode D, the combination of which is electrically connected in series with capacitor C between terminals 523-1 and 523-2 as shown. Voltage clamping circuit 514d is a transient voltage suppression (TVS) diode electrically connected between terminals 523-1 and 523-2 as shown. TVS diodes function similarly to avalanche diodes but can withstand high peak current and energy. Voltage clamping circuit 514e is a varistor (e.g., metal oxide varistor) V electrically connected between terminals 523-1 and 523-2 as shown. Metal oxide varistors can be constructed using various materials, such as zinc oxide and silicon oxide. At low applied voltage levels (below the clamping voltage), the metal oxide varistors may exhibit high impedance properties. As the voltage increases to reach a predetermined voltage, the impedance of metal oxide varistors decreases fast, enabling the flow of current. Voltage clamping circuit 514f includes varistor V electrically connected in parallel with capacitor C, the combination of which is electrically connected between terminals 523-1 and 523-2 as shown. Voltage clamping circuit 514g includes a first varistor (e.g., metal oxide varistor) V1 electrically connected in series with capacitor C, the combination of which is electrically connected in parallel with a second varistor (e.g., metal oxide varistor) V2 between terminals 523-1 and 523-2 as shown. Voltage clamping circuit 514h is voltage clamping circuit 514g with resistor R electrically connected in parallel with capacitor C as shown. Voltage clamping circuit 514i is voltage clamping circuit 514c with varistor V electrically connected in parallel as shown.

FIGS. 5M-1 and 5M-2 show SSCS 500a with dielectric tubes 420a received in bus bars 501s and 502s. Tubes other than 420a can be received by the bus bars. For example, each of bus bars 501s and 502s can be formed by soldering metal bus bar portions around tubes 420d or 420e using a process like that described with reference to FIGS. 5A-17-1-5A-17-5. Or the bus bars can be swapped with bus bars formed around tubes like tubes 420v1 using a process like that described with reference to FIGS. 9A-30-9A-33.

SSCS 500a can operate in forward mode, reverse mode or bidirectional mode. When operating in the forward mode, SSCS 500a can conduct forward current IF flowing through one or both switches 304q. FIG. 5M-2 shows SSCS 500a operating in the forward mode. SSCS 500a may interrupt current IF flowing through it while operating in the forward mode. When operating in reverse mode, SSCS 500a can conduct reverse current IR flowing through one or both switches 304q. SSCS 500a can interrupt current IR flowing through it while operating in the reverse mode. When operating in the bidirectional mode, SSCS 500a can conduct IF or IR through one or both switches 304q. SSCS 500a can interrupt IR or IF while operating in bidirectional mode. When SSCS 500a is off, all transistors in switches 304q may be deactivated and no electrical current, other than perhaps leakage current, passes through switches 304q.

In bidirectional mode all transistors in both switches 304q may be activated. In the forward mode, all transistors that are controlled through connector-leads 288g1 in one or both switches 247q, may be activated, while all transistors that are controlled through connector-leads 288g2 in both switches 247q, may be deactivated. In the reverse mode, all transistors that are controlled through connector-leads 288g1 in both switches 247q, may be deactivated, while all transistors that are controlled through connector-leads 288g2 in one or both switches 247q, may be activated.

If SSCS 500a uses packaged switch 247qG or 247qI (e.g., switches containing BBJTs) SSCS 500a may operate in the forward mode when one or both connector-leads 288g1 in packaged switches 247q1 and 247q2, respectively, is/are driven with a transistor activation current (e.g., a base current for activating the BBJT(s)), and neither connector-lead 288g2 in packaged switches 247q1 and 247q2 is driven with a transistor activation current. SSCS 500a may operate in the reverse mode when neither connector-lead 288g1 in packaged switches 247q1 and 247q2 is driven with a transistor activation current, and one or both connector-leads 288g2 in packaged switches 247q1 and 247q2 is/are driven with a transistor activation current.

An SSCS may include driver PCB upon which one or more drivers are mounted. In example SSCS 500a, pairs of drivers 306 are mounted on driver 461cba and may control respective switches 304q. Each pair of drivers 306 may be electrically connected to and control a respective switch 304q through a respective set of connector-leads 288g1 and 288g2. Only drivers 306 and connector-leads 288g1 and 288g2 for packaged switch 247q1 are represented in FIG. 5M-2. Another pair of drivers 306 may be mounted on PCB 461cba and similarly connected to packaged switch 247q2 through its connector-leads 288g1 and 288g2. PCB 461cba in FIG. 5M-2 may include a voltage sensor V_Sense that can sense voltage across connector-leads 288ds and 288dc (not shown) of packaged switch 247q1 or 247q2. A current sensor I_Sense may be mounted on driver PCB 461cba as shown. One end of a bus bar connector 465i can be connected (e.g., soldered, welded, integrally formed, etc.) to bus bar 501s as shown. The other end of bus bar connector 465i may extend through aligned apertures of current sensor I_Sense and PCB 461cba. Current sensor I_Sense can sense forward or reverse current flow through SSCS 500a via bus bar connector 465i. FIG. 5M-2 shows an MCU mounted on PCB 462cb1. The MCU may be in data communication with drivers 306, I_Sense, and V_Sense. The MCU may generate a control signal to deactivate some or all switches 304q via the drivers 306 after processing current and/or voltage signals received from I_Sense and V-Sense, respectively. Alternatively, or in addition, the MCU may generate a control signal to activate or deactivate some or all switches 304q via the drivers 306 in response to the MCU receiving a signal from a device external to SSCS 500a.

All tubes 420, such as tubes 420a in FIG. 5M-1, received in all bus bars may be substantially equal in length. FIG. 5M-1 shows tubes 420a extending through side walls of manifolds 512s. First and second manifolds 512s-1 and 512s-2, respectively, may be in fluid communication with first and second ends, respectively, of tubes 420a. Manifolds 512s are shown with flat surfaces that contact flat end surfaces of bus bars 501s and 502s, it being understood that a gap could exist between manifolds 512s and bus bars 501s and 502s.

Liquid dielectric material such as epoxy, silicon, etc., can be added to air gaps or empty spaces between electrical conductors of SSCS 500a, including adjacent electrical conductors of naked packaged switches 247q if they are employed, to suppress dendrite growth and electrical arcing therebetween. The liquid dielectric material can be subsequently cured.

FIGS. 5M-4-5M-6 illustrate relevant components of an example SSCS 500b when seen from the front, left and right side, respectively. Manifolds 512s are shown in FIG. 5M-4 but not in FIGS. 5M-5 and 5M-6. Driver PCB 461cbb and voltage clamping circuits 514 are shown in FIGS. 5M-5 and 5M-6 but not in FIG. 5M-4.

Example SSCS 500b includes bus bars 527, 502s1 and 502s2, which may have a generally rectangular cuboid shape as shown. Example bus bars 527 may have a height, width, and length around 12 mm, 25 mm, and 90 mm, respectively. Bus bars 527, 502s1 and 502s2 may be electrically connected to three distinct devices, respectively. For example, bus bar 527 may be electrically connected to a battery terminal, bus bar 502s1 may be electrically connected to a terminal of a power converter (e.g., a three-phase inverter) while bus bar 502s2 may be electrically connected to a terminal of a battery charger.

SSCS 500b is shown with packaged switches 247q, it being understood packaged switches 247q may be swapped with packaged switches 247pK or 247dD in an alternative version. Each of the packaged switches 247q of SSCS 500b may be packaged switch 247qG, 247qI, 247qJ, or 247ql of FIGS. 3G, 3I, 3J, and 3L, respectively. All packaged switches 247 of SSCS 500b may be the same type. In an alternative embodiment, SSCS 500b may use a mix of packaged switches 247. For example, packaged switch 247q1 may be packaged switch 247qG, and packaged switch 247q2 may be packaged switch 247qI.

FIG. 5M-4 illustrates the relative positioning of packaged switches 247q, bus bar 527, and bus bars 502s to each other. Packaged switches 247q in FIG. 5M-4 have die substrate terminals 230 that may be electrically and thermally connected (e.g., soldered, sintered, press-fitted, etc.) directly or indirectly to a flat surface or respective flat surfaces of bus bar 527, and die clip terminals 344 that may be electrically and thermally connected (e.g., soldered, sintered, press-fitted, etc.) directly or indirectly to a flat surface or respective flat surfaces of bus bar 502s1 or 502s2 as shown.

SSCS 500b includes two legs a and b as shown. Leg-a includes two packaged switches 247q electrically connected in parallel between bus bars 527 and 502s2, and leg-b includes two packaged switches 247q electrically connected in parallel between bus bars 527 and 502s1. In an alternative version, leg-a may include only one packaged switch 247q, 247pK or 247dD electrically connected between bus bars 527 and 502s2, and leg-b may only include one packaged switch 247q, 247pK or 247dD electrically connected between bus bars 527 and 502s1. In still another version, leg-a may include three or more packaged switches 247q, three or more packaged switches 247pK, or three or more packaged switches 247dD positioned between and electrically connected between bus bars 527 and 502s2, and leg-b may include three or more packaged switches 247q, three or more packaged switches 247pK, or three or more packaged switches 247dD positioned between and electrically connected between bus bars 527 and 502s1. The lengths or widths of tubes 420a, bus bar 527 and bus bar 502s may be extended to accommodate legs with three or more packaged switches 247.

Voltage clamping circuits 514-1 and 514-2 may be mounted on PCB 516vcb as shown in FIGS. 5M-5 and 5M-6. Voltage clamping circuit 514-1 may be electrically connected to bus bars 527 and 502s1 via PCB traces and metal vias, and voltage clamping circuit 514-2 may be electrically connected to bus bars 527 and 502s1 via PCB traces and metal vias. Voltage clamping circuit 514-2 includes terminals 523-1 and 523-2 that may be electrically connected to bus bars 527 and 502s2, respectively, via PCB traces and metal vias. Voltage clamping circuit 514-1 includes terminals 523-1 and 523-2 that may be electrically connected to bus bars 527 and 502s1, respectively, via PCB traces and metal vias. In an alternative embodiment of SSCS 500b, voltage clamping circuit 514-2 may be mounted on driver PCB 461cbb with terminals 523-1 and 523-2 that may be electrically connected to connector-leads 288ds and 288dc, respectively, of packaged switch 247q2 of leg-a via PCB traces and metal vias, and voltage clamping circuit 514-1 may be mounted on driver PCB 461cbb with terminals 523-1 and 523-2 that may be electrically connected to connector-leads 288ds and 288dc, respectively, of packaged switch 247q1 of leg-b via PCB traces and metal vias.

FIGS. 5M-5 and 5M-6 show SSCS 500b with dielectric tubes 420a received in bus bar 527 and bus bars 502s. Tubes other than 420a can be received by the bus bars. For example, bus bars 502s can be formed by soldering metal bus bar portions around tubes 420d or 420e using a process like that described with reference to FIGS. 5A-17-6-5A-17-10. Or the bus bars can be swapped with bus bars formed around tubes like tubes 420v1 using a process like that described with reference to FIGS. 9A-34-9A-37. Bus bar 527 can be formed by soldering metal bus bar portions around tubes 420d or 420e using a process like that described with reference to FIGS. 5A-17-1-5A-17-5. Or bus bar 527 can be swapped with a bus bar formed around tubes like tubes 420v1 using a process like that described with reference to FIGS. 9A-30-9A-33.

Each leg of SSCS 500b can operate in forward mode, reverse mode or bidirectional mode. When leg-a is operating in the forward mode, leg-a can conduct some or all current IF flowing through one or both of its switches 304q. Leg-a can interrupt current flowing through it while operating in forward mode. When leg-a is operating in reverse mode, leg-a can conduct current IR3 flowing through one or both of its switches 304q. Leg-a can interrupt current IR3 flowing through it while operating in reverse mode. When leg-a is operating in the bidirectional mode, leg-a can conduct forward or reverse current through one or both its switches 304q. Leg-a can interrupt forward or reverse current while operating in bidirectional mode. When leg-a is off, all transistors in its switches 304q may be deactivated and no electrical current, other than perhaps leakage current, passes through the switches 304q. When leg-b is operating in forward mode, leg-b can conduct some or all current IF flowing through one or both of its switches 304q. Leg-b can interrupt current flowing through it while operating in forward mode. When leg-b is operating in reverse mode, leg-b can conduct current IR2 flowing through one or both of its switches 304q. Leg-b can interrupt current IR2 flowing through it while operating in reverse mode. When leg-b is operating in the bidirectional mode, leg-b can conduct forward or reverse current through one or both of its switches 304q. Leg-b can interrupt forward or reverse current while operating in bidirectional mode. When leg-b is off, all transistors in its switches 304q may be deactivated and no electrical current, other than perhaps leakage current, passes through switches 304q.

When leg-a is operating in bidirectional mode, all transistors in both of its switches 304q may be activated. When leg-a is operating in forward mode, all transistors that are controlled through connector-leads 288g1 in one or both of its switches 247q, may be activated, while all transistors that are controlled through connector-leads 288g2 in both switches 247q, may be deactivated. When leg-a is operating in reverse mode, all transistors that are controlled through connector-leads 288g1 in both switches 247q, may be deactivated, while all transistors that are controlled through connector-leads 288g2 in one or both its switches 247q, may be activated.

If leg-a uses packaged switches 247qG or 247ql (e.g., switches containing BBJTs) leg-a may operate in the forward mode when one or both connector-leads 288g1 in leg-a's packaged switches 247q1 and 247q2, respectively, is/are driven with a transistor activation current (e.g., a base current for activating the BBJT(s)), and neither connector-lead 288g2 in leg-a's packaged switches 247q1 and 247q2 is driven with a transistor activation current. Leg-a may operate in the reverse mode when neither connector-lead 288g1 in leg-a's packaged switches 247q1 and 247q2 is driven with a transistor activation current, and one or both connector-leads 288g2 in leg-a's packaged switches 247q1 and 247q2 is/are driven with a transistor activation current. If leg-b uses packaged switches 247qG or 247ql (e.g., switches containing BBJTs) leg-b may operate in the forward mode when one or both connector-leads 288g1 in leg-b's packaged switches 247q1 and 247q2, respectively, is/are driven with a transistor activation current (e.g., a base current for activating the BBJT(s)), and neither connector-lead 288g2 in leg-b's packaged switches 247q1 and 247q2 is driven with a transistor activation current. Leg-b may operate in the reverse mode when neither connector-lead 288g1 in leg-b's packaged switches 247q1 and 247q2 is driven with a transistor activation current, and one or both connector-leads 288g2 in leg-b's packaged switches 247q1 and 247q2 is/are driven with a transistor activation current.

SSCS 500b may include a driver PCB 461cbb as shown in FIGS. 5M-5 and 5M-6. Driver PCB 461cbb may include one or more drivers. PCB 461cbb may include pairs of drivers 306 that may control respective switches 304q through connector-leads 288g1 and 288g2. Drivers 306 and connector-leads 288g1 and 288g2 for switch 247q1 of leg-a are represented in FIG. 5M-6, and drivers 306 and connector-leads 288g1 and 288g2 for switch 247q2 in leg-b are represented in FIG. 5M-5. Other groups of drivers 306 may be mounted on PCB 461cbb and similarly connected to packaged switches 247q2 of leg-a and 247q1 of leg b through their connector-leads 288g1 and 288g2. PCB 461cbb in FIGS. 5M-5 and 5M-show a voltage sensor V_Sense that can sense voltage across connector-leads 288ds and 288dc (not shown) of packaged switch 247q1 of leg-a, and a voltage sensor V_Sense that can sense voltage across connector-leads 288ds and 288dc (not shown) of packaged switch 247q2 of leg-b. SSCS 500b may include bus bar connectors 465i. One end of a bus bar connector 465ib can be connected (e.g., soldered, welded, etc.) to bus bar 502s1 as shown. One end of a bus bar connector 465ia can be connected (e.g., soldered, welded, integrally formed, etc.) to bus bar 502s2 as shown. Current sensors I_Sense may be mounted on driver PCB 461cbb as shown. Bus bar connector 465ib may extend through aligned apertures of current sensor I_Sense and PCB 461cbb as shown in FIG. 5M-5. Bus bar connector 465ia may extend through aligned apertures of current sensor I_Sense and PCB 461cbb as shown in FIG. 5M-5. Current sensors I_Sense can sense current flow through respective bus bar connectors 465ib and 465ia. FIGS. 5M-5 and 5M-6 show an MCU mounted on PCB 461cbb. The MCU may be in data communication with drivers 306, current sensors I_Sense, and voltage sensors V_Sense. The MCU may generate a control signal to deactivate some or all switches 304q via their respective drivers 306 in leg-a, leg-b or both after processing current and/or voltage signals received from current sensors I_Sense and voltage sensors V-Sense, respectively. Alternatively, or in addition, the MCU may generate a control signal to activate or deactivate some or all switches 304q via the drivers 306 in response to receiving a control signal from a device external to SSCS 500b.

All tubes 420, such as tubes 420a in FIG. 5M-4, received in all bus bars may be substantially equal in length. FIG. 5M-4 shows tubes 420a extending through side walls of manifolds 512s. First and second manifolds 512s-1 and 512s-2, respectively, may be in fluid communication with first and second ends, respectively, of tubes 420a. Manifolds 512s are shown with flat surfaces that contact flat end surfaces of bus bars 527 and 502s, it being understood that a gap could exist between manifolds 512s and bus bars 527 and 502s.

Liquid dielectric material such as epoxy, silicon, etc., can be added to air gaps or empty spaces between electrical conductors of SSCS 500b, including adjacent electrical conductors of naked packaged switches 247q if they are employed, and around/between bus bars 527, 502s1, and 502s2, to suppress dendrite growth and electrical arcing therebetween. The liquid dielectric material can be subsequently cured.

FIGS. 5M-7-5M-9 illustrate relevant components of another SSCS 500c when seen from the front, left and right side, respectively. Manifolds 512s, driver PCB 461cbc, and voltage clamping circuits 514 are shown in FIGS. 5M-8 and 5M-9 but not in FIG. 5M-7.

Example SSCS 500c may include bus bars 501s and bus bars 502s as shown. Bus bars 501s and 502s may be electrically connected to two, three, or four distinct devices. For example, bus bar 501s1 and 501s2 may be electrically connected to V+ and V-terminals, respectively, of a battery, and bus bar 501s1 and 501s2 may be electrically connected to V+ and V-terminals, respectively, of a power converter such as an inverter.

SSCS 500c is shown with packaged switches 247q, it being understood packaged switches 247q may be swapped with packaged switches 247pK or 247dD in an alternative version. Each of the packaged switches 247q of SSCS 500c may be packaged switch 247qG, 247qI, 247qJ, or 247ql of FIGS. 3G, 3I, 3J, and 3L, respectively. All packaged switches 247 of SSCS 500c may be the same type. In an alternative embodiment, SSCS 500c may use a mix of packaged switches 247. For example, packaged switch 247q1 may be packaged switch 247qG, and packaged switch 247q2 may be packaged switch 247qI.

FIG. 5M-7 illustrates the relative positioning of packaged switches 247q, bus bars 501s, and bus bars 502s to each other. Packaged switches 247q in FIG. 5M-7 have die substrate terminals 230 that may be electrically and thermally connected (e.g., soldered, sintered, press-fitted, etc.) directly or indirectly to a flat surface or respective flat surfaces of a bus bar 501s as shown, and die clip terminals 344 that may be electrically and thermally connected (e.g., soldered, sintered, press-fitted, etc.) directly or indirectly to a flat surface or respective flat surfaces of a bus bar 502s as shown.

SSCS 500c includes two legs a and b as shown. Leg-a may include two packaged switches 247q that are electrically connected in parallel between bus bars 500s1 and 502s1 as shown, and leg-b may include two packaged switches 247q that are electrically connected in parallel between bus bars 501s2 and 502s2 as shown. In an alternative version, leg-a may include only one packaged switch 247q, 247pK or 247dD electrically connected between bus bars 501s1 and 502s1, and leg-b may only include one packaged switch 247q, 247pK or 247dD electrically connected between bus bars 500s2 and 502s2. In still another version, leg-a may include three or more packaged switches 247q, three or more packaged switches 247pK, or three or more packaged switches 247dD positioned between and electrically connected between bus bars 501s1 and 502s1, and leg-b may include three or more packaged switches 247q, three or more packaged switches 247pK, or three or more packaged switches 247dD positioned between and electrically connected between bus bars 501s2 and 502s2. The lengths or widths of tubes 420a, bus bars 501s and bus bar 502s may be extended to accommodate three or more packaged switches 247 in each leg.

Voltage clamping circuits 514-1 and 514-2 are mounted on PCB 516vcc. Voltage clamping circuit 514-1 may be electrically connected to bus bars 501s1 and 502s1, and voltage clamping circuit 514-2 may be electrically connected to bus bars 501s2 and 502s2. Voltage clamping circuit 514-2 includes terminals 523-1 and 523-2 that may be electrically connected to bus bars 501s2 and 502s2, respectively, via PCB traces and metal vias. Voltage clamping circuit 514-1 includes terminals 523-1 and 523-2 that may be electrically connected to bus bars 500s1 and 502s1, respectively, via PCB traces and metal vias. In an alternative embodiment of SSCS 500c, voltage clamping circuit 514-2 may be mounted on driver PCB 461cbc with terminals 523-1 and 523-2 that may electrically connected to connector-leads 288ds and 288dc, respectively, of packaged switch 247q2 of leg-a via PCB traces and metal vias, and voltage clamping circuit 514-1 may be mounted on driver PCB 461cbc with terminals 523-1 and 523-2 that are electrically connected to connector-leads 288ds and 288dc, respectively, of packaged switch 247q1 of leg-b via PCB traces and metal vias.

FIGS. 5M-8 and 5M-9 show SSCS 500c with dielectric tubes 420a received in bus bars 501s and 502s. Tubes other than 420a can be received by the bus bars. For example, bus bars 501s can be formed by soldering metal bus bar portions around tubes 420d or 420e using a process like that described with reference to FIGS. 5A-17-6-5A-17-10. And bus bars 502s can be formed by soldering metal bus bar portions around tubes 420d or 420e using a process like that described with reference to FIGS. 5A-17-6-5A-17-10. Or bus bars 501s can be swapped with bus bars formed around tubes like tubes 420v1 using a process like that described with reference to FIGS. 9A-34-9A-37. And bus bars 502s can be swapped with bus bars formed around tubes like tubes 420v1 using a process like that described with reference to FIGS. 9A-34-9A-37.

Each leg of SSCS 500c can operate in forward mode, reverse mode or bidirectional mode. When leg-a is operating in the forward mode, leg-a can conduct some or all current IF flowing through one or both of its switches 304q. Leg-a may interrupt current flowing through it while operating in the forward mode. When leg-a is operating in reverse mode, leg-a can conduct current IR2 flowing through one or both of its switches 304q. Leg-a can interrupt current IR2 flowing through it while operating in the reverse mode. When leg-a is operating in the bidirectional mode, leg-a can conduct forward or reverse current through one or both its switches 304q. Leg-a can interrupt forward or reverse current while operating in bidirectional mode. When leg-a is off, all transistors in its switches 304q may be deactivated and no electrical current, other than perhaps leakage current, passes through the switches 304q. When leg-b is operating in the forward mode, leg-b can conduct some or all current IF flowing through one or both of its switches 304q. Leg-b may interrupt current flowing through it while operating in the forward mode. When leg-b is operating in reverse mode, leg-b can conduct current IR3 flowing through one or both of its switches 304q. Leg-b can interrupt current IR3 flowing through it while operating in the reverse mode. When leg-b is operating in the bidirectional mode, leg-b can conduct forward or reverse current through one or both of its switches 304q. Leg-b can interrupt forward or reverse current while operating in bidirectional mode. When leg-b is off, all transistors in its switches 304q may be deactivated and no electrical current, other than perhaps leakage current, passes through switches 304q.

When leg-a is operating in bidirectional mode, all transistors in both of its switches 304q may be activated. When leg-a is operating in forward mode, all transistors that are controlled through connector-leads 288g1 in one or both of its switches 247q, may be activated, while all transistors that are controlled through connector-leads 288g2 in both switches 247q, may be deactivated. When leg-a is operating in reverse mode, all transistors that are controlled through connector-leads 288g1 in both switches 247q, may be deactivated, while all transistors that are controlled through connector-leads 288g2 in one or both its switches 247q, may be activated.

If leg-a uses packaged switches 247qG or 247ql (e.g., switches containing BBJTs) leg-a may operate in the forward mode when one or both connector-leads 288g1 in leg-a's packaged switches 247q1 and 247q2, respectively, is/are driven with a transistor activation current (e.g., a base current for activating the BBJT(s)), and neither connector-lead 288g2 in leg-a's packaged switches 247q1 and 247q2 is driven with a transistor activation current. Leg-a may operate in the reverse mode when neither connector-lead 288g1 in leg-a's packaged switches 247q1 and 247q2 is driven with a transistor activation current, and one or both connector-leads 288g2 in leg-a's packaged switches 247q1 and 247q2 is/are driven with a transistor activation current. If leg-b uses packaged switches 247qG or 247ql (e.g., switches containing BBJTs) leg-b may operate in the forward mode when one or both connector-leads 288g1 in leg-b's packaged switches 247q1 and 247q2, respectively, is/are driven with a transistor activation current (e.g., a base current for activating the BBJT(s)), and neither connector-lead 288g2 in leg-b's packaged switches 247q1 and 247q2 is driven with a transistor activation current. Leg-b may operate in the reverse mode when neither connector-lead 288g1 in leg-b's packaged switches 247q1 and 247q2 is driven with a transistor activation current, and one or both connector-leads 288g2 in leg-b's packaged switches 247q1 and 247q2 is/are driven with a transistor activation current.

SSCS 500c may include a driver PCB 461cbc as shown in FIGS. 5M-8 and 5M-9. Driver PCB 461cbc may include one or more drivers. In example PCB 461cbc pairs of drivers 306 may control respective switches 304q through connector-leads 288g1 and 288g2. Drivers 306 and connector-leads 288g1 and 288g2 for packaged switch 247q1 of leg-a are represented in FIG. 5M-8, and drivers 306 and connector-leads 288g1 and 288g2 for packaged switch 247q2 in leg-b are represented in FIG. 5M-9. Other groups of drivers 306 may be mounted on PCB 461cbc and similarly connected to packaged switches 247q2 of leg-a and 247q1 of leg b through their connector-leads 288g1 and 288g2. PCB 461cbc in FIGS. 5M-8 and 5M-9 may include a voltage sensor V_Sense that can sense voltage across connector-leads 288ds and 288dc (not shown) of packaged switch 247q1 of leg-a, and a voltage sensor V_Sense that can sense voltage across connector-leads 288ds and 288dc (not shown) of packaged switch 247q2 of leg-b. SSCS 500c may include bus bar connectors 465i. One end of a bus bar connector 465ib can be connected (e.g., soldered, welded, integrally formed, etc.) to bus bar 502s1 as shown. One end of a bus bar connector 465ia can be connected (e.g., soldered, welded, integrally formed, etc.) to bus bar 502s2 as shown. Current sensors I_Sense may be mounted on driver PCB 461cbc as shown. Bus bar connector 465ib may extend through aligned apertures of current sensor I_Sense and PCB 461cbc shown in FIG. 5M-9. Bus bar connector 465ia may extend through aligned apertures of current sensor I_Sense and PCB 461cbc shown in FIG. 5M-8. Current sensors I_Sense can sense current flow through respective bus bar connectors 465ib and 465ia. FIGS. 5M-8 and 5M-9 show an MCU mounted on PCB 461cbc. The MCU may be in data communication with drivers 306, current sensors I_Sense, and voltage sensors V_Sense. The MCU may generate a control signal to deactivate switches 304q in leg-a, leg-b or both after processing current and/or voltage signals received from current sensors I_Sense and voltage sensors V-Sense, respectively. Alternatively, or in addition, the MCU may generate a control signal to activate or deactivate some or all switches 304q via the drivers 306 in response to receiving a control signal from a device external to SSCS 500c.

All tubes 420, such as tubes 420a in FIG. 5M-7, received in all bus bars may be substantially equal in length. FIG. 5M-7 shows tubes 420a extending through side walls of manifolds 512s. First and second manifolds 512s-1 and 512s-2, respectively, may be in fluid communication with first and second ends, respectively, of tubes 420a. Manifolds 512s are shown with flat surfaces that contact flat end surfaces of bus bars 527 and 502s, it being understood that a gap could exist between manifolds 512s and bus bars 527 and 502s.

Liquid dielectric material such as epoxy, silicon, etc., can be added to air gaps or empty spaces between electrical conductors of SSCS 500c, including adjacent electrical conductors of naked packaged switches 247q if they are employed, and around/between bus bars 501 and 502, to suppress dendrite growth and electrical arcing therebetween. The liquid dielectric material can be subsequently cured.

An SSCS of this disclosure can interrupt AC current. FIGS. 5M-10-5M-12 illustrate relevant components of an example SSCS 500d when seen from the front, left, and right sides, respectively. Manifolds 512s and driver PCBs 461cbd are shown in FIG. 5M-10 but not in FIGS. 5M-11 and 5M-12. SSCS 500d is shown electrically connected to a three-phase AC power source (e.g., a three-phase electrical power grid) as shown. Although not shown, SSCS 500d of this disclosure may be electrically connected in parallel with a three-phase UPS, it being understood SSCS 500d should not be limited thereto.

Example SSCS 500d includes bus bars 501s and 502s as shown. Bus bars 501s may be electrically connected to respective connections ¢ of the three-phase AC power system as shown. Bus bars 502s may be electrically connected to respective terminals of one or more loads (not shown). SSCS 500d can be flipped so that bus bars 502s are electrically connected to respective connections o of the three-phase AC power system, and bus bars 501s are electrically connected to respective terminals of the one or more loads.

SSCS 500d is shown with packaged switches 247q, it being understood packaged switches 247q may be swapped with packaged switches 247pK or 247dD in an alternative version. Each of the packaged switches 247q of SSCS 500d may be packaged switch 247qG, 247qI, 247qJ, or 247ql of FIGS. 3G, 3I, 3J, and 3L respectively. All packaged switches 247 of SSCS 500d may be the same type.

FIG. 5M-10 illustrates the relative positioning of packaged switches 247q, bus bars 501s, and bus bars 502s. Packaged switches 247q in FIG. 5M-10 have die substrate terminals 230 that may be electrically and thermally connected (e.g., soldered, sintered, press-fitted, etc.) directly or indirectly to respective flat surfaces of respective bus bars 501s, and die clip terminals 344 that may be electrically and thermally connected (e.g., soldered, sintered, press-fitted, etc.) directly or indirectly to respective flat surfaces of respective bus bars 502s as shown.

Example SSCS 500d is shown with one packaged switch 247q electrically connected between each pair of bus bars 501s and 502s. In an alternative version, two or more packaged switches 247q, 247pK or 247dD may be electrically connected between each pair of bus bars 501s and 502s. Bus bars 501s and 502s can be extended in length or width to accommodate two or more packaged switches 247 connected therebetween.

FIGS. 5M-10-5M-12 show SSCS 500d with dielectric tubes 420a received in bus bars 501s and 502s. Tubes other than 420a can be received by the bus bars. For example, bus bars 501s can be formed by soldering metal bus bar portions around tubes 420d or 420e using a process like that described with reference to FIGS. 5A-17-6-5A-17-10. Likewise bus bars 502s can also be formed by soldering metal bus bar portions around tubes 420d or 420e using a process like that described with reference to FIGS. 5A-17-6-5A-17-10. Or bus bars 501s can be formed around tubes like tubes 420v1 using a process like that described with reference to FIGS. 9A-34-9A-37, and bus bars 502s can be formed around tubes like tubes 420v1 using a process like that described with reference to FIGS. 9A-34-9A-37.

SSCS 500d may have three legs a-c as shown. Each leg may include a packaged switch 247q as shown. Each leg can operate independently. When activated, each leg can transmit AC current. When a leg is activated, all transistors in the leg may be activated. When a leg is deactivated, all transistors in the leg may be deactivated and no electrical current, other than perhaps leakage current, passes through the leg.

SSCS 500d may include a driver PCB 461cbd as shown in FIGS. 5M-11 and 5M-12. Driver PCB 461cbd may include one or more mounted drivers. In example PCB 461cbd a pair of drivers may control a respective switch 304q through connector-leads 288g1 and 288g2. Drivers 306 and connector-leads 288g1 and 288g2 for packaged switch 247qa are represented in FIG. 5M-12, and drivers 306 and connector-leads 288g1 and 288g2 for packaged switch 247qc are represented in FIG. 5M-11. Another group of drivers 306 may be mounted on PCB 461cbd and similarly connected to packaged switch 247qb through connector-leads 288g1 and 288g2 (not shown). PCB 461cbd in FIGS. 5M-11 and 5M-12 may include a voltage sensor V_Sense that can sense voltage across connector-leads 288ds and 288dc (not shown) of packaged switch 247qa, and a voltage sensor V_Sense that can sense voltage across connector-leads 288ds and 288dc (not shown) of packaged switch 247qc. Another voltage sensor may be mounted on PCB 461cbd and similarly connected to sense a voltage across connector-leads 288ds and 288dc (not shown) of packaged switch 247qv. SSCS 500c may include bus bar connectors 465i. One end of a bus bar connector 465ic can be connected (e.g., soldered, welded, integrally formed, etc.) to bus bar 501sc as shown. One end of a bus bar connector 465ia can be connected (e.g., soldered, welded, integrally formed, etc.) to bus bar 501s1a as shown. One end of a bus bar connector 465ib (not shown) can be connected (e.g., soldered, welded, integrally formed, etc.) to bus bar 501s1b. Current sensors I_Sense may be mounted on driver PCB 461cbc as shown. Bus bar connector 465ic may extend through aligned apertures of current sensor I_Sense and PCB 461cbd as shown in FIG. 5M-11. Bus bar connector 465ia may extend through aligned apertures of current sensor I_Sense and PCB 461cbd as shown in FIG. 5M-12. Although not shown, bus bar connector 465ib may extend through aligned apertures of a current sensor I_Sense and PCB 461cbd. Current sensors I_Sense can sense current flow through respective bus bar connectors 465i. FIGS. 5M-11 and 5M-12 show an MCU mounted on PCB 461cbd. The MCU may be in data communication with drivers 306, current sensors I_Sense, and voltage sensors V_Sense. The MCU may generate a control signal to deactivate switches 304q in leg-a, leg-b, leg-c or any two or more combination thereof via their drivers 306 after processing current and/or voltage signals received from current sensors I_Sense and voltage sensors V-Sense, respectively. Alternatively, or in addition, the MCU may generate a control signal to activate or deactivate some or all switches 304q via the drivers 306 in response to receiving a control signal from a device external to SSCS 500d.

All tubes 420, such as tubes 420a in FIGS. 5M-10-5M-12, received in all bus bars may be substantially equal in length. FIG. 5M-10 shows tubes 420a extending through side walls of manifolds 512s. First and second manifolds 512s-1 and 512s-2, respectively, may be in fluid communication with first and second ends, respectively, of tubes 420a.

Liquid dielectric material such as epoxy, silicon, etc., can be added to air gaps or empty spaces between electrical conductors of SSCS 500d, including adjacent electrical conductors of naked packaged switches 247q if they are employed, to suppress dendrite growth and electrical arcing therebetween. The liquid dielectric material can be subsequently cured.

FIGS. 5N-1 and 5N-2 illustrate relevant components of another SSCS 510a when seen from the front and side, respectively. Manifolds 512e, driver PCB 461ga and voltage clamping circuits 514 are shown in FIG. 5N-2 but not in FIG. 5N-1.

SSCS 510a may include packaged switches 247d, it being understood that in an alternative version the packaged switches 247d may be swapped for packaged switches 247p or packaged switches 247q. All packaged switches 247 of SSCS 510a may be the same type. Each of the packaged switches 247d of SSCS 510a may be packaged switch 247dA, or 247dB of FIGS. 3A, and 3B, respectively. In an alternative embodiment, SSCS 510a may use a mix of packaged switches 247. For example, each of packaged switches 247d1 and 247d3 may be packaged switch 247dA, and each of packaged switches 247d2 and 247d4 may be packaged switch 247dB.

SSCS 510a may include bus bars 501e, 502e, and 506e, each of which may have a generally rectangular cuboid shape as shown. Example bus bars 501e, 502e, and 506e may have a height, width, and length around 12 mm, 25 mm, and 45 mm, respectively. Bus bars 501e and 502e may be electrically connected to separate devices. For example, bus bar 501e may be electrically connected to a battery terminal, and bus bar 502e may be electrically connected to the terminal of a power converter (e.g., a three-phase inverter), or bus bar 502e may be electrically connected to a battery terminal, and bus bar 501e may be electrically connected to a terminal of the power converter.

FIG. 5N-1 illustrates the relative positioning of packaged switches 247d, bus bar 506e, bus bar 501e, and bus bar 502e. Packaged switches 247d1 and 247d2 have die substrate terminals 230 that may be electrically and thermally connected (e.g., soldered, sintered, press-fitted, etc.) directly or indirectly to a flat surface or respective flat surfaces of bus bar 501e, and die clip terminals 344 that may be electrically and thermally connected (e.g., soldered, sintered, press-fitted, etc.) directly or indirectly to a flat surface or respective flat surfaces of bus bar 506e. Packaged switches 247d3 and 247d4 have die clip terminals 344 that may be electrically and thermally connected (e.g., soldered, sintered, press-fitted, etc.) directly or indirectly to a flat surface or respective flat surfaces of bus bar 506e, and die substrate terminals 230 that may be electrically and thermally connected (e.g., soldered, sintered, press-fitted, etc.) directly or indirectly to a flat surface or respective flat surfaces of bus bar 502e.

In an alternative embodiment, packaged switches 247d3 and 247d4 in FIGS. 5N-1 and 5N-2 may be flipped so that their die clip terminals 344 are electrically and thermally connected (e.g., soldered, sintered, press-fitted, etc.) directly or indirectly to a flat surface or respective flat surfaces of bus bar 502e, and their die substrate terminals 230 are be electrically and thermally connected (e.g., soldered, sintered, press-fitted, etc.) directly or indirectly to a flat surface or respective flat surfaces of bus bar 506e. Voltage clamping circuit 514-2 may also be flipped in this alternative so that its terminals 523-1 and 523-2 are electrically connected to bus bars 506e and 502e, respectively. This alternative circuit breaker 510a may lack the ability to interrupt current IR.

Example SSCS 510a is shown in FIG. 5N-1 with two packaged switches 247d electrically connected in parallel between bus bars 501e and 506e, and two packaged switches 247d electrically connected in parallel between bus bars 506e and 502e. In an alternative version, SSCS 510a may include only one packaged switch 247d electrically connected between bus bars 501e and 506e, and only one packaged switch 247d electrically connected between bus bars 506e and 502e. In still another version, three or more packaged switches 247d can be electrically connected between width and/or length extended bus bars 501e and 506e, and three or more packaged switches 247d can be electrically connected between bus bars 506e and 502e. The lengths or widths of bus bar 501e, bus bar 506e, bus bar 502e and tubes 420a, may be extended to accommodate three or more packaged switches 247.

One or more voltage clamping circuits 514 may be electrically connected between bus bars 501e and 506e, and one or more voltage clamping circuits may be electrically connected between bus bars 502e and 506e. FIG. 5N-2 shows two voltage clamping circuits 514, the first of which is electrically connected between bus bars 501e and 506e, while the second is electrically connected between bus bars 502e and 506e. In an alternative embodiment, one or more voltage clamping circuits 514 may be electrically connected between bus bars 501e and 502e, with or without the voltage clamping circuits 514 shown in FIG. 5N-2.

Voltage clamping circuit 514-1 may be mounted on PCB 516ga with terminals 523-1 and 523-2 electrically connected to bus bars 501e and 506e, respectively, via traces and vias, and voltage clamping circuit 514-2 may be mounted on PCB 516ga with terminals 523-2 and 523-1 electrically connected to bus bars 506e and 502e, respectively, via traces and vias. In an alternative embodiment of SSCS 510a, voltage clamping circuit 514-1 may be mounted on driver PCB 461 ga with terminals 523-1 and 523-2 electrically connected to connector-leads 288ds and 288dc, respectively, of one or both packaged switches 247d1 and 247d2 via traces and vias, and voltage clamping circuit 514-2 may be mounted on driver PCB 461 ga with terminals 523-2 and 523-1 electrically connected to connector-leads 288dc and 288ds, respectively, of one or both packaged switches 247d3 and 247d4 via traces and vias.

FIGS. 5N-1 and 5N-2 show SSCS 510a with dielectric tubes 420a received by the bus bars. Tubes other than 420a can be received by the bus bars. For example, each of bus bars 501e, 502e, and 506e can be formed by soldering metal bus bar portions around tubes 420d or 420e using a process like that described with reference to FIGS. 5A-17-1-5A-17-5. Or each bus bar 501e, 506e and 502e can be swapped with bus bars formed around tubes like tubes 420v1 using a process like that described with reference to FIGS. 9A-30-9A-33.

SSCS 510a can operate in forward, reverse mode, or bidirectional mode. When SSCS 510a is operating in the forward mode, SSCS 510a can pass forward current IF through activated switches 304d of packaged switches 247d1 and/or 247d2 and deactivated switches 304d of packaged switches 247d3 and 247d4 via their diodes (see, e.g., diode D of FIG. 3A, body diodes inherent in the MOSFETs of FIG. 3B, etc.). SSCS 510a may interrupt forward current IF while it is operating in the forward mode. FIG. 5N-2 shows SSCS 510a operating in forward mode. When SSCS 510a is operating in the reverse mode, SSCS 510a can pass reverse current IR through activated switches 304d of packaged switches 247d3 and/or 247d4 and deactivated switches 304d of packaged switches 247d1 and 247d2 via their diodes (see, e.g., diode D of FIG. 3A, body diodes inherent in the MOSFETs of FIG. 3B, etc.). SSCS 510a can interrupt reverse current IR while operating in the reverse mode. When SSCS 510a is operating in bidirectional mode, SSCS 510a can conduct IF or IR through activated switches 304d of packaged switches 247d1 and/or 247d2 and activated switches 304d of packaged switches 247d3 and/or 247d4. SSCS 510a can interrupt IR or IF while operating in bidirectional mode. When SSCS 510a is off, all transistors in switches 304d may be deactivated and no current, other than perhaps leakage current, passes through SSCS 510a.

In the forward mode, one or more transistors in packaged switches 247d1 and 247d2 may be activated, while all transistors in packaged switches 247d3 and 247d4 may be deactivated. In the reverse mode, one or more transistors in packaged switches 247d3 and 247d4 may be activated, while all transistors in packaged switches 247d1 and 247d2 may be deactivated. In bidirectional mode, all transistors in packaged switches 247d1-247d4 may be activated.

SSCS 510a may include driver PCB 461ga. Drivers on PCB 461ga may control respective switches 304 through their connector-leads 288g. Only drivers 306 and connector-leads 288g for switches 247d1 and 247d3 are represented in FIG. 5N-2. PCB 461ga in FIG. 5N-2 may include two voltage sensors V_Sense that can sense voltages across respective packaged switches 247d1 and 247d3 through their respective sets of connector-leads 288ds and 288dc (not shown). A voltage sensor V_Sense can measure or sense voltage and generate a signal with a magnitude that is proportional thereto or dependent thereon. FIG. 5N-2 shows drivers 306 and respective PMICs for packaged switches 247d1 and 247d3. Similar groups of drivers 306 and PMICs may be mounted on PCB 461ga for packaged switches 247d2 and 247d4. A current sensor I_Sense may be mounted on driver PCB 461ga. One end of a bus bar connector 465i can be connected (e.g., soldered, welded, integrally formed, etc.) to bus bar 501e as shown. The other end of bus bar connector 465i may extend through aligned apertures of current sensor I_Sense and PCB 461ga. A current sensor I_Sense can measure or sense current flow through a bus bar connector, like bus bar connector 465i, and generate a signal with a magnitude that is proportional thereto or dependent thereon. FIG. 5N-2 shows an MCU mounted on PCB 462cb2. The MCU may be in data communication with drivers 306, I_Sense, and voltage sensors V_Sense. An MCU, like the MCU mounted on driver PCB 461ga, may control (e.g., deactivate) switches 304, like switches 304d of SSCS 510a, via their drivers 306 in response to processing current and/or voltage signals received from I_Sense and V-Sense, respectively. Alternatively, or in addition, the MCU may generate a control signal to activate or deactivate some or all switches 304d via the drivers 306 in response to receiving a control signal from a device external to SSCS 510a.

In another alternative embodiment of SSCS 510a, packaged switch 247d3, packaged switch 247d4, bus bar 502e, voltage clamping circuit 514-2, drivers 306 for controlling packaged switches 247d3 and 247d4, PMICs for supporting those drivers 306, and voltage sensor V_Sense for sensing voltage across connector-leads 288ds and 288dc of packaged switches 247d3 and 247d4, can be eliminated. In this other alternative embodiment, bus bars 501e and 506e may be electrically connected to, for example, a DC power supply and an inverter, respectively. This other alternative circuit breaker 510a may lack the ability to interrupt current IR. However, this other alternative circuit breaker may be able to withstand high voltages between bus bars 501e and 502e when the circuit breaker is deactivated. Should we show that the 502e circuit breaker between 506e is used for since it needs to show the benefit with operation of not just the high side?”

All tubes 420, such as tubes 420a in FIG. 5N-1, received in all bus bars may be substantially equal in length. First and second manifolds 512e-1 and 512e-2, respectively, may be in fluid communication with first and second ends, respectively, of tubes 420a as shown. Manifolds 512e are shown with a gap between their flat surfaces and bus bars 501e, 506e, and 502e, it being understood no gap exists between manifolds 512e and bus bars 501e, 506e, and 502e.

Liquid dielectric material such as epoxy, silicon, etc., can be added to air gaps or empty spaces between electrical conductors of SSCS 510a, including adjacent electrical conductors of naked packaged switches 247 if employed, and then cured to create structures that suppress dendrite growth and electrical arcing therebetween.

FIGS. 5N-3-5N-5 illustrate relevant components of an example SSCS 510b when seen from the front, left, and right sides, respectively. Driver PCBs 461gb is shown in FIGS. 5N-4 and 5N-5 but not in FIG. 5N-3. SSCS 510b is shown electrically connected to a three-phase AC power source as shown. Although not shown, SSCS 510b of this disclosure may be electrically connected in parallel with a three-phase UPS, it being understood SSCS 510b should not be limited thereto.

Example SSCS 510b includes bus bars 501e, bus bars 506e and bus bars 502e. Bus bars 501e are shown electrically connected to respective connections o of the three-phase AC power system. Bus bars 502e may be electrically connected to respective terminals of one or more loads (not shown). SSCS 510b can be flipped so that bus bars 502e are electrically connected to respective connections o of the three-phase AC power system, and bus bars 501e are electrically connected to respective terminals of the one or more loads.

SSCS 510b may include packaged switches 247d, it being understood that in an alternative the packaged switches 247d may be swapped for packaged switches 247p or packaged switches 247q. All packaged switches 247 of SSCS 510b may be the same type. Each of the packaged switches 247d of SSCS 510b may be packaged switch 247dA, or 247dB of FIGS. 3A, and 3B, respectively. In an alternative embodiment, SSCS 510b may use a mix of packaged switches 247. For example, each of packaged switches 247d1 and 247d3 may be packaged switch 247dA, and each of packaged switches 247d2 and 247d4 may be packaged switch 247dB.

FIG. 5N-3 illustrates the relative positioning of packaged switches 247q, bus bars 501e, bus bars 506e, bus bars 502e. Each pair of packaged switches 247d1 and 247d2 have die substrate terminals 230 that may be electrically and thermally connected (e.g., soldered, sintered, press-fitted, etc.) directly or indirectly to a flat surface or respective flat surfaces of a respective bus bar 501e, and die clip terminals 344 that may be electrically and thermally connected (e.g., soldered, sintered, press-fitted, etc.) directly or indirectly to a flat surface or respective flat surfaces of a respective bus bar 506e. Each pair of packaged switches 247d3 and 247d4 have die clip terminals 344 that may be electrically and thermally connected (e.g., soldered, sintered, press-fitted, etc.) directly or indirectly to a flat surface or respective flat surfaces of a respective bus bar 506e, and die substrate terminals 230 that may be electrically and thermally connected (e.g., soldered, sintered, press-fitted, etc.) directly or indirectly to a flat surface or respective flat surfaces of a respective bus bar 502e.

Example SSCS 510b is shown with two packaged switches 247d electrically connected between each pair of bus bars 501e and 506e, and two packaged switches 247d electrically connected between each pair of bus bars 506e and 502e. In an alternative version, one or more than two packaged switch 247d, 247q or 247pK may be electrically connected between each pair of bus bars 501e and 502e, and one or more than two packaged switch 247d, 247q or 247pK may be electrically connected between each pair of bus bars 506e and 502e. Bus bars 501e, 506e, and 502e may be extended in length or width to accommodate the three or more packaged switches 247.

FIGS. 5N-3-5N-5 show SSCS 510b with dielectric tubes 420a received in bus bars 501e, 506e, 502e. Tubes other than 420a can be received by the bus bars. For example, bus bars 501e can be formed by soldering metal bus bar portions around tubes 420d or 420e using a process like that described with reference to FIGS. 5A-17-6-5A-17-10, bus bars 502e can also be formed by soldering metal bus bar portions around tubes 420d or 420e using a process like that described with reference to FIGS. 5A-17-6-5A-17-10, and bus bars 506e can be formed by soldering metal bus bar portions around tubes 420d or 420e using a process like that described with reference to FIGS. 5A-17-6-5A-17-10. Or bus bars 501e can be formed around tubes like tubes 420v1 using a process like that described with reference to FIGS. 9A-34-9A-37, bus bars 502e can be formed around tubes like tubes 420v1 using a process like that described with reference to FIGS. 9A-34-9A-37, and bus bars 506e can be formed around tubes like tubes 420v 1 using a process like that described with reference to FIGS. 9A-34-9A-37.

SSCS 500d may have three legs a-c as shown. Each leg may include packaged switches 247d1-247d4 as shown. Each leg can operate independently. When activated, each leg can transmit AC current. When a leg is activated, all transistors in packaged switches 247d1-247d4 of the leg may be activated. When a leg is deactivated, all transistors in packaged switches 247d1-247d4 of the leg may be deactivated and no electrical current, other than perhaps leakage current, passes through the leg.

FIGS. 5N-3 and 5N-4 show side views of SSCS 510b. SSCS 510b may include driver PCB 461gb that may include mounted drivers for controlling respective switches 304d via respective connector-leads 288. Driver PCB 461gb may include drivers 306 electrically connected to a respective connector-leads 288g via PCB traces. Only drivers 306 and connector-leads 288g for packaged switches 247d2c and 247d4c are represented in FIGS. 5N-4, and only drivers 306 and connector-leads 288g for packaged switches 247d1a and 247d3a are represented in 5N-5. Additional drivers 306 may be mounted on driver PCB 461gb (not shown) and similarly connected to connector-leads 288g of packaged switches 247d2a, 247d4a, 247d1c, 247d3c, and 247d1b-247d4b, respectively. SSCS 510b may include bus bar connectors 465i. One end of a bus bar connector 465ic can be connected (e.g., soldered, welded, integrally formed, etc.) to bus bar 501ec as shown. One end of a bus bar connector 465ia can be connected (e.g., soldered, welded, integrally formed, etc.) to bus bar 501ea as shown. One end of a bus bar connector 465ib (not shown) can be connected (e.g., soldered, welded, integrally formed, etc.) to bus bar 501eb. Current sensors I_Sense may be mounted on driver PCB 461gb as shown. Bus bar connector 465ic may extend through aligned apertures of current sensor I_Sense and PCB 461gb as shown in FIG. 5N-4. Bus bar connector 465ia may extend through aligned apertures of current sensor I_Sense and PCB 461gb as shown in FIG. 5N-5. Although not shown, bus bar connector 465ib may extend through aligned apertures of a current sensor I_Sense and PCB 461gb. Current sensors I_Sense can sense current flow through respective bus bar connectors 465i. FIGS. 5N-4 and 5N-5 show an MCU mounted on PCB 461gb. The MCU may be in data communication with drivers 306, current sensors I_Sense, and voltage sensors V_Sense. The MCU may generate a control signal to deactivate switches 304d in leg-a, leg-b, leg-c or any two or more combination thereof after processing current and/or voltage signals received from current sensors I_Sense and voltage sensors V-Sense, respectively. Alternatively, or in addition, the MCU may generate a control signal to activate or deactivate some or all switches 304d via the drivers 306 in response to receiving a control signal from a device external to SSCS 510b.

Although not shown, all tubes 420, such as tubes 420a in FIGS. 5N-3-5N-5, received in all bus bars may be substantially equal in length. Although not shown all tubes 420a may extend through side walls of manifolds of first and second manifolds 512e-1 and 512e-2.

Liquid dielectric material such as epoxy, silicon, etc., can be added to air gaps or empty spaces between electrical conductors of SSCS 510b, including adjacent electrical conductors of naked packaged switches 247d if they are employed, to suppress dendrite growth and electrical arcing therebetween. The liquid dielectric material can be subsequently cured.

Power converters may include one, two, three, four, five, six or more legs. FIGS. 5I-1-5I-4 show relevant components of a converter 460vfd with six legs. FIGS. 5I-1-5I-4 illustrate converter 460vfd when seen from the front, back, side, and top respectively. Converter 460vfd may integrate a bidirectional three-phase inverter with a bidirectional three-phase rectifier through common V+ and V− bus bars.

Converter 460vfd is shown with two portions designated inverter and rectifier. FIGS. 5I-1 and 5I-2 show the inverter and rectifier portions, respectively. The inverter and rectifier portions share V+ and V− bus bars 417vfd and 412vfd, respectively. Each inverter and rectifier portion has three legs designated a-c. FIG. 5I-3 shows leg-c of the inverter and rectifier portions. Several components (e.g., driver PCB 461vfdr, driver PCB 461vfdi, control PCB 462vfd, capacitors 403vfd) are not shown or fully shown in FIGS. 5I-1 and 5I-2 but may be seen in FIG. 5I-3 or 5I-4. Control PCB 462vfd is omitted from FIG. 5I-4.

Converter 460vfd employs packaged switches 247d, each of which may be packaged switch 247dA, 247dB, or 247dD of FIGS. 3A, 3B, and 3D respectively. Alternatively, packaged switches 247d of converter 460vfd may be replaced with packaged switches 247p or packaged switches 247q.

As seen in FIGS. 5I-1 and 51-2, each leg of the inverter and rectifier portions include packaged switches 247dH and 247dL. Each of the switches 304 in packaged switches 247 of converter 460vfd can be independently controlled by an MCU on control PCB 462vfd. Each group of one or more transistors in each switch 247q or 247p, which is electrically connected to a respective connector-lead 288, can be independently controlled by the MCU or other data processing device.

Converter 460vfd may include V+ bus bar 417vfd, V− bus bar 412vfd, inverter phase bus bars 418vfdi, and rectifier phase bus bars 418vfdr as shown. FIGS. 5I-1-51-4 illustrate the vertical and horizontal positioning of packaged switches 247d, V+ bus bar 417vfd, V− bus bar 412vfd, inverter phase bus bars 418vfdi, and rectifier phase bus bars 418vfdr with respect to each other. Inverter phase bus bars 418vfdia-418vfdic may be electrically connected to windings Wa-Wc, respectively, as shown. Rectifier phase bus bars 418vfdra-418vfdrc may be electrically connected to AC power sources φa-φc, respectively, via inductors La-Lc, respectively, as shown. In an alternative embodiment, phase bus bars 418vfdra-418vfdrc may be electrically connected to respective stator windings of a motor or generator.

V+ bus bar 417vfd, V− bus bar 412vfd, inverter phase bus bars 418vfdi, and rectifier phase bus bars 418vfdr may have a generally rectangular cuboid shape as shown. Each of the example inverter and rectifier phase bus bars 418vfdi and 418vfdr, respectively, may have a height, width, and length around 8 mm, 25 mm, and 20 mm, respectively. Example V+ bus bar 417vfd and V− bus bar 412vfd may have a height, width, and length around 8 mm, 55 mm, and 70 mm, respectively. FIG. 5I-3 shows the height and width of the bus bars. FIG. 5I-4 shows the length and width of V+ bus bar 417vfd. The lengths of V+ bus bar 417vfd, V− bus bar 412vfd, and tubes 420a, could be extended to increase the distance between adjacent bus bar-leads 465, which in turn can accommodate wider capacitors 403vfd therebetween.

With continuing reference to FIGS. 5I-1 and 5I-2, packaged switches 247dHi and 247dHr in each leg may have die substrate terminals 230 that may be electrically and thermally connected (e.g., soldered, sintered, press-fitted, etc.) directly or indirectly to a flat surface or respective flat surfaces of V+ bus bar 417vfd. Packaged switches 247dHi in each leg of the inverter portion may have die clip terminals 344 that may be electrically and thermally connected (e.g., soldered, sintered, press-fitted, etc.) directly or indirectly to a flat surface of a respective inverter phase bus bar 418vfdi. Packaged switches 247dHr in each leg of the rectifier portion may have die clip terminals 344 that may be electrically and thermally connected (e.g., soldered, sintered, press-fitted, etc.) directly or indirectly to a flat surface of a respective rectifier phase bus bar 418vfdr. Packaged switches 247dLi and 247dLr in each leg may have die clip terminals 344 that may be electrically and thermally connected (e.g., soldered, sintered, press-fitted, etc.) directly or indirectly to a flat surface or respective flat surfaces of V− bus bar 412vfd. Packaged switches 247dLi in each leg of the inverter portion may have die substrate terminals 230 that may be electrically and thermally connected (e.g., soldered, sintered, press-fitted, etc.) directly or indirectly to a flat surface of a respective inverter phase bus bar 418vfdi. Packaged switches 247dLr in each leg of the rectifier portion may have die substrate terminals 230 that may be electrically and thermally connected (e.g., soldered, sintered, press-fitted, etc.) directly or indirectly to a flat surface of a respective rectifier phase bus bar 418vfdr.

FIG. 5I-1 includes electrical current symbols that represent electrical current flow through the inverter portion of 460vfd at an instant in time. More particularly, FIG. 5I-1 shows electrical current flow through activated switch 304dHi in packaged switch 247dHi of leg-a, while switches 304dLi in packages 247dLi of legs b and c may be activated and conducting current to the V-terminal through the V− bus bar 412vdr. All other switches 304 of the inverter portion may be deactivated.

FIGS. 5I-1-5I-3 show converter 460vfd with dielectric tubes 420a received by bus bars. Tubes other than 420a can be received by the bus bars. For example, each of bus bars 412vfd and 417vfd can be formed by soldering metal bus bar portions around tubes 420d or 420e using a process like that described with reference to FIGS. 5A-17-1-5A-17-5, bus bars 418vfdr can be formed by soldering metal bus bar portions around tubes 420g using a process like that described with reference to FIGS. 5A-17-6-5A-17-10, and bus bars 418vfdi can be formed by soldering metal bus bar portions around tubes 420g using a process like that described with reference to FIGS. 5A-17-6-5A-17-10. Or the bus bars can be swapped with bus bars formed around tubes like tubes 420v1 using a process like that described with reference to FIGS. 9A-30-9A-33 or FIGS. 9A-34-9A-37.

With continuing reference to FIGS. 5I-3 and 5I-4, converter 460vfd may include DC link capacitors 403vfdi and 403vfdr. First and second metal capacitor-leads 405avfdr and 405bvfdr may extend from each capacitor 403vfdr. First and second metal capacitor-leads 405avfdi and 405bvfdi may extend from each capacitor 403vfdi. Example capacitor-leads 405avfdr, 405bvfdr, 405avfdi, and 405bvfdi may have a height, length, and width around 6 mm, 25 mm, and 20 mm, respectively. The lengths of leads 405vfd in FIGS. 5I-3 and 5I-4 are exaggerated to enable better understanding. A substantial portion (e.g., 10, 20, 50, 75, 90% or more) of each of capacitor-lead 405avfdi and 405avfdr's flat bottom surface area may be electrically and thermally connected (e.g., welded, soldered, press-fitted by screws or other fasteners, etc.) directly to a flat surface of V+ bus bar 417vfd, and a substantial portion (e.g., 10, 20, 50, 75, 90% or more) of each capacitor-lead 405bvfdi and 405bvfdr's flat top surface area may be electrically and thermally connected (e.g., welded, soldered, press-fitted by screws or other fasteners, etc.) directly to a flat surface of V− bus bar 412vfd.

FIG. 5I-5 is top view of converter 460vfd, but with capacitors 403 rotated 90 degrees. Although not shown in FIG. 5I-5, a substantial portion of each capacitor-lead 405avfd's flat bottom surface area may be electrically and thermally connected directly to a flat surface of V+ bus bar 417vfd, and a substantial portion of each capacitor-lead 405bvfd's flat top surface area may be electrically and thermally connected directly to a flat surface of V− bus bar 412vfd. FIG. 5I-5 shows the ends of tubes 420a with hidden lines. Although not clearly shown in FIG. 5I-5, ends of tubes 420a are positioned between capacitor-leads 405avfd and 405bvfd. Capacitor-leads 405avfd and 405bvfd may need to be longer when rotated and electrically connected to the bus bars, to provide space adjacent the bus bars for manifolds (not shown) that are fluidly connected to ends of tubes 420a.

Converter 460vfd may include driver PCBs 461vfdi and 461vfdr with drivers 306 that control respective switches 304 through transistor control signals transmitted via respective connector-leads 288g. FIG. 5I-3 shows drivers 306 and connector-leads 288g only for leg-c of the rectifier and inverter portions. FIG. 5I-4 shows connector-leads 288 for packaged switches 247dH, but most of the connector-leads 288dsH and 288dcH are positioned beneath capacitor-leads 405avfd and shown with hidden lines.

Each of driver PCBs 461vfdi and 461vfdr may include RCD snubber circuits that are connected in parallel with respective switches 304 through respective sets of connector-leads 288ds and 288dc.

Converter 460vfd may include a control PCB 462vfd with an MCU that may be in data communication with drivers 306, current sensors I_Sense, voltage sensors V_Sense, or other components mounted on driver PCBs 461vfdi and 461vfdr, via data connections 484-1 and 484-2, respectively.

Converters, including converter 460vfd, may include bus bar-leads that extend laterally between first and second ends. The first end may be electrically connected (e.g., welded) to a bus bar. The second end may be electrically connected (e.g., welded) to a terminal of a device such as an inductor, capacitor, another bus bar-lead, etc. FIGS. 5I-3 and 5I-4 shows example phase bus bar-leads 465. The bus bar-leads 465 are connected to respective terminals of inductors La-Lc and windings Wa-Wc. FIG. 5I-4 shows the relative positioning of components with respect to each other, including the horizontal positioning of capacitors 403vfd between phase bus bar-leads 465.

FIG. 5I-3 shows PCB 461vfdi with drivers 306 that can send transistor control signals to respective switches 304dHi and 304dLi of leg-c through respective connector-leads 288g. Although not shown in FIG. 5I-3, driver PCB 461vfdi may also include drivers 306 that can similarly send transistor control signals to respective packaged switches 304dHi and 304dLi in legs a and b. Driver PCB 461vfdi may also include voltage sensors V_Sense that can monitor voltages across respective packaged switches 247dHi and 247dLi via respective pairs or connector-leads 288ds and 288dc.

Example phase bus bar-lead 465ci may extend laterally between first and second ends as shown in FIG. 5I-3. The first end of phase bus bar-lead 465ci may be electrically connected to phase bus bar 418vfdic, and the second end may be electrically connected to winding Wc. Phase bus bar-lead 465ci may extend through an aperture in PCB 461vfdi. Current sensor I_Sense-I can measure electrical current flowing through phase bus bar-lead 465ci. I_Sense-I may include an aperture through which phase bus bar-lead 465ci may extend. FIG. 5I-3 shows voltage sensors V_Sense, PMICs, current sensor I_Sense, and a phase bus bar-lead 465ci for leg-c of the inverter portion. Similar groups voltage sensors V_Sense, PMICs, current sensor I_Sense, and phase bus bar-leads may be mounted on or extending through PCB 461vfdi for legs a and b of the inverter portion.

FIG. 5I-3 shows driver PCB 461vfdr may include drivers 306 that can send transistor control signals to respective switches 304dHr and 304dLr of leg-c of the rectifier portion through respective connector-leads 288g. Driver PCB 462vfdr also may include drivers that can similarly send transistor control signals to respective switches 304dHr and 304dLr in legs a and b. Driver PCB 461vfdr may also include voltage sensors V_Sense that can sense voltages between respective pairs of connector-leads 288ds and 288dc (not shown in FIG. 5I-3).

Example phase bus bar-lead 465cr may extend laterally between first and second ends as shown in FIG. 5I-3. The first end of phase bus bar-lead 465cr may be electrically connected to phase bus bar 418vfdrc, and the second end may be electrically connected to inductor Lc. Phase bus bar-lead 465cr may extend through an aperture in PCB 461vfdr. Current sensor I_Sense-R measures electrical current flowing through phase bus bar-lead 465cr. I_Sense-R may include an aperture through which phase bus bar-lead 465cr may extend. FIG. 5I-3 shows voltage sensors V_Sense, PMICs, current sensor I_Sense, and a phase bus bar-lead 465cr for leg-c of the rectifier portion. Similar groups voltage sensors V_Sense, PMICs, current sensor I_Sense, and phase bus bar-lead 465r may be mounted on or extending through PCB 461vfdr for legs a and b of the rectifier portion.

Converter 460vfd may include one or more ceramic DC link capacitors (e.g., multilayer ceramic capacitors, not shown) with first and second metal terminals that may be electrically connected directly or indirectly to flat surfaces V+ bus bar 417vfd and V− bus bar 412vfd, respectively. These ceramic DC link capacitors may be mounted on driver PCBs 461vfdr and 461vfdi and connected in parallel, the combination of which is connected in series between V+ bus bar 417vfd and V− bus bar 412vfd. Ceramic DC link capacitors mounted on driver PCB 461vfdr may be connected between V+ bus bar 417vfd and V− bus bar 412vfd via PCB 461vfdr traces, connector-leads 288ds of the high-side packaged switches 247dHr, and connector-leads 288dc of the low-side packaged switches 247dLr. Ceramic DC link capacitors mounted on driver PCB 461vfdi may be connected between V+ bus bar 417vfd and V− bus bar 412vfd via PCB 461vfdi traces, connector-leads 288ds of the high-side packaged switches 247dHi, and connector-leads 288dc of the low-side packaged switches 247dLi.

All tubes 420a in a bus bar, such as bus bar 412vdr, may be substantially equal in length. Each tube 420a has first and second ends. The first ends of all tubes 420a may be in fluid communication with a first manifold, while the second ends of all the tubes 420a may be in fluid communication with a second manifold.

Liquid dielectric material such as epoxy, silicon, etc., can be added to air gaps or empty spaces between electrical conductors of converter 460vfd, including adjacent electrical conductors of naked packaged switches 247 if employed, and then cured to create structures that suppress dendrite growth and electrical arcing therebetween.

Converter 460vfd may be configured to drive windings Wa-Wc of a three-phase electric motor of, for example, an industrial pump using three phase power provided by AC sources φa-φc. With modifications, converter 460vfd can be used for other applications. For example, converter 460vfd can be used as an inverter for converting DC power provided by a DC voltage source such as a battery, into three-phase AC power for driving an electric motor. V+ bus bar 417vfd and V− bus bar 412vfd can be connected directly or indirectly to positive and negative terminals, respectively, of a battery (not shown). All phase bus bars 418vfd may be coupled to windings W of a stator. The six phase bus bars 418vfd can be electrically connected to respective terminals of six stator windings that are wye (i.e., star) connected at one neutral point. Or three of six phase bus bars 418vfd may be electrically connected to respective terminals of a first group of three windings in a stator that are wye connected to a first neutral point, while the other three phase bus bars 418vfd may be electrically connected to respective terminals of a second group of three windings in the stator that are wye connected to a separate neutral point. FIG. 5I-6A illustrates example an example of three windings of a stator connected in a wye configuration to a neutral point N. In another embodiment, three of six phase bus bars 418vfd may be electrically connected to respective terminals of three, wye connected windings in a stator, while the other three phase bus bars 418vfd may be electrically connected to respective terminals of three, delta connected windings in the stator. FIG. 5I-6A illustrates an example of three windings of a stator connected in a delta configuration. A stator may have windings, which are open ended. FIG. 5I-6A illustrates an example of three windings of a stator with open ended terminals. Three of six phase bus bars 418vfd may be electrically connected to terminals t1-t3, respectively, of the open ended windings shown in FIG. 5I-6A, while the other three phase bus bars 418vfd may be electrically connected to terminals t4-t6, respectively, of the open ended windings. Instructions executing on the MCU of 460vfd may be updated to a different control algorithm.

As noted above, each of driver PCBs 461vfdi and 461vfdr may include RCD snubber circuits that are connected in parallel with respective switches 304 through respective sets of connector-leads 288ds and 288dc. RCD snubber circuits can be replaced by PSSS circuits. FIGS. 5I-6F and 51-6B show front and back views of an alternative-driver PCB 461vfdai that includes a PSSS circuit. Driver PCB 461vfdi of converter 460vfd can be replaced with the alternative-driver PCB 461vfdai. Driver PCB 461vfdr can be replaced with a driver PCB like alternative-driver PCB 461vfdai.

With continuing reference to FIGS. 5I-1, 5I-2, and 5I-4, FIG. 5I-6F shows an alternative-driver PCB 461vfdai that includes snubber capacitors 433s, recovery capacitors 433r, transformer 451, snubber diodes 425, traces (e.g., traces 438f, 448f, etc.), recovery diodes 427, etc.

Recovery capacitors 433r may take form in ceramic capacitors, it being understood that other types of recovery capacitors, including film or electrolytic capacitors, can be used in the alternative. Each of the recovery capacitors 433r includes first and second metal-terminals 437-1 and 437-2, respectively, which may be electrically and thermally connected to first and second electrical conductors, respectively, inside the capacitor's dielectric case or package.

With continuing reference to FIGS. 5I-6F and 5I-6B, alternative-driver PCB 461vfdai includes six groups of apertures 464c, 464g, and 464s as shown. Each aperture 464c, 464g, and 464s in a group is configured to receive connector-leads 288dc, 288g, and 288ds, respectively, of a respective packaged switch 247d. Apertures 464 may have substantially the same size and shape as the cross-section of connector-leads 288 they receive.

Alternative-driver PCB 461vfdai also includes apertures 463a-463c configured to receive phase bus bar-leads 465ai-465ci, respectively. Apertures 463 may have substantially the same size and shape as the cross-section of phase bus bar-leads 465 they receive. Alternative-driver PCB 461vfdai includes current sensors I_Sense-I as shown in FIG. 5I-6F, each of which may include an aperture configured to receive a respective bus bar-lead 465c. Apertures of current sensors I_Sense-I may have substantially the same size and shape as the cross-section of phase bus bar-leads 465 they receive. Apertures 463a-463c may align with respective apertures of current sensors I_Sense-I as shown in FIG. 5I-6F.

Anodes and cathodes of a first group of snubber diodes 425 may be electrically connected (e.g., soldered) to PCB traces 438f and 448f, respectively. Anodes and cathodes of a second group of snubber diodes 425 may be electrically connected (e.g., soldered) to traces 449f and 439f, respectively. The anode and cathode of recovery diode 427H may be electrically connected (e.g., soldered) respectively to PCB traces 448f and 415-1, respectively. The anode and cathode of recovery diode 427L may be electrically connected (e.g., soldered) to PCB traces 415-2 and 449f, respectively. Diodes are shown symbolically.

First and second transformer-leads 414-1 and 414-2, respectively, of transformer 451 may be electrically connected (e.g., soldered) to traces 415-1 and 415-2, respectively. Third and fourth transformer-leads 414-3 and 414-4, respectively, of transformer 451 may be electrically connected (e.g., soldered) to traces 438f and 439f, respectively. Transformer 451 and transformer-leads 415 are shown symbolically in FIG. 5I-6F.

First terminals 437-1H of snubber capacitors 433sH-a-433sH-c, may be electrically connected (e.g., soldered) to PCB trace 448f, and second terminals 437-2L of snubber capacitors 433sL-a-433sL-c, may be electrically connected (e.g., soldered) to PCB trace 449f. Second terminals 437-2H of snubber capacitors 433sH-a-433sH-c and first terminals 437-1L of snubber capacitors 433sL-a-433sL-c may be electrically connected (e.g., soldered) to respective PCB traces 469a-469c.

Connector-leads 288ds of packaged switches 247dLi of FIG. 5I-1 can be connected (e.g., soldered) to respective PCB traces 469a-469c when the connector-leads 288ds extend through apertures 464sHa-464sHc, respectively. Connector-lead 288ds of packaged switch 247dHi in leg-a of FIG. 5I-1 can be electrically connected (e.g., soldered) to PCB trace 438f when the connector-lead 288ds extends through aperture 464sHa. Through separate traces not shown, all connector-leads 288ds of packaged switches 247dHi can be electrically connected to PCB trace 438f when the connector-leads 288ds extend through respective apertures 464sH. Connector-lead 288dc of packaged switch 247dLi in leg-a of FIG. 5I-1 can be electrically connected (e.g., soldered) to PCB trace 439f when the connector-lead 288dc extends through aperture 464cLa. Through separate traces not shown, all connector-leads 288dc of packaged switches 247dLi can be electrically connected to PCB trace 439f when the connector-leads 288dc extend through respective apertures 464cL.

FIG. 5I-6B shows voltage sensors V_Sense, drivers 306, PMICs, and traces 470-475. Each voltage sensor V_Sense may have terminals that are electrically connected (e.g., soldered) to a respective pair of traces 472 and 473. Each driver 306 may terminals that are electrically connected (e.g., soldered) to a respective set of traces 470, 471, and 475. Each PMIC may have two terminals that are electrically connected to respective traces 470 and 471. Each PMIC may supply and/or regulate a DC voltage to its corresponding driver 306 through trace 471.

The placement of voltage sensors V_Sense, drivers 306, PMICs, traces, etc., on alternative-driver PCB 460vfdai should not be limited to that shown in FIGS. 5I-6F and 5I-6B. Any placement of voltage sensors V_Sense, drivers 306, PMICs, traces, etc., of alternative-driver PCB 460vfdai should consider effects such as capacitive or inductive coupling. The lengths of traces 470 and 475 between a driver 306 and corresponding apertures 464c and 464g may be 5 mm or less, 4 mm or less, 3 mm or less, 2 mm or less, 1 mm or less, 0.5 mm or less, or 0.1 mm or less. PMIC and driver 306 pairs are shown electrically connected with a short trace 471 (e.g., 5 mm or less, 4 mm or less, 3 mm or less, 2 mm or less, 1 mm or less, 0.5 mm or less, or 0.1 mm or less). The length of trace 470 between each PMIC and its corresponding aperture 464c may be 10 mm or less, 5 mm or less, 4 mm or less, 3 mm or less, 2 mm or less, 1 mm or less, or 0.5 mm or less. Although not shown, ceramic capacitors may be electrically connected (e.g., soldered) between respective pairs of trace 471 and trace 470.

FIG. 5I-6B shows six groups of traces 470-475. Traces 470 and 473 in each group can be electrically connected (e.g., soldered) to connector-lead 288dc of a respective packaged switch 247d when the connector-lead 288dc extends through a respective aperture 464c. Traces 475 and 472 in each group can be electrically connected (e.g., soldered) to connector-leads 288g and 288ds, respectively, of a respective packaged switch 247d when the connector-leads 288g and 288ds extend through the apertures 464g and 464s, respectively. Each driver 306 may terminals that are electrically connected to a pair of connector-leads 288g and 288ds of a respective packaged switch 247d through a respective pair of traces 475 and 470, respectively. The electrical connection between a connector-lead 288g or connector-lead 288ds and a respective driver 306 may include one or more intervening components such as a resistor, diode, etc., in an alternative embodiment. For example, trace 470 or 475 in FIG. 5I-6B may be replaced by one or more components electrically connected through one or more PCB traces (and metal vias if needed), the combination of which is electrically connected between a driver 306 and an aperture 464c or 464g. Each voltage sensor V_Sense may have terminals that are electrically connected to a pair of connector-leads 288dc and 288ds of a respective packaged switch 247d through a respective pair of traces 473 and 472, respectively. The electrical connection between a connector-lead 288dc or connector-lead 288ds and a voltage sensor V_Sense may include one or more intervening components such as a resistor, diode, etc., in an alternative embodiment. For example, trace 473 or 472 in FIG. 5I-6B may be replaced by one or more components electrically connected through one or more PCB traces (and metal vias if needed), the combination of which is electrically connected between a voltage sensor V_Sense and an aperture 464c or 464s.

With continuing reference to FIGS. 5I-1, 5I-2, 5I-4, 5I-6F, and 5I-6B, FIG. 5I-7 shows a front view of converter 460vfd with alternate-driver PCB 461vfdai. FIG. 5I-7 shows phase bus bar-leads 465ci-465ai extending through apertures 463c-463a, respectively. Phase bus bar-leads 465ci-465ai also extend through apertures of respective current sensors I_Sense-I. FIG. 5I-7 shows phase bus bar-lead 465ai electrically connected to winding Wa. FIG. 5I-7 shows connector-leads 288dcH, 288gH, and 288dsH of respective high-side packaged switches 247dHi extending through respective sets of apertures 464cH, 464gH, and 464sH, respectively. Connector-leads 288dsLc-288dsLa may be electrically connected (e.g., soldered) to traces 469c-469a, respectively. Connector-lead 288dsHa may be electrically connected (e.g., soldered) to trace 438fi. FIG. 5I-7 shows connector-leads 288dcL, 288gL, and 288dsL of respective low-side packaged switches 247dLi extending through respective sets of apertures 464cL, 464gL, and 464sL, respectively. Connector-lead 288dcLa may be electrically connected (e.g., soldered) to trace 439fi.

FIG. 5I-8 shows a back view of converter 460vfd with alternate-driver PCB 461vfdar. FIG. 5I-8 shows phase bus bar-leads 465cr-465ar extending through respective apertures of alternate-driver PCB 461vfdar. Phase bus bar-leads 465cr-465ar also extend through apertures of respective current sensors I_Sense-R. FIG. 5I-8 shows phase bus bar-lead 465ar electrically connected to inductor La. FIG. 5I-8 shows connector-leads 288 of respective high-side packaged switches 247dHr extending through respective sets of apertures in alternate-driver PCB 461vfdar. Connector-leads 288dcHc-288dcHa may be electrically connected (e.g., welded) to traces 469c-469a, respectively. Connector-lead 288dsHa may be electrically connected (e.g., welded) to trace 438fr. Connector-lead 288dcLa may be electrically connected (e.g., welded) to trace 439fr.

FIG. 5J illustrates components of a converter 460tp when seen from the front. Converter 460tp shares components of inverter 460iT and passive rectifier 460pr, which are integrated through common V+ bus bar and V− bus bar 417tp and 412tp, respectively, each of which may have a height, width, and length of 8 mm, 25 mm, and 145 mm, respectively. In an alternative embodiment, each diode package 245 in FIG. 5J can be replaced with a packaged switch 247 such as packaged switch 247d. FIG. 5J shows converter 460vfdr with dielectric tubes 420a received in bus bars. Tubes other than 420a can be received by the bus bars. For example, the six aligned bus bars 418p and 418T can be formed by soldering metal bus bar portions around tubes like tubes 420g, but with six metal layers 407p instead of three, using a process like the process described with reference to FIGS. 5A-17-11-5A-17-15 in which six pairs of metal bus bar portions 505 and 509 are soldered around the six metal layers 407p, respectively, and each of bus bars 417tp and 412tp can be formed around tubes 420d or 420e using the process described with reference to FIGS. 5A-17-1-5A-17-5. Or the bus bars can be swapped with bus bars formed around tubes like tubes 420v1 using a process like that described with reference to FIGS. 9A-30-9A-33 or FIGS. 9A-34-9A-37.

FIGS. 5K-1-5K-3 illustrate front, left-side, and right-side views of a converter 460wh1, which is electrically connected between inductors La-Lc and load 468. Inductors La-Lc may be part of a filter like filter 162 shown in FIG. 1C. With continuing reference to FIGS. 5B-1, 5B-2, 5G-1, and 5G-2, converter 460wh1 of FIGS. 5K-1-5K-3 includes components of rectifier 460rT and converter 460fb that share V+ and V− bus bars 417wh1 and 412wh1, respectively.

As seen in FIG. 5K-1, a portion of PCB 435f extends from the side of converter 450wh1. FIGS. 5K-4F and 5K-4B show front and back views, respectively of PCB 435f. Snubber capacitors 433s, recovery capacitor 433r, transformer 451, snubber diodes 425, and recovery diodes 427 are mounted and electrically connected (e.g., soldered) to traces of PCB 435f. Recovery capacitor 433r can be replaced with a film capacitor or an electrolytic capacitor.

As seen in FIG. 5K-1, converter 460wh1 has a rectifier portion and an inverter or full bridge portion as shown. The rectifier portion may also be referred to as a power factor correction (PFC) portion of a PFC circuit. The rectifier portion has three legs designated a-c, each of which may include a pair of packaged switches 247. The inverter portion has two legs designated a and b, each of which may include a pair of packaged switches 247. Alternatively, all packaged switches of converter 460wh1 may be a version of packaged switch 247p, 247q, or 247d. All packaged switches 247 of converter 460wh1 may be the same type. Packaged switches 247d of converter 460wh1 may be packaged switch 247dA, 247dB, 247dC, or 247dD of FIGS. 3A, 3B, 3C, and 3D, respectively. Each of the switches 304 in packaged switches 247 of converter 460wh1 can be independently controlled by an MCU on control PCB 462wh1. Each group of one or more transistors in each switch 247q or 247p, which is electrically connected to a respective connector-lead 288, can be independently controlled by the MCU or other data processing device. Converter 460wh1 can operate bidirectionally.

Each leg a-c of the rectifier portion may include packaged switches 247dH and 247dL that may be electrically and thermally connected to a respective phase bus bar 418T, which in combination may be sandwiched between V+ bus bar 417wh1 and V− bus bar 412wh1. Each leg a and b of the inverter portion may include packaged switches 247dH and 247dL that may be electrically and thermally connected to a respective phase bus bar 418fb, which in combination may be sandwiched between V+ bus bar 417wh1 and V− bus bar 412wh1. All packaged switches 247dH may be electrically and thermally connected to V+ bus bar 417wh1, and all packaged switches 247dL may be electrically and thermally connected to V− bus bar 412wh1.

FIGS. 5K-1-5K-3 illustrate the relative positioning of packaged switches 247, V+ bus bar 417wh1, phase bus bars 418T, phase bus bars 418fb, and V− bus bar 412wh1 with respect to each other. Packaged switches 247dH in each leg of the rectifier portion may have die substrate terminals 230 that are electrically and thermally connected (e.g., soldered, sintered, press-fitted, etc.) directly or indirectly to a flat surface or respective flat surfaces of V+ bus bar 417wh1, and die clip terminals 344 that may be electrically and thermally connected (e.g., soldered, sintered, press-fitted, etc.) directly or indirectly to flat surfaces of respective phase bus bars 418Ta-418Tc, which in turn have terminals that are electrically connected to inductors La-Lc, respectively, as shown. Packaged switches 247dL in each leg of the rectifier portion may have die substrate terminals 230 that may be electrically and thermally connected (e.g., soldered, sintered, press-fitted, etc.) directly or indirectly to flat surfaces of respective phase bus bars 418Ta-418Tc, and die clip terminals 344 that may be electrically and thermally connected (e.g., soldered, sintered, press-fitted, etc.) directly or indirectly to a flat surface or respective flat surfaces of V− bus bar 412wh1.

Packaged switches 247dH in each leg of the inverter portion may have die substrate terminals 230 that are electrically and thermally connected (e.g., soldered, sintered, press-fitted, etc.) directly or indirectly to a flat surface or respective flat surfaces of V+ bus bar 417wh1, and die clip terminals 344 that may be electrically and thermally connected (e.g., soldered, sintered, press-fitted, etc.) directly or indirectly to flat surfaces of respective phase bus bars 418fba and 418fbb, which in turn have terminals that are electrically connected to load 468. Packaged switches 247dL in each leg of the inverter portion may have die substrate terminals 230 that may be electrically and thermally connected (e.g., soldered, sintered, press-fitted, etc.) directly or indirectly to flat surfaces of respective phase bus bars 418fb and 418fa, and die clip terminals 344 that may be electrically and thermally connected (e.g., soldered, sintered, press-fitted, etc.) directly or indirectly to a flat surface or respective flat surfaces of V− bus bar 412wh1.

V+ bus bar 417wh1 and V− bus bar 412wh1 in FIGS. 5K-1-5K-3, may have a generally rectangular cuboid shape, and a height, width, and length around 8 mm, 25 mm, and 120 mm, respectively. FIG. 5K-1 shows the height and length of the bus bars.

FIGS. 5K-1-5K-3 show converter 460wh1 with dielectric tubes 420a received by bus bars. Tubes other than 420a can be received by the bus bars. For example, each of bus bars 412wh1 and 417wh1 can be formed by soldering metal bus bar portions around tubes 420d or 420e using a process like that described with reference to FIGS. 5A-17-1-5A-17-5, and bus bars 418T and 418fb can be formed by soldering metal bus bar portions around tubes 420g using a process like that described with reference to FIGS. 5A-11-5A-15. Or the bus bars can be swapped with bus bars formed around tubes like tubes 420v1 using a process like that described with reference to FIGS. 9A-30-9A-33 or FIGS. 9A-34-9A-37.

Converter 460wh1 may include one or more DC link capacitors 403fb. FIGS. 5K-1-5K-3 show only one DC link capacitor 403fb electrically connected between V+ bus bar 417wh1 and V− bus bar 412wh1, it being understood two or more DC link capacitors 403fb can be electrically connected between V+ bus bar 417wh1 and V− bus bar 412wh1. FIGS. 5K-1-5K-3 shows first and second metal capacitor-leads 405fba and 405fbb of DC link capacitor 403fb1. Example capacitor-leads 405fb have a height hbc, length lbc, and width wbc around 6 mm, 30 mm, and 50 mm, respectively. Capacitor-leads 405fb, may have substantially flat, rectangular-shaped opposite facing top and bottom surfaces. A substantial portion (e.g., 10, 20, 50, 75, 90% or more) of capacitor-lead 405fba's flat bottom surface area may be electrically and thermally connected (e.g., welded, soldered, press-fitted by screws or other fasteners, etc.) directly to a flat surface of V+ bus bar 417wh1, and a substantial portion (e.g., 10, 20, 50, 75, 90% or more) of capacitor-lead 405fbb's flat top surface area may be electrically and thermally connected (e.g., welded, soldered, press-fitted by screws or other fasteners, etc.) directly to a flat surface of V-bus bar 412wh1.

FIGS. 5K-4B and 5K-4F show that first terminals 437-1H of snubber capacitors 433sH-a-433sH-e, may be electrically connected (e.g., soldered) to PCB trace 448f, and second terminals 437-2L of snubber capacitors 433sL-a-433sL-e, may be electrically connected (e.g., soldered) to PCB trace 449f. Second terminals 437-2H of snubber capacitors 433sH-a-433sH-e and first terminals 437-1L of snubber capacitors 433sL-a-433sL-e may be electrically connected (e.g., soldered) to respective PCB traces 444a-444e. Anodes and cathodes of a first group of snubber diodes 425 are electrically connected to PCB traces 438f and 448f, respectively. Anodes and cathodes of a second group of snubber diodes 425 are electrically connected to traces 449f and 439f, respectively. The anode and cathode of recovery diode 427H are electrically connected respectively to PCB traces 448f and 415-1, respectively. The anode and cathode of recovery diode 427L are electrically connected to PCB traces 415-2 and 449f, respectively. First and second transformer-leads 414-1 and 414-2, respectively, of transformer 451 are electrically connected to traces 415-1 and 415-2, respectively. Third and fourth transformer-leads 414-3 and 414-4, respectively, of transformer 451 are electrically connected to traces 438e and 439e, respectively. Transformer 451, including transformer-leads 415, are shown symbolically in FIG. 5A-33.

PCB trace 438f may be electrically connected to PCB trace 511f shown in FIG. 5K-4B through one or more metal vias, and PCB trace 439f may be electrically connected to PCB trace 513f through one or more metal vias. PCB traces 444a-444e may be electrically connected to PCB traces 515a-515e, respectively, through respective metal vias or groups of metal vias.

With continuing reference to FIGS. 5K-2 and 5K-3, surfaces of PCB traces 515a-515a may be electrically connected (e.g., soldered) to side wall surfaces of respective phase bus bars 418Ta-418Tc, and surfaces of PCB traces 515d and 515e may be electrically connected (e.g., soldered) to side wall surfaces of respective phase bus bars 418fbb and 418fba, respectively. Surfaces of PCB traces 511a and 513a may be electrically connected (e.g., soldered) to side wall surfaces of V+ bus bar 417T and V− bus bar 412T, respectively.

Example transformer 451 shows a toroidal magnetic core 410 around which wires 411-1 and 411-2 are wound. Ends of wire or winding 411-1 may be electrically connected between transformer-leads 414-1 and 414-3, and ends of wire or winding 411-2 may be electrically connected between transformer-leads 414-2 and 414-4. Transformer-leads 414 may take form in cylindrical metal pins with flat end surfaces that may be connected (e.g., soldered) to surfaces of PCB traces. In FIG. 5K-3, flat end surfaces of transformer-leads 414-3 and 414-4 are connected to PCB traces 438f and 439f, respectively. Although not shown in FIG. 5K-3 for ease of illustration, flat end surfaces of transformer-leads 414-1 and 414-2 are connected to PCB traces 415-1 and 415-2, respectively (see Figures and 5K-4F).

Converter 460wh1 may include driver PCBs 461wh1 with drivers 306 that can send transistor control signals to respective switches 304 through respective connector-leads 288g. Only connector-leads 288g of rectifier portion leg-a are represented in FIG. 5K-2, and only connector-leads 288g of inverter portion leg-a are represented in FIG. 5K-3. In an alternative embodiment, driver PCBs 461wh1 may include surface mounted snubber capacitors (e.g., multilayer ceramic capacitors, not shown) that are connected in parallel with respective switches 304 through respective sets of connector-leads 288ds and 288dc. Converter 460wh1 may include a control PCB 462wh1 with an MCU that may be in data communication with drivers 306, current sensor I_Sense, voltage sensors, and other components mounted on driver PCB 461wh1. Data connection 484 may facilitate data communication between the MCU and components mounted on PCB components, including drivers 306, current sensors I_Sense, voltage sensors V_Sense, etc. mounted on PCB 461wh1.

Driver PCB 461it in FIG. 5K-2 may include drivers 306 that can send transistor control signals to respective packaged switches 247d of leg-a of the rectifier portion through respective sets of connector-leads 288g. Driver PCB 461it in FIG. 5K-3 may include drivers 306 that can send transistor control signals to respective packaged switches 247d of leg-a of the inverter portion through respective connector-leads 288. Driver PCB 462wh1 also may include drivers that can send transistor control signals to respective packaged switches 247d in legs b and c of the rectifier portion and leg-b of the inverter portion.

Driver PCB 461wh1 may include voltage sensors V_Sense that can sense voltages between respective pairs or connector-leads 288ds and 288dc (not shown). Example phase bus bar-leads 465a and 465fba are shown in FIGS. 5K-2 and 5K-3, respectively, that extend laterally between first and second ends. The first end of phase bus bar-leads 465a and 465fba may be electrically connected to phase bus bars 418Ta and 418fba, respectively, and the second ends may be electrically connected to windings inductor La and Load 468, respectively. Phase bus bar-leads 465a and 465fba extend through respective apertures in PCB 461wh1. Current sensors I_Sense-a and I_Sense-fba measure electrical current flowing through phase bus bar-connectors 465a and 456fba, respectively. I_Sense-a and I_Sense-fba may include respective apertures through which phase bus bar-connectors 465a and 465fba extend. FIG. 5K-2 shows voltage sensors V_Sense, PMICs, current sensor I_Sense-a, and a phase bus bar-lead 465a for leg-a of the rectifier portion, and FIG. 5K-3 shows voltage sensors V_Sense, PMICs, current sensor I_Sense-fba, and a phase bus bar-lead 465fba for leg-a of the inverter portion. A similar group voltage sensor V_Sense, PMICs, current sensor I_Sense, and phase bus bar-lead 465 may be mounted on or extending through PCB 461wh1 for legs b and c of the rectifier portion and leg-b of the inverter portion.

All tubes 420a received in all bus bars of converter 460wh1 may be substantially equal in length. Each tube 420a has first and second ends. The first ends of all tubes 420a may be in fluid communication with a first manifold like manifold 466iT-1, while the second ends of all the tubes 420a may be in fluid communication with a second manifold like manifold 466iT-2.

Liquid dielectric material such as epoxy, silicon, etc., can be added to air gaps or empty spaces between electrical conductors of converter 461wh1, including adjacent electrical conductors of naked packaged switches 247 if employed, and then cured to create structures that suppress dendrite growth and electrical arcing therebetween.

FIGS. 5K-1-5K-3 shows converter 460wh1 with dielectric tubes 420a received in bus bars. Tubes other than 420a can be received by the bus bars. For example, the five aligned bus bars 418T and 418fb can be formed by soldering metal bus bar portions around tubes like tubes 420g, but with five metal layers 407p instead of three, using a process like the process described with reference to FIGS. 5A-17-11-5A-17-15 in which five groups of metal bus bar portions 505 and 509 are soldered around the five metal layers 407p, respectively. Each of bus bars 412wh1 and 417wh1 can be formed around tubes 420d or 420e using a process like that described with reference to FIGS. 5A-17-1-5A-17-5. Or the bus bars can be swapped with bus bars formed around tubes like tubes 420v1 using a process like that described with reference to FIGS. 9A-30-9A-33.

FIG. 5L illustrates components of passive rectifier 460pr of FIG. 5H and converter 460fb of FIG. 5G-1, integrated through common V+ bus bar and V− bus bar 417wh2 and 412wh2, each of which may have a height, width, and length of 8 mm, 25 mm, and 120 mm, respectively, to create power converter 460wh2, which may be electrically connected to a load 468. FIG. 5L shows converter 460wh2 with dielectric tubes 420a received in bus bars. Tubes other than 420a can be received by the bus bars. For example, the five aligned bus bars 418T can be formed by soldering metal bus bar portions around tubes like tubes 420g, but with five metal layers 407p instead of three, using a process like the process described with reference to FIGS. 5A-17-11-5A-17-15 in which five groups of metal bus bar portions 505 and 509 are soldered around the five metal layers 407p, respectively. Each of bus bars 412wh2 and 417wh2 can be formed around tubes 420d or 420e using a process like that described with reference to FIGS. 5A-17-1-5A-17-5. Or the bus bars can be swapped with bus bars formed around tubes like tubes 420v1 using a process like that described with reference to FIGS. 9A-30-9A-33.

Several converters, solid-state circuit breakers, solid-state contactors or other power apparatuses described above have bus bars that are formed around tubes that convey fluids. Alternative bus bars, including finned bus bars, can be used in power apparatuses. FIGS. 5P-1 and 5P-2 illustrate relevant components of an example three-phase inverter 460tair having finned bus bars. FIGS. 5P-1 and 5P-2 show inverter 460tair when seen from the front and side. Several components (e.g., DC link capacitors 403tair and capacitors 433a-1) shown in FIG. 5P-2 are not shown or fully shown in FIG. 5P-1 but are described below. Several components (e.g., driver PCB 461it and control PCB 462it) shown in FIG. 5P-2 are not shown or fully shown in FIG. 5P-1 but are described below.

Inverter 460tair is substantially like inverter 460iT with bus bars 412T, 417T, and 418T replaced by example finned bus bars 412tair, 417tair, and 418tair, respectively. Finned bus bars in FIG. 5P-1 and other figures of this disclosure are shown transmitting air. The present disclosure should not be limited to bus bars, including finned bus bars, transmitting air. Bus bars of this disclosure, including finned bus bars such as bus bars 412tair, 417tair, and 418tair, can transmit other types of dielectric fluids such as hydrogen gas, oil (e.g., mineral oil), deionized water, distilled water, perfluorinated compounds (e.g., perfluorohexane), natural esters, synthetic esters, etc.

Like inverter 460iT, inverter 460tair includes packaged switches 247d, it being understood that in an alternative version the packaged switches 247d may be swapped for packaged switches 247p or packaged switches 247q. All packaged switches 247 of inverter 460tair may be the same type. Each packaged switch 247d of inverter 460tair may be packaged switch 247dA, 247dB, or 247dD, of FIGS. 3A, 3B, and 3D, respectively. Packaged switch 247dO could be used if diodes are added (e.g., diodes and IGBTs integrated in semiconductor dies); the cathodes and anodes of the added diodes are electrically connected to IGBT collectors and emitters, respectively. Flat case surfaces of packaged switches 247d in FIG. 5P-1, may be thermally connected directly or indirectly to flat surfaces of V+ bus bar 417tair, V− bus bar 412tair, and/or phase bus bars 418air.

Inverter 460tair has three legs designated a-c. Each leg in FIG. 5P-1 may include two packaged switches 247dH and 247dL that may be electrically and thermally connected directly or indirectly to a phase bus bar 418air, which in combination may be sandwiched between V+ bus bar 417tair and V− bus bar 412tair. Packaged switches 247dH and 247dL may be also electrically and thermally connected directly or indirectly to V+ bus bar 417tair and V− bus bar 412tair, respectively.

A coupling (tube, duct, sleeve, pipe, etc.) having first and second ends may fluidly connect bus bars including finned bus bars. Phase bus bars 418airc and 418airb may be in fluid communication with each other through coupling 532cb, and phase bus bars 418airb and 418aira may be in fluid communication with each other through coupling 532ba. Couplings, including couplings 532 and couplings 533 (described below), can fluidly connect adjacent bus bars while electrically isolating the adjacent bus bars. Thus, phase bus bars 418air may be thermally connected to each other and electrically isolated from each other through couplings 532. Couplings may be wholly or partially formed of dielectric material.

Inner, substantially flat surfaces of couplings may be connected (e.g., glued) at an end to substantially flat, outer surfaces of a bus bar including a finned bus bar. The connection between a coupling and a bus bar should be fluid tight to prevent leakage. Couplings, such as couplings 532, can pass air or other dielectric fluids (e.g., oil, synthetic esters, etc.) between bus bars to which they are connected.

FIGS. 5P-1 and 5P-2 illustrate the relative positioning of packaged switches 247d, V+ bus bar 417tair, phase bus bars 418air, and V− bus bar 412tair with respect to each other. Packaged switches 247dH in FIG. 5P-1 may have die substrate terminals 230 that may be electrically and thermally connected (e.g., soldered, sintered, press-fitted, etc.) directly or indirectly to a flat surface or respective flat surfaces of V+ bus bar 417air, and die clip terminals 344 that may be electrically and thermally connected (e.g., soldered, sintered, press-fitted, etc.) directly or indirectly to flat surfaces of respective phase bus bars 418aira-418airc, which in turn may be electrically connected to windings Wa-Wc, respectively. Packaged switches 247dL in FIG. 5P-1 may have die substrate terminals 230 that may be electrically and thermally connected (e.g., soldered, sintered, press-fitted, etc.) directly or indirectly to flat surfaces of respective phase bus bars 418aira-418airc, and die clip terminals 344 that may be electrically and thermally connected (e.g., soldered, sintered, press-fitted, etc.) directly to a flat surface or respective flat surfaces of V− bus bar 412tair.

Finned bus bars, like V+ bus bar 417tair, V− bus bar 412tair, and phase bus bars 418air in FIGS. 5P-1 and 5P-2, may have rectangular tube shapes. FIG. 5P-1 shows height and length dimensions of the finned bus bars, and FIG. 5P-2 shows the height and width dimensions. Example phase bus bars 418air may have a height, width, and length around 12 mm, 25 mm, and 20 mm, respectively. Example V+ bus bar 417tair and V− bus bar 412tair may have a height, width, and length around 8 mm, 25 mm, and 70 mm, respectively. Couplings may have a shape like the bus bars to which they are connected. Couplings 532 have rectangular tube shape, and may have a height, width, and length around 13 mm, 26 mm, and 5 mm, respectively. Finned bus bars and couplings may have different shapes and dimensions to accommodate differences in converter design.

FIGS. 5P-1-5P-6 show side and end views of bus bars 412tair, 417tair, and 418air. V+ bus bar 417tair may be substantially like V− bus bar 412air. Finned bus bars such as bus bars 412tair, 417tair, and 418air, may be formed of metal such as aluminum or copper. Finned bus bars such as bus bars 412tair, 417tair, and 418air, may be extruded from a metal such as aluminum or copper.

FIGS. 5P-2 and 5P-4 show end views of a phase bus bar 418air. Phase bus bar 418air may include four thin (e.g., 50.0, 25.0, 15.0, 10.0, 5.0 3.0, 2.0, 1.0 mm or less) sidewalls 542-548 that may be connected at right angles to each other. Sidewalls 542 and 544 may be parallel to each other, and sidewalls 546 and 548 may be parallel to each other. Each of the sidewalls 542-548 may include oppositely facing, substantially flat surfaces. Cooling-fins 541 extend between sidewalls 546 and 548. Ends of cooling-fins 541 may be thermally and electrically connected directly to sidewalls 546 and 548. Cooling-fins 541 have opposite facing, substantially flat surfaces over which fluid (liquid or gas) can flow. Cooling-fins 541 may have a width whf of 10.0, 6.0 4.0, 2.0, 1.0, 0.5 mm or less. The length of cooling-fins 541 may be substantially equal to the length of the phase bus bar 418air in which they are contained. Cooling-fins 541 may be equally spaced in bus bar 418air. FIGS. 5P-2 and 5P-4 show bus bars with three cooling-fins. However fewer than three or more than three cooling-fins may be used in finned bus bars like phase bus bar 418air. Cooling-fins 541 and sidewalls define channels 560 through which fluid can flow through bus bar 418air. Dielectric fluid flow through finned bus bars can extract substantial heat (e.g., 1.0, 5.0, 10.0, 20.0, 50.0, 100.0, 200.0, 300.0, 500.0 W or more) from one or more switches 304 or diodes that are electrically and thermally connected indirectly to cooling-fins 541.

FIGS. 5P-2 and 5P-6 show end views of V+ bus bar 412tair. V− bus bar 417tair may be substantially similar. Each of V− bus bar 412tair and V+ bus bar 417tair may include four thin (e.g., 50.0, 25.0, 15.0, 10.0, 5.0 3.0, 2.0, 1.0 mm or less) sidewalls 562-568 that may be connected at right angles to each other. Sidewalls 562 and 564 may be parallel to each other, and sidewalls 566 and 568 may be parallel to each other. Each of the sidewalls 562-568 may include oppositely facing, substantially flat surfaces. Cooling-fins 543 extend between sidewalls 566 and 568. Ends of cooling-fins 543 may be thermally and electrically connected directly to sidewalls 566 and 568. Cooling-fins 543 have oppositely faced, substantially flat surfaces over which fluid (liquid or gas) can flow. Cooling-fins 543 may have a width whf of 10.0, 6.0 4.0, 2.0, 1.0, 0.5 mm or less. The length of cooling-fins 543 may be substantially equal to the length of bus bar 412tair. Cooling-fins 543 may be equally spaced in bus bar 412tair. FIGS. 5P-2 and 5P-6 show bus bars with three cooling-fins 543. However fewer than three or more than three cooling-fins may be used. Cooling-fins 543 and sidewalls define channels 570 through which fluid can flow through bus bar 412tair. Dielectric fluid flow through finned bus bar 412tair can extract substantial heat (e.g., 1.0, 5.0, 10.0, 20.0, 50.0, 100.0, 200.0, 300.0, 500.0 W or more) from one or more switches 304 or diodes D that are electrically and thermally connected indirectly to cooling-fins 543.

A thin layer of corrosion resistant material (e.g. epoxy filled with conductive materials, nickel, synthetic diamond, rhodium, silver, titanium, etc.) can be formed (e.g., electroplated, sprayed, etc.) on surfaces of channels, such as channels 560 or 570 to prevent oxidation, tarnish, etc., without significantly affecting thermal conductivity between fluid flowing through the channel and a die clip terminal 344 or die clip terminal 230 attached to the finned bus bar. Alternatively, a thin layer can be formed on surfaces of channels, such as channels 560 or 570, by, for example, by applying a chemical such as benzotriazole, or by passivation, anodization, etc., to prevent oxidation, tarnish, etc., without significantly affecting thermal conductivity between fluid flowing through the channel and a die clip terminal 344 or die clip terminal 230 attached to the finned bus bar.

Cooling-fins are shown as rectangular structures that extend continuously between substantially flat opposing sidewalls in FIGS. 5P-4 and 5P-6. Cooling-fins should not be limited thereto. Cooling-fins may have opposite facing, non-planar surfaces each with one or more protrusions, depressions, or channels to promote turbulent fluid flow. Each cooling-fin could be replaced by a row of cylindrical pins extending perpendicularly from sidewalls such as sidewalls 546 and/or 548 in FIG. 5P-4, or sidewalls 546 and/or 548 in FIG. 5P-7. The pins may have a unform cross-sectional diameter of 10.0, 6.0 4.0, 2.0, 1.0, 0.5 mm or less. Alternatively, each cooling-fin may be flat rectangular structures that are directly connected to only one sidewall. FIG. 5P-7 shows examples of these alternative cooling-fins connected at only one end. FIG. 5P-7 shows phase bus bar 418air of FIG. 5P-4 with cooling-fins 540 replaced with cooling-fins 549. Cooling-fins 549 are connected at only one end to side wall 548 or 546. Fluid can flow over all surfaces at the other, distal end (i.e., the end of the cooling-fin that is not connected to a sidewall).

FIG. 5P-3 shows a side view of example coupling 532ba in fluid communication with phase bus bar 418aira and phase bus bar 418airb. FIG. 5P-4 shows the structure of FIG. 5P-3 when seen from an end. Couplings enable fluid flow between adjacent bus bars. Each coupling 532 may have four substantially flat sidewalls connected at right angles to each other. Example coupling, such as coupling 532ba, may have height and width slightly larger than the height and width of the bus bar, such as phase bus bars 418airb and 418aira, to which it is directly or indirectly connected. Inner flat surfaces of coupling's sidewall, such as coupling 532b, may be connected (e.g., glued) directly to outer flat surfaces of respective sidewalls of a bus bar, such as phase bus bars 418airb or 418aira. Couplings, such as coupling 532, may not include cooling-fins as shown in FIG. 5P-4 or pins. Couplings, such as coupling 532, may have structures (e.g., pins) that induce turbulence in the fluid flowing through the coupling.

Inverter 460tair may include example film DC link capacitors 403tair, each of which has first and second metal capacitor-leads 405air-a and 405air-b. Example capacitor-leads 405air have a height, length, and width around 6 mm, 30 mm, and 17 mm, respectively. Capacitor-leads 405air may have substantially flat, rectangular-shaped opposite facing top and bottom surfaces. The areas of the example top and bottom surfaces may be around 510 mm². A substantial portion (e.g., 10, 20, 50, 75, 90% or more) of a capacitor-lead's flat surface area may be electrically and thermally connected (e.g., soldered, press-fitted by screws or other fasteners, etc.) directly to a flat surface of a fluid-cooled V+ or V− bus bar. For example, a substantial portion (e.g., 10, 20, 50, 75, 90% or more) of capacitor-lead 405air-a's flat bottom surface area may be electrically and thermally connected directly or indirectly to a flat surface of V+ bus bar 417air, and a substantial portion (e.g., 10, 20, 50, 75, 90% or more) of capacitor-lead 405air-b's flat top surface area may be electrically and thermally connected directly or indirectly to a flat surface of V− bus bar 412air. V+ bus bar 417tair and V− bus bar 412tair can extract a substantial amount of heat (e.g., 1, 2, 5, 10, 20, 40, 80, 100, 200, 300 Watts or more) from film DC link capacitors 403tair through flat surfaces of their capacitor-leads 405air-a and/or 405air-b, respectively.

Inverter 460tair may include a row of ceramic DC link capacitors 433a electrically connected in parallel. For ease of illustration, only one ceramic DC link capacitor 433a-1 of the row is shown. Each of the ceramic DC link capacitors 433 may include first and second metal terminals 437-1 and 437-2, respectively, connected electrically to the fluid-cooled V+ and V− bus bars, respectively.

Example ceramic DC link capacitors 433 may be mounted on a PCB 435r and electrically connected in parallel. First and second metal terminals 437-1 and 437-2 may be electrically connected to first and second metal traces 511r and 513r, respectively, on the side of PCB 435r opposite the side with capacitors 433. Metal vias can electrically connect traces 511r and 513r to respective terminals 437-1 and 437-2. The ends of first and second traces 511r and 513r may be widened to create large surface areas that can be electrically and thermally connected directly or indirectly to respective side wall surfaces of the V+ and V− bus bars 418air and 412air, respectively. In an alternative embodiment, PCB 435r may be replaced with PCB 435e shown in FIG. 5A-33F and 5A-33B, or PCB 435c shown in FIGS. 5A-27B and 5A-27F. Assuming the height and length of bus bars 417tair, 412tair, and 418air are substantially equal to the height and length of bus bars 417T, 412T, and 418T, respectively, surfaces of PCB traces 511a and 513a of PCB 435c or 435e may be electrically connected (e.g., soldered) to side wall surfaces of V+ bus bar 417tair and V− bus bar 412tair, respectively, and PCB traces 515a-515c may be electrically connected (e.g., soldered) to side wall surfaces of respective phase bus bars 418aira-418airc, respectively.

Returning to FIG. 5P-1, electrical current symbols are shown that represent electrical current flow through inverter system 460tair at an instant in time. More particularly, FIG. 5P-1 shows electrical current flow through activated high-side switch 304dH of leg-a, while low-side switches 304dL of legs b and c may be activated and conducting current to the V-terminal through the V− bus bar 412air.

Inverter 460tair may include control PCB 462it. Inverter 460tair may include driver PCB 461it. Driver and control PCBs may be in data communication with each other. Driver PCB 461it may be electrically connected to switches 304 through respective sets of connector-leads 288. Only connector-leads 288gH and 288gL of leg-c are represented in FIG. 5P-2. Driver PCB 461it may include surface mounted snubber capacitors (e.g., multilayer ceramic capacitors, not shown) that are connected in parallel with respective switches 304 through respective sets of connector-leads 288ds and 288dc.

Driver PCB 461it in FIG. 5P-2 includes drivers 306 that can send transistor control signals to respective packaged switches 247d of leg-c through respective connector-leads 288g. Driver PCB 461it in FIG. 5P-2 may include voltage sensors V_Sense that can sense voltages between respective pairs of connector-leads 288ds and 288dc (not shown). Example phase bus bar-lead 465c may extend laterally between first and second ends. The first end of phase bus bar-lead 465c may be electrically connected to phase bus bar 418Tc, and the second end may be electrically connected to winding Wc. Phase bus bar-lead 465c may extend through an aperture in PCB 461it. Current sensor I_Sense measures electrical current flowing through phase bus bar-lead 465c. I_Sense may include an aperture through which phase bus bar-lead 465c may extend. FIG. 5P-2 shows drivers 306, voltage sensors V_Sense, PMICs, current sensors I_Sense, and a phase bus bar-leads 465 for leg-c. Similar groups of drivers 306, voltage sensors V_Sense, PMICs, current sensor I_Sense, and phase bus bar-leads 465 may be mounted on or extending through PCB 461it for legs a and b.

FIG. 5P-2 shows an MCU mounted on control PCB 462it. The MCU may be in data communication with each driver 306, V_Sense, and I_Sense mounted on driver PCB 461it through a flexible PCB 484.

Liquid dielectric material such as epoxy, silicon, etc., can be added to air gaps or empty spaces between adjacent electrical conductors of inverter 460tair, including electrical conductors of naked packaged switches 247 if employed, and then cured to create structures that suppress dendrite growth and electrical arcing therebetween.

FIGS. 5Q-1-5Q-5 illustrate relevant components of an example converter 460hev when seen from the front, back, left, right, and top, respectively. Converter 460hev may be an example of a bidirectional three-phase inverter, bidirectional three-phase rectifier, and bidirectional DC/DC converter that are integrated through common V+ and V− bus bars.

Converter 460hev and converter 460vfd of FIGS. 5I-1-51-4 have common components. But while converter 460vfd has six legs, converter 460hev has an extra leg that may be part of a DC/DC converter as shown. Converter 460hev may be connected to a pair of motors/generators and a rechargeable battery BT1.

Converter 460hev shows three portions designated as inverter, rectifier, and DC/DC. FIG. 5Q-1 shows the inverter and DC/DC portions, while FIG. 5Q-2 shows the rectifier and DC/DC portions. The DC/DC portion is common to FIGS. 5Q-1 and 5Q-2.

The DC/DC, inverter, and rectifier portions of converter 460hev may share V+ and V− bus bars 417hev and 412hev as shown. Several components (e.g., driver PCB 461rhev, driver PCB 461ihev, control PCB 462hev, and DC link capacitors 403vfd) are not shown or fully shown in FIGS. 5Q-1 and 5Q-2 but may be seen in FIGS. 5Q-3-5Q-5. Control PCB 462hev is omitted from FIG. 5Q-5. Each of the inverter and rectifier portions have three legs designated a-c. FIG. 5Q-4 shows leg-a of the inverter and rectifier portions. The DC/DC portion has one leg. FIG. 5Q-3 shows the DC/DC leg.

Converter 460hev may be electrically connected to windings Wa1-Wc1 as shown. Windings Wa1-Wc1 may be part of a stator in a first motor/generator, which in turn may be mechanically coupled to wheels (not shown) of a hybrid EV. Additionally, converter 460hev may be electrically connected to windings Wa2-Wc2 as shown. Windings Wa2-Wc2 may be part of a stator in second motor/generator, which in turn may be mechanically coupled to an internal combustion engine (ICE, not shown) of the hybrid EV. Further, converter 460hev may be electrically connected to inductor LB, which in turn may be connected to rechargeable battery BT1 as shown. Battery BT1 may be part of the hybrid EV.

The DC/DC portion of converter 460hev can be used for converting a first DC voltage provided by battery BT1 into a second and different DC voltage between the V+ bus bar 417hev and the V− bus bar 412hev when operating in the forward direction, or the DC/DC portion can be used for converting the second DC voltage between the V+ bus bar 417hev and the V− bus bar 412hev into the first DC voltage for charging battery BT1 when the DC/DC converter portion is operating in the reverse direction. The first and second DC voltages may have different magnitudes.

The rectifier portion of converter 460hev can convert a three-phase AC power input at phase bus bars 418vfdr into DC power between the V+ bus bar 417hev and the V− bus bar 412hev when operating in the forward direction. The rectifier portion can convert DC power input to the V+ and V− bus bars into three-phase AC power output at phase bus bars 418vfdr when operating in the reverse direction.

The inverter portion can convert DC power input to the V+ bus bar 417hev and the V-bus bar 412hev into three-phase AC power output at phase bus bars 418vfdr when operating in the forward direction. The inverter portion of converter 460hev can convert three-phase AC power input at the phase bus bars 418vfdr into DC power output at the V+ and V− bus when operating in the reverse direction.

Converter 460hev uses packaged switches 247d, each of which may be packaged switch 247dA, 247dB, or 247dD of FIGS. 3A, 3B, and 3D respectively. Alternatively, packaged switches of converter 460hev may be replaced with packaged switches 247p or packaged switches 247q.

As seen in FIGS. 5Q-1 and 5Q-2, each leg of the inverter and rectifier portions includes packaged switches 247dH and 247dL. Likewise, the DC/DC portion includes packaged switches 247dH and 247dL. Each of the switches 304 in packaged switches 247d of converter 460hev can be independently controlled by an MCU mounted on control PCB 462hev. Each group of one or more transistors in each switch 247q or 247p, which is electrically connected to a respective connector-lead 288, can be independently controlled by the MCU or other data processing device.

Converter 460hev may include V+ bus bar 417hev, V− bus bar 412hev, inverter phase bus bars 418vfdi, rectifier phase bus bars 418vfdr, and DC/DC phase bus bar 418dc as shown. FIGS. 5Q-1-5Q-5 illustrate the vertical and horizontal positioning of packaged switches 247d, V+ bus bar 417hev, V− bus bar 412hev, inverter phase bus bars 418vfdi, rectifier phase bus bars 418vfdr, and DC/DC phase bus bar 418dc with respect to each other. Inverter phase bus bars 418vfdia-418vfdic may be electrically connected to windings Wa1-Wc1, respectively, as shown. Rectifier phase bus bars 418vfdra-418vfdrc may be electrically connected to windings Wa2-Wc2, respectively, as shown. DC/DC phase bus bar 418dc may be electrically connected to battery BT1 via inductor LB as shown.

V+ bus bar 417hev, V− bus bar 412hev, inverter phase bus bars 418vfdi, rectifier phase bus bars 418vfdr, and DC/DC phase bus bar 418dc may have a generally rectangular cuboid shape as shown. Each of the example inverter and rectifier phase bus bars 418vfdi and 418vfdr, respectively, may have a height, width, and length around 8 mm, 25 mm, and 20 mm, respectively. Example phase bus bar 418dc may have a height, width, and length around 8 mm, 55 mm, and 20 mm, respectively. Example V+ bus bar 417hev and V− bus bar 412hev may have a height, width, and length around 8 mm, 55 mm, and 95 mm, respectively. FIGS. 5Q-3 and 5Q-4 show the height and width dimensions of the bus bars. The lengths of V+ bus bar 417vfd, V− bus bar 412vfd, and tubes 420a, could be extended to increase the distance between adjacent bus bar-leads 465, which in turn can accommodate wider capacitors 403vfd therebetween.

With continuing reference to FIGS. 5Q-1 and 5Q-2, each of packaged switches 247dHf, 247dHb, 247dHi and 247dHr may have die substrate terminal 230 that may be electrically and thermally connected (e.g., soldered, sintered, press-fitted, etc.) directly or indirectly to a flat surface or respective flat surfaces of V+ bus bar 417hev as shown. Packaged switches 247dHi of the inverter portion may have die clip terminals 344 that may be electrically and thermally connected (e.g., soldered, sintered, press-fitted, etc.) directly or indirectly to a flat surface of a respective inverter phase bus bar 418vfdi as shown. Packaged switches 247dHr of the rectifier portion may have die clip terminals 344 that may be electrically and thermally connected (e.g., soldered, sintered, press-fitted, etc.) directly or indirectly to a flat surface of a respective rectifier phase bus bar 418vfdr as shown. Packaged switches 247dHf and 247dHb of the DC/DC converter portion each may have die clip terminal 344 that may be electrically and thermally connected (e.g., soldered, sintered, press-fitted, etc.) directly or indirectly to a flat surface or respective flat surfaces of DC/DC phase bus bar 418dc as shown. Packaged switches 247dLf, 247dLb, 247dLi and 247dLr in each leg may have die clip terminals 344 that may be electrically and thermally connected (e.g., soldered, sintered, press-fitted, etc.) directly or indirectly to a flat surface or respective flat surfaces of V− bus bar 412hev as shown. Packaged switches 247dLi of the inverter portion may have die substrate terminals 230 that may be electrically and thermally connected (e.g., soldered, sintered, press-fitted, etc.) directly or indirectly to a flat surface of a respective inverter phase bus bar 418vfdi as shown. Packaged switches 247dLr of the rectifier portion may have die substrate terminals 230 that may be electrically and thermally connected (e.g., soldered, sintered, press-fitted, etc.) directly or indirectly to a flat surface of a respective rectifier phase bus bar 418vfdr as shown. Packaged switches 247dLf and 247dLb of the DC/DC converter portion may have die substrate terminal 230 that may be electrically and thermally connected (e.g., soldered, sintered, press-fitted, etc.) directly or indirectly to a flat surface or respective flat surfaces of DC/DC bus bar 418dc as shown.

FIGS. 5Q-1-5Q-5 show converter 460hev with dielectric tubes 420a received in bus bars. Tubes other than 420a can be received by the bus bars. For example, each of bus bars 412hev and 417hev can be formed by soldering metal bus bar portions around tubes 420d or 420e using a process like that described with reference to FIGS. 5A-17-1-5A-17-5, and aligned bus bars 418dc and 418vfd, collectively, can be formed by soldering metal bus bar portions around tubes like tubes 420g, but with four metal layers 407p instead of three, using a process like that described with reference to FIGS. 5A-17-6-5A-17-10 in which four pairs of metal bus bar portions 505 and 509 are soldered around the four metal layers 407p, respectively. Bus bars 418vfdia-418vfdic and 418dc may be thermally connected to each other by commonly received tubes 420. Bus bars 418vfdra-418vfdrc and 418dc may be thermally connected to each other by commonly received tubes 420.

With continuing reference to FIGS. 5Q-3-5Q-5, converter 460hev may include DC link capacitors 403vfdi and 403vfdr. First and second metal capacitor-leads 405avfdr and 405bvfdr may extend from each capacitor 403vfdr. First and second metal capacitor-leads 405avfdi and 405bvfdi may extend from each capacitor 403vfdi. Example capacitor-leads 405avfdr, 405bvfdr, 405avfdi, and 405bvfdi may have a height, length, and width around 6 mm, 25 mm, and 20 mm, respectively. A substantial portion (e.g., 10, 20, 50, 75, 90% or more) of each flat bottom surface area of capacitor-lead 405avfdi and 405avfdr, may be electrically and thermally connected (e.g., welded, soldered, press-fitted by screws or other fasteners, etc.) directly to a flat surface of V+ bus bar 417hev, and a substantial portion (e.g., 20, 40, 60% or more) of each flat top surface area of capacitor-lead 405bvfdi and 405bvfdr, may be electrically and thermally connected (e.g., welded, soldered, press-fitted by screws or other fasteners, etc.) directly to a flat surface of V− bus bar 412hev.

FIG. 5Q-6 is top view of converter 460hev, but with capacitors 403vfdi rotated 90 degrees. Although not shown in FIG. 5Q-6, a substantial portion of each capacitor-lead 405avfd's flat bottom surface area may be electrically and thermally connected directly to a flat surface of V+ bus bar 417hev, and a substantial portion of each capacitor-lead 405bvfd's flat top surface area may be electrically and thermally connected directly to a flat surface of V− bus bar 412hev. FIG. 5Q-6 shows the ends of tubes 420a with hidden lines. Although not clearly shown in FIG. 5Q-6, ends of tubes 420a are positioned between capacitor-leads 405avfd and 405bvfd. Although not shown, capacitors 403vfdr could also be rotated 90 degrees and electrically connected between bus bars 417hev and 412hev. Capacitor-leads 405avfd and 405bvfd may need to be longer when rotated and electrically connected to the bus bars, to provide space adjacent to the bus bars for manifolds (not shown) that are fluidly connected to ends of tubes 420a.

Converter 460hev may include one or more ceramic DC link capacitors (e.g., multilayer ceramic capacitors) with first and second metal terminals that may be electrically and thermally connected directly or indirectly to flat surfaces V+ bus bar 417hev and V− bus bar 412hev, respectively.

Converter 460hev may include driver PCBs 461ihev and 461rhev with drivers 306 that can send transistor control signals to respective switches 304 through respective connector-leads 288g. FIG. 5Q-3 shows connector-leads 288g for the DC/DC portion. Only connector-leads 288g of leg-a for each of the rectifier and inverter portions are represented in FIG. 5Q-4. FIG. 5Q-5 shows connector-leads 288 for all packaged switches 247dH, but several of the connector-leads 288dsH and 288dcH are positioned beneath capacitor-leads 405avfd and drawn with hidden lines. Each of the driver PCBs 461ihev and 461rhev may include RCD snubber circuits that are connected in parallel with respective switches 304 through respective sets of connector-leads 288ds and 288dc.

Converter 460hev may include a control PCB 462hev with an MCU that may be in data communication with drivers 306, current sensors I_Sense, voltage sensors V_Sense, or other components mounted on driver PCBs 461ihev and 461rhev via data connections 484-1 and 484-2, respectively.

FIGS. 5Q-3-5Q5 show example phase bus bar-leads 465 for converter 460hev, which extend laterally between first and second ends as shown. The first ends may be electrically connected (e.g., welded) to respective phase bus bars 418 in converter 460hev. The second ends may be electrically connected (e.g., welded) to a terminal of inductor LB or windings such as windings Wa1 and Wa2 as shown. FIG. 5Q-5 shows the relative positioning of components with respect to each other, including the horizontal positioning of capacitors 403vfd between phase bus bar-leads 465.

FIG. 5Q-4 shows drivers 306 that can send transistor control signals to respective packaged switches 247dLi and 247dHi of leg-a of the inverter portion through respective connector-leads 288g. Although not shown in this figure, driver PCB 461ihev also may include drivers that can send transistor control signals to respective packaged switches 247dHi and 247dLi in legs b and c of the inverter portion.

Driver PCB 461ihev in FIGS. 5Q-3 and 5Q-4 may include voltage sensors V_Sense that can sense voltages between respective pairs of connector-leads 288ds and 288dc (not shown). In FIG. 5Q-4 example phase bus bar-lead 465ai may extend laterally between first and second ends. The first end of phase bus bar-lead 465ai may be electrically connected to phase bus bar 418vfdia, and the second end may be electrically connected to winding Wa1. Phase bus bar-lead 465ai may extend through an aperture in PCB 461ihev. Current sensor I_Sense-I can measure electrical current flowing through phase bus bar-lead 465ai. I_Sense-I may include an aperture through which phase bus bar-lead 465ai extends. FIG. 5Q-4 shows voltage sensors V_Sense, PMICs, current sensor I_Sense, and phase bus bar-lead 465ai for leg-a of the inverter portion. Similar groups of voltage sensors V_Sense, PMICs, current sensor I_Sense-I, and phase bus bar-lead may be mounted on or extending through PCB 461ihev for legs b and c of the invertor portion.

FIG. 5Q-4 shows drivers 306 that can send transistor control signals to respective packaged switches 247dr of leg-a of the rectifier portion through respective connector-leads 288g. Although not shown in FIG. 5Q-4, driver PCB 461rhev also may include drivers 306 that can send transistor control signals to respective packaged switches 247dr in legs b and c of the rectifier portion.

Driver PCB 461rhev may include voltage sensors V_Sense that can sense voltages between respective pairs or connector-leads 288ds and 288dc (not shown). Example phase bus bar-lead 465ar may extend laterally between first and second ends. The first end of phase bus bar-lead 465ar may be electrically connected to phase bus bar 418vfdra, and the second end may be electrically connected to winding Wa2. Phase bus bar-lead 465ar may extend through an aperture in PCB 461rhev. Current sensor I_Sense-R can measure electrical current flowing through phase bus bar-lead 465ar. I_Sense-R may include an aperture through which phase bus bar-lead 465ar extends. FIG. 5Q-4 shows voltage sensors V_Sense, PMICs, current sensor I_Sense, and a phase bus bar-lead 465ar for leg-a of the rectifier portion. Similar groups of voltage sensors V_Sense, PMICs, current sensor I_Sense, and phase bus bar-lead may be mounted on or extending through PCB 461rhev for legs b and c of the rectifier portion.

In FIG. 5Q-3 driver PCB 461ihev may include drivers 306 that can send transistor control signals to respective switches 304dHf and 304dLf of the DC/DC portion through respective connector-leads 288g. Driver PCB 461ihev in FIG. 5Q-3 may include voltage sensors V_Sense that can sense voltages across respective switches 304dHf and 304dLf via respective pairs of connector-leads 288ds and 288dc (not shown). Driver PCB 461rhev in FIG. 5Q-3 may include drivers 306 that can send transistor control signals to respective switches 304dHb and 304dLb of the DC/DC portion through respective connector-leads 288g. Driver PCB 461rhev in FIG. 5Q-3 may include voltage sensors V_Sense that can sense voltages across respective switches 304dHb and 304dLb via respective pairs or connector-leads 288ds and 288dc (not shown).

In FIG. 5Q-3 example phase bus bar-lead 465dd may extend laterally between first and second ends. The first end of phase bus bar-lead 465dd may be electrically connected to phase bus bar 418dc, and the second end may be electrically connected to inductor LB as shown. Phase bus bar-lead 465dd may extend through an aperture in PCB 461rhev. Current sensor I_Sense-1b measures electrical current flowing through phase bus bar-lead 465dd. I_Sense 1b may include an aperture through which phase bus bar-lead 465dd may extend.

All tubes 420a received in all bus bars in FIGS. 5Q-1-5Q-4, such as bus bar 412vdre, may be substantially equal in length. Each tube 420a has first and second ends. The first ends of all tubes 420a may be in fluid communication with a first manifold, while the second ends of all the tubes 420a may be in fluid communication with a second manifold.

Liquid dielectric material such as epoxy, silicon, etc., can be added to air gaps or empty spaces between adjacent electrical conductors of converter 460hev, including electrical conductors of naked packaged switches 247 if employed, and then cured to create structures that suppress dendrite growth and electrical arcing therebetween.

In an alternative embodiment of converter 460hev, bus bars 417hev, 412hev, 418vfd, and 418dc may be replaced with finned bus bars like those shown in FIGS. 5P-1-5P-6. For example, each of phase bus bars 418vfdic and 418vfdrc could be replaced with phase bus bars 418air. Couplings 532 may fluidly connect adjacent pairs of phase bus bars 418air. A wider version of phase bus bar 418air can replace phase bus bar 418dc. A dielectric fluid coupling can be connected at its' first end to the wider version of phase bus bar 418air, while a split-second end is connected to phase bus bars 418air. V+ bus bar 417hev and V− bus bar 412hev can be replaced by longer and/or wider versions of V+ bus bar 417tair and 412tair, respectively.

In another alternative embodiment of converter 460hev, packaged switches 247dHb and 247dHf may be replaced by packaged diodes 245M or 245N of FIGS. 3M and 3N, respectively. The die substrate terminals 230 of the replacement packaged diodes 245 may be electrically and thermally connected (e.g., soldered, sintered, press-fitted, etc.) directly or indirectly to a flat surface or respective flat surfaces of V+ bus bar 417hev, and the die clip terminals 344 of the replacement packaged diodes 245 may be electrically and thermally connected (e.g., soldered, sintered, press-fitted, etc.) directly or indirectly to a flat surface or respective flat surfaces of DC/DC phase bus bar 418dc. In this alternative embodiment, the DC/DC portion is unidirectional and configured to only boost the DC voltage supplied by battery BT1 to a higher voltage.

Power converters of this disclosure may be used for many different purposes. FIGS. 5R-1-5R-3 illustrate an example bidirectional converter 460obc, which could be used as a vehicle to grid (V2G) converter. Converter 460obc may be employed in an EV. Converter 460obc can be employed externally to an EV and electrically connected thereto via a charging cable.

FIG. 5R-1 shows converter 460obc with three full-bridge converter portions FB1, FB2, and FB3. Each full-bridge converter portion (hereinafter converter portion) FB1, FB2, and FB3 may include components of full-bridge inverter 460fb shown in FIGS. 5G-1 and 5G-2.

Converter portion FB1 may be electrically coupled to a grid connection φ through an inductor LB and an EMI filter, which may include a choke (e.g., a unitary turns ratio transformer with a core that lacks a gap) electrically connected and configured to attenuate common mode current in converter 460obc. Converter portion FB1 and inductor LB can convert AC power provided at grid connection φ into DC power, or convert DC power into AC power for subsequent transmission to the grid through grid connection φ.

Converter portions FB2 and FB3 may be electrically connected to each other through transformer T, inductors Ls and Lp, and capacitors Cs and Cp as shown. FIG. 5R-1 shows phase bus bar 418fbb3 electrically connected directly to the bottom terminal of transformer T on the secondary side, and phase bus bar 418fba3 electrically connected indirectly to the top terminal of transformer T on the secondary side via Ls and Cs. In an alternative embodiment, phase bus bar 418fbb3 may be electrically connected indirectly to the top terminal of transformer T on the secondary side via Ls and Cs, and phase bus bar 418fba3 may be electrically connected directly to the bottom terminal of transformer T on the secondary side. Converter portion FB2, converter portion FB3, and transformer T can collectively implement resonant DC/DC power conversion. In an alternative embodiment, converter 460obc may lack capacitors Cs and Cp, inductor Lp may be electrically connected directly between transformer T and converter portion FB2, and inductor Ls may be electrically connected directly between transformer T and FB3. In this alternative embodiment, converter portion FB2, converter portion FB3, and transformer T can collectively implement dual-active bridge DC/DC power conversion. In either embodiment, converter portions FB2 and FB3 can convert DC power provided by converter portion FB1 into DC power for charging a battery BT1, or converter portions FB2 and FB3 can convert DC power provided by battery BT1 into DC power for subsequent conversion into AC power by converter portion FB1. Converter 460obc should not be limited to use in charging or discharging a battery. Converter portions FB2 and FB3 can convert DC power provided by converter portion FB1 into DC power for subsequent conversion into AC power by an inverter (not shown) that is electrically connected to portion FB3.

FIGS. 5R-1-5R-3 illustrate relevant components of example converter 460obc when seen from the front, left, and right sides, respectively. Several components (e.g., driver PCB 461obc, control PCB 462obc, and DC link capacitors 403fb) are not shown in FIG. 5R-1 but can be seen in FIGS. 5R-2 and 5R-3. With continuing reference to FIG. 5R-1, each converter portion FB has two legs designated a and b. FIGS. 5R-2 and 5R-3 show legs b1 and a2 of converter portions FB1 and FB3, respectively.

Converter 460obc may include packaged switches 247d, it being understood that in an alternative version packaged switches 247d may be replaced by packaged switches 247p or packaged switches 247q. All packaged switches 247 of converter 460obc may be the same type. Packaged switches 247d of converter 460obc may be packaged switch 247dA, 247dB, or 247dD of FIGS. 3A, 3B, and 3D, respectively.

Converter 460obc may include V+ bus bar 417ofb, V− bus bar 412ofb, V+ bus bar 417fb, V− bus bar 412fb and phase bus bars 418fb. Flat case surfaces of packaged switches 247 may be thermally connected directly or indirectly to flat surfaces of bus bars. Converter portions FB1 and FB2 may be combined through common V+ and V− bus bars 417ofb and 412ofb.

As noted, each converter portion FB has two legs designated a and b. Each leg of converter portions FB1 and FB2 may include packaged switches 247dH and 247dL that may be electrically and thermally connected to a respective phase bus bar 418fb, which in combination may be sandwiched between V+ bus bar 417ofb and V− bus bar 412ofb. Packaged switches 247dH and 247dL in converter portions FB1 and FB2 may be also electrically and thermally connected to V+ bus bar 417ofb and V− bus bar 412ofb, respectively. Each leg of converter portion FB3 may include packaged switches 247dH and 247dL that may be electrically and thermally connected to a respective phase bus bar 418fb, which in combination may be sandwiched between V+ bus bar 417fb and V− bus bar 412fb. Packaged switches 247dH and 247dL in converter portion FB3 may be also electrically and thermally connected to V+ bus bar 417fb and V− bus bar 412fb, respectively.

FIG. 5R-1 illustrates the relative positioning of packaged switches 247d, V+ bus bar 417ofb, V− bus bar 412ofb, V+ bus bar 417fb, V− bus bar 412fb, and phase bus bars 418fb with respect to each other. Die substrate terminals 230 and die clip terminals 344 may be pressed-fitted, soldered, sintered, welded, or connected by other means directly to corresponding flat surfaces of bus bars to establish thermal and electrical connectivity. Packaged switches 247dH in converter portions FB1 and FB2 of FIG. 5R-1 may have die substrate terminals 230 that may be electrically and thermally connected (e.g., soldered, sintered, press-fitted, etc.) directly or indirectly to a flat surface or respective flat surfaces of V+ bus bar 417ofb. Die clip terminals 344 of converter portion FB1 may be electrically and thermally connected (e.g., soldered, sintered, press-fitted, etc.) directly or indirectly to flat surfaces of respective phase bus bars 418fba1 and 418fbb1, which in turn may be electrically connected to terminals of inductor LB and the EMI filter as shown. Die clip terminals 344 of converter portion FB2 may be electrically and thermally connected (e.g., soldered, sintered, press-fitted, etc.) directly or indirectly to flat surfaces of respective phase bus bars 418fba2 and 418fbb2, which in turn have terminals that may be electrically connected to terminals of inductor Lp and transformer T as shown. Packaged switches 247dL of converter portion FB1 may have die substrate terminals 230 that may be electrically and thermally connected (e.g., soldered, sintered, press-fitted, etc.) directly or indirectly to flat surfaces of respective phase bus bars 418fba1 and 418fbb1, and die clip terminals 344 that may be electrically and thermally connected (e.g., soldered, sintered, press-fitted, etc.) directly or indirectly to a flat surface or respective flat surfaces of V− bus bar 412ofb. Packaged switches 247dL of converter portion FB2 may have die substrate terminals 230 that may be electrically and thermally connected (e.g., soldered, sintered, press-fitted, etc.) directly or indirectly to flat surfaces of respective phase bus bars 418fba2 and 418fbb2, and die clip terminals 344 that may be electrically and thermally connected (e.g., soldered, sintered, press-fitted, etc.) directly or indirectly to a flat surface or respective flat surfaces of V− bus bar 412ofb. Packaged switches 247dH of converter portion FB3 may have die substrate terminals 230 that may be electrically and thermally connected (e.g., soldered, sintered, press-fitted, etc.) directly or indirectly to a flat surface or respective flat surfaces of V+ bus bar 417fb, and die clip terminals 344 that may be electrically and thermally connected (e.g., soldered, sintered, press-fitted, etc.) directly or indirectly to flat surfaces of respective phase bus bars 418fbb3 and 418fba3, which in turn may be electrically connected to terminals of inductor Ls and transformer T as shown. Packaged switches 247dL of converter portion FB3 may have die substrate terminals 230 that may be electrically and thermally connected (e.g., soldered, sintered, press-fitted, etc.) directly or indirectly to flat surfaces of respective phase bus bars 418fba3 and 418fbb3, and die clip terminals 344 that may be electrically and thermally connected (e.g., soldered, sintered, press-fitted, etc.) directly or indirectly to a flat surface or respective flat surfaces of V− bus bar 412fb.

Bus bars, like V+ bus bar 417ofb, V− bus bar 412ofb, V+ bus bar 417fb, V− bus bar 412fb and phase bus bars 418fb, may have a generally rectangular cuboid shape. Example phase bus bars 418fb may have a height, width, and length around 12 mm, 25 mm, and 20 mm, respectively. Example V+ bus bar 417fb and V− bus bar 412fb may have a height, width, and length around 8 mm, 25 mm, and 45 mm, respectively. Example V+ bus bar 417ofb and V− bus bar 412ofb may have a height, width, and length around 8 mm, 25 mm, and 95 mm, respectively. FIGS. 5R-2 and 5R-3 show the height and width of the bus bars.

FIGS. 5R-1 and 5R-2 show converter 460obc with dielectric tubes 420a received in bus bars. Tubes other than 420a can be received by the bus bars. For example, the six aligned bus bars 418fb can be formed by soldering metal bus bar portions around tubes like tubes 420g, but with six metal layers 407p instead of three, using a process like the process described with reference to FIGS. 5A-11-5A-15 in which six groups of metal bus bar portions 505 and 509 are soldered around the six metal layers 407p, respectively. The two aligned bus bars 417ofb and 417fb can be formed by soldering metal bus bar portions around tubes like tubes 420g, but with two unequally sized metal layers 407p instead of three equally sized metal layers 407p, using a process like the process described with reference to FIGS. 5A-17-6-5A-17-10 in which two pairs metal bus bar portions 505 and 509 are soldered around the two unequally sized metal layers 407p, respectively. The two aligned bus bars 412ofb and 412fb can be formed by soldering metal bus bar portions around tubes like tubes 420g, but with unequally sized two metal layers 407p instead of three equally sized metal layers 407p, using a process like the process described with reference to FIGS. 5A-17-6-5A-17-10 in which pairs of metal bus bar portions 505 and 509 are soldered around respective metal layers 407p.

With continuing reference to FIGS. 5R-2 and 5R-3, FIG. 5R-1 shows that all phase bus bars 418fb of converter 460obc may be thermally connected to each other and electrically isolated from each other by commonly received dielectric tubes 420a. V+ bus bars 417fb and 417ofb may be thermally connected to each other and electrically isolated from each other by commonly received dielectric tubes 420a. V− bus bars 412fb and 412ofb may be thermally connected to each other and electrically isolated from each other by commonly received dielectric tubes 420a.

Converter 460obc may include DC link capacitors 403fb. In FIG. 5R-2, first and second metal capacitor-leads 405fb1a and 405fb1b extend from DC link capacitor 403fb1. A flat bottom surface of capacitor-lead 405fb1a may be electrically and thermally connected (e.g., welded, soldered, press-fitted by screws or other fasteners, etc.) directly to a flat surface of V+ bus bar 417ofb, and a flat top surface area of capacitor-lead 405fb 1b may be electrically and thermally connected to a flat surface of V− bus bar 412ofb. In FIG. 5R-3, first and second metal capacitor-leads 405fb2a and 405fb2b extend from DC link capacitor 403fb2. A flat bottom surface of capacitor-lead 405fb2a may be electrically and thermally connected (e.g., welded, soldered, press-fitted by screws or other fasteners, etc.) directly to a flat surface of V+ bus bar 417ofb, and a flat top surface area of capacitor-lead 405fb2b may be electrically and thermally connected to a flat surface of V− bus bar 412ofb.

Converter 460obc may include one or more ceramic DC link capacitors (e.g., multilayer ceramic capacitors, not shown) with first and second metal terminals that may be electrically connected directly or indirectly to flat surfaces V+ bus bar 417obc and V− bus bar 412obc, respectively. These ceramic DC link capacitors may be mounted on driver PCB 461obc and connected in parallel, the combination of which is connected in series between V+ bus bar 417obc and V− bus bar 412obc. Ceramic DC link capacitors mounted on driver PCB 461obc may be connected between V+ bus bar 417obc and V− bus bar 412obc via traces, at least one connector-leads 288d of a high-side packaged switch 247dH of FB2, and at least one connector-lead 288dc of a low-side packaged switch 247dL of FB2. Converter 460obc may include one or more ceramic DC link capacitors (e.g., multilayer ceramic capacitors, not shown) with first and second metal terminals that may be electrically connected directly or indirectly to flat surfaces V+ bus bar 417fb and V− bus bar 412fb, respectively. These ceramic DC link capacitors may be mounted on driver PCB 461obc and connected in parallel, the combination of which is connected in series between V+ bus bar 417fb and V− bus bar 412fb. Ceramic DC link capacitors mounted on driver PCB 461obc may be connected between V+ bus bar 417fb and V− bus bar 412fb via traces, at least one connector-lead 288ds of a high-side packaged switch 247dH in FB3, and at least one connector-lead 288dc of the low-side packaged switch 247dL in FB3.

Converter 460obc may include control PCB 462obc and driver PCB 461obc. Drivers on driver PCB 461obc can control respective switches 304 through respective connector-leads 288g. Only drivers and connector-leads 288gH and 288gL of leg-b1 and leg-a3 are represented in FIGS. 5R-2 and 5R-3, respectively. Driver PCB 461obc in FIGS. 5R-2 and 5R-3 may include voltage sensors V_Sense that can sense voltages across respective pairs of connector-leads 288ds and 288dc. Example phase bus bar-lead 465b1 in FIG. 5R-2 may extend laterally between first and second ends. The first end of phase bus bar-lead 465b1 may be electrically connected to phase bus bar 418fbb1, and the second end may be electrically connected to inductor LB. Phase bus bar-lead 465b1 may extend through an aperture in PCB 461obc. Current sensor I_Sense measures electrical current flowing through phase bus bar-lead 465b1. I_Sense may include an aperture through which phase bus bar-lead 465b1 may extend. FIG. 5R-2 shows drivers 306, voltage sensors V_Sense, PMICs, current sensor I_Sense, and a phase bus bar-lead 465b1 for leg-b1 of converter portion FB1. A similar group of drivers 306, voltage sensors V_Sense, PMICs, current sensor I_Sense, and phase bus bar-lead 465 may be mounted on or extending through PCB 461obc for legs a1, a2, b2, b3, and, as shown in FIG. 5R-3, a3. FIGS. 5R-2 and 5R-3 show an MCU mounted on control PCB 461obc. The MCU may be in data communication with each driver 306, V_Sense, and I_Sense mounted on driver PCB 461obc through a data connection 484. Although not shown, snubber capacitors can be mounted on driver PCB 461oba and electrically connected in parallel with respective switches 304d via respective pairs of connector-leads 288ds and 288dc.

All tubes 420, such as tubes 420a in FIG. 5R-1, received in all bus bars of converter 460obc may be substantially equal in length. Although not shown in FIGS. 5R-1-5R-3, first and second manifolds like manifolds 466iT, may be in fluid communication with first and second ends, respectively, of tubes 420a.

Liquid dielectric material such as epoxy, silicon, etc., can be added to air gaps or empty spaces between adjacent electrical conductors of converter 460obc, including electrical conductors of naked packaged switches 247 if employed, and then cured to create structures that suppress dendrite growth and electrical arcing therebetween.

Converter 460obc may be connected between a DC power supply such as battery BT1 and a grid connection φ. Converter 460obc operating in the forward direction can convert AC power provided at grid connection φ into DC power for charging battery BT1. Converter 460obc operating in the reverse direction can convert DC power provided by battery BT1 into AC power for transmission to the grid through grid connection φ. In an alternative embodiment, battery BT1 can be replaced by another DC power supply like an such as inverter 460iT. In this alternative embodiment, bus bars 417fb and 412fb can be electrically connected to bus bars 417T and 412T, respectively, of inverter 460iT.

Battery chargers can be unidirectional. FIGS. 5R-4-5R-6 illustrate an example unidirectional battery charger 460uobc. Battery charger 460uobc may be like converter 460obc with packaged switches 247d in legs a1, a3, and b3 replaced with packaged diodes 245M. Battery charger 460uobc may be employed in an EV as an OBC, it being understood battery charger 460uobc should not be limited thereto. Charger 460uobc can be external to an EV and used for providing DC power to EVs or for other purposes.

FIGS. 5R-4-5R-6 illustrate relevant components of example battery charger 460uobc when seen from the front, left, and right sides, respectively. Battery charger 460uobc may include packaged switches 247d and packaged diodes 245M, it being understood that in an alternative version packaged switches 247d may be replaced by packaged switches 247p or packaged switches 247q and/or packaged diodes 245M can be replaced by packaged diode 245N. All packaged switches 247 of battery charger 460uobc may be the same type. Packaged switches 247d of battery charger 460uobc may be packaged switch 247dA, 247dB, or 247dD of FIGS. 3A, 3B, and 3D, respectively.

Leg-a1 may include packaged diodes 245MH and 245ML that may be electrically and thermally connected to a respective phase bus bar 418fb, which in combination may be sandwiched between V+ bus bar 417ofb and V− bus bar 412ofb. Packaged diodes 245MH and 245ML in leg-a1 may be also electrically and thermally connected to V+ bus bar 417ofb and V-bus bar 412ofb, respectively. Each leg of converter portion FB3 may include packaged diodes 245MH and 245ML that may be electrically and thermally connected to a respective phase bus bar 418fb, which in combination may be sandwiched between V+ bus bar 417fb and V− bus bar 412fb. Packaged diodes 245MH and 245ML in converter portion FB3 may be also electrically and thermally connected to V+ bus bar 417fb and V− bus bar 412fb, respectively.

FIG. 5R-4 illustrates the relative positioning of packaged switches 247d, packaged diodes 245M, V+ bus bar 417ofb, V− bus bar 412ofb, V+ bus bar 417fb, V− bus bar 412fb, and phase bus bars 418fb with respect to each other. Die substrate terminals 230 and die clip terminals 344 may be pressed-fitted, soldered, sintered, welded, or connected by other means directly to corresponding flat surfaces of bus bars to establish thermal and electrical connectivity. Packaged diode 245MH in leg-a1 of FIG. 5R-4 may have a die substrate terminal 230 that may be electrically and thermally connected (e.g., soldered, sintered, press-fitted, etc.) directly or indirectly to a flat surface of V+ bus bar 417ofb. Die clip terminal 344 of diode 245MH in leg-a1 may be electrically and thermally connected (e.g., soldered, sintered, press-fitted, etc.) directly or indirectly to a flat surface of phase bus bar 418fba1, which in turn may be electrically connected to the EMI filter which may include a transformer (e.g., a choke) electrically connected to attenuate common mode current in charger 460uobc. Packaged diode 245ML of converter portion FB1 may have die substrate terminals 230 that may be electrically and thermally connected (e.g., soldered, sintered, press-fitted, etc.) directly or indirectly to a flat surface of phase bus bar 418fba1, and die clip terminal 344 that may be electrically and thermally connected (e.g., soldered, sintered, press-fitted, etc.) directly or indirectly to a flat surface of V− bus bar 412ofb. Packaged diodes 245MH of converter portion FB3 may have die substrate terminals 230 that may be electrically and thermally connected (e.g., soldered, sintered, press-fitted, etc.) directly or indirectly to a flat surface or respective flat surfaces of V+ bus bar 417fb, and die clip terminals 344 that may be electrically and thermally connected (e.g., soldered, sintered, press-fitted, etc.) directly or indirectly to flat surfaces of respective phase bus bars 418fbb3 and 418fba3, respectively, which in turn may be electrically connected to respective terminals of transformer T as shown. Packaged diodes 245ML of converter portion FB3 may have die substrate terminals 230 that may be electrically and thermally connected (e.g., soldered, sintered, press-fitted, etc.) directly or indirectly to flat surfaces of respective phase bus bars 418fba3 and 418fbb3, and die clip terminals 344 that may be electrically and thermally connected (e.g., soldered, sintered, press-fitted, etc.) directly or indirectly to a flat surface or respective flat surfaces of V− bus bar 412fb. FIG. 5R-4 shows phase bus bar 418fbb3 electrically connected directly to the bottom terminal of transformer T on the secondary side, and phase bus bar 418fba3 electrically connected directly to the top terminal of transformer T on the secondary side. In an alternative embodiment, phase bus bar 418fbb3 may be electrically connected directly to the top terminal of transformer T on the secondary side, and phase bus bar 418fba3 may be electrically connected directly to the bottom terminal of transformer T on the secondary side. Cp could be eliminated so that Lp is directly connected between transformer T and phase bus bar 418fbb2.

Battery charger 460uobc may be connected between battery BT1 and a grid connection φ. Battery charger 460uobc can convert AC power provided by grid connection φ into DC power for charging battery BT1.

Converter 460obc of FIG. 5R-1 employs bus bars that receive tubes 420a through which a liquid may flow. In an alternative embodiment, the bus bars shown in FIGS. 5R1-5R-3 can be replaced with finned bus bars like those shown in FIGS. 5P-1-5P-6. FIGS. 5R-7-5R-9 illustrate relevant components of example dielectric fluid-cooled converter 460oair when seen from the front, left, and right sides, respectively. Several components (e.g., driver PCB 461obc, control PCB 462obc, and DC link capacitors 403ofb) are not shown in FIG. 5R-7 but can be seen in FIGS. 5R-8 and 5R-9. Converter 460oair may be employed in an EV as an OBC, it being understood converter 460oair should not be limited thereto. Converter 460oair can be external to an EV and electrically connected thereto via a charging cable.

Dielectric fluid-cooled converter 460oair may be substantially like converter 460obc with bus bars 417ofb, 412ofb, 417fb, 412fb, and 418fb replaced by finned bus bars 417oair, 412oair, 417ofb, 412ofb, and 418air, respectively. Bus bar 417oair may be a longer version of bus bar 417air. Bus bar 412oair may be a longer version of bus bar 412air. Bus bar 417ofb may be a shorter version of bus bar 417air. Bus bar 412ofb may be a shorter version of bus bar 412air.

Converter 460oair may include packaged switches 247d, it being understood that in an alternative version packaged switches 247d may be replaced by packaged switches 247p or packaged switches 247q. All packaged switches 247 of converter 460oair may be the same type. Packaged switches 247d of converter 460oair may be packaged switch 247dA, 247dB, or 247dD of FIGS. 3A, 3B, and 3D, respectively.

Converter 460oair may include V+ bus bar 417oair, V− bus bar 412oair, V+ bus bar 417ofb, V− bus bar 412ofb and phase bus bars 418air. Converter portions FB1 and FB2 of converter 460oair may be combined through common V+ and V− bus bars 417oair and 412oair.

As noted, each converter portion FB has two legs designated a and b. Each leg of converter portions FB1 and FB2 may include packaged switches 247dH and 247dL that may be electrically and thermally connected to a respective phase bus bar 418air, which in combination may be sandwiched between V+ bus bar 417oair and V− bus bar 412oair. Packaged switches 247dH and 247dL in converter portions FB1 and FB2 may be also electrically and thermally connected to V+ bus bar 417oair and V− bus bar 412oair, respectively. Each leg of converter portion FB3 may include packaged switches 247dH and 247dL that may be electrically and thermally connected to a respective phase bus bar 418air, which in combination may be sandwiched between V+ bus bar 417ofb and V− bus bar 412ofb. Packaged switches 247dH and 247dL in converter portion FB3 may be also electrically and thermally connected to V+ bus bar 417ofb and V− bus bar 412ofb, respectively. FIG. 5R-7 shows phase bus bar 418airb3 electrically connected directly to the bottom terminal of transformer T on the secondary side, and phase bus bar 418aira3 electrically connected indirectly to the top terminal of transformer T on the secondary side via Ls and Cs. In an alternative embodiment, phase bus bar 418airb3 may be electrically connected indirectly to the top terminal of transformer T on the secondary side via Ls and Cs, and phase bus bar 418aira3 may be electrically connected directly to the bottom terminal of transformer T on the secondary side. Cp could be eliminated so that Lp is directly connected between transformer T and phase bus bar 418airb2, and Cs could be eliminated so that Ls is directly connected between transformer T and phase bus bar 418aira3.

FIG. 5R-7 illustrates the relative positioning of packaged switches 247d, V+ bus bar 417oair, V− bus bar 412oair, V+ bus bar 417ofb, V− bus bar 412ofb, and phase bus bars 418air with respect to each other. Die substrate terminals 230 and die clip terminals 344 may be pressed-fitted, soldered, sintered, welded, or connected by other means directly to corresponding flat surfaces of finned bus bars to establish thermal and electrical connectivity. Packaged switches 247dH of converter portions FB1 and FB2 of FIG. 5R-7 may have die substrate terminals 230 that may be electrically and thermally connected (e.g., soldered, sintered, press-fitted, etc.) directly or indirectly to a flat surface or respective flat surfaces of V+ bus bar 417oair. Die clip terminals 344 of converter portion FB1 may be electrically and thermally connected (e.g., soldered, sintered, press-fitted, etc.) directly or indirectly to flat surfaces of respective phase bus bars 418aira1 and 418airb1, which in turn may be electrically connected to inductor LB and the EMI filter, which may include a transformer (e.g., a unitary turns ratio transformer with a core that lacks a gap similar to transformer 451) electrically connected to attenuate common mode current in 460oair. Die clip terminals 344 of converter portion FB2 may be electrically and thermally connected (e.g., soldered, sintered, press-fitted, etc.) directly or indirectly to flat surfaces of respective phase bus bars 418aira2 and 418airb2, which in turn may be electrically connected to inductor Lp and transformer T as shown. Packaged switches 247dL of converter portion FB1 may have die substrate terminals 230 that may be electrically and thermally connected (e.g., soldered, sintered, press-fitted, etc.) directly or indirectly to flat surfaces of respective phase bus bars 418aira1 and 418airb1, and die clip terminals 344 that may be electrically and thermally connected (e.g., soldered, sintered, press-fitted, etc.) directly or indirectly to a flat surface or respective flat surfaces of V− bus bar 412oair. Packaged switches 247dL of converter portion FB2 may have die clip terminals 230 that may be electrically and thermally connected (e.g., soldered, sintered, press-fitted, etc.) directly or indirectly to flat surfaces of respective phase bus bars 418aira2 and 418airb2, and die clip terminals 344 that may be electrically and thermally connected (e.g., soldered, sintered, press-fitted, etc.) directly or indirectly to a flat surface or respective flat surfaces of V− bus bar 412oair. Packaged switches 247dH of converter portion FB3 may have die substrate terminals 230 that may be electrically and thermally connected (e.g., soldered, sintered, press-fitted, etc.) directly or indirectly to a flat surface or respective flat surfaces of V+ bus bar 417ofb, and die clip terminals 344 that may be electrically and thermally connected (e.g., soldered, sintered, press-fitted, etc.) directly or indirectly to flat surfaces of respective phase bus bars 418airb3 and 418aira3, which in turn may be electrically connected to inductor Ls and transformer T as shown. Packaged switches 247dL of converter portion FB3 may have die substrate terminals 230 that may be electrically and thermally connected (e.g., soldered, sintered, press-fitted, etc.) directly or indirectly to flat surfaces of respective phase bus bars 418aira3 and 418airb3, and die clip terminals 344 that may be electrically and thermally connected (e.g., soldered, sintered, press-fitted, etc.) directly or indirectly to a flat surface or respective flat surfaces of V− bus bar 412ofb.

V+ bus bar 417oair, V− bus bar 412oair, V+ bus bar 417ofb, V− bus bar 412ofb and phase bus bars 418air, may have a rectangular tube shape. Example phase bus bars 418air may have a height, width, and length around 20 mm, 25 mm, and 20 mm, respectively. Example V+ bus bar 417ofb and V− bus bar 412ofb may have a height, width, and length around 16 mm, 25 mm, and 45 mm, respectively. Example V+ bus bar 417oair and V− bus bar 412oair may have a height, width, and length around 16 mm, 25 mm, and 95 mm, respectively. FIG. 5R-7 shows the height and length of the bus bars.

Finned bus bars 412oair and 417oair may be like finned bus bar 412tair of FIGS. 5P-1-5P-6, but longer. Finned bus bars 412ofb and 417ofb may be like finned bus bar 412tair of FIGS. 5P-1-5P-6, but shorter. Couplings 532 and 533 may be connected (e.g., glued) between adjacent finned bus bars in FIG. 5R-7. Couplings 532 and 533 can pass fluid between adjacent bus bars. Couplings 532 and 533 fluidly connect adjacent finned bus bars while electrically isolating the adjacent finned bus bars. Phase bus bars may be thermally connected to each other and electrically isolated from each other by couplings 532. Couplings 532a-532e may be like the couplings 532 in FIGS. 5P-1-5P-6. However, coupling 532d may be longer than couplings 532a-532c and 532e. V+ bus bars 417oair and 417ofb may be thermally connected to each other and electrically isolated from each other by couplings 533a. V− bus bars 412oair and 412ofb may be thermally connected to each other and electrically isolated from each other by coupling 533b. Couplings 533 may be like coupling 532d with a smaller height to accommodate the smaller heights of finned bus bars 412ofb and 417ofb relative to the height of phase bus bars 418air.

Converter 460oair may include DC link capacitors 403ofb. In FIG. 5R-8, first and second metal capacitor-leads 405fb1a and 405fb1b extend from DC link capacitor 403ofb1. A flat bottom surface of capacitor-lead 405fb1a may be electrically and thermally connected (e.g., welded, soldered, press-fitted by screws or other fasteners, etc.) directly to a flat surface of V+ bus bar 417oair, and a flat top surface area of capacitor-lead 405fb1b may be electrically and thermally connected to a flat surface of V− bus bar 412oair. In FIG. 5R-9, first and second metal capacitor-leads 405fb2a and 405fb2b extend from DC link capacitor 403ofb2. A flat bottom surface of capacitor-lead 405fb2a may be electrically and thermally connected (e.g., welded, soldered, press-fitted by screws or other fasteners, etc.) directly to a flat surface of V+ bus bar 417ofb, and a flat top surface area of capacitor-lead 405fb2b may be electrically and thermally connected to a flat surface of V− bus bar 412ofb.

One or more ceramic DC link capacitors may be electrically and thermally connected between V+ bus bar 417oair and V− bus bar 412oair. The one or more ceramic DC link capacitors may have first and second metal terminals that may be electrically and thermally connected to a flat surface of V+ bus bar 417oair and V− bus bar 412oair, respectively. One or more ceramic DC link capacitors may be electrically and thermally connected between V+ bus bar 417ofb and V− bus bar 412ofb. The one or more ceramic DC link capacitors may have first and second metal terminals that may be electrically and thermally connected to a flat surface of V+ bus bar 417ofb and V− bus bar 412ofb, respectively

Converter 460oair may include control PCB 462obc and driver PCB 461obc. Drivers on driver PCB 461obc can control respective switches 304 through respective connector-leads 288g. Only drivers and connector-leads 288gH and 288gL of leg-b1 and leg-a3 are represented in FIGS. 5R-8 and 5R-9. Driver PCB 461obc in FIGS. 5R-8 and 5R-9 may include voltage sensors V_Sense that can sense voltages between respective pairs of connector-leads 288ds and 288dc. Example phase bus bar-lead 465b1 in FIG. 5R-8 may extend laterally between first and second ends. The first end of phase bus bar-lead 465b1 may be electrically connected to phase bus bar 418airb1, and the second end may be electrically connected to inductor LB. Phase bus bar-lead 465b1 may extend through an aperture in PCB 461obc. Current sensor I_Sense measures electrical current flowing through phase bus bar-lead 465b1. I_Sense may include an aperture through which phase bus bar-lead 465b1 may extend. FIG. 5R-8 shows drivers 306, voltage sensors V_Sense, PMICs, current sensor I_Sense, and a phase bus bar-lead 465b1 for leg-b1 of converter portion FB1. A similar group of drivers 306, voltage sensors V_Sense, PMICs, current sensor I_Sense, and phase bus bar-leads 465 may be mounted on or extending through PCB 461obc for legs a1, a2, b2, b3, and, as shown in FIG. 5R-9, a3. FIGS. 5R-8 and 5R-9 show an MCU mounted on control PCB 461obc. The MCU may be in data communication with each driver 306, V_Sense, and I_Sense mounted on driver PCB 461obc through a data connection 484. Although not shown, snubber capacitors can be mounted on driver PCB 461obc and electrically connected in parallel with respective switches 304d via respective pairs of connector-leads 288ds and 288dc.

Liquid dielectric material such as epoxy, silicon, etc., can be added to air gaps or empty spaces between electrical conductors of converter 460oair, including adjacent electrical conductors of naked packaged switches 247 if they are employed, to suppress dendrite growth and electrical arcing therebetween, and subsequently cured.

Converter 460oair may be connected between a DC supply such as battery BT1 and an AC power grid connection φ. Converter 460oair operating in the forward direction can convert AC power provided at grid connection φ into DC power for charging battery BT1. Converter 460oair operating in the reverse direction can convert DC power provided by battery BT1 into AC power for transmission to the grid through grid connection φ. In an alternative embodiment, battery BT1 can be replaced by another DC power supply like an such as inverter 460iT. In this alternative embodiment, bus bars 417ofb and 4102fb can be electrically connected to bus bars 417T and 412T, respectively, of inverter 460iT.

Air is shown flowing through the channels of bus bars of converter 460oair. Alternatively, dielectric liquid (e.g., oil, deionized water, etc.) can flow through these channels.

FIGS. 5R-10-5R-12 illustrate an example unidirectional battery charger 460uair. Battery charger 460uair may be like converter 460oair with packaged switches 247d in legs a1, a3, and b3 replaced with packaged diodes 245M. Battery charger 460uair may be employed in an EV as an OBC, it being understood battery charger 460uair should not be limited thereto. Charger 460uobc can be external to an EV and used for providing DC power to EVs or for other purposes.

FIGS. 5R-10-5R-12 illustrate relevant components of example battery charger 460uair when seen from the front, left, and right sides, respectively. Battery charger 460uair may include packaged switches 247d and packaged diodes 245M, it being understood that in an alternative version packaged switches 247d may be replaced by packaged switches 247p or packaged switches 247q and/or packaged diodes 245M can be replaced by packaged diode 245N. All packaged switches 247 of battery charger 460uair may be the same type. Packaged switches 247d of battery charger 460uair may be packaged switch 247dA, 247dB, or 247dD of FIGS. 3A, 3B, and 3D, respectively.

Leg-a1 may include packaged diodes 245MH and 245ML that may be electrically and thermally connected to a phase bus bar 418aira1, which in combination may be sandwiched between V+ bus bar 417oair and V− bus bar 412oair. Packaged diodes 245MH and 245ML in leg-a1 may be also electrically and thermally connected to V+ bus bar 417oair and V− bus bar 412oair, respectively. Each leg of converter portion FBU3 may include packaged diodes 245MH and 245ML that may be electrically and thermally connected to a respective phase bus bar 418air, which in combination may be sandwiched between V+ bus bar 417ofb and V− bus bar 412fb. Packaged diodes 245MH and 245ML in converter portion FB3 may be also electrically and thermally connected to V+ bus bar 417ofb and V− bus bar 412ofb, respectively.

FIG. 5R-10 illustrates the relative positioning of packaged switches 247d, packaged diodes 245M, V+ bus bar 417oair, V− bus bar 412oair, V+ bus bar 417ofb, V− bus bar 412ofb, and phase bus bars 418air with respect to each other. Die substrate terminals 230 and die clip terminals 344 may be pressed-fitted, soldered, sintered, welded, or connected by other means directly to corresponding flat surfaces of bus bars to establish thermal and electrical connectivity. Packaged diode 245MH in leg-a1 of FIG. 5R-10 may have a die substrate terminal 230 that may be electrically and thermally connected (e.g., soldered, sintered, press-fitted, etc.) directly or indirectly to a flat surface of V+ bus bar 417oair. Die clip terminal 344 of diode 245MH in leg-a1 may be electrically and thermally connected (e.g., soldered, sintered, press-fitted, etc.) directly or indirectly to a flat surface of phase bus bar 418aira1, which in turn may be electrically connected to the EMI filter as shown. Packaged diode 245ML of converter portion FB1 may have die substrate terminals 230 that may be electrically and thermally connected (e.g., soldered, sintered, press-fitted, etc.) directly or indirectly to a flat surface of phase bus bar 418fba1, and die clip terminal 344 that may be electrically and thermally connected (e.g., soldered, sintered, press-fitted, etc.) directly or indirectly to a flat surface of V− bus bar 412oair. Packaged diodes 245MH of converter portion FBU3 may have die substrate terminals 230 that may be electrically and thermally connected (e.g., soldered, sintered, press-fitted, etc.) directly or indirectly to a flat surface or respective flat surfaces of V+ bus bar 417ofb, and die clip terminals 344 that may be electrically and thermally connected (e.g., soldered, sintered, press-fitted, etc.) directly or indirectly to flat surfaces of respective phase bus bars 418airb3 and 418aira3, which in turn may be electrically connected to terminals of transformer T as shown. Packaged diodes 245ML of converter portion FBU3 may have die substrate terminals 230 that may be electrically and thermally connected (e.g., soldered, sintered, press-fitted, etc.) directly or indirectly to flat surfaces of respective phase bus bars 418aira3 and 418airb3, and die clip terminals 344 that may be electrically and thermally connected (e.g., soldered, sintered, press-fitted, etc.) directly or indirectly to a flat surface or respective flat surfaces of V− bus bar 412ofb. FIG. 5R-10 shows phase bus bar 418airb3 electrically connected directly to the bottom terminal of transformer T on the secondary side, and phase bus bar 418aira3 electrically connected directly to the top terminal of transformer T on the secondary side. In an alternative embodiment, phase bus bar 418airb3 may be electrically connected directly to the top terminal of transformer T on the secondary side, and phase bus bar 418aira3 may be electrically connected directly to the bottom terminal of transformer T on the secondary side. Cp could be eliminated so that Lp is directly connected between transformer T and phase bus bar 418airb2.

Battery charger 460uair may be connected between battery BT1 and a grid connection φ through inductor LB and an EMI filter, which may include a transformer (e.g., a unitary turns ratio transformer with a core that lacks a gap like transformer 451) electrically connected and configured to attenuate common mode current in 460uair. Battery charger 460uair can convert AC power provided by grid connection φ into DC power for charging battery BT1.

Air is shown flowing through the channels of bus bars of charger 460uair. Alternatively, dielectric liquid (e.g., oil, deionized water, etc.) can flow through these channels.

Several power converters described above have high-side and low-side packaged switches connected to opposite facing sides of a phase bus bar, the combination of which may be sandwiched between V+ and V− bus bars. Power converters may have high-side and low-side packaged power switches that may be connected to the same side of a phase bus bar. FIGS. 5S-1-5S-3 illustrate front, back and side views of an example three-phase inverter 460hiT in which high-side and low-side packaged switches may be connected to the same side of a respective phase bus bar as shown. Several components (e.g., driver PCBs 461hi, control PCB 462hi, shield 432-2, DC link capacitors 403hT and 433-1) shown in FIG. 5S-3 are not shown or fully shown in FIGS. 5S-1 and 5S-2 but are described below.

Inverter 460hiT may be connected to windings Wa-Wc. Example inverter 460hiT is shown with packaged switches 247d, it being understood that in an alternative version switches 247d can be replaced with packaged switches 247p or packaged switches 247q. All packaged switches 247 of inverter 460hiT may be the same type. Packaged switches 247d of inverter 460hiT may be packaged switch 247dA, 247dB, or 247dD of FIGS. 3A, 3B, and 3D, respectively.

Inverter 460hiT may include V+ bus bar 417T, V− bus bar 412T, and phase bus bars 418hT. FIGS. 5S-1-5S-3 illustrate the relative positioning of packaged switches 247d, V+ bus bar 417T, phase bus bars 418hT, and V− bus bar 412T with respect to each other.

Inverter 460hiT has three legs designated a-c. Each leg in FIGS. 5S-1 and 5S-2 may include packaged switches 247dH and 247dL that may be electrically and thermally connected to a common flat surface of a respective phase bus bar 418hT. Packaged switches 247dH and 247dL in each leg may also be electrically and thermally connected to V+ bus bar 417T and V-bus bar 412T, respectively. Packaged switches 247dH and 247dL in each leg of inverter 460hiT may be positioned side-by-side on a common phase bus bar 418hT. Packaged switches 247dH and 247dL in each leg may be electrically connected in series through a phase bus bar 418hT. More specifically, in each phase, die clip terminal 344 of packaged switch 247dH may be electrically connected to die substrate terminal 230 of packaged switch 247dL.

As seen in FIG. 5S-1 packaged switches 247dH may have die substrate terminals 230 that may be electrically and thermally connected (e.g., soldered, sintered, press-fitted, etc.) to a flat surface or respective flat surfaces of V+ bus bar 417T, and die clip terminals 344 that may be electrically and thermally connected (e.g., soldered, sintered, press-fitted, etc.) to flat surfaces of respective phase bus bars 418hTa-418hTc, which in turn may be electrically connected to windings Wa-Wc, respectively. As seen in FIG. 5S-2, packaged switches 247dL may have die substrate terminals 230 that may be electrically and thermally connected (e.g., soldered, sintered, press-fitted, etc.) to flat surfaces of respective phase bus bars 418hTa-418Tc, and die clip terminals 344 that may be electrically and thermally connected (e.g., soldered, sintered, press-fitted, etc.) to a flat surface or respective flat surfaces of V− bus bar 412T.

Bus bars, like V+ bus bar 417T, V− bus bar 412T, and phase bus bars 418T in FIGS. 5S-1 and 5S-2, may have a generally rectangular cuboid shape. Example phase bus bars 418hT may have a height, width, and length around 8 mm, 55 mm, and 20 mm, respectively. Example V+ bus bar 417T and V− bus bar 412T may have a height, width, and length around 8 mm, 25 mm, and 75 mm, respectively.

FIGS. 5S-1-5S-3 show inverter 460hiT with tubes 420a received in bus bars. Tubes other than 420a can be received by the bus bars. For example, each of bus bars 412T and 417T can be formed by soldering metal bus bar portions around tubes 420d or 420e using a process like that described with reference to FIGS. 5A-17-1-5A-17-5, and bus bars 418hT can be formed by soldering metal bus bar portions around tubes 420g using a process like that described with reference to FIGS. 5A-17-6-5A-17-10. Or the bus bars can be swapped with bus bars formed around tubes like tubes 420v1 using a process like that described with reference to FIGS. 9A-30-9A-33 or FIGS. 9A-34-9A-37. All phase bus bars 418hT may be thermally connected to each other and electrically isolated from each other by commonly received tubes.

FIGS. 5S-1 and 5S-2 include electrical current symbols that represent electrical current flow through the inverter 460hiT at an instant in time. More particularly, FIG. 5S-1 shows electrical current flow through activated switch 304dH in packaged switch 247dH of leg-a, while FIG. 5S-2 shows switches 304dL in packages 247dL of legs b and c may be activated and conducting current to the V-terminal through the V− bus bar 412T. All other switches may be deactivated.

Inverter 460hiT may include DC link capacitors 403hT-1 and 403hT-2. First and second metal capacitor-leads 405hia-1 and 405hib-1 may extend from capacitor 403hT-1. First and second metal capacitor-leads 405hia-2 and 405hib-2 may extend from capacitors 403hT-2. As shown in FIG. 5S-3, bent portions 601a and 601b may be integrated with and extend at right angles from first and second metal capacitor-leads 405hia and 405hib, respectively. Bent portions 601a and 601b of capacitor-leads 405hia and 405hib, respectively, may have a height, length, and width around 6 mm, 20 mm, and 10 mm, respectively. The flat bottom surface areas of bent portions 601a and 601b may be electrically and thermally connected (e.g., welded, soldered, press-fitted by screws or other fasteners, etc.) directly to flat surfaces of V− bus bar 412T and V+ bus bar 417T, respectively.

Inverter 460hiT may include one or more ceramic DC link capacitors (e.g., multilayer ceramic capacitors) with first and second metal terminals that may be electrically and thermally connected directly or indirectly to flat surfaces V+ bus bar 417T and V− bus bar 412T, respectively. FIG. 5S-3 shows ceramic capacitors 433 mounted on PCB 435w. Terminals of ceramic capacitors 433 may be electrically and thermally connected to flat surfaces V+ bus bar 417T and V− bus bar 412T via PCB 435w.

With continuing reference to FIG. 5S-3, inverter 460hiT may include driver PCBs 461hiL and 461hiH with drivers 306 that control respective switches 304 through respective connector-leads 288g. Only connector-leads 288g of leg-c are represented in FIG. 5S-3. Driver PCBs 461hiL and 461hiH may include surface mounted snubber capacitors (e.g., multilayer ceramic capacitors, not shown) that are connected in parallel with respective switches 304 through respective sets of connector-leads 288ds and 288dc (not shown). Inverter 460hiT may include a control PCB 462hi with an MCU that may be in data communication with drivers 306, current sensors I_Sense, voltage sensors V_Sense, and other components mounted on control PCB 462hi, driver PCB 461hiL and driver PCB 461hiH. Data connections 484L and 484H may facilitate data communication between driver PCBs 461hi and control PCB 462hi.

Driver PCB 461hiL in FIG. 5S-3 may include a driver 306 that can send transistor control signals to packaged switch 247dL of leg-c through a connector-lead 288g. Although not shown, driver PCB 461hiL also may include drivers that can send transistor control signals to packaged switches 247dL in legs a and b. Driver PCB 461hiH may include a driver 306 that can send transistor control signals to packaged switch 247dH of leg-c through a connector-lead 288g. Although not shown, driver PCB 461hiH also may include drivers that can send transistor control signals to respective packaged switches 247dH in legs a and b.

Control PCB 462hi may include voltage sensors V_Sense that can sense voltages across respective packaged switches 247dH and 247dL for leg-c via respective pairs of connector-leads 288ds and 288dc (not shown) and data connections 484H and 484L. Similar groups of voltage sensors V_Sense may be mounted on control PCB 462hi for legs a and b.

Example phase bus bar-lead 465c may extend laterally between first and second ends. The first end of phase bus bar-lead 465c may be electrically connected to phase bus bar 418hTc, and the second end may be electrically connected to winding Wc. Phase bus bar-lead 465c may extend through an aperture in PCB 461hiH. Current sensor I_Sense measures electrical current flowing through phase bus bar-lead 465c. I_Sense may include an aperture through which phase bus bar-lead 465c may extend. FIG. 5S-3 shows I_sense and phase bus bar-lead 465c for leg-c. Similar groups of current sensors I_Sense and phase bus bar-leads may be mounted on or extending through PCB 461hiH for legs a and b. A thin (e.g., 20, 10, 5, 4 mm or less) plate-like shield 432-2 may be positioned between bus bars 418hT on one side and PCB 462hi on the other side as shown in FIG. 5S-3. Shield 432-2 may have oppositely facing, substantially flat surfaces as shown. Shield 432-2 may be formed (e.g., stamped, cut, etc.) from a sheet of metal or other electrically conductive material. Shield 432-2 may be as wide or wider than the phase bus bars 418hT as shown in FIG. 5S-3. Shield 432-2 may be as long or longer than bus bars 412T and 417T. Although not shown, shield 432-2 may be electrically connected to V− bus bar 412T. Shield 432-2 can act as a Faraday shield and mitigate capacitive coupling or other adverse effects the phase bus bars 418ht may have on components mounted on control PCB 462hi such as the MCU and voltage sensors V_Sense.

All tubes 420, such as tubes 420a in FIG. 5S-1, received in all bus bars of inverter 460hiT may be substantially equal in length. Although not shown in FIGS. 5S-1-5S-3, first and second manifolds may be in fluid communication with first and second ends, respectively, of tubes 420a.

Liquid dielectric material such as epoxy, silicon, etc., can be added to air gaps or empty spaces between electrical conductors of inverter 460hiT, including adjacent electrical conductors of naked packaged switches 247 if employed, and then cured to create structures that suppress dendrite growth and electrical arcing therebetween.

FIGS. 5S-4-5S-6 illustrate relevant components of an example full bridge converter 460hfb when seen from the front, back, and side, respectively. Full bridge converter 460hfb is shown connected to a load 468.

Converter 460hfb may include packaged switches 247d, it being understood that in an alternative version packaged switches 247d may be replaced by packaged switches 247p or packaged switches 247q.

All packaged switches 247 of converter 460hfb may be the same type. Packaged switches 247d of converter 460hfb may be packaged switch 247dA, 247dB, or 247dD of FIG. 3A, 3B, and 3D, respectively.

Converter 460hfb may include V+ bus bar 417fb, V− bus bar 412fb, and phase bus bars 418hfb. Case surfaces of packaged switches 247 may be thermally connected to flat surfaces of bus bars, like V+ bus bar 417fb, V− bus bar 412fb, and phase bus bars 418hfb.

Converter 460hfb has two legs designated a and b. Each leg in FIGS. 5S-4 and 5S-5 may include packaged switches 247dH and 247dL that may be electrically and thermally connected to a common flat surface of a respective phase bus bar 418hT. Packaged switches 247dH and 247dL in each leg may also be electrically and thermally connected to V+ bus bar 417fb and V− bus bar 412fb, respectively. Packaged switches 247dH and 247dL in each leg of converter 460hfb may be positioned side-by-side on a common phase bus bar 418hT. Packaged switches 247dH and 247dL in each leg may be electrically connected in series through a phase bus bar 418hT.

As seen in FIG. 5S-4 packaged switches 247dH may have die substrate terminals 230 that may be electrically and thermally connected (e.g., soldered, sintered, press-fitted, etc.) to a flat surface or respective flat surfaces of V+ bus bar 417fb, and die clip terminals 344 that may be electrically and thermally connected (e.g., soldered, sintered, press-fitted, etc.) to flat surfaces of respective phase bus bars 418hTa and 418hTb, which in turn may be electrically connected to terminals of a load. As seen in FIG. 5S-5, packaged switches 247dL may have die substrate terminals 230 that may be electrically and thermally connected (e.g., soldered, sintered, press-fitted, etc.) to flat surfaces of respective phase bus bars 418hTa and 418Tb, and die clip terminals 344 that may be electrically and thermally connected (e.g., soldered, sintered, press-fitted, etc.) to a flat surface or respective flat surfaces of V− bus bar 412fb.

Bus bars, like V+ bus bar 417fb, V− bus bar 412fb, and phase bus bars 418hT in FIGS. 5S-4 and 5G-5, may have a generally rectangular cuboid shape. Example V+ bus bar 417fb and V− bus bar 412fb may have a height, width, and length around 8 mm, 25 mm, and 45 mm, respectively.

FIGS. 5S-4-5S-6 show converter 460hfb with dielectric tubes 420a received in bus bars. Tubes other than 420a can be received by the bus bars. For example, each of DC bus bars 412fb and 417fb can be formed by soldering metal bus bar portions around tubes 420d or 420e using a process like that described with reference to FIGS. 5A-17-1-5A-17-5, and bus bars 418hT can be formed by soldering metal bus bar portions around tubes similar to tubes 420g, but with two metal layers 407p instead of three, using a process like that described with reference to FIGS. 5A-17-6-5A-17-10 in which two pairs of metal bus bar portions 505 and 509 are soldered around the two metal layers 407p, respectively. Or the bus bars can be swapped with bus bars formed around tubes like tubes 420v1 using a process like that described with reference to FIGS. 9A-30-9A-33 or FIGS. 9A-34-9A-37. Phase bus bars 418hTa and 418hTb may be thermally connected to each other and electrically isolated from each other by commonly received dielectric tubes 420a.

Converter 460hfb may include a DC link capacitors 403hT-1. First and second metal capacitor-leads 405hia-1 and 405hib-1 may extend from capacitor 403hT-1. As shown in FIG. 5S-6, bent portions 601a and 601b may be integrated with and extend at right angles from first and second metal capacitor-leads 405hia and 405hib, respectively. The flat bottom surface areas of bent portions 601a and 601b may be electrically and thermally connected (e.g., welded, soldered, press-fitted by screws or other fasteners, etc.) directly to flat surfaces of V− bus bar 412fb and V+ bus bar 417fb, respectively.

FIGS. 5S-4 and 5S-5 shows electrical current symbols that represent electrical current flow through converter 460hfb at an instant in time. More particularly, FIGS. 5S-4 and 5S-5 shows electrical current flow through activated high-side switch 304dH of leg-a, while low-side switch 304dL of leg-b is activated and conducting current to the V-terminal through the V− bus bar 412fb. All other switches 304 may be deactivated in the figures.

With continuing reference to FIG. 5S-6, converter 460hfb may include driver PCBs 461hfbL and 461hfbH with drivers 306 that control respective switches 304 through respective connector-leads 288g. Only connector-leads 288g of leg-b are represented in FIG. 5S-6. Driver PCBs 461hfbL and 461hfbH may include surface mounted snubber capacitors (e.g., multilayer ceramic capacitors, not shown) that are connected in parallel with respective switches 304 through respective sets of connector-leads 288ds and 288dc. Converter 460hfb may include a control PCB 462hfb with an MCU that may be in data communication with drivers 306, current sensors I_Sense, voltage sensors V_Sense, and other components mounted on control PCB 462hfb, driver PCB 461hfbL and driver PCB 461hfbH. Data connections 484L and 484H may facilitate data communication between driver PCBs 461hfb and control PCB 462hfb.

Driver PCB 461hfbL in FIG. 5S-3 may include a driver 306 that can send transistor control signals to packaged switch 247dL of leg-b through a connector-lead 288g. Although not shown, driver PCB 461hfbL also may include a driver that can send transistor control signals to packaged switch 247dL in leg-a. Driver PCB 461hfbH may include a driver 306 that can send transistor control signals to with packaged switch 247dH of leg-b through a connector-lead 288g. Although not shown, driver PCB 461hfbH also may include a that can send transistor control signals to a packaged switch 247dH in leg-a.

Control PCB 462hfb may include voltage sensors V_Sense for sensing voltages across respective packaged switches 247dH and 247dL of leg-b via respective pairs of connector-leads 288ds and 288dc (not shown) and data connections 484H and 484L. A similar group of voltage sensors V_Sense may be mounted on control PCB 462hfb for leg-a.

Example phase bus bar-lead 465b may extend laterally between first and second ends. The first end of phase bus bar-lead 465b may be electrically connected to phase bus bar 418hTb, and the second end may be electrically connected to the load. Phase bus bar-lead 465b may extend through an aperture in PCB 461hfbH. Current sensor I_Sense measures electrical current flowing through phase bus bar-lead 465b. I_Sense may include an aperture through which phase bus bar-lead 465b may extend. FIG. 5S-6 shows I_sense and phase bus bar-lead 465b for leg-b. A similar current sensor I_Sense and phase bus bar-lead may be mounted on or extending through PCB 461hfbH for leg-a. A thin (e.g., 20, 10, 5, 4 mm or less) plate-like shield 432-3 may be positioned between bus bars 418hT on one side and PCB 462hfb on the other side as shown in FIG. 5S-6. Shield 432-3 may have oppositely facing, substantially flat surfaces as shown. Shield 432-3 may be formed (e.g., stamped, cut, etc.) from a sheet of metal or other electrically conductive material. Shield 432-3 may be as wide or wider than the phase bus bars 418hT as shown in FIG. 5S-3. Shield 432-2 may be as long or longer than bus bars 412fb and 417fb. than the phase bus bars 418hT as shown in FIG. 5S-3. Although not shown, shield 432-2 may be electrically connected to V− bus bar 412fb. Shield 432-3 can act as a Faraday shield and mitigate capacitive coupling or other adverse effects that phase bus bars 418hT may have on components mounted on control PCB 462hfb such as the MCU and voltage sensors V_Sense.

All tubes 420, such as tubes 420a in FIG. 5S-4, received in all bus bars of battery converter 460hfb may be substantially equal in length. Although not shown in FIGS. 5S-4-5S-6, first and second manifolds may be in fluid communication with first and second ends, respectively, of tubes 420a.

Liquid dielectric material such as epoxy, silicon, etc., can be added to air gaps or empty spaces between electrical conductors of converter 460hfb, including adjacent electrical conductors of naked packaged switches 247 if employed, and then cured to create structures that suppress dendrite growth and electrical arcing therebetween.

FIGS. 5T-1-5T-4 illustrate relevant components of an example converter 400obc when seen from the front, back, left, and right sides, respectively. Converter 400obc may be employed in an EV as an OBC, it being understood converter 400obc should not be limited thereto. Converter 400obc can be external to an EV and used for charging of an EV positioned next to it, or for other purposes. Driver PCBs 461u, control PCB 462u, and DC link capacitors 403hT are shown in FIG. 5T-3 or 5T-4 but not in FIGS. 5T-1 and 5T-2. In an alternative embodiment, bus bars 417ufb and 412ufb can be electrically connected to bus bars 417T and 412T of inverter 460iT.

Referencing FIGS. 5T-1 and 5T-2, converter 400obc has seven legs designated a-c, a1, b1, a2, and b2. Legs a-c may include packaged switches 247qa-247qc, respectively, each of which may be packaged switch 247qG, 247q1, 247qJ, or 247ql of FIGS. 3G, 3I, 3J, and 3L, respectively. In an alternative version, each packaged switch 247q is replaced with packaged switch 247pK shown in FIG. 3K. Each leg a-c may also include series connected packaged diodes 245MH and 245ML. In an alternative version, each packaged diode 245M in leg a-c is replaced by packaged diode 245N. Each leg-a1 and b1 may include series connected packaged switches 247dH and 247dL. All packaged switches 247 of converter 400obc may be the same type. Each packaged switch 247d of converter 400obc may be packaged switch 247dA, 247dB, or 247dD of FIGS. 3A, 3B, and 3D, respectively. Each leg-a2 and b2 may include series connected packaged diodes 245MH and 245ML. In an alternative version, each packaged diode 245M of legs a2 and b2 is replaced by packaged diode 245N. Each of the switches 304 of converter 400obc can be independently controlled by an MCU or other data processing device. Each group of one or more transistors in each switch 247q or 247p, which is electrically connected to a respective connector-lead 288, can be independently controlled by the MCU or other data processing device.

Converter 400obc may include generally rectangular cuboid-shaped, finned bus bars including V+ bus bar 417uc, V− bus bar 412uc, V+ bus bar 417ufb, V− bus bar 412ufb, phase bus bars 418u, and bus bar 404u. Bus bar 418u may be a wider version of bus bar 418air. Bus bar 412ufb may be a shorter version of bus bar 412air. Bus bar 417uc may be a longer version of bus bar 412air. Bus bar 417ufb may be a shorter version of bus bar 412air. Bus bar 412uc may be a longer version of bus bar 412air. Bus bar 404u may be like bus bar 412air. FIGS. 5T-3 and 5T-4 may be left and right-side views of converter 400obc of FIG. 5T-1, which shows square or rectangular channels 560 or 570 through which a fluid such as air can flow through the bus bars.

Bus bar 418u may have a height, width, and length around 12 mm, 55 mm, and 20 mm, respectively. V+ bus bar 417ufb and V− bus bar 412ufb may have a height, width, and length around 12 mm, 25 mm, and 45 mm, respectively. V+ bus bar 417uc and V− bus bar 412uc may have a height, width, and length around 12 mm, 25 mm, and 125 mm, respectively. Common bus bar 404v a height, width, and length around 12 mm, 25 mm, and 70 mm, respectively. FIG. 5T-3 shows the height and width of the bus bars.

FIGS. 5T-1-5T-4 show the relative positioning of packaged switches 247q, packaged switches 247d, packaged diodes 245M, phase bus bars 418u, V− bus bar 412uc, V+ bus bar 417uc, V− bus bar 412ufb, V+ bus bar 417ufb, and bus bar 404u with respect to each other.

Packaged switches 247qa-247qc may have die substrate terminals 230 that may be electrically and thermally connected (e.g., soldered, sintered, press-fit, etc.) directly to surfaces of phase bus bars 418ua-418uc, respectively. Packaged switches 247qa-247qc may have die clip terminals 344 that may be electrically and thermally connected (e.g., soldered, sintered, press-fit, etc.) directly to a surface or respective surfaces of bus bar 404u. In an alternative version, packaged switches 247q (or substituted packaged switches 247p) may be turned upside down so that their die substrate terminals 230 may be electrically and thermally connected (e.g., soldered, sintered, press-fit, etc.) directly to a surface or respective surfaces of bus bar 404u. Phase bus bars 418ua-418uc may be electrically connected to AC sources φa-φc, respectively, via inductors La-Lc, respectively. Packaged diodes 245MH in legs a-c may have die substrate terminals 230 that may be electrically and thermally connected (e.g., soldered, sintered, press-fit, etc.) directly to surfaces or respective surfaces of V+ bus bar 417uc. Packaged 247MH in legs a-c may have die clip terminals 344 that may be electrically and thermally connected (e.g., soldered, sintered, press-fit, etc.) directly to surfaces of phase bus bars 418ua-418uc, respectively. Packaged diodes 245ML in legs a-c may have die clip terminals 344 that may be electrically and thermally connected (e.g., soldered, sintered, press-fit, etc.) directly to surfaces or respective surfaces of V− bus bar 412uc. Packaged diodes 247ML in legs a-c may have die substrate terminals 230 that may be electrically and thermally connected (e.g., soldered, sintered, press-fit, etc.) directly to surfaces of phase bus bars 418ua-418uc, respectively. Packaged switches 247dH may have die substrate terminals 230 that may be electrically and thermally connected (e.g., soldered, sintered, press-fit, etc.) directly to a surface or respective surfaces of V+ bus bar 417uc. Packaged switches 247dH may have die clip terminals 344 that may be electrically and thermally connected (e.g., soldered, sintered, press-fit, etc.) directly to surfaces of respective phase bus bars 418ua1 and 418ub1. Packaged switches 247dL may have die clip terminals 344 that may be electrically and thermally connected (e.g., soldered, sintered, press-fit, etc.) directly to a surface or respective surfaces of V− bus bar 412uc. Packaged switches 247dL may have die substrate terminals 230 that may be electrically and thermally connected (e.g., soldered, sintered, press-fit, etc.) directly to surfaces of respective phase bus bars 418ua1 and 418ub1. Packaged diodes 245MH in legs a2 and b2 may have die substrate terminals 230 that may be electrically and thermally connected (e.g., soldered, sintered, press-fit, etc.) directly to surfaces or respective surfaces of V+ bus bar 417ufb. Packaged 247MH in legs a2 and b2 may have die clip terminals 344 that may be electrically and thermally connected (e.g., soldered, sintered, press-fit, etc.) directly to respective surfaces of phase bus bars 418ua2 and 418ub2. Packaged diodes 245ML in legs a2 and b2 may have die clip terminals 344 that may be electrically and thermally connected (e.g., soldered, sintered, press-fit, etc.) directly to surfaces or respective surfaces of V− bus bar 412ufb. Packaged 247ML in legs a2 and b2 may have die substrate terminals 230 that may be electrically and thermally connected (e.g., soldered, sintered, press-fit, etc.) directly to respective surfaces of phase bus bars 418ua2 and 418ub2. FIG. 5T-1 shows phase bus bar 418ua2 electrically connected directly to the bottom terminal of transformer T on the secondary side, and phase bus bar 418ub2 electrically connected directly to the top terminal of transformer T on the secondary side. In an alternative embodiment, phase bus bar 418ua2 may be electrically connected directly to the top terminal of transformer T on the secondary side, and phase bus bar 418ub2 may be electrically connected directly to the bottom terminal of transformer T on the secondary side. Cp could be eliminated so that Lp is directly connected between transformer T and phase bus bar 418ua1.

Capacitors C− and C+ may be polar capacitors. Capacitor C+ may be electrically connected between bus bar 404u and bus bar 412uc as shown in FIGS. 5T-1 and 5T-3, and capacitor C− may be electrically connected between bus bar 404u and 417uc as shown in FIGS. 5T-2 and 5T-3. Capacitors C− and C+ may have substantially the same capacitance so that bus bar 404u is maintained at a voltage that is halfway between the voltages on bus bars 412uc and 417uc. Flat surfaces of the positive and negative terminals or leads of capacitors C− and C+, respectively, may be sintered, soldered, press-fitted, welded, or connected by other means to a flat surface or respective flat surfaces of bus bar 404u. Flat surfaces of negative and positive terminals or leads of capacitors C− and C+, respectively, may be sintered, soldered, press-fitted, welded, or connected by other means to flat surfaces of V− bus 412uc and V+ bus bar 417uc, respectively.

Converter 400obc may include driver PCB 461uH with drivers 306 that may control respective switches 304q through respective sets of connector-leads 288g1 and 288g2. Only connector-leads 288g1 and 288g2 of leg-a are represented in FIG. 5T-3. Driver PCB 461uH may include surface mounted snubber capacitors (e.g., multilayer ceramic capacitors, not shown) that are connected in parallel with respective switches 304 through respective sets of connector-leads 288ds and 288dc. Driver PCB 461uH may also include drivers 306 (not shown) that that can send transistor control signals to respective switches 304dH through respective connector-leads 288 (not shown). Driver PCB 461uL may include drivers 306 (not shown) that can send transistor control signals to respective switches 304dL through respective connector-leads 288 (not shown).

In FIG. 5T-3, driver PCBs 461uH and 461UL show voltage sensors V_Sense that can sense voltages across respective packaged switch 247qa, packaged diode 245MH, and packaged diode 245ML, respectively, via respective sets of connector-leads 288ds and 288dc (not shown) of leg-a. Driver PCB 461uH may include voltage sensors V_Sense (not shown) that can sense voltages across respective packaged switches 247qb and 247qc via respective pairs or connector-leads 288ds and 288dc (not shown). Driver PCB 461uH may include voltage sensors V_Sense for sensing voltages across respective packaged switches 247dH of legs a1 and b1 via respective pairs or connector-leads 288ds and 288dc (not shown). Driver PCB 461uH may include voltage sensors V_Sense that can sense voltages across respective packaged diodes 245MH of legs a2 and b2 via respective pairs or connector-leads 288ds and 288dc (not shown). Driver PCB 461uL may include voltage sensors V_Sense for sensing voltages across respective packaged switches 247dL of legs a1 and b1 via respective pairs or connector-leads 288ds and 288dc (not shown). Driver PCB 461uL may include voltage sensors V_Sense that can sense voltages across respective packaged diodes 245ML of legs a2 and b2 via respective pairs or connector-leads 288ds and 288dc (not shown). Driver PCB 461uL may include drivers 306 that can send transistor control signals to respective switches 304dL of legs b and c through respective connector-leads 288g.

FIG. 5T-3 shows example phase bus bar-lead 465a that may extend laterally between first and second ends. The first ends of phase bus bar-lead 465a may be electrically connected to phase bus bar 418ua, and the second end may be electrically connected to inductor La. Phase bus bar-lead 465a may extend through an aperture in PCB 461uH. Current sensor I_Sense-a can measure electrical current flowing through phase bus bar-lead 465a. I_Sense may include an aperture through which phase bus bar-lead 465a extends. FIG. 5T-3 shows current sensor I_Sense-a, and phase bus bar-lead 465a for leg-a. First ends of similar phase bus bar-leads 465b, 465c, 465a1, 465b1, 465a2, 465b2 (not shown) can be electrically attached to phase bus bars 418ub, 418uc, 418ua1, 418ub2, 418ua1, and 418ub2, respectively. The second ends of the phase bus bar-leads 465b, 465c, 465a1, 465b1, 465a2, and 465b2 in converter 400obc can be electrically connected to inductor Lb, inductor Lc, capacitor Cp, a first terminal of transformer T, a second terminal of transformer T, and a third terminal of transformer T, respectively. Driver board 461uH may include apertures through which phase bus bar-leads 465b, 465c, 465a1, 465b1, 465a2, and 465b2 extend, respectively. Driver board 461uH may include current sensors I_Sense-b, I_Sense-c, I_Sense-a1, I_Sense-b1, I_Sense-a2, and I_Sense-b2 (not shown) for measuring current flow in phase bus bar-leads 465b, 465c, 465a1, 465b1, 465a2, and 465b2, respectively. Current sensors I_Sense-b, I_Sense-c, I_Sense-a1, I_Sense-b1, I_Sense-a2, and I_Sense-b2 may include an aperture through which phase bus bar-leads 465b, 465c, 465a1, 465b1, 465a2, and 465b2, respectively, extend.

Converter 400obc may include a control PCB 462u with an MCU in data communication with drivers 306, current sensors I_Sense, voltage sensors V_Sense, and other components mounted on driver PCBs 421u. Connectors 484H and 484L may facilitate the data communication with the MCU.

Air is shown flowing through the channels of bus bars in converter 400obc. Alternatively, dielectric liquid (e.g., oil, deionized water, etc.) can flow through these channels.

Half bridge circuits are employed in power converters and other power apparatuses. Half bridge circuits can be created with packaged switches 247. FIGS. 5U-1-5U-3 illustrate front, left, and right-side views of an example half bridge circuit 460hb.

With reference to FIG. 5U-1, half bridge 460hb may include two packaged switches 247qG and four packaged switches 247s. Each packaged switch 247qG may include switch 304qG shown in FIG. 3G. Packaged switches 247qG can be replaced with packaged switches 247ql in an alternate version. Each of packaged switches 247s may include switch 304d, which in turn may be an implementation of switch 304dA shown in FIG. 3A, or switch 304dB shown in FIG. 3B with four, three, two, or just one MOSFET. For purposes of explanation only, each packaged switch 247s includes only one MOSFET electrically connected between a die clip and a die substrate. Each of the switches 304 of half bridge 460hb can be independently controlled by an MCU on control PCB 462it shown in FIGS. 5U-2 and 5U-3. Each group of one or more transistors in each switch 247q or 247p, which is electrically connected to a respective connector-lead 288, can be independently controlled by the MCU or other data processing device.

Half bridge 460hb may include V+ bus bar 417hb, V− bus bar 412hb, and bus bars 418hb. Bus bars V+ bus bar 417hb and V− bus bar 412hb are shown symbolically in FIG. 5U-1. V+ bus bar 417hb, V− bus bar 412hb, and bus bars 418hb in FIGS. 5U-1-5U-3, may have a generally rectangular cuboid shape. Example bus bars 418hbH and 418hbL may have a height, width, and length around 8 mm, 25 mm, and 70 mm, respectively. Example bus bar 418hbM may have a height, width, and length around 12 mm, 25 mm, and 70 mm, respectively. Example V+ bus bar 417hb and V− bus bar 412hb may have a height, width, and length around 8 mm, 25 mm, and 70 mm, respectively. FIGS. 5U2 and 5U-3 show the height and width of the bus bars. FIG. 5U-1 shows the height and length of bus bars 418hb.

FIGS. 5U-1-5U-3 illustrate the relative positioning of packaged switches 247, V+ bus bar 417hb, V− bus bar 412hb, and bus bars 418hb with respect to each other. In FIG. 5U-1, packaged switches 247qGH and 247qGL may have die substrate terminals 230 that are electrically and thermally connected (e.g., soldered, sintered, press-fitted, etc.) directly to respective flat surfaces of bus bars 418hbM and 418hbL, respectively, and die clip terminals 344 that are electrically and thermally connected (e.g., soldered, sintered, press-fitted, etc.) directly to respective flat surfaces of bus bars 418hbH and 418hbM, respectively. In an alternative version, packaged switches 247qGH and 247qGL can be rotated so that their die substrate terminals 230 are electrically and thermally connected to respective flat surfaces of bus bars 418hbH and 418hbM, respectively, and their die clip terminals 344 are electrically and thermally connected to respective flat surfaces of bus bars 418hbM and 418hbL, respectively. With continuing reference to FIG. 5U-1, FIG. 5U-2 shows packaged switch 247s2H may have a die substrate terminal 230 that is electrically and thermally connected (e.g., soldered, sintered, press-fitted, etc.) directly to a flat surface of bus bar 418hbH. Packaged switch 247s2L may have a die substrate terminal 230 that is electrically and thermally connected (e.g., soldered, sintered, press-fitted, etc.) directly to a flat surface of bus bar 418hbL. With continuing reference to FIG. 5U-2 and with additional reference to FIGS. 2C-4-2C-6, each packaged switch 247s2 may have a connector-lead 288bdc with oppositely facing flat surfaces. A substantial portion (e.g., 25%, 50%, 75%, 90% or more) of the upper flat surface of connector-lead 288bdcH may be electrically and thermally connected (e.g., sintered, welded, soldered, press-fitted by screws or other fasteners, etc.) directly to a flat surface of V+ bus bar 417hb. A substantial portion (e.g., 25%, 50%, 75%, 90% or more) of the lower flat surface of connector-lead 288bdcL may be electrically and thermally connected (e.g., sintered, welded, soldered, press-fitted by screws or other fasteners, etc.) directly to a flat surface of V− bus bar 412hb. In FIG. 5U-3, each packaged switch 247s3 and 247s4 may have a die substrate terminal 230 that is electrically and thermally connected (e.g., soldered, sintered, press-fitted, etc.) directly to respective, opposite facing flat surfaces of bus bar 418hbM. With continuing reference to FIG. 5U-3 and with additional reference to FIGS. 2C-7-2C-12, each packaged switch 247s3 and 247s4 may have a wide collector-lead 288dc. Packaged switches 247s4 and 247s3 may have connector-leads 288dcl and 288der that are electrically connected by connector 572, which is electrically connected to lead 465hb, which in turn may be electrically connected to a load that could include a capacitor, inductor, and/or a transformer.

FIGS. 5U-4 and 5U-5 show side and front views of bus bar 418hbM, packaged switches 247s3 and 247s4 of half bridge 460hb, along with connector 572 and lead 465hb. Connector 572 may be a solid, rectangular cuboid-shaped element made of metal such as copper or aluminum. Although not shown, die substrate terminals 230 of packaged switches 247s3 and 247s4 are electrically and thermally connected to opposite facing flat surfaces of half bridge 418hbM. The flat bottom surface of connector-lead 288dcr and the flat top surface of connector-lead 288dcl are electrically connected to opposite facing flat surfaces of connector 572. Lead 465hb extends between first and second ends. The first end is electrically connected to connector 572, and the second end is electrically connected to the load (not shown in FIGS. 5U-4 and 5U-5). Connector-leads 288dcr and 288dcl may or may not be electrically connected to traces on driver PCB 461hb.

FIGS. 5U-2 and 5U-3 show half bridge 460hb with dielectric tubes 420a received by bus bars 412hb, 417hb, 418hbH, 418hbM, and 418hbL. Tubes other than 420a can be received bus bars 412hb, 417hb, 418hbH, 418hbM, and 418hbL. For example, each of bus bars 412hb, 417hb, 418hbH, 418hbM, and 418hbL can be formed by soldering metal bus bar portions around tubes 420d or 420e using a process like that described with reference to FIGS. 5A-17-1-5A-17-5. Or the bus bars can be swapped with bus bars formed around tubes like tubes 420v1 using a process like that described with reference to FIGS. 9A-30-9A-33.

Half bridge 460hb may include a DC link capacitor 403hb. FIGS. 5U-2 and 5U-3 shows leads 405t of DC link capacitors 403hb. First and second metal capacitor-leads 405ta and 405tb may extend from one of the capacitor's dielectric wall. Example capacitor-leads 405t may have a height, length, and width around 6 mm, 20 mm, and 20 mm, respectively. Capacitor-leads, including capacitor-leads 405t, may have substantially flat, rectangular-shaped opposite facing top and bottom surfaces. A substantial portion (e.g., 10, 20, 50, 75, 90% or more) of each capacitor-lead 405ta's flat bottom surface area may be electrically and thermally connected (e.g., welded, soldered, press-fitted by screws or other fasteners, etc.) directly to a flat surface of V+ bus bar 417hb, and a substantial portion (e.g., 10, 20, 50, 75, 90% or more) of each capacitor-lead 405tb's flat top surface area may be electrically and thermally connected (e.g., welded, soldered, press-fitted by screws or other fasteners, etc.) directly to a flat surface of V− bus bar 412hb.

FIG. 5U-1 includes electrical current symbols that represent electrical current flow through half bridge 460hb at an instant in time. More particularly, FIG. 5U-1 shows electrical current flow through packaged switches 247s2H, 247qGH, and 247s4.

Half bridge 460hb may include driver PCB 461hb with drivers 306 that can send transistor control signals to respective switches 304 through respective connector-leads 288g or respective sets of connector-leads 288g1 and 288g2. Only connector-leads 288g of packaged switches 247s are represented in FIGS. 5U-2 and 5U-3. Driver PCB 461hb may include surface mounted snubber capacitors (e.g., multilayer ceramic capacitors, not shown) that are connected in parallel with respective switches 304 through respective sets of connector-leads 288ds and 288dc. Half bridge 460hb may include a control PCB 462hb with an MCU that may be in data communication with drivers 306, current sensor I_Sense, voltage sensors, and other components mounted on driver PCB 461hb via connection 484.

Half bridge circuits 460hb can be combined to create an inverter. FIG. 5V illustrates a front view of an example three-phase inverter 460ip employing half bridge circuits 460hb. Inverter 460ip has three legs designated a-c, each of which may include six packaged switches 247. Each leg a-c includes components of the half bridge 406hb shown in FIG. 5V.

Each leg a-c may include two packaged switches 247qG and four packaged switches 247s. Each packaged switch 247qG in a leg may include switch 304qG shown in FIG. 3G. Packaged switches 247qG can be replaced with packaged switches 247ql in an alternate version. Each of packaged switches 247s may include switch 304d, which in turn may be an implementation of switch 304dA shown in FIG. 3A, or switch 304dB shown in FIG. 3B with four, three, two, or just one MOSFET. For purposes of explanation only, each packaged switch 247s includes only one MOSFET electrically connected between a die clip and a die substrate. Each of the switches 304 of inverter 460ip can be independently controlled by an MCU on control PCB (not shown).

Inverter 460ip may include V+ bus bar 417ehb and V− bus bar 412ehb, which are length extended versions of V+ bus bar 417hb and V− bus bar 412hb in FIGS. 5U-1-5U-5. Example V+ bus bar 417ehb and V− bus bar 412ehb may have a height, width, and length around 8 mm, 20 mm, and 200 mm, respectively.

FIG. 5V illustrates the relative positioning of packaged switches 247 and bus bars 418hb with respect to each other. Packaged switches 247qGH in legs a-c may have die substrate terminals 230 that are electrically and thermally connected (e.g., soldered, sintered, press-fitted, etc.) directly to respective flat surfaces of bus bars 418hbMa-418hbMc, respectively, and die clip terminals 344 that are electrically and thermally connected (e.g., soldered, sintered, press-fitted, etc.) directly to respective flat surfaces of bus bars 418hbHa-418hbHc, respectively. Packaged switches 247qGL in legs a-c may have die clip terminals 344 that are electrically and thermally connected (e.g., soldered, sintered, press-fitted, etc.) directly to respective flat surfaces of bus bars 418hbMa-418hbMc, respectively, and die substrate terminals 230 that are electrically and thermally connected (e.g., soldered, sintered, press-fitted, etc.) directly to respective flat surfaces of bus bars 418hbLa-418hbLc, respectively.

Packaged switches 247s2H of legs a-c may have die substrate terminals 230 that are electrically and thermally connected (e.g., soldered, sintered, press-fitted, etc.) directly to respective flat surfaces of bus bars 418hbHa-418hbHc, respectively. Packaged switches 247s2L of legs a-c may have die substrate terminals 230 that are electrically and thermally connected (e.g., soldered, sintered, press-fitted, etc.) directly to respective flat surfaces of bus bar 418hbLa-418hbLa, respectively. With continuing reference to FIG. 5V and with additional reference to FIGS. 2C-4-2C-6, each packaged switch 247s2 may have a connector-lead 288bdc with oppositely facing flat surfaces. A substantial portion (e.g., 25%, 50%, 75%, 90% or more) of the upper flat surface of connector-leads 288bdcH may be electrically and thermally connected (e.g., sintered, welded, soldered, press-fitted by screws or other fasteners, etc.) directly to a flat surface of V+ bus bar 417ehb. A substantial portion (e.g., 25%, 50%, 75%, 90% or more) of the lower flat surface of connector-lead 288bdcL may be electrically and thermally connected (e.g., sintered, welded, soldered, press-fitted by screws or other fasteners, etc.) directly to a flat surface of V− bus bar 41e2hb. Packaged switches 247s3 and 247s4 in legs a-c may have die substrate terminals 230 that are electrically and thermally connected (e.g., soldered, sintered, press-fitted, etc.) directly to respective, opposite facing flat surfaces of bus bar 418hbMa-418hbMc, respectively. With continuing reference to FIG. 5V and with additional reference to FIGS. 2C-7-2C-12, each packaged switch 247s3 and 247s4 may have a wide collector-lead 288dc. Packaged switches 247s4 and 247s3 in each leg a-c may have connector-leads 288dcl and 288dcr that are electrically connected by respective connectors (not shown), which are electrically connected to respective bus connector-leads (not shown), which in turn are electrically connected to respective windings Wa-Wc.

Inverter 460ip is shown with dielectric tubes 420a received by bus bars. Tubes other than 420a can be received by the bus bars. For example, aligned bus bars 418hbH can be formed by soldering metal bus bar portions around tubes 420g using a process like the process described with reference to FIGS. 5A-17-6-5A-17-10. Aligned bus bars 418hbM can formed around tubes 420g using a process like the process described with reference to FIGS. 5A-17-11-5A-17-15. Bus bars 418hbL can be formed around tubes 420g using a process like the process described with reference to FIGS. 5A-17-6-5A-17-10. Bus bar 417m can be formed by soldering metal bus bar portions around tubes 420g using a process like the process described with reference to FIGS. 5A-17-1-5A-17-5. Aligned bus bars 418mU can formed around tubes 420g using a process like the process described with reference to FIGS. 5A-17-6-5A-17-10. Bus bars 418m can be formed around tubes 420g using a process like the process described with reference to FIGS. 5A-17-6-5A-17-10. Bus bars 418mL can be formed around tubes 420g using a process like the process described with reference to FIGS. 5A-17-6-5A-17-10.

Inverter 460ip may include one or more DC link capacitors electrically connected between V+ bus bar 417ehb and V− bus bar 412ehb. FIG. 5V symbolically shows one of the capacitors C1. Although not shown in this figure, first and second metal capacitor-leads may extend from capacitor C1, each of which may have a height hbc, length lbc, and width wbc around 6 mm, 30 mm, and 50 mm, respectively. These capacitor-leads may have substantially flat, rectangular-shaped opposite facing top and bottom surfaces. A substantial portion (e.g., 10, 20, 50, 75, 90% or more) of the first capacitor-lead's flat bottom surface area may be electrically and thermally connected (e.g., welded, soldered, press-fitted by screws or other fasteners, etc.) directly to a flat surface of V+ bus bar 417ehb, and a substantial portion (e.g., 10, 20, 50, 75, 90% or more) of the second capacitor-lead's flat top surface area may be electrically and thermally connected (e.g., welded, soldered, press-fitted by screws or other fasteners, etc.) directly to a flat surface of V− bus bar 412ehb.

FIG. 5V includes electrical current symbols that represent electrical current flow through inverter 460ip at an instant in time. More particularly, FIG. 5V shows electrical current flow through activated transistors of switches 304 in packaged switches 247qGH and 247s4 of leg-a, and electrical current flow through activated transistors of switches 304 in packages 247s2 and 247qGL of legs b and c. All other switches are deactivated. It is noted that current can flow through the body diodes of MOSFETs when they are off.

Inverter 460ip may include a driver PCB with drivers that may be electrically connected to and control respective switches 304 through respective connector-leads 288g or respective sets of connector-leads 288g1 and 288g2. Inverter 460ip may include a control PCB with an MCU that may be in data communication with the drivers.

All tubes 420a received in all bus bars of inverter 460ip may be substantially equal in length. Each tube 420a has first and second ends. The first ends of all tubes 420a may be in fluid communication with a first manifold like manifold 466iT-1, while the second ends of all the tubes 420a may be in fluid communication with a second manifold like manifold 466iT-2.

Liquid dielectric material such as epoxy, silicon, etc., can be added to air gaps or empty spaces between electrical conductors of inverter 460ip, including adjacent electrical conductors of naked packaged switches 247 if employed, and then cured to create structures that suppress dendrite growth and electrical arcing therebetween.

FIGS. 5W-1-5W-4 illustrate front, back, left, and right-side views of an example inverter 460m that employs packaged switches 247q, 247d, and 247s. Several components (e.g., DC link capacitors 403m) shown in FIGS. 5W-3 and 5W-4 are not shown or fully shown in FIGS. 5W-1 and 5W-2 but may be described below.

With reference to FIGS. 5W-1 and 5W-2, inverter 460m may have three legs a-c. Each leg has two packaged switches 247qG, two packaged switches 247s2, and two packaged switches 247d. Each packaged switch 247qG may include switch 304qG shown in FIG. 3G. Packaged switches 247qG can be replaced with packaged switches 247ql in an alternate version. Each packaged switch 247s2 may include switch 304d, which in turn may be an implementation of switch 304dA shown in FIG. 3A, or switch 304dB shown in FIG. 3B with four, three, two, or just one MOSFET. For purposes of explanation only, each packaged switch 247s2 of inverter 460m includes only one MOSFET that is electrically connected between a die clip 372 and a die substrate 360. Each of packaged switches 247d may be packaged switch 247dA, 247dB, or 247dD, of FIGS. 3A, 3B, and 3D, respectively, it being understood that in an alternative version the packaged switches 247d may be swapped for packaged switches 247p or packaged switches 247q. Each of the switches 304 of inverter 460m can be independently controlled by an MCU on control PCB 462m shown in FIGS. 5W-3 and 5W-4. Each group of one or more transistors in each switch 247q or 247p, which is electrically connected to a respective connector-lead 288, can be independently controlled by the MCU or other data processing device.

FIGS. 5W-3 and 5W-4 show packaged switches 247dH may have a height that is greater than the height of packaged switches 247s2U. Thicker die substrates 360 and/or thicker die clips 372 in packaged switches 247dH can give them a height greater than the height of packaged switches 247s2U, or longer pedestals (not shown) in packaged switches 247dH can give them a height greater than the height of packaged switches 247s2U.

Inverter 460m may include V+ bus bar 417m, V− bus bar 412m, phase bus bars 418m, and bus bars 487m. V+ bus bar 417m, V− bus bar 412m, phase bus bars 418m, and bus bars 487m in FIGS. 5W-1-5W-4, may have a generally rectangular cuboid shape as shown. Example bus bars 487mU and 487 mL may have a height, width, and length around 8 mm, 25 mm, and 45 mm, respectively. Example phase bus bars 418m may have a height, width, and length around 8 mm, 55 mm, and 45 mm, respectively. Example V+ bus bar 417m may have a height, width, and length around 8 mm, 55 mm, and 145 mm, respectively. Example V− bus bar 417m may have a height, width, and length around 8 mm, 25 mm, and 145 mm, respectively. FIG. 5W-3 shows the width and height of bus bars. A layer of dielectric material may be inserted between phase bus bar 418m and bus bars 487mH in each leg to electrically isolate them from each other.

FIGS. 5W-1-5W-4 illustrate the relative positioning of packaged switches 247, V+ bus bar 417m, V− bus bar 412m, phase bus bars 418m, and bus bars 487m with respect to each other. In FIG. 5W-1, packaged switches 247qGH have die substrate terminals 230 that may be electrically and thermally connected (e.g., soldered, sintered, press-fitted, etc.) to respective flat surfaces of bus bars 487mUa-487mUc, and die clip terminals 344 that may be electrically and thermally connected (e.g., soldered, sintered, press-fitted, etc.) to a flat surface or respective flat surfaces of V+ bus bar 417m. Packaged switches 247qGL have die substrate terminals 230 that may be electrically and thermally connected (e.g., soldered, sintered, press-fitted, etc.) to respective flat surfaces of bus bars 487mLa-487mLc, and die clip terminals 344 that may be electrically and thermally connected (e.g., soldered, sintered, press-fitted, etc.) to respective flat surfaces of phase bus bars 418ma-418mc. Packaged switches 247s2U may have die substrate terminals 230 that are electrically and thermally connected (e.g., soldered, sintered, press-fitted, etc.) to respective flat surfaces of bus bars 487mUa-487mUc, and packaged switches 247s2L with die substrate terminals 230 that are electrically and thermally connected (e.g., soldered, sintered, press-fitted, etc.) to respective flat surfaces of bus bars 487mLa-487mLc. With continuing reference to FIGS. 5W-1, 5W-3 and 5W-4 and with additional reference to FIGS. 2C-4-2C-6, each packaged switch 247s2 may have a connector-lead 288bdc with oppositely facing flat surfaces. Connector leads 388bdcH of packaged switches 247s2U are electrically and thermally connected to respective phase bus bars 418ma-418mc via respective connectors 573Ua-573Uc. Connector leads 388bdcL of packaged switches 247s2L are electrically and thermally connected to V− bus bar 412m via respective connectors 573La-573Lc. FIG. 5W-5 shows a side view of phase bus bar 418ma, bus bar 487mUa, packaged switch 247s2Ua, packaged switch 247dHa, and connector 573Ua. Connector 573Ua may be a solid, rectangular cuboid-shaped element made of metal such as copper or aluminum. The opposite facing flat surfaces of connector 573Ua may be electrically connected (e.g., soldered) to a flat bottom surface of connector-lead 288bdcHa and to a flat surface of phase bus bar 418ma. FIG. 5W-5 shows that the height of packaged switch 247dHa is greater than the height of packaged switch 247s2Ua, so that the die substrate terminal 230 is coplanar with the top surface of packaged switch 247s2Ua.

With reference to FIGS. 5W-2-5W-4, packaged switches 247dH have die substrate terminals 230 that may be electrically and thermally connected (e.g., soldered, sintered, press-fitted, etc.) to a flat surface or respective flat surfaces of V+ bus bar 417m, and die clip terminals 344 that may be electrically and thermally connected (e.g., soldered, sintered, press-fitted, etc.) to flat surfaces of respective phase bus bars 418ma-418mc, which in turn may be electrically connected to windings Wa-Wc, respectively. Packaged switches 247dL may have die substrate terminals 230 that may be electrically and thermally connected (e.g., soldered, sintered, press-fitted, etc.) to flat surfaces of respective phase bus bars 418ma-418mc, and die clip terminals 344 that may be electrically and thermally connected (e.g., soldered, sintered, press-fitted, etc.) to a flat surface or respective flat surfaces of V− bus bar 412m.

FIGS. 5W-1-5W-4 show inverter 460m with dielectric tubes 420a received in bus bars 412m, 417m, 418m, and 487m. Tubes other than 420a can be received by the bus bars. For example, each of bus bars 412m and 417m can be formed by soldering metal bus bar portions around tubes 420d or 420e using a process like that described with reference to FIGS. 5A-17-1-5A-17-5. Bus bars 487mU can be formed by soldering metal bus bar portions around tubes 420g using a process like that described with reference to FIGS. 5A-17-6-5A-17-10. Bus bars 418m can be formed by soldering metal bus bar portions around tubes 420g using a process like that described with reference to FIGS. 5A-17-6-5A-17-10. Bus bars 487mL can be formed by soldering metal bus bar portions around tubes 420g using a process like that described with reference to FIGS. 5A-17-6-5A-17-10. Or the bus bars can be swapped with bus bars formed around tubes like tubes 420v1 using a process like that described with reference to FIGS. 9A-30-9A-33 or FIGS. 9A-34-9A-37.

Inverter 460m may include a DC link capacitors 403m. FIGS. 5W-3 and 5W-4 show leads 405h of DC link capacitors 403m. Capacitor-leads 405h may have substantially flat, rectangular-shaped opposite facing top and bottom surfaces. A substantial portion (e.g., 10, 20, 50, 75, 90% or more) of each capacitor-lead 405ha's flat bottom surface area may be electrically and thermally connected (e.g., welded, soldered, press-fitted by screws or other fasteners, etc.) directly to a flat surface of V+ bus bar 417m, and a substantial portion (e.g., 10, 20, 50, 75, 90% or more) of each capacitor-lead 405hb's flat top surface area may be electrically and thermally connected (e.g., welded, soldered, press-fitted by screws or other fasteners, etc.) directly to a flat surface of V− bus bar 412m.

FIG. 5W-1 includes electrical current symbols that represent electrical current flow through inverter 460m at an instant in time. More particularly, FIG. 5W-1 shows electrical current flow through packaged switches 247s2U and 247qGH of leg-a, and 247s2L and 247qGL of legs b and c.

Inverter 460m may include driver PCBs 461m with drivers 306 that can send transistor control signals to respective switches 304 through respective connector-leads 288g or respective sets of connector-leads 288g1 and 288g2. Inverter 460m may include a control PCB 462m with an MCU that may be in data communication with drivers 306, current sensor I_Sense, voltage sensors, and other components mounted on driver PCBs 461m via respective connections 484.

FIGS. 5X-1 and 5X-2 illustrate relevant components of an example inverter 460s when seen from the front and from a side. Several components (e.g., DC link capacitors 403s and 433-1) shown in FIG. 5X-1 are not shown or fully shown in FIG. 5X-2 but are described below. Several components (e.g., driver PCB 461s and control PCB 462s) shown in FIG. 5X-2 are not shown or fully shown in FIG. 5X-1 but are described below.

Inverter includes finned bus bars 412s, 417s, and 418s, respectively. Inverter 460s includes packaged switches 247d, it being understood that in an alternative version the packaged switches 247d may be swapped for packaged switches 247p or packaged switches 247q. All packaged switches 247 of inverter 460s may be the same type. Packaged switches 247d of inverter 460iair may be packaged switch 247dA, 247dB, or 247dD, of FIGS. 3A, 3B, and 3D, respectively.

Inverter 460s has three legs designated a-c. Each leg in FIG. 5X-1 may include two packaged switches 247dH and 247dL that may be electrically and thermally connected to a phase bus bar 418s, which in combination may be sandwiched between V+ bus bar 417s and V− bus bar 412s. Packaged switches 247dH and 247dL may be also electrically and thermally connected to V+ bus bar 417s and V− bus bar 412s, respectively. Phase bus bars 418s may be thermally and electrically isolated from each other.

FIGS. 5X-1 and 5X-2 illustrate the relative positioning of packaged switches 247d, V+ bus bar 417s, phase bus bars 418s, and V− bus bar 412s with respect to each other. Packaged switches 247dH in FIG. 5X-2 may have die substrate terminals 230 that may be electrically and thermally connected (e.g., soldered, sintered, press-fitted, etc.) directly or indirectly to a flat surface or respective flat surfaces of V+ bus bar 417air, and die clip terminals 344 that may be electrically and thermally connected (e.g., soldered, sintered, press-fitted, etc.) directly or indirectly to flat surfaces of respective phase bus bars 418sa-418sc, which in turn may be electrically connected to windings Wa-Wc, respectively. Packaged switches 247dL in FIG. 5X-2 may have die substrate terminals 230 that may be electrically and thermally connected (e.g., soldered, sintered, press-fitted, etc.) directly or indirectly to flat surfaces of respective phase bus bars 418sa-418sc, and die clip terminals 344 that may be electrically and thermally connected (e.g., soldered, sintered, press-fitted, etc.) directly or indirectly to a flat surface or respective flat surfaces of V− bus bar 412s.

Finned bus bars V+ bus bar 417s, V− bus bar 412s, and phase bus bars 418s in FIGS. 5X-2 and 5X-1, may have a rectangular tube shape. FIG. 5X-1 shows the height and length of the finned bus bars, and FIG. 5X-2 shows the height and width. Example phase bus bars 418s may have a height, width, and length around 12 mm, 25 mm, and 20 mm, respectively. Example V+ bus bar 417s and V− bus bar 412s may have a height, width, and length around 8 mm, 25 mm, and 70 mm, respectively.

Each Phase bus bar 418s may include four thin (e.g., 25.0, 15.0, 10.0, 5.0 3.0, 2.0, 1.0 mm or less) sidewalls that may be connected at right angles to each other. Each of the sidewalls may include oppositely facing substantially flat surfaces. Cooling-fins 540 may be parallel to each other and extend between upper and lower sidewalls. Cooling-fins 540 may be thermally and electrically connected to upper and lower sidewalls. Cooling-fins 540 have oppositely faced substantially flat surfaces. Cooling-fins 540 may have a width of 10.0, 6.0 4.0, 2.0, 1.0, 0.5 mm or less. The length and height of cooling-fins 540 may be substantially equal to the length and height of phase bus bar 418s. Cooling-fins 540 may be equally spaced in bus bar 418s. FIG. 5X-1 shows three cooling-fins 540 in each phase bus bars 418s. In alternative versions fewer than three or more than three cooling-fins 540 may be used in bus bars 418s. Cooling-fins 540 and sidewalls define channels through which fluid such as air can flow through bus bars 418s. Fluid flow over cooling-fins can extract substantial heat (e.g., 1.0, 5.0, 10.0, 20.0, 50.0, 100.0, 200.0, 300.0, 500.0 W or more) from one or more switches 304 or diodes electrically and thermally connected to a phase bus bar 418s.

V− bus bar 412s is substantially like V+ bus bar 417s. V− bus bar 412s may include four thin (e.g., 25.0, 15.0, 10.0, 5.0 3.0, 2.0, 1.0 mm or less) sidewalls that may be connected at right angles to each other. Each of the sidewalls may include oppositely facing substantially flat surfaces. Each of the sidewalls may include oppositely facing substantially flat surfaces. Cooling-fins 543 extend between upper and lower sidewalls. Cooling-fins 543 have oppositely faced substantially flat surfaces. Cooling-fins 543 may be thermally and electrically connected to upper and lower sidewalls. Cooling-fins 543 may have a width of 10.0, 6.0 4.0, 2.0, 1.0, 0.5 mm or less. The length and height of cooling-fins 543 may be substantially equal to the length and height of V− bus bar 412s. FIG. 5X-1 shows V− bus bar 412s with nine cooling-fins 543 in groups of three. In alternative versions fewer than nine or more than nine cooling-fins 543 may be used. Cooling-fins 543 and sidewalls define channels through which fluid such as air can flow through bus bar 412s. Fluid passing over cooling-fins 543 can extract substantial heat (e.g., 1.0, 5.0, 10.0, 20.0, 50.0, 100.0, 200.0, 300.0, 500.0 W or more) from one or more switches 304 or diodes electrically and thermally connected to V− bus bar 412s.

A thin layer of corrosion resistant material (e.g. epoxy filled with conductive materials, nickel, synthetic diamond, rhodium, silver, titanium, etc.) can be formed (e.g., electroplated, sprayed, etc.) on surfaces of channels of finned bus bars 412s, 417s, and 418s, to prevent oxidation, tarnish, etc., without significantly affecting thermal conductivity between a fluid such as air flowing through the channel and a die clip terminal 344 or a die clip terminal 230 attached to the finned bus bar. Alternatively, a thin layer can be formed on surfaces of the channels by applying a chemical such as benzotriazole, or by passivation, anodization, etc., to prevent oxidation, tarnish, etc., without significantly affecting thermal conductivity between fluid flowing through the channel and a die clip terminal 344 or a die clip terminal 230 attached to the finned bus bar.

Inverter 460s may include a film DC link capacitor 403s, which has first and second metal capacitor-leads 405s-a and 405s-b. Capacitor-leads 405s may have a height, width, and length around 6 mm, 25 mm, and 17 mm, respectively. A substantial portion (e.g., 10, 20, 50, 75, 90% or more) of capacitor-lead 405s-a's flat bottom surface area may be electrically and thermally connected directly or indirectly to a flat surface of V+ bus bar 417s, and a substantial portion (e.g., 10, 20, 50, 75, 90% or more) of capacitor-lead 405s-b's flat top surface area may be electrically and thermally connected directly or indirectly to a flat surface of V− bus bar 412s. V+ bus bar 417s and V− bus bar 412s can extract a substantial amount of heat (e.g., 1, 2, 5, 10, 20, 40, 80, 100, 200, 300 Watts or more) from film DC link capacitor 403s through flat surfaces of its capacitor-lead 405s-a and/or 405s-b, respectively.

Inverter 460s may include a row of ceramic DC link capacitors 433 electrically connected in parallel. For ease of illustration, only one ceramic DC link capacitor 433-1 of the row is shown. Each of the ceramic DC link capacitors 433 may include first and second metal terminals connected electrically to the die-cooled V+ and V− bus bars, respectively.

Example ceramic DC link capacitors 433 may be mounted on a PCB 435s and electrically connected in parallel. First and second metal terminals of each capacitor 433 may be electrically connected to first and second metal traces 511s and 513s, respectively, on the side of PCB 435s opposite the side with capacitors 433. Metal vias can electrically connect traces 511s and 513s to respective terminals of capacitors 433. The ends of first and second traces 511s and 513s may be widened to create large surface areas that can be electrically and thermally connected directly or indirectly to respective side wall surfaces of the V+ and V− bus bars 418s and 412air, respectively.

Returning to FIG. 5X-1, electrical current symbols are shown that represent electrical current flow through inverter system 460s at an instant in time. More particularly, FIG. 5X-1 shows electrical current flow through activated high-side switch 304dH of leg-a, while low-side switches 304dL of legs b and c may be activated and conducting current to the V-terminal through the V− bus bar 412air. The other switches 304 are presumed to be off.

Inverter 460s may include control PCB 462s and driver PCB 461s. Driver and control PCBs may be in data communication with each other. Driver PCB 461s may be electrically connected to switches 304 through respective sets of connector-leads 288. Only connector-leads 288gH and 288gL of leg-a are represented in FIG. 5X-2. Driver PCB 461s may include surface mounted snubber capacitors (e.g., multilayer ceramic capacitors, not shown) that are connected in parallel with respective switches through respective sets of connector-leads 288ds and 288dc.

Driver PCB 461s in FIG. 5X-1 include drivers 306 that can send transistor control signals to respective switches 304 of leg-a through respective connector-leads 288g. Driver PCB 461s in FIG. 5X-2 may include voltage sensors V_Sense that can sense voltages between respective pairs of connector-leads 288ds and 288dc. Example phase bus bar-lead 465a may extend laterally between first and second ends. A flat surface of the first end may be electrically connected (e.g., soldered) to a sidewall of phase bus bar 418sa, and the second end may be electrically connected to winding Wa. Phase bus bar-lead 465a may extend through an aperture in PCB 461s. Current sensor I_Sense measures electrical current flowing through phase bus bar-lead 465a. I_Sense may include an aperture through which phase bus bar-lead 465a may extend. FIG. 5X-1 shows drivers 306, voltage sensors V_Sense, PMICs, current sensors I_Sense, and a phase bus bar-lead 465 for leg-a. Similar groups of drivers 306, voltage sensors V_Sense, PMICs, current sensor I_Sense, and phase bus bar-lead 465 may be mounted on or extending through PCB 461it for legs c and b.

FIG. 5X-1 shows an MCU mounted on control PCB 462s. The MCU may be in data communication with each driver 306, V_Sense, and I_Sense mounted on driver PCB 461it through a flexible PCB 484.

Although not shown in FIG. 5X-2, one or more air fans can be positioned on the side of bus bars 417s, 418s, and 412s opposite the side with driver PCB 461s. The one or more air fans can draw or pull air through the channels of bus bars 417s, 418s, and 412s as shown to cool cooling-fins 540 and 543. Air gaps should exist between bus bars 417s, 418s, and 412s and PCB 461s, including components mounted thereon, to enable fluid such as air to enter the bus bars 417s, 418s, and 412s.

Packaged switches, packaged diodes, bus bars, converters, etc., of this disclosure can be stacked to create devices with high-voltage (e.g., 1K, 2K, 5K, 10K, 20K Volts or more) ratings. Packaged switches of a stack can be individually controlled (i.e., activated or deactivated). Packaged switches of a stack can be controlled in groups. All packaged switches of a stack can be collectively controlled. The disclosed stacks may be used as switches. Stacks may be electrically connected in series and/or in parallel to create, for example, power converters such as inverters, solid-state transformers, etc.

FIG. 6A-1-6A-3 illustrate relevant components of an example stack 602a, which includes a pair of submodules 605a1 and 605a2. Each submodule 605a is essentially an instance of converter 460fb shown in FIGS. 5G-1 and 5G-2. FIG. 6A-1-6A-3 shows stack 602a when seen from the front, left, and right sides, respectively.

Each submodule 605a may include packaged switches 247d as shown, it being understood that in an alternative version packaged switches 247d may be replaced by packaged switches 247p or packaged switches 247q. All packaged switches 247 of stack 602a may be the same type. Packaged switches 247d of stack 602a may be packaged switch 247dA, 247dB, or 247dD of FIGS. 3A, 3B, and 3D, respectively.

Each submodule 605a may include a capacitor 403fb, bus bar 417fb, bus bar 412fb, and bus bars 418fb as shown. An insulator may be sandwiched between adjacent submodules in a stack. For example, insulator 604-1 is sandwiched between submodules 605a1 and 605a2. More specifically, insulator 604-1 is sandwiched between capacitor-leads 405fbb1 and 405fba2 of submodules 605a1 and 605a2, respectively. Insulator 604 may be manufactured (e.g., extruded) from or made to include a dielectric material (e.g., a ceramic) that electrically isolates two devices, such as capacitor-leads 405fbb1 and 405fba2, between which insulator 604 is sandwiched.

Each submodule 605a may include bus bar-leads 456a and 456b, which may be electrically connected (e.g., welded) to respective bus bars 418fb as shown in FIGS. 6A-2 and 6A-3. Bus bar-leads 465b of adjacent submodules 605a may be electrically connected. FIG. 6A-2 shows bus bar-leads 465b1 and 465b2 electrically connected. Bus bar-leads 465a of adjacent submodules 605a may be electrically connected. Although not shown, bus bar-lead 465a1 in FIG. 6A-3 may be electrically connected to a terminal of a device (not shown) such as a capacitor, inductor, voltage source, bus-bar lead 465 of another submodule 605a, etc. Although not shown, bus bar-lead 465a2 in FIG. 6A-3 may be electrically connected to a terminal of another device (not shown) such as a capacitor, inductor, voltage source, bus-bar lead 465 of another submodule 605a, etc.

Although not shown, a third submodule 605a3 and a second insulator 604-2 could be added to the top of stack 602a. The second insulator 604-2 may be sandwiched between submodule 605a1 and the third submodule 605a3. The second insulator 604-2 can electrically isolate capacitor-lead 405fba1 from a capacitor-lead 405fbb3 (not shown) of the third submodule 605a3. Bus bar-lead 465a3 (not shown) of the third submodule 605a3 may be electrically connected to bus bar-lead 465a1 of FIG. 6A-3, and bus bar-lead 465b3 (not shown) of the third submodule 605a3 may be connected to a terminal of a device (not shown) such as a capacitor, inductor, voltage source, bus-bar lead 465 of another submodule 605a, etc.

Bus bar-lead 465a2 in FIG. 6A-3 may be electrically connected to a terminal of another device such as a capacitor, inductor, voltage source, bus-bar lead 465 of a fourth submodule 605a (not shown, but described below), etc. Regardless of whether the third submodule 605a3 is added to the top as mentioned above, a fourth submodule 605a4 (not shown) and a third insulator 604-3 (not shown) could be added to the bottom of stack 602a. The third insulator 604-3 may be sandwiched between capacitor-lead 405fbb2 and a capacitor-lead 405fba4 (not shown) of the fourth submodule 605a4. The third insulator 604-3 should electrically isolate capacitor-lead 405fbb2 from the capacitor-lead 405fba4 of the fourth submodule 605a4. Bus bar-lead 465a4 (not shown) of the fourth submodule 605a4 may be electrically connected to bus bar-lead 465a2 of FIG. 6A-3, and bus bar-lead 465b4 (not shown) of the fourth submodule 650a4 may be electrically connected to a terminal of a device (not shown) such as a capacitor, inductor, voltage source, bus-bar lead 465 of another submodule 605a, etc.

Each submodule 605a in a stack 602a may have two legs designated b and a as shown in FIGS. 6a-2 and 6a-3, respectively, and each leg may include packaged switches 247dH and 247dL. Each packaged switch 247dH and 247dL in a submodule leg of a stack 602a may be electrically and thermally connected to a respective bus bar 418fb as shown, which in combination may be sandwiched between bus bar 417fb and bus bar 412fb as shown. In an alternative embodiment, each submodule leg in a stack 602a may include two or more packaged switches 247dH that are electrically connected in parallel between bus bar 417fb and a respective bus bar 418fb, and two or more packaged switches 247dL that are electrically connected in parallel between bus bar 412fb and the respective bus bar 418fb. The bus bars may need to be lengthened or widened to accommodate these additional packaged switches 247d.

FIG. 6A-1 illustrates the relative positioning of packaged switches 247d, bus bars 417fb, bus bars 418fb, bus bars 412fb, capacitors 403fb and insulator 604-1 with respect to each other. Die substrate terminals 230 and die clip terminals 344 may be pressed-fitted, soldered, sintered, welded, or connected by other means directly to corresponding flat surfaces of bus bars to establish thermal and electrical connectivity. Packaged switches 247dH in each submodule 605a may have die substrate terminals 230 that are electrically and thermally connected (e.g., soldered, sintered, press-fitted, etc.) directly or indirectly to a flat surface or respective flat surfaces of bus bar 417fb, and die clip terminals 344 that may be electrically and thermally connected (e.g., soldered, sintered, press-fitted, etc.) directly or indirectly to respective flat surfaces of respective bus bars 418fb as shown. Packaged switches 247dL in each submodule 605a may have die substrate terminals 230 that may be electrically and thermally connected (e.g., soldered, sintered, press-fitted, etc.) directly or indirectly to respective flat surfaces of respective bus bars 418fb, and die clip terminals 344 that may be electrically and thermally connected (e.g., soldered, sintered, press-fitted, etc.) directly or indirectly to a flat surface or respective flat surfaces of a bus bar 412fb as shown.

Bus bars, like 417fb, 412fb, and 418fb in FIGS. 6A-1 and 6A-2, may have a generally rectangular cuboid shape. Example bus bars 418fb may have height, width, and length around 12 mm, 25 mm, and 20 mm, respectively. Example bus bar 417fb and bus bar 412fb may have height, width, and length around 8 mm, 25 mm, and 45 mm, respectively. Bus bars may have different dimensions to accommodate differences in design. FIG. 6A-1 shows the height and length of the bus bars.

FIGS. 6A-1 and 6A-2 show tubes 420a received in bus bar 417fb, bus bar 412fb, and bus bars 418fb of each submodule 605a. Bus bars 418fb in each submodule 605a may be thermally connected to each other and electrically isolated from each other by commonly received dielectric tubes 420a. Tubes other than 420a can be received by the bus bars. For example, each of bus bars 412fb and 417fb can be formed by soldering metal bus bar portions around tubes 420d or 420e using a process like that described with reference to FIGS. 5A-17-1-5A-17-5, and aligned bus bars 418fb can be formed by soldering metal bus bar portions around metalized ceramic tubes like tube 420g, but with two metal layers 407p instead of three, using a process like that described with reference to FIGS. 5A-17-11-5A-17-15. Or the bus bars can be swapped with bus bars formed around tubes like tubes 420v1 using a process like that described with reference to FIGS. 9A-30-9A-33 or FIGS. 9A-34-9A-37.

Each submodule 605a of stack 602a may include a film capacitor 403fb. A flat bottom surface of capacitor-lead 405fba may be electrically and thermally connected (e.g., welded, soldered, press-fitted by screws or other fasteners, etc.) directly to a flat surface of a respective bus bar 417fb, and a flat top surface area of capacitor-lead 405fbb may be electrically and thermally connected to a flat surface of a respective bus bar 412fb as shown. Although not shown, one or more ceramic DC link capacitors may be electrically and thermally connected between bus bar 417fb and bus bar 412fb in each submodule 605a of stack 602a.

Stack 602a may include a control PCB 462a and a driver PCB 461a as shown. Drivers 306 on driver PCB 461a can send transistor control signals to respective switches 304 through respective connector-leads 288g. Drivers 306 and connector-leads 288gbH and 288gbL of each submodule 605a are shown in FIG. 6A-2, and drivers 306 and connector-leads 288gaH and 288gaL of each submodule 605a are shown in FIG. 6A-3. Driver PCB 461a may include voltage sensors V_Sense that can sense voltages between respective pairs of connector-leads 288ds and 288dc (not shown).

Example bus bar-leads 465 in each submodule 605a may extend laterally between first and second ends. The first ends of bus bar-leads 465b1 and 465b2 may be electrically connected (e.g., welded) to bus bar 418fbb1 and 418fbb2, respectively, and the second ends may be electrically connected to each other as shown in FIG. 6A-2. The first ends of bus bar-leads 465a1 and 465a2 may be electrically connected (e.g., welded) to bus bar 418fba1 and 418fba2, respectively, as shown in FIG. 6A-3. Each bus bar-lead 465 may extend through a respective aperture in PCB 461a. Each current sensor I_Sense can measure electrical current flowing through a respective bus bar-lead 465. I_Sense may include an aperture through which a respective bus bar-lead 465 may extend. FIG. 6A-2 shows drivers 306, voltage sensors V_Sense, PMICs, current sensors I_Sense, and bus bar-leads 465b for leg-b of each submodule 605a in stack 602a. FIG. 6A-3 shows drivers 306, voltage sensors V_Sense, PMICs, current sensors I_Sense, and a bus bar-leads 465a for leg-a of each submodule 605a in stack 602a. FIGS. 6A-2 and 6A-3 show an MCU mounted on control PCB 462a. The MCU may be in data communication with each driver 306, V_Sense, and I_Sense mounted on driver PCB 461a through a data connection 484. The MCU can individually control (turn on or turn off) each switch 304 via a respective driver 306.

Two instances of stack 602a can be electrically connected in series to form a leg of a modular multi-level converter (e.g., one leg of three similar legs in a modular multi-level three-phase inverter or rectifier). For example: bus-bar lead 465a1 (or bus-bar 465b3 of the third submodule 505a3 mentioned above) in a first instance of stack 609a may be electrically connected to a V+ terminal of a voltage source while bus bar lead 465a2 (or bus-bar 465b4 of the fourth submodule 505a4 mentioned above) of the first instance may be electrically connected to a first terminal of a first inductor; bus-bar lead 465a2 (or bus-bar 465b4 of the forth submodule 505a4 mentioned above) of a second instance of stack 602a may be electrically connected to a V− terminal of the voltage source while bus-bar lead 465a1 (or bus-bar 465b3 of the third submodule 505a3 mentioned above) of the second instance may be electrically connected to a first terminal of a second inductor, and; the second terminals of the first and second inductors can be electrically connected together. One MCU may control switches 304 in the first and second instances of stacks 602a.

All tubes 420, such as tubes 420a, received in all bus bars of stack 602a may be substantially equal in length. Although not shown in FIGS. 6A-1, 6A-2, and 6A-3 first and second manifolds may be in fluid communication with first and second ends, respectively, of tubes 420a.

Liquid dielectric material such as epoxy, silicon, etc., can be added to air gaps or empty spaces between electrical conductors of stack 602a, including adjacent electrical conductors of naked packaged switches 247 if employed, and then cured to create structures that suppress dendrite growth and electrical arcing therebetween.

Stacks can be made with dielectric-fluid cooled bus bars. FIG. 6A-4-6A-6 illustrate relevant components of an example stack 602c with dielectric-fluid cooled bus bars 417ofb, 418air, and 412ofb. Stack 602c is like stack 602a described above with bus bars 417fb, 418fb, and 412fb replaced by bus bars 417ofb, 418air, and 412ofb, respectively. FIG. 6A-4-6A-6 shows stack 602c when seen from the front, right, and left sides, respectively.

Stack 602 includes submodules 605c as shown. Each submodule 605c may include packaged switches 247d as shown, it being understood that in an alternative version packaged switches 247d may be replaced by packaged switches 247p or packaged switches 247q. All packaged switches 247 of stack 602c may be the same type. Packaged switches 247d of stack 602c may be packaged switch 247dA, 247dB, or 247dD of FIGS. 3A, 3B, and 3D, respectively.

Each submodule 605c may include a capacitor 403ofb, bus bar 417ofb, bus bar 412ofb, and bus bars 418air as shown. Bus bars 418airb and 418aira in each submodule 605c may be fluidly connected by a coupling 532a. Bus bars 417ofb, 412ofb, and 418air are more fully described above.

Each submodule 605c may include bus bar-leads 456a and 456b, which may be electrically connected (e.g., welded) to respective bus bars 418fb as shown in FIGS. 6A-5 and 6A-6. Bus bar-leads 465b of adjacent submodules 605c may be electrically connected. FIG. 6A-6 shows bus bar-leads 465b 1 and 465b2 electrically connected. Bus bar-leads 465a of adjacent submodules 605c may be electrically connected. Although not shown, bus bar-lead 465a1 in FIG. 6A-5 may be electrically connected to a terminal of a device (not shown) such as a capacitor, inductor, voltage source, bus-bar lead 465 of another submodule 605c, etc. Although not shown, bus bar-lead 465a2 in FIG. 6A-5 may be electrically connected to a terminal of another device such as a capacitor, inductor, voltage source, bus-bar lead 465 of a fourth submodule 605a, etc.

Although not shown, a third submodule 605c3 and a second insulator 604-2 could be added to the top of stack 602c. The second insulator 604-2 may be sandwiched between submodule 605c1 and the third submodule 605c3. The second insulator 604-2 should electrically isolate capacitor-lead 405fb2a1 from a capacitor-lead 405fb2b3 (not shown) of the third submodule 605c3. Bus bar-lead 465a3 (not shown) of the third submodule 605a3 may be electrically connected to bus bar-lead 465a1 of FIG. 6A-5, and bus bar-lead 465b3 (not shown) of the third submodule 605c3 may be connected to a terminal of a device (not shown) such as a capacitor, inductor, voltage source, bus-bar lead 465 of another submodule 605c, etc.

Regardless of whether the third submodule 605c3 is added to the top as mentioned above, a fourth submodule 605c4 (not shown) and a third insulator 604-3 (not shown) could be added to the bottom of stack 602c. The third insulator 604-3 may be sandwiched between capacitor-lead 405fb2b2 and a capacitor-lead 405f2ba4 (not shown) of the fourth submodule 605c4. The third insulator 604-3 should electrically isolate capacitor-lead 405fb2b2 from the capacitor-lead 405fb2a4 of the fourth submodule 605c4. Bus bar-lead 465a4 (not shown) of the fourth submodule 605c4 may be electrically connected to bus bar-lead 465a2 of FIG. 6A-5, and bus bar-lead 465b4 (not shown) of the fourth submodule 650c4 may be electrically connected to a terminal of a device (not shown) such as a capacitor, inductor, voltage source, bus-bar lead 465 of another submodule 605c, etc.

Each submodule 605c may have two legs designated a and b as shown in as shown FIGS. 6A-5 and 6A-6, respectively, and each leg may include packaged switches 247dH and 247dL. Each packaged switch 247dH and 247dL in a submodule leg may be electrically and thermally connected to a respective bus bar 418air as shown, which in combination may be sandwiched between bus bar 417ofb and bus bar 412ofb as shown. In an alternative embodiment, each submodule leg in a stack 602c may include two or more packaged switches 247dH that are electrically connected in parallel between bus bar 417ofb and a respective bus bar 418air, and two or more packaged switches 247dL that are electrically connected in parallel between bus bar 412ofb and the respective bus bar 418air. The bus bars of stack 602c may need to be lengthened or widened to accommodate the additional multiple packaged switches 247d.

FIG. 6A-4 illustrates the relative positioning of packaged switches 247d, bus bars 417ofb, bus bars 418air, bus bars 412ofb, capacitors 403ofb, and insulator 604-1 with respect to each other. Die substrate terminals 230 and die clip terminals 344 may be pressed-fitted, soldered, sintered, welded, or connected by other means directly to corresponding flat surfaces of bus bars to establish thermal and electrical connectivity. Packaged switches 247dH in each submodule 605c may have die substrate terminals 230 that are electrically and thermally connected (e.g., soldered, sintered, press-fitted, etc.) directly or indirectly to a flat surface or respective flat surfaces of bus bar 417ofb, and die clip terminals 344 that may be electrically and thermally connected (e.g., soldered, sintered, press-fitted, etc.) directly or indirectly to respective flat surfaces of respective bus bars 418air as shown. Packaged switches 247dL in each submodule 605c may have die substrate terminals 230 that may be electrically and thermally connected (e.g., soldered, sintered, press-fitted, etc.) directly or indirectly to respective flat surfaces of respective bus bars 418air, and die clip terminals 344 that may be electrically and thermally connected (e.g., soldered, sintered, press-fitted, etc.) directly or indirectly to a flat surface or respective flat surfaces of a bus bar 412ofb as shown.

FIG. 6A-4 shows dielectric fluid (e.g., castor oil) flowing through bus bars 417ofb and 412ofb. Bus bars 418air in each submodule 605c may be thermally connected to each other and electrically isolated from each other by coupling 532a, which is more fully described above. Dielectric fluid can flow through bus bars 418aira and 418airb via coupling 532a. Bus bars 417ofb, 412ofb, and 418air may be in fluid communication with a pump or other device for moving the dielectric fluid through stack 602c. Although not shown in FIGS. 6A-4, 6A-5, and 6A-6 first and second manifolds may be in fluid communication with first and second ends, respectively, of bus bars 417ofb, 418air, and 412ofb.

Each submodule 605c of stack 602c may include a film capacitor 403ofb. A flat bottom surface of capacitor-lead 405fb2a may be electrically and thermally connected (e.g., welded, soldered, press-fitted by screws or other fasteners, etc.) directly to a flat surface of a respective bus bar 417ofb, and a flat top surface area of capacitor-lead 405fb2b may be electrically and thermally connected to a flat surface of a respective bus bar 412ofb as shown. Although not shown, one or more ceramic DC link capacitors may be electrically and thermally connected between bus bar 417ofb and bus bar 412ofb in each submodule 605c.

Two instances of stack 602c can be electrically connected in series to form a leg of a modular multi-level converter (e.g., modular multi-level three-phase inverter or rectifier). For example: bus bar-lead 465a1 of a first instance of stack 602c may be electrically connected to a (e.g., V+) terminal of a voltage source while bus bar-lead 465a2 of the first instance may be electrically connected to a first terminal of a first inductor; bus bar-lead 465a2 of a second instance of stack 602c may be electrically connected to a terminal (e.g., V−) of the voltage source while bus bar-lead 465a1 of the second instance may be electrically connected to a first terminal of a second inductor, and; the second terminals of the first and second inductors can be electrically connected together. One MCU may control switches 304 in the first and second instances of stacks 602c.

Liquid dielectric material such as epoxy, silicon, etc., can be added to air gaps or empty spaces between electrical conductors of stack 602c, including adjacent electrical conductors of naked packaged switches 247 if employed, and then cured to create structures that suppress dendrite growth and electrical arcing therebetween.

A stack may be built with half bridge submodules. FIGS. 6B-1 and 6B-2 illustrate relevant components of an example stack 602b, which includes a pair of submodules 605b1 and 605b2 that include packaged switches 247 connected in half bridge configurations. FIGS. 6B-1 and 6B-2 show stack 602b when seen from the front and left sides, respectively.

Each submodule 605b of stack 602b may include packaged switches 247d as shown, it being understood that in an alternative version packaged switches 247d may be replaced by packaged switches 247p or packaged switches 247q. All packaged switches 247 of stack 602b may be the same type. Packaged switches 247d of each submodule 605b may be packaged switch 247dA, 247dB, or 247dD of FIGS. 3A, 3B, and 3D, respectively.

Each submodule 605b may include a capacitor 403n, bus bar 417n, bus bar 412n, and bus bar 418n as shown. An insulator may be sandwiched between submodules 605b. For example, insulator 606-1 is sandwiched between capacitor-leads 405nb1 and 405na2 of submodules 605b1 and 605b2, respectively, as shown. Insulator 606 may be manufactured (e.g., extruded) from or made to include a dielectric material (e.g., a ceramic) that electrically isolates devices, such as capacitor-leads 405nb1 and 405na2, between which insulator 606 is sandwiched.

Each submodule 605b may include bus bar-leads 456a and 456e as shown in FIG. 6B-2. Bus bar-leads 465a and 465e of adjacent submodules 605b may be electrically connected. FIG. 6B-2 shows bus bar-leads 465e1 and 465a2 electrically connected. Bus bar-lead 465a1 in stack 602b may be electrically connected to a terminal of a device (not shown) such as a capacitor, inductor, voltage source, bus bar-lead 465e of another submodule 605b, etc. Bus bar-lead 465e2 in stack 602b may be electrically connected to a terminal of a device (not shown) such as a capacitor, inductor, voltage source, bus bar-lead 465a of another submodule 605b, etc.

Although not shown, a third submodule 605b3 and a second insulator 606-2 could be added to the top of stack 602b. The second insulator 606-2 may be sandwiched between submodule 605b1 and the third submodule 605b3. The second insulator 606-2 should electrically isolate capacitor-lead 405na1 from a capacitor-lead 405nb3 (not shown) of the third submodule 605b3. Bus bar-lead 465e3 (not shown) of the third submodule 605b3 may be electrically connected to bus bar-lead 465a1 or to a terminal of a device (not shown) such as a capacitor, inductor, voltage source, bus bar-lead 465a of another submodule 605b, etc.

Regardless of whether a second insulator 606-2 is sandwiched between submodule 605b1 and the third submodule 605b3 as mentioned above, a third insulator 606-3 (not shown) and a fourth submodule 605b4 (not shown) may be added to the bottom of stack 602b. The third insulator 606-3 may be sandwiched between capacitor-lead 405nb2 and a capacitor-lead 405na4 (not shown) of the fourth submodule 605b4. The third insulator 606-3 should electrically isolate capacitor-lead 405nb2 from the capacitor-lead 405na4 of the fourth submodule 605b4. Bus bar-lead 465a4 of the fourth submodule 605b4 may be electrically connected to bus bar-lead 465e2. Bus bar-lead 465e4 (not shown) of the fourth submodule may be electrically connected to the terminal of a device (not shown) such as a capacitor, inductor, voltage source, bus bar-lead 465a of another submodule 605b, etc.

Each submodule 605b may include packaged switches 247dH and 247dL as shown. Packaged switches 247dH and 247dL may be electrically and thermally connected to bus bar 418n, which in combination may be sandwiched between bus bar 417n and bus bar 412n as shown. Packaged switches 247dH and 247dL in each submodule 605b may be also electrically and thermally connected to bus bar 417n and bus bar 412n, respectively, as shown. Alternatively, each submodule 605b may include two or more packaged switch 247dH electrically connected in parallel between bus 418n and 417n, and two or more packaged switches 247dL electrically connected in parallel between bus 418n and 412n. The bus bars may need to be lengthened or widened to accommodate these additional packaged switches 247d.

FIG. 6B-1 illustrates the relative positioning of packaged switches 247d, bus bars 417n, bus bars 418n, bus bars 412n, capacitors 403n and insulator 606-1 with respect to each other. Die substrate terminals 230 and die clip terminals 344 may be pressed-fitted, soldered, sintered, welded, or connected by other means directly to corresponding flat surfaces of bus bars to establish thermal and electrical connectivity. Packaged switches 247dH in each submodule 605b may have a die substrate terminal 230 that is electrically and thermally connected (e.g., soldered, sintered, press-fitted, etc.) directly or indirectly to a flat surface of bus bars 417n, and a die clip terminal 344 that is electrically and thermally connected (e.g., soldered, sintered, press-fitted, etc.) directly or indirectly to a flat surface of bus bar 418n as shown. Packaged switches 247dL in each submodule 605b may have a die substrate terminal 230 that is electrically and thermally connected (e.g., soldered, sintered, press-fitted, etc.) directly or indirectly to a flat surface of bus bar 418n, and a die clip terminal 344 that is electrically and thermally connected (e.g., soldered, sintered, press-fitted, etc.) directly or indirectly to a flat surface of bus bar 412n as shown.

Bus bars, like bus bar 417n, bus bar 412n, and bus bar 418n in FIGS. 6B-1 and 6B-2, may have a generally rectangular cuboid shape. Example bus bars 417n, bus bars 412n, and bus bars 418n may have height, width, and length around 12 mm, 25 mm, and 20 mm, respectively. FIG. 6B-1 shows the height and length of the bus bars.

FIGS. 6B-1 and 6B-2 show submodules 605b with dielectric tubes 420a received by bus bars. Tubes other than 420a can be received by the bus bars. For example, each of bus bars 412n, 418n and 417n can be formed by soldering metal bus bar portions around tubes 420d or 420e using a process like that described with reference to FIGS. 5A-17-1-5A-17-5. Or the bus bars can be swapped with bus bars formed around tubes like tubes 420v1 using a process like that described with reference to FIGS. 9A-30-9A-33.

Each submodule 605b may include a film capacitor 403n. A flat bottom surface of capacitor-lead 405na may be electrically and thermally connected (e.g., welded, soldered, press-fitted by screws or other fasteners, etc.) directly to a flat surface of bus bar 417n, and a flat top surface area of capacitor-lead 405nb may be electrically and thermally connected to a flat surface of bus bar 412n as shown in FIG. 6B-2. Although not shown, one or more ceramic DC link capacitors may be electrically and thermally connected between bus bar 417n and bus bar 412n in each submodule 605b.

Stack 602b may include a control PCB 462n and a driver PCB 461n as shown. Drivers 306 on driver PCB 461n can send transistor control signals to respective switches 304 through respective connector-leads 288g. Drivers 306 and connector-leads 288gH and 288gL of each submodule 605b are shown in FIG. 6B-2. Driver PCB 461n may include voltage sensors V_Sense that can sense voltages between respective pairs of connector-leads 288ds and 288dc (not shown).

Example bar-leads 465 in each submodule 605b may extend laterally between first and second ends. The first ends of bus bar-leads 465a and 465e may be electrically connected (e.g., welded) to phase bus bar 418n and 412n, respectively, in each submodule 605b as shown in FIG. 6B-2. The second ends of bus bar-leads 465a and 465e in adjacent submodules 605b, such as 465a2 and 465e1, may be electrically connected to each other as shown. Each bus bar-lead 465a may extend through a respective aperture in PCB 461n. Each current sensor I_Sense can measure electrical current flowing through a respective bus bar-lead-lead 465a in stack 602b. I_Sense may include an aperture through which a respective bus bar-lead-lead 465 may extend. FIG. 6B-2 shows drivers 306, voltage sensors V_Sense, PMICs, current sensors I_Sense, and bus bar-leads 465 for each submodule 605b of stack 602b.

FIG. 6B-2 shows an MCU mounted on control PCB 462n. The MCU may be in data communication with each driver 306, V_Sense, and I_Sense mounted on driver PCB 461n through a data connection 484.

All tubes 420, such as tubes 420a, received in all bus bars in stack 602b may be substantially equal in length. Although not shown in FIGS. 6B-1 and 6B-2, first and second manifolds may be in fluid communication with first and second ends, respectively, of the tubes 420a.

Two instances of stack 602b can be electrically connected in series to form a leg of a modular multi-level converter (e.g., modular multi-level three-phase inverter or rectifier). For example: bus bar-lead 465a1 of a first instance of stack 602b may be electrically connected to a (e.g., V+) terminal of a voltage source while bus bar-lead 465e2 of the first instance may be electrically connected to a first terminal of a first inductor; bus bar-lead 465e2 of a second instance of stack 602b may be electrically connected to a terminal (e.g., V−) of the voltage source while bus bar-lead 465a1 of the second instance may be electrically connected to a first terminal of a second inductor, and; the second terminals of the first and second inductors can be electrically connected together. One MCU may control switches 304 in the first and second instances of stacks 602b.

Liquid dielectric material such as epoxy, silicon, etc., can be added to air gaps or empty spaces between electrical conductors of stack 602b, including adjacent electrical conductors of naked packaged switches 247 if employed, and then cured to create structures that suppress dendrite growth and electrical arcing therebetween.

FIGS. 6B-3 and 6B-4 illustrate relevant components of an example stack 602d with dielectric fluid cooled bus bars 418air. Stack 602c is like stack 602b described above with bus bars 417n, 418n, and 412n replaced by bus bars 418aira, 418airb, and 418airc, respectively. Bus bars 418air in FIGS. 6B-3 and 6B-4, may have a generally rectangular cuboid shape as shown. FIGS. 6B-3 and 6B-4 show stack 602d with when seen from the front and left sides, respectively.

Each submodule 605d of stack 602d may include packaged switches 247d as shown, it being understood that in an alternative version packaged switches 247d may be replaced by packaged switches 247p or packaged switches 247q. All packaged switches 247 in stack 602d may be the same type. Packaged switches 247d of each submodule 605d may be packaged switch 247dA, 247dB, or 247dD of FIGS. 3A, 3B, and 3D, respectively.

Each submodule 605d may include a capacitor 403d, bus bar 418aira, bus bar 418airb, and bus bar 418airc as shown. An insulator may be sandwiched between submodules 605d. For example, insulator 606-1 is sandwiched between capacitor-leads 405db1 and 405da2 as shown. Insulator 606 may be manufactured (e.g., extruded) from or made to include a dielectric material (e.g., a ceramic) that electrically isolates devices, such as capacitor-leads 405db1 and 405da2, between which insulator 606 is sandwiched.

Each submodule 605d may include bus bar-leads 456a and 456e as shown in FIG. 6B-4. Bus bar-leads 465a and 465e of adjacent submodules 605d may be electrically connected. FIG. 6B-4 shows bus bar-leads 465e1 and 465a2 electrically connected. Bus bar-lead 465a1 in stack 602d may be electrically connected to a terminal of a device (not shown) such as a capacitor, inductor, voltage source, bus bar-lead 465e of another submodule 605d, etc. Bus bar-lead 465e2 in stack 602d may be electrically connected to a terminal of a device (not shown) such as a capacitor, inductor, voltage source, bus bar-lead 465a of another submodule 605d, etc.

Although not shown, a third submodule 605d3 and a second insulator 606-2 could be added to the top of stack 602d. The second insulator 606-2 may be sandwiched between submodule 605d1 and the third submodule 605d3. Bus bar-lead 465e3 (not shown) of the third submodule 605d3 may be electrically connected to bus bar-lead 465a1 or to a terminal of a device (not shown) such as a capacitor, inductor, voltage source, bus bar-lead 465e of another submodule 605d, etc.

Regardless of whether the third submodule 650d3 is added to the top of stack 602d, a fourth submodule 605d4 (not shown) and A third insulator 606-3 (not shown) could be added to bottom of stack 602d. The third insulator 606-3 may electrically isolate capacitor-lead 405db2 from the capacitor-lead 405da4 (not shown) of the fourth submodule 605d4. Bus bar-lead 465a4 of the fourth submodule 460fb4 may be electrically connected to bus bar-lead 465e2 or to a terminal of a device (not shown) such as a capacitor, inductor, voltage source, bus bar-lead 465 of another submodule 605d, etc.

Each submodule 605d may include packaged switches 247dH and 247dL as shown. Packaged switches 247dH and 247dL may be electrically and thermally connected to bus bar 418airb, which in combination may be sandwiched between bus bar 418aira and bus bar 418airc as shown. Packaged switches 247dH and 247dL in each submodule 605d may be also electrically and thermally connected to bus bar 418aira and bus bar 418airc, respectively. Alternatively, each submodule 605d may include two or more packaged switch 247dH electrically connected in parallel between bus 418aira and 418airb, and two or more packaged switches 247dL electrically connected in parallel between bus 418airb and 418airc. The bus bars may need to be lengthened or widened to accommodate these additional packaged switches 247d.

FIG. 6B-3 illustrates the relative positioning of packaged switches 247d, bus bars 418aira-418airc, capacitors 403d, and insulator 606-1 with respect to each other. Die substrate terminals 230 and die clip terminals 344 may be pressed-fitted, soldered, sintered, welded, or connected by other means directly to corresponding flat surfaces of bus bars to establish thermal and electrical connectivity. Packaged switches 247dH in each submodule 605d may have a die substrate terminal 230 that is electrically and thermally connected (e.g., soldered, sintered, press-fitted, etc.) directly or indirectly to a flat surface of bus bar 418aira, and a die clip terminal 344 that is electrically and thermally connected (e.g., soldered, sintered, press-fitted, etc.) directly or indirectly to a flat surface of bus bar 418airb as shown. Packaged switches 247dL in each submodule 605d of stack 602d may have a die substrate terminal 230 that is electrically and thermally connected (e.g., soldered, sintered, press-fitted, etc.) directly or indirectly to a flat surface of bus bar 418airb, and a die clip terminal 344 that is electrically and thermally connected (e.g., soldered, sintered, press-fitted, etc.) directly or indirectly to a flat surface of bus bar 418airc as shown.

Each submodule 605d may include a film capacitor 403d. A flat bottom surface of capacitor-lead 405da may be electrically and thermally connected (e.g., welded, soldered, press-fitted by screws or other fasteners, etc.) directly to a flat surface of bus bar 418aira, and a flat top surface area of capacitor-lead 405db may be electrically and thermally connected to a flat surface of bus bar 418airc as shown. Although not shown, one or more ceramic DC link capacitors may be electrically and thermally connected between bus bar 418aira and bus bar 418airc in each submodule 605d of stack 602d.

Stack 602d may include a control PCB 462n and a driver PCB 461n as shown. Drivers 306 on driver PCB 461n can send transistor control signals to respective switches 304 through respective connector-leads 288g. Drivers 306 and connector-leads 288gH and 288gL of each submodule 605d are shown in FIG. 6B-4. Driver PCB 461n may include voltage sensors V_Sense that can sense voltages between respective pairs of connector-leads 288ds and 288dc (not shown).

Example bar-leads 465 in each submodule 605d of stack 602d may extend laterally between first and second ends. The first ends of bus bar-leads 465a and 465e may be electrically connected (e.g., welded) to phase bus bar 418airb and 418airc, respectively, in each submodule 605d as shown. The second ends of bus bar-leads 465a and 465e in adjacent submodules 605d, such as 465a2 and 465e1, may be electrically connected to each other as shown. Each bus bar-lead 465a may extend through a respective aperture in PCB 461n. Each current sensor I_Sense can measure electrical current flowing through a respective bus bar-lead-lead 465a in stack 602d. I_Sense may include an aperture through which a respective bus bar-lead-lead 465 may extend. FIG. 6B-4 shows drivers 306, voltage sensors V_Sense, PMICs, current sensors I_Sense, and bus bar-leads 465 for each submodule 605d of stack 602d. FIG. 6B-4 shows an MCU mounted on control PCB 462n. The MCU may be in data communication with each driver 306, V_Sense, and I_Sense mounted on driver PCB 461n through data connection 484.

FIG. 6B-3 shows dielectric fluid (e.g., castor oil) flowing through bus bars 418air. Bus bars 418air may be in fluid communication with a pump or other device for moving the dielectric fluid through bus bars 418air. Although not shown in FIGS. 6B-3 and 6B-4 first and second manifolds may be in fluid communication with first and second ends, respectively, of bus bars 418air.

Two instances of stack 602d can be electrically connected in series to form a leg of a modular multi-level converter (e.g., modular multi-level three-phase inverter or rectifier). For example: bus bar-lead 465a1 of a first instance of stack 602d may be electrically connected to a (e.g., V+) terminal of a voltage source while bus bar-lead 465e2 of the first instance may be electrically connected to a first terminal of a first inductor; bus bar-lead 465e2 of a second instance of stack 602d may be electrically connected to a terminal (e.g., V−) of the voltage source while bus bar-lead 465a1 of the second instance may be electrically connected to a first terminal of a second inductor, and; the second terminals of the first and second inductors can be electrically connected together. One MCU may control switches 304 in the first and second instances of stacks 602b.

Liquid dielectric material such as epoxy, silicon, etc., can be added to air gaps or empty spaces between electrical conductors of stack 602d, including adjacent electrical conductors of naked packaged switches 247 if employed, and then cured to create structures that suppress dendrite growth and electrical arcing therebetween.

Packaged switches 247 can be stacked with bus bars to create a multi-layered or stacked switch with a high-voltage rating. FIGS. 6C-1-6C-3 illustrate relevant components of an example stacked switch 602e that includes three submodules 605e1-605e3 electrically connected in series. In an alternative embodiment, stacked switch 602e can be built with two submodules 605e, or four or more submodules 605e electrically connected in series. FIGS. 6C-1-6C-3 show stacked switch 602e when seen from the front, left, and right sides, respectively.

Each submodule 605e may include a packaged switch 247d and packaged diode 245M electrically connected in parallel between a pair of bus bars 418dc as shown. Adjacent submodules 605e share a bus bar 418dc. In an alternative embodiment, stacked switch 602e may lack packaged diodes 245.

Submodules 605e may be electrically connected in series between bus bar-leads 465t1 and 465t2 as shown. Bus bar-leads 465 may act as terminals for electrical connection to other devices. First ends of bus bar-leads 465t1 and 465t2 may be electrically connected (e.g., welded) to the wide, flat outer surfaces of bus bars 418dcl and 418dc4, respectively, as shown. A second end of bus bar-lead 465t1 may be electrically connected to a terminal of a device such as a capacitor, inductor, voltage source, etc., and a second end of bus bar-lead 465t2 may be electrically connected to a terminal of another device.

Each submodule 605e of stacked switch 602e may include a packaged switch 247d as shown, it being understood that in an alternative version packaged switches 247d may be replaced by packaged switches 247p or packaged switches 247q. All packaged switches 247 of stacked switch 602e may be the same type. Packaged switch 247d of each submodule 605e may be packaged switch 247dA, 247dB, or 247dD of FIGS. 3A, 3B, and 3D, respectively. Each submodule 605e may include a packaged diode 245M as shown, it being understood that packaged diode 245M can be replaced with packaged diode 345N. All packaged diodes 245 of stacked switch 602e may be the same type.

Stacked switch 602e can operate in the forward or reverse direction. In the forward direction, current IF can pass from bus bar-lead 465t1 to bus bar-lead 465t2 via packaged switches 247d in submodules 605e, assuming all switches 304d1 are activated and voltage V1 is greater in magnitude than voltage V2. In the reverse direction, current IR can pass from bus bar-leads 465t2 to bus bar-lead 465t1 via packaged switches 247d and/or packaged diodes 245M in submodules 605e, assuming voltage V2 is greater in magnitude than voltage V1.

Each submodule 605e includes a packaged switch 247dH and a packaged diode 245M that may be electrically and thermally connected in parallel between adjacent bus bars 418dc as shown. Alternatively, each submodule 605e may include more than one packaged switch 247d and more than one packaged diode 245M that may be electrically and thermally connected between adjacent bus bars 418dc. For example, four packaged switches 247d may be electrically connected in parallel between adjacent bus bars 418dc and/or four packaged diodes 245M may be electrically connected in parallel between adjacent bus bars 418dc to enable greater current conduction between bus bar-leads 465t.

FIG. 6C-1 illustrates the relative positioning of packaged switches 247d, packaged diodes 245M, and bus bars 418dc with respect to each other. Die substrate terminals 230 in each submodule 605e may be pressed-fitted, soldered, sintered, welded, or connected by other means directly to a flat surface or respective flat surfaces of a first bus bar 418dc to establish thermal and electrical connectivity, and die clip terminals 344 in each submodule 605e may be pressed-fitted, soldered, sintered, welded, or connected by other means directly to a flat surface or respective flat surfaces of a second bus bar 418dc to establish thermal and electrical connectivity. For example, packaged switches 247d1 and packaged diodes 245M-1 in submodule 605e1 may have die substrate terminals 230 that are electrically and thermally connected (e.g., soldered, sintered, press-fitted, etc.) directly or indirectly to a flat surface or respective flat surfaces of bus bars 418dc1, and die clip terminals 344 that are electrically and thermally connected (e.g., soldered, sintered, press-fitted, etc.) directly or indirectly to a flat surface or respective flat surfaces of bus bar 418dc2 as shown.

Bus bars 418dc may have a generally rectangular cuboid shape as shown. Each of example bus bars 418dc may have a height, width, and length around 8 mm, 55 mm, and 20 mm, respectively. The height and length are shown in FIGS. 6C-2 and 6C-3. The width or length of bus bars 418d may need to be increased to accommodate more than one package switch 247d and/or more than one packaged diode 245M connected in parallel between adjacent bus bars 418d.

FIGS. 6C-1-6C-3 show submodules 605e with dielectric tubes 420a received by bus bars 418dc. Tubes other than 420a can be received by the bus bars. For example, each of bus bars 418dc can be formed by soldering metal bus bar portions around tubes 420d or 420e using a process like that described with reference to FIGS. 5A-17-1-5A-17-5. Or the bus bars can be swapped with bus bars formed around tubes like tubes 420v1 using a process like that described with reference to FIGS. 9A-30-9A-33.

A stacked switch, including stacked switch 602e, may include a control unit (e.g., MCU) for activating or deactivating all switches 304 in the stacked switch at substantially the same point in time. The control unit can generate a driver control signal for controlling switches 304 in the stacked switch via their respectively connected drivers 306. Ideally, all switches 304 in a stacked switch should be activated or deactivated at the same time. A signal distribution network can deliver the driver control signal in parallel to all drivers 306 in the stacked switch so that the drivers 306 receive the signal at substantially the same point in time. The signal distribution network may include a transmitter system that may be in data communication with a control unit. The transmitter system may receive a driver control signal from the control unit. The signal distribution network may include fiber optical cables and photodetectors or optoelectronic converters. A first end of each fiber optic cable may be in data communication with the control unit via the transmitter system, and the second end of each fiber optic cable may be in data communication with a respective driver 306 via a respective optoelectronic converter. The transmitter system can send driver control signals into the fiber optic cables. The fiber optic cables can transmit the driver control signals at the same time and in parallel. The optoelectronic converters may be in data communication with respective fiber optic cables, and the optoelectronic converters may be in data communication with respective PCB traces, which in turn are electrically connected to respective drivers 306. The signal distribution network may include driver the PCB traces that are electrically connected, directly or indirectly, to respective inputs of drivers 306 in the stacked switch. The PCB traces can transmit the driver control signal in parallel and at the same time to respective inputs of drivers 306 in the stacked switch. The optoelectronic converters may convert optical driver control signals that are received via respective optical fiber cables into electrical driver control signals for subsequent transmission to respective drivers 306 via respective PCB traces. The PCB traces connected between the optoelectronic converters and drivers 306 may have substantially the same length and width so that all drivers 306 in the stacked switch may receive the same driver control signal at substantially the same time. The signal distribution network may include additional components between the control unit and the drivers 306 in a switched stack. In an alternative embodiment, the signal distribution network may include a single fiber optic cable and a single optoelectronic converter. In this embodiment, the single optoelectronic converter may receive and convert an optical driver control signal into an electrical driver control signal for transmission in parallel to the drivers 306 in the stacked switch via a common PCB trace. Stacked switches, including stacked switch 602e of FIG. 6C-1, may include a control PCB 462p and a driver PCB 461p, each of which are seen from the side. Stacked switches, such as stacked switch 602e, may include a signal distribution network that includes fiber optic cables such as fiber optic cables 624. Although not shown, stacked switches, such as stacked switch 602e, may also include a connector 484 that enables additional data communication between control PCB 462p and driver PCB 461p. Fiber optic cables 624 enable data communication between control PCB 462p and driver PCB 461p. Fiber optic cables 624 are symbolized in the figures. Driver PCB 461p may include optoelectronic converters 622 for converting optical signals into electrical signals, and vice versa. Optoelectronic converters 622 are symbolized in the figures and shown mounted on driver PCB 461p. Each optoelectronic converter 622 may be in data communication with a respective one of the fiber optic cables 624. Each optoelectronic converter 622 may be connected to receive an optical signal from a respective one of the fiber optic cables 624. Each optoelectronic converter 622 may be in data communication with a respective driver 306 mounted on driver PCB 461p via a respective trace formed thereon. Each optoelectronic converters 622 can send an electrical signal it generates to a respective driver 306, or each optoelectronic converters 622 can receive an electrical signal from a respective driver 306 for conversion into an optical signal to be transmitted to control PCB 462p via a respective one of the fiber optic cables 624. Drivers 306 can generate and send transistor activation or deactivation control signals to respective switches 304 through respective connector-leads 288g in response to drivers 306 receiving corresponding driver control signals from respective optoelectronic converters 622. Fiber optic cables 624 may be connected between an MCU mounted on control PCB 462p and respective optoelectronic converters 622. Fiber optic cables 624 may be in data communication with the MCU and respective optoelectronic converters 622. The fiber optic cables 624 may have equal or unequal lengths between first and second ends. Optoelectronic converters 622 are mounted on driver PCB 461p and data communication with respective drivers 306 via respective traces. Each optoelectronic converter 622 can convert an optical driver control signal received via a respective one of the fiber optic cables 624 into a corresponding electrical driver control signal for subsequent transmission to a respective driver 306 via a respective trace on driver PCB 461p. Ideally the traces between the optoelectronic converters 622 and respective drivers 306 may have the same length and width. All drivers 306 of a stacked switch, such as stacked switch 602e, may be connected to receive the same MCU generated driver control signal at substantially the same point in time, to activate their respective switches 304 at substantially the same time or deactivate their respective switches 304d at substantially the same time. Although not shown, driver PCB 461p may include voltage sensors V_Sense that can sense voltages between respective pairs of connector-leads 288ds and 288dc (not shown). Driver PCB 461p is shown as a unified PCB. In an alternative embodiment, optoelectronic converters 622, drivers 306, PMICs, and voltage sensors for respective submodules 605 may be mounted on respective sub-driver PCBs to enable voltage separation or isolation therebetween. The voltage sensor on each sub-driver PCB may be connected to a respective pair of connector-leads 288ds and 288dc. The driver 306 on each sub-driver PCB may control a respective switch 304. The optoelectronic converter 622 on each sub-driver PCB may be in data communication with a respective driver 306 via a respective trace. In an alternative embodiment of the stacked switch 602e shown in FIG. 6C-1, bus bar-lead 465t1 or 465t2 may be repositioned so that its first end is electrically connected (e.g., welded) to the short, flat outer side surface of bus bars 418dcl or 418dc4. In this alternative embodiment, the second end of the repositioned bus bar-lead 465t1 or 465t2 may extend through an aperture of a current sensor I_Sense (not shown) mounted on driver PCB 461p or on a sub-driver PCB.

An MCU may be mounted on control PCB such as control PCB 462p shown in FIG. 6C-1. The MCU of a control PCB 462p may be in data communication with each driver 306 mounted on driver PCB 461p through a respective one of the fiber optic cables 624 and a respective optoelectronic converter 622. A transmitter system 626 with optical fan-out may be mounted on control PCB 462p. The transmitter system 626 may receive an electrical driver control signal from the MCU via a trace and convert it into an optical equivalent for transmission on each one of the fiber optic cables 624. The transmitter system 626 may include an optical splitter that can simultaneously send an optical signal into each one of the fiber optic cables 624. The transmitter system 626 may include optical transmitters that simultaneously receive a copy of electrical driver control signal from the MCU and send optical signal equivalents into respective cables of the fiber optic cables 624. The MCU of a control PCB 462p may be in data communication with each voltage sensor V_Sense mounted on driver PCB 461p through a respective one of the fiber optic cables 624 and a respective optoelectronic converter 622. Fiber optical cables 624 may also be used to transmit signals other than driver control signals. For example, fiber optical cables 624 may transmit signals between respective voltage sensors V_Sense and the MCU. Or fiber optical cables 624 may transmit fault signals between respective drivers 306 and the MCU. The fault signals may be generated by drivers 306 when they detect fault conditions in their respective switches 304. An MCU can transmit one driver control signal in parallel to all drivers 306 in the stacked switch 602 via respective fiber optic cables. Gate driver control signal input terminals for all drivers 306 in a stacked switch 602 may be connected so that they directly or indirectly receive the same driver control signal from an MCU at substantially the same time. All gate drivers 306 of a stacked switch 602 may be in data communication with the MCU via respective fiber optic cables that transmit respective optical driver control signals to the gate drivers 306, regardless of whether the gate drivers 306 are mounted on the same driver PCB 461p or if the gate drivers 306 are mounted on respective sub-driver PCBs. The gate drivers 306 may activate or deactivate their respective switches 304 at substantially the same point in time in response to receiving the driver control signals from the MCU.

All tubes 420, such as tubes 420a, received in all bus bars 418dc in stacked switch 602e may be substantially equal in length. Although not shown in FIGS. 6C-1-6C-3, first and second manifolds may be in fluid communication with first and second ends, respectively, of the tubes 420a.

Two instances of stacked switch 602e can be electrically connected in series to form a leg of a power converter (e.g., three-phase inverter or three-phase rectifier). For example: bus bar-lead 465t1 of a first instance of stacked switch 602e may be electrically connected to a terminal of a voltage source (e.g., V+) while bus bar-lead 465t2 of the first instance may be electrically connected to a first terminal of an inductor, and; bus bar-lead 465t2 of a second instance of stacked switch 602e may be electrically connected to a terminal of the voltage source (e.g., V−) while bus bar-lead 465t1 of the second instance may be electrically connected to the first terminal of the inductor. One MCU may control switches 304 in the first and second instances of switched stacks 602e via their respective signal distribution networks. However, the MCU may control all drivers 306 of the first instance with one control signal, and all drivers 306 of the second instance with a different control signal, so that the first and second instances of stacked switch 602e can be independently operated; all switches 304d of the first instance can be turned on or turned off at substantially the same first point in time, and all switches 304d of the second instance can be turned on or turned off at substantially the same second point in time, which may be different from the first point of time. Two instances of stacked switch 602e can be electrically connected in parallel. In this embodiment, bus bar-leads 465t in each instance of stacked switch 602e may be electrically connected to a terminal of a voltage source (e.g., V+) while bus bar-leads 465t2 of each instance of stacked switch 602e may be electrically connected to a terminal of the voltage source (e.g., V−). Each packaged switch 247 in the parallel connected instances of stacked switch 602e may be connected to one MCU via respective fiber optic cables so that all switches 304d in the parallel connected instances of stacked switch 602e can be activated or deactivated at substantially the same point in time.

Liquid dielectric material such as epoxy, silicon, etc., can be added to air gaps or empty spaces between electrical conductors of stacked switch 602e, including adjacent electrical conductors of naked packaged switches 247 and naked packaged diodes 245M if employed, and then cured to create structures that suppress dendrite growth and electrical arcing therebetween.

Bus bars 418dc of FIGS. 6C-1-6C-3 may be replaced with dielectric fluid cooled bus bars. FIGS. 6D-1-6D-3 illustrate relevant components of an example stacked switch 602f that includes three submodules 605f1-605f3 with dielectric fluid cooled bus bars 418u. Bus FIGS. 6D-1-6D-3 show stacked switch 602f when seen from the front, left, and right sides, respectively.

Each submodule 605f may include a packaged switch 247d and a packaged diode 245M electrically connected in parallel between a pair of bus bars 418u as shown. In an alternative embodiment, stacked switch 602f may lack packaged diodes 245M. Adjacent submodules 605f share a bus bar 418u. Bus bars 418u are described above. It is noted that a stack like stacked switch 602f may have more than three submodules 605f or fewer than three submodules 605f electrically connected in series.

Submodules 605f may be electrically connected in series between bus bar-leads 465t1 and 465t2 as shown. First ends of bus bar-leads 465t1 and 465t2 may be electrically connected (e.g., welded) to the wide, flat outer surfaces of bus bars 418u1 and 418u4, respectively, as shown. A second end of bus bar-lead 465t1 may be electrically connected to a terminal of a device such as a capacitor, inductor, voltage source, etc., and a second end of bus bar-lead 465t2 may be electrically connected to a terminal of a device such as a capacitor, inductor, voltage source, etc.

Each submodule 605f may include a packaged switch 247d as shown, it being understood that in an alternative version packaged switches 247d may be replaced by packaged switches 247p or packaged switches 247q. All packaged switches 247 of stacked switch 602f may be the same type. Packaged switch 247d of each submodule 605f may be packaged switch 247dA, 247dB, or 247dD of FIGS. 3A, 3B, and 3D, respectively. Each submodule 605f may include a packaged diode 245M. All packaged diodes 245 of stacked switch 602f may be the same type. Packaged diode 245M could be replaced with packaged diode 245N of FIG. 3N.

Stacked switch 602f can operate in the forward or reverse direction. In the forward direction, current IF can pass from bus bar-lead 465t1 to bus bar-lead 465t2 via activated packaged switches 247d in submodules 605f, assuming voltage V1 is greater in magnitude than voltage V2. In the reverse direction, current IR can pass from bus bar-lead 465t2 to bus bar-lead 465t1 via packaged switches 247d and/or packaged diodes 245M, assuming voltage V2 is greater in magnitude than voltage V1.

Each submodule 605f includes a packaged switch 247dH and a packaged diode 245M that may be electrically and thermally connected in parallel between adjacent bus bars 418u as shown. Alternatively, each submodule 605f may include more than one packaged switch 247d and more than one packaged diode 245M that are electrically and thermally connected between adjacent bus bars 418u. For example, four packaged switches 247d may be electrically connected in parallel between adjacent bus bars 418u and/or four packaged diodes 245M may be electrically connected in parallel between adjacent bus bars 418u to enable greater current conduction between the adjacent bus bars 418u.

FIG. 6D-1 illustrates the relative positioning of packaged switches 247d, packaged diodes 245M, and bus bars 418u with respect to each other. Die substrate terminals 230 in each submodule 605f may be pressed-fitted, soldered, sintered, welded, or connected by other means directly to a flat surface or respective flat surfaces of a first bus bar 418u to establish thermal and electrical connectivity, and die clip terminals 344 in each submodule 605f may be pressed-fitted, soldered, sintered, welded, or connected by other means directly to a flat surface or respective flat surfaces of a second bus bar 418u to establish thermal and electrical connectivity. For example, packaged switches 247d1 and packaged diodes 245M-1 in submodule 605f1 may have die substrate terminals 230 that are electrically and thermally connected (e.g., soldered, sintered, press-fitted, etc.) directly or indirectly to a flat surface or respective flat surfaces of bus bars 418u1, and die clip terminals 344 that are electrically and thermally connected (e.g., soldered, sintered, press-fitted, etc.) directly or indirectly to a flat surface or respective flat surfaces of bus bar 418u2 as shown. Bus bars 418u may have a generally rectangular cuboid shape as shown as shown.

Stacked switch 602f may include control PCB 462p and driver PCB 461p, which may be in data communication with each other through fiber optic cables 624. Control PCB 462p, driver PCB 461p and fiber optic cables 624 are more fully described above. Drivers 306 on driver PCB 461p can send transistor control signals to respective switches 304 through respective connector-leads 288g (not shown) of packaged switches 247 in which the switches 304 are contained. All drivers 306 shown in FIG. 6D-1 of stacked switch 602f, may be connected to receive the same control signal directly or indirectly from an MCU or other device, to activate their respective switches 304 at substantially the same time or deactivate their respective switches 304d at substantially the same time. In an alternative embodiment of stacked switch 602f, bus bar-lead 465t1 or 465t2 may be repositioned so that its first end is electrically connected (e.g., welded) to the short, flat outer side surface of bus bars 418u1 or 418u4. In this alternative embodiment, the second end of the repositioned bus bar-lead 465t1 or 465t2 may extend through an aperture of a current sensor I_Sense (not shown) mounted on driver PCB 461p.

FIG. 6D-1 shows an MCU mounted on control PCB 462p. The MCU may be in data communication with each driver 306 mounted on driver PCB 461p through a respective one of the fiber optic cables 624 and a respective optoelectronic converter 622. The MCU can transmit one driver control signal to all drivers 306 in the stacked switch 602f via respective fiber optic cables.

FIGS. 6D-2 and 6D-3 show dielectric fluid (e.g., castor oil) flowing through bus bars 418u. Bus bars, such as bus bars 418u, may be in fluid communication with a pump, fan, or other device for moving the dielectric fluid through the bus bars. Although not shown in FIGS. 6D-1, 6D-2, and 6D-3 first and second manifolds may be in fluid communication with first and second ends, respectively, of bus bars 418u.

Two instances of stacked switch 602f can be electrically connected in series to form a leg of a power converter (e.g., three-phase inverter or three-phase rectifier). For example: bus bar-lead 465t1 of a first instance of stacked switch 602f may be electrically connected to a (e.g., V+) terminal of a voltage source while bus bar-lead 465t2 of the first instance may be electrically connected to a first terminal of an inductor, and; bus bar-lead 465t2 of a second instance of stacked switch 602f may be electrically connected to a terminal (e.g., V−) of the voltage source while bus bar-lead 465t1 of the second instance may be electrically connected to the first terminal of the inductor. One MCU may control switches 304 in the first and second instances of switched stacks 602f. However, the MCU may control all drivers 306 of the first instance with one control signal, and all drivers 306 of the second instance with a different control signal, so that the first and second instances of stacked switch 602f can be independently operated; all switches 304d of the first instance can be turned on or turned off at substantially the same first point in time, and all switches 304d of the second instance can be turned on or turned off at substantially the same second point in time, which is different from the first point of time. Two instances of stacked switch 602f can be electrically connected in parallel. In this embodiment, bus bar-leads 465t in each instance of stacked switch 602f may be electrically connected to a terminal of a voltage source (e.g., V+) while bus bar-leads 465t2 of each instance of stacked switch 602f may be electrically connected to a terminal of the voltage source (e.g., V−). Each packaged switch 247 in the parallel connected instances of stacked switch 602f may be connected to one MCU via respective fiber optic cables so that all switches 304d in the parallel connected instances of stacked switch 602f can be activated or deactivated at substantially the same point in time.

Liquid dielectric material such as epoxy, silicon, etc., can be added to air gaps or empty spaces between electrical conductors of stacked switch 602f, including adjacent electrical conductors of naked packaged switches 247 and naked packaged diodes 245M if employed, and then cured to create structures that suppress dendrite growth and electrical arcing therebetween.

FIGS. 6E-1-6E-3 illustrate relevant components of an example stacked switch 602g, which includes three submodules 605g1-605g3 electrically connected in series. In an alternative embodiment, stacked switch 602g can be built with two submodules 605g, or four or more submodules 605g electrically connected in series. FIGS. 6E-1-6E-3 show stacked switch 602g when seen from the front, left, and right sides, respectively.

Each submodule 605g may include a packaged switch 247d and packaged diode 245M electrically connected in parallel between a pair of bus bars 418dca and 418dcb as shown. Adjacent submodules 605g are electrically connected at their sides by rigid metal straps 409. In an alternative embodiment, stacked switch 602g may lack packaged diodes 245.

Each submodule 605g of stacked switch 602g may include a packaged switch 247d as shown, it being understood that in an alternative version packaged switches 247d may be replaced by packaged switches 247p or packaged switches 247q. All packaged switches 247 of stacked switch 602g may be the same type. Packaged switch 247d of each submodule 605g may be packaged switch 247dA, 247dB, or 247dD of FIGS. 3A, 3B, and 3D, respectively. Each submodule 605g may include a packaged diode 245M as shown, it being understood that packaged diode 245M can be replaced with packaged diode 345N. All packaged diodes 245 of stacked switch 602g may be the same type.

Submodules 605g may be electrically connected in series between bus bar-leads 465t1 and 465t2 as shown. First ends of bus bar-leads 465t1 and 465t2 may be electrically connected (e.g., welded) to the wide, flat outer surfaces of bus bars 418dca1 and 418dcb3, respectively, as shown. A second end of bus bar-lead 465t1 may be electrically connected to a terminal of a device such as a capacitor, inductor, voltage source, etc., and a second end of bus bar-lead 465t2 may be electrically connected to a terminal of a device such as a capacitor, inductor, voltage source, etc.

Each submodule 605g of stacked switch 602g may include a packaged switch 247d as shown, it being understood that in an alternative version packaged switches 247d may be replaced by packaged switches 247p or packaged switches 247q. All packaged switches 247 of stacked switch 602g may be the same type. Packaged switch 247d of each submodule 605g may be packaged switch 247dA, 247dB, or 247dD of FIGS. 3A, 3B, and 3D, respectively. Each submodule 605g may include a packaged diode 245M. All packaged diodes 245 of stacked switch 602g may be the same type. Packaged diode 245M could be replaced with packaged diode 245N of FIG. 3N.

Stacked switch 602g can operate in the forward or reverse direction. In the forward direction, current IF can pass between bus bar-leads 465t1 and 465t2 via packaged switches 247d in submodules 605g, assuming switches 304d1 are activated and voltage V1 is greater in magnitude than voltage V2. In the reverse direction, current IR can pass between bus bar-leads 465t1 and 465t2 via packaged diodes 245M in submodules 605g, assuming voltage V2 is greater in magnitude than voltage V1.

C-shaped metal straps 409 may electrically connect adjacent submodules 605g in stacked switch 602g. For example, flat end surfaces of metal straps 409-1 may be electrically connected (e.g., welded) to first flat side surfaces of bus bars 418dcb and 418dca, respectively, and flat end surfaces of metal straps 409-2 may be electrically connected (e.g., welded) to second flat side surfaces of bus bars 418dcb and 418dca, respectively, as shown. Forward current IF or reverse current IR can flow through metal straps 409.

Each submodule 605g includes a packaged switch 247dH and a packaged diode 245M that may be electrically and thermally connected in parallel between bus bars 418dca and 418dcb as shown. Alternatively, each submodule 605g may include more than one packaged switch 247d and more than one packaged diode 245M electrically and thermally connected between bus bars 418dca and 418dcb. For example, four packaged switches 247d may be electrically connected in parallel between bus bars 418dca and 418dcb and/or four packaged diodes 245M may be electrically connected in parallel between bus bars 418dca and 418dcb to enable greater current conduction between bus bars 418dca and 418dcb.

FIGS. 6E-1-6E-3 illustrate the relative positioning of packaged switches 247d, packaged diodes 245M, metal straps 409 and bus bars 418dc with respect to each other. Die substrate terminals 230 in each submodule 605g may be pressed-fitted, soldered, sintered, welded, or connected by other means directly to a flat surface or respective flat surfaces of bus bar 418dca to establish thermal and electrical connectivity, and die clip terminals 344 in each submodule 605g may be pressed-fitted, soldered, sintered, welded, or connected by other means directly to a flat surface or respective flat surfaces of a second bus bar 418dcb to establish thermal and electrical connectivity.

FIGS. 6E-1-6E-3 show submodules 605g with dielectric tubes 420a received by bus bars. Tubes other than 420a can be received by the bus bars. For example, each of bus bars 418dc can be formed by soldering metal bus bar portions around tubes 420d or 420e using a process like that described with reference to FIGS. 5A-17-1-5A-17-5. Or the bus bars can be swapped with bus bars formed around tubes like tubes 420v1 using a process like that described with reference to FIGS. 9A-30-9A-33.

Stacked switch 602g may include control PCB 462p and driver PCB 461p, which may be in data communication with each other through fiber optic cables 624. Control PCB 462p, driver PCB 461p and fiber optic cables 624 are more fully described above. Drivers 306 on driver PCB 461p can send transistor control signals to respective switches 304 through respective connector-leads 288g. All drivers 306 of stacked switch 602g may be connected to receive the same control signal directly or indirectly from an MCU or other device, to activate their respective switches 304d at substantially the same time or deactivate their respective switches 304d at substantially the same time. In an alternative embodiment of stacked switch 602g, bus bar-lead 465t1 or 465t2 may be repositioned so that its first end is electrically connected (e.g., welded) to the short, flat outer side surface of bus bars 418dca1 or 418dcb3. In this alternative embodiment, the second end of the repositioned bus bar-lead 465t1 or 465t2 may extend through an aperture of a current sensor I_Sense (not shown) mounted on driver PCB 461p.

FIG. 6E-1 shows an MCU mounted on control PCB 462p. The MCU may be in data communication with each driver 306 via a respective one of the fiber optic cables 624 and a respective optoelectronic converter 622. Fiber optical cables 624 can optically transmit the same driver control signal in optical signal form to all drivers 306 at substantially the same time.

All tubes 420, such as tubes 420a, received in all bus bars in stacked switch 602g may be substantially equal in length. Although not shown in FIGS. 6E-1-6E-3, first and second manifolds may be in fluid communication with first and second ends, respectively, of the tubes 420a.

Two instances of stacked switch 602g can be electrically connected in series to form a leg of a power converter (e.g., three-phase inverter or three-phase rectifier). For example: bus bar-lead 465t1 of a first instance of stacked switch 602g may be electrically connected to a (e.g., V+) terminal of a voltage source while bus bar-lead 465t2 of the first instance may be electrically connected to a first terminal of an inductor, and; bus bar-lead 465t2 of a second instance of stacked switch 602g may be electrically connected to a terminal (e.g., V−) of the voltage source while bus bar-lead 465t1 of the second instance may be electrically connected to the first terminal of the inductor. One MCU may control switches 304 in the first and second instances of switched stacks 602g. However, the MCU should control all drivers 306 of the first instance with one control signal, and all drivers 306 of the second instance with a different control signal, so that the first and second instances of stacked switch 602g can be independently operated; all switches 304d of the first instance can be turned on or turned off at substantially the same first point in time, and all switches 304d of the second instance can be turned on or turned off at substantially the same second point in time, which is different from the first point of time. Two or more instances of stacked switch 602g can be electrically connected in parallel. In this embodiment, bus bar-leads 465t in each instance of stacked switch 602g may be electrically connected to a terminal of a voltage source (e.g., V+) while bus bar-leads 465t2 of each instance of stacked switch 602g may be electrically connected to a terminal of the voltage source (e.g., V−). Each packaged switch 247 in the parallel connected instances of stacked switch 602g may be connected to one MCU via respective fiber optic cables so that all switches 304d in the parallel connected instances of stacked switch 602g can be activated or deactivated at substantially the same point in time.

Liquid dielectric material such as epoxy, silicon, etc., can be added to air gaps or empty spaces between electrical conductors of stacked switch 602g, including adjacent electrical conductors of naked packaged switches 247 and diodes 245M if employed, and then cured to create structures that suppress dendrite growth and electrical arcing therebetween.

FIGS. 6F-1-6F-3 illustrate relevant components of an example stacked switch 602h, which includes three submodules 605h1-605h3 that are electrically connected in series. In an alternative embodiment, stacked switch 602h can be built with two submodules 605h electrically connected in series, or four or more submodules 605h electrically connected in series. FIGS. 6F-1-6F-3 show stacked switch 602h when seen from the front, left, and right sides, respectively.

Each submodule 605h of stacked switch 602h may include a packaged switch 247d as shown, it being understood that in an alternative version packaged switches 247d may be replaced by packaged switches 247p or packaged switches 247q. All packaged switches 247 of stacked switch 602h may be the same type. Packaged switch 247d of each submodule 605h may be packaged switch 247dA, 247dB, or 247dD of FIGS. 3A, 3B, and 3D, respectively. Each submodule 605h may include a packaged diode 245M as shown, it being understood that packaged diode 245M can be replaced with packaged diode 345N. All packaged diodes 245 of stacked switch 602h may be the same type.

Each submodule 605h may include a packaged switch 247d and packaged diode 245M that are electrically connected in parallel between a pair of bus bars 418ua and 418ub as shown. In an alternative embodiment, stacked switch 602m may lack packaged diodes 245. Adjacent submodules 605h may be electrically connected at their sides by rigid metal straps 409 as shown.

Submodules 605h may be electrically connected in series between bus bar-leads 465t1 and 465t2 as shown. First ends of bus bar-leads 465t1 and 465t2 may be electrically connected (e.g., welded) to the wide, flat outer surfaces of bus bars 418ua1 and 418ub3, respectively, as shown. A second end of bus bar-lead 465t1 may be electrically connected to a terminal of a device such as a capacitor, inductor, voltage source, etc., and a second end of bus bar-lead 465t2 may be electrically connected to a terminal of another device.

Stacked switch 602h can operate in the forward or reverse direction. In the forward direction, current IF can pass between bus bar-leads 465t1 and 465t2 via packaged switches 247d in submodules 605h, assuming switches 304d1 are activated and voltage V1 is greater in magnitude than voltage V2. In the reverse direction, current IR can pass between bus bar-leads 465t1 and 465t2 via packaged switches 247d and/or packaged diodes 245M in submodules 605h, assuming voltage V2 is greater in magnitude than voltage V1.

Metal straps may electrically connect adjacent submodules 605 in a stacked switch 602. FIG. 6F-1 shows example C-shaped metal straps 409 that electrically connect adjacent submodules 605h in stacked switch 602h. In the illustrated example, flat, parallel end surfaces of metal straps 409-1 may be electrically connected (e.g., welded) to first flat side surfaces of bus bars 418ub and 418ua, respectively, and flat, parallel end surfaces of metal straps 409-2 may be electrically connected (e.g., welded) to second flat side surfaces of bus bars 418ub and 418ua, respectively, as shown. Forward current IF or reverse current IR can flow through metal straps such as metal straps 409.

Each submodule 605h includes a packaged switch 247dH and a packaged diode 245M that may be electrically and thermally connected in parallel between bus bars 418ua and 418ub as shown. Alternatively, each submodule 605h may include more than one packaged switch 247d and more than one packaged diode 245M electrically and thermally connected between bus bars 418ua and 418ub. For example, four packaged switches 247d may be electrically connected in parallel between bus bars 418ua and 418ub and/or four packaged diodes 245M may be electrically connected in parallel between bus bars 418ua and 418ub to enable greater current conduction between terminals 465t.

FIGS. 6F-1-6F-3 illustrate the relative positioning of packaged switches 247d, packaged diodes 245M, metal straps 409 and bus bars 418u with respect to each other. Die substrate terminals 230 in each submodule 605h may be pressed-fitted, soldered, sintered, welded, or connected by other means directly to a flat surface or respective flat surfaces of bus bar 418ua (e.g., bus bar 418ua1) to establish thermal and electrical connectivity, and die clip terminals 344 in each submodule 605h may be pressed-fitted, soldered, sintered, welded, or connected by other means directly to a flat surface or respective flat surfaces of a second bus bar 418ub (e.g., 418ub1) to establish thermal and electrical connectivity.

FIGS. 6F-2 and 6F-3 show dielectric fluid (e.g., castor oil) flowing through bus bars 418u. Bus bars 418u may be in fluid communication with a pump of other device for circulating the dielectric fluid through the bus bars. Although not shown in FIGS. 6F-1-6F-3 first and second manifolds may be in fluid communication with first and second ends, respectively, of bus bars 418u.

Stacked switch 602h may include control PCB 462p and driver PCB 461p, which may be in data communication with each other through fiber optic cables 624. Control PCB 462p, driver PCB 461p and fiber optic cables 624 are more fully described above. Drivers 306 on driver PCB 461p can send transistor control signals to respective switches 304 through respective connector-leads 288g. All drivers of stacked switch 602h may be connected to receive the same driver control signal directly or indirectly from an MCU or other device, to activate their respective switches 304d at substantially the same time or deactivate their respective switches 304d at substantially the same time. In an alternative embodiment of stacked switch 602h, bus bar-lead 465t1 or 465t2 may be repositioned so that its first end is electrically connected (e.g., welded) to the short, flat outer side surface of bus bars 418ua1 or 418ub3. In this alternative embodiment, the second end of the repositioned bus bar-lead 465t1 or 465t2 may extend through an aperture of a current sensor I_Sense (not shown) mounted on driver PCB 461p.

FIG. 6F-1 shows an MCU mounted on control PCB 462p. The MCU may be in data communication with each driver 306 mounted on driver PCB 461p through a respective one of the fiber optic cables 624 and a respective optoelectronic converter 622. Fiber optic cables 624 may optically transmit the same driver control signal directly or indirectly to all drivers 306 for the drivers to activate or deactivate their respective switches 304 at substantially the same point in time.

Two instances of stacked switch 602h can be electrically connected in series to form a leg of a power converter (e.g., three-phase inverter or three-phase rectifier). For example: bus bar-lead 465t1 of a first instance of stacked switch 602h may be electrically connected to a (e.g., V+) terminal of a voltage source while bus bar-lead 465t2 of the first instance may be electrically connected to a first terminal of an inductor, and; bus bar-lead 465t2 of a second instance of stacked switch 602h may be electrically connected to a terminal (e.g., V−) of the voltage source while bus bar-lead 465t1 of the second instance may be electrically connected to the first terminal of the inductor. One MCU may control switches 304 in the first and second instances of switched stacks 602h. However, the MCU may control all drivers 306 of the first instance with one control signal, and all drivers 306 of the second instance with a different control signal, so that the first and second instances of stacked switch 602h can be independently operated; all switches 304d of the first instance can be turned on or turned off at substantially the same first point in time, and all switches 304d of the second instance can be turned on or turned off at substantially the same second point in time, which is different from the first point of time. Two instances of stacked switch 602h can be electrically connected in parallel. In this embodiment, bus bar-leads 465t in each instance of stacked switch 602h may be electrically connected to a terminal of a voltage source (e.g., V+) while bus bar-leads 465t2 of each instance of stacked switch 602h may be electrically connected to a terminal of the voltage source (e.g., V−). Each packaged switch 247 in the parallel connected instances of stacked switch 602h may be connected to one MCU via respective fiber optic cables so that all switches 304d in the parallel connected instances of stacked switch 602h can be activated or deactivated at substantially the same point in time.

Liquid dielectric material such as epoxy, silicon, etc., can be added to air gaps or empty spaces between electrical conductors of stacked switch 602h, including adjacent electrical conductors of naked packaged switches 247 and diodes 245M if employed, and then cured to create structures that suppress dendrite growth and electrical arcing therebetween.

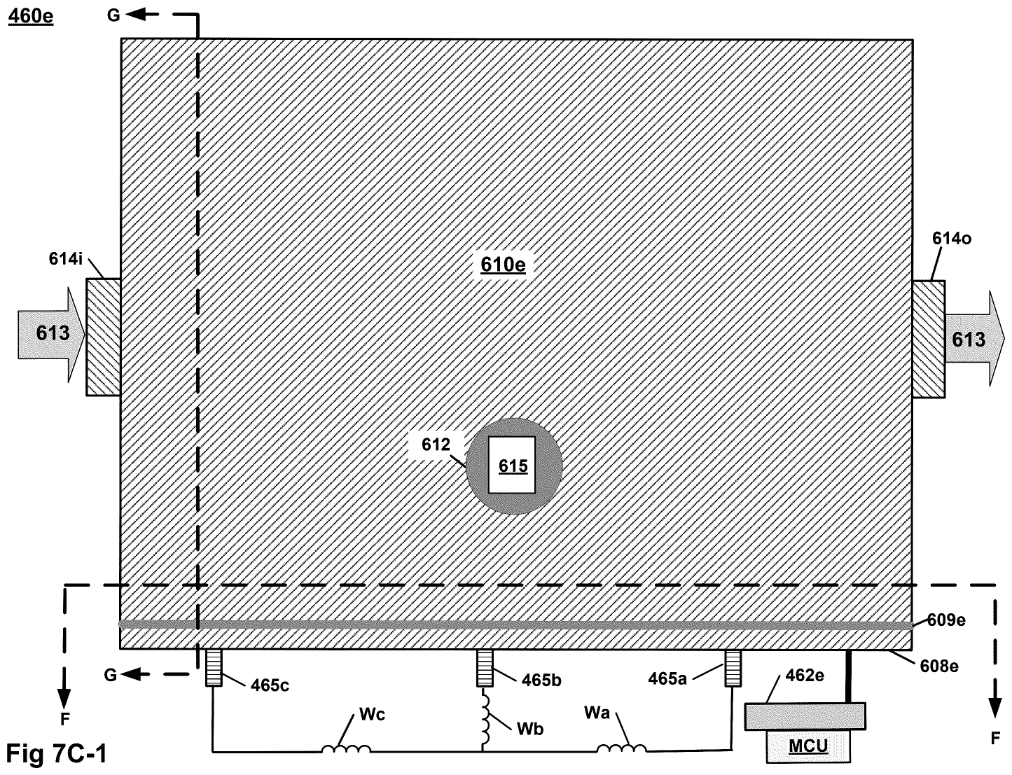

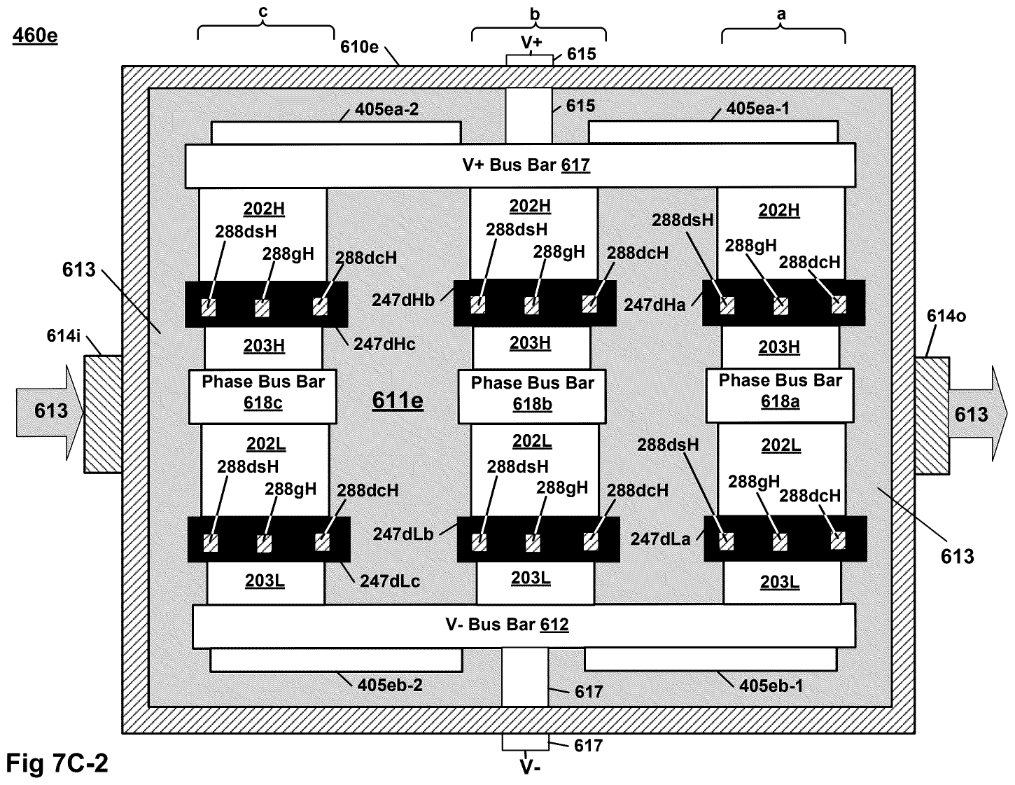

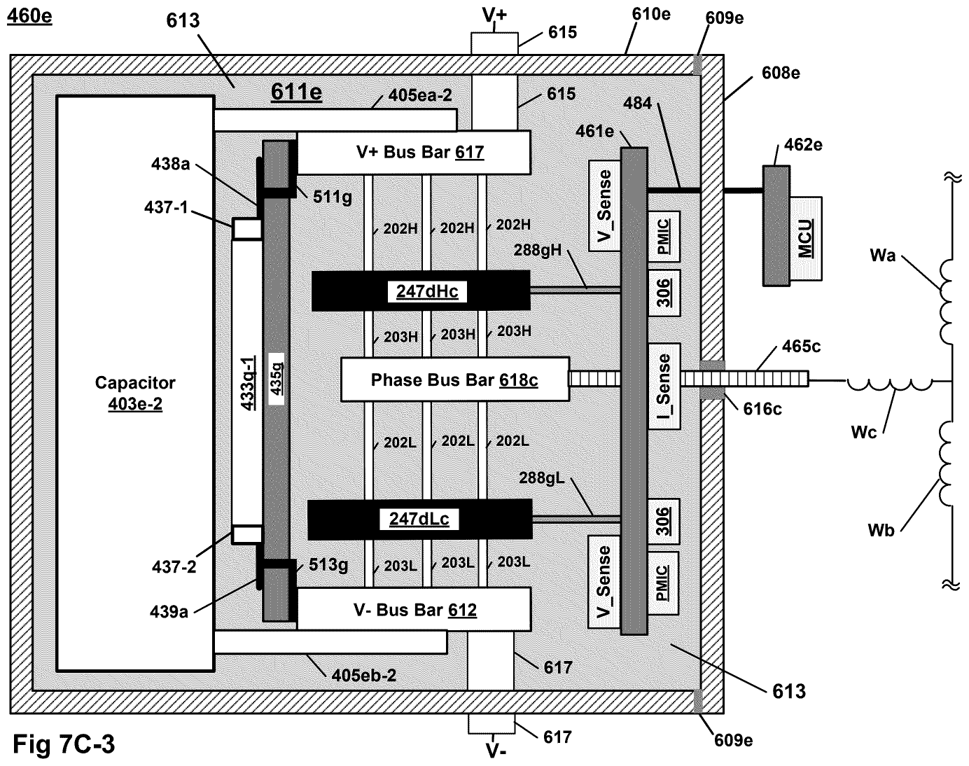

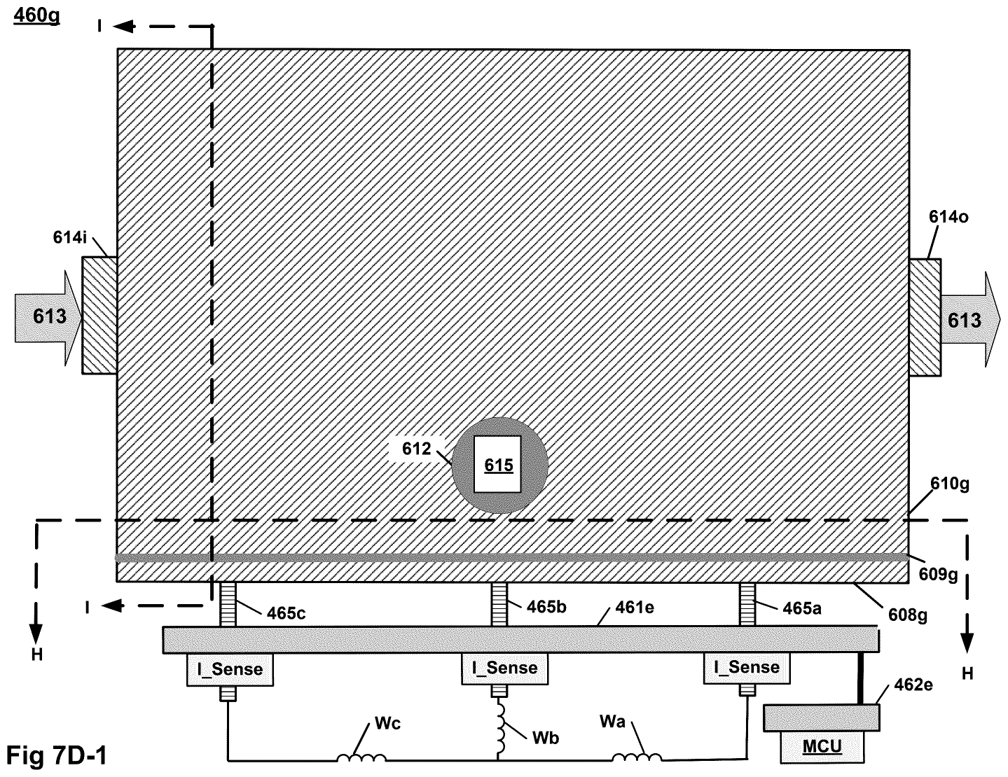

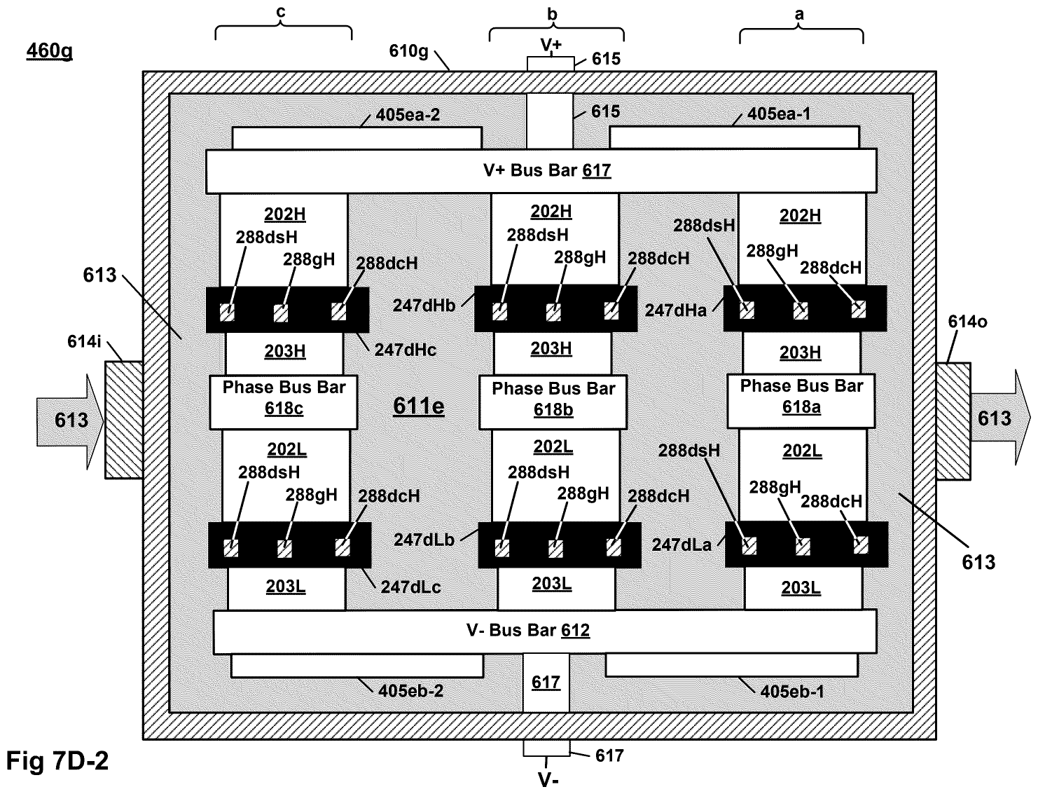

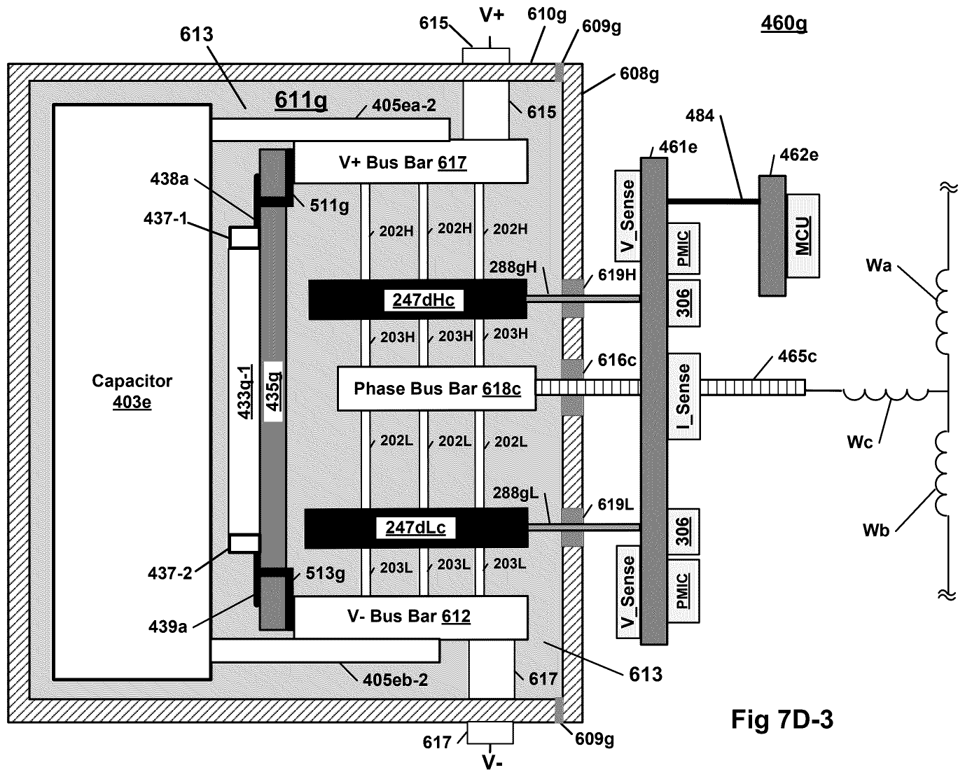

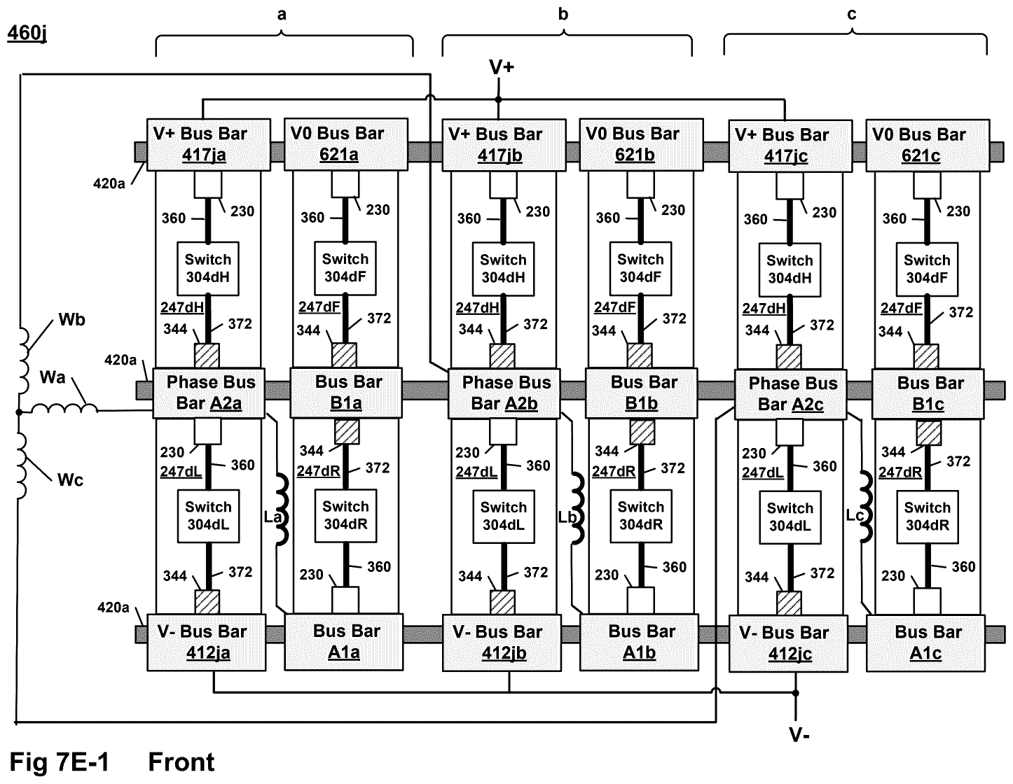

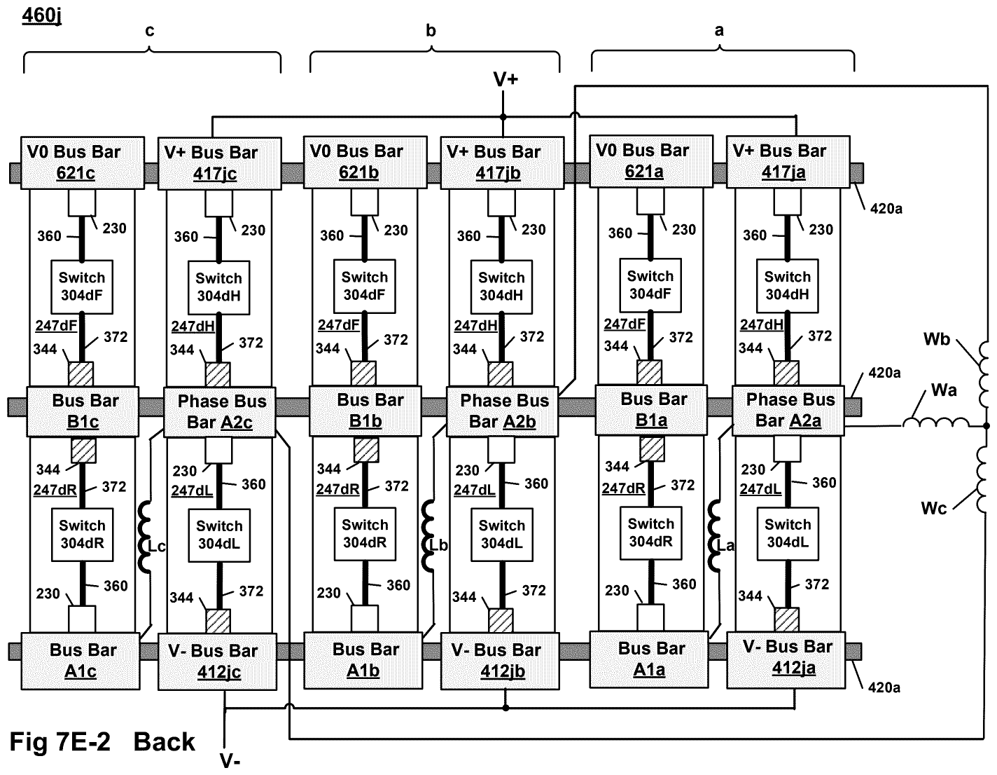

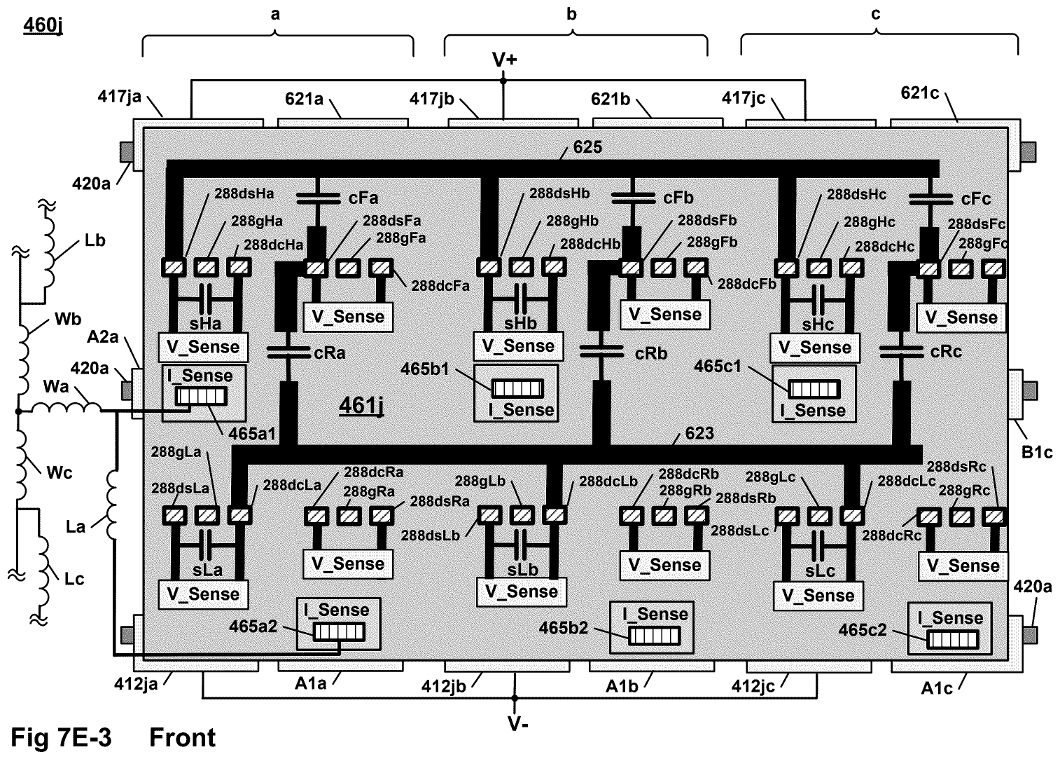

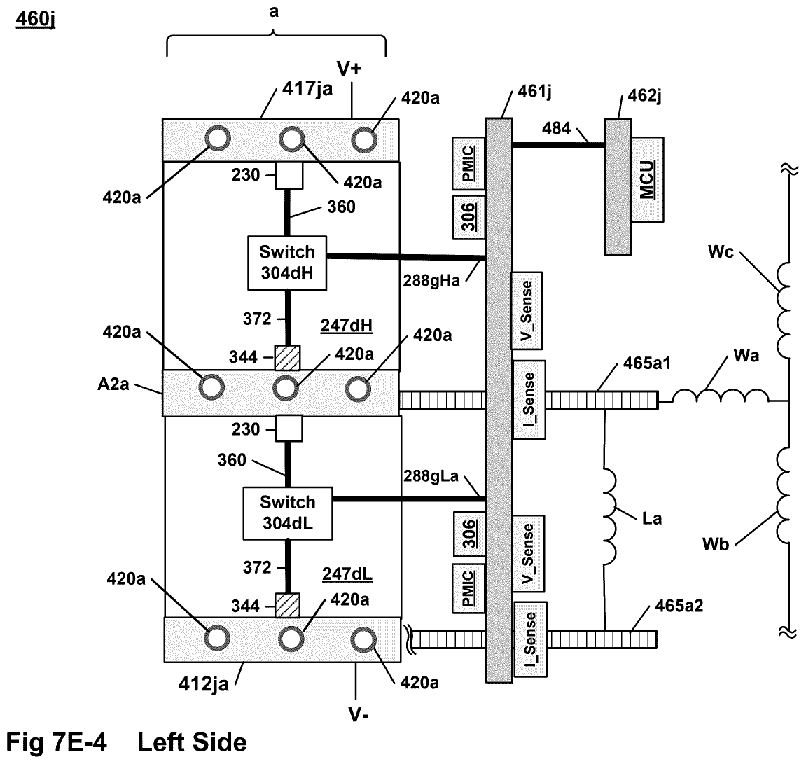

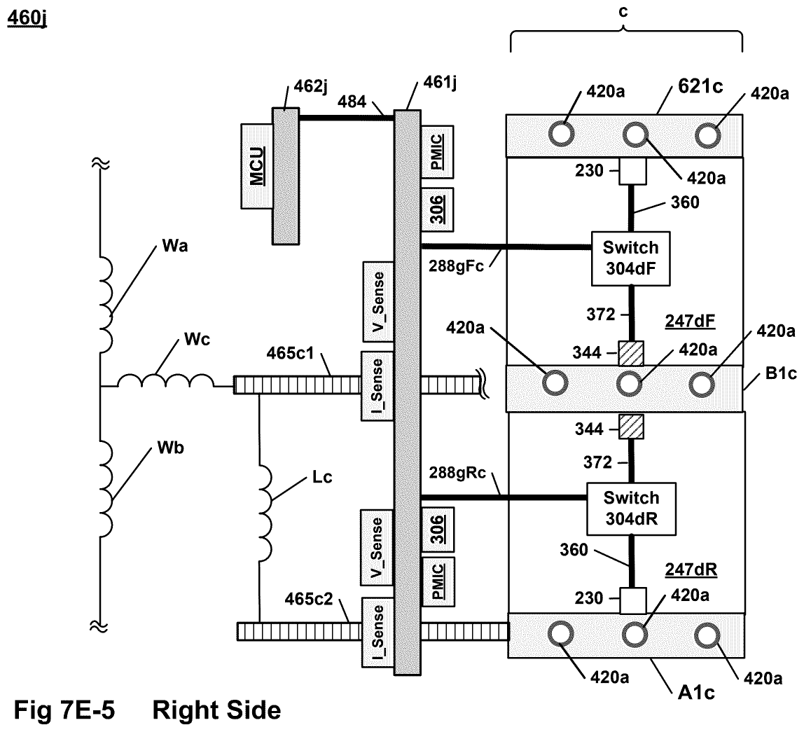

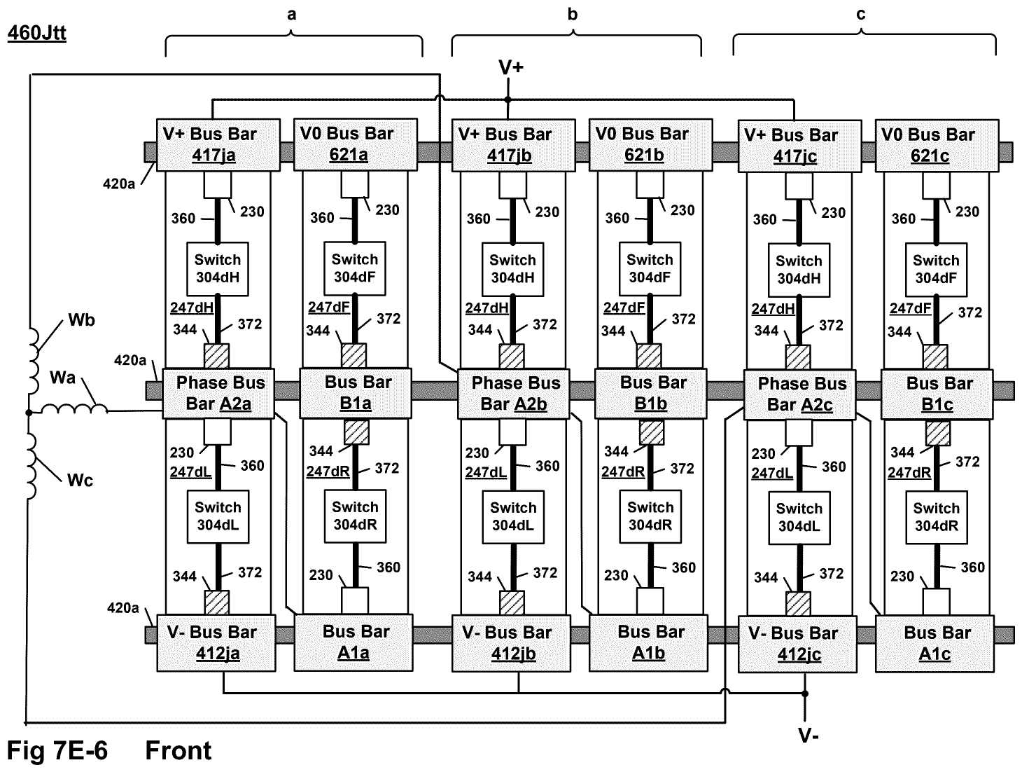

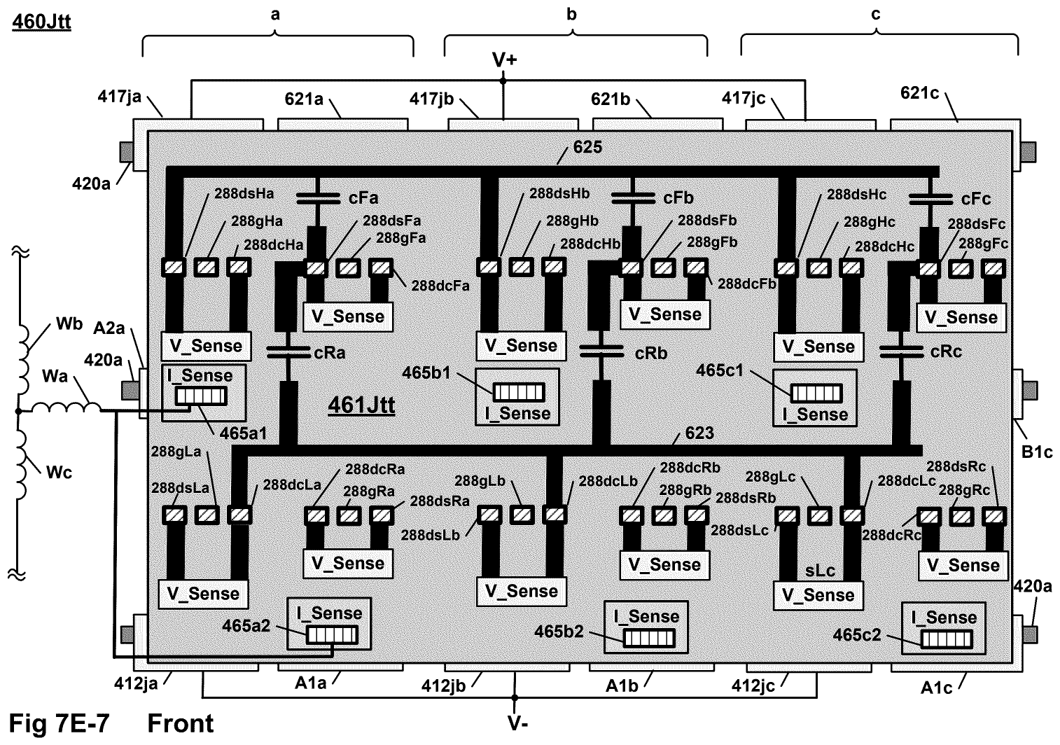

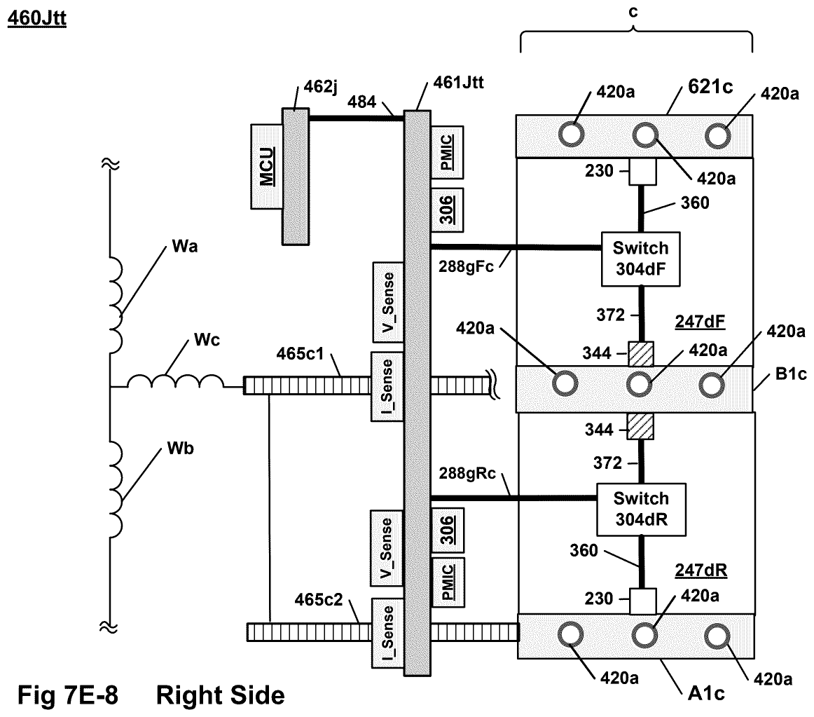

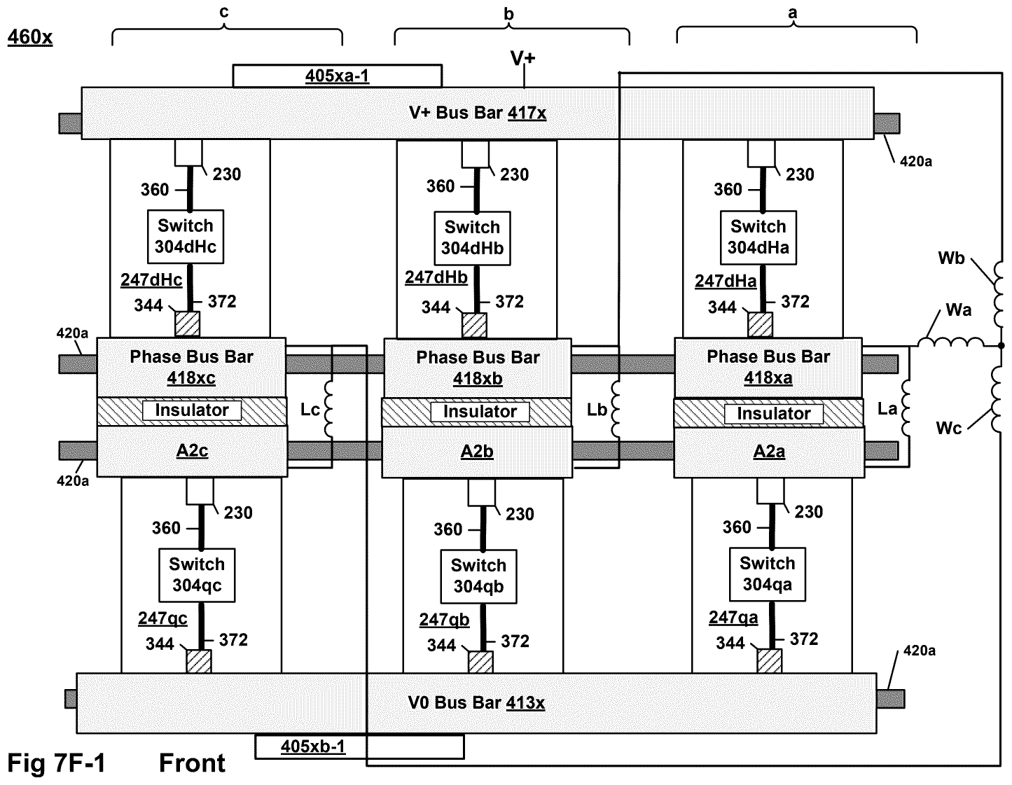

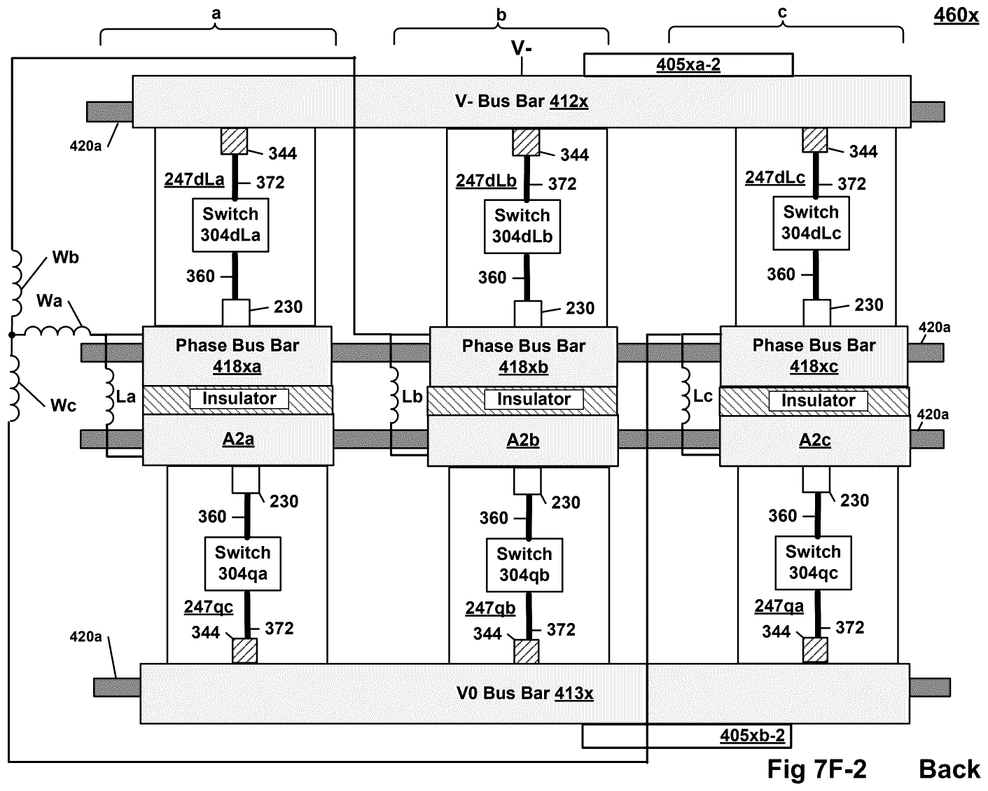

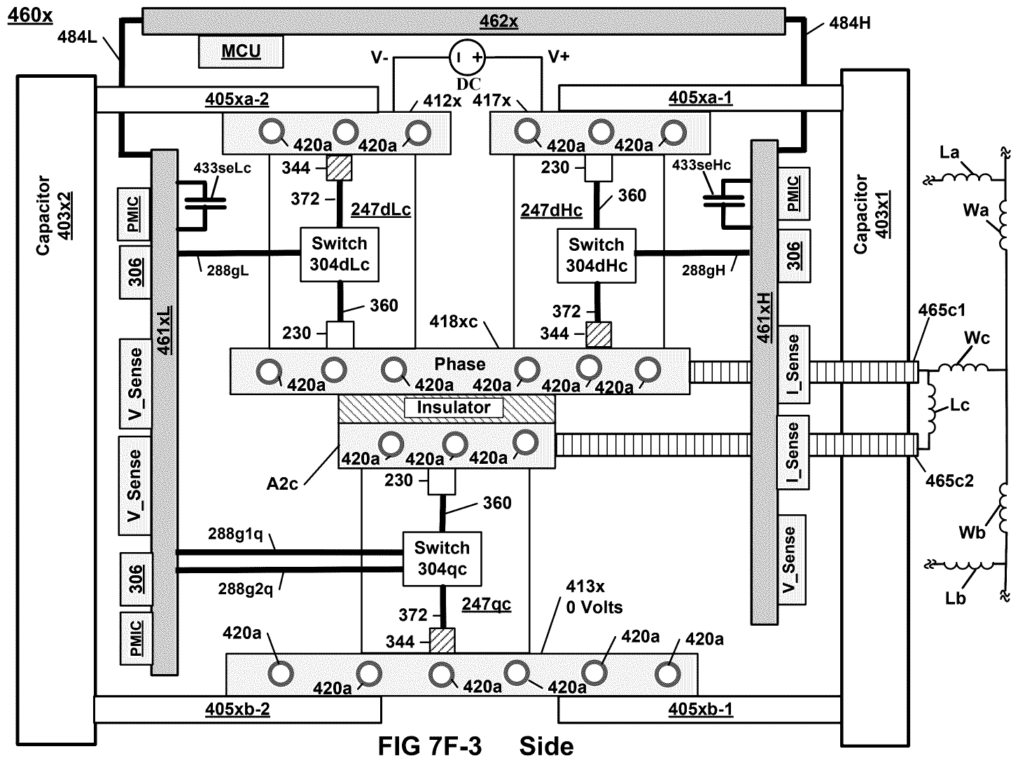

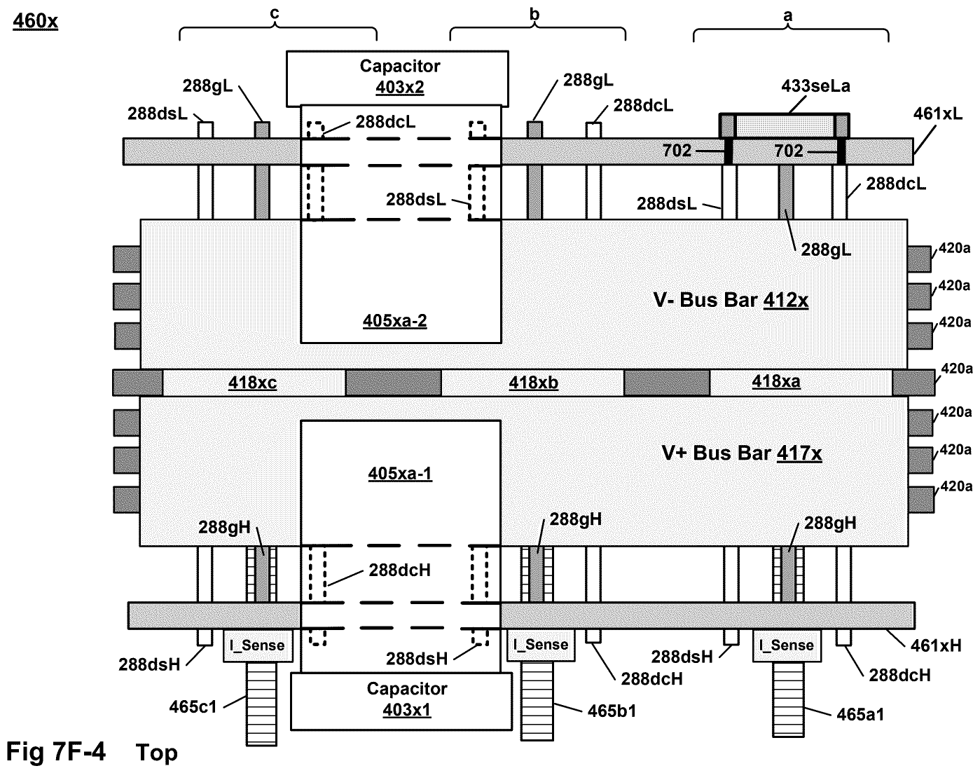

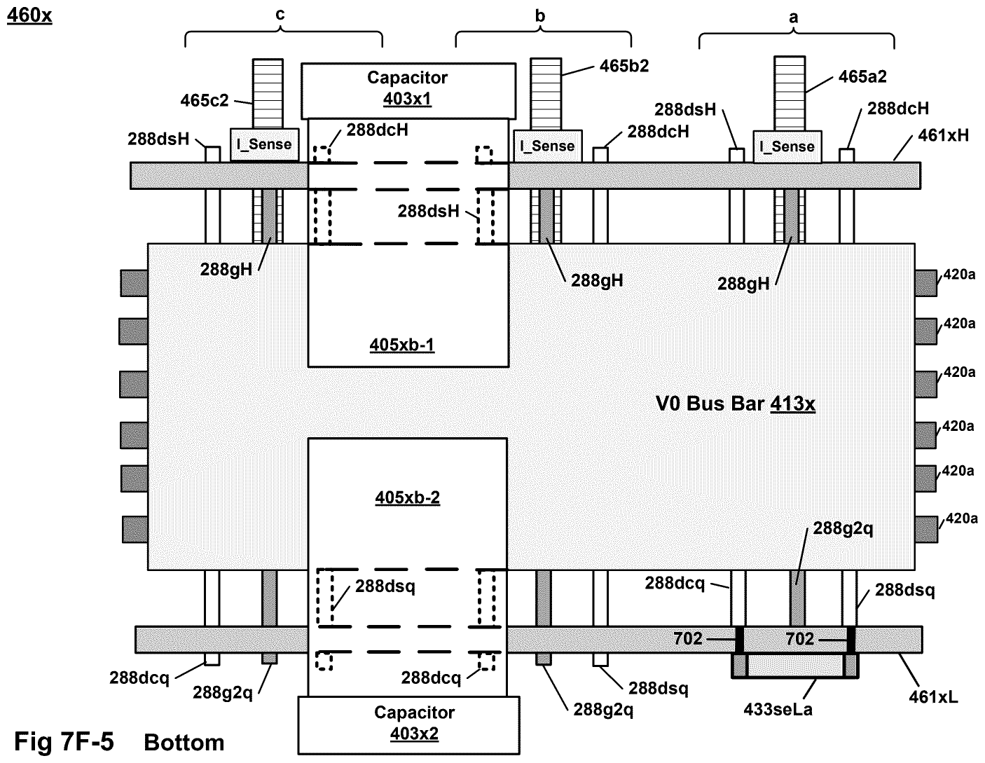

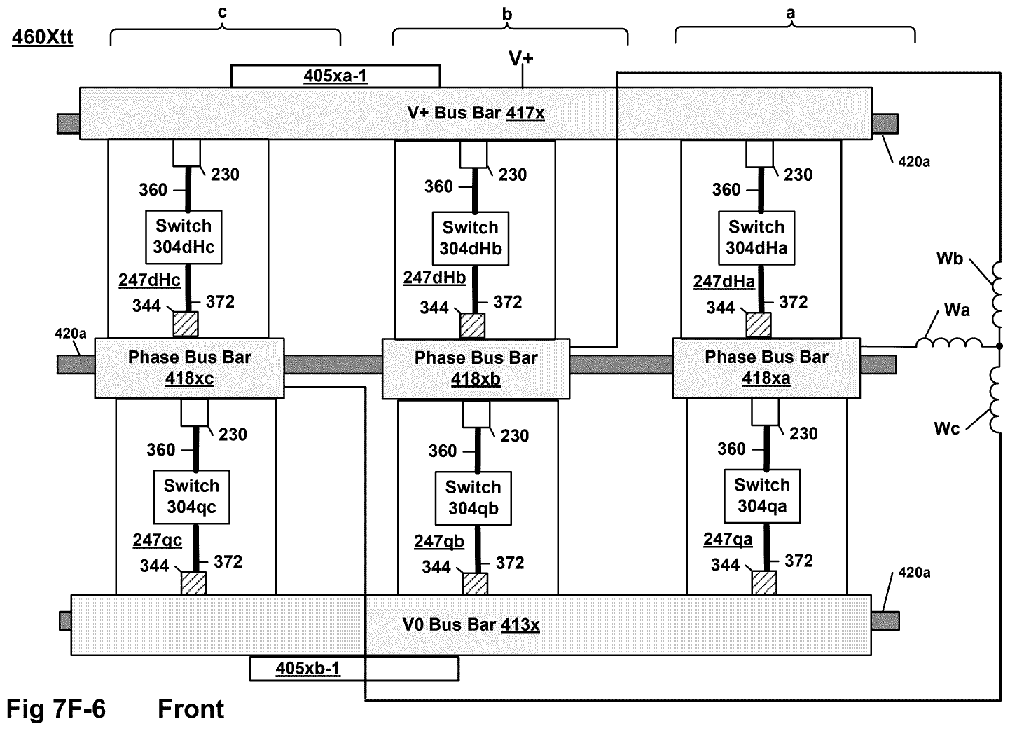

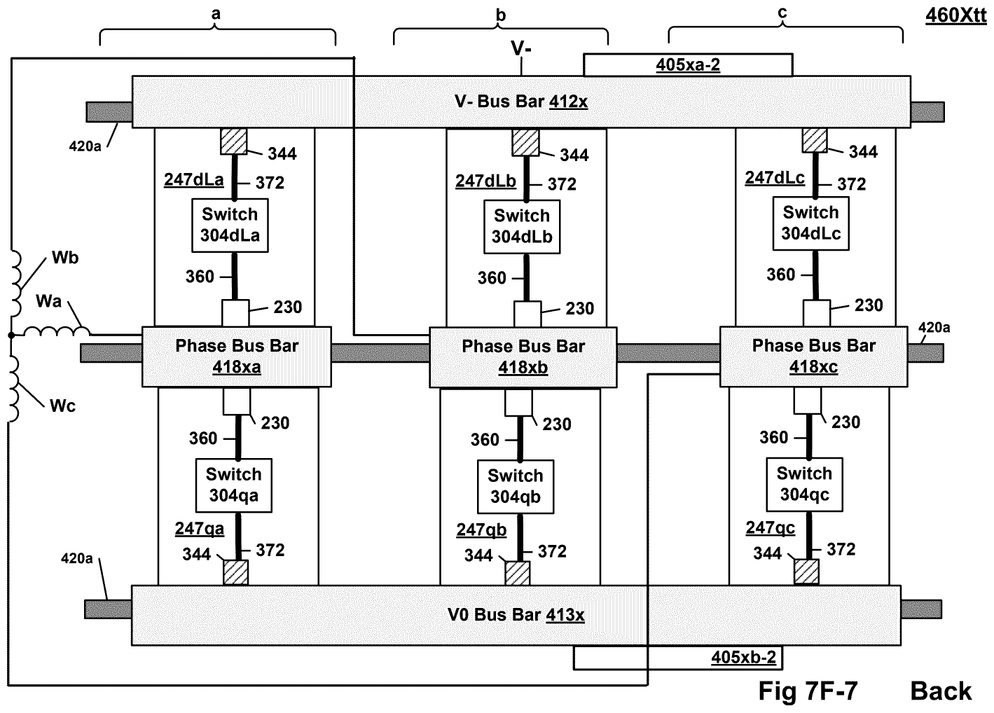

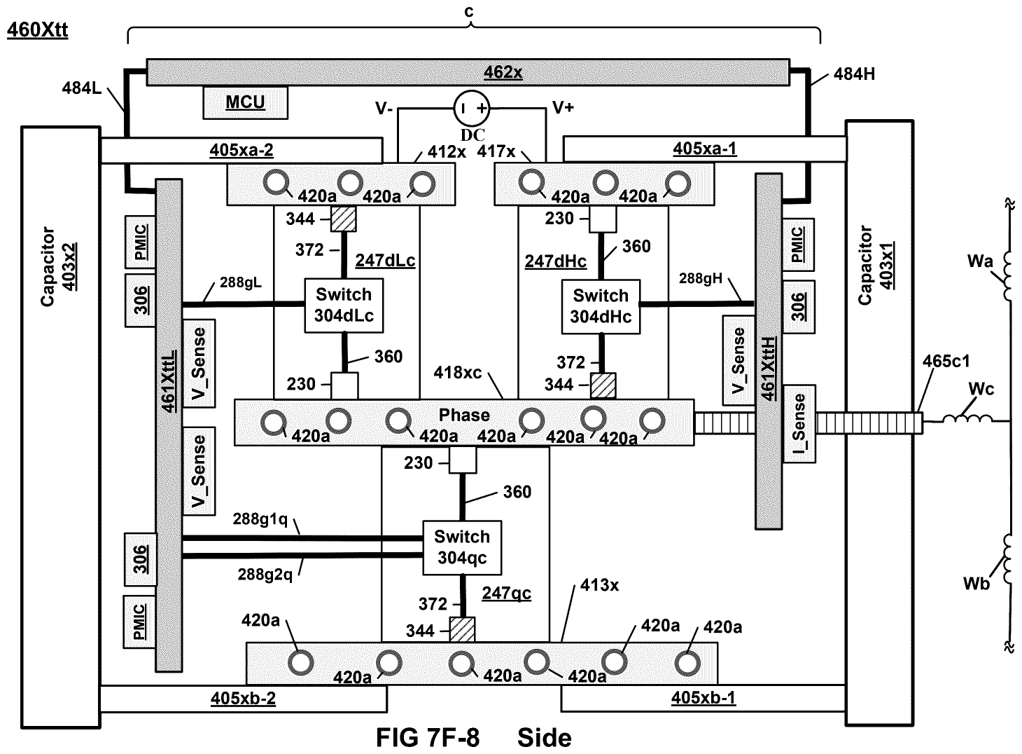

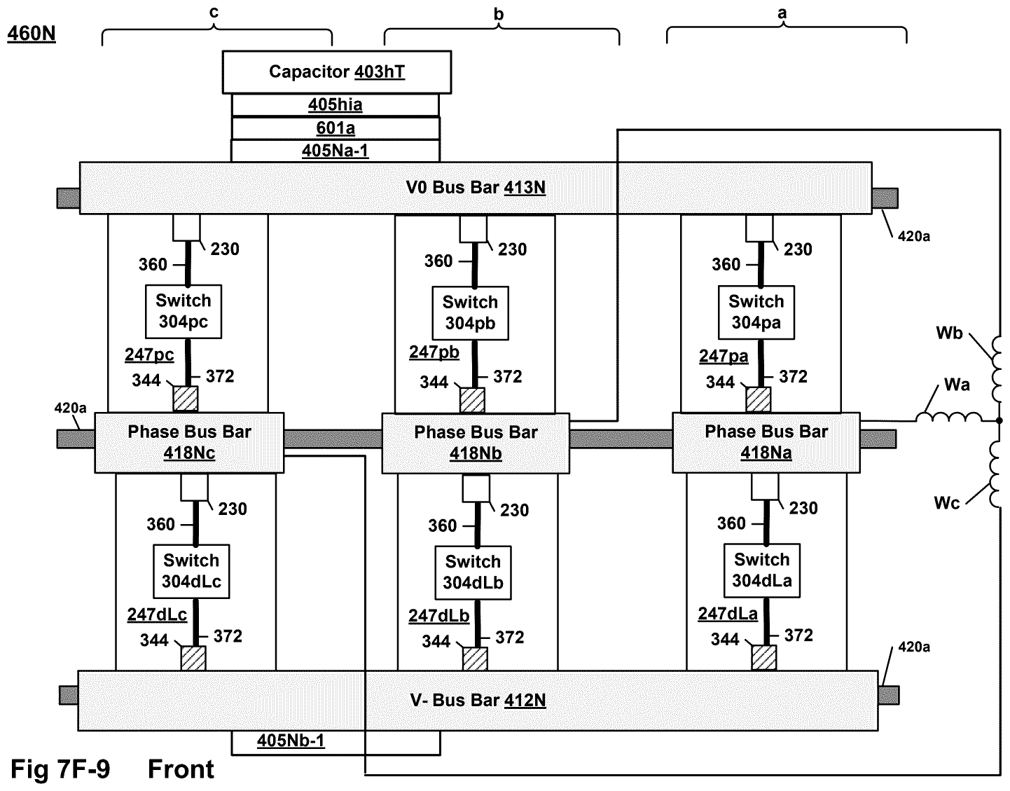

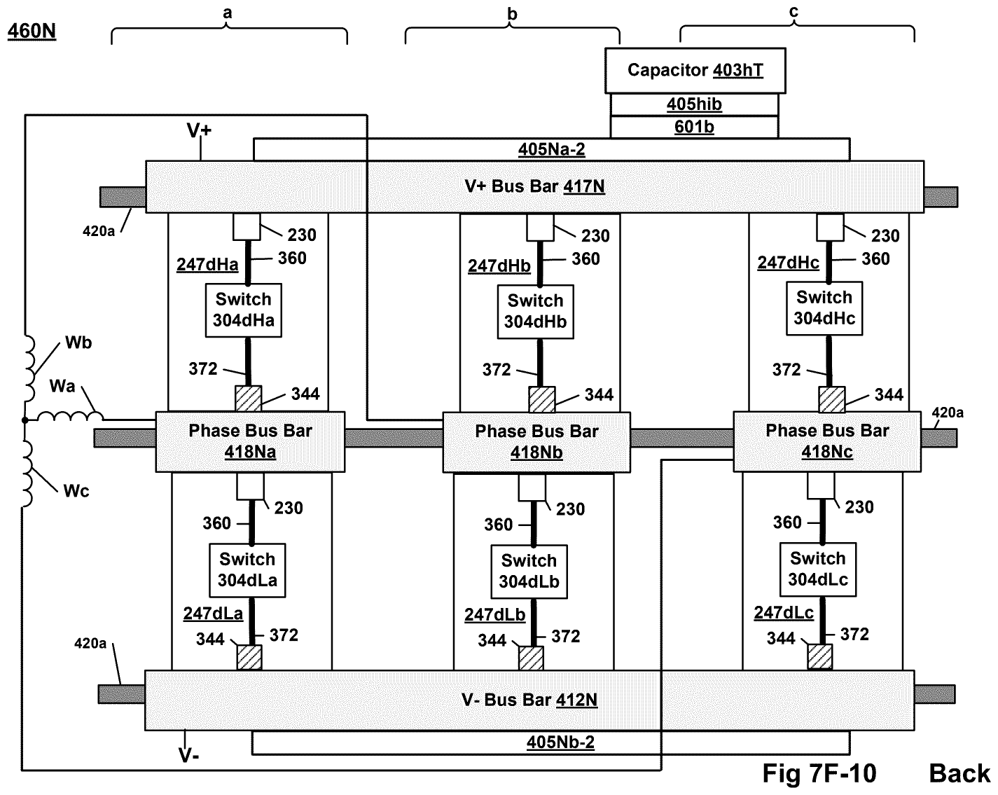

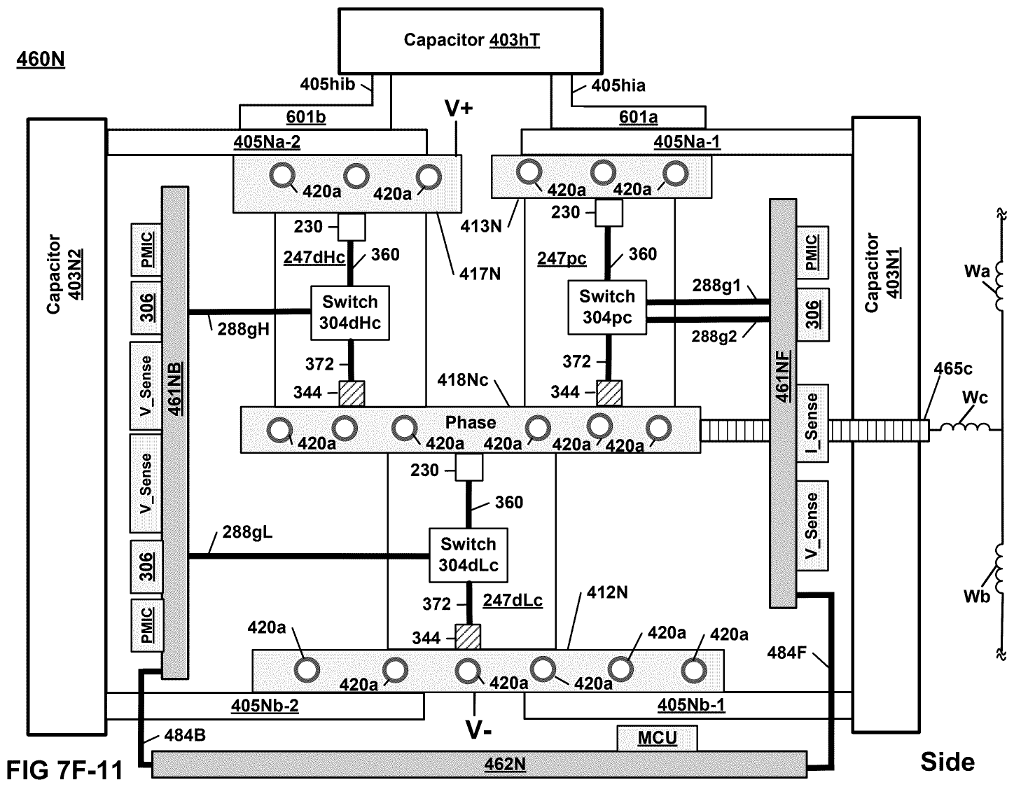

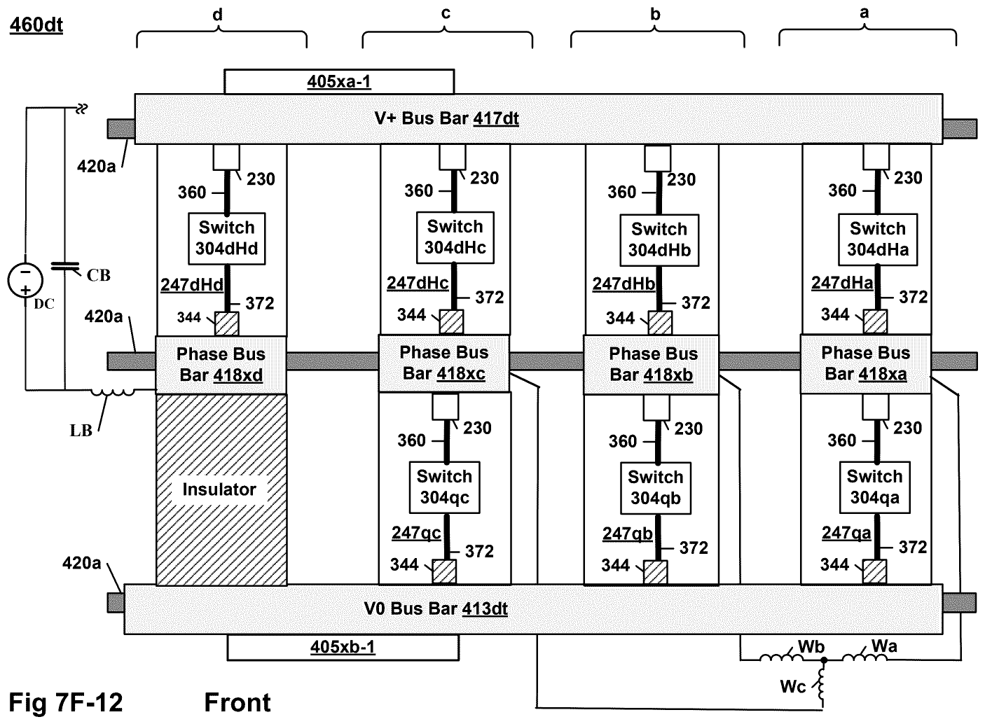

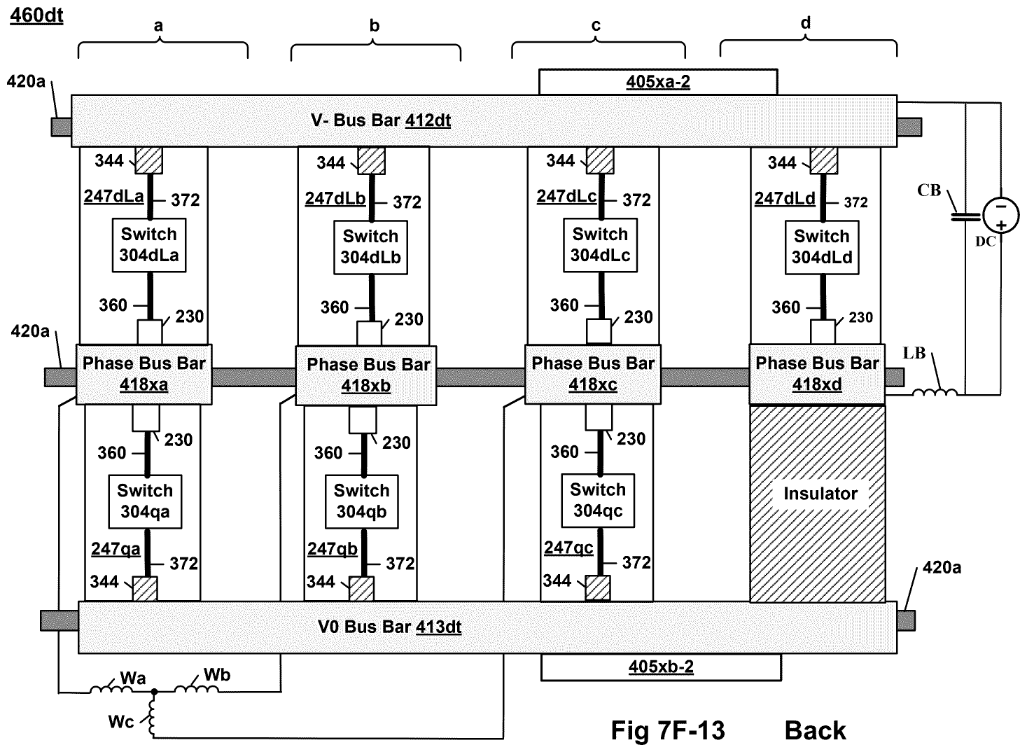

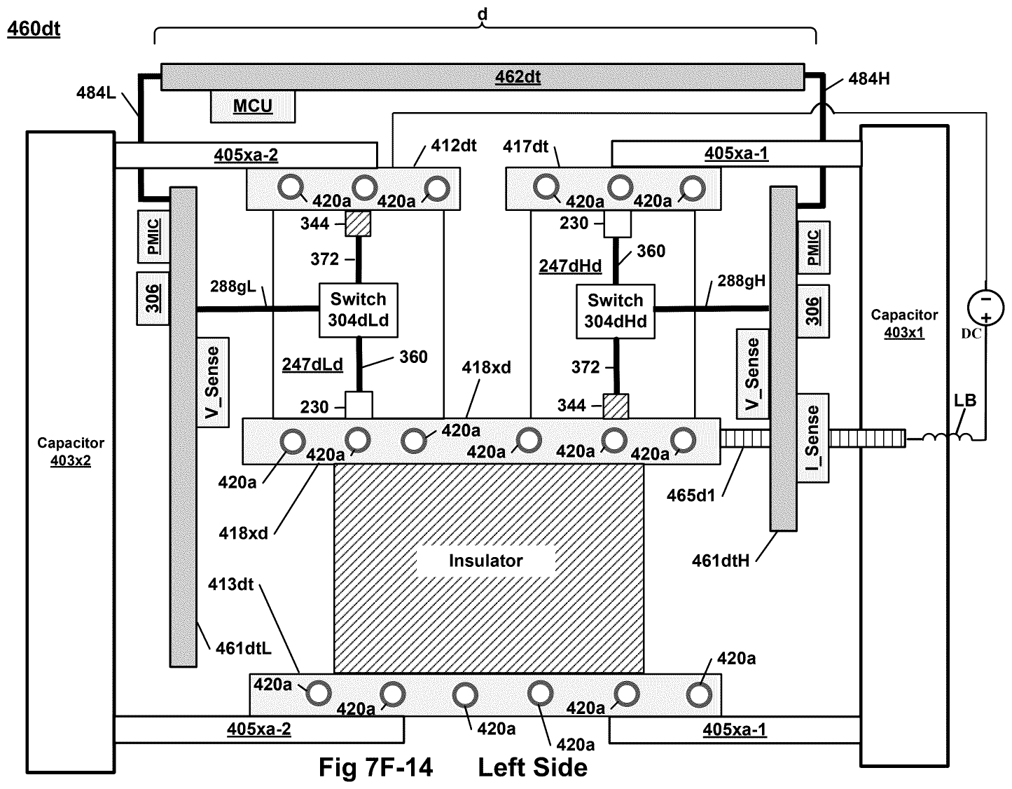

Power converters and other apparatuses of this disclosure can be immersion cooled. FIG. 7C-1 shows an example of an immersion cooled converter 460e when seen from the top. FIGS. 7C-2 and 7C-3 show cross sectional views of converter 460e taken along lines F-F and G-G, respectively, in FIG. 7C-1. Several components (e.g., driver PCB 461e, control PCB 462e, capacitors 403e, etc.) shown in FIG. 7C-3 are not shown in FIG. 7C-2 but are described below.

With continuing reference to FIGS. 7C-1-7C-3, inverter 460e may include a housing 610e with detachable lid 608e as shown, each of which may be formed of metal such as aluminum or a dielectric material such as plastic. Housing 610e and lid 608e may form an interior chamber 611e as shown. A sealing ring, gasket or permanent attachment (e.g. weld joint, adhesive, soldered joint) to provide leak-proof attachment of lid 608e. For example, a sealing ring 609e may connect housing 610e with lid 608e. Sealing ring 609e creates a leak-proof seal with housing 610e and lid 608e.

Fluid can flow through housing 610e. Housing 610e may include an input port 614i through which a dielectric fluid (e.g., castor oil) 613 may enter interior chamber 611e. Housing 610e may include an output port 6140 through which dielectric fluid 613 may exit interior chamber 611e. Components (e.g., driver PCB 461e, and capacitors 403e, etc.) may be positioned in chamber 611e and immersed in dielectric fluid 613 as shown.

As seen in FIGS. 7C-2 and 7C-3 converter 460e may include V+ bus bar 617, V− bus bar 612, and phase bus bars 618 inside chamber 611e. The bus bars may be cooled by dielectric fluid 613 flowing through chamber 611e. The bus bars may be formed from metal such as copper. The bus bars may be like bus bar 563 of FIG. 5A-16-3 with channels 40 through which fluid 613 can flow, or the bus bars may be solid with no channels as shown. V+ bus bar 617 and V− bus bar 612 may have the same shapes (e.g., generally rectangular cuboid) and sizes as shown. Phase bus bars 618 may have the same shapes (e.g., generally rectangular cuboid) and sizes as shown.

Converter 460e may include metal DC bus bar-leads 615 and 617 with rectangular or square cross-sections. First ends of metal DC bus bar-leads 615 and 617 may be electrically connected (e.g., soldered) to respective surfaces of bus bars 617 and 612, respectively, as shown. The second and opposite ends of DC bus bar-leads 615 and 617 may be electrically connected to V+ and V-terminals, respectively, of a battery or other device such as a DC/DC converter. DC bus bar-leads 615 and 617 may extend through plugs 612 (only one of which is shown in FIGS. 7C-1-7C-3) that snugly fit in respective apertures of housing 610e as shown. Plugs 612 can create leak-proof seals with bus bar-leads 615 and 617, and with housing 610e. Plugs 612 may electrically isolate bus bar-leads 615 and 617 from housing 610e.

As shown, converter 460e may include packaged switches 247d with fins that are cooled by fluid 613 flowing inside chamber 611e, it being understood that packaged switches 247d with fins may be swapped with packaged switches 247p with fins or packaged switches 247q with fins. As shown in FIGS. 7C-2 and 7C-3, converter 460e may include the finned packaged switches 247d of FIGS. 2D-4-2D-6. All packaged switches 247d of converter 460e may be the same type. Packaged switches 247d of converter 460e may be packaged switch 247dA, 247dB, 247dC, or 247dD of FIGS. 3A, 3B, 3C, and 3D, respectively. Packaged switches 247d include cases 248d (see, e.g., FIGS. 2D-3 and 2D-6). In an alternative embodiment, packaged switches 247 with fins of converter 460e can be replaced with naked or unpackaged switches 247 (e.g., packaged switches 247 lacking cases 248) with fins.

Converter 460e may have three legs designated a-c as shown in FIG. 7C-2. Each leg in FIG. 7C-2 may include two packaged switches 247dH and 247dL with fins. Edges 205 (not shown in FIGS. 7C-2 and 7C-3) of fins 203H and 202L in each leg, may be electrically and thermally connected (e.g., soldered) to a respective phase bus bar 618, such as phase bus bar 618c shown in FIGS. 7C-2 and 7C-3. Edges 205 of fins 202H and 203L in each leg may be electrically and thermally connected (e.g., soldered) to V+ bus bar 617 and V− bus bar 612, respectively, as shown. Fins 202 may be spaced to enable dielectric fluid 613 flow therebetween. Likewise, fins 203 may be spaced to enable dielectric fluid 613 flow therebetween. Fluid 613 may also flow over exposed surfaces of die substrate terminals 230 (not shown) and die clip terminals 344 (not shown) of packaged switches 247d.

Example V+ bus bar 617 and V− bus bar 612 may have a height, width, and length around 4 mm, 25 mm, and 70 mm, respectively. Bus bars 618 may have a height, width, and length around 4 mm, 25 mm, and 20 mm, respectively. FIG. 7C-2 shows the height and length of the bus bars and heat sink.

Inverter 460e may include driver PCB 461e and control PCB 462e. Driver PCB 461e is like driver PCB 461iT of FIG. 5A-2S. Driver PCB 461e, including components mounted thereon, is contained in chamber 611g and immersion cooled by fluid 613 as shown. Components, such as drivers 306, current sensors I_Sense, voltage sensors V_Sense, etc., may be sealed to prevent fluid 613 ingress into sensitive electronics.

Traces on driver PCBs 461e may be electrically connected to switches 304, such as switch 304d, through respective sets of connector-leads 288ds, 288g, and 288dc. Only connector-leads 288gH and 288gL of leg-c are represented in FIG. 7C-3. Driver PCB 461e may include drivers 306 that can send transistor control signals to respective packaged switches 247d of legs a and b through respective connector-leads 288g. Similarly, other drivers 306 (not shown) on driver PCB 461e can send transistor control signals to respective packaged switches 247 of legs a and b through respective connector-leads 288g. PCB 461e, may include voltage sensors V_Sense that can sense voltages across respective pairs of connector-leads 288dc and 288ds.

Phase bus bar-leads may be electrically connected (e.g., welded) to phase bus bars 618. FIG. 7C-3 shows phase bus bar-lead 465c connected to phase bus bar 618c. FIG. 7C-1 shows three phase bus bar-leads 465a-465c extending from lid 608e. Phase bus bar-leads 465 may extend through plugs 616 (only 616c is shown in FIG. 7C-3) that fit snugly in respective apertures of lid 609e as shown. Plugs 616 can create leak-proof seals with bus bar-leads 465, and with lid 609e. Plugs 616 may also electrically isolate respective bus bar-leads 465 from lid 609e.

Driver PCB 461e may include apertures through which respective bus bar-leads 465, including phase bus bar-lead 465c, may extend. PCB 461e may include current sensors configured to measure electrical current flow through respective phase bus bar-leads 465. Each of the current sensors I_Sense may have an aperture through which a respective phase bus bar-lead 465 may extend. If the current sensors have apertures for receiving bus bar-leads, they may align with respective apertures in the driver PCB 461e through which respective phase bus bar-leads extend.

Converter 460e may include film capacitors 403e within chamber 611e. First and second metal capacitor-leads 405ea and 405eb extend from a dielectric wall of each capacitor 403e. A flat bottom surface of each capacitor-lead 405ea may be electrically and thermally connected (e.g., welded, soldered, press-fitted by screws or other fasteners, etc.) directly to a flat surface of V+ bus bar 617, and a flat top surface area of each capacitor-lead 405eb may be electrically and thermally connected to a flat surface of V− bus bar 612. Capacitors 403e, including capacitor-leads 405e, can be cooled by fluid 613 flow.

FIG. 7C-3 shows a PCB 435g positioned between DC link film capacitors 403 and bus bars 617, 612, and 618. PCB 435g is also positioned between connector-leads 405ea and 405eb as shown. Terminals 437-1 and 437-2 of ceramic capacitors 433q can be electrically connected to traces 438a and 438b, respectively, on PCB 435g. For ease of illustration, only one ceramic capacitor 433q-1 is shown, but the ceramic capacitors 433q mounted on PCB 435g are electrically connected in parallel between traces 438a and 439a. Metal vias can electrically connect 511g and 513g to respective traces 438a and 439a on the other side of the PCB 435g. Metal traces 511g and 513g may be electrically connected to V+ bus bar 617 and V− bus bar 612, respectively, as shown.

FIG. 7C-2 shows an MCU mounted on control PCB 462e. The MCU may be in data communication with each driver 306, V_Sense, and I_Sense mounted on driver PCB 461e through data connection 484. Although not shown, connector 484 may extend through a plug that fits snugly in an aperture of lid 609e, and the plug may create a leak-proof seal with connector 484 and with lid 609e.

FIG. 7D-1 shows an alternative immersion cooled converter 460g when seen from the top. Converter 460g is like converter 460e, but with driver PCB 461e positioned externally to a dielectric fluid filled inner chamber as more fully described below. Other differences may exist between converters 460e and 460g.

FIGS. 7D-2 and 7D-3 show cross sectional views of converter 460g taken along lines H-H and I-I, respectively, in FIG. 7D-1. Several components (e.g., driver PCB 461e, control PCB 462e, capacitors 403e, etc.) shown in FIG. 7D-3 are not shown in FIG. 7D-2 but are described below.

With continuing reference to FIGS. 7D-1-7D-3, inverter 460g may include a housing 610g with detachable lid 620g as shown, each of which may be formed of metal such as aluminum or a dielectric material such as plastic. Housing 610g and lid 620g may form an interior chamber 611g as shown. A sealing ring 609g may connect housing 610g with lid 620g. Sealing ring 609g creates a leak-proof seal with housing 610g and lid 620g.

Fluid can flow through housing 610g. Housing 610g may include an input port 614i through which a dielectric fluid 613 may enter interior chamber 611g. Housing 610g may include an output port 6140 through which dielectric fluid 613 may exit chamber 611g. Components (e.g., capacitors 403e, etc.) may be positioned in chamber 611g and immersed in dielectric fluid 613 as shown.

As seen in FIGS. 7D-2 and 7D-3 converter 460g may include V+ bus bar 617, V− bus bar 612, and phase bus bars 618 inside chamber 611g. The bus bars may be cooled by dielectric fluid 613 flowing through chamber 611g. The bus bars may be formed from metal such as copper. The bus bars may be like bus bar 563 of FIG. 5A-16-3 with channels 40 through which fluid 613 can flow, or the bus bars may be solid with no channels as shown. V+ bus bar 617 and V− bus bar 612 may have the same shapes (e.g., generally rectangular cuboid) and sizes as shown. Phase bus bars 618 may have the same shapes (e.g., generally rectangular cuboid) and sizes as shown.

Converter 460g may include metal DC bus bar-leads 615 and 617 with rectangular or square cross-sections. First ends of metal DC bus bar-leads 615 and 617 may be electrically connected (e.g., soldered) to respective surfaces of bus bars 617 and 612, respectively, as shown. The second and opposite ends of DC bus bar-leads 615 and 617 may be electrically connected to V+ and V-terminals, respectively, of a battery or other device such as a DC/DC converter. DC bus bar-leads 615 and 617 may extend through plugs 612 (only one of which is shown in FIGS. 7D-1-7D-3) that snugly fit in respective apertures of housing 610g as shown. Plugs 612 can create leak-proof seals with bus bar-leads 615 and 617, and with housing 610g. Plugs 612 may electrically isolate bus bar-leads 615 and 617 from housing 610g.

As shown, converter 460g may include packaged switches 247d with fins that are cooled by fluid 613 flowing inside chamber 611g, it being understood that packaged switches 247d with fins may be swapped with packaged switches 247p with fins or packaged switches 247q with fins. FIGS. 7D-2 and 7D-3 show the finned packaged switches 247d of FIGS. 2D-4-2D-6. All packaged switches 247d of converter 460g may be the same type. Packaged switches 247d of converter 460g may be packaged switch 247dA, 247dB, 247dC, or 247dD of FIGS. 3A, 3B, 3C, and 3D, respectively. Packaged switches 247d include cases 248d (see, e.g., FIGS. 2D-3 and 2D-6). In an alternative embodiment, packaged switches 247 with fins of converter 460g can be replaced with naked or unpackaged switches 247 (i.e., packaged switches 247 lacking cases 248) with fins.

Converter 460g may have three legs designated a-c as shown in FIG. 7D-2. Each leg in FIG. 7D-2 may include two packaged switches 247dH and 247dL with fins. Edges 205 (not shown in FIGS. 7D-2 and 7D-3) of fins 203H and 202L in each leg, may be electrically and thermally connected (e.g., soldered) to a respective phase bus bar 618, such as phase bus bar 618c shown in FIGS. 7D-2 and 7D-3. Edges 205 of fins 202H and 203L in each leg may be electrically and thermally connected (e.g., soldered) to V+ bus bar 617 and V− bus bar 612, respectively, as shown. Fins 202 may be spaced to enable dielectric fluid 613 flow therebetween. Likewise, fins 203 may be spaced to enable dielectric fluid 613 flow therebetween. Fluid 613 may also flow over exposed surfaces of die substrate terminals 230 (not shown) and die clip terminals 344 (not shown) of packaged switches 247d.

Example V+ bus bar 617 and V− bus bar 612 may have a height, width, and length around 4 mm, 25 mm, and 70 mm, respectively. Bus bars 618 may have a height, width, and length around 4 mm, 25 mm, and 20 mm, respectively. FIG. 7D-2 shows the height and length of the bus bars and heat sink.

Inverter 460g may include driver PCB 461e and control PCB 462e, which are external to housing 610g. Driver PCB 461e is like driver PCB 461iT of FIG. 5A-2S.

Traces on driver PCBs 461e may be electrically connected to switches 304, such as switch 304d, through respective sets of connector-leads 288ds, 288g, and 288dc. Only connector-leads 288gH and 288gL of leg-c are represented in FIG. 7D-3. Driver PCB 461e may include drivers 306 that can send transistor control signals to switches 304 of leg-c through respective connector-leads 288g. Similarly, other drivers 306 (not shown) on driver PCB 461e can send transistor control signals to respective packaged switches 247 of legs a and b through respective connector-leads 288g. Each of the connector-leads 288 may extend through a respective plug 619 that fits snugly in respective apertures of lid 609e. FIG. 7D-3 only shows plugs 619H and 619L for connector leads 288gH and 288gL of leg-c. Plugs 619 can create a leak-proof seal with connector-leads 288, and with lid 609g. Plugs 619 may also electrically isolate respective connector-leads 288 from lid 609g.

Phase bus bar-leads may be electrically connected (e.g., welded) to phase bus bars 618. FIG. 7D-3 shows phase bus bar-lead 465c connected to phase bus bar 618c. FIG. 7D-1 shows three phase bus bar-leads 465a-465c extending from lid 620g. Phase bus bar-leads 465 may extend through plugs 616 (only 616c is shown in FIG. 7D-3) that fit snugly in respective apertures of lid 609g as shown. Plugs 616 can create leak-proof seals with bus bar-leads 465, and with lid 609g. Plugs 616 may also electrically isolate respective bus bar-leads 465 from lid 609g.

Converter 460g may include film capacitors 403e within chamber 611g. First and second metal capacitor-leads 405ea and 405eb extend from a dielectric wall of each capacitor 403e. A flat bottom surface of each capacitor-lead 405ea may be electrically and thermally connected (e.g., welded, soldered, press-fitted by screws or other fasteners, etc.) directly to a flat surface of V+ bus bar 617, and a flat top surface area of each capacitor-lead 405eb may be electrically and thermally connected to a flat surface of V− bus bar 612. Capacitors 403e, including capacitor-leads 405e, can be cooled by fluid 613 flow.

FIG. 7D-3 shows a PCB 435g positioned between DC link film capacitors 403 and bus bars 617, 612, and 618. PCB 435g is also positioned between connector-leads 405ea and 405eb as shown. Terminals 437-1 and 437-2 of ceramic capacitors 433q can be electrically connected to traces 438a and 438b, respectively, on PCB 435g. For ease of illustration, only one ceramic capacitor 433q-1 is shown, but the ceramic capacitors 433q mounted on PCB 435g are electrically connected in parallel between traces 438a and 439a. Metal vias can electrically connect 511g and 513g to respective traces 438a and 439a on the other side of the PCB 435g. Metal traces 511g and 513g may be electrically connected to V+ bus bar 617 and V− bus bar 612, respectively, as shown.

FIG. 7D-2 shows an MCU mounted on control PCB 462e. The MCU may be in data communication with each driver 306, V_Sense, and I_Sense mounted on driver PCB 461e through data connection 484. The MCU can execute memory stored instructions for processing signals from voltage sensors V_Sense, current sensors I_Sense, etc., and for controlling packaged switches 247d.

FIGS. 7E-1-7E-5 illustrate relevant components of an example three-phase converter 460j when seen from the front, back, left, and right sides. Converter 460j may be one implementation of a three-phase inverter that employs active soft switching. Power converters of this disclosure may employ passive or active soft switching of transistors to limit switching losses and/or provide other benefits such as reducing EMI. Converters with active soft switching may employ an auxiliary circuit for zero volt switching and/or zero current switching of transistors. The auxiliary circuit may include voltage-dividing capacitors, switches connected in series with inductors, and switches connected in parallel with capacitors.

FIGS. 7E-1 and 7E-3 show front views of converter 460j with and without an example driver PCB 461j. Several components (e.g., driver PCB 461j, control PCB 462j, bus bar-leads 465, capacitors sH and sL, capacitors cF and Cr, etc.) shown in FIGS. 7E-3-7E-5 are not shown or fully shown in FIGS. 7E-1 and 7E-2 but are described below. Several components (e.g., drivers 306, PMICs, etc.) are omitted from FIG. 7E-3 for ease of illustration.

Converter 460j is shown electrically connected to windings Wa-Wc, which may be part of a stator in a motor/generator. Converter 460j should not be limited to use with a motor/generator. Converter 460j may be bidirectional. Converter 460j can convert DC power from a battery or other source (e.g., DC/DC converter, a photovoltaic (PV) panel, etc.) connected between terminals V+ and V-into three-phase AC power. Converter 460j can convert three-phase AC power into DC power for any one of many purposes such as charging a battery electrically connected between terminals V+ and V−.

Converter 460j is shown with packaged switches 247d, it being understood in an alternative version packaged switches 247d may be replaced by packaged switches 247p or packaged switches 247q. All packaged switches 247 of battery charger 460j may be the same type. Packaged switches 247d of battery charger 460j may be packaged switch 247dA, 247dB, or 247dD of FIGS. 3A, 3B, and 3D, respectively.

Converter 460j may include V+ bus bars 417j, V− bus bars 412j, V0 (zero or neutral voltage) bus bars 621, bus bars B1, bus bars A1, and phase bus bars A2. All bus bars converter 460j are metal and configured to conduct electrical current. All bus bars of converter 460j may have a generally rectangular cuboid shape as shown in FIGS. 7E-1-7E-5. Each of example V+ bus bars 417j, V− bus bars 412j, V0 bus bars 621, bus bars B1, bus bars A1, and phase bus bars A2 may have a height, width, and length around 12 mm, 25 mm, and 20 mm, respectively, it being understood that the bus bars can have different dimensions in alternative embodiments. FIGS. 7E-1 and 7E-2 show the height and length of the bus bars. FIGS. 7E-4 and 7E-5 show the height and width of the bus bars.

Although not shown, converter 460j may include one or more DC link capacitors (e.g., film and/or ceramic capacitors) with first and second metal terminals that may be electrically and thermally connected directly or indirectly to flat surfaces V+ bus bar 417j and V− bus bar 412, respectively.

Converter 460j has three legs a-b as shown in FIGS. 7E-1 and 7E-2. Each leg may include packaged switches 247dH and 247dL that are electrically and thermally connected to a respective phase bus bar A2, which in combination may be electrically and thermally connected between a respective pair of bus bars 417j and 412j as shown. Each leg may also include packaged switches 247dF and 247dR that are electrically and thermally connected to a respective phase bus bar B1, which in combination may be electrically and thermally connected between a respective pair of bus bars 621 and A1 as shown. Legs a-c may further include inductors La-Lc, respectively, that are electrically connected between respective pairs of bus bars A2 and A1 as shown. Phase bus bars A2a-A2c are electrically connected to windings Wa-Wc, respectively, as shown.

FIGS. 7E-1, 7E-2, 7E-4, and 7E-5 illustrate the relative positioning of packaged switches 247d, V+ bus bars 417j, V− bus bars 412j, V0 bus bars 621, bus bars B1, bus bars A1, and phase bus bars A2 with respect to each other. Packaged switches 247dH may have flat die substrate terminals 230 that are electrically and thermally connected (e.g., soldered, sintered, press-fitted, etc.) directly or indirectly to flat surfaces of respective V+ bus bars 417ja, and flat die clip terminals 344 that are electrically and thermally connected (e.g., soldered, sintered, press-fitted, etc.) directly or indirectly to flat surfaces of respective phase bus bars A2. Packaged switches 247dL may have flat die substrate terminals 230 that are electrically and thermally connected (e.g., soldered, sintered, press-fitted, etc.) directly to flat surfaces of respective phase bus bars A2, and flat die clip terminals 344 that are electrically and thermally connected (e.g., soldered, sintered, press-fitted, etc.) directly or indirectly to flat surfaces of respective V− bus bars 412j. Packaged switches 247dF may have flat die substrate terminals 230 that are electrically and thermally connected (e.g., soldered, sintered, press-fitted, etc.) directly or indirectly to flat surfaces of respective V0 bus bars 621, and flat die clip terminals 344 that are electrically and thermally connected (e.g., soldered, sintered, press-fitted, etc.) directly or indirectly to flat surfaces of respective bus bars B1. Packaged switches 247dR may have flat die clip terminals 344 that are electrically and thermally connected (e.g., soldered, sintered, press-fitted, etc.) directly to flat surfaces of respective bus bars B1, and die flat substrate terminals 230 that are electrically and thermally connected (e.g., soldered, sintered, press-fitted, etc.) directly or indirectly to flat surfaces of respective bus bars A1.

With continuing reference to FIGS. 7E-1 and 7E-2 all bus bars 417j and 621 may be thermally connected to each other and electrically isolated from each other by commonly received dielectric tubes 420a. All bus bars A2 and B1 may be thermally connected to each other and electrically isolated from each other by commonly received dielectric tubes 420a. All bus bars 412j and A1 may be thermally connected to each other and electrically isolated from each other by commonly received dielectric tubes 420a.

Converter 460j may include control PCB 462j and driver PCB 461j as shown in FIGS. 7E-3-7E-5. Drivers 306 on driver PCB 461j can control respective switches 304 through respective connector-leads 288g. Only drivers 306 and connector-leads 288gHa and 288gLa of leg-a are represented in FIG. 7E-4, and only drivers 306 and connector-leads 288gFc and 288gRc of leg-c are represented in FIG. 7E-5.

Converter 460j may include metal bus bar-leads 465, each of which extends laterally between first and second ends as shown in FIGS. 7E-4 and 7E-5. As shown in FIG. 7E-4 the first end of bus bar-lead 465a1 may be electrically connected (e.g., welded) to bus bar A2a, and the second end may be electrically connected to winding Wa. Although not shown in FIG. 7E-4, the first end of bus bar-lead 465a2 may be electrically connected (e.g., welded) to bus bar Ala. Inductor La is electrically connected between bus bar-leads 465a1 and 465a2 as shown in FIG. 7E-4. As shown in FIG. 7E-5 the first end of bus bar-lead 465c2 may be electrically connected to bus bar Alc. Although not shown in FIG. 7E-5, the first end of bus bar-lead 465c1 may be electrically connected to bus bar A2c. The second end of bus bar-lead 465c1 may be electrically connected to winding Wc. Inductor Lc is electrically connected between bus bar-leads 465c1 and 465c2 as shown in FIG. 7E-5.

Bus bar-leads 465 may extend through respective apertures in driver PCB 461j. Current sensors I_Sense measure electrical current flowing through respective bus bar-leads 465. Each I_Sense may include an aperture through which a respective phase bus bar-lead 465 may extend. FIG. 7E-3 shows bus bar-leads 465 extending through respective apertures of respective current sensors I_Sense.

FIG. 7E-4 shows inductor La, bus bar-leads 465a, and driver PCB 461j with drivers 306, voltage sensors V_Sense, PMICs, and current sensors I_Sense, for leg-a of converter 460j. FIG. 7E-5 shows inductor Lc, bus bar-leads 465c, and driver PCB 461j with drivers 306, voltage sensors V_Sense, PMICs, and current sensors I_Sense for leg-c of converter 460j. Bus bar-leads 465b and similar group of drivers 306, voltage sensors V_Sense, PMICs, current sensors I_Sense, may be mounted on PCB 461j for leg-b. Bus bar-lead 465b may extend through PCB 461j and a corresponding current sensor I_Sense may be mounted thereon for leg-b.

FIGS. 7E-4 and 7E-5 show an MCU mounted on control PCB 461j. The MCU controls the operation of converter 460j through based on executable instructions stored in memory. The MCU may be in data communication with each driver 306, V_Sense, and I_Sense mounted on driver PCB 461j through a data connection 484. Control of converter 460j may be sensitive to the current flow through bus bar-leads 465 as measured by respective current sensors I_Sense, voltages across switches 304 of packaged switches 247d as measured by respective voltage sensors V_Sense, temperature of transistors in switches 304 of packaged switches 247d, etc. Although not shown, each of the packaged switches 247d may be replaced with packaged switch 247b shown in FIGS. 2D-22-2D-24, which may include the switch module, including temperature sensor 348, shown in FIGS. 4F-1-4F-3. Temperature sensors 348 may provide the MCU with temperature measurements near transistors in switches 304. Driver PCB 461j may need modification to accommodate PCBs 340 shown in FIGS. 2D-22-2D-24 and 4F-1-4F-3. For example, connectors configured to receive ends of PCB 340, can be mounted on driver PCB 461j. Traces of PCB 340 can be electrically connected to traces of driver PCB 461j through the connectors mounted on driver PCB 461j so that signals generated by temperature sensors 348 can be transmitted to the MCU. The MCU can process signals received from temperature sensors 348, current sensors I_Sense, voltage sensors V_Sense, etc., through data connection 484, during control of converter 460j.

FIG. 7E-3 shows driver PCB 461j in greater detail. Connector-leads 288 of respective packaged switches 247d extend through respective apertures of driver PCB 461j. Connector-leads 288ds and 288dc are shown electrically connected (e.g., soldered) to respective PCB traces. For example, all connector-leads 288dsH are electrically connected to trace 625, which in turn is electrically connected to first terminals of capacitors cFa-cFc, and all connector-leads 288dcL are electrically connected to trace 623, which in turn is electrically connected to first terminals of capacitors cRa-cRc. Connector-leads 288dsH are electrically connected to the V+ terminal via respective die substrate terminals 230 of packaged switches 247dH, and respective V+ bus bars 417j (see FIGS. 7E-1 and 7E-2). Connector-leads 288dcL are electrically connected to the V-terminal via respective die clip terminals 344 of packaged switches 247dL, and V− bus bars 412j (see FIGS. 7E-1 and 7E-2). Connector-leads 288dsF are electrically connected to respective second terminals of capacitors cFa-cFc via respective traces as shown. Connector-leads 288dsF are electrically connected to respective second terminals of capacitors cRa-cRc via respective traces as shown. Connector-leads 288dsF are electrically connected to respective V0 bus bars 62 via respective die clip substrate terminals 230 of packaged switches 247dF. Capacitors cRa-cRc and cFa-cFc should have substantially equal capacitance. Or the parallel combination of capacitors cRa-cRc should have substantially the same capacitance of the parallel combination of capacitors cFa-cFc. Capacitors cRa-cRc and cFa-cFc form a part of a capacitive voltage divider circuit that maintain V0 bus bars 621 at zero or neutral voltage. Zero or neutral voltage should be half-way between V+ and V−. For purposes explanation, V+ and V− are equal in magnitude and opposite in polarity. Capacitors cRa-cRc and cFa-cFc may take form in ceramic capacitors, it being understood other types of capacitors such as film capacitors or electrolytic capacitors can be used.

Driver PCB 461j as shown in FIG. 7E-3 may include voltage sensors V_Sense that can sense voltages across switches 304d via respective pairs of connector-leads 288ds and 288dc. Voltage sensors V_Sense may be electrically connected between respective pairs of connector-leads 288dsH and 288dcH through respective pairs of PCB traces as shown. Snubber capacitors sH may be electrically connected between respective pairs of connector-leads 288dsH and 288dcH via traces as shown. Voltage sensors V_Sense may be electrically connected between respective pairs of connector-leads 288dsL and 288dcL through respective pairs of PCB traces as shown. Snubber capacitors sL may be electrically connected between respective pairs of connector-leads 288dsL and 288dcL via traces as shown. Snubber capacitors sH and sL may take form in ceramic capacitors.

Although not shown, converter 460j may include one or more DC link capacitors (e.g., film and/or ceramic capacitors) with first and second metal terminals that may be electrically and thermally connected directly or indirectly to V+ bus bars 417j and V− bus bars 412, respectively. DC link capacitors may be mounted on driver PCB 461j and connected in parallel, the combination of which is connected in series between V+ bus bars 417j and V− bus bars 412j. DC link capacitors mounted on driver PCB 461j may be connected between V+ bus bars 417j and V-bus bars 412j via PCB 461j traces, connector-leads 288ds of high-side packaged switches 247dH, and connector-leads 288dc of the low-side packaged switches 247dL.

FIGS. 7E-1-7E-5 show converter 460j with dielectric tubes 420a received in bus bars. Tubes other than 420a can be received by the bus bars. For example, tubes like tubes 420g of FIG. 5A-17-6, can be received by bus bars of converter 460j. The six bus bars 417j and 621 of converter 460j can be formed by soldering six groups of metal bus bar portions 505 and 509 around tubes, like tubes 420g with six metal layers 407p, using a process like the process described with reference to FIGS. 5A-17-6-5A-17-10. During the process, the six groups of metal bus bar portions 505 and 509 can be soldered around the six metal layers 407p, respectively. Phase bus bars 417j and 621 may be thermally connected to each other and electrically isolated from each other by the tubes they commonly receive. The six bus bars A2 and B1 can be similarly formed around tubes like 420g with six metal layers 407p. Like bus bars 417j and 621, the six bus bars A2 and B1 can be formed by soldering six groups of metal bus bar portions 505 and 509 around tubes, like tubes 420g with six metal layers 407p, using a process like the process described with reference to FIGS. 5A-17-6-5A-17-10. During the process, the six groups of metal bus bar portions 505 and 509 can be soldered around the six metal layers 407p, respectively. Phase bus bars A2 and B1 may be thermally connected to each other and electrically isolated from each other by the commonly received tubes. The six bus bars A1 and 412j can also be formed by soldering six groups of metal bus bar portions 505 and 509 around tubes, like tubes 420g with six metal layers 407p, using a process like the process described with reference to FIGS. 5A-17-6-5A-17-10. During the process, the six groups of metal bus bar portions 505 and 509 can be soldered around the six metal layers 407p, respectively. Phase bus bars A1 and 412j may be thermally connected to each other and electrically isolated from each other by commonly received tubes.

A die substrate terminal 230 or die clip terminal 344 in converter 460j may be electrically and/or thermally connected to a flat metal surface of a bus bar, such as one of the phase bus bars A2, after the bus bar is formed around one or more tubes 420. The die substrate terminal 230 or die clip terminal 344 may be electrically and/or thermally connected to the flat metal surface using any one of several methods including the wire mesh bonding method described above.

All tubes 420 received in all bus bars of converter 460j may be substantially equal in length. Although not shown in FIGS. 7E-1-7E-3, first and second manifolds like manifolds 466iT, may be in fluid communication with first and second ends, respectively, of tubes 420a.

Liquid dielectric material such as epoxy, silicon, etc., can be added to air gaps or empty spaces between adjacent electrical conductors of charger 460j, including electrical conductors of naked packaged switches 247 if employed, and then cured to create structures that suppress dendrite growth and electrical arcing therebetween.

FIGS. 7E-6-7E-8 illustrate relevant components of another three-phase converter 460Jtt when seen from the front and side. Inverter 460Jtt may be one implementation of a T-type inverter. FIGS. 7E-6 and 7E-7 show front views of converter 460Jtt with and without an example driver PCB 461Jtt. Converter 460Jtt and previously described converter 460j are similar. One difference, however, is that converter 460Jtt lacks the inductors La-Lc of converter 460j.

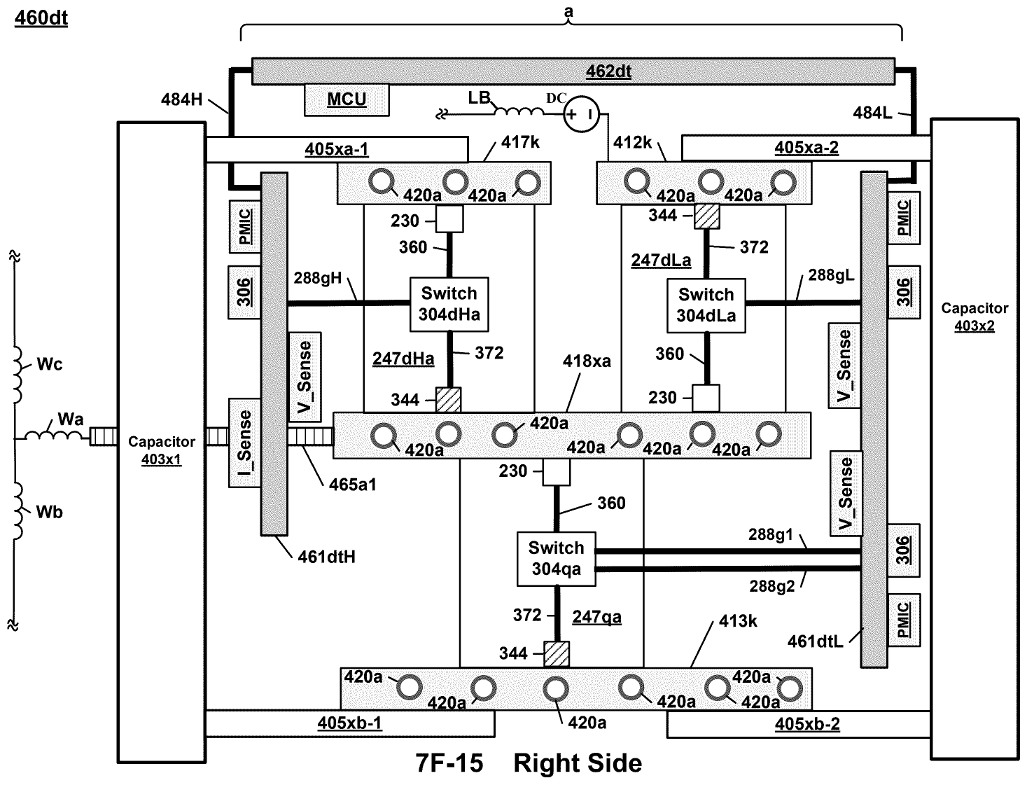

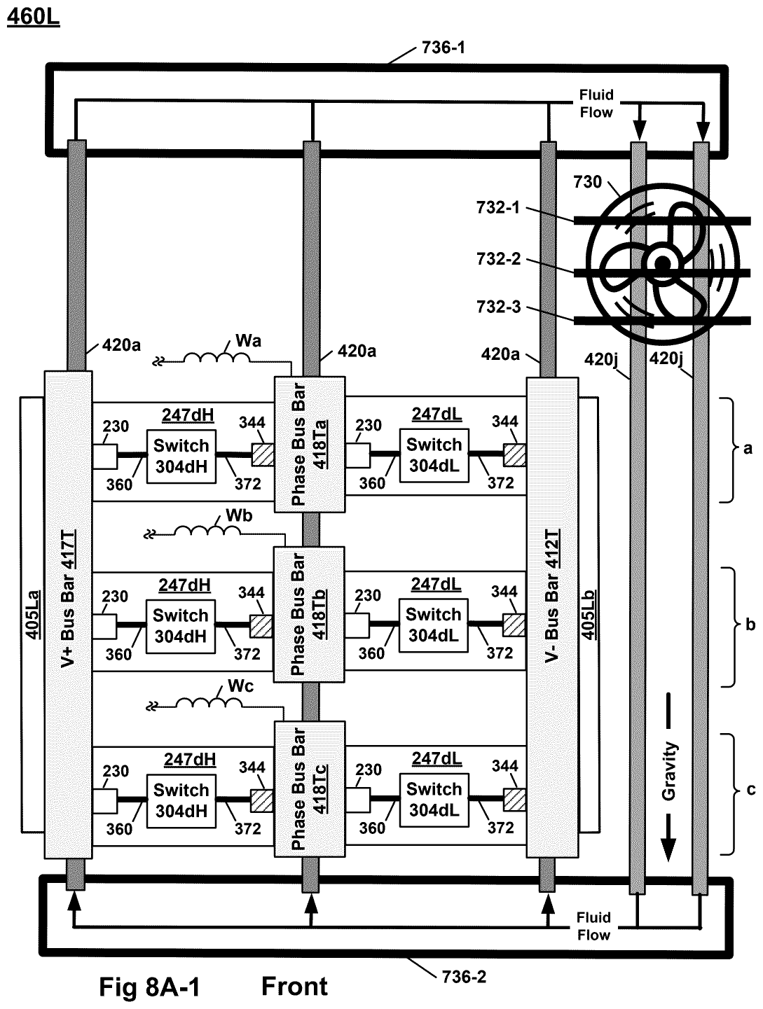

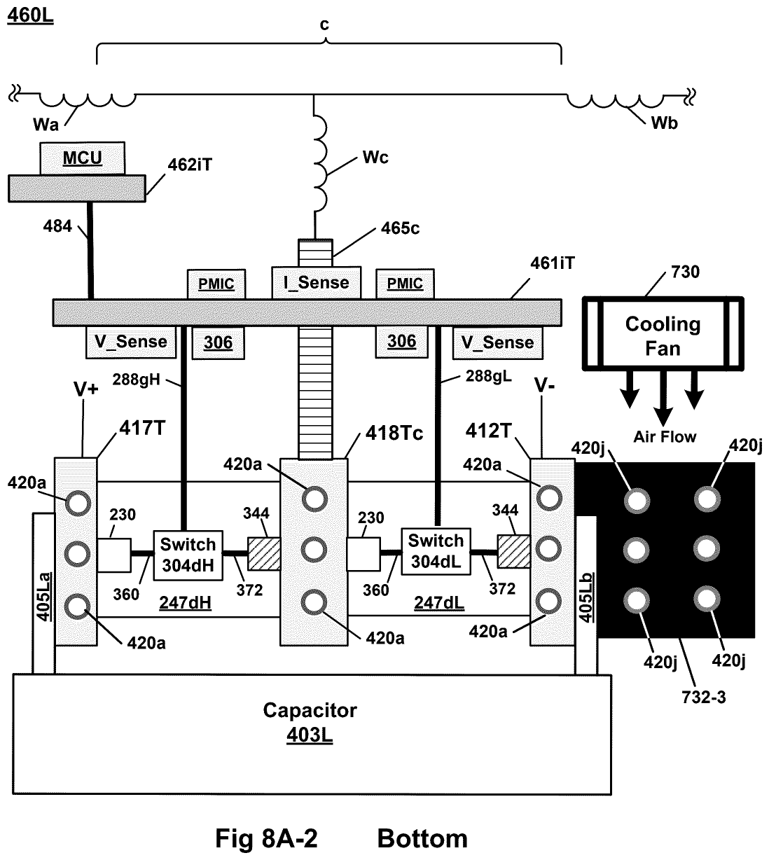

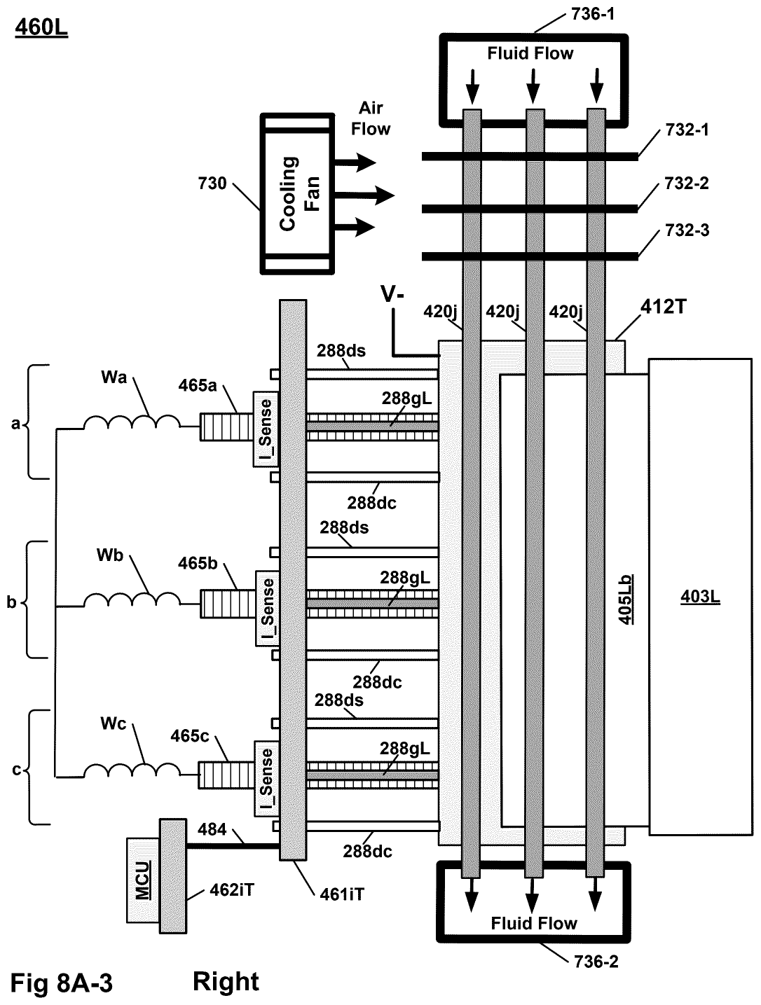

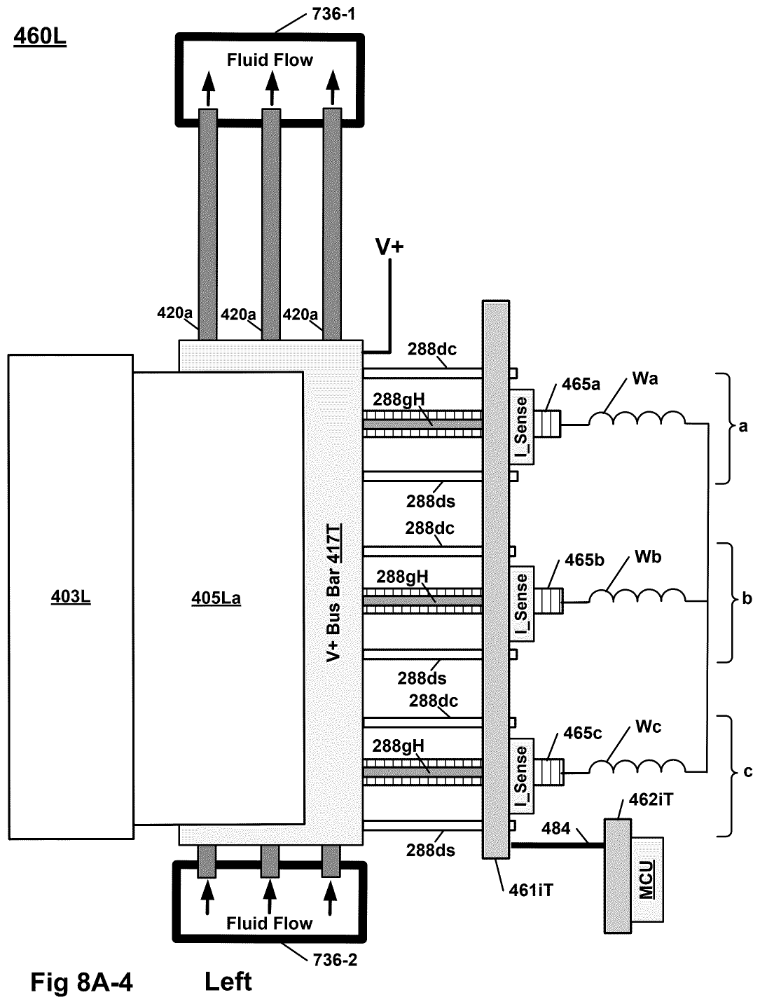

As seen in FIG. 7E-6, bus bars A1a-A1c are electrically connected directly to bus bars A2a-A2c, respectively. FIG. 7E-7 shows bus bar-lead 465a1 electrically connected directly to bus bar-lead 465a2. FIG. 7E-8 shows bus bar-lead 465c1 electrically connected directly to bus bar-lead 465c2. Though not shown in 7E-7 and 7E-8, bus bar-leads 465b1 and 465b2 are also electrically connected directly together.

FIG. 7E-7 shows example driver PCB 461Jtt, which is essentially driver PCB 461j of converter 460j without snubber capacitors sH and sL. In an alternative embodiment, snubber capacitors sH and sL remain mounted on driver PCB 461Jtt and electrically connected by traces to respective pairs of connector-leads 288ds and 288dc. The MCU of converter 460Jtt may execute stored instructions of an algorithm for controlling converter 460Jtt, which are different than the instructions of the algorithm executed by the MCU of converter 460j for controlling converter 460j.

In FIGS. 7E-1-7E-8, each pair of packaged switch 247dH and packaged switch 247dL of converter 460j or 460Jtt is electrically and thermally connected to opposite facing flat surfaces of a respective phase bus bar A2. A converter may have packaged power switches 247dH and 247dL that are thermally and electrically connected to the same flat surface of phase bus bars. FIGS. 7F-1-7F-5 illustrate front, back, side, top and bottom views of an example converter 460x in which packaged switches 247dH and 247dL may be electrically and thermally connected to the same flat surface of a respective phase bus bar. Converter 460x may be one implementation of a three-phase inverter that employs active soft switching.

Several components (e.g., driver PCBs 461x, control PCB 462x, snubber capacitors 433se, capacitors 403x) of converter 460x shown in FIG. 7F-3-7F-5 are not shown or fully shown in FIGS. 7F-1 and 7F-2 but are described below. Control PCB 462x is not shown in FIG. 7F-5 to facilitate a better understanding of converter 460x.

Converter 460x is shown electrically connected to windings Wa-Wc, which may be part of a stator in a motor/generator. Converter 460x should not be limited to use with a motor/generator. Converter 460x may be bidirectional. Converter 460x can convert DC power from a battery or other source (e.g., a PV panel) connected between terminals V+ and V− into three-phase AC power. Converter 460x can convert three-phase AC power into DC power for any one of many purposes such as charging a battery electrically connected between terminals V+ and V−.

Example converter 460x includes packaged switches 247d and 247q. All packaged switches 247d of converter 460x may be the same type. Packaged switches 247d of converter 460x may be packaged switch 247dA, 247dB, or 247dD of FIGS. 3A, 3B, and 3D, respectively. Packaged switches 247d can be replaced with packaged switches 247p or packaged switches 247q.

Converter 460x includes packaged switches 247q, it being understood that in an alternative version packaged switches 247q can be replaced with packaged switches 247pK. All packaged switches 247q of converter 460x may be the same type. Packaged switches 247q of converter 460x may be packaged switch 247qG, 247qI, 247qJ, or 247ql of FIGS. 3G, 3I, 3J, and 3L, respectively.

Converter 460x may include V+ bus bar 417x, V− bus bar 412x, V0 bus bar 413x, phase bus bars 418x, and bus bars A2. All bus bars of converter 460x may have a generally rectangular cuboid shape as shown in FIGS. 7F-1-7F-5. Example phase bus bars 418x may have a height, width, and length around 12 mm, 55 mm, and 20 mm, respectively. Example V+ bus bar 417x and V− bus bar 412 may have a height, width, and length around 12 mm, 25 mm, and 100 mm, respectively. Example V0 bus bar may have a height, width, and length around 12 mm, 55 mm, and 100 mm, respectively. The bus bars of converter 460x should not be limited to the foregoing dimensions. FIGS. 7F-1 and 7F-2 show the height and length of the bus bars.

Converter 460x has three legs designated a-c. Converter 460x may include an insulators that electrically isolate phase bus bars 418x from respective bus bars A2. Each insulator may have a rectangular cross section and may be formed of a dielectric material. Each insulator may have oppositely-facing substantially flat surfaces that are connected (e.g., glued) to respective flat surfaces of bus bars 418x and A2 in a leg as shown in FIGS. 7F-1 and 7F-2. Example converter 460x is presented with three insulators. Alternatively, the three insulators of FIGS. 7F-1 and 7F-2 may be replaced by a single insulator that electrically insulates all phase bus bars 418x from bus bars A2. This alternative insulator may have oppositely facing first and second surfaces that are substantially flat. The first surface may be connected (e.g., glued) to flat surfaces of phase bus bars 418x, and the second flat surface may be connected (e.g., glued) to flat surfaces of bus bars A2.

With reference to 7F-1 and 7F-2, each of the legs a-c may include packaged switches 247dH and 247dL that are electrically and thermally connected to a respective phase bus bar 418x. Packaged switches 247dH and 247dL in each leg may also be electrically and thermally connected to V+ bus bar 417x and V− bus bar 412x, respectively. Pairs of packaged switches 247dH and 247dL in each leg of converter 460x may be positioned side-by-side on a flat surface of a respective phase bus bar 418x. Packaged switches 247dH and 247dL in each leg may be electrically connected in series through a respective phase bus bar 418x. FIG. 7F-3 shows leg-c in which die clip terminal 344 of packaged switch 247dHc is connected to die substrate terminal 230 of packaged switch 247dLc through phase bus bar 418xc, the combination of which is electrically connected in series between V+ bus bar 417x and V− bus bar 412x. Each leg in FIGS. 7F-1 and 7F-2 may include a packaged switch 247q that is electrically and thermally connected to a respective bus bar A2. Packaged switches 247q in each leg may also be electrically and thermally connected to V0 bus bar 413x.

FIGS. 7F-1-7E-5 illustrate the relative positioning of packaged switches 247d, packaged switches 247q, V+ bus bar 417x, V− bus bar 412x, V0 bus bar 413x, phase bus bars 418x, and bus bars A2 with respect to each other. With continuing reference to FIG. 7F-1, packaged switches 247dH may have flat die substrate terminals 230 that are electrically and thermally connected (e.g., soldered, sintered, press-fitted, etc.) to a flat surface or respective flat surfaces of V+ bus bar 417x, and flat die clip terminals 344 that are electrically and thermally connected (e.g., soldered, sintered, press-fitted, etc.) to respective flat surfaces of phase bus bars 418xa-418xc, respectively, which in turn may be electrically connected to windings Wa-Wc, respectively, as shown. With continuing reference to FIG. 7F-2, packaged switches 247dL may have flat die substrate terminals 230 that are electrically and thermally connected (e.g., soldered, sintered, press-fitted, etc.) to respective flat surfaces of phase bus bars 418xa-418xc, respectively, and flat die clip terminals 344 that may be electrically and thermally connected (e.g., soldered, sintered, press-fitted, etc.) to a flat surface or respective flat surfaces of V− bus bar 412x.

With continuing reference to FIGS. 7F-1 and 7F-2, packaged switches 247q may have flat die clip terminals 344 that are electrically and thermally connected (e.g., soldered, sintered, press-fitted, etc.) to a flat surface or respective flat surfaces of V0 bus bar 413x, and flat die substrate terminals 230 that are electrically and thermally connected (e.g., soldered, sintered, press-fitted, etc.) to respective flat surfaces of bus bars A2a-A2c, respectively. Packaged switches 247q are bidirectional. In an alternative embodiment, packaged switches 247q can be rotated 180 degrees. In this alternative embodiment, the flat die substrate terminals 230 are electrically and thermally connected (e.g., soldered, sintered, press-fitted, etc.) to a flat surface of V0 bus bar 413x, and flat die clip terminals 344 are electrically and thermally connected (e.g., soldered, sintered, press-fitted, etc.) to respective flat surfaces of bus bars A2a-A2c, respectively.

FIGS. 7F-1-7F-5 show converter 460x with tubes 420a received in bus bars. Tubes other than 420a can be received by the bus bars. Several of the bus bars can receive tubes like tube 420d shown in FIG. 5A-17-1 or tubes 420g shown in FIG. 5A-17-6. For example, each of bus bars 412x and 417x can be formed by soldering metal bus bar portions 504 and 508 around tubes 420d using a process like that described above with reference to FIGS. 5A-17-1-5A-17-5. Phase bus bars 418x can be formed by soldering wider metal bus bar portions 505 and 508 around six tubes 420g using a process like that described with reference to FIGS. 5A-17-6-5A-17-10. All phase bus bars 418x may be thermally connected to each other and electrically isolated from each other by their commonly received tubes. Bus bars A2 can also be formed by soldering metal bus bar portions 505 and 509 around tubes 420g using a process like that described with reference to FIGS. 5A-17-6-5A-17-10. All phase bus bars A2 may be thermally connected to each other and electrically isolated from each other by their commonly received tubes. V0 bus bar 413x can be formed by soldering wider metal bus bar portions 504 and 508 around six tubes 420d using a process like that described with reference to FIGS. 5A-17-1-5A-17-5 described above

Converter 460x may include example capacitors 403x1 and 403x2 as shown in FIGS. 7F-1-7F-5. Capacitor 403x1 may be thermally and electrically connected between V+ bus bar 417x and V0 bus bar 413x. Capacitor 403x2 may be thermally and electrically connected between V− bus bar 412x and V0 bus bar 413x. Capacitors 403x1 and 403x2 should have substantially equal capacitance. Capacitors 403x1 and 403x2 form a part of a capacitive voltage divider circuit that maintains V0 bus bar 413x at zero or neutral voltage. FIG. 7F-4 shows capacitors 403x1 positioned between bus bar-leads 465c1 and 465b1. FIG. 7F-5 shows capacitors 403x1 positioned between bus bar-leads 465c2 and 465b2. A second pair of capacitors 403x (not shown) could be added to converter 460x. The first of the second pair of capacitor 403x can be thermally and electrically connected between V+ bus bar 417x and V0 bus bar 413x, positioned between bus bar-leads 465b1 and 465a1, and positioned between bus bar-leads 465b2 and 465a2. The second of the second pair of capacitors 403x can be thermally and electrically connected between V− bus bar 412x and V0 bus bar 413x. The added first and second capacitors 403x should have substantially equal capacitance.

Capacitors 403x of converter 460x may take form in film capacitors. First and second metal capacitor-leads 405xa-1 and 405xb-1 may extend from capacitor 403x1. First and second metal capacitor-leads 405xa-2 and 405xb-2 may extend from capacitor 403x2. Capacitor-leads 405x may have a rectangular cross section as shown in FIGS. 7F-1-7F-5. Example capacitor-leads 405x have a height, length, and width around 5 mm, 50 mm, and 30 mm, respectively. FIGS. 7F-1 and 7F-2 show the height and width of capacitor-leads 405x. Capacitor-leads 405x should not be limited to the foregoing dimensions.

Capacitor-leads 405 may have substantially flat, rectangular-shaped opposite facing top and bottom surfaces. With reference to FIG. 7F-3, a substantial portion (e.g., 10, 20, 50, 75, 90% or more) of capacitor-lead 405xa-1's flat bottom surface area may be electrically and thermally connected to a flat surface of V+ bus bar 417x, and a substantial portion (e.g., 10, 20, 50, 75, 90% or more) of capacitor-lead 405xb-1's flat top surface area may be electrically and thermally connected to a flat surface of V0 bus bar 413x. A substantial portion (e.g., 10, 20, 50, 75, 90% or more) of capacitor-lead 405xa-2's flat bottom surface area may be electrically and thermally connected to a flat surface of V− bus bar 412x, and a substantial portion (e.g., 10, 20, 50, 75, 90% or more) of capacitor-lead 405xb-2's flat top surface area may be electrically and thermally connected to a flat surface of V0 bus bar 413x. V+ bus bar 417x, V− bus bar 412x, and V0 413x can extract heat (e.g., 1, 2, 5, 10, 20, 40, 80, 100, 200, 300 Watts or more) from connected capacitors 403x through connected flat surfaces of their capacitor-leads 405.

Although not shown, converter 460x may include one or more ceramic DC link capacitors (e.g., multilayer ceramic capacitors, not shown) with first and second metal terminals that are electrically and thermally connected directly or indirectly to flat surfaces V+ bus bar 417x and V− bus bar 412x, respectively. These ceramic DC link capacitors can be mounted on a PCB that extends between V+ bus bar 417x and V− bus bar 412x. In addition, or alternatively converter 460x may include a DC link capacitor (e.g., a film capacitor, not shown) electrically and thermally connected between bus bars 417x and 412x.

Converter 460x may include control PCB 462x, and driver PCBs 461xH and 461xL as shown in FIGS. 7F-3-7F-5. With continuing reference to FIG. 7F-3, drivers 306 on driver PCBs 461xH and 461xL can control respective switches 304d through respective connector-leads 288g. Additional drivers 306 on driver PCB 461xL can control respective switches 304q through respective pairs of connector-leads 288g1 and 288g2. Only connector-leads 288gH, 288gL, 288g1, and 288g2 of leg-c are represented in FIG. 7F-3. Connector-leads 288g1 and 288g2 may be longer than the connector-leads 288gH and 288gL as shown in FIG. 7F-3.

One driver 306 of PCB 461xL can send transistor control signals to packaged switch 247dL of leg-c through a connector-lead 288g. Although not shown, driver PCB 461xL also may include drivers 306 that can similarly send transistor control signals to packaged switches 247dL in legs a and b. Another driver of PCB 461xL can send transistor control signals to packaged switch 247q of leg-c through connector-leads 288g1 and 288g2. Although not shown, driver PCB 461xL also may include drivers 306 that can similarly send transistor control signals to packaged switches 247q in legs a and b through respective pairs of connector-leads 288g1 and 288g2. Driver PCB 461xH may include a driver 306 that can send transistor control signals to packaged switch 247dH of leg-c through a connector-lead 288gH. Although not shown, driver PCB 461xH also may include drivers 306 that can similarly send transistor control signals to respective packaged switches 247dH in legs a and b.

Driver PCBs 461xH and 461xL may include voltage sensors V_Sense that can sense voltages across respective switches 304 via respective pairs of connector-leads 288ds and 288dc. Voltage sensors V_Sense can be electrically connected to respective pairs of connector-leads 288ds and 288dc. FIG. 7F-3 shows voltage sensors V_Sense that can sense voltages across respective switches 304dH, 304dL, and 304q, respectively, of leg-c via respective pairs of connector-leads 288ds and 288dc (not shown in FIG. 7F-3). Similar groups of voltage sensors V_Sense may be mounted on driver PCBs 461xL and 461xH for legs a and b.

With reference to FIGS. 7F-3-7F-5, converter 460x may include bus bar-leads 465, each of which extends laterally between first and second ends. Leads 465a1-465c1 may be shorter than leads 465a2-465c2, respectively, as shown. The first ends of bus bar-leads 465a1-465c1 may be electrically connected (e.g., welded) to respective flat surfaces of phase bus bars 418xa-418xc, respectively, and the second ends of bar-leads 465a1-465c1 may be electrically connected to windings Wa-Wc, respectively. FIG. 7F-3 shows the first end of bus bar-lead 465c1 electrically connected to phase bus bar 418xc, and the second end electrically connected to winding Wc. The first ends of bus bar-leads 465a2-465c2 may be electrically connected (e.g., welded) to respective flat surfaces of bus bars A2a-A2c, respectively, and the second ends of bar-leads 465a2-465c2 may be electrically connected to inductors La-Lc, respectively. FIG. 7F-3 shows the first end of bus bar-lead 465c2 electrically connected to bus bar A2c, and the second end electrically connected to inductor Lc, which in turn is electrically connected to winding Wc and bus-bar lead 465c1.

Bus bar-leads 465 may extend through respective apertures in diver PCBs 461xH and 461xL. Current sensors I_Sense shown in FIGS. 7F-3-7F-5 can measure electrical current flowing through respective bus bar-leads 465. Each I_Sense may include an aperture through which a respective phase bus bar-lead 465 may extend. FIGS. 7F-3-7F-5 show bus bar-leads 465 extending through respective apertures of respective current sensors I_Sense.

FIG. 7F-3 shows inductor Lc, bus bar-leads 465c, and driver 465 PCB 461xH with driver 306, voltage sensor V_Sense, PMIC, and current sensors I_Sense, for leg-c of converter 460x. Similar groups of driver 306, voltage sensors V_Sense, PMICs, current sensors I_Sense, may be mounted on PCB 461xH for legs a and b. FIG. 7F-3 also shows driver PCB 461xL with drivers 306, PMICs, and voltage sensors V_Sense for leg-c of converter 460x. Similar group of drivers 306, PMICs, voltage sensors V_Sense, and current sensors I_Sense, may be mounted on PCB 461xL for legs a and b.

FIG. 7F-3 shows an MCU mounted on control PCB 462x. The MCU controls the operation of converter 460x in accordance with memory stored MCU executable instructions. The MCU may be in data communication with each driver 306, V_Sense, and I_Sense mounted on driver PCBs 461xH and 461xL through data connections 484H and 484L, respectively. MCU control of converter 460x may be sensitive to several variables. For example, control may be sensitive to the current flow through bus bar-leads 465 as measured by respective current sensors I_Sense, voltages across switches 304 of switches 247 as measured by respective voltage sensors V_Sense, temperature of transistors in switches 304 or packaged switches 247, etc. Although not shown, each of the packaged switches 247d may be replaced with packaged switch 247b shown in FIGS. 2D-22-2D-24, which include the switch module, including temperature sensor 348, shown in FIGS. 4F-1-4F-3. Each of the packaged switches 247q can be modified to also include PCB 340 with mounted temperature sensor 348 shown in FIGS. 4F-1-4F-3.

Temperature sensors 348 may provide accurate temperature measurements near transistors in switches 304. Driver PCBs 461xH and 461xL may need modification to accommodate the PCB 340 shown in FIGS. 4F-1-4F-3. For example, connectors configured to receive ends of PCB 340, can be mounted on driver PCBs 461x. Traces of PCB 340 can be electrically connected to traces of driver PCBs 461x through the connectors mounted on driver PCBs 461x so that signals generated by temperature sensors 348 can be transmitted to the MCU. The MCU can process signals received from temperature sensors 348, current sensors I_Sense, voltage sensors V_Sense, etc., through data connections 484H and 484L in accordance with memory stored instructions during control of converter 460x.

Driver PCBs 461xH and 461xL may include snubber capacitors (e.g., ceramic capacitors) 433se, which are electrically connected in parallel with respective switches 304d. FIG. 7F-3 shows capacitors 433seHc and 433seLc mounted on driver PCBs 461xH and 461xL, respectively, that may be electrically connected across switches 304dLc and 304dHc, respectively, via respective pairs of connector-leads 288ds and 288dc (not shown in FIG. 7F-3). Although not shown, additional capacitors 433se may be electrically connected in parallel with switches 304d of legs a and b. FIGS. 7F-4 and 7F-5 shows one (i.e., snubber capacitor 433seLa) of the six snubber capacitors 433se. Snubber capacitor 433seLa has metal terminals that may be electrically connected via respective PCB metal vias 702 to connector-leads 288dc and 288ds, respectively, of packaged switch 247dL in leg-a.

All tubes 420, such as tubes 420a in FIGS. 7F-1-7F-5, received in all bus bars of converter 460x may be substantially equal in length. Although not shown in FIGS. 7F-1-7F-5, first and second manifolds like manifolds 466iT, may be in fluid communication with first and second ends, respectively, of tubes 420a.

Liquid dielectric material such as epoxy, silicon, etc., can be added to air gaps or empty spaces between electrical conductors of converter 460x, including adjacent electrical conductors of naked packaged switches 247 if employed, and then cured to create structures that suppress dendrite growth and electrical arcing therebetween.

FIGS. 7F-6-7F-8 illustrate relevant components of another three-phase converter 460Xtt when seen from the front, back, and side, respectively. Converter 460Xtt may be one implementation of a three-phase T-type inverter. Converters 460x and 460Xtt are similar. Differences exist. For example, converter 460Xtt lacks inductors La-Lc, bus bars A2, snubber capacitors 433se, and the insulators.

With continuing reference to FIGS. 7F-6-7F-8, packaged switches 247q may have flat die clip terminals 344 that are electrically and thermally connected (e.g., soldered, sintered, press-fitted, etc.) to a flat surface of V0 bus bar 413x, and flat die substrate terminals 230 that are electrically and thermally connected (e.g., soldered, sintered, press-fitted, etc.) to flat respective surfaces of respective phase bus bars 418xa-418xc. In an alternative embodiment, packaged switches 247q can be rotated 180 degrees. In this alternative embodiment, the flat die substrate terminals 230 are electrically and thermally connected (e.g., soldered, sintered, press-fitted, etc.) to a flat surface of V0 bus bar 413x, and flat die clip terminals 344 are electrically and thermally connected (e.g., soldered, sintered, press-fitted, etc.) to respective flat surfaces of respective bus bars 418xa-418xc. Packaged switches 247qG or 247qI may be particularly well suited for use in converters 460x and 460Xtt, it being understood converters 460x and 460Xtt should not be limited thereto. Packaged switch 247q of converter 460Xtt may be swapped with packaged switch 247p, such as 247pK.

FIG. 7F-7 shows example driver PCBs 461Xtt, which are essentially the driver PCBs 461Xtt of converter 460x without snubber capacitors 433se. In an alternative embodiment, snubber capacitors 433se remain mounted on driver PCBs 461Xtt and electrically connected by traces to respective pairs of connector-leads 288ds and 288dc. Further, the MCU of converter 460Xtt may execute instructions of an algorithm for controlling converter 460Xtt, which are different than the instructions of the algorithm executed by the MCU of converter 460x for controlling converter 460x. A comparison of FIGS. 7F-1 and 7F-6 shows that converter 460Xtt has a greater height than converter 460j. The capacitors 403x of converter 460Xtt may need resizing to accommodate the difference in heights between converters 460x and 460Xtt. The capacitors 403x of converter 460Xtt may or may not have the same capacitance as capacitors 403x of converter 460x. However, capacitors 403x of converter 460Xtt should have the same capacitance.

In still another embodiment, converter 460x can be modified by only removing inductors La-Lc, so that bus bar-leads 465 in each leg are electrically connected directly together. Snubber capacitors 433se might also be removed in this embodiment. The instructions executing on the MCU may also be different.

FIGS. 7F-9-7F-11 illustrate front, back, and side views of an example converter 460N, which may be another implementation of a T-type inverter. Several components (e.g., driver PCBs 461N, control PCB 462N, capacitor 403hT, capacitors 403N) of converter 460N shown in FIG. 7F-11 are not shown or fully shown in FIGS. 7F-9 and 7F-10 but are described below.

Converter 460N is shown electrically connected to windings Wa-Wc, which may be part of a stator in a motor/generator. Converter 460N should not be limited to use with a motor/generator. Converter 460N may be bidirectional. Converter 460N can convert DC power from a battery or other source (e.g., a PV panel) connected between terminals V+ and V-into three-phase AC power. Converter 460N can convert three-phase AC power into DC power for any one of many purposes such as charging a battery electrically connected between terminals V+ and V−.

Example converter 460N includes packaged switches 247d and 247p. All packaged switches 247d of converter 460N may be the same type. Packaged switches 247d of converter 460N may be packaged switch 247dA, 247dB, or 247dD of FIGS. 3A, 3B, and 3D, respectively. Packaged switches 247d can be replaced with packaged switches 247p or packaged switches 247q.

Converter 460N includes packaged switches 247p, it being understood that in an alternative version packaged switches 247p can be replaced with packaged switches 247q. Packaged switches 247qI and 247qG may be particularly well suited for use in converter 460N. The height of bus bar 413N may need resizing to accommodate a difference in height between packaged switches 247p and packaged switches 247q including switches 247ql and 247qG. All packaged switches 247p of converter 460N may be the same type. Packaged switches 247p of converter 460N may be packaged switch 247pK of FIG. 3K.

Converter 460N may include V+ bus bar 417N, V− bus bar 412N, V0 bus bar 413N, and phase bus bars 418N. All bus bars of converter 460N may have a generally rectangular cuboid shape as shown in FIGS. 7F-9-7F-11. Example phase bus bars 418N may have height, width, and length around 12 mm, 55 mm, and 20 mm, respectively. Example V+ bus bar 417N may have a height, width, and length around 19 mm, 25 mm, and 100 mm, respectively. Example V− bus bar 412N may have a height, width, and length around 12 mm, 55 mm, and 100 mm, respectively. Example V0 bus bar 413N may have a height, width, and length around 12 mm, 25 mm, and 100 mm, respectively. The bus bars of converter 460N should not be limited to the foregoing dimensions. FIG. 7F-11 shows the height and width of the bus bars.

Converter 460N has three legs designated a-c. With reference to FIG. 7F-10, each of the legs a-c may include packaged switches 247dH and 247dL that are electrically and thermally connected to a respective phase bus bar 418N. Packaged switches 247dH and 247dL in each leg may also be electrically and thermally connected to V+ bus bar 417N and V− bus bar 412N, respectively. Each leg in FIG. 7F-9 may include a packaged switch 247p that is electrically and thermally connected to a respective phase bus bar 418N. Packaged switches 247q in each leg may also be electrically and thermally connected to V0 bus bar 413N.

FIGS. 7F-9-7E-11 illustrate the relative positioning of packaged switches 247d, packaged switches 247p, V+ bus bar 417N, V− bus bar 412N, V0 bus bar 413N, and phase bus bars 418N with respect to each other. With continuing reference to FIG. 7F-10, packaged switches 247dH may have flat die substrate terminals 230 that are electrically and thermally connected (e.g., soldered, sintered, press-fitted, etc.) to a flat surface or respective flat surfaces of V+ bus bar 417N, and flat die clip terminals 344 that are electrically and thermally connected (e.g., soldered, sintered, press-fitted, etc.) to respective flat surfaces of phase bus bars 418Na-418Nc, respectively, which in turn may be electrically connected to windings Wa-Wc, respectively, as shown. Packaged switches 247dL may have flat die substrate terminals 230 that are electrically and thermally connected (e.g., soldered, sintered, press-fitted, etc.) to respective flat surfaces of phase bus bars 418Na-418Nc, respectively, and flat die clip terminals 344 that may be electrically and thermally connected (e.g., soldered, sintered, press-fitted, etc.) to a flat surface or respective flat surfaces of V− bus bar 412N.

With continuing reference to FIG. 7F-9, packaged switches 247p may have flat die substrate terminals 230 that are electrically and thermally connected (e.g., soldered, sintered, press-fitted, etc.) to a flat surface or respective flat surfaces of V0 bus bar 413N, and flat clip terminals 344 that are electrically and thermally connected (e.g., soldered, sintered, press-fitted, etc.) to respective flat surfaces of phase bus bars 418Na-418Nc, respectively. Packaged switches 247p are bidirectional. Accordingly, packaged switches 247q could be rotated 180 degrees so that flat die clip terminals 344 are electrically and thermally connected (e.g., soldered, sintered, press-fitted, etc.) to a flat surface or respective flat surfaces of V0 bus bar 413N, and flat die substrate terminals 230 are electrically and thermally connected (e.g., soldered, sintered, press-fitted, etc.) to respective flat surfaces of phase bus bars 418Na-418Nc, respectively.

FIGS. 7F-9-7F-11 show converter 460N with tubes 420a received in bus bars. Tubes other than 420a can be received by the bus bars. Several of the bus bars can receive tubes like tube 420d shown in FIG. 5A-17-1 or tubes 420g shown in FIG. 5A-17-6. For example, each of bus bars 412N and 417N can be formed by soldering metal bus bar portions 504 and 508 around tubes 420d using a process like that described above with reference to FIGS. 5A-17-1-5A-17-5. Metal bus bar portions 504 and 508 may vary in height for bus bars 412N and 417N. Phase bus bars 418N can be formed by soldering wider metal bus bar portions 505 and 508 around six tubes 420g using a process like that described with reference to FIGS. 5A-17-6-5A-17-10. All phase bus bars 418N may be thermally connected to each other and electrically isolated from each other by their commonly received tubes. V0 bus bar 413N can be formed by soldering wider metal bus bar portions 504 and 508 around six tubes 420d using a process like that described above with reference to FIGS. 5A-17-1-5A-17-5.

Converter 460N may include example capacitors 403N1 and 403hT with substantially equal capacitance. Converter 460N may include example capacitor 403N2, which may have a capacitance that is larger or smaller than the capacitance of 403N1 and 403hT. Capacitor 403N2 is electrically connected in parallel with series connected capacitors 403hT and 403N1. Although capacitors 403N and 403hT are presumed film capacitors, alternative types of capacitors, such as electrolytic capacitors, can be used.

With continuing reference to FIG. 7F-9, FIG. 7F-11 shows first and second metal capacitor-leads 405Na-1 and 405Nb-1 extending from capacitor 403N1. Capacitor-leads 405Na-1 and 405Nb-1 may have a rectangular cross section as shown in the figures. Capacitor-leads 405Na-1 and 405Nb-1 may have a height, width, and length around 5 mm, 30 mm, and 50 mm, respectively. FIG. 7F-11 shows the height and length of capacitor-leads 405Na-1 and 405Nb-1. Capacitor-leads 405Na-1 and 405Nb-1 should not be limited to the foregoing dimensions. A substantial portion (e.g., 10, 20, 50, 75, 90% or more) of capacitor-lead 405Na-1's flat bottom surface area may be electrically and thermally connected (e.g., soldered) to a flat surface of common bus bar 413N, and a substantial portion (e.g., 10, 20, 50, 75, 90% or more) of capacitor-lead 405Nb-1's flat top surface area may be electrically and thermally connected (e.g., soldered) to a flat surface of V− bus bar 412N as shown. V− bus bar 412N and common bus bar 413N can extract heat (e.g., 1, 2, 5, 10, 20, 40, 80, 100, 200, 300 Watts or more) from connected film capacitor 403N1 through flat surfaces of its capacitor-leads 405N.

With continuing reference to FIG. 7F-10, FIG. 7F-11 shows first and second metal capacitor-leads 405Na-2 and 405Nb-2 extending from capacitor 403N2. Capacitor-leads 405Na-2 and 405Nb-2 may have a rectangular cross section as shown. Capacitor-leads 405Na-2 and 405Nb-2 may have a height, width, and length around 5 mm, 90 mm, and 50 mm, respectively. FIG. 7F-11 shows the height and length of capacitor-leads 405Na-2 and 405Nb-2. Capacitor-leads 405Na-2 and 405Nb-2 should not be limited to the foregoing dimensions. A substantial portion (e.g., 10, 20, 50, 75, 90% or more) of capacitor-lead 405Na-2's flat bottom surface area may be electrically and thermally connected (e.g., soldered) to a flat surface of V+ bus bar 417N, and a substantial portion (e.g., 10, 20, 50, 75, 90% or more) of capacitor-lead 405Nb-2's flat top surface area may be electrically and thermally connected (e.g., soldered) to a flat surface of V− bus bar 412N as shown. V− bus bar 412N and V+ bus bar 417N can extract heat (e.g., 1, 2, 5, 10, 20, 40, 80, 100, 200, 300 Watts or more) from connected film capacitor 403N2 through flat surfaces of its capacitor-leads 405N.

With continuing reference to FIGS. 7F-9-7F-11 first and second metal capacitor-leads 405hia and 405hib may extend from capacitor 403hT as shown. Bent portions 601a and 601b may extend at right angles from first and second metal capacitor-leads 405hia and 405hib, respectively. Bent portions 601a and 601b of capacitor-leads 405hia and 405hib, respectively, may have a height, width, and length around 5 mm, 30 mm, and 30 mm, respectively. Height and length are shown in FIG. 7F-11. The flat bottom surface areas of bent portions 601a and 601b may be electrically and thermally connected (e.g., welded, soldered, press-fitted by screws or other fasteners, etc.) directly to flat top surfaces of capacitor-leads 405Na-1 and 405Na-2, respectively, as shown.

Although not shown, converter 460N may include one or more ceramic DC link capacitors (e.g., multilayer ceramic capacitors, not shown) with first and second metal terminals that are electrically and thermally connected directly or indirectly to flat surfaces V+ bus bar 417N and V− bus bar 412N, respectively.

Converter 460N may include control PCB 462N, driver PCB 461NB, and driver 461NF as shown in FIG. 7F-11. Drivers 306 on driver PCB 461NB can control respective switches 304d through respective connector-leads 288g. Drivers 306 on driver PCB 461NF can control respective switches 304p through respective pairs of connector-leads 288g1 and 288g2. Only connector-leads 288gH, 288gL, 288g1, and 288g2 of leg-c are represented in FIG. 7F-11. Connector-leads 288gL may be longer than connector-leads 288gH, 288g1, and 288g2 as shown in FIG. 7F-11.

A driver 306 of PCB 461NB can send transistor control signals to packaged switch 247dH of leg-c through a connector-lead 288gH. Although not shown, driver PCB 461NB may include drivers 306 that can similarly send transistor control signals to packaged switches 247dH in legs a and b through respective connector-leads 288. Another driver of PCB 461NB can send transistor control signals to packaged switch 247dL of leg-c through connector-lead 288gL. Although not shown, driver PCB 461NB also may include drivers 306 that can similarly send transistor control signals to packaged switches 247dL in legs a and b through respective connector-leads 288. Driver PCB 461NF may include a driver 306 that can send transistor control signals to packaged switch 247p of leg-c through a connector-leads 288g1 and 288g2. Although not shown, driver PCB 461NF also may include drivers 306 that can similarly send transistor control signals to respective packaged switches 247p in legs a and b through respective pairs of connector-leads 288g1 and 288g2.

Driver PCBs 461NB and 461NF may include voltage sensors V_Sense that can sense voltages across respective switches 304 via respective pairs of connector-leads 288ds and 288dc. FIG. 7F-11 shows voltage sensors V_Sense that can sense voltages across respective switches 304dH, 304dL, and 304p, respectively, of leg-c via respective pairs of connector-leads 288ds and 288dc (not shown). Similar groups of voltage sensors V_Sense may be mounted on driver PCBs 461NF and 461NB for legs a and b via respective pairs of connector-leads 288ds and 288dc.

With reference to FIGS. 7F-11, converter 460N may include bus bar-leads 465a-465c, each of which extends laterally between first and second ends. Only bus bar-lead 465c is shown in FIG. 7F-11. The first ends of bus bar-leads 465a-465c may be electrically connected (e.g., welded) to respective flat surfaces of phase bus bars 418Na-418Nc, respectively, and the second ends of bar-leads 465a-465c may be electrically connected to windings Wa-Wc, respectively. FIG. 7F-11 shows the first end of bus bar-lead 465c electrically connected to phase bus bar 418Nc, and the second end electrically connected to winding Wc.

Bus bar-leads 465a-465c may extend through respective apertures in diver PCB 461NF. FIG. 7F-11 shows only bus bar-lead 465c extending through driver PCB 461F. Current sensors I_Sense can measure electrical current flowing through respective bus bar-leads 465a-465c. FIG. 7F-11 shows only current sensor I_Sense for measuring current flow through bus bar-lead 465c. Each I_Sense may include an aperture through which a respective phase bus bar-lead 465 may extend. FIG. 7F-11 shows bus bar-lead 465c extending through an aperture of current sensor I_Sense for leg-c. Similar bus bar-leads 465a and 465b may extend through respective apertures of current sensors I_Sense for legs a and b, respectively.

FIG. 7F-11 shows an MCU mounted on control PCB 462N. The MCU controls the operation of converter 460N in accordance with MCU executable instructions stored in memory. The MCU may be in data communication with each driver 306, V_Sense, and I_Sense mounted on driver PCBs 461NB and 461NF through data connections 484B and 484F, respectively. MCU control of converter 460N may be sensitive to several variables. For example, control may be sensitive to the current flow through bus bar-leads 465 as measured by respective current sensors I_Sense, voltages across switches 304 of switches 247 as measured by respective voltage sensors V_Sense, temperature of transistors in switches 304, etc. Although not shown, each of the packaged switches 247d may be replaced with packaged switch 247b shown in FIGS. 2D-22-2D-24, which include the switch module, including temperature sensor 348, shown in FIGS. 4F-1-4F-3. Each of the packaged switches 247p can be modified to include the PCB 340 shown in FIGS. 2D-22-2D-24 and FIGS. 4F-1-4F-3 with mounted temperature sensor 348. Temperature sensors 348 may provide accurate temperature measurements near transistors in switches 304. Driver PCBs 461NB and 461NF may need modification to accommodate the PCB 340 shown in FIGS. 2D-22-2D-24 and FIGS. 4F-1-4F-3. For example, connectors configured to receive ends of PCB 340, can be mounted on driver PCBs 461N. Traces of PCB 340 can be electrically connected to traces of driver PCBs 461N through the connectors mounted on driver PCBs 461N so that signals generated by temperature sensors 348 can be transmitted to the MCU. The MCU can process signals received from temperature sensors 348, current sensors I_Sense, voltage sensors V_Sense, etc., through data connections 484B and 484F in accordance with instructions stored in memory during control of converter 460N.

All tubes 420, such as tubes 420a in FIGS. 7F-9-7F-5, received in all bus bars of converter 460N may be substantially equal in length. Although not shown in FIGS. 7F-9-7F-11, first and second manifolds like manifolds 466iT, may be in fluid communication with first and second ends, respectively, of tubes 420a.

Liquid dielectric material such as epoxy, silicon, etc., can be added to air gaps or empty spaces between electrical conductors of converter 460N, including adjacent electrical conductors of naked packaged switches 247 if employed, and then cured to create structures that suppress dendrite growth and electrical arcing therebetween.

FIGS. 7F-12-7F-15 illustrate relevant components of three-phase converter 460dt when seen from the front, back, left and right sides, respectively. Converters 460dt and 460Xtt are similar. Converter 460dt is essentially converter 460Xtt with a bidirectional DC/DC converter added thereto.

Converter 460dt is shown electrically connected to windings Wa-Wc, which may be part of a stator in a motor/generator. Converter 460dt should not be limited to use with a motor/generator. Converter 460dt may be bidirectional. Converter 460x can convert DC power from a battery or other source (e.g., a PV panel) into three-phase AC power.

Example converter 460dt includes packaged switches 247d and 247q. All packaged switches 247d of converter 460x may be the same type. Packaged switches 247d of converter 460x may be packaged switch 247dA, 247dB, or 247dD of FIGS. 3A, 3B, and 3D, respectively. Packaged switches 247d can be replaced with packaged switches 247p or packaged switches 247q.

Converter 460dt includes packaged switches 247q, it being understood that in an alternative version packaged switches 247q can be replaced with packaged switches 247pK. All packaged switches 247q of converter 460dt may be the same type. Packaged switches 247q of converter 460dt may be packaged switch 247qG, 247qI, 247qJ, or 247ql of FIGS. 3G, 3I, 3J, and 3L, respectively.

Converter 460dt may include V+ bus bar 417dt, V− bus bar 412dt, V0 bus bar 413dt, and phase bus bars 418x. All bus bars of converter 460x may have a generally rectangular cuboid shape as shown in FIGS. 7F-12-7F-15. Example phase bus bars 418x may have a height, width, and length around 12 mm, 55 mm, and 20 mm, respectively. Example V+ bus bar 417dt and V− bus bar 412dt may have a height, width, and length around 12 mm, 25 mm, and 125 mm, respectively. Example V0dt bus bar may have a height, width, and length around 12 mm, 55 mm, and 120 mm, respectively. The bus bars of converter 460dt should not be limited to the foregoing dimensions. FIGS. 7F-12 and 7F-13 show the height and length of the bus bars.

Converter 460dt has four legs designated a-d. Converter 460dt may include an insulator that electrically isolate phase bus bars 418xd from bus bars 413dt. The insulator may have a rectangular cross section and may be formed of a dielectric material. The insulator may have oppositely-facing substantially flat surfaces that are connected (e.g., glued) to respective flat surfaces of bus bars 418xd and 413dt as shown in FIGS. 7F-12-7F-15.

With reference to 7F-12 and 7F-15, each of the legs a-d may include packaged switches 247dH and 247dL that are electrically and thermally connected to a respective phase bus bar 418x. Packaged switches 247dH and 247dL in each leg may also be electrically and thermally connected to V+ bus bar 417x and V− bus bar 412dt, respectively. Pairs of packaged switches 247dH and 247dL in each leg of converter 460dt may be positioned side-by-side on a flat surface of a respective phase bus bar 418x. Packaged switches 247dH and 247dL in each leg may be electrically connected in series through a respective phase bus bar 418x. FIG. 7F-14 shows leg-d in which die clip terminal 344 of packaged switch 247dHd is connected to die substrate terminal 230 of packaged switch 247dLd through phase bus bar 418xd, the combination of which is electrically connected in series between V+ bus bar 417dt and V− bus bar 412dt. Each of legs a-c in FIGS. 7F-12, 7F-13, and 7F-15 may include a packaged switch 247q that is electrically and thermally connected to a respective phase bus bar 418x. Packaged switches 247q in each leg may also be electrically and thermally connected to V0 bus bar 413dt.

FIGS. 7F-12-7E-15 illustrate the relative positioning of packaged switches 247d, packaged switches 247q, V+ bus bar 417dt, V− bus bar 412dt, V0 bus bar 413dt, and phase bus bars 418x. With continuing reference to FIG. 7F-12, packaged switches 247dH may have flat die substrate terminals 230 that are electrically and thermally connected (e.g., soldered, sintered, press-fitted, etc.) to a flat surface or respective flat surfaces of V+ bus bar 417dt, and flat die clip terminals 344 that are electrically and thermally connected (e.g., soldered, sintered, press-fitted, etc.) to respective flat surfaces of phase bus bars 418xa-418xd, respectively. With continuing reference to FIG. 7F-13, packaged switches 247dL may have flat die substrate terminals 230 that are electrically and thermally connected (e.g., soldered, sintered, press-fitted, etc.) to respective flat surfaces of phase bus bars 418xa-418xd, respectively, and flat die clip terminals 344 that may be electrically and thermally connected (e.g., soldered, sintered, press-fitted, etc.) to a flat surface or respective flat surfaces of V− bus bar 412dt.

With continuing reference to FIGS. 7F-12, packaged switches 247q may have flat die clip terminals 344 that are electrically and thermally connected (e.g., soldered, sintered, press-fitted, etc.) to a flat surface or respective flat surfaces of V0 bus bar 413dt, and flat die substrate terminals 230 that are electrically and thermally connected (e.g., soldered, sintered, press-fitted, etc.) to respective flat surfaces of phase bus bars 418x, respectively.

FIGS. 7F-12-7F-15 show converter 460dt with tubes 420a received in bus bars. Tubes other than 420a can be received by the bus bars. Several of the bus bars can receive tubes like tube 420d shown in FIG. 5A-17-1 or tubes 420g shown in FIG. 5A-17-6. For example, each of bus bars 412dt and 417dt can be formed by soldering metal bus bar portions 504 and 508 around tubes 420d using a process like that described above with reference to FIGS. 5A-17-1-5A-17-5. Phase bus bars 418x can be formed by soldering wider four pairs of metal bus bar portions 505 and 508 around six tubes 420g using a process like that described with reference to FIGS. 5A-17-6-5A-17-10. All phase bus bars 418x may be thermally connected to each other and electrically isolated from each other by their commonly received tubes. V0 bus bar 413dt can be formed by soldering wider metal bus bar portions 504 and 508 around six tubes 420d using a process like that described with reference to FIGS. 5A-17-1-5A-17-5 described above

Converter 460dt may include example capacitors 403x1 and 403x2 as shown in FIGS. 7F-12-7F-15. Capacitor 403x1 may be thermally and electrically connected between V+ bus bar 417dt and V0 bus bar 413dt. Capacitor 403x2 may be thermally and electrically connected between V− bus bar 412dt and V0 bus bar 413dt.

Capacitor-leads 405 may have substantially flat, rectangular-shaped opposite facing top and bottom surfaces. With reference to FIG. 7F-14, a substantial portion (e.g., 10, 20, 50, 75, 90% or more) of capacitor-lead 405xa-1's flat bottom surface area may be electrically and thermally connected to a flat surface of V+ bus bar 417dt, and a substantial portion (e.g., 10, 20, 50, 75, 90% or more) of capacitor-lead 405xb-1's flat top surface area may be electrically and thermally connected to a flat surface of V0 bus bar 413dt. A substantial portion (e.g., 10, 20, 50, 75, 90% or more) of capacitor-lead 405xa-2's flat bottom surface area may be electrically and thermally connected to a flat surface of V− bus bar 412t, and a substantial portion (e.g., 10, 20, 50, 75, 90% or more) of capacitor-lead 405xb-2's flat top surface area may be electrically and thermally connected to a flat surface of V0 bus bar 413dt.

Although not shown, converter 460x may include one or more ceramic DC link capacitors (e.g., multilayer ceramic capacitors, not shown) with first and second metal terminals that are electrically and thermally connected directly or indirectly to flat surfaces V+ bus bar 417dt and V− bus bar 412dt, respectively. These ceramic DC link capacitors can be mounted on a PCB that extends between V+ bus bar 417dt and V− bus bar 412dt. In addition, or alternatively converter 460dt may include a DC link capacitor (e.g., a film capacitor, not shown) electrically and thermally connected between bus bars 417dt and 412dt.

Converter 460dt may include control PCB 462dt, and driver PCBs 461dtH and 461dtL as shown in FIGS. 7F-14 and 7F-15. With continuing reference to FIGS. 7F-14 and 7F-15, drivers 306 on driver PCBs 461dtH and 461dtL can control respective switches 304d through respective connector-leads 288g. Additional drivers 306 on driver PCB 461dtL can control respective switches 304q through respective pairs of connector-leads 288g1 and 288g2. Only connector-leads 288gH and 288gL of leg-d are represented in FIG. 7F-14. Only connector-leads 288gH, 288gL, 288g1, and 288g2 of leg-a are represented in FIG. 7F-15.

One driver 306 of PCB 461dtL can send transistor control signals to packaged switch 247dL of leg-a through a connector-lead 288g. Although not shown, driver PCB 461dtL also may include drivers 306 that can similarly send transistor control signals to packaged switches 247dL in legs b and c. Another driver of PCB 461dtL can send transistor control signals to packaged switch 247q of leg-a through connector-leads 288g1 and 288g2. Although not shown, driver PCB 461dtL also may include drivers 306 that can similarly send transistor control signals to packaged switches 247q in legs b and c through respective pairs of connector-leads 288g1 and 288g2. Driver PCB 461dtH may include a driver 306 that can send transistor control signals to packaged switch 247dH of leg-a through a connector-lead 288gH. Although not shown, driver PCB 461tH also may include drivers 306 that can similarly send transistor control signals to respective packaged switches 247dH in legs b and c.

Driver PCBs 461dtH and 461dtL may include voltage sensors V_Sense that can sense voltages across respective switches 304 via respective pairs of connector-leads 288ds and 288dc. Voltage sensors V_Sense can be electrically connected to respective pairs of connector-leads 288ds and 288dc. FIG. 7F-14 show voltage sensors V_Sense that can sense voltages across respective switches 304dH and 304dL, respectively, of leg-d via respective pairs of connector-leads 288ds and 288dc (not shown in FIG. 7F-14). FIG. 7F-15 show voltage sensors V_Sense that can sense voltages across respective switches 304dH, 304dL, and 304q, respectively, of leg-a via respective pairs of connector-leads 288ds and 288dc (not shown in FIG. 7F-15). Similar groups of voltage sensors V_Sense may be mounted on driver PCBs 461dtL and 461dtH for legs b and c.

With reference to FIGS. 7F-3-7F-5, converter 460x may include bus bar-leads 465, each of which extends laterally between first and second ends. The first ends of bus bar-leads 465a1-465d1 may be electrically connected (e.g., welded) to respective flat surfaces of phase bus bars 418xa-418xd, respectively. FIG. 7F-15 shows the first end of bus bar-lead 465a1 electrically connected to phase bus bar 418xa, and the second end electrically connected to winding Wa. The first ends of bus bar-leads 465b1 and 465c1 may be electrically connected (e.g., welded) to respective flat surfaces of bus bars 418xb and 418xc, respectively, and the second ends of bar-leads bus bar-leads 465b1 and 465c1 may be electrically connected to windings Wb-Wc, respectively. FIG. 7F-14 shows the first end of bus bar-lead 465d1 electrically connected to phase bus bar 418xd, and the second end electrically connected to inductor LB, which in turn is electrically to a positive terminal of a DC supply (e.g., a battery). The negative terminal of the DC supply is electrically connected to V− bus bar 412dt as shown.

Bus bar-leads 465 may extend through respective apertures in diver PCBs 461dtH and 461dtL. Current sensors I_Sense shown in FIGS. 7F-14 and 7F-15 can measure electrical current flowing through respective bus bar-leads 465. Each I_Sense may include an aperture through which a respective phase bus bar-lead 465 may extend. FIGS. 7F-14 and 7F-15 show bus bar-leads 465 extending through respective apertures of respective current sensors I_Sense.

FIG. 7F-15 shows bus bar-lead 465c1, drivers 306, voltage sensors V_Sense, PMICs, and current sensors I_Sense, for leg-a of converter 460dt. Similar groups of bus bar leads 465, drivers 306, voltage sensors V_Sense, PMICs, current sensors I_Sense, may be mounted on PCBs 461dtH and 461dtL for legs b and c.

FIG. 7F-3 shows an MCU mounted on control PCB 462dt. The MCU controls the operation of converter 460dt in accordance with memory stored MCU executable instructions. The MCU may be in data communication with each driver 306, V_Sense, and I_Sense mounted on driver PCBs 461dtH and 461dtL through data connections 484H and 484L, respectively. Although not shown, each of the packaged switches 247d may be replaced with packaged switch 247b shown in FIGS. 2D-22-2D-24, which include the switch module, including temperature sensor 348, shown in FIGS. 4F-1-4F-3. Each of the packaged switches 247q can be modified to also include PCB 340 with mounted temperature sensor 348 shown in FIGS. 4F-1-4F-3. Driver PCBs 461dtH and 461dtL may need modification to accommodate the PCB 340 shown in FIGS. 4F-1-4F-3. For example, connectors configured to receive ends of PCB 340, can be mounted on driver PCBs 461dt. Traces of PCB 340 can be electrically connected to traces of driver PCBs 461dt through the connectors mounted on driver PCBs 461t so that signals generated by temperature sensors 348 can be transmitted to the MCU. The MCU can process signals received from temperature sensors 348, current sensors I_Sense, voltage sensors V_Sense, etc., through data connections 484H and 484L in accordance with memory stored instructions during control of converter 460dt.

All tubes 420, such as tubes 420a in FIGS. 7F-1-7F-5, received in all bus bars of converter 460x may be substantially equal in length. Although not shown in FIGS. 7F-1-7F-5, first and second manifolds like manifolds 466iT, may be in fluid communication with first and second ends, respectively, of tubes 420a.

Liquid dielectric material such as epoxy, silicon, etc., can be added to air gaps or empty spaces between electrical conductors of converter 460x, including adjacent electrical conductors of naked packaged switches 247 if employed, and then cured to create structures that suppress dendrite growth and electrical arcing therebetween.

Many power converters rely on cooling systems to reduce operating temperatures of transistors and other power devices. Cooling systems often include electro-mechanical pumps for circulating cooling fluid through power converters. For example, the inverter 460iT of FIG. 5A-1 may rely on a pump to circulate cooling liquid through tubes 420a of bus bars 417T, 418T, and 412T, which in turn are thermally and electrically connected to switches 304d. Unfortunately, electro-mechanical pumps are expensive and prone to failure. Cooling systems may also require tubes to complete a fluid circuit that includes the electro-mechanical pump, the power converter, and a radiator. These tubes can clog or leak. If they do, the power converter can overheat. Further, electro-mechanical pumps, tubes and other components may add weight, volume, and complexity to cooling systems.

FIGS. 8A-1-8A-4 show front, bottom, right and left side views, respectively, of an example power inverter 460L with thermosyphon cooled bus bars. Several components (e.g., PCB 461iT, PCB 462iT, capacitor 403L, connector-leads 288, etc.) shown in FIGS. 8A-2-8A-4 are not shown or fully shown in FIG. 8A-1 but are described below. Several components (e.g., packaged switches 247d, drivers 306, voltage sensors V_sense, PMICs, etc.) shown in FIG. 8A-1 or 8A-2 are not shown in FIGS. 8A-3 and 8A-4 but are described below. PCBs 461iT and 462iT are omitted from FIG. 8A-1.

Inverter 460L and inverter 460iT of FIG. 5A-1 have similarities. For example, both inverters have V+ bus bar 417T, V− bus bar 412T, and phase bus bars 418T. Both inverters are shown with packaged switches 247d that are electrically and thermally connected between bus bars. Both inverters include control PCB 462iT and driver PCB 461iT that are in data communication via connector 484. Both inverters include phase bus-bar leads 465 electrically connected to and extending from respective phase bus bars 418T.

While inverters 460L and 460iT have similarities, differences exist. For example, V+ bus bar 417T, V− bus bar 412T, and phase bus bars 418T of inverter 460L are formed around tubes 420a that may be longer than tubes 420a of inverter 460iT. Phase bus bars 418T of inverter 460iT have two rows of tubes 420a, while phase bus bars 418T of inverter 460L have only one row of tubes 420a. Inverter 460L includes only one capacitor 403L electrically and thermally connected between bus bars 417T and 412T. Additionally, unlike inverter 460iT, inverter 460L includes a thermosyphon, which may include a cooling fan 730, metal cooling-fins 732 and metal tubes 420j. The thermosyphon utilizes natural convection to circulate fluid (e.g., ethylene glycol and water) through tubes 420a without the need for a pump. It can operate by creating a cyclic fluid flow from areas of high temperature inside tubes 420a to areas of lower temperature inside tubes 420j. Thermosyphons are recognized for their efficiency in heat transfer. Other differences between inverters 460L and 460iT may exist.

Inverter 460L is electrically connected to windings Wa-Wc as shown, which may be part of a stator in a motor/generator. Inverter 460L should not be limited to use with a motor/generator.

Inverter 460L may be bidirectional. Inverter 460L can convert DC power from a battery or other source (e.g., a PV panel) electrically connected between terminals V+ and V− into three-phase AC power. Inverter 460L can convert three-phase AC power provided at phase bus bars 418T into DC power for many purposes such as for charging a battery that is electrically connected between terminals V+ and V−.

Inverter 460L employs packaged switches 247d, it being understood that packaged switches 247d can be replaced with packaged switches 247p or packaged switches 247q. Some, most or all packaged switches 247 of inverter 460L may be the same type. Packaged switches 247d of inverter 460L may be packaged switch 247dA, 247dB, or 247dD of FIGS. 3A, 3B, and 3D, respectively.

Inverter 460L is shown with three legs designated a-c. Each leg may include packaged switches 247dH and 247dL that are electrically and thermally connected to a respective phase bus bar 418T, which in combination may be sandwiched between V+ bus bar 417T and V− bus bar 412T as shown. Packaged switches 247dH and 247dL may be also electrically and thermally connected to V+ bus bar 417T and V− bus bar 412T, respectively, as shown. V+ bus bar 417T and V− bus bar 412T may be electrically connected as shown to terminals V+ and V−, respectively, which may be electrically connected between a DC supply such as a battery.

DC bus bars 417 and 412, including V+ bus bar 417T and V− bus bar 412T, are generally rectangular cuboid in shape. V+ bus bar 417T and V− bus bar 412T may have a height, width, and length around 8 mm, 25 mm, and 70 mm, respectively. Phase bus bar 418T may have a height, width, and length around 12 mm, 25 mm, and 20 mm, respectively. FIG. 8A-1 shows the height and length of bus bars of inverter 460iT, while FIG. 8A-2 shows the height and width.

FIG. 8A-1 illustrates the relative positioning of packaged switches 247d, V+ bus bar 417T, phase bus bars 418T, and V− bus bar 412T. Packaged switches 247dH may have die substrate terminals 230 that are electrically and thermally connected (e.g., soldered, sintered, press-fitted, etc.) to a flat surface or respective flat surfaces of V+ bus bar 417T as shown, and die clip terminals 344 that are electrically and thermally connected (e.g., soldered, sintered, press-fitted, etc.) to flat surfaces of respective phase bus bars 418Ta-418Tc as shown. Packaged 247dL may have die substrate terminals 230 that are electrically and thermally connected (e.g., soldered, sintered, press-fitted, etc.) to flat surfaces of respective phase bus bars 418Ta-418Tc as shown, and die clip terminals 344 that are electrically and thermally connected (e.g., soldered, sintered, press-fitted, etc.) to a flat surface or respective flat surfaces of V− bus bar 412T as shown.

FIGS. 8A-1-8-4 show inverter 460L with ceramic tubes 420a received in the bus bars. Tubes other than ceramic tubes 420a can be received by the bus bars. For example, bus bars 412T and 417T can be formed around and connected with dielectric layers 422d of insulated metal tubes like tube 420m, and phase bus bars 418T may be formed around and connected with dielectric layers 422p of insulated metal tubes like tube 420s. The dielectric layers 422d and 422p need not cover these tubes between the bus bars and manifold 736-1. Bus bars 412T, 417T and 418T can be formed around and connected with dielectric layers 422d of insulated metal tubes like tube 420m. The dielectric layers 422d need not cover these tubes between the bus bars and manifold 736-1. Bus bars 412T and 417T can be formed by soldering metal bus bar portions 504 and 508 around metallization layers 407d of metalized ceramic tubes like tube 420d using a process like that described above with reference to FIGS. 5A-17-1-5A-17-5, and phase bus bars 418T can be formed by soldering metal bus bar portions 505 and 508 around metallization layers 407p of metalized ceramic tubes like tubes 420g using a process like that described above with reference to FIGS. 5A-17-6-5A-17-10. The metallization layers 407d and 407p need not cover these tubes between the bus bars and manifold 736-1. Phase bus bars 418T may be thermally connected to each other and electrically isolated from each other by their commonly received tubes.

Inverter 460L may include example capacitor 403L as shown in FIGS. 8A-2-8A-4 and as partially shown in FIG. 8A-1. Capacitor 403L may be thermally and electrically connected between V+ bus bar 417T and V− bus bar 412L. Capacitor 403L may take form in a film capacitor. First and second metal capacitor-leads 405La and 405Lb may extend from capacitor 403L. Capacitor-leads 405L may have a rectangular cross section as shown in FIGS. 8A-1 and 8A-2. Example capacitor-leads 405L have a height, length, and width around 5 mm, 30 mm, and 65 mm, respectively. FIGS. 8A-3 and 8A-4 show the height and width of capacitor-leads 405L. Capacitor-leads 405L should not be limited to the foregoing dimensions.

Capacitor-leads 405L may have substantially flat, rectangular-shaped opposite facing top and bottom surfaces. With reference to FIGS. 8A-1-8A-4, a substantial portion (e.g., 10, 20, 50, 75, 90% or more) of capacitor-lead 405La's flat bottom surface area may be electrically and thermally connected to a flat surface of V+ bus bar 417T, and a substantial portion (e.g., 10, 20, 50, 75, 90% or more) of capacitor-lead 405L's flat top surface area may be electrically and thermally connected to a flat surface of V− bus bar 412L. V+ bus bar 417T and V− bus bar 412L can extract heat (e.g., 1, 2, 5, 10, 20, 40, 80, 100, 200, 300 Watts or more) from connected capacitor 403L through connected flat surfaces of capacitor-leads 405.

Inverter 460L may include control PCB 462iT and driver PCB 461iT. With continuing reference to FIG. 8A-2, drivers 306 on driver PCB 461iT can control respective switches 304d through respective connector-leads 288g. Only connector-leads 288gH and 288gL of leg-c are represented in FIG. 8A-2. Drivers 306 can send transistor control signals to packaged switches 247dH and 247dL of leg-c through connector-leads 288gH and 288gL, respectively. Although not shown, driver PCB 461iT also may include drivers 306 that can similarly send transistor control signals to packaged switches 247dH and 247dL in legs a and b.

Driver PCB 461iT may include voltage sensors V_Sense that can sense voltages across respective switches 304 via respective pairs of connector-leads 288ds and 288dc. Voltage sensors V_Sense can be electrically connected to respective pairs of connector-leads 288ds and 288dc. FIG. 8A-2 shows voltage sensors V_Sense that can sense voltages across respective switches 304dH and 304dL, respectively, of leg-c via respective pairs of connector-leads 288ds and 288dc (not shown in FIG. 8A-2). Similar groups of voltage sensors V_Sense may be mounted on driver PCB 461iT for legs a and b.

With reference to FIGS. 8A-2-8A-4, inverter 460L may include metal bus bar-leads 465, each of which extends laterally between first and second ends. The first ends of bus bar-leads 465a-465c may be electrically connected (e.g., welded) to respective flat surfaces of phase bus bars 418Ta-418Tc, respectively, and the second ends of bar-leads 465a-465c may be electrically connected to windings Wa-Wc, respectively. FIG. 8A-2 shows the first end of bus bar-lead 465c electrically connected to phase bus bar 418Tc, and the second end electrically connected to winding Wc.

Bus bar-leads 465 may extend through respective apertures in diver PCB 461iT. Current sensors I_Sense shown in FIGS. 8A-2-8A-4 can measure electrical current flowing through respective bus bar-leads 465. Each I_Sense may include an aperture through which a respective phase bus bar-lead 465 may extend. FIGS. 8A-2-8A-4 show bus bar-leads 465 extending through respective apertures of respective current sensors I_Sense. FIGS. 8A-3 and 8A-4 also show connector-leads 288ds and 288dc extending through respective apertures of driver PCB 461iT

FIG. 8A-2 shows bus bar-lead 465c, voltage sensors V_Sense, drivers 306, PMICs, and current sensors I_Sense, for leg-c of inverter 460L. Similar groups of drivers 306, voltage sensors V_Sense, PMICs, current sensors I_Sense, may be mounted on PCB 461iT for legs a and b.

FIGS. 8A-2-8A-4 shows an MCU mounted on control PCB 462iT. The MCU controls the operation of inverter 460L in accordance with MCU executable instructions stored in memory. The MCU may be in data communication with each driver 306, V_Sense, and I Sense mounted on driver PCB 461iT through data connection 484.

Although not shown, inverter 460L may include PCB 435a, 435b, 435c, or 435e, which are more fully described above with reference to inverter 460iT, positioned in the space between capacitor 403L and V+ bus bar 417T, V− bus bar 412T, and phase bus bars 418Ta-418Tc. PCB 435a, 435b, 435c, or 435e can be electrically connected to V+ bus bar 417T, V− bus bar 412T, and phase bus bars 418Ta-418Tc through traces 511, 513, and 515a-515c, respectively, in substantially the same way PCB 435a, 435b, 435c, or 435e may be electrically connected to V+ bus bar 417T, V− bus bar 412T, and phase bus bars 418Ta-418Tc of inverter 460iT as described above.

All tubes 420a and tubes 420j in FIGS. 8A-1-8A-4 received in all bus bars of inverter 460L may be substantially equal in length. First and second manifolds 736-1 and 736-2, which are shown in cross section, may be in fluid communication with first and second ends, respectively, of tubes 420a and 420j as shown. Fluid flowing out of tubes 420a can mix in an inner chamber of manifold 736-1 before entering tubes 420j. Fluid flowing out of tubes 420j can mix in an inner chamber of manifold 736-2 before entering tubes 420a. Thin (e.g., 1-8 mm), plate-like metal cooling-fins 732 may be positioned parallel to each other, each of which may have opposite facing flat surfaces as shown. Tubes 420j may extend through aligned apertures of metal cooling-fins 732. Outer surfaces of tubes 420j may be thermally connected (e.g., soldered, welded, etc.) to cylindrical walls of respective apertures in cooling-fins 732. Cooling-fins 732 can extract heat through thermal connections with tubes 420j as fluid flows between manifolds 736. A fan, like fan 730, can force cooling air across the flat surfaces of cooling-fins 732.

Liquid dielectric material such as epoxy, silicon, etc., can be added to air gaps or empty spaces between electrical conductors of inverter 460L, including adjacent electrical conductors of naked packaged switches 247 if employed, and then cured to create structures that suppress dendrite growth and electrical arcing therebetween. Inverter 460L should be free of dielectric material in and around areas of fan 730 and cooling-fins 732 that may inhibit the cooling of fluid flowing through tubes 420j.

Bus bars may be built around tubes with square or rectangular shapes. FIGS. 9A-1 and 9A-2 show front and side views of inverter 460CT, which may be inverter 460iT of FIG. 5A-20 with its bus bars 412T, 417T, and 418T replaced with bus bars 412CT, 417CT, and 418CT, respectively. Each of bus bars 412T, 417T, and 418T may be formed around one or more rectangular shaped tubes as shown. In an alternative embodiment of inverter 460CT, only bus bars 417T and 418T of inverter 460T are replaced by bus bars 417CT and 418CT, respectively. In another embodiment, bus bars 412T, 418T, and 417T of inverter 460T may be replaced with bus bars 412CST, 417CST, and 418CST, respectively, which also receive rectangular shaped tubes, and which are more fully described below.

FIG. 9A-3 shows end views of example rectangular shaped tubes 420u1-420u3, which may be formed (e.g., extruded, extruded hot pressed, cast, isostatic pressed, grown, 3D printed, sintered, etc.) from dielectric material such as aluminum nitride or beryllium oxide, or from metal such as copper or aluminum. Tube 420u1 is shown with four tube channels through which fluid may flow. The four tube channels are defined by a solid rectangular center element 429 that is integrally connected to an inner rectangular shaped flat surface of tube 420u1 by pairs of rectangular horizontal and vertical spokes. In an alternative embodiment, tube 420u1 may be square shaped with a square or rectangular center element 429. Tubes 420u1-420u3 are examples of tubes that can electrically insulate fluid flowing through them from bus bars in which they are received.

Tube 420u1 should not be limited to the number and shape of tube channels shown. For example, tube 420u1 could have a single circular, single oval, single rectangular, or single square shaped tube channel. Tube 420u2 is a rectangular shaped with tube channels like those of tube 420u1. An alternative of tube 420u2 may include only two oval or circular shaped channels through which fluid can flow. Tube 420u3 includes example oval channels as shown. A tube 420u with circular or oval channels may have the structural support that might be needed to withstand sintering pressure that is applied to the tube during a process to build a bus bar around the tube.

When received by only one bus bar, such as a V+ or V− bus bar, the outer surface of a dielectric tube 420u1-420u3 may directly connect to the bus bar, or the outer surface of the dielectric tube 420u1-420u3 may connect to the bus bar through an electrically conducting or electrically non-conducting square or rectangular shaped tube joint. When received by only one bus bar, a metal tube 420u1-420us may connect to the bus bar through an electrically non-conducting square or rectangular shaped tube joint, to electrically isolate the tube from the bus bar.

A dielectric tube 420u1-420u3 may be commonly received in two or more bus bars. When commonly received in two or more bus bars, the outer surface of the dielectric tube 420u1-420u3 may directly connect with the two or more bus bars, or the outer surface of the dielectric tube 420u1-420u3 may connect with the two or more bus bars through an electrically non-conducting square or rectangular shaped tube joint that maintains electrical isolation between the two or more bus bars. A metal tube 420u1-420u3 may be commonly received in two or more bus bars. When commonly received in two or more bus bars, a metal tube 420u1-420u3 may connect with the two or more bus bars through an electrically non-conducting square or rectangular shaped tube joint to electrically isolate the tube from the two or more bus bars.

FIG. 9A-4 shows cross-sectional or end views of tubes 420v1-420v3, which may be dielectric tubes 420u1-420u3, respectively, with a thin (e.g., 4.0, 2.0, 1.0, 0.5, 0.1, 0.05, 0.01, 0.005, 0.001 mm or less) layer of metal 407d formed on most or substantially all outer flat surfaces. Metal layer 407d may be formed, for example, by painting the outer surface of a dielectric tube, such as a dielectric 420u1-420u3, with conductive ink containing silver or other sintering conducive material and then curing the conductive ink. Other methods of forming meal layer 407d are described above. Metal layer 407d may generally have the same square or rectangular shape as tube 420v1-420v3. Like metal layers 407 formed on cylindrical tubes 420 described above, the surfaces of metal layers 407 formed on square or rectangular tubes, including tubes 420v, may be smoothed (e.g., sanded) to form a surface for increasing heat transfer with the surface of another object, such as a slat 551 described below, to which it is connected (e.g., soldered, sintered, etc.). End sections of metalized dielectric tubes, such as tubes 420v1-420v3, may lack a metal layer. FIG. 9A-5 is a side view of tube 420v2, which shows end sections of metalized dielectric tube 420v2 without metal layer 407d. Tubes 420v1 and 420v2 may be similar when seen from the side.

When a tube 420v1-420v3 is received in just one bus bar, such as a V+ bus bar 417CT or V− bus bar 412CT of FIGS. 9A-1 and 9A-2, the outer surface of metal layer 407d may directly connect with the bus bar, or the outer surface of metal layer 407d may connect with the bus bar through an electrically conducting or electrically non-conducting tube joint. The tube joint may generally have the same square or rectangular shape as tube 420v1-420v3. Alternatively, a tube 420v1-420v3 may connect with the bus bar only through its opposite facing top and bottom surfaces via respective electrically conducting or electrically non-conducting tube joints, or only through its opposite facing side surfaces via respective electrically conducting or electrically non-conducting tube joints. When commonly received in two or more bus bars, the outer surface of metal layer 407d of a tube 420v1-420v3 may connect to the two or more bus bars through an electrically non-conducting tube joint to maintain electrical isolation between the two or more bus bars. End sections of metalized tube 420v1-420v3 may extend partially or fully through respective walls of respective fluid manifolds. The metal layers 407d, if electrified, should not contact electrically conductive fluid flowing in the manifolds.

With continuing reference to FIGS. 9A-1 and 9A-2, FIG. 9A-13 is a cross-sectional or end view of example V+ bus bars 417CT that is formed around tubes 420v2. Outer surfaces of tubes 420v2 in FIG. 9A-13 are shown connected to V+ bus bar 417CT through tube joints 441d. An example process for building a bus bar, such as phase bus bar 417CT, is described below with reference to FIGS. 9A-10-9A-14.

Metal layers may be formed on selected portions of a dielectric tube's outer surface to be connected to respective bus bars. FIG. 9A-6-1 is a side view of tube 420vg1, which is dielectric tube 420u1 with thin (e.g., 4.0, 2.0, 1.0, 0.5, 0.1, 0.05, 0.01, 0.005, 0.001 mm or less) metal layers 407p formed on three portions of the outer surface as shown. Alternatively, metal layers 407p may be formed on two, four, five, six or more portions of dielectric tube 420u1. Metal layers 407p may be formed, for example, by painting respective sections of the outer surface of a dielectric tube, such as dielectric tube 420u1, with conductive ink containing silver or other sintering conducive material and then curing the conductive ink. Other methods of forming metal layers 407p are contemplated. Metal layers 407p may be formed on tube dielectric 420u2 or 420u3 in the same manner. The axial length of metal layers 407p need not be the same as shown in FIG. 9A-6-1. FIG. 9A-6-2 is a side view of tube 420vg2, which is dielectric tube 420u2 with thin (e.g., 4.0, 2.0, 1.0, 0.5, 0.1, 0.05, 0.01, 0.005, 0.001 mm or less) metal layers 407p formed on three portions of the outer surface as shown. Tubes with metal layers 407p, like tube 420vg1 or 420vg2, can be commonly received by multiple bus bars such as bus bars 418CT of FIGS. 9A-1 and 9A-2. When received in bus bars, the outer surface of metal layers 407p may directly connect to the bus bars, respectively, or the outer surface of metal layers 407p may connect to the bus bars, respectively, through respective square or rectangular shaped tube joints, which may be electrically conducting or electrically non-conducting. Like tube 420v2 shown in FIG. 9A-5, the end sections of tube 420vg1 and 420vg2 may lack a metal layer 407. End sections of metalized tube 420vg1 or 420vg2 may extend partially or fully through respective walls of respective fluid manifolds. The metal layers 407p, if electrified, should not contact electrically conductive fluid flowing in the manifolds.

FIG. 9A-18 is a cross-sectional or end view of example phase bus bars 418CTa formed around tubes 420vg2. Phase bus bar 418CTa may be one of three aligned phase bus bars 418CT that commonly receive tubes 420vg2. Outer surfaces of tubes 420vg2 in FIG. 9A-18 are connected to respective phase bus bars 418CT through respective square or rectangular shaped tube joints 441p. An example process for building phase bus bars, such as phase bus bars 418CT, is described below with reference to FIGS. 9A-15-9A-19.

FIG. 9A-7 shows cross-sectional or end views of metalized dielectric tubes 420w1-420w3, which may be tubes dielectric 420u1-420u3, respectively, with thin (e.g., 4.0, 2.0, 1.0, 0.5, 0.1, 0.05, 0.01, 0.005, 0.001 mm or less) layers of metal 407d formed only on most or substantially all the outer flat top surface and most or substantially all the outer flat bottom surface as shown. Flat side surfaces between the top and bottom of tubes 420w may lack a layer of metal 407d as shown. FIG. 9A-8 is a side view of tube 420w2, which shows end sections without metallization. Tubes 420w1 and 420w3 may be similar when seen from the side. When received in only one bus bar, such as a V+ bus bar or V− bus bar, the outer surface of metal layers 407d may directly connect with the bus bar, or the outer surface of metal layers 407d may connect with the bus bar through respective electrically conducting or electrically non-conducting tube joints. When commonly received in two or more bus bars, such as phase bus bars, the outer surface of metal layers 407d of a tube 420w1-420w3 may connect with the two or more bus bars through respective electrically non-conducting tube joints to maintain electrical isolation between the two or more bus bars. End sections of metalized tube 420w1-420w3 may extend partially or fully through respective walls of respective fluid manifolds. The metal layers 407d, if electrified, should not contact electrically conductive fluid flowing in the manifolds.

FIG. 9A-9 is a side view of tube 420wg, which is dielectric tube 420u3 with thin (e.g., 4.0, 2.0, 1.0, 0.5, 0.1, 0.05, 0.01, 0.005, 0.001 mm or less) metal layers 407p formed only on three portions of the flat outer top and bottom surfaces as shown. Similar metal layers 407p may be formed on tube dielectric 420u1 or 420u2. Tubes with metal layers 407p, like tube 420wg, can be commonly received by multiple (e.g., three) bus bars (e.g., phase bus bars). Like tube 420w2 shown in FIG. 9A-8, the end sections of tube 420wg may lack a metal layer 407. End sections of metalized tube 420wg may extend partially or fully through respective walls of respective fluid manifolds. The metal layers 407p, if electrified, should not contact electrically conductive fluid flowing in the manifolds.

Bus bars can be built around one or more of the tubes 420u, 420v, 420w, 420vg, or 420wg. For example, a bus bar (e.g., V+ or V− bus bar) may be formed by connecting (e.g., soldering, sintering, etc.) metal bus bar portions around one or more of the tubes 420u, 420v, or 420w. FIGS. 9A-10-9A-14 illustrate relevant aspects of an example method of forming the V+ bus bar 417CT of FIGS. 9A-1 and 9A-2 around tubes 420v2, it being understood the method can be used for forming bus bars around tubes 420v1, 420v3, 420w1, 420w2, or 420w3.

FIGS. 9A-10 and 9A-11 are side and end views, respectively, of metal bus bar portions 574 and 578 and metalized ceramic tubes 420v2. Pairs of semi-rectangular grooves 571 and 576 are aligned with each other and with respective tubes 420v2 as shown in FIGS. 9A-10 and 9A-11. Tubes 420v2 in FIGS. 9A-10-9A-14 can be swapped with other tubes 420v such as tubes 420v1, 420v3, or 420w so long as grooves 571 and 576 are resized to accommodate the different tube dimensions.

Join material (e.g., solder paste) may be added to some, most, or substantially all surface of a metal bus bar portion groove, such as groove 571 or 576, to which a tube will be connected. FIG. 9A-11 shows join material 440d added to the wider flat surfaces of semi-rectangular grooves 571 and 576. Most of each of the wider flat groove surface may be covered with join material as shown. Although not shown join material may be added to some of the short flat surfaces of grooves 571 and 576. In an alternative embodiment, metal bus bar portion groove surfaces, such as those of grooves 571 and 576, may be bare, and join material may be applied to some or all four outer surfaces of tubes 420v2 before they are aligned between aligned grooves 571 and 576 of FIG. 9A-11.

Metal bus bar portions 574 and 578 can be positioned so that solder paste 440d contacts tubes 420v2 as shown in FIG. 9A-12. Then heat can be applied to solder paste 440d. Metal bits of solder paste 440d may melt with the application of heat. Heated solder paste 440d can flow around tubes 420v2 to create rectangular-shaped tube joints 441d shown in FIG. 9A-13. Some heated solder paste 440d may flow into spaces between flat surfaces of metal bus bar portions 574 and 578 to create joints 443d shown in FIG. 9A-13. The assembly can be cooled, which solidifies joints 441d and 443d. FIG. 9A-14 is a front view of bus bar 417CT shown in FIG. 9A-13.

Some heated solder paste 440d may flow into spaces between opposite facing flat surfaces of metal bus bar portions 574 and 578 to create joints 443d as described above. However, the amount of solder paste 440d added to the surfaces of grooves may provide little to no solder flow into spaces between opposing flat surfaces of metal bus bar portions. Join material like solder paste 440d may also be added to one or both opposing flat surfaces of metal bus bar portions 574 and 578 in FIG. 9A-11. When heated, this added solder paste can flow to create joints 443d.

Multiple bus bars, such as phase bus bars 418Ct of FIGS. 9A-1 and 9A-2, may be formed by joining (e.g., soldering) sets of metal bus bar portions around one or more square or rectangular tubes, such as tubes 420vg1 or 420vg2, using a process like that described above with reference to FIGS. 9A-10-9A-14. FIGS. 9A-15-9A-19 show relevant aspects of an example process for building example bus bars 418CT of FIG. 9A-1 around tubes 420vg2, it being understood the process can be applied to building phase bus bars around other square or rectangular tubes such as tubes 420ug or 420wg.

FIGS. 9A-15 and 9A-16 are front and end views, respectively, of a set of three linearly aligned metal bus bar portions 575, a set of three linearly aligned metal bus bar portions 579, and a set of three tubes 420vg2, each of which is positioned between and aligned with a respective pair of semi-rectangular grooves that are formed in flat surfaces of metal bus bar portions 575 and 579, it being understood that grooves with different dimensions may be formed in the flat surfaces to accommodate square or rectangular tubes with dimensions that are different than those of tubes 420vg2. The size and shape of metal bus bar portions 575 may be substantially equal, and the size and shape of metal bus bar portions 579 may be substantially equal. The size and shape of metal bus bar portions 575 and 579 may be substantially equal. The size and shape of metal bus bar portions 575 may be different than the size and shape of metal bus bar portions 579. Metal layers 407p are aligned with respective pairs of bus bar portions 575 and 579 as shown. Metal layers 407p may be axially longer than the lengths of respective pairs of bus bar portions 575 and 579 as shown in FIG. 9A-15. Gaps exist between metal layers 407p on tubes 420vg2. The axial length of metal layers 407p need not be the same as shown in FIG. 9A-15. Tubes 420vg2 of FIGS. 9A-15-9A-19 can be swapped with other types of tubes such as tubes such as 420wg.

Each tube 420vg2 can be received in a set of linearly aligned semi-rectangular grooves of metal bus bar portions 575 or metal bus bar portions 579. Semi-rectangular grooves in metal bus bar portions 575 and 579 are substantially the same size and shape, and parallel to each other in the figures. Each semi-rectangular groove extends the full length of the metal bus bar portion 575 or 579 in which the groove is formed.

FIG. 9A-16 shows join material 440p added to the wider, flat surfaces of semi-rectangular grooves of metal bus bar portions 575 and 579. Most of each of the wider flat metal bus bar portion groove surface may be covered with join material as shown. Although not shown join material may be added to some of the shorter flat surfaces of grooves 571 and 576. In an alternative embodiment, metal bus bar portion groove surfaces, such as those of grooves 571 and 576, may be bare, and join material may be applied to some or all four outer surfaces of tubes 420vg2 before they are aligned between aligned grooves 571 and 576 as shown in FIG. 9A-16.

Metal bus bar portions 575 and 579 can be positioned with solder paste 440p contacting tubes 420vg as shown in FIG. 9A-17. Then heat can be applied to solder paste 440p. Heated solder paste 440p can flow around tubes 420vg to create rectangular shaped tube joints 441p of FIG. 9A-18. Some heated solder paste 440p may flow into spaces between opposite facing flat surfaces of metal bus bar portions 575 and 579 to create electrically conductive joints 443p in FIG. 9A-18. The assembly can be cooled, which solidifies solder joints 441p and 443p. FIG. 9A-19 is a front view of bus bars 418CT shown in FIG. 9A-18.

Some heated solder paste 440p may flow into spaces between flat surfaces of metal bus bar portions 575 and 579 to create joints 443p as described above. However, the amount of solder paste 440p added to the surfaces of the grooves may provide little to no solder flow into spaces between opposing flat surfaces of respective pairs of metal bus bar portions 575 and 579. Join material like solder paste 440p (or other electrically conductive join material) may also be added to one or both opposing flat surfaces of metal bus bar portions 575 and 579 in FIG. 9A-16. When heated, this added solder can flow to create joints 443p.

It is noted that joints 441p and joints 443p can be made with a join material other than solder paste. Tube joints 441p could be made with a join material that is thermally conductive and electrically isolating such as electrically insulating glue. However, some, most or all of each or most of joints 443p should be made with an electrically conductive join material, such as the solder paste 440p described above, to enable an electrical connection between respective metal bus bar portion pairs 575 and 579.

FIGS. 9A-20-9A-24 illustrate relevant aspects of another example method of forming a bus bar (e.g., V+ or V− bus bar) like V+ bus bar 417CT. The method FIGS. 9A-20-9A-24 of is like the method of FIGS. 9A-13-9A-14. Both methods use bus bar portions 574 and 578. However, differences exist. For example, the method of FIGS. 9A-20-9A-24 forms a bus bar around tubes 420w2, it being understood the method can be used for forming bus bars around tubes 420w1, 420w3, 420v1, 420v2, or 420v3.

FIGS. 9A-20 and 9A-21 are side and end views, respectively, of metal bus bar portions 574 and 578 and metalized ceramic tubes 420w2. Pairs of semi-rectangular grooves 571 and 576 are aligned with each other and with respective tubes 420w2 as shown in FIGS. 9A-20 and 9A-21. Tubes 420w2 in FIGS. 9A-20-9A-24 can be swapped with other tubes 420, such as tubes 420w1, 420w3, or 420v, so long as grooves 571 and 576 are resized to accommodate the different tube dimensions. A layer of sintering enhancement material (e.g., silver) may be formed (e.g., electroplated) on all surfaces of bus bar portions 574 and 578.

Join material may be added to some, most, or substantially all the metalized flat top and bottom surfaces of tubes 420w. FIG. 9A-21 shows sinter-join material (e.g., sinter paste, sinter preform, etc.) 640d added to substantially all the metalized flat top and bottom surfaces tubes 420w2. FIG. 9A-21 also shows sinter-join material 640d added to substantially all flat surfaces of bus bar portion 578 to be sintered to respective flat surfaces 645 of bus bar portion 574.

Metal bus bar portions 574 and 578 can be positioned so that sinter-join material 640d formed on tubes 420w2 contacts surfaces of grooves 571 and 576, and so that sinter-join material 640d formed flat surfaces of bus bar portion 578 contacts flat surfaces 645 as shown in FIG. 9A-22. Pressure and heat are then applied to bus bar portions 574 and 578 in a sintering process to sinter bus bar portions 574 and 578 to each other and to tubes 420w2 through sintered joints 641d and 643d, which are shown in FIG. 9A-23. FIG. 9A-24 is a front view of bus bar 417CST shown in FIG. 9A-23. V+ bus bar 417CT of FIGS. 9A-1 and 9A-2 can be swapped with bus bar 417CST.

Multiple bus bars, such as phase bus bars 418Ct of FIGS. 9A-1 and 9A-2, may be formed by joining (e.g., sintering) sets of metal bus bar portions around one or more square or rectangular tubes, such as tubes 420wg2, using a process like that described above with reference to FIGS. 9A-20-9A-24. FIGS. 9A-25-9A-29 show relevant aspects of an example process for building example bus bars around tubes 420wg2, it being understood the process can be applied to building phase bus bars around other square or rectangular.

FIGS. 9A-25 and 9A-26 are front and end views, respectively, of a set of three linearly aligned metal bus bar portions 575, a set of three linearly aligned metal bus bar portions 579, and a set of two tubes 420wg2, each of which is positioned between and aligned with a respective pair of semi-rectangular grooves that are formed in flat surfaces of metal bus bar portions 575 and 579, it being understood that grooves with different dimensions may be formed in the flat surfaces to accommodate square or rectangular tubes with dimensions that are different than those of tubes 420wg2. Metal layers 407p are aligned with respective pairs of bus bar portions 575 and 579 as shown. Gaps exist between metal layers 407p on tubes 420wg2. The axial length of metal layers 407p need not be the same as shown in FIG. 9A-25. Tubes 420wg2 of FIGS. 9A-25-9A-29 can be swapped with other types of tubes such as tubes such as 420vg2.

Each tube 420wg2 can be received in a set of linearly aligned semi-rectangular grooves of metal bus bar portions 575 or metal bus bar portions 579. Semi-rectangular grooves in metal bus bar portions 575 and 579 are substantially the same size and shape, and parallel to each other in the figures. Each semi-rectangular groove extends the full length of the metal bus bar portion 575 or 579 in which the groove is formed.

FIG. 9A-26 shows sinter-join material (e.g., sinter paste, sinter preform, etc.) 640p added to substantially all the metalized flat top and bottom surfaces of tubes 420wg2. FIG. 9A-26 also shows sinter-join material 640p added to substantially all flat surfaces of bus bar portions 578 to be sintered to respective flat surfaces 645 of respective bus bar portions 574.

Metal bus bar portions 575 and 579 can be positioned so that sinter-join material 640p formed on tubes 420wg2 contacts surfaces of grooves 571 and 576, and so that sinter-join material 640p formed on flat surfaces of bus bar portion 579 contacts respective flat surfaces 645 as shown. Then pressure and heat can be applied to bus bar portions 575 and 579 in a sintering process to sinter bus bar portions 575 and 579 to each other and to tubes 420wg2 through sintered joints 641p and 643p, which are shown in FIG. 9A-28. FIG. 9A-29 is a front view of bus bar 418CST shown in FIG. 9A-28. Phase bus bars 418CT of FIGS. 9A-1 and 9A-2 can be swapped with phase bus bars 418CST.

Tubes 420 can be connected to form “compound tubes.” FIGS. 9A-30 and 9A-31 show example compound tube 423a when seen from an end and from above, respectfully. Example compound tube 423a can be formed by connecting (e.g., soldering, sintering, etc.) three tubes 420v1 together with metal slats 551d using join material such as solder paste, sinter paste or sinter preform. Fewer tubes 420v1 and fewer slats 551d, or more tubes 420v1 and more slats 551d may be used to build an alternative version of compound tube 423a. A compound tube can also be formed by connecting tubes 420v2, tubes 420v3, or a mix of two or more tubes 420v1-420v3 together with metal slats 551d using join material such as solder paste, sinter paste or sinter preform. In an alternative embodiment, compound tube 423a may lack slat 551d1, slat 551d4, or both. In a two-tube embodiment, compound tube 423a may have only two tubes 420v1 connected by a single slat 551d. Slats 551d in this two-tube embodiment may be wider than slats 551d shown in FIGS. 9A-30 and 9A-31. The two-tube embodiment may lack slat 551d1, slat 551d4, or both.

Slats 551, including slats 551d, can be formed (e.g., extruded, stamped, cut, machined, etc.) from metal such as copper or aluminum. For example, each slat 551 may be cut from thin sheets of copper. Each slat 551, including slats 551d, may have a uniform cross-section that may be rectangular shaped as shown. Each slat 551 may have substantially flat opposite facing surfaces for connection to tubes 420. Although not shown, each slat 551 may have a thin layer of sintering enhancement material (e.g., silver) formed (e.g., electroplated) on most or substantially all outer surfaces. The sintering enhancement material may be added after slat 551 is stamped, cut or machined from a thin sheet of metal.

Tubes 420v can be connected through intervening slats 551. For example, tubes 420v1 can be connected in parallel through intervening metal slats 551d2 and 551d3 as shown. Flat, side-surfaces of metal layer 407d on a pair of adjacent tubes 420v1 can be connected (e.g., sintered) to opposite facing flat surfaces, respectively, of an intervening slat 551d2 or 551d3 through respective joints (e.g., sintered joints) 581d as shown. Flat surfaces of outer metal slats 551d1 and 551d4 can be connected (e.g., soldered, sintered, etc.) to respective flat side-surfaces of metal layer layers 407 on outer tubes 420v1 through respective joints 581d as shown. The lengths of slats 551d may be substantially equal to the lengths of metal layer 407d to which they are joined as shown in FIG. 9A-31. Tubes 420v1 and slats 551d may have substantially equal heights so that compound tube 423a has substantially flat, oppositely-facing top and bottom surfaces as shown in FIG. 9A-30. The ends of joints 581d may have substantially flat surfaces that are planar with the substantially flat, oppositely-facing top and bottom surfaces, respectively, as shown in FIG. 9A-30. In an alternative embodiment, intervening slates 551d are not needed, and the long, flat, side-surfaces metal layers 407d on adjacent tubes 420v1 can be directly connected (e.g., soldered, sintered, etc.) through a joint 581d, to create a compound tube with substantially flat, opposite-facing top and bottom surfaces. In this alternative embodiment, joints 581d may have substantially flat end surfaces that are planar with the substantially flat, opposite-facing top and bottom surfaces of the compound tube. The wider opposite-facing top and bottom surfaces of compound tube 423, with or without slats 551, may be smoothed (e.g., sanded) to make the surfaces more uniformly flat.

Bus bars can be formed around compound tubes 423. FIGS. 9A-32 and 9A-33 show top and end views of an example bus bar 557 formed around compound tube 423a. FIGS. 9A-32 and 9A-33 also show packaged switches 247d. With continuing reference to FIGS. 9A-30-9A-33, the top and bottom facing flat surfaces of tube 423a are shown connected (e.g. soldered, sintered, etc.) to respective first flat surfaces of metal slats 551t and 551b, respectively, through respective joints 581d. Die clip terminals 344 (not shown) of packed switches 247d may be connected (e.g., soldered) to substantially flat surface 559t. Although not shown, top and bottom facing flat surfaces of the two-tube version of tube 423a mentioned above, can be connected (e.g. soldered, sintered, etc.) to respective first flat surfaces of respective metal slats 551, through respective joints 581d.

FIGS. 9A-34 and 9A-35 show another compound tube 423b when seen from an end and top, respectively. Example compound tube 423b can be formed by connecting (e.g., soldering, sintering, etc.) three tubes 420vg1 together with sets of metal slats 551p as shown using join material such as solder paste, sinter paste or sinter preform. Fewer tubes 420vg1 and fewer slats 551p, or more tubes 420vg1 and more slats 551p may be used to build an alternative version of compound tube 423b. A compound tube can also be formed by connecting (e.g., soldering, sintering, etc.) three tubes 420vg2, or a combination of tubes 420vg1 and v20vg2 together with metal slats 551d using join material such as solder paste, sinter paste or sinter preform. In an alternative embodiment, compound tube 423b may lack slats 551p1, slats 551p4, or both. In a two-tube embodiment, compound tube 423b may have only two tubes 420vg1 connected by a single set of slats 551p. Slats 551p in this two-tube embodiment may be wider than slats 551p shown in FIGS. 9A-34 and 9A-35. The two-tube embodiment may lack slats 551p1, slats 551p4, or both.

Flat side-surfaces of metal layers 407p on a pair of adjacent tubes 420vg1 can be connected (e.g., soldered, sintered, etc.) to opposite facing flat surfaces, respectively, of an intervening slat 551p2 or 551p3 through respective joints (e.g., sintered joints) 581p as shown. Additional metal slats 551p1 and 551p4 can be connected (e.g., soldered, sintered, etc.) to respective flat side-surfaces of metal layers 407p on the outer tubes 420vg1 through respective joints 581p as shown. In an alternative embodiment, intervening sets of slats 551p are not needed, and respective flat side-surfaces of metal layers 507p on adjacent tubes 420vg1 can be directly connected (e.g., soldered, sintered, etc.) through joints 581p. The length of slats 551p may be substantially equal to the lengths of metal layers 407p to which they are joined as shown in FIG. 9A-35. Tubes 420vg1 and slats 551p may have substantially equal heights so that compound tube 423b may have substantially flat top and bottom surfaces as shown in FIG. 9A-34. The wider opposite-facing top and bottom surfaces of compound tube 423b, with or without slats 551p, may be smoothed (e.g., sanded) to make the surfaces more uniformly flat.

Phase bus bars can be built around compound tubes 423. FIGS. 9A-36 and 9A-37 are top and end views of an example phase bus bars 558 formed around compound tube 423b. FIG. 9A-37 also shows packaged switches 247d. With continuing reference to FIGS. 9A-34-9A-37, pairs of opposite facing top and bottom surfaces of tube 423b may be connected (e.g. soldered, sintered, etc.) to respective first flat surfaces of respective pairs of metal slats 551u and 5511, respectively, through respective joints (e.g., sintered joints) 581p. Die clip terminals 344 (not shown) of respective packed switches 247d may be connected (e.g., soldered) to respective flat surfaces 561u. Although not shown, top and bottom facing flat surfaces of the two-tube version of tube 423b mentioned above, can be connected (e.g. soldered, sintered, etc.) to respective first flat surfaces of respective metal slats 551, through respective joints 581p.

A power apparatus such as a converter can be built using bus bars formed around compound tubes. For example, a three-phase converter can be built using bus bars of FIGS. 9A-32, 9A-33, 9A-36, and 9A-37. More particularly the exposed flat surfaces of slats 5511 can be connected (e.g., sintered or soldered) to respective die substrate terminals 230 of the packaged switches 247d in FIG. 9A-33, and a flat surface 559b of another bus bar 557 like that shown in FIG. 9A-33, may be connected (e.g., sintered or soldered) to the die substrate terminals 230 of packaged switches 247d of FIG. 9A-37. The connector-leads 288 of FIGS. 9A-32, 9A-33, 9A-36, and 9A-37 can be electrically connected to traces on a driver PCB like driver PCB 461iT. Ends of tubes 420v1 and 420vg1 can be received through rectangular shaped apertures of manifolds like manifolds 466.

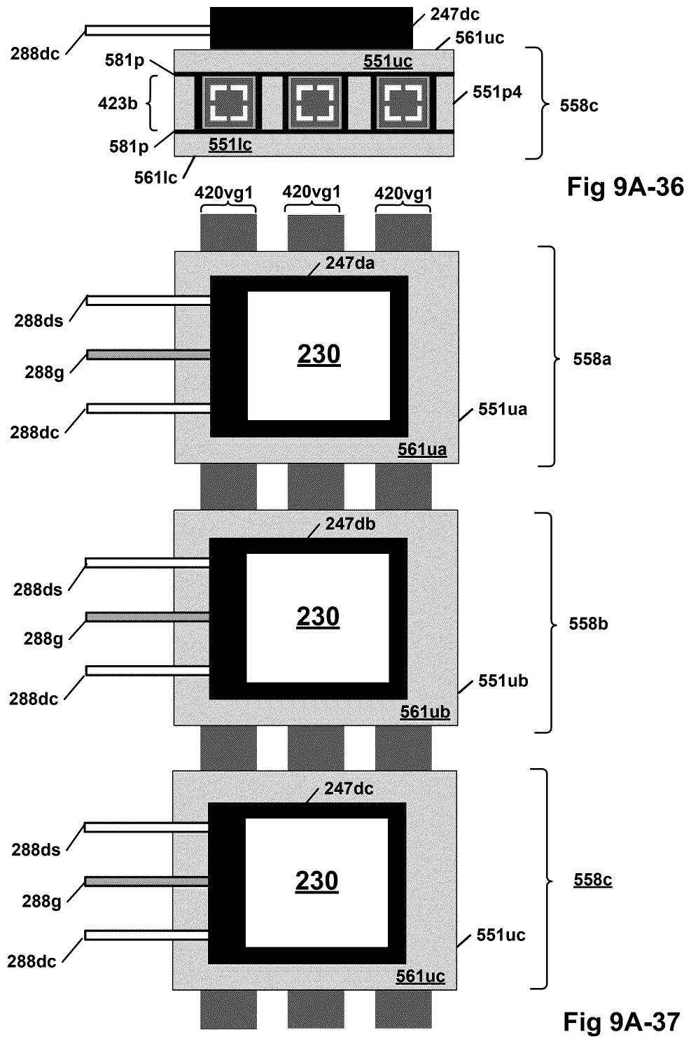

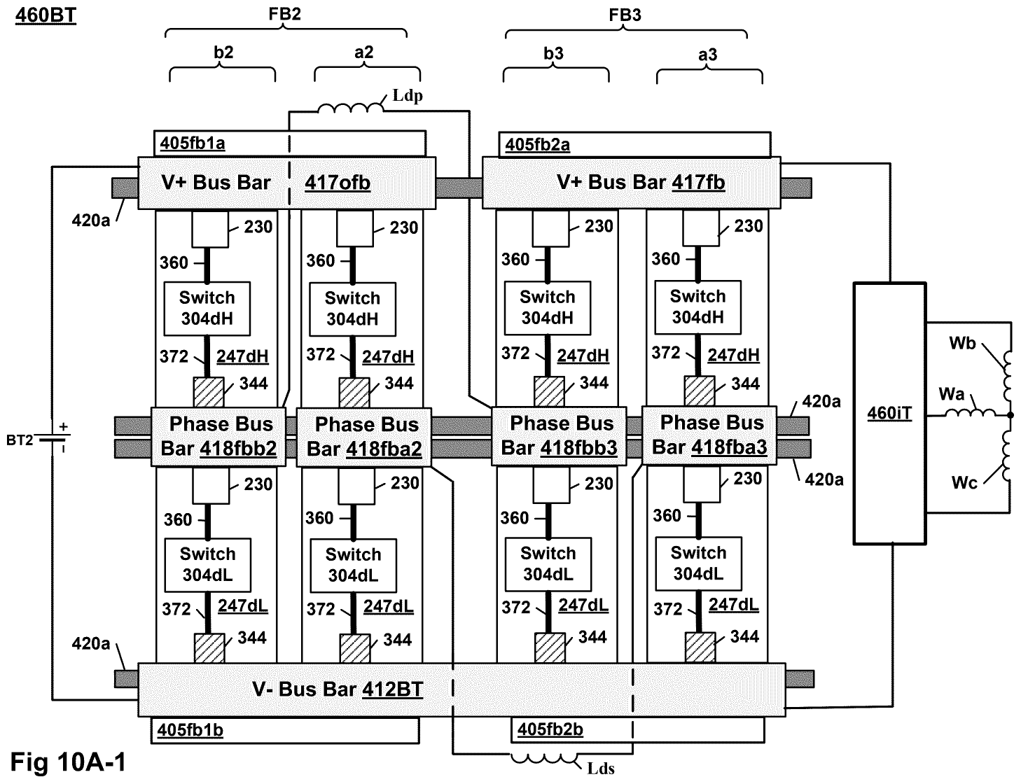

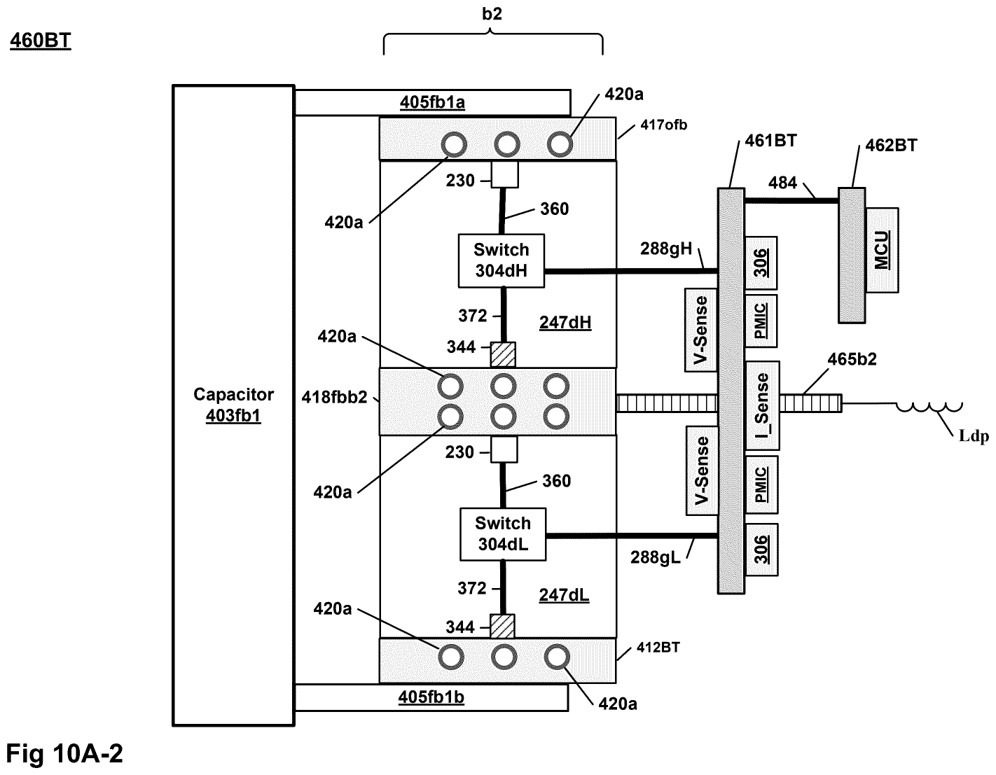

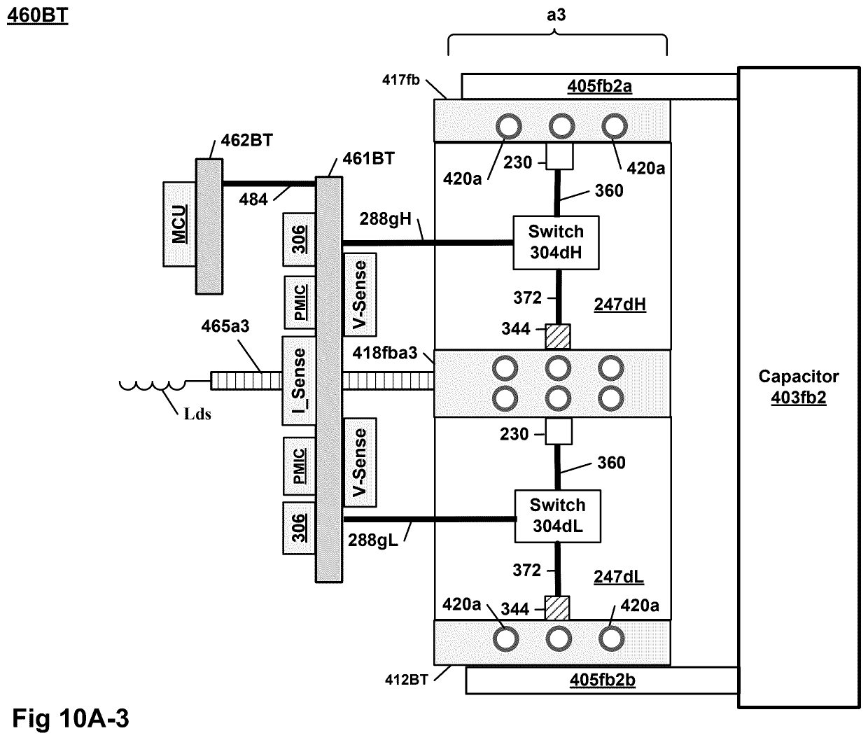

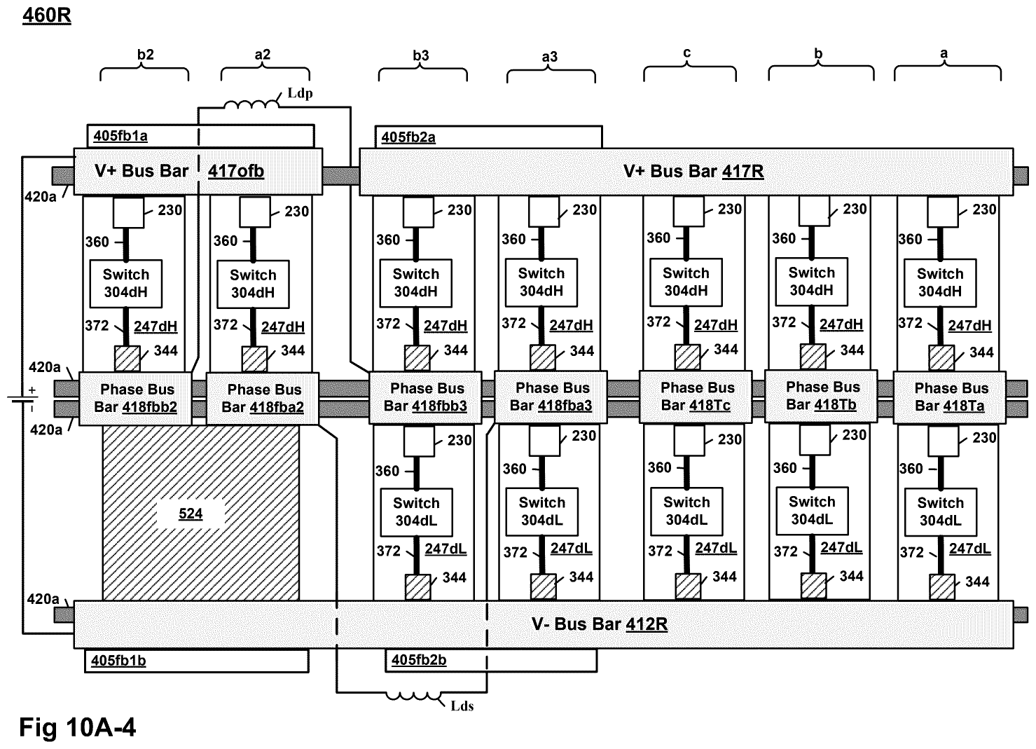

FIGS. 10A-1, 10A-2, and 10A-3 illustrate relevant components of an example converter 460BT when seen from the front, left and right sides, respectively. Several components (e.g., PCB 461BT, PCB 462BT, and capacitors 403fb) shown in FIGS. 10A-2 and 10A-3 are not shown or fully shown in FIG. 10A-1 but are described below. Converter 460BT can function as a bidirectional, DC/DC, buck/boost converter.

Converter 460BT may include packaged switches 247d, it being understood that in an alternative version packaged switches 247d may be replaced by packaged switches 247p or packaged switches 247q. All packaged switches 247 of converter 460BT may be the same type. Packaged switches 247d of converter 460BT may be packaged switch 247dA, 247dB, or 247dD of FIGS. 10A-3A, 3B, and 3D, respectively.

With continuing reference to FIG. 10A-1, converter 460BT may include V+ bus bar 417ofb, V+ bus bar 417fb, V− bus bar 412BT, and phase bus bars 418fb as shown. V+ bus bar 417ofb, V+ bus bar 417fb, V− bus bar 412BT and phase bus bars 418fb may have a generally rectangular cuboid shape. Example phase bus bars 418fb may have a height, width, and length around 12 mm, 25 mm, and 20 mm, respectively. Example V+ bus bar 417fb and V+ bus bar 417ofb may have a height, width, and length around 8 mm, 25 mm, and 45 mm, respectively. Example V− bus bar 412BT may have a height, width, and length around 8 mm, 25 mm, and 95 mm, respectively. FIGS. 10A-2 and 10A-3 show the height and width of the bus bars.

Converter 460BT is shown with two full-bridge portions FB2 and FB3. Each full-bridge portion (hereinafter portion) FB2 and FB3 may include components of full-bridge inverter 460fb shown in FIGS. 5G-1 and 5G-2. Portions FB2 and FB3 may be electrically connected to each other through inductors Lds and Ldp, and through V− bus bar 412BT. Each portion FB has two legs designated a and b. Each leg of portion FB2 may include packaged switches 247dH and 247dL that may be electrically and thermally connected to a respective phase bus bar 418fb, which in combination may be sandwiched between V+ bus bar 417ofb and V− bus bar 412BT as shown. Packaged switches 247dH and 247dL in portion FB2 may also be electrically and thermally connected to V+ bus bar 417ofb and V− bus bar 412BT, respectively. Each leg of portion FB3 may include packaged switches 247dH and 247dL that may be electrically and thermally connected to a respective phase bus bar 418fb, which in combination may be sandwiched between V+ bus bar 417fb and V− bus bar 412BT as shown. Packaged switches 247dH and 247dL in portion FB3 may be also electrically and thermally connected to V+ bus bar 417fb and V− bus bar 412BT, respectively.

FIG. 10A-1 illustrates the relative positioning of packaged switches 247d, V+ bus bar 417ofb, V− bus bar BT, V+ bus bar 417fb, and phase bus bars 418fb with respect to each other. Die substrate terminals 230 and die clip terminals 344 may be pressed-fitted, soldered, sintered, welded, or connected by other means directly to corresponding flat surfaces of bus bars to establish thermal and electrical connectivity. Die clip terminals 344 of packaged switches 247dH in portion FB2 may be electrically and thermally connected (e.g., soldered, sintered, press-fitted, etc.) directly or indirectly to flat surfaces of respective phase bus bars 418fba2 and 418fbb2, which in turn may be electrically connected to terminals of inductor Ldp and inductor Lds as shown. Packaged switches 247dL of portion FB2 may have die substrate terminals 230 that may be electrically and thermally connected (e.g., soldered, sintered, press-fitted, etc.) directly or indirectly to flat surfaces of respective phase bus bars 418fba2 and 418fbb2, and die clip terminals 344 that may be electrically and thermally connected (e.g., soldered, sintered, press-fitted, etc.) directly or indirectly to a flat surface or respective flat surfaces of V− bus bar 412BT as shown. Packaged switches 247dH of portion FB3 may have die substrate terminals 230 that may be electrically and thermally connected (e.g., soldered, sintered, press-fitted, etc.) directly or indirectly to a flat surface or respective flat surfaces of V+ bus bar 417fb, and die clip terminals 344 that may be electrically and thermally connected (e.g., soldered, sintered, press-fitted, etc.) directly or indirectly to flat surfaces of respective phase bus bars 418fbb3 and 418fba3, which in turn may be electrically connected to terminals of inductor Lds and inductor Ldp as shown. Packaged switches 247dL of portion FB3 may have die substrate terminals 230 that may be electrically and thermally connected (e.g., soldered, sintered, press-fitted, etc.) directly or indirectly to flat surfaces of respective phase bus bars 418fba3 and 418fbb3, and die clip terminals 344 that may be electrically and thermally connected (e.g., soldered, sintered, press-fitted, etc.) directly or indirectly to a flat surface or respective flat surfaces of V− bus bar 412BT as shown.

FIGS. 10A-1 and 10A-2 show converter 460BT with dielectric tubes 420a received in bus bars. Tubes other than 420a can be received by the bus bars. For example, the four aligned bus bars 418fb can be formed by soldering metal bus bar portions around tubes like tubes 420g, but with four metal layers 407p in instead of three, using a process like the process described with reference to FIGS. 5A-11-5A-15. The two aligned bus bars 417ofb and 417fb can be formed by soldering metal bus bar portions around tubes like tubes 420g, but with two metal layers 407p instead of three, using a process like the process described with reference to FIGS. 5A-17-6-5A-17-10. V− bus bar 412BT can be formed by soldering metal bus bar portions around tubes like tubes 420g using a process like the process described with reference to FIGS. 5A-17-1-5A-17-5.

With continuing reference to FIGS. 10A-2 and 10A-3, FIG. 10A-1 shows that all phase bus bars 418fb may be thermally connected to each other and electrically isolated from each other by commonly received dielectric tubes 420a. V+ bus bars 417fb and 417ofb may be thermally connected to each other and electrically isolated from each other by commonly received dielectric tubes 420a.

Converter 460BT may include DC link capacitors 403fb. In FIG. 10A-2, first and second metal capacitor-leads 405fb1a and 405fb1b extend from DC link capacitor 403fb1. A flat bottom surface of capacitor-lead 405fb1a may be electrically and thermally connected (e.g., welded, soldered, press-fitted by screws or other fasteners, etc.) directly to a flat surface of V+ bus bar 417ofb, and a flat top surface area of capacitor-lead 405fb1b may be electrically and thermally connected to a flat surface of V− bus bar 412BT as shown. In FIG. 10A-3, first and second metal capacitor-leads 405fb2a and 405fb2b extend from DC link capacitor 403fb2. A flat bottom surface of capacitor-lead 405fb2a may be electrically and thermally connected (e.g., welded, soldered, press-fitted by screws or other fasteners, etc.) directly to a flat surface of V+ bus bar 417ofb, and a flat top surface area of capacitor-lead 405fb2b may be electrically and thermally connected to a flat surface of V− bus bar 412BT as shown.

Converter 460BT may include control PCB 462BT and driver PCB 461BT. Drivers 306 on driver PCB 461BT can control respective switches 304 through respective connector-leads 288g. Only drivers 306 and connector-leads 288gH and 288gL of leg-b2 and leg-a3 of portions FB2 and FB3, respectively, are represented in FIGS. 10A-2 and 10A-3, respectively.

Driver PCB 461BT may include voltage sensors V_Sense that can sense voltages across respective pairs of connector-leads 288ds and 288dc. With continuing reference to FIG. 10A-2 example phase bus bar-lead 465b2 may extend laterally between first and second ends. The first end of phase bus bar-lead 465b2 may be electrically connected to a side wall of phase bus bar 418fbb2, and the second end may be electrically connected to inductor Ldp as shown. Phase bus bar-lead 465b2 may extend through an aperture in PCB 461BT. Current sensor I_Sense may include an aperture through which phase bus bar-lead 465b2 may extend. Current sensor I_Sense can measure electrical current flowing through phase bus bar-lead 465b2. FIG. 10A-2 shows drivers 306, voltage sensors V_Sense, PMICs, current sensor I_Sense, and a phase bus bar-lead 465b2 for leg-b2 of portion FB2. A similar group of drivers 306, voltage sensors V_Sense, PMICs, and current sensor I_Sense, and bus bar-lead 465 may be mounted on or extending through PCB 461BT for leg-a2.

With continuing reference to FIG. 10A-3 example phase bus bar-lead 465a3 may extend laterally between first and second ends. The first end of phase bus bar-lead 465a3 may be electrically connected to a side wall of phase bus bar 418fba3, and the second end may be electrically connected to inductor Ls as shown. Phase bus bar-lead 465a3 may extend through an aperture in PCB 461BT. Current sensor I_Sense may include an aperture through which phase bus bar-lead 465a3 may extend. Current sensor I_Sense can measure electrical current flowing through phase bus bar-lead 465a3. FIG. 10A-3 shows drivers 306, voltage sensors V_Sense, PMICs, current sensor I_Sense, and a phase bus bar-lead 465a3 for leg-a3 of portion FB3. A similar group of drivers 306, voltage sensors V_Sense, PMICs, and current sensor I_Sense, and bus bar-lead 465 may be mounted on or extending through PCB 461BT for leg-b3.

FIGS. 10A-2 and 10A-3 show an MCU mounted on control PCB 461BT. The MCU may be in data communication with each driver 306, V_Sense, and I_Sense mounted on driver PCB 461BT through a data connection 484.

Converter 460BT is electrically connected between a battery BT1 and an inverter, like inverter 460iT described above, which in turn is electrically coupled to windings Wa-Wc as shown. In this configuration, converter 460BT can boost the DC voltage provided by battery BT2 for inverter 460iT when it is operating in the forward direction, or converter 460BT can buck the DC voltage generated by inverter 460iT when it is operating in reverse, for charging battery BT2. In the configuration shown in FIGS. 10A-1-10A-3, packaged switches 247dL of FB2 may not be required and could be removed or replaced with a solid, rectangular cuboid-shaped dielectric block of similar height to provide electrical isolation and structural support between bus bars 418fbb2 and 418fba2, respectively, on one side, and V− bus bar 412 BT on the opposite side. The dielectric block may have opposite facing flat surfaces, the first of which engages flat surfaces of bus bar 418fbb2 and 418fba2, while the second flat surface engages a flat surface of V− bus bar 412BT.

All tubes 420, such as tubes 420a in FIG. 10A-1, received in all bus bars of converter 460BT may be substantially equal in length. Although not shown in FIGS. 10A-1-10A-3, first and second manifolds like manifolds 466iT, may be in fluid communication with first and second ends, respectively, of tubes 420a.

Converter 460BT can be combined with an inverter to create an integrated converter. FIG. 10A-4 illustrates a front view of an example of combining components of converter 460BT with components of inverter 460iT (see FIG. 5A-1) to create an integrated converter 460R. More particularly, V+ bus bar 417fb of converter 460BT and V+ bus bar of 417T of inverter 460iT can be replaced by a rectangular cuboid-shaped V+ bus bar 417R. Extended tubes 420a can be commonly received by V+ bus bar 417ofb and V+ bus bar 417R. V− bus bars 412BT and 412T can be replaced with a rectangular cuboid-shaped single V− bus bar 412R. Extended tubes 420a can be commonly received by V− bus bar 412R. Extended tubes 420a can be received by linearly aligned bus bars 418fb and 418T in integrated converter 460R. All extended tubes 420a of integrated converter 460R may have the same length. Packaged switches 247dL of FB2 are shown replaced with solid, rectangular cuboid-shaped dielectric block 524 of similar height to provide electrical isolation and structural support between bus bars 418fbb2 and 418fba2, respectively, on one side, and V− bus bar 412R on the opposite side. Although not shown in FIG. 10A-4, first and second manifolds 466iT may be in fluid communication with first and second ends, respectively, of the extended tubes 420a. The dielectric block 524 may have opposite facing flat surfaces, the first of which engages flat surfaces of bus bar 418fbb2 and 418fba2, while the second flat surface engages a flat surface of V− bus bar 412R as shown.

Liquid dielectric material such as epoxy, silicon, etc., can be added to air gaps or empty spaces between adjacent electrical conductors of charger 460BT, including electrical conductors of naked packaged switches 247 if employed, and then cured to create structures that suppress dendrite growth and electrical arcing therebetween.

A first power converter is disclosed that comprises: a plurality of first submodules electrically connected in series; wherein each of the first submodules comprises: a first metal bus bar comprising a first channel through which fluid can flow; a second metal bus bar comprising a second channel through which fluid can flow; a third metal bus bar comprising a third channel through which fluid can flow; a first transistor comprising first and second transistor terminals thermally and electrically connected to the first and second metal bus bars, respectively; a second transistor comprising first and second transistor terminals thermally and electrically connected to the second and third metal bus bars, respectively; and a first capacitor comprising first and second metal leads thermally and electrically connected to the first and third metal bus bars, respectively. The first power converter may also comprise: a plurality of second submodules electrically connected in series; wherein each of the second submodules comprises: a fourth metal bus bar comprising a fourth channel through which fluid can flow; a fifth metal bus bar comprising a fifth channel through which fluid can flow; a sixth metal bus bar comprising a sixth channel through which fluid can flow; a third transistor comprising first and second transistor terminals thermally and electrically connected to the fourth and fifth metal bus bars, respectively; a fourth transistor comprising first and second transistor terminals thermally and electrically connected to the fifth and sixth metal bus bars, respectively; a second capacitor comprising first and second metal leads thermally and electrically connected to the fourth and sixth metal bus bars, respectively; wherein the plurality of first submodules and electrically connected in series with the plurality of second submodules.

A first power apparatus is disclosed that comprises: a first metal bus bar comprising a first channel through which fluid can flow; a second metal bus bar comprising a second channel through which fluid can flow; a third metal bus bar comprising a third channel through which fluid can flow; a first transistor comprising first and second transistor terminals thermally and electrically connected to the first and second metal bus bars, respectively; a second transistor comprising first and second transistor terminals thermally and electrically connected to the first and third metal bus bars, respectively; wherein the second metal bus bar is configured for electrical connection to a first winding of a first stator of a first motor; wherein the third metal bus bar is configured for electrical connection to a second winding of a second stator of a second motor. In addition, the second metal bus bar is electrically connected to the first winding of the first power apparatus, and the third metal bus bar of the first power apparatus is electrically connected to the second winding.

A second power converter is disclosed that comprises: a first metal bus bar comprising a first channel through which fluid can flow; a second metal bus bar comprising a second channel through which fluid can flow; a third metal bus bar comprising a third channel through which fluid can flow; a fourth metal bus bar comprising a fourth channel through which fluid can flow; a fifth metal bus bar comprising a fifth channel through which fluid can flow; a sixth metal bus bar comprising a sixth channel through which fluid can flow; a first transistor comprising first and second transistor terminals thermally and electrically connected to the first and third metal bus bars, respectively; a second transistor comprising first and second transistor terminals thermally and electrically connected to the first and forth metal bus bars, respectively; a third transistor comprising first and second transistor terminals thermally and electrically connected to the second and fifth metal bus bars, respectively; a fourth transistor comprising first and second transistor terminals thermally and electrically connected to the second and sixth metal bus bars, respectively; wherein the third metal bus bar is configured for direct or indirect electrical connection to a first terminal on a primary side of a transformer; wherein the fourth metal bus bar is configured for direct or indirect electrical connection to a second terminal on the primary side of the transformer; wherein the fifth metal bus bar is configured for direct or indirect electrical connection to a first terminal on a secondary side of the transformer; wherein the sixth metal bus bar is configured for direct or indirect electrical connection to a second terminal on the secondary side of the transformer. The second power converter may further comprise: a first tube commonly received by the first and second metal bus bars; a second tube commonly received by the third, fourth, fifth, and sixth metal bus bars; wherein the first tube comprises the first and second channels; wherein the second tube comprises the third, fourth, fifth and sixth channels; wherein the first and second channels are linearly aligned with each other; wherein the third, fourth, fifth and sixth channels are linearly aligned with each other. In the second power converter: the third metal bus bar may be directly or indirectly connected electrically to the first terminal on a primary side of the transformer; the fourth metal bus bar may be directly or indirectly connected electrically to the second terminal on the primary side of the transformer; the fifth metal bus bar may be directly or indirectly connected electrically to the first terminal on the secondary side of the transformer; the sixth metal bus bar may be directly or indirectly connected electrically to the second terminal on the secondary side of the transformer.

A third power converter is disclosed that comprises: a first metal bus bar comprising a first channel through which fluid can flow; a second metal bus bar comprising a second channel through which fluid can flow; a third metal bus bar comprising a third channel through which fluid can flow; a fourth metal bus bar comprising a fourth channel through which fluid can flow; a fifth metal bus bar comprising a fifth channel through which fluid can flow; a sixth metal bus bar comprising a sixth channel through which fluid can flow; a first transistor comprising first and second transistor terminals thermally and electrically connected to the first and third metal bus bars, respectively; a second transistor comprising first and second transistor terminals thermally and electrically connected to the first and forth metal bus bars, respectively; a first diode comprising first and second transistor terminals thermally and electrically connected to the second and fifth metal bus bars, respectively; a second diode comprising first and second transistor terminals thermally and electrically connected to the second and sixth metal bus bars, respectively; wherein the third metal bus bar is configured for direct or indirect electrical connection to a first terminal on a primary side of a transformer; wherein the fourth metal bus bar is configured for direct or indirect electrical connection to a second terminal on the primary side of the transformer; wherein the fifth metal bus bar is configured for direct or indirect electrical connection to a first terminal on a secondary side of the transformer; wherein the sixth metal bus bar is configured for direct or indirect electrical connection to a second terminal on the secondary side of the transformer. The third power converter may further comprise: a first tube commonly received by the first and second metal bus bars; a second tube commonly received by the third, fourth, fifth, and sixth metal bus bars; wherein the first tube comprises the first and second channels; wherein the second tube comprises the third, fourth, fifth and sixth channels; wherein the first and second channels are linearly aligned with each other; wherein the third, fourth, fifth and sixth channels are linearly aligned with each other. In the third power converter: the third metal bus bar may be directly or indirectly connected electrically to the first terminal on a primary side of the transformer; the fourth metal bus bar may be directly or indirectly connected electrically to the second terminal on the primary side of the transformer; the fifth metal bus bar may be directly or indirectly connected electrically to the first terminal on the secondary side of the transformer; the sixth metal bus bar may be directly or indirectly connected electrically to the second terminal on the secondary side of the transformer.

A first apparatus is disclosed that comprises: a first bus bar comprising: a first bus bar portion comprising a first groove; a second bus bar portion comprising a second groove; a tube received in the first and second grooves; wherein the tube comprises a channel through which fluid can flow; wherein the first and second bus bar portions are attached together and around the tube. In the first apparatus: the tube may comprise a dielectric that electrical insulates the first bus bar from the fluid when it flows through the channel; the tube may comprise an outer metallic layer; the outer metallic layer may comprise an outer surface that is attached to a surface of the first groove and a surface of a second groove using solder that comprises bits of metal and flux. The first apparatus may further comprise: a second bus bar comprising: a third bus bar portion comprising a third groove; a fourth bus bar portion comprising a fourth groove; wherein the tube received in the third and fourth grooves; wherein the third and fourth bus bar portions are attached together and around the tube.

A fourth power converter is disclosed that comprises: a first bus bar comprising a first channel through which fluid may flow; a second bus bar comprising a second channel through which fluid may flow; a third bus bar comprising a third channel through which fluid may flow; a first transistor comprising first and second transistor terminals thermally and electrically connected to the first and second bus bars, respectively; a second transistor comprising first and second transistor terminals thermally and electrically connected to the second and third bus bars, respectively; a first printed circuit board (PCB) comprising: a first trace electrically connected to the first bus bar; a second trace electrically connected to the second bus bar; a third trace electrically connected to the third bus bar; a fourth trace; a fifth trace; a sixth trace; a seventh trace; a first capacitor comprising first and second terminals electrically connected to the second and fourth traces, respectively; a second capacitor comprising first and second terminals electrically connected to the second and fifth traces, respectively; a third capacitor comprising first and second terminals electrically connected to the fourth and fifth traces, respectively; a first diode comprising first and second terminals electrically connected to the first and fourth traces, respectively; a second diode comprising first and second terminals electrically connected to the third and fifth traces, respectively; a third diode comprising first and second terminals electrically connected to the fourth and sixth traces, respectively; a fourth diode comprising first and second terminals electrically connected to the fifth and seventh and fifth traces, respectively; a transformer comprising first and second primary side terminals and first and second secondary side terminals; wherein the first primary side terminal is electrically connected to sixth trace; wherein the first secondary side terminal is electrically connected to seventh trace; wherein the first secondary side terminal is electrically connected to first trace; wherein the first secondary side terminal is electrically connected to third trace. In the fourth power converter the first, second, and third bus bars may comprise first, second, and third tubes, respectively, and the first, second, and third tubes may comprise the first, second, and third channels, respectively.

A second apparatus is disclosed for electrically connecting and disconnecting a power converter to a voltage supply, the second apparatus comprising: a first bus bar configured for electrical connection to the power converter; a first tube received in the first bus bar, wherein the first tube extends between a first end and a second end, and wherein the first tube is configured to electrically insulate fluid flowing through it from the first bus bar; first and second manifolds in fluid communication with the first and second ends, respectively, of the first tube; a first switch, which comprises a first terminal and a second terminal between which electrical current is transmitted when the first switch is activated; and wherein the first terminal is thermally and electrically connected to the first bus bar. The second apparatus may further comprise: a second bus bar configured for electrical connection to the voltage supply; a second tube received in the second bus bar, wherein the second tube extends between first and second ends, and wherein the second tube is configured to electrically insulate fluid flowing through it from the second bus bar; wherein the second terminal is thermally and electrically connected to the second bus bar; and wherein the first and second manifolds are in fluid communication with the first and second ends, respectively, of the second tube. The second apparatus may further comprise a voltage clamping circuit electrically connected between the first and second bus bars.

A third apparatus for opening or closing a circuit is disclosed, the third apparatus comprising: a first bus bar; a first tube received in the first bus bar, wherein the first tube extends between a first end and a second end, wherein the first tube is configured to electrically insulate fluid flowing through it from the first bus bar; a second bus bar; a second tube received in the second bus bar, wherein the second tube extends between first and second ends, wherein the second tube is configured to electrically insulate fluid flowing through it from the second bus bar; and a first switch electrically connected between the first and second bus bars. In the third apparatus: the first switch may comprise a first terminal and a second terminal between which electrical current is transmitted when the first switch is activated; and the first terminal and second terminals may be thermally and electrically connected to the first and second bus bars, respectfully. In the third apparatus the first switch may comprise a first bidirectional switch.

Although embodiments of the present disclosure are described in connection with several versions, the disclosure is not intended to be limited to the versions set forth herein.

What is claimed is:

1. A power converter comprising:
a first switch comprising first and second switch terminals, the first switch further comprising:
first and second transistors electrically connected in series between the first and second switch terminals, wherein each of the first and second transistors comprise first and second transistor terminals between which a first electrical current can flow;
a first metal bus bar comprising a first channel through which fluid can flow;
a second metal bus bar comprising a second channel through which fluid can flow;
a first driver for controlling the first transistor;
a second driver for controlling the second transistor;
a control unit for generating a first signal;
a first distribution network for transmitting the first signal to the first and second drivers at the same time;
wherein the first transistor terminal of the first transistor is electrically and thermally connected to the first metal bus bar;
wherein the first transistor terminal of the second transistor is electrically and thermally connected to the second metal bus bar.

2. The power converter of claim 1 wherein the first switch comprises:
a third metal bus bar comprising a third channel through which fluid can flow;
wherein the first and second transistor terminals of the first transistor are electrically and thermally connected to the first and second metal bus bars, respectively; and
wherein the first and second transistor terminals of the second transistor are electrically and thermally connected to the second and third metal bus bars, respectively.

3. The power converter of claim 1 wherein the first switch further comprises:
first and second diodes electrically connected in series between the first and second switch terminals, wherein each of the first and second diodes comprise first and second diode terminals;
wherein the first diode terminal of the first diode is electrically and thermally connected to the first metal bus bar; and
wherein the first diode terminal of the second diode is electrically and thermally connected to the second metal bus bar.

4. The power converter of claim 1 wherein the first metal bus bar comprises a first tube through which fluid can flow, wherein the first tube extends linearly between first and second ends, wherein the first tube comprises the first channel, and wherein the first tube is configured to electrically isolate fluid flowing through the first channel from the first transistor.

5. The power converter of claim 4 wherein the first switch comprises first and second manifolds that are in fluid communication with the first end and the second end, respectively, of the first tube.

6. The power converter of claim 4 wherein the first metal bus bar comprises first and second metal portions attached together around the first tube.

7. The power converter of claim 4 wherein the first metal bus bar is formed by sintering material around the first tube.

8. The power converter of claim 4 wherein the first metal bus bar comprises a rectangular or square shaped tube sandwiched between rectangular shaped metal conductors.

9. The power converter of claim 1 wherein the first metal bus bar comprises a pair of metal fins extending from a metal wall, wherein the pair of metal fins are parallel to each other, wherein the pair of metal fins are immediately adjacent to each other, wherein a space between the pair of metal fins comprises the first channel.

10. The power converter of claim 9 wherein the first switch further comprises:
first and second manifolds;
wherein each of the first and second metal bus bars extend linearly between first and second ends; and
wherein the first and second ends are in fluid communication with the first and second ends, respectively, of the first and second metal bus bars.

11. The power converter of claim 10 wherein fluid flowing through the first channel comprises a dielectric fluid.

12. The power converter of claim 1 wherein the first distribution network comprises:
first and second fiber optic cables for transmitting the first signal in parallel at the same time;
wherein the first fiber optic cable is connected between the control unit and the first driver; and
wherein the second fiber optic cable is connected between the control unit and the second driver.

13. The power converter of claim 12 wherein the first distribution network comprises:
first and second optoelectronic converters for converting optical signals into electrical signals;
wherein each of the first and second fiber optic cables extends between first and second ends;
wherein the second ends of the first and second fiber optic cables are in data communication with the first and second optoelectronic converters, respectively.

14. The power converter of claim 1 wherein the first switch comprises:
a third metal bus bar comprising a third channel through which fluid can flow;
a fourth metal bus bar comprising a fourth channel through which fluid can flow;
a metal strap that electrically connects the second and third metal bus bars;
wherein the first and second transistor terminals of the first transistor are electrically and thermally connected to the first and second metal bus bars, respectively; and
wherein the first and second transistor terminals of the second transistor are electrically and thermally connected to the third and fourth metal bus bars, respectively.

15. The power converter of claim 1 further comprising:
a second switch comprising third and fourth switch terminals, the second switch comprising:
third and fourth transistors electrically connected in series between the third and fourth switch terminals, wherein each of the third and fourth transistors comprise first and second transistor terminals between which a second electrical current can flow;
a third metal bus bar comprising a third channel through which fluid can flow;
a fourth metal bus bar comprising a fourth channel through which fluid can flow;
a third driver for controlling the third transistor;
a fourth driver for controlling the fourth transistor;
a second distribution network for transmitting a second signal to the third and fourth drivers at the same time;
wherein the first transistor terminal of the third transistor is electrically and thermally connected to the third metal bus bar;
wherein the first transistor terminal of the fourth transistor is electrically and thermally connected to the fourth metal bus bar;
wherein the second switch terminal of the first switch is electrically connected to the third switch terminal of the second switch.

16. An apparatus comprising:
a first switch comprising first and second switch terminals, the first switch further comprising:
first and second transistors electrically connected in series between the first and second switch terminals, wherein each of the first and second transistors comprise first and second transistor terminals between which a first electrical current can flow;
a first metal bus bar comprising a first channel through which fluid can flow;
a second metal bus bar comprising a second channel through which fluid can flow;
a first driver for controlling the first transistor;
a second driver for controlling the second transistor;
wherein the first transistor terminal of the first transistor is electrically and thermally connected to the first metal bus bar;
wherein the first transistor terminal of the second transistor is electrically and thermally connected to the second metal bus bar; and
wherein the first and second drivers are connected to receive a first driver control signal at the same time.

17. The apparatus of claim 16 wherein the first switch comprises:
a third metal bus bar comprising a third channel through which fluid can flow;
wherein the first and second transistor terminals of the first transistor are electrically and thermally connected to the first and second metal bus bars, respectively; and
wherein the first and second transistor terminals of the second transistor are electrically and thermally connected to the second and third metal bus bars, respectively.

18. The apparatus of claim 16 further comprising:
a second switch comprising third and fourth switch terminals, the second switch comprising:
third and fourth transistors electrically connected in series between the third and fourth switch terminals, wherein each of the third and fourth transistors comprise first and second transistor terminals between which a second electrical current can flow;
a third metal bus bar comprising a third channel through which fluid can flow;
a fourth metal bus bar comprising a fourth channel through which fluid can flow;
a third driver for controlling the third transistor;
a fourth driver for controlling the fourth transistor;
wherein the first transistor terminal of the third transistor is electrically and thermally connected to the third metal bus bar;
wherein the first transistor terminal of the fourth transistor is electrically and thermally connected to the fourth metal bus bar;
wherein the second switch terminal is electrically connected to the third switch terminal; and
wherein the third driver and the fourth driver are connected to receive a second driver control signal, which is different from the first driver control signal, at the same time.

19. The apparatus of claim 16 wherein the first metal bus bar comprises a first tube through which fluid can flow, wherein the first tube extends linearly between first and second ends, wherein the first tube comprises the first channel, and wherein the first tube is configured to electrically isolate fluid flowing through the first channel from the first transistor.

20. The apparatus of claim 16 wherein the first switch further comprises:
first and second manifolds;
wherein each of the first and second metal bus bars extend linearly between first and second ends; and
wherein the first and second ends are in fluid communication with the first and second ends, respectively, of the first and second metal bus bars.
